SEQUENCE LISTING (1268 sequences)

SEQ ID NO: 1 - protein, 15 aa, Homo sapiens
YFDYWGQGTLVTVSS

SEQ ID NO: 2 - protein, 15 aa, Homo sapiens
AFDIWGQGTMVTVSS

SEQ ID NO: 3 - protein, 20 aa, Homo sapiens
YYYYYGMDVWGQGTTVTVSS

SEQ ID NO: 4 - protein, 107 aa, Artificial Sequence
  Description of Artificial Sequence Synthetic polypeptide
DIQMTQSPSSLSASVGDRVTITCRASQSISSYLNWYQQKPGKAPKLLIYAASSLQSGVPSRFSGSGSGTDFTLTISSLQPEDFATYYCQQSYSTPFTFGPGTKVDIK

SEQ ID NO: 5 - protein, 107 aa, Artificial Sequence
  Description of Artificial Sequence Synthetic polypeptide
DIQMTQSPSSLSASVGDRVTITCRASQDISSYLNWYQQKPGKAPKLLIYAASSLQSGVPSRFSGSGSGTDFTLTISSLQPEDFATYYCQQSYSTPFTFGPGTKVDIK

SEQ ID NO: 6 - protein, 107 aa, Artificial Sequence
  Description of Artificial Sequence Synthetic polypeptide
DIQMTQSPSSLSASVGDRVTITCRASQSISSYLNWYQQKPGKAPKLLIYAASSLQSGVPSRFSGSGSGTDFTLTISSLQPEDFATYYCQQRYSTPFTFGPGTKVDIK

SEQ ID NO: 7 - protein, 107 aa, Artificial Sequence
  Description of Artificial Sequence Synthetic polypeptide
DIQMTQSPSSLSASVGDRVTITCRASQSISSYLNWYQQKPGKAPKLLIYAASSLQSGVPSRFSGSGSGTDFTLTISSLQPEDFATYYCQQEYSTPFTFGPGTKVDIK

SEQ ID NO: 8 - protein, 107 aa, Artificial Sequence
  Description of Artificial Sequence Synthetic polypeptide
DIQMTQSPSSLSASVGDRVTITCRASQSISRYLNWYQQKPGKAPKLLIYAASSLQSGVPSRFSGSGSGTDFTLTISSLQPEDFATYYCQQSYSTPFTFGPGTKVDIK

SEQ ID NO: 9 - protein, 107 aa, Artificial Sequence
  Description of Artificial Sequence Synthetic polypeptide
DIQMTQSPSSLSASVGDRVTITCRASQSISEYLNWYQQKPGKAPKLLIYAASSLQSGVPSRFSGSGSGTDFTLTISSLQPEDFATYYCQQSYRTPFTFGPGTKVDIK

SEQ ID NO: 10 - protein, 107 aa, Artificial Sequence
  Description of Artificial Sequence Synthetic polypeptide
EIVLTQSPATLSLSPGERATLSCRASQSVSSYLAWYQQKPGQAPRLLIYDASNRATGIPARFSGSGSGTDFTLTISSLEPEDFAVYYCQQRSNWPLTFGGGTKVEIK

SEQ ID NO: 11 - protein, 107 aa, Artificial Sequence
  Description of Artificial Sequence Synthetic polypeptide
EIVLTQSPATLSLSPGERATLSCRASQSVSRYLAWYQQKPGQAPRLLIYDASNRATGIPARFSGSGSGTDFTLTISSLEPEDFAVYYCQQRSNWPLTFGGGTKVEIK

SEQ ID NO: 12 - protein, 107 aa, Artificial Sequence
  Description of Artificial Sequence Synthetic polypeptide
EIVLTQSPATLSLSPGERATLSCRASQSVSSYLAWYQQKPGQAPRLLIYDASNRATGIPARFSGSGSGTDFTLTISSLEPEDFAVYYCQQRRNWPLTFGGGTKVEIK

SEQ ID NO: 13 - protein, 107 aa, Artificial Sequence
  Description of Artificial Sequence Synthetic polypeptide
EIVLTQSPATLSLSPGERATLSCRASQSVSSYLAWYQQKPGQAPRLLIYDASNRATGIPARFSGSGSGTDFTLTISSLEPEDFAVYYCQQRGNWPLTFGGGTKVEIK

SEQ ID NO: 14 - protein, 107 aa, Artificial Sequence
  Description of Artificial Sequence Synthetic polypeptide
EIVLTQSPATLSLSPGERATLSCRASQSVSSYLAWYQQKPGQAPRLLIYDASNRATGIPARFSGSGSGTDFTLTISSLEPEDFAVYYCQQRYNWPLTFGGGTKVEIK

SEQ ID NO: 15 - protein, 107 aa, Artificial Sequence
  Description of Artificial Sequence Synthetic polypeptide
EIVLTQSPATLSLSPGERATLSCRASQSVSSYLAWYQQKPGQAPRLLIYDASNRATGIPARFSGSGSGTDFTLTISSLEPEDFAVYYCQQRENWPLTFGGGTKVEIK

SEQ ID NO: 16 - protein, 107 aa, Artificial Sequence
  Description of Artificial Sequence Synthetic polypeptide
EIVLTQSPATLSLSPGERATLSCRASQSVSSFLAWYQQKPGQAPRLLIYDASNRATGIPARFSGSGSGTDFTLTISSLEPEDFAVYYCQQRSNWPLTFGGGTKVEIK

SEQ ID NO: 17 - protein, 107 aa, Artificial Sequence
  Description of Artificial Sequence Synthetic polypeptide
EIVLTQSPATLSLSPGERATLSCRASQSVSSDLAWYQQKPGQAPRLLIYDASNRATGIPARFSGSGSGTDFTLTISSLEPEDFAVYYCQQRSNWPLTFGGGTKVEIK

SEQ ID NO: 18 - protein, 107 aa, Artificial Sequence
  Description of Artificial Sequence Synthetic polypeptide
EIVLTQSPATLSLSPGERATLSCRASQSVSSYLAWYQQKPGQAPRLLIYDASNRATGIPARFSGSGSGTDFTLTISSLEPEDFAVYYCQQRSGWPLTFGGGTKVEIK

SEQ ID NO: 19 - protein, 108 aa, Artificial Sequence
  Description of Artificial Sequence Synthetic polypeptide
EIVLTQSPGTLSLSPGERATLSCRASQSVSSSYLAWYQQKPGQAPRLLIYGASSRATGIPDRFSGSGSGTDFTLTISRLEPEDFAVYYCQQYGSSPFTFGPGTKVDIK

SEQ ID NO: 20 - protein, 108 aa, Artificial Sequence
  Description of Artificial Sequence Synthetic polypeptide
EIVLTQSPGTLSLSPGERATLSCRASQSVSRSYLAWYQQKPGQAPRLLIYGASSRATGIPDRFSGSGSGTDFTLTISRLEPEDFAVYYCQQYGSSPFTFGPGTKVDIK

SEQ ID NO: 21 - protein, 108 aa, Artificial Sequence
  Description of Artificial Sequence Synthetic polypeptide
EIVLTQSPGTLSLSPGERATLSCRASQSVSSRYLAWYQQKPGQAPRLLIYGASSRATGIPDRFSGSGSGTDFTLTISRLEPEDFAVYYCQQYGSSPFTFGPGTKVDIK

SEQ ID NO: 22 - protein, 108 aa, Artificial Sequence
  Description of Artificial Sequence Synthetic polypeptide
EIVLTQSPGTLSLSPGERATLSCRASQSVSSDYLAWYQQKPGQAPRLLIYGASSRATGIPDRFSGSGSGTDFTLTISRLEPEDFAVYYCQQYGSSPFTFGPGTKVDIK

SEQ ID NO: 23 - protein, 108 aa, Artificial Sequence
  Description of Artificial Sequence Synthetic polypeptide
EIVLTQSPGTLSLSPGERATLSCRASQSVSSSYLAWYQQKPGQAPRLLIYGASSRATGIPDRFSGSGSGTDFTLTISRLEPEDFAVYYCQQYESSPFTFGPGTKVDIK

SEQ ID NO: 24 - protein, 108 aa, Artificial Sequence
  Description of Artificial Sequence Synthetic polypeptide
EIVLTQSPGTLSLSPGERATLSCRASQSVSSSYLAWYQQKPGQAPRLLIYGASSRATGIPDRFSGSGSGTDFTLTISRLEPEDFAVYYCQQYRSSPFTFGPGTKVDIK

SEQ ID NO: 25 - protein, 108 aa, Artificial Sequence
  Description of Artificial Sequence Synthetic polypeptide
EIVLTQSPGTLSLSPGERATLSCRASQSVDSSYLAWYQQKPGQAPRLLIYGASSRATGIPDRFSGSGSGTDFTLTISRLEPEDFAVYYCQQYESSPFTFGPGTKVDIK

SEQ ID NO: 26 - protein, 108 aa, Artificial Sequence
  Description of Artificial Sequence Synthetic polypeptide
EIVLTQSPGTLSLSPGERATLSCRASQSVSSSYLAWYQQKPGQAPRLLIYGASSRATGIPDRFSGSGSGTDFTLTISRLEPEDFAVYYCQQYGRSPFTFGPGTKVDIK

SEQ ID NO: 27 - protein, 107 aa, Artificial Sequence
  Description of Artificial Sequence Synthetic polypeptide
EIVMTQSPATLSVSPGERATLSCRASQSVSSNLAWYQQKPGQAPRLLIYGASTRATGIPARFSGSGSGTEFTLTISSLQSEDFAVYYCQQYNNWPFTFGPGTKVDIK

SEQ ID NO: 28 - protein, 107 aa, Artificial Sequence
  Description of Artificial Sequence Synthetic polypeptide
DIQLTQSPSFLSASVGDRVTITCRASQGISSYLAWYQQKPGKAPKLLIYAASTLQSGVPSRFSGSGSGTEFTLTISSLQPEDFATYYCQQLNSYPITFGQGTRLEIK

SEQ ID NO: 29 - protein, 4 aa, Mus sp.
NWDY

SEQ ID NO: 30 - protein, 8 aa, Artificial Sequence
  Description of Artificial Sequence Synthetic peptide
TAVYYCAK

SEQ ID NO: 31 - protein, 22 aa, Artificial Sequence
  Description of Artificial Sequence Synthetic peptide
TAVYYCAKFQHWGQGTLVTVSS

SEQ ID NO: 32 - protein, 22 aa, Artificial Sequence
  Description of Artificial Sequence Synthetic peptide
TAVYYCAKFDLWGRGTLVTVSS

SEQ ID NO: 33 - protein, 22 aa, Artificial Sequence
  Description of Artificial Sequence Synthetic peptide
TAVYYCAKFDIWGQGTMVTVSS

SEQ ID NO: 34 - protein, 22 aa, Artificial Sequence
  Description of Artificial Sequence Synthetic peptide
TAVYYCAKFDYWGQGTLVTVSS

SEQ ID NO: 35 - protein, 22 aa, Artificial Sequence
  Description of Artificial Sequence Synthetic peptide
TAVYYCAKFDPWGQGTLVTVSS

SEQ ID NO: 36 - protein, 22 aa, Artificial Sequence
  Description of Artificial Sequence Synthetic peptide
TAVYYCAKMDVWGQGTTVTVSS

SEQ ID NO: 37 - protein, 22 aa, Artificial Sequence
  Description of Artificial Sequence Synthetic peptide
TAVYYCAKGTTWGQGTLVTVSS

SEQ ID NO: 38 - protein, 22 aa, Artificial Sequence
  Description of Artificial Sequence Synthetic peptide
TAVYYCAKTTGWGQGTLVTVSS

SEQ ID NO: 39 - protein, 22 aa, Artificial Sequence
  Description of Artificial Sequence Synthetic peptide
TAVYYCAKIFGWGRGTLVTVSS

SEQ ID NO: 40 - protein, 23 aa, Artificial Sequence
  Description of Artificial Sequence Synthetic peptide
TAVYYCAKYFQHWGQGTLVTVSS

SEQ ID NO: 41 - protein, 23 aa, Artificial Sequence
  Description of Artificial Sequence Synthetic peptide
TAVYYCAKYFDLWGRGTLVTVSS

SEQ ID NO: 42 - protein, 23 aa, Artificial Sequence
  Description of Artificial Sequence Synthetic peptide
TAVYYCAKAFDIWGQGTMVTVSS

SEQ ID NO: 43 - protein, 23 aa, Artificial Sequence
  Description of Artificial Sequence Synthetic peptide
TAVYYCAKYFDYWGQGTLVTVSS

SEQ ID NO: 44 - protein, 23 aa, Artificial Sequence
  Description of Artificial Sequence Synthetic peptide
TAVYYCAKWFDPWGQGTLVTVSS

SEQ ID NO: 45 - protein, 23 aa, Artificial Sequence
  Description of Artificial Sequence Synthetic peptide
TAVYYCAKGMDVWGQGTTVTVSS

SEQ ID NO: 46 - protein, 23 aa, Artificial Sequence
  Description of Artificial Sequence Synthetic peptide
TAVYYCAKLLWFWGRGTLVTVSS

SEQ ID NO: 47 - protein, 24 aa, Artificial Sequence
  Description of Artificial Sequence Synthetic peptide
TAVYYCAKEYFQHWGQGTLVTVSS

SEQ ID NO: 48 - protein, 24 aa, Artificial Sequence
  Description of Artificial Sequence Synthetic peptide
TAVYYCAKWYFDLWGRGTLVTVSS

SEQ ID NO: 49 - protein, 24 aa, Artificial Sequence
  Description of Artificial Sequence Synthetic peptide
TAVYYCAKYAFDIWGQGTMVTVSS

SEQ ID NO: 50 - protein, 24 aa, Artificial Sequence
  Description of Artificial Sequence Synthetic peptide
TAVYYCAKSYFDYWGQGTLVTVSS

SEQ ID NO: 51 - protein, 24 aa, Artificial Sequence
  Description of Artificial Sequence Synthetic peptide
TAVYYCAKNWFDPWGQGTLVTVSS

SEQ ID NO: 52 - protein, 24 aa, Artificial Sequence
  Description of Artificial Sequence Synthetic peptide
TAVYYCAKYGMDVWGQGTTVTVSS

SEQ ID NO: 53 - protein, 24 aa, Artificial Sequence
  Description of Artificial Sequence Synthetic peptide
TAVYYCAKDIVLMWGRGTLVTVSS

SEQ ID NO: 54 - protein, 27 aa, Artificial Sequence
  Description of Artificial Sequence Synthetic peptide
AEDTAVYYCAKDIVLMWGQGTTVTVSS

SEQ ID NO: 55 - DNA, 81 bp, Artificial Sequence
  Description of Artificial Sequence Synthetic oligonucleotide
gctgaggatactgcagtttattactgcgctaagnnnnnnnnnnnnnnntggggccagggtactacggtcaccgtctccagt

SEQ ID NO: 56 - protein, 42 aa, Artificial Sequence
  Description of Artificial Sequence Synthetic polypeptide
SRDNSKNTLYLQMNSLRAEDTAVYYCAXXXXWGQGTTVTVSS

SEQ ID NO: 57 - DNA, 135 bp, Artificial Sequence
  Description of Artificial Sequence Synthetic polynucleotide
ttcactatctctagagacaactctaagaatactctctacttgcagatgaacagcttaagggctgaggatactgcagtttattactgcgctargnnknnknnktggggccagggtactacggtcaccgtctccagt

SEQ ID NO: 58 - DNA, 48 bp, Artificial Sequence
  Description of Artificial Sequence Synthetic oligonucleotide
tgcagtttattactgcgctargnnknnknnktggggccagggtactac

SEQ ID NO: 59 - DNA, 33 bp, Artificial Sequence
  Description of Artificial Sequence Synthetic oligonucleotide
tggggccagggtactacggtcaccgtctccagt

SEQ ID NO: 60 - protein, 43 aa, Artificial Sequence
  Description of Artificial Sequence Synthetic polypeptide
SRDNSKNTLYLQMNSLRAEDTAVYYCAXXXXXWGQGTTVTVSS

SEQ ID NO: 61 - DNA, 138 bp, Artificial Sequence
  Description of Artificial Sequence Synthetic polynucleotide
ttcactatctctagagacaactctaagaatactctctacttgcagatgaacagcttaagggctgaggatactgcagtttattactgcgctargnnknnknnknnktggggccagggtactacggtcaccgtctccagt

SEQ ID NO: 62 - DNA, 50 bp, Artificial Sequence
  Description of Artificial Sequence Synthetic oligonucleotide
gcagtttattactgcgctargnnknnknnknnktggggccagggtactac

SEQ ID NO: 63 - protein, 44 aa, Artificial Sequence
  Description of Artificial Sequence Synthetic polypeptide
SRDNSKNTLYLQMNSLRAEDTAVYYCAXXXXXXWGQGTTVTVSS

SEQ ID NO: 64 - DNA, 141 bp, Artificial Sequence
  Description of Artificial Sequence Synthetic polynucleotide
ttcactatctctagagacaactctaagaatactctctacttgcagatgaacagcttaagggctgaggatactgcagtttattactgcgctargnnknnknnknnknnktggggccagggtactacggtcaccgtctccagt

SEQ ID NO: 65 - DNA, 53 bp, Artificial Sequence
  Description of Artificial Sequence Synthetic oligonucleotide
gcagtttattactgcgctargnnknnknnknnknnktggggccagggtactac

SEQ ID NO: 66 - protein, 17 aa, Homo sapiens
AEYFQHWGQGTLVTVSS

SEQ ID NO: 67 - protein, 17 aa, Homo sapiens
YWYFDLWGRGTLVTVSS

SEQ ID NO: 68 - protein, 16 aa, Homo sapiens
NWFDPWGQGTLVTVSS

SEQ ID NO: 69 - protein, 39 aa, Artificial Sequence
  Description of Artificial Sequence Synthetic polypeptide
YYCAXXXGYCSXXSCYTXXYSYAEYFQHWGQGTLVTVSS

SEQ ID NO: 70 - protein, 10 aa, Homo sapiens
GYCSSTSCYT

SEQ ID NO: 71 - protein, 62 aa, Artificial Sequence
  Description of Artificial Sequence Synthetic polypeptide
SRDNSKNTLYLQMNSLRAEDTAVYYCAXXXGYCSXXSCYTXXYSYAEYFQHWGQGTLVTVSS

SEQ ID NO: 72 - DNA, 195 bp, Artificial Sequence
  Description of Artificial Sequence Synthetic polynucleotide
ttcactatctctagagacaactctaagaatactctctacttgcagatgaacagcttaagggctgaggatactgcagtttattactgcgctargnnknnkggttattgttccnnknnktcttgctatactnnknnktattcctacgctgaatatttccagcactggggccagggtactctggtcaccgtctccagt

SEQ ID NO: 73 - DNA, 107 bp, Artificial Sequence
  Description of Artificial Sequence Synthetic polynucleotide
gcagtttattactgcgctargnnknnkggttattgttccnnknnktcttgctatactnnknnktattcctacgctgaatatttccagcactggggccagggtactct

SEQ ID NO: 74 - DNA, 18 bp, Artificial Sequence
  Description of Artificial Sequence Synthetic oligonucleotide
gcagtttattactgcgct

SEQ ID NO: 75 - DNA, 37 bp, Artificial Sequence
  Description of Artificial Sequence Synthetic oligonucleotide
agagtaccctggccccagacgtccataccgtaatagt

SEQ ID NO: 76 - DNA, 37 bp, Artificial Sequence
  Description of Artificial Sequence Synthetic oligonucleotide
actattacggtatggacgtctggggccagggtactct

SEQ ID NO: 77 - DNA, 90 bp, Artificial Sequence
  Description of Artificial Sequence Synthetic oligonucleotide
ttcactatctctagagacaactctaagaatactctctacttgcagatgaacagcttaagggctgaggatactgcagtttattactgcgct

SEQ ID NO: 78 - DNA, 33 bp, Artificial Sequence
  Description of Artificial Sequence Synthetic oligonucleotide
actggagacggtgaccagagtaccctggcccca

SEQ ID NO: 79 - DNA, 33 bp, Artificial Sequence
  Description of Artificial Sequence Synthetic oligonucleotide
tggggccagggtactctggtcaccgtctccagt

SEQ ID NO: 80 - protein, 39 aa, Artificial Sequence
  Description of Artificial Sequence Synthetic polypeptide
YYCAXXXYYYGXGSXYNXXSYYAEYFQHWGQGTLVTVSS

SEQ ID NO: 81 - protein, 10 aa, Homo sapiens
YYYGSGSYYN

SEQ ID NO: 82 - protein, 62 aa, Artificial Sequence
  Description of Artificial Sequence Synthetic polypeptide
SRDNSKNTLYLQMNSLRAEDTAVYYCAXXXYYYGXGSXYNXXSYYAEYFQHWGQGTLVTVSS

SEQ ID NO: 83 - DNA, 195 bp, Artificial Sequence
  Description of Artificial Sequence Synthetic polynucleotide
ttcactatctctagagacaactctaagaatactctctacttgcagatgaacagcttaagggctgaggatactgcagtttattactgcgctargnnknnktactactatggtnnkggctctnnktacaatnnknnktcttattacgctgagtactttcaacattggggccagggtactctggtcaccgtctccagt

SEQ ID NO: 84 - DNA, 107 bp, Artificial Sequence
  Description of Artificial Sequence Synthetic polynucleotide
gcagtttattactgcgctactccknnktactactatggtnnkggctctnnktacaatnnknnktcttattacgctgagtactttcaacattggggccagggtactct

SEQ ID NO: 85 - protein, 36 aa, Artificial Sequence
  Description of Artificial Sequence Synthetic polypeptide
AVYYCAXXXYXXGXGXXYNXXXYXAXXFQHWGQGTL

SEQ ID NO: 86 - DNA, 107 bp, Artificial Sequence
  Description of Artificial Sequence Synthetic polynucleotide
gcagtttattactgcgctargnnktmctactmctmtggttmcggctmtnnktacaattmtnnktmctattmcgctnnktmctttcaacattggggccagggtactct

SEQ ID NO: 87 - protein, 51 aa, Artificial Sequence
  Description of Artificial Sequence Synthetic polypeptide
YYCAXYYSXSYYXYXYDSXGYXYXYYSXYXYXXXAXXFQHWGQGTLVTVSS

SEQ ID NO: 88 - protein, 10 aa, Homo sapiens
YYYDSSGYYY

SEQ ID NO: 89 - protein, 74 aa, Artificial Sequence
  Description of Artificial Sequence Synthetic polypeptide
SRDNSKNTLYLQMNSLRAEDTAVYYCAXYYSXSYYXYXYDSXGYXYXYYSXYXYXXXAXXFQHWGQGTLVTVSS

SEQ ID NO: 90 - DNA, 231 bp, Artificial Sequence
  Description of Artificial Sequence Synthetic polynucleotide
ttcactatctctagagacaactctaagaatactctctacttgcagatgaacagcttaagggctgaggatactgcagtttattactgcgctargtactattccnnktcttactatnnktattmttacgatagttmtggttactmctatnnktactatagcnnktattmctactmctmttmcgcttmttmcttccaacactggggccagggtactctggtcaccgtctccagt

SEQ ID NO: 91 - DNA, 107 bp, Artificial Sequence; identical to SEQ ID NO: 84
  Description of Artificial Sequence Synthetic polynucleotide

SEQ ID NO: 92 - protein, 39 aa, Artificial Sequence
  Description of Artificial Sequence Synthetic polypeptide
YYCAXXXGXCXXXXCXTXXYXYXXYFQHWGQGTLVTVSS

SEQ ID NO: 93 - protein, 62 aa, Artificial Sequence
  Description of Artificial Sequence Synthetic polypeptide
SRDNSKNTLYLQMNSLRAEDTAVYYCAXXXGXCXXXXCXTXXYXYXXYFQHWGQGTLVTVSS

SEQ ID NO: 94 - DNA, 195 bp, Artificial Sequence
  Description of Artificial Sequence Synthetic polynucleotide
ttcactatctctagagacaactctaagaatactctctacttgcagatgaacagcttaagggctgaggatactgcagtttattactgcgctargtmctmtggttmttgctmctmtnnktmttgttmcaccnnknnktattmttacnnktmttatttccagcactggggccagggtactctggtcaccgtctccagt

SEQ ID NO: 95 - DNA, 107 bp, Artificial Sequence
  Description of Artificial Sequence Synthetic polynucleotide
gcagtttattactgcgctargtmctmtggttmttgctmctmtnnktmttgttmcaccnnknnktattmttacnnktmttatttccagcactggggccagggtactct

SEQ ID NO: 96 - protein, 51 aa, Artificial Sequence
  Description of Artificial Sequence Synthetic polypeptide
YYCAXXYXXYGXCXXXSCXTYXSXXXYSXYXSXYAEXFQHWGQGTLVTVSS

SEQ ID NO: 97 - protein, 74 aa, Artificial Sequence
  Description of Artificial Sequence Synthetic polypeptide
SRDNSKNTLYLQMNSLRAEDTAVYYCAXXYXXYGXCXXXSCXTYXSXXXYSXYXSXYAEYFQHWGQGTLVTVSS

SEQ ID NO: 98 - DNA, 231 bp, Artificial Sequence
  Description of Artificial Sequence Synthetic polynucleotide
ttcactatctctagagacaactctaagaatactctctacttgcagatgaacagcttaagggctgaggatactgcagtttattactgcgctargtmttacnnktmctacggctmttgctmttmcnnktcttgttmcacctattmttcctmtnnktmctattctnnktactmcagttmttatgctgagtatttccagcactggggccagggtactctggtcaccgtctccagt

SEQ ID NO: 99 - DNA, 143 bp, Artificial Sequence
  Description of Artificial Sequence Synthetic polynucleotide
gcagtttattactgcgctargtmttacnnktmctacggctattgctmttmcnnktmttgttmcacctattmttcctmtnnktmctattctnnktactmcagttmttatgctgagtatttccagcactggggccagggtactct

SEQ ID NO: 100 - protein, 51 aa, Artificial Sequence
  Description of Artificial Sequence Synthetic polypeptide
YYCAXXYXXYGXCXXXXCXTYXSXXXYSXYXSXYAXXXQXWGQGTLVTVSS

SEQ ID NO: 101 - protein, 74 aa, Artificial Sequence
  Description of Artificial Sequence Synthetic polypeptide
SRDNSKNTLYLQMNSLRAEDTAVYYCAXXYXXYGXCXXXXCXTYXSXXXYSXYXSXYAXXXQXWGQGTLVTVSS

SEQ ID NO: 102 - DNA, 231 bp, Artificial Sequence
  Description of Artificial Sequence Synthetic polynucleotide
ttcactatctctagagacaactctaagaatactctctacttgcagatgaacagcttaagggctgaggatactgcagtttattactgcgctargtmttactmctmctacggctmttgctmttmcnnktmttgttmcacctattmttcctmtnnktmctattcttmttactmcagttmttatgctvagtmtthccagnactggggccagggtactctggtcaccgtctccagt

SEQ ID NO: 103 - protein, 50 aa, Artificial Sequence
  Description of Artificial Sequence Synthetic polypeptide
YYCAXXXXYXXXVWGXXRXTXSXXXYXXXYXSXAXXFQHWGQGTLVTVSS

SEQ ID NO: 104 - protein, 12 aa, Homo sapiens
YYDYVWGSYRYT

SEQ ID NO: 105 - protein, 73 aa, Artificial Sequence
  Description of Artificial Sequence Synthetic polypeptide
SRDNSKNTLYLQMNSLRAEDTAVYYCAXXXXYXXXVWGXXRXTXSXXXYXXXYXSXAXXFQHWGQGTLVTVSS

SEQ ID NO: 106 - DNA, 228 bp, Artificial Sequence
  Description of Artificial Sequence Synthetic polynucleotide
ttcactatctctagagacaactctaagaatactctctacttgcagatgaacagcttaagggctgaggatactgcagtttattactgcgctargtmtnnktmctactmtnattmtgtttggggttmttmccgttmtacttmtagttmtnnktmttactmctmttmctattmcagttmtgctvagtmcttccagcattggggccagggtactctggtcaccgtctccagt

SEQ ID NO: 107 - DNA, 140 bp, Artificial Sequence
  Description of Artificial Sequence Synthetic polynucleotide
gcagtttattactgcgctargtmtnnktmctactmtnattmtgtttggggttmttmccgttmtacttmtagtactccktmttactmctmttmctattmcagttmtgctvagtmcttccagcattggggccagggtactct

SEQ ID NO: 108 - protein, 50 aa, Artificial Sequence
  Description of Artificial Sequence Synthetic polypeptide
YYCAXXXXXXXXYXXXYXXXVWGXXRXTYXSXYAXXFQHWGQGTLVTVSS

SEQ ID NO: 109 - protein, 73 aa, Artificial Sequence
  Description of Artificial Sequence Synthetic polypeptide
SRDNSKNTLYLQMNSLRAEDTAVYYCAXXXXXXXXYXXXYXXXVWGXXRXTYXSXYAXXFQHWGQGTLVTVSS

SEQ ID NO: 110 - DNA, 228 bp, Artificial Sequence
  Description of Artificial Sequence Synthetic polynucleotide
ttcactatctctagagacaactctaagaatactctctacttgcagatgaacagcttaagggctgaggatactgcagtttattactgcgctargtmtnnktmctmttmcnnktmttactmctmttmctactmtnattmtgtttggggttmttmccgttmtacttattmcagttmttacgctvagtmcttccagcattggggccagggtactctggtcaccgtctccagt

SEQ ID NO: 111 - DNA, 140 bp, Artificial Sequence
  Description of Artificial Sequence Synthetic polynucleotide
gcagtttattactgcgctargtmtnnktmctmtactccktmttactmctmttmctactmtnattmtgtttggggttmttmccgttmtacttattmcagttmttacgctvagtmcttccagcattggggccagggtactct

SEQ ID NO: 112 - protein, 40 aa, Artificial Sequence
  Description of Artificial Sequence Synthetic polypeptide
YYCAXXXXYXXGXGXXYNXXXYXAXXFQHWGQGTLVTVSS

SEQ ID NO: 113 - DNA, 110 bp, Artificial Sequence
  Description of Artificial Sequence Synthetic polynucleotide
gcagtttattactgcgctargactccctmctactmctmtggttmcggctmtnnktacaattmtnnktmctattmcgctnnktmctttcaacattggggccagggtactct

SEQ ID NO: 114 - protein, 39 aa, Artificial Sequence
  Description of Artificial Sequence Synthetic polypeptide
YYCAXXXXXGXCXXGVCXXXXXXXXXXLWGRGTLVTVSS

SEQ ID NO: 115 - protein, 10 aa, Homo sapiens
GYCTNGVCYT

SEQ ID NO: 116 - DNA, 107 bp, Artificial Sequence
  Description of Artificial Sequence Synthetic polynucleotide
gcagtttattactgcgctargtmctmtnnktmtggttmctgtananatggtgtctgctmtanatmcnnktmttmttbgtmtthtnatctgtggggccagggtactct

SEQ ID NO: 117 - DNA, 107 bp, Artificial Sequence
  Description of Artificial Sequence Synthetic polynucleotide
gcagtttattactgcgctargtmctmtnnktmcggttmctgcananatggcgtctgctmtanatmcnnktmttmttbgtmtthtnatctgtggggccagggtactct

SEQ ID NO: 118 - DNA, 58 bp, Artificial Sequence
  Description of Artificial Sequence Synthetic oligonucleotide
gcagtttattactgcgctargtmctmtnnktmcggttmctgcananatggcgtctgct

SEQ ID NO: 119 - DNA, 75 bp, Artificial Sequence
  Description of Artificial Sequence Synthetic oligonucleotide
agagtaccctggccccacagatnadaakacvaakaakamnngkatntakagcagacgccatntntgcagkaaccg

SEQ ID NO: 120 - DNA, 75 bp, Artificial Sequence
  Description of Artificial Sequence Synthetic oligonucleotide
cggttmctgcananatggcgtctgctmtanatmcnnktmttmttbgtmtthtnatctgtggggccagggtactct

SEQ ID NO: 121 - protein, 49 aa, Artificial Sequence
  Description of Artificial Sequence Synthetic polypeptide
YYCAXXXXXXXGXCXXGVCXXXXXXYXXYXYXXXXXXLWGRGTLVTVSS

SEQ ID NO: 122 - DNA, 137 bp, Artificial Sequence
  Description of Artificial Sequence Synthetic polynucleotide
gcagtttattactgcgctargtmttmctmctmttmctmcggttmttgtananatggcgtgtgctmtanatmctmctmctmttattmttmctattmttactmttmctbgtmcthtnatctgtggggccagggtactct

SEQ ID NO: 123 - protein, 50 aa, Artificial Sequence
  Description of Artificial Sequence Synthetic polypeptide
YYCAXXXXXXXXXXXGYCTNGVCYTXXXXXXXXXWXFXLWGRGTLVTVSS

SEQ ID NO: 124 - DNA, 81 bp, Artificial Sequence
  Description of Artificial Sequence Synthetic oligonucleotide
gcagtttattactgcgctargtmttmctmctmttmttmctmctmttmctmcggttattgtactaacggcgtttgctatact

SEQ ID NO: 125 - DNA, 86 bp, Artificial Sequence
  Description of Artificial Sequence Synthetic oligonucleotide
agagtaccctggccccacaggtngaaakaccaakaakaakagkagkagkagkaakaakaagtatagcaaacgccgttagtacaata

SEQ ID NO: 126 - DNA, 86 bp, Artificial Sequence
  Description of Artificial Sequence Synthetic oligonucleotide
tattgtactaacggcgtttgctatacttmttmttmctmctmctmctmttmttmttggtmtttcnacctgtggggccagggtactct

SEQ ID NO: 127 - protein, 50 aa, Artificial Sequence
  Description of Artificial Sequence Synthetic polypeptide
YYCAXXXXXXXXXXXXDYVWGSYRXTXXXXXXXAEXFQHWGQGTLVTVSS

SEQ ID NO: 128 - DNA, 78 bp, Artificial Sequence
  Description of Artificial Sequence Synthetic oligonucleotide
gcagtttattactgcgctargtmttmctmctmttmttmctmctmttmctmctmcgattatgtctggggtacttatcgt

SEQ ID NO: 129 - DNA, 86 bp, Artificial Sequence
  Description of Artificial Sequence Synthetic oligonucleotide
agagtaccctggccccaatgctggaaakactcagcgkagkagkagkagkagkaakaagtgkaacgataagtaccccagacataatc

SEQ ID NO: 130 - DNA, 86 bp, Artificial Sequence
  Description of Artificial Sequence Synthetic oligonucleotide
gattatgtctggggtacttatcgttmcacttmttmctmctmctmctmctmcgctgagtmtttccagcattggggccagggtactct

SEQ ID NO: 131 - protein, 51 aa, Artificial Sequence
  Description of Artificial Sequence Synthetic polypeptide
YYCAKXXXXXXXXXXXDXVWGXXRXTXXXXXXXXAEXFQHWGQGTLVTVSS

SEQ ID NO: 132 - DNA, 85 bp, Artificial Sequence
  Description of Artificial Sequence Synthetic oligonucleotide
gcagtttattactgcgctargtmttmctmctmttmttmctmctmttmctmctmcgactmtgtctggggttmctmccgttmcacct

SEQ ID NO: 133 - DNA, 93 bp, Artificial Sequence
  Description of Artificial Sequence Synthetic oligonucleotide
agagtaccctggccccaatgctggaaakactcagcgkagkagkagkagkagkagkaakaggtgkaacggkagkaaccccagacakagtcgkag

SEQ ID NO: 134 - DNA, 93 bp, Artificial Sequence
  Description of Artificial Sequence Synthetic oligonucleotide
ctmcgactmtgtctggggttmctmccgttmcacctmttmctmctmctmctmctmctmcgctgagtmtttccagcattggggccagggtactct

SEQ ID NO: 135 - protein, 51 aa, Artificial Sequence
  Description of Artificial Sequence Synthetic polypeptide
YYCAXXXXXXXXXXXGXCXGGXCXSXXXXXXXXXAEXFQHWGQGTLVTVSS

SEQ ID NO: 136 - protein, 10 aa, Homo sapiens
GYCSGGSCYS

SEQ ID NO: 137 - DNA, 82 bp, Artificial Sequence
  Description of Artificial Sequence Synthetic oligonucleotide
gcagtttattactgcgctargtmttmttmttmttmttmttmttmttmctmcggctmctgttmcggtggctmctgctmctcct

SEQ ID NO: 138 - DNA, 96 bp, Artificial Sequence
  Description of Artificial Sequence Synthetic oligonucleotide
agagtaccctggccccaatgttggaaakattcagcgkagkagkagkagkagkagkagkagkagkaggagcagkagccaccgkaacagkagccgkag

SEQ ID NO: 139 - DNA, 79 bp, Artificial Sequence
  Description of Artificial Sequence Synthetic oligonucleotide
gcagtttattactgcgctargtmttmttmttmttmttmttmttmctmcggctmctgttmcggtggctmctgctmctcct

SEQ ID NO: 140 - DNA, 93 bp, Artificial Sequence
  Description of Artificial Sequence Synthetic oligonucleotide
agagtaccctggccccaatgttggaaakattcagcgkagkagkagkagkagkagkagkagkaggagcagkagccaccgkaacagkagccgkag

SEQ ID NO: 141 - protein, 50 aa, Artificial Sequence
  Description of Artificial Sequence Synthetic polypeptide
YYCAXXXXXXXXDXVWGXXRXTXXXXXXXXXXXAEXFQHWGQGTLVTVSS

SEQ ID NO: 142 - DNA, 73 bp, Artificial Sequence
  Description of Artificial Sequence Synthetic oligonucleotide
gcagtttattactgcgctargtmttmttmttmttmttmttmcgactmcgtctggggttmttmccgttmtacct

SEQ ID NO: 143 - DNA, 105 bp, Artificial Sequence
  Description of Artificial Sequence Synthetic polynucleotide
agagtaccctggccccagtgctggaagkactcagcgkagkagkagkagkagkagkagkagkagkagkagkagkaggtakaacggkaakaaccccagacgkagtcg

SEQ ID NO: 144 - protein, 50 aa, Artificial Sequence
  Description of Artificial Sequence Synthetic polypeptide
YYCAXXXXXXXXXXXDXVWGXXRXTXXXXXXXXAEXFQHWGQGTLVTVSS

SEQ ID NO: 145 - DNA, 82 bp, Artificial Sequence
  Description of Artificial Sequence Synthetic oligonucleotide
gcagtttattactgcgctargtmttmttmttmttmttmttmctmctmctmcgactmcgtctggggttmctmccgttmcacct

SEQ ID NO: 146 - DNA, 96 bp, Artificial Sequence
  Description of Artificial Sequence Synthetic oligonucleotide
agagtaccctggccccagtgctggaagkactcagcgkagkagkagkagkagkagkagkagkagkaggtgkaacggkagkaaccccagacgkagtcg

SEQ ID NO: 147 - protein, 51 aa, Artificial Sequence
  Description of Artificial Sequence Synthetic polypeptide
YYCAXXXXXXXXXXXXDSSGXXXXXXXXXXXXXXAEXFQHWGQGTLVTVSS

SEQ ID NO: 148 - protein, 74 aa, Artificial Sequence
  Description of Artificial Sequence Synthetic polypeptide
SRDNSKNTLYLQMNSLRAEDTAVYYCAXXXXXXXXXXXXDSSGXXXXXXXXXXXXXXAEXFQHWGQGTLVTVSS

SEQ ID NO: 149 - DNA, 231 bp, Artificial Sequence
  Description of Artificial Sequence Synthetic polynucleotide
ttcactatctctagagacaactctaagaatactctctacttgcagatgaacagcttaagggctgaggatactgcagtttattactgcgctargtmctmttmctmctmttmctmttmctmctmctmcgacagctccggctmctmctmttmctmttmctmctmttmctmttmctmctmctmcgctgaatmcttccaacactggggccagggtactctggtcaccgtctccagt

SEQ ID NO: 150 - DNA, 73 bp, Artificial Sequence
  Description of Artificial Sequence Synthetic oligonucleotide
gcagtttattactgcgctargtmctmttmctmctmttmctmttmctmctmctmcgacagctccggctmctmct

SEQ ID NO: 151 - DNA, 97 bp, Artificial Sequence
  Description of Artificial Sequence Synthetic oligonucleotide
cagagtaccctggccccagtgttggaagkattcagcgkagkagkagkaakagkaakagkagkaakagkaakagkagkagccggagctgtcgkagkag

SEQ ID NO: 152 - protein, 51 aa, Artificial Sequence; identical to SEQ ID NO: 147
  Description of Artificial Sequence Synthetic polypeptide

SEQ ID NO: 153 - DNA, 73 bp, Artificial Sequence; identical to SEQ ID NO: 150
  Description of Artificial Sequence Synthetic oligonucleotide

SEQ ID NO: 154 - DNA, 70 bp, Artificial Sequence
  Description of Artificial Sequence Synthetic oligonucleotide
gcagtttattactgcgctargtmctmctmctmttmctmttmctmctmctmcgacagctccggctmctmct

SEQ ID NO: 155 - DNA, 94 bp, Artificial Sequence
  Description of Artificial Sequence Synthetic oligonucleotide
cagagtaccctggccccagtgttggaagkattcagcgkagkagkagkaakagkaakagkagkaakaakagkagkagccggagctgtcgkagkag

SEQ ID NO: 156 - protein, 5 aa, Homo sapiens
GTTGT

SEQ ID NO: 157 - protein, 5 aa, Homo sapiens
VQLER

SEQ ID NO: 158 - protein, 5 aa, Homo sapiens
YNWND

SEQ ID NO: 159 - protein, 5 aa, Homo sapiens
GITGT

SEQ ID NO: 160 - protein, 3 aa, Homo sapiens
LEL

SEQ ID NO: 161 - protein, 5 aa, Homo sapiens
YNWNY

SEQ ID NO: 162 - protein, 3 aa, Homo sapiens
LER

SEQ ID NO: 163 - protein, 5 aa, Homo sapiens
YNWND

SEQ ID NO: 164 - protein, 6 aa, Homo sapiens
GIVGAT

SEQ ID NO: 165 - protein, 4 aa, Homo sapiens
WELL

SEQ ID NO: 166 - protein, 6 aa, Homo sapiens
YSGSYY

SEQ ID NO: 167 - protein, 5 aa, Homo sapiens
YQLLY

SEQ ID NO: 168 - protein, 9 aa, Homo sapiens
DIVVVPAAI

SEQ ID NO: 169 - protein, 4 aa, Homo sapiens
RILY

SEQ ID NO: 170 - protein, 9 aa, Homo sapiens
DIVLMVYAI

SEQ ID NO: 171 - protein, 3 aa, Homo sapiens
RIL

SEQ ID NO: 172 - protein, 9 aa, Homo sapiens
DIVVVVAAT

SEQ ID NO: 173 - protein, 5 aa, Homo sapiens
SILWW

SEQ ID NO: 174 - protein, 9 aa, Homo sapiens
AYCGGDCYS

SEQ ID NO: 175 - protein, 8 aa, Homo sapiens
HIVVVTAI

SEQ ID NO: 176 - protein, 10 aa, Homo sapiens
VLRFLEWLLY

SEQ ID NO: 177 - protein, 10 aa, Homo sapiens
YYDFWSGYYT

SEQ ID NO: 178 - protein, 9 aa, Homo sapiens
ITIFGVVII

SEQ ID NO: 179 - protein, 9 aa, Homo sapiens
VLRYFDWLL

SEQ ID NO: 180 - protein, 10 aa, Homo sapiens
YYDILTGYYN

SEQ ID NO: 181 - protein, 4 aa, Homo sapiens
ITIF

SEQ ID NO: 182 - protein, 9 aa, Homo sapiens
VLLWFGELL

SEQ ID NO: 183 - protein, 9 aa, Homo sapiens
ITMVRGVII

SEQ ID NO: 184 - protein, 9 aa, Homo sapiens
LRLGELSLY

SEQ ID NO: 185 - protein, 11 aa, Homo sapiens
IMITFGGVIVI

SEQ ID NO: 186 - protein, 4 aa, Homo sapiens
WLLL

SEQ ID NO: 187 - protein, 10 aa, Homo sapiens
YYYDSSGYYY

SEQ ID NO: 188 - protein, 9 aa, Homo sapiens
ITMIVVVIT

SEQ ID NO: 189 - protein, 2 aa, Homo sapiens
LQ

SEQ ID NO: 190 - protein, 4 aa, Homo sapiens
TTVT

SEQ ID NO: 191 - protein, 2 aa, Homo sapiens
LQ

SEQ ID NO: 192 - protein, 5 aa, Homo sapiens
DYSNY

SEQ ID NO: 193 - protein, 4 aa, Homo sapiens
TTVT

SEQ ID NO: 194 - protein, 2 aa, Homo sapiens
LR

SEQ ID NO: 195 - protein, 5 aa, Homo sapiens
DYGDY

SEQ ID NO: 196 - protein, 4 aa, Homo sapiens
TTVT

SEQ ID NO: 197 - protein, 3 aa, Homo sapiens
LRW

SEQ ID NO: 198 - protein, 6 aa, Homo sapiens
DYGGNS

SEQ ID NO: 199 - protein, 5 aa, Homo sapiens
TTVVT

SEQ ID NO: 200 - protein, 6 aa, Artificial Sequence
  Description of Artificial Sequence Synthetic peptide
QGFLPR

SEQ ID NO: 201 - protein, 6 aa, Artificial Sequence
  Description of Artificial Sequence Synthetic peptide
KGFCPD

SEQ ID NO: 202 - protein, 6 aa, Artificial Sequence
  Description of Artificial Sequence Synthetic peptide
RVSAQT

SEQ ID NO: 203 - protein, 7 aa, Homo sapiens
VDIVATI

SEQ ID NO: 204 - protein, 4 aa, Homo sapiens
WLRL

SEQ ID NO: 205 - protein, 7 aa, Homo sapiens
GYSGYDY

SEQ ID NO: 206 - protein, 6 aa, Homo sapiens
VDTAMV

SEQ ID NO: 207 - protein, 6 aa, Homo sapiens
WIQLWL

SEQ ID NO: 208 - protein, 6 aa, Homo sapiens
GYSYGY

SEQ ID NO: 209 - protein, 6 aa, Homo sapiens
VEMATI

SEQ ID NO: 210 - protein, 5 aa, Homo sapiens
RWLQL

SEQ ID NO: 211 - protein, 6 aa, Homo sapiens
RDGYNY

SEQ ID NO: 212 - protein, 6 aa, Homo sapiens
EYSSSS

SEQ ID NO: 213 - protein, 5 aa, Homo sapiens
SIAAR

SEQ ID NO: 214 - protein, 3 aa, Homo sapiens
QLV

SEQ ID NO: 215 - protein, 7 aa, Homo sapiens
GYSSSWY

SEQ ID NO: 216 - protein, 6 aa, Homo sapiens
GIAAAG

SEQ ID NO: 217 - protein, 4 aa, Homo sapiens
QQLV

SEQ ID NO: 218 - protein, 7 aa, Homo sapiens
GYSSGWY

SEQ ID NO: 219 - protein, 6 aa, Homo sapiens
GIAVAG

SEQ ID NO: 220 - protein, 4 aa, Homo sapiens
QWLV

SEQ ID NO: 221 - protein, 3 aa, Homo sapiens
LTG

SEQ ID NO: 222 - protein, 2 aa, Homo sapiens
LG

SEQ ID NO: 223 - protein, 3 aa, Homo sapiens
NWG

SEQ ID NO: 224 - DNA, 107 bp, Artificial Sequence
  Description of Artificial Sequence Synthetic polynucleotide
gcagtttattactgcgctaagtccggtggttattgttccagttcttcttgctatacttatggttattcctacgctgaatatttccagcactggggccagggtactct

SEQ ID NO: 225 - protein, 7 aa, Artificial Sequence
  Description of Artificial Sequence Synthetic polypeptide
AASSLQS

SEQ ID NO: 226 - protein, 22 aa, Artificial Sequence
  Description of Artificial Sequence Synthetic peptide
YYCAKAEYFQHWGQGTLVTVSS

SEQ ID NO: 227 - protein, 22 aa, Artificial Sequence
  Description of Artificial Sequence Synthetic peptide
YYCAKYDYGDYWGQGTLVTVSS

SEQ ID NO: 228 - protein, 22 aa, Artificial Sequence
  Description of Artificial Sequence Synthetic peptide
YYCAKGYSYGYWGQGTLVTVSS

SEQ ID NO: 229 - protein, 22 aa, Artificial Sequence
  Description of Artificial Sequence Synthetic peptide
YYCAKSYYFDYWGQGTLVTVSS

SEQ ID NO: 230 - protein, 24 aa, Artificial Sequence
  Description of Artificial Sequence Synthetic peptide
YYCAKYYAEYFQHWGQGTLVTVSS

SEQ ID NO: 231 - protein, 24 aa, Artificial Sequence
  Description of Artificial Sequence Synthetic peptide
YYCAKYGYSSSWYWGQGTLVTVSS

SEQ ID NO: 232 - protein, 24 aa, Artificial Sequence
  Description of Artificial Sequence Synthetic peptide
YYCAKYGDYYFDYWGQGTLVTVSS

SEQ ID NO: 233 - protein, 26 aa, Artificial Sequence
  Description of Artificial Sequence Synthetic peptide
YYCAKYYYDSSGYYYWGQGTLVTVSS

SEQ ID NO: 234 - protein, 26 aa, Artificial Sequence
  Description of Artificial Sequence Synthetic peptide
YYCAKGYCSSTSCYTWGQGTLVTVSS

SEQ ID NO: 235 - protein, 26 aa, Artificial Sequence
  Description of Artificial Sequence Synthetic peptide
YYCAKYYSSAEYFQHWGQGTLVTVSS

SEQ ID NO: 236 - protein, 26 aa, Artificial Sequence
  Description of Artificial Sequence Synthetic peptide
YYCAKGYSYGYYFDYWGQGTLVTVSS

SEQ ID NO: 237 - protein, 28 aa, Artificial Sequence
  Description of Artificial Sequence Synthetic peptide
YYCAKYYYDSSGYYYQHWGQGTLVTVSS

SEQ ID NO: 238 - protein, 28 aa, Artificial Sequence
  Description of Artificial Sequence Synthetic peptide
YYCAKGYCSSTSCYTQHWGQGTLVTVSS

SEQ ID NO: 239 - protein, 28 aa, Artificial Sequence
  Description of Artificial Sequence Synthetic peptide
YYCAKYYSSYSAEYFQHWGQGTLVTVSS

SEQ ID NO: 240 - protein, 28 aa, Artificial Sequence
  Description of Artificial Sequence Synthetic peptide
YYCAKYYDYVWGSYRYTWGQGTLVTVSS

SEQ ID NO: 241 - protein, 28 aa, Artificial Sequence
  Description of Artificial Sequence Synthetic peptide
YYCAKGYSYGYYWYFDLWGRGTLVTVSS

SEQ ID NO: 242 - protein, 30 aa, Artificial Sequence
  Description of Artificial Sequence Synthetic polypeptide
YYCAKYYYDSSGYYYYFQHWGQGTLVTVSS

SEQ ID NO: 243 - protein, 30 aa, Artificial Sequence
  Description of Artificial Sequence Synthetic polypeptide
YYCAKGYCSSTSCYTYFQHWGQGTLVTVSS

SEQ ID NO: 244 - protein, 30 aa, Artificial Sequence
  Description of Artificial Sequence Synthetic polypeptide
YYCAKSYGYCSSTSCYTQHWGQGTLVTVSS

SEQ ID NO: 245 - protein, 30 aa, Artificial Sequence
  Description of Artificial Sequence Synthetic polypeptide
YYCAKSYYYSSYSAEYFQHWGQGTLVTVSS

SEQ ID NO: 246 - protein, 30 aa, Artificial Sequence
  Description of Artificial Sequence Synthetic polypeptide
YYCAKAYCGGDCYSNWFDPWGQGTLVTVSS

SEQ ID NO: 247 - protein, 32 aa, Artificial Sequence
  Description of Artificial Sequence Synthetic polypeptide
YYCAKYYYDSSGYYYAEYFQHWGQGTLVTVSS

SEQ ID NO: 248 - protein, 32 aa, Artificial Sequence
  Description of Artificial Sequence Synthetic polypeptide
YYCAKGYCSSTSCYTAEYFQHWGQGTLVTVSS

SEQ ID NO: 249 - protein, 32 aa, Artificial Sequence
  Description of Artificial Sequence Synthetic polypeptide
YYCAKSYYSYSSYYSAEYFQHWGQGTLVTVSS

SEQ ID NO: 250 - protein, 32 aa, Artificial Sequence
  Description of Artificial Sequence Synthetic polypeptide
YYCAKSYSYGYCSSTSCYTQHWGQGTLVTVSS

SEQ ID NO: 251 - protein, 36 aa, Artificial Sequence
  Description of Artificial Sequence Synthetic polypeptide
YYCAKYSSYYYYDSSGYYYAEYFQHWGQGTLVTVSS

SEQ ID NO: 252 - protein, 36 aa, Artificial Sequence
  Description of Artificial Sequence Synthetic polypeptide
YYCAKSYYSGYCSSTSCYTAEYFQHWGQGTLVTVSS

SEQ ID NO: 253 - protein, 36 aa, Artificial Sequence
  Description of Artificial Sequence Synthetic polypeptide
YYCAKSGYCSSTSCYTYYSAEYFQHWGQGTLVTVSS

SEQ ID NO: 254 - protein, 36 aa, Artificial Sequence
  Description of Artificial Sequence Synthetic polypeptide
YYCAKYYYYDYVWGSYRYTSNWFDPWGQGTLVTVSS

SEQ ID NO: 255 - protein, 36 aa, Artificial Sequence
  Description of Artificial Sequence Synthetic polypeptide
YYCAKYYYYDYVWGSYRYTSSYFDYWGQGTLVTVSS

SEQ ID NO: 256 - DNA, 33 bp, Artificial Sequence
  Description of Artificial Sequence Synthetic oligonucleotide
actggagacggtgaccgtagtaccctggcccca

SEQ ID NO: 257 - protein, 4 aa, Homo sapiens
GTTG

SEQ ID NO: 258 - protein, 4 aa, Homo sapiens
VQLE

SEQ ID NO: 259 - protein, 4 aa, Homo sapiens
YNWN

SEQ ID NO: 260 - protein, 5 aa, Homo sapiens
GTTGT

SEQ ID NO: 261 - protein, 5 aa, Homo sapiens
VQLER

SEQ ID NO: 262 - protein, 5 aa, Homo sapiens
YNWND

SEQ ID NO: 263 - protein, 4 aa, Homo sapiens
TTGT

SEQ ID NO: 264 - protein, 4 aa, Homo sapiens
QLER

SEQ ID NO: 265 - protein, 4 aa, Homo sapiens
NWND

SEQ ID NO: 266 - protein, 4 aa, Homo sapiens
GITG

SEQ ID NO: 267 - protein, 4 aa, Homo sapiens
VYLE

SEQ ID NO: 268 - protein, 5 aa, Homo sapiens
GITGT

SEQ ID NO: 269 - protein, 5 aa, Homo sapiens
VYLEL

SEQ ID NO: 270 - protein, 5 aa, Homo sapiens
YNWNY

SEQ ID NO: 271 - protein, 4 aa, Homo sapiens
ITGT

SEQ ID NO: 272 - protein, 4 aa, Homo sapiens
YLEL

SEQ ID NO: 273 - protein, 4 aa, Homo sapiens
NWNY

SEQ ID NO: 274 - protein, 5 aa, Homo sapiens
VYLER

SEQ ID NO: 275 - protein, 4 aa, Homo sapiens
YLER

SEQ ID NO: 276 - protein, 4 aa, Homo sapiens
GIVG

SEQ ID NO: 277 - protein, 4 aa, Homo sapiens
VYWE

SEQ ID NO: 278 - protein, 4 aa, Homo sapiens
YSGS

SEQ ID NO: 279 - protein, 5 aa, Homo sapiens
GIVGA

SEQ ID NO: 280 - protein, 5 aa, Homo sapiens
VYWEL

SEQ ID NO: 281 - protein, 5 aa, Homo sapiens
YSGSY

SEQ ID NO: 282 - protein, 6 aa, Homo sapiens
GIVGAT

SEQ ID NO: 283 - protein, 6 aa, Homo sapiens
VYWELL

SEQ ID NO: 284 - protein, 6 aa, Homo sapiens
YSGSYY

SEQ ID NO: 285 - protein, 4 aa, Homo sapiens
IVGA

SEQ ID NO: 286 - protein, 4 aa, Homo sapiens
YWEL

SEQ ID NO: 287 - protein, 4 aa, Homo sapiens
SGSY

SEQ ID NO: 288 - protein, 5 aa, Homo sapiens
IVGAT

SEQ ID NO: 289 - protein, 5 aa, Homo sapiens
YWELL

SEQ ID NO: 290 - protein, 5 aa, Homo sapiens
SGSYY

SEQ ID NO: 291 - protein, 4 aa, Homo sapiens
VGAT

SEQ ID NO: 292 - protein, 4 aa, Homo sapiens
WELL

SEQ ID NO: 293 - protein, 4 aa, Homo sapiens
GSYY

SEQ ID NO: 294 - protein, 4 aa, Homo sapiens
RILY

SEQ ID NO: 295 - protein, 4 aa, Homo sapiens
GYCS

SEQ ID NO: 296 - protein, 4 aa, Homo sapiens
DIVV

SEQ ID NO: 297 - protein, 5 aa, Homo sapiens
RILYY

SEQ ID NO: 298 - protein, 5 aa, Homo sapiens
GYCSS

SEQ ID NO: 299 - protein, 5 aa, Homo sapiens
DIVVV

SEQ ID NO: 300 - protein, 6 aa, Homo sapiens
RILYYY

SEQ ID NO: 301 - protein, 6 aa, Homo sapiens
GYCSST

SEQ ID NO: 302 - protein, 6 aa, Homo sapiens
DIVVVP

SEQ ID NO: 303 - protein, 4 aa, Homo sapiens
ILYY

SEQ ID NO: 304 - protein, 4 aa, Homo sapiens
YCSS

SEQ ID NO: 305 - protein, 4 aa, Homo sapiens
IVVV

SEQ ID NO: 306 - protein, 5 aa, Homo sapiens
ILYYY

SEQ ID NO: 307 - protein, 5 aa, Homo sapiens
YCSST

SEQ ID NO: 308 - protein, 5 aa, Homo sapiens
IVVVP

SEQ ID NO: 309 - protein, 6 aa, Homo sapiens
ILYYYQ

SEQ ID NO: 310 - protein, 6 aa, Homo sapiens
YCSSTS

SEQ ID NO: 311 - protein, 6 aa, Homo sapiens
IVVVPA

SEQ ID NO: 312 - protein, 4 aa, Homo sapiens
LYYY

SEQ ID NO: 313 - protein, 4 aa, Homo sapiens
CSST

SEQ ID NO: 314 - protein, 4 aa, Homo sapiens
VVVP

SEQ ID NO: 315 - protein, 5 aa, Homo sapiens
LYYYQ

SEQ ID NO: 316 - protein, 5 aa, Homo sapiens
CSSTS

SEQ ID NO: 317 - protein, 5 aa, Homo sapiens
VVVPA

SEQ ID NO: 318 - protein, 6 aa, Homo sapiens
LYYYQL

SEQ ID NO: 319 - protein, 6 aa, Homo sapiens
CSSTSC

SEQ ID NO: 320 - protein, 6 aa, Homo sapiens
VVVPAA

SEQ ID NO: 321 - protein, 4 aa, Homo sapiens
YYYQ

SEQ ID NO: 322 - protein, 4 aa, Homo sapiens
SSTS

SEQ ID NO: 323 - protein, 4 aa, Homo sapiens
VVPA

SEQ ID NO: 324 - protein, 5 aa, Homo sapiens
YYYQL

SEQ ID NO: 325 - protein, 5 aa, Homo sapiens
SSTSC

SEQ ID NO: 326 - protein, 5 aa, Homo sapiens
VVPAA

SEQ ID NO: 327 - protein, 6 aa, Homo sapiens
YYYQLL

SEQ ID NO: 328 - protein, 6 aa, Homo sapiens
SSTSCY

SEQ ID NO: 329 - protein, 6 aa, Homo sapiens
VVPAAI

SEQ ID NO: 330 - protein, 4 aa, Homo sapiens
YYQL

SEQ ID NO: 331 - protein, 4 aa, Homo sapiens
STSC

SEQ ID NO: 332 - protein, 4 aa, Homo sapiens
VPAA

SEQ ID NO: 333 - protein, 5 aa, Homo sapiens
YYQLL

SEQ ID NO: 334 - protein, 5 aa, Homo sapiens
STSCY

SEQ ID NO: 335 - protein, 5 aa, Homo sapiens
VPAAI

SEQ ID NO: 336 - protein, 6 aa, Homo sapiens
YYQLLY

SEQ ID NO: 337 - protein, 6 aa, Homo sapiens
STSCYT

SEQ ID NO: 338 - protein, 4 aa, Homo sapiens
YQLL

SEQ ID NO: 339 - protein, 4 aa, Homo sapiens
TSCY

SEQ ID NO: 340 - protein, 4 aa, Homo sapiens
PAAI

SEQ ID NO: 341 - protein, 5 aa, Homo sapiens
YQLLY

SEQ ID NO: 342 - protein, 5 aa, Homo sapiens
TSCYT

SEQ ID NO: 343 - protein, 4 aa, Homo sapiens
QLLY

SEQ ID NO: 344 - protein, 4 aa, Homo sapiens
SCYT

SEQ ID NO: 345 - protein, 4 aa, Homo sapiens
RILY

SEQ ID NO: 346 - protein, 4 aa, Homo sapiens
GYCT

SEQ ID NO: 347 - protein, 4 aa, Homo sapiens
DIVL

SEQ ID NO: 348 - protein, 5 aa, Homo sapiens
RILYY

SEQ ID NO: 349 - protein, 5 aa, Homo sapiens
GYCTN

SEQ ID NO: 350 - protein, 5 aa, Homo sapiens
DIVLM

SEQ ID NO: 351 - protein, 6 aa, Homo sapiens
RILYYW

SEQ ID NO: 352 - protein, 6 aa, Homo sapiens
GYCTNG

SEQ ID NO: 353 - protein, 6 aa, Homo sapiens
DIVLMV

SEQ ID NO: 354 - protein, 4 aa, Homo sapiens
ILYY

SEQ ID NO: 355 - protein, 4 aa, Homo sapiens
YCTN

SEQ ID NO: 356 - protein, 4 aa, Homo sapiens
IVLM

SEQ ID NO: 357 - protein, 5 aa, Homo sapiens
ILYYW

SEQ ID NO: 358 - protein, 5 aa, Homo sapiens
YCTNG

SEQ ID NO: 359 - protein, 5 aa, Homo sapiens
IVLMV

SEQ ID NO: 360 - protein, 6 aa, Homo sapiens
ILYYWC

SEQ ID NO: 361 - protein, 6 aa, Homo sapiens
YCTNGV

SEQ ID NO: 362 - protein, 6 aa, Homo sapiens
IVLMVY

SEQ ID NO: 363 - protein, 4 aa, Homo sapiens
LYYW

SEQ ID NO: 364 - protein, 4 aa, Homo sapiens
CTNG

SEQ ID NO: 365 - protein, 4 aa, Homo sapiens
VLMV

SEQ ID NO: 366 - protein, 5 aa, Homo sapiens
LYYWC

SEQ ID NO: 367 - protein, 5 aa, Homo sapiens
CTNGV

SEQ ID NO: 368 - protein, 5 aa, Homo sapiens
VLMVY

SEQ ID NO: 369 - protein, 6 aa, Homo sapiens
LYYWCM

SEQ ID NO: 370 - protein, 6 aa, Homo sapiens
CTNGVC

SEQ ID NO: 371 - protein, 6 aa, Homo sapiens
VLMVYA

SEQ ID NO: 372 - protein, 4 aa, Homo sapiens
YYWC

SEQ ID NO: 373 - protein, 4 aa, Homo sapiens
TNGV

SEQ ID NO: 374 - protein, 4 aa, Homo sapiens
LMVY

SEQ ID NO: 375 - protein, 5 aa, Homo sapiens
YYWCM

SEQ ID NO: 376 - protein, 5 aa, Homo sapiens
TNGVC

SEQ ID NO: 377 - protein, 5 aa, Homo sapiens
LMVYA

SEQ ID NO: 378 - protein, 6 aa, Homo sapiens
YYWCML

SEQ ID NO: 379 - protein, 6 aa, Homo sapiens
TNGVCY

SEQ ID NO: 380 - protein, 6 aa, Homo sapiens
LMVYAI

SEQ ID NO: 381 - protein, 4 aa, Homo sapiens
YWCM

SEQ ID NO: 382 - protein, 4 aa, Homo sapiens
NGVC

SEQ ID NO: 383 - protein, 4 aa, Homo sapiens
MVYA

SEQ ID NO: 384 - protein, 5 aa, Homo sapiens
YWCML

SEQ ID NO: 385 - protein, 5 aa, Homo sapiens
NGVCY

SEQ ID NO: 386 - protein, 5 aa, Homo sapiens
MVYAI

SEQ ID NO: 387 - protein, 6 aa, Homo sapiens
YWCMLY

SEQ ID NO: 388 - protein, 6 aa, Homo sapiens
NGVCYT

SEQ ID NO: 389 - protein, 4 aa, Homo sapiens
WCML

SEQ ID NO: 390 - protein, 4 aa, Homo sapiens
GVCY

SEQ ID NO: 391 - protein, 4 aa, Homo sapiens
VYAI

SEQ ID NO: 392 - protein, 5 aa, Homo sapiens
WCMLY

SEQ ID NO: 393 - protein, 5 aa, Homo sapiens
GVCYT

SEQ ID NO: 394 - protein, 4 aa, Homo sapiens
CMLY

SEQ ID NO: 395 - protein, 4 aa, Homo sapiens
VCYT

SEQ ID NO: 396 - protein, 5 aa, Homo sapiens
RILYW

SEQ ID NO: 397 - protein, 5 aa, Homo sapiens
GYCSG

SEQ ID NO: 398 - protein, 6 aa, Homo sapiens
RILYWW

SEQ ID NO: 399 - protein, 6 aa, Homo sapiens
GYCSGG

SEQ ID NO: 400 - protein, 6 aa, Homo sapiens
DIVVVV

SEQ ID NO: 401 - protein, 4 aa, Homo sapiens
ILYW

SEQ ID NO: 402 - protein, 4 aa, Homo sapiens
YCSG

SEQ ID NO: 403 - protein, 5 aa, Homo sapiens
ILYWW

SEQ ID NO: 404 - protein, 5 aa, Homo sapiens
YCSGG

SEQ ID NO: 405 - protein, 5 aa, Homo sapiens
IVVVV

SEQ ID NO: 406 - protein, 6 aa, Homo sapiens
ILYWWY

SEQ ID NO: 407 - protein, 6 aa, Homo sapiens
YCSGGS

SEQ ID NO: 408 - protein, 6 aa, Homo sapiens
IVVVVA

SEQ ID NO: 409 - protein, 4 aa, Homo sapiens
LYWW

SEQ ID NO: 410 - protein, 4 aa, Homo sapiens
CSGG

SEQ ID NO: 411 - protein, 4 aa, Homo sapiens
VVVV

SEQ ID NO: 412 - protein, 5 aa, Homo sapiens
LYWWY

SEQ ID NO: 413 - protein, 5 aa, Homo sapiens
CSGGS

SEQ ID NO: 414 - protein, 5 aa, Homo sapiens
VVVVA

SEQ ID NO: 415 - protein, 6 aa, Homo sapiens
LYWWYL

SEQ ID NO: 416 - protein, 6 aa, Homo sapiens
CSGGSC

SEQ ID NO: 417 - protein, 6 aa, Homo sapiens
VVVVAA

SEQ ID NO: 418 - protein, 4 aa, Homo sapiens
YWWY

SEQ ID NO: 419 - protein, 4 aa, Homo sapiens
SGGS

SEQ ID NO: 420 - protein, 4 aa, Homo sapiens
VVVA

SEQ ID NO: 421 - protein, 5 aa, Homo sapiens
YWWYL

SEQ ID NO: 422 - protein, 5 aa, Homo sapiens
SGGSC

SEQ ID NO: 423 - protein, 5 aa, Homo sapiens
VVVAA

SEQ ID NO: 424 - protein, 6 aa, Homo sapiens
YWWYLL

SEQ ID NO: 425 - protein, 6 aa, Homo sapiens
SGGSCY

SEQ ID NO: 426 - protein, 6 aa, Homo sapiens
VVVAAT

SEQ ID NO: 427 - protein, 4 aa, Homo sapiens
WWYL

SEQ ID NO: 428 - protein, 4 aa, Homo sapiens
GGSC

SEQ ID NO: 429 - protein, 4 aa, Homo sapiens
VVAA

SEQ ID NO: 430 - protein, 5 aa, Homo sapiens
WWYLL

SEQ ID NO: 431 - protein, 5 aa, Homo sapiens
GGSCY

SEQ ID NO: 432 - protein, 5 aa, Homo sapiens
VVAAT

SEQ ID NO: 433 - protein, 6 aa, Homo sapiens
WWYLLL

SEQ ID NO: 434 - protein, 6 aa, Homo sapiens
GGSCYS

SEQ ID NO: 435 - protein, 4 aa, Homo sapiens
WYLL

SEQ ID NO: 436 - protein, 4 aa, Homo sapiens
GSCY

SEQ ID NO: 437 - protein, 4 aa, Homo sapiens
VAAT

SEQ ID NO: 438 - protein, 5 aa, Homo sapiens
WYLLL

SEQ ID NO: 439 - protein, 5 aa, Homo sapiens
GSCYS

SEQ ID NO: 440 - protein, 4 aa, Homo sapiens
YLLL

SEQ ID NO: 441 - protein, 4 aa, Homo sapiens
SCYS

SEQ ID NO: 442 - protein, 4 aa, Homo sapiens
SILW

SEQ ID NO: 443 - protein, 4 aa, Homo sapiens
AYCG

SEQ ID NO: 444 - protein, 4 aa, Homo sapiens
HIVV

SEQ ID NO: 445 - protein, 5 aa, Homo sapiens
SILWW

SEQ ID NO: 446 - protein, 5 aa, Homo sapiens
AYCGG

SEQ ID NO: 447 - protein, 5 aa, Homo sapiens
HIVVV

SEQ ID NO: 448 - protein, 6 aa, Homo sapiens
SILWWW

SEQ ID NO: 449 - protein, 6 aa, Homo sapiens
AYCGGD

SEQ ID NO: 450 - protein, 6 aa, Homo sapiens
HIVVVT

SEQ ID NO: 451 - protein, 4 aa, Homo sapiens
ILWW

SEQ ID NO: 452 - protein, 4 aa, Homo sapiens
YCGG

SEQ ID NO: 453 - protein, 5 aa, Homo sapiens
ILWWW

SEQ ID NO: 454 - protein, 5 aa, Homo sapiens
YCGGD

SEQ ID NO: 455 - protein, 5 aa, Homo sapiens
IVVVT

SEQ ID NO: 456 - protein, 6 aa, Homo sapiens
ILWWWL

SEQ ID NO: 457 - protein, 6 aa, Homo sapiens
YCGGDC

SEQ ID NO: 458 - protein, 6 aa, Homo sapiens
IVVVTA

SEQ ID NO: 459 - protein, 4 aa, Homo sapiens
LWWW

SEQ ID NO: 460 - protein, 4 aa, Homo sapiens
CGGD

SEQ ID NO: 461 - protein, 4 aa, Homo sapiens
VVVT

SEQ ID NO: 462 - protein, 5 aa, Homo sapiens
LWWWL

SEQ ID NO: 463 - protein, 5 aa, Homo sapiens
CGGDC

SEQ ID NO: 464 - protein, 5 aa, Homo sapiens
VVVTA

SEQ ID NO: 465 - protein, 6 aa, Homo sapiens
LWWWLL

SEQ ID NO: 466 - protein, 6 aa, Homo sapiens
CGGDCY

SEQ ID NO: 467 - protein, 6 aa, Homo sapiens
VVVTAI

SEQ ID NO: 468 - protein, 4 aa, Homo sapiens
WWWL

SEQ ID NO: 469 - protein, 4 aa, Homo sapiens
GGDC

SEQ ID NO: 470 - protein, 4 aa, Homo sapiens
VVTA

SEQ ID NO: 471 - protein, 5 aa, Homo sapiens
WWWLL

SEQ ID NO: 472 - protein, 5 aa, Homo sapiens
GGDCY

SEQ ID NO: 473 - protein, 5 aa, Homo sapiens
VVTAI

SEQ ID NO: 474 - protein, 6 aa, Homo sapiens
WWWLLF

SEQ ID NO: 475 - protein, 6 aa, Homo sapiens
GGDCYS

SEQ ID NO: 476 - protein, 4 aa, Homo sapiens
WWLL

SEQ ID NO: 477 - protein, 4 aa, Homo sapiens
GDCY

SEQ ID NO: 478 - protein, 4 aa, Homo sapiens
VTAI

SEQ ID NO: 479 - protein, 5 aa, Homo sapiens
WWLLF

SEQ ID NO: 480 - protein, 5 aa, Homo sapiens
GDCYS

SEQ ID NO: 481 - protein, 4 aa, Homo sapiens
WLLF

SEQ ID NO: 482 - protein, 4 aa, Homo sapiens
DCYS

SEQ ID NO: 483 - protein, 4 aa, Homo sapiens
VLRF

SEQ ID NO: 484 - protein, 4 aa, Homo sapiens
YYDF

SEQ ID NO: 485 - protein, 4 aa, Homo sapiens
ITIF

SEQ ID NO: 486 - protein, 5 aa, Homo sapiens
VLRFL

SEQ ID NO: 487 - protein, 5 aa, Homo sapiens
YYDFW

SEQ ID NO: 488 - protein, 5 aa, Homo sapiens
ITIFG

SEQ ID NO: 489 - protein, 6 aa, Homo sapiens
VLRFLE

SEQ ID NO: 490 - protein, 6 aa, Homo sapiens
YYDFWS

SEQ ID NO: 491 - protein, 6 aa, Homo sapiens
ITIFGV

SEQ ID NO: 492 - protein, 4 aa, Homo sapiens
LRFL

SEQ ID NO: 493 - protein, 4 aa, Homo sapiens
YDFW

SEQ ID NO: 494 - protein, 4 aa, Homo sapiens
TIFG

SEQ ID NO: 495 - protein, 5 aa, Homo sapiens
LRFLE

SEQ ID NO: 496 - protein, 5 aa, Homo sapiens
YDFWS

SEQ ID NO: 497 - protein, 5 aa, Homo sapiens
TIFGV

SEQ ID NO: 498 - protein, 6 aa, Homo sapiens
LRFLEW

SEQ ID NO: 499 - protein, 6 aa, Homo sapiens
YDFWSG

SEQ ID NO: 500 - protein, 6 aa, Homo sapiens
TIFGVV

SEQ ID NO: 501 - protein, 4 aa, Homo sapiens
RFLE

SEQ ID NO: 502 - protein, 4 aa, Homo sapiens
DFWS

SEQ ID NO: 503 - protein, 4 aa, Homo sapiens
IFGV

SEQ ID NO: 504 - protein, 5 aa, Homo sapiens
RFLEW

SEQ ID NO: 505 - protein, 5 aa, Homo sapiens
DFWSG

SEQ ID NO: 506 - protein, 5 aa, Homo sapiens
IFGVV

SEQ ID NO: 507 - protein, 6 aa, Homo sapiens
RFLEWL

SEQ ID NO: 508 - protein, 6 aa, Homo sapiens
DFWSGY

SEQ ID NO: 509 - protein, 6 aa, Homo sapiens
IFGVVI

SEQ ID NO: 510 - protein, 4 aa, Homo sapiens
FLEW

SEQ ID NO: 511 - protein, 4 aa, Homo sapiens
FWSG

SEQ ID NO: 512 - protein, 4 aa, Homo sapiens
FGVV

SEQ ID NO: 513 - protein, 5 aa, Homo sapiens
FLEWL

SEQ ID NO: 514 - protein, 5 aa, Homo sapiens
FWSGY

SEQ ID NO: 515 - protein, 5 aa, Homo sapiens
FGVVI

SEQ ID NO: 516 - protein, 6 aa, Homo sapiens
FLEWLL

SEQ ID NO: 517 - protein, 6 aa, Homo sapiens
FWSGYY

SEQ ID NO: 518 - protein, 6 aa, Homo sapiens
FGVVII

SEQ ID NO: 519 - protein, 4 aa, Homo sapiens
LEWL

SEQ ID NO: 520 - protein, 4 aa, Homo sapiens
WSGY

SEQ ID NO: 521 - protein, 4 aa, Homo sapiens
GVVI

SEQ ID NO: 522 - protein, 5 aa, Homo sapiens
LEWLL

SEQ ID NO: 523 - protein, 5 aa, Homo sapiens
WSGYY

SEQ ID NO: 524 - protein, 5 aa, Homo sapiens
GVVII

SEQ ID NO: 525 - protein, 6 aa, Homo sapiens
LEWLLY

SEQ ID NO: 526 - protein, 6 aa, Homo sapiens
WSGYYT

SEQ ID NO: 527 - protein, 4 aa, Homo sapiens
EWLL

SEQ ID NO: 528 - protein, 4 aa, Homo sapiens
SGYY

SEQ ID NO: 529 - protein, 4 aa, Homo sapiens
VVII

SEQ ID NO: 530 - protein, 5 aa, Homo sapiens
EWLLY

SEQ ID NO: 531 - protein, 5 aa, Homo sapiens
SGYYT

SEQ ID NO: 532 - protein, 4 aa, Homo sapiens
WLLY

SEQ ID NO: 533 - protein, 4 aa, Homo sapiens
GYYT

SEQ ID NO: 534 - protein, 4 aa, Homo sapiens
VLRY

SEQ ID NO: 535 - protein, 4 aa, Homo sapiens
YYDI

SEQ ID NO: 536 - protein, 5 aa, Homo sapiens
VLRYF

SEQ ID NO: 537 - protein, 5 aa, Homo sapiens
YYDIL

SEQ ID NO: 538 - protein, 5 aa, Homo sapiens
ITIFY

SEQ ID NO: 539 - protein, 6 aa, Homo sapiens
VLRYFD

SEQ ID NO: 540 - protein, 6 aa, Homo sapiens
YYDILT

SEQ ID NO: 541 - protein, 6 aa, Homo sapiens
ITIFYL

SEQ ID NO: 542 - protein, 4 aa, Homo sapiens
LRYF

SEQ ID NO: 543 - protein, 4 aa, Homo sapiens
YDIL

SEQ ID NO: 544 - protein, 4 aa, Homo sapiens
TIFY

SEQ ID NO: 545 - protein, 5 aa, Homo sapiens
LRYFD

SEQ ID NO: 546 - protein, 5 aa, Homo sapiens
YDILT

SEQ ID NO: 547 - protein, 5 aa, Homo sapiens
TIFYL

SEQ ID NO: 548 - protein, 6 aa, Homo sapiens
LRYFDW

SEQ ID NO: 549 - protein, 6 aa, Homo sapiens
YDILTG

SEQ ID NO: 550 - protein, 6 aa, Homo sapiens
TIFYLV

SEQ ID NO: 551 - protein, 4 aa, Homo sapiens
RYFD

SEQ ID NO: 552 - protein, 4 aa, Homo sapiens
DILT

SEQ ID NO: 553 - protein, 4 aa, Homo sapiens
IFYL

SEQ ID NO: 554 - protein, 5 aa, Homo sapiens
RYFDW

SEQ ID NO: 555 - protein, 5 aa, Homo sapiens
DILTG

SEQ ID NO: 556 - protein, 5 aa, Homo sapiens
IFYLV

SEQ ID NO: 557 - protein, 6 aa, Homo sapiens
RYFDWL

SEQ ID NO: 558 - protein, 6 aa, Homo sapiens
DILTGY

SEQ ID NO: 559 - protein, 6 aa, Homo sapiens
IFYLVI

SEQ ID NO: 560 - protein, 4 aa, Homo sapiens
YFDW

SEQ ID NO: 561 - protein, 4 aa, Homo sapiens
ILTG

SEQ ID NO: 562 - protein, 4 aa, Homo sapiens
FYLV

SEQ ID NO: 563 - protein, 5 aa, Homo sapiens
YFDWL

SEQ ID NO: 564 - protein, 5 aa, Homo sapiens
ILTGY

SEQ ID NO: 565 - protein, 5 aa, Homo sapiens
FYLVI

SEQ ID NO: 566 - protein, 6 aa, Homo sapiens
YFDWLL

SEQ ID NO: 567 - protein, 6 aa, Homo sapiens
ILTGYY

SEQ ID NO: 568 - protein, 6 aa, Homo sapiens
FYLVII

SEQ ID NO: 569 - protein, 4 aa, Homo sapiens
FDWL

SEQ ID NO: 570 - protein, 4 aa, Homo sapiens
LTGY

SEQ ID NO: 571 - protein, 4 aa, Homo sapiens
YLVI

SEQ ID NO: 572 - protein, 5 aa, Homo sapiens
FDWLL

SEQ ID NO: 573 - protein, 5 aa, Homo sapiens
LTGYY

SEQ ID NO: 574 - protein, 5 aa, Homo sapiens
YLVII

SEQ ID NO: 575 - protein, 6 aa, Homo sapiens
FDWLLY

SEQ ID NO: 576 - protein, 6 aa, Homo sapiens
LTGYYN

SEQ ID NO: 577 - protein, 4 aa, Homo sapiens
DWLL

SEQ ID NO: 578 - protein, 4 aa, Homo sapiens
TGYY

SEQ ID NO: 579 - protein, 4 aa, Homo sapiens
LVII

SEQ ID NO: 580 - protein, 5 aa, Homo sapiens
DWLLY

SEQ ID NO: 581 - protein, 5 aa, Homo sapiens
TGYYN

SEQ ID NO: 582 - protein, 4 aa, Homo sapiens
WLLY

SEQ ID NO: 583 - protein, 4 aa, Homo sapiens
GYYN

SEQ ID NO: 584 - protein, 4 aa, Homo sapiens
VLLW

SEQ ID NO: 585 - protein, 4 aa, Homo sapiens
YYYG

SEQ ID NO: 586 - protein, 4 aa, Homo sapiens
ITMV

SEQ ID NO: 587 - protein, 5 aa, Homo sapiens
VLLWF

SEQ ID NO: 588 - protein, 5 aa, Homo sapiens
YYYGS

SEQ ID NO: 589 - protein, 5 aa, Homo sapiens
ITMVR

SEQ ID NO: 590 - protein, 6 aa, Homo sapiens
VLLWFG

SEQ ID NO: 591 - protein, 6 aa, Homo sapiens
YYYGSG

SEQ ID NO: 592 - protein, 6 aa, Homo sapiens
ITMVRG

SEQ ID NO: 593 - protein, 4 aa, Homo sapiens
LLWF

SEQ ID NO: 594 - protein, 4 aa, Homo sapiens
YYGS

SEQ ID NO: 595 - protein, 4 aa, Homo sapiens
TMVR

SEQ ID NO: 596 - protein, 5 aa, Homo sapiens
LLWFG

SEQ ID NO: 597 - protein, 5 aa, Homo sapiens
YYGSG

SEQ ID NO: 598 - protein, 5 aa, Homo sapiens
TMVRG

SEQ ID NO: 599 - protein, 6 aa, Homo sapiens
LLWFGE

SEQ ID NO: 600 - protein, 6 aa, Homo sapiens
YYGSGS

SEQ ID NO: 601 - protein, 6 aa, Homo sapiens
TMVRGV

SEQ ID NO: 602 - protein, 4 aa, Homo sapiens
LWFG

SEQ ID NO: 603 - protein, 4 aa, Homo sapiens
YGSG

SEQ ID NO: 604 - protein, 4 aa, Homo sapiens
MVRG

SEQ ID NO: 605 - protein, 5 aa, Homo sapiens
LWFGE

SEQ ID NO: 606 - protein, 5 aa, Homo sapiens
YGSGS

SEQ ID NO: 607 - protein, 5 aa, Homo sapiens
MVRGV

SEQ ID NO: 608 - protein, 6 aa, Homo sapiens
LWFGEL

SEQ ID NO: 609 - protein, 6 aa, Homo sapiens
YGSGSY

SEQ ID NO: 610 - protein, 6 aa, Homo sapiens
MVRGVI

SEQ ID NO: 611 - protein, 4 aa, Homo sapiens
WFGE

SEQ ID NO: 612 - protein, 4 aa, Homo sapiens
GSGS

SEQ ID NO: 613 - protein, 4 aa, Homo sapiens
VRGV

SEQ ID NO: 614 - protein, 5 aa, Homo sapiens
WFGEL

SEQ ID NO: 615 - protein, 5 aa, Homo sapiens
GSGSY

SEQ ID NO: 616 - protein, 5 aa, Homo sapiens
VRGVI

SEQ ID NO: 617 - protein, 6 aa, Homo sapiens
WFGELL

SEQ ID NO: 618 - protein, 6 aa, Homo sapiens
GSGSYY

SEQ ID NO: 619 - protein, 6 aa, Homo sapiens
VRGVII

SEQ ID NO: 620 - protein, 4 aa, Homo sapiens
FGEL

SEQ ID NO: 621 - protein, 4 aa, Homo sapiens
RGVI

SEQ ID NO: 622 - protein, 5 aa, Homo sapiens
FGELL

SEQ ID NO: 623 - protein, 5 aa, Homo sapiens
RGVII

SEQ ID NO: 624 - protein, 6 aa, Homo sapiens
FGELLY

SEQ ID NO: 625 - protein, 6 aa, Homo sapiens
SGSYYN

SEQ ID NO: 626 - protein, 4 aa, Homo sapiens
GELL

SEQ ID NO: 627 - protein, 4 aa, Homo sapiens
GVII

SEQ ID NO: 628 - protein, 5 aa, Homo sapiens
GELLY

SEQ ID NO: 629 - protein, 5 aa, Homo sapiens
GSYYN

SEQ ID NO: 630 - protein, 4 aa, Homo sapiens
ELLY

SEQ ID NO: 631 - protein, 4 aa, Homo sapiens
SYYN

SEQ ID NO: 632 - protein, 4 aa, Homo sapiens
VLWL

SEQ ID NO: 633 - protein, 4 aa, Homo sapiens
YYDY

SEQ ID NO: 634 - protein, 4 aa, Homo sapiens
IMIT

SEQ ID NO: 635 - protein, 5 aa, Homo sapiens
VLWLR

SEQ ID NO: 636 - protein, 5 aa, Homo sapiens
YYDYV

SEQ ID NO: 637 - protein, 5 aa, Homo sapiens
IMITF

SEQ ID NO: 638 - protein, 6 aa, Homo sapiens
VLWLRL

SEQ ID NO: 639 - protein, 6 aa, Homo sapiens
YYDYVW

SEQ ID NO: 640 - protein, 6 aa, Homo sapiens
IMITFG

SEQ ID NO: 641 - protein, 4 aa, Homo sapiens
LWLR

SEQ ID NO: 642 - protein, 4 aa, Homo sapiens
YDYV

SEQ ID NO: 643 - protein, 4 aa, Homo sapiens
MITF

SEQ ID NO: 644 - protein, 5 aa, Homo sapiens
LWLRL

SEQ ID NO: 645 - protein, 5 aa, Homo sapiens
YDYVW

SEQ ID NO: 646 - protein, 5 aa, Homo sapiens
MITFG

SEQ ID NO: 647 - protein, 6 aa, Homo sapiens
LWLRLG

SEQ ID NO: 648 - protein, 6 aa, Homo sapiens
YDYVWG

SEQ ID NO: 649 - protein, 6 aa, Homo sapiens
MITFGG

SEQ ID NO: 650 - protein, 4 aa, Homo sapiens
WLRL

SEQ ID NO: 651 - protein, 4 aa, Homo sapiens
DYVW

SEQ ID NO: 652 - protein, 4 aa, Homo sapiens
ITFG

SEQ ID NO: 653 - protein, 5 aa, Homo sapiens
WLRLG

SEQ ID NO: 654 - protein, 5 aa, Homo sapiens
DYVWG

SEQ ID NO: 655 - protein, 5 aa, Homo sapiens
ITFGG

SEQ ID NO: 656 - protein, 6 aa, Homo sapiens
WLRLGE

SEQ ID NO: 657 - protein, 6 aa, Homo sapiens
DYVWGS

SEQ ID NO: 658 - protein, 6 aa, Homo sapiens
ITFGGV

SEQ ID NO: 659 - protein, 4 aa, Homo sapiens
LRLG

SEQ ID NO: 660 - protein, 4 aa, Homo sapiens
YVWG

SEQ ID NO: 661 - protein, 4 aa, Homo sapiens
TFGG

SEQ ID NO: 662 - protein, 5 aa, Homo sapiens
LRLGE

SEQ ID NO: 663 - protein, 5 aa, Homo sapiens
YVWGS

SEQ ID NO: 664 - protein, 5 aa, Homo sapiens
TFGGV

SEQ ID NO: 665 - protein, 6 aa, Homo sapiens
LRLGEL

SEQ ID NO: 666 - protein, 6 aa, Homo sapiens
YVWGSY

SEQ ID NO: 667 - protein, 6 aa, Homo sapiens
TFGGVI

SEQ ID NO: 668 - protein, 4 aa, Homo sapiens
RLGE

SEQ ID NO: 669 - protein, 4 aa, Homo sapiens
VWGS

SEQ ID NO: 670 - protein, 4 aa, Homo sapiens
FGGV

SEQ ID NO: 671 - protein, 5 aa, Homo sapiens
RLGEL

SEQ ID NO: 672 - protein, 5 aa, Homo sapiens
VWGSY

SEQ ID NO: 673 - protein, 5 aa, Homo sapiens
FGGVI

SEQ ID NO: 674 - protein, 6 aa, Homo sapiens
RLGELS

SEQ ID NO: 675 - protein, 6 aa, Homo sapiens
VWGSYR

SEQ ID NO: 676 - protein, 6 aa, Homo sapiens
FGGVIV

SEQ ID NO: 677 - protein, 4 aa, Homo sapiens
LGEL

SEQ ID NO: 678 - protein, 4 aa, Homo sapiens
WGSY

SEQ ID NO: 679 - protein, 4 aa, Homo sapiens
GGVI

SEQ ID NO: 680 - protein, 5 aa, Homo sapiens
LGELS

SEQ ID NO: 681 - protein, 5 aa, Homo sapiens
WGSYR

SEQ ID NO: 682 - protein, 5 aa, Homo sapiens
GGVIV

SEQ ID NO: 683 - protein, 6 aa, Homo sapiens
LGELSL

SEQ ID NO: 684 - protein, 6 aa, Homo sapiens
WGSYRY

SEQ ID NO: 685 - protein, 6 aa, Homo sapiens
GGVIVI

SEQ ID NO: 686 - protein, 4 aa, Homo sapiens
GELS

SEQ ID NO: 687 - protein, 4 aa, Homo sapiens
GSYR

SEQ ID NO: 688 - protein, 4 aa, Homo sapiens
GVIV

SEQ ID NO: 689 - protein, 5 aa, Homo sapiens
GELSL

SEQ ID NO: 690 - protein, 5 aa, Homo sapiens
GSYRY

SEQ ID NO: 691 - protein, 5 aa, Homo sapiens
GVIVI

SEQ ID NO: 692 - protein, 6 aa, Homo sapiens
GELSLY

SEQ ID NO: 693 - protein, 6 aa, Homo sapiens
GSYRYT

SEQ ID NO: 694 - protein, 4 aa, Homo sapiens
ELSL

SEQ ID NO: 695 - protein, 4 aa, Homo sapiens
SYRY

SEQ ID NO: 696 - protein, 4 aa, Homo sapiens
VIVI

SEQ ID NO: 697 - protein, 5 aa, Homo sapiens
ELSLY

SEQ ID NO: 698 - protein, 5 aa, Homo sapiens
SYRYT

SEQ ID NO: 699 - protein, 4 aa, Homo sapiens
LSLY

SEQ ID NO: 700 - protein, 4 aa, Homo sapiens
YRYT

SEQ ID NO: 701 - protein, 4 aa, Homo sapiens
VLLW

SEQ ID NO: 702 - protein, 4 aa, Homo sapiens
YYYD

SEQ ID NO: 703 - protein, 4 aa, Homo sapiens
ITMI

SEQ ID NO: 704 - protein, 5 aa, Homo sapiens
VLLWY

SEQ ID NO: 705 - protein, 5 aa, Homo sapiens
YYYDS

SEQ ID NO: 706 - protein, 5 aa, Homo sapiens
ITMIV

SEQ ID NO: 707 - protein, 6 aa, Homo sapiens
VLLWYY

SEQ ID NO: 708 - protein, 6 aa, Homo sapiens
YYYDSS

SEQ ID NO: 709 - protein, 6 aa, Homo sapiens
ITMIVV

SEQ ID NO: 710 - protein, 4 aa, Homo sapiens
LLWY

SEQ ID NO: 711 - protein, 4 aa, Homo sapiens
YYDS

SEQ ID NO: 712 - protein, 4 aa, Homo sapiens
TMIV

SEQ ID NO: 713 - protein, 5 aa, Homo sapiens
LLWYY

SEQ ID NO: 714 - protein, 5 aa, Homo sapiens
YYDSS

SEQ ID NO: 715 - protein, 5 aa, Homo sapiens
TMIVV

SEQ ID NO: 716 - protein, 6 aa, Homo sapiens
LLWYYW

SEQ ID NO: 717 - protein, 6 aa, Homo sapiens
YYDSSG

SEQ ID NO: 718 - protein, 6 aa, Homo sapiens
TMIVVV

SEQ ID NO: 719 - protein, 4 aa, Homo sapiens
LWYY

SEQ ID NO: 720 - protein, 4 aa, Homo sapiens
YDSS

SEQ ID NO: 721 - protein, 4 aa, Homo sapiens
MIVV

SEQ ID NO: 722 - protein, 5 aa, Homo sapiens
LWYYW

SEQ ID NO: 723 - protein, 5 aa, Homo sapiens
YDSSG

SEQ ID NO: 724 - protein, 5 aa, Homo sapiens
MIVVV

SEQ ID NO: 725 - protein, 6 aa, Homo sapiens
LWYYWL

SEQ ID NO: 726 - protein, 6 aa, Homo sapiens
YDSSGY

SEQ ID NO: 727 - protein, 6 aa, Homo sapiens
MIVVVI

SEQ ID NO: 728 - protein, 4 aa, Homo sapiens
WYYW

SEQ ID NO: 729 - protein, 4 aa, Homo sapiens
DSSG

SEQ ID NO: 730 - protein, 5 aa, Homo sapiens
WYYWL

SEQ ID NO: 731 - protein, 5 aa, Homo sapiens
DSSGY

SEQ ID NO: 732 - protein, 5 aa, Homo sapiens
IVVVI

SEQ ID NO: 733 - protein, 6 aa, Homo sapiens
WYYWLL

SEQ ID NO: 734 - protein, 6 aa, Homo sapiens
DSSGYY

SEQ ID NO: 735 - protein, 6 aa, Homo sapiens
IVVVIT

SEQ ID NO: 736 - protein, 4 aa, Homo sapiens
YYWL

SEQ ID NO: 737 - protein, 4 aa, Homo sapiens
SSGY

SEQ ID NO: 738 - protein, 4 aa, Homo sapiens
VVVI

SEQ ID NO: 739 - protein, 5 aa, Homo sapiens
YYWLL

SEQ ID NO: 740 - protein, 5 aa, Homo sapiens
SSGYY

SEQ ID NO: 741 - protein, 5 aa, Homo sapiens
VVVIT

SEQ ID NO: 742 - protein, 6 aa, Homo sapiens
YYWLLL

SEQ ID NO: 743 - protein, 6 aa, Homo sapiens
SSGYYY

SEQ ID NO: 744 - protein, 4 aa, Homo sapiens
YWLL

SEQ ID NO: 745 - protein, 4 aa, Homo sapiens
VVIT

SEQ ID NO: 746 - protein, 5 aa, Homo sapiens
YWLLL

SEQ ID NO: 747 - protein, 5 aa, Homo sapiens
SGYYY

SEQ ID NO: 748 - protein, 4 aa, Homo sapiens
WLLL

SEQ ID NO: 749 - protein, 4 aa, Homo sapiens
GYYY

SEQ ID NO: 750 - protein, 4 aa, Homo sapiens
WLQY

SEQ ID NO: 751 - protein, 4 aa, Homo sapiens
DYSN

SEQ ID NO: 752 - protein, 4 aa, Homo sapiens
TTVT

SEQ ID NO: 753 - protein, 5 aa, Homo sapiens
WLQYL

SEQ ID NO: 754 - protein, 5 aa, Homo sapiens
DYSNY

SEQ ID NO: 755 - protein, 4 aa, Homo sapiens
LQYL

SEQ ID NO: 756 - protein, 4 aa, Homo sapiens
YSNY

SEQ ID NO: 757 - protein, 4 aa, Homo sapiens
WLRW

SEQ ID NO: 758 - protein, 4 aa, Homo sapiens
DYGD

SEQ ID NO: 759 - protein, 5 aa, Homo sapiens
WLRWL

SEQ ID NO: 760 - protein, 5 aa, Homo sapiens
DYGDY

SEQ ID NO: 761 - protein, 4 aa, Homo sapiens
LRWL

SEQ ID NO: 762 - protein, 4 aa, Homo sapiens
YGDY

SEQ ID NO: 763 - protein, 4 aa, Homo sapiens
WLRW

SEQ ID NO: 764 - protein, 4 aa, Homo sapiens
DYGG

SEQ ID NO: 765 - protein, 4 aa, Homo sapiens
TTVV

SEQ ID NO: 766 - protein, 5 aa, Homo sapiens
WLRWY

SEQ ID NO: 767 - protein, 5 aa, Homo sapiens
DYGGN

SEQ ID NO: 768 - protein, 5 aa, Homo sapiens
TTVVT

SEQ ID NO: 769 - protein, 6 aa, Homo sapiens
WLRWYL

SEQ ID NO: 770 - protein, 6 aa, Homo sapiens
DYGGNS

SEQ ID NO: 771 - protein, 4 aa, Homo sapiens
LRWY

SEQ ID NO: 772 - protein, 4 aa, Homo sapiens
YGGN

SEQ ID NO: 773 - protein, 4 aa, Homo sapiens
TVVT

SEQ ID NO: 774 - protein, 5 aa, Homo sapiens
LRWYL

SEQ ID NO: 775 - protein, 5 aa, Homo sapiens
YGGNS

SEQ ID NO: 776 - protein, 4 aa, Homo sapiens
RWYL

SEQ ID NO: 777 - protein, 4 aa, Homo sapiens
GGNS

SEQ ID NO: 778 - protein, 4 aa, Homo sapiens
VDTA

SEQ ID NO: 779 - protein, 4 aa, Homo sapiens
WIQL

SEQ ID NO: 780 - protein, 4 aa, Homo sapiens
GYSY

SEQ ID NO: 781 - protein, 5 aa, Homo sapiens
VDTAM

SEQ ID NO: 782 - protein, 5 aa, Homo sapiens
WIQLW

SEQ ID NO: 783 - protein, 5 aa, Homo sapiens
GYSYG

SEQ ID NO: 784 - protein, 6 aa, Homo sapiens
VDTAMV

SEQ ID NO: 785 - protein, 6 aa, Homo sapiens
WIQLWL

SEQ ID NO: 786 - protein, 6 aa, Homo sapiens
GYSYGY

SEQ ID NO: 787 - protein, 4 aa, Homo sapiens
DTAM

SEQ ID NO: 788 - protein, 4 aa, Homo sapiens
IQLW

SEQ ID NO: 789 - protein, 4 aa, Homo sapiens
YSYG

SEQ ID NO: 790 - protein, 5 aa, Homo sapiens
DTAMV

SEQ ID NO: 791 - protein, 5 aa, Homo sapiens
IQLWL

SEQ ID NO: 792 - protein, 5 aa, Homo sapiens
YSYGY

SEQ ID NO: 793 - protein, 4 aa, Homo sapiens
TAMV

SEQ ID NO: 794 - protein, 4 aa, Homo sapiens
QLWL

SEQ ID NO: 795 - protein, 4 aa, Homo sapiens
SYGY

SEQ ID NO: 796 - protein, 4 aa, Homo sapiens
VDIV

SEQ ID NO: 797 - protein, 4 aa, Homo sapiens
WIYW

SEQ ID NO: 798 - protein, 4 aa, Homo sapiens
GYSG

SEQ ID NO: 799 - protein, 5 aa, Homo sapiens
VDIVA

SEQ ID NO: 800 - protein, 5 aa, Homo sapiens
WIYWL

SEQ ID NO: 801 - protein, 5 aa, Homo sapiens
GYSGY

SEQ ID NO: 802 - protein, 6 aa, Homo sapiens
VDIVAT

SEQ ID NO: 803 - protein, 6 aa, Homo sapiens
WIYWLR

SEQ ID NO: 804 - protein, 6 aa, Homo sapiens
GYSGYD

SEQ ID NO: 805 - protein, 4 aa, Homo sapiens
DIVA

SEQ ID NO: 806 - protein, 4 aa, Homo sapiens
IYWL

SEQ ID NO: 807 - protein, 4 aa, Homo sapiens
YSGY

SEQ ID NO: 808 - protein, 5 aa, Homo sapiens
DIVAT

SEQ ID NO: 809 - protein, 5 aa, Homo sapiens
IYWLR

SEQ ID NO: 810 - protein, 5 aa, Homo sapiens
YSGYD

SEQ ID NO: 811 - protein, 6 aa, Homo sapiens
DIVATI

SEQ ID NO: 812 - protein, 6 aa, Homo sapiens
IYWLRL

SEQ ID NO: 813 - protein, 6 aa, Homo sapiens
YSGYDY

SEQ ID NO: 814 - protein, 4 aa, Homo sapiens
IVAT

SEQ ID NO: 815 - protein, 4 aa, Homo sapiens
YWLR

SEQ ID NO: 816 - protein, 4 aa, Homo sapiens
SGYD

SEQ ID NO: 817 - protein, 5 aa, Homo sapiens
IVATI

SEQ ID NO: 818 - protein, 5 aa, Homo sapiens
YWLRL

SEQ ID NO: 819 - protein, 5 aa, Homo sapiens
SGYDY

SEQ ID NO: 820 - protein, 4 aa, Homo sapiens
VATI

SEQ ID NO: 821 - protein, 4 aa, Homo sapiens
WLRL

SEQ ID NO: 822 - protein, 4 aa, Homo sapiens
GYDY

SEQ ID NO: 823 - protein, 4 aa, Homo sapiens
VEMA

SEQ ID NO: 824 - protein, 4 aa, Homo sapiens
YRWL

SEQ ID NO: 825 - protein, 4 aa, Homo sapiens
RDGY

SEQ ID NO: 826 - protein, 5 aa, Homo sapiens
VEMAT

SEQ ID NO: 827 - protein, 5 aa, Homo sapiens
YRWLQ

SEQ ID NO: 828 - protein, 5 aa, Homo sapiens
RDGYN

SEQ ID NO: 829 - protein, 6 aa, Homo sapiens
VEMATI

SEQ ID NO: 830 - protein, 6 aa, Homo sapiens
YRWLQL

SEQ ID NO: 831 - protein, 6 aa, Homo sapiens
RDGYNY

SEQ ID NO: 832 - protein, 4 aa, Homo sapiens
EMAT

SEQ ID NO: 833 - protein, 4 aa, Homo sapiens
RWLQ

SEQ ID NO: 834 - protein, 4 aa, Homo sapiens
DGYN

SEQ ID NO: 835 - protein, 5 aa, Homo sapiens
EMATI

SEQ ID NO: 836 - protein, 5 aa, Homo sapiens
RWLQL

SEQ ID NO: 837 - protein, 5 aa, Homo sapiens
DGYNY

SEQ ID NO: 838 - protein, 4 aa, Homo sapiens
MATI

SEQ ID NO: 839 - protein, 4 aa, Homo sapiens
WLQL

SEQ ID NO: 840 - protein, 4 aa, Homo sapiens
GYNY

SEQ ID NO: 841 - protein, 4 aa, Homo sapiens
EYSS

SEQ ID NO: 842 - protein, 4 aa, Homo sapiens
SIAA

SEQ ID NO: 843 - protein, 4 aa, Homo sapiens
VYQL

SEQ ID NO: 844 - protein, 5 aa, Homo sapiens
EYSSS

SEQ ID NO: 845 - protein, 5 aa, Homo sapiens
SIAAR

SEQ ID NO: 846 - protein, 5 aa, Homo sapiens
VYQLV

SEQ ID NO: 847 - protein, 6 aa, Homo sapiens
EYSSSS

SEQ ID NO: 848 - protein, 4 aa, Homo sapiens
YSSS

SEQ ID NO: 849 - protein, 4 aa, Homo sapiens
IAAR

SEQ ID NO: 850 - protein, 4 aa, Homo sapiens
YQLV

SEQ ID NO: 851 - protein, 5 aa, Homo sapiens
YSSSS

SEQ ID NO: 852 - protein, 4 aa, Homo sapiens
SSSS

SEQ ID NO: 853 - protein, 4 aa, Homo sapiens
GYSS

SEQ ID NO: 854 - protein, 4 aa, Homo sapiens
GIAA

SEQ ID NO: 855 - protein, 4 aa, Homo sapiens
VYQQ

SEQ ID NO: 856 - protein, 5 aa, Homo sapiens
GYSSS

SEQ ID NO: 857 - protein, 5 aa, Homo sapiens
GIAAA

SEQ ID NO: 858 - protein, 5 aa, Homo sapiens
VYQQL

SEQ ID NO: 859 - protein, 6 aa, Homo sapiens
GYSSSW

SEQ ID NO: 860 - protein, 6 aa, Homo sapiens
GIAAAG

SEQ ID NO: 861 - protein, 6 aa, Homo sapiens
VYQQLV

SEQ ID NO: 862 - protein, 4 aa, Homo sapiens
IAAA

SEQ ID NO: 863 - protein, 4 aa, Homo sapiens
YQQL

SEQ ID NO: 864 - protein, 5 aa, Homo sapiens
YSSSW

SEQ ID NO: 865 - protein, 5 aa, Homo sapiens
IAAAG

SEQ ID NO: 866 - protein, 5 aa, Homo sapiens
YQQLV

SEQ ID NO: 867 - protein, 6 aa, Homo sapiens
YSSSWY

SEQ ID NO: 868 - protein, 4 aa, Homo sapiens
SSSW

SEQ ID NO: 869 - protein, 4 aa, Homo sapiens
AAAG

SEQ ID NO: 870 - protein, 4 aa, Homo sapiens
QQLV

SEQ ID NO: 871 - protein, 5 aa, Homo sapiens
SSSWY

SEQ ID NO: 872 - protein, 4 aa, Homo sapiens
SSWY

SEQ ID NO: 873 - protein, 4 aa, Homo sapiens
GIAV

SEQ ID NO: 874 - protein, 4 aa, Homo sapiens
VYQW

SEQ ID NO: 875 - protein, 5 aa, Homo sapiens
GYSSG

SEQ ID NO: 876 - protein, 5 aa, Homo sapiens
GIAVA

SEQ ID NO: 877 - protein, 5 aa, Homo sapiens
VYQWL

SEQ ID NO: 878 - protein, 6 aa, Homo sapiens
GYSSGW

SEQ ID NO: 879 - protein, 6 aa, Homo sapiens
GIAVAG

SEQ ID NO: 880 - protein, 6 aa, Homo sapiens
VYQWLV

SEQ ID NO: 881 - protein, 4 aa, Homo sapiens
YSSG

SEQ ID NO: 882 - protein, 4 aa, Homo sapiens
IAVA

SEQ ID NO: 883 - protein, 4 aa, Homo sapiens
YQWL

SEQ ID NO: 884 - protein, 5 aa, Homo sapiens
YSSGW

SEQ ID NO: 885 - protein, 5 aa, Homo sapiens
IAVAG

SEQ ID NO: 886 - protein, 5 aa, Homo sapiens
YQWLV

SEQ ID NO: 887 - protein, 6 aa, Homo sapiens
YSSGWY

SEQ ID NO: 888 - protein, 4 aa, Homo sapiens
SSGW

SEQ ID NO: 889 - protein, 4 aa, Homo sapiens
AVAG

SEQ ID NO: 890 - protein, 4 aa, Homo sapiens
QWLV

SEQ ID NO: 891 - protein, 5 aa, Homo sapiens
SSGWY

SEQ ID NO: 892 - protein, 432 aa, Artificial Sequence [sequence omitted]

SEQ ID NO: 893 - DNA, 1320 bp, Artificial Sequence
  Description of Artificial Sequence Synthetic polynucleotide
atgaaatacctattgcctacggcagccgctggattgttattactcgcggcccagccggccatggccgaagttcaattgttagagtctggtggcggtcttgttcagcctggtggttctttacgtctttcttgcgctgcttccggattcactttctcttcgtacgctatgtcttgggttcgccaagctcctggtaaaggtttggagtgggtttctgctatctctggttctggtggcagtacttactatgctgactccgttaaaggtcgcttcactatctctagagacaactctaagaatactctctacttgcagatgaacagcttaagggctgaggacactgcagtctactattgcgctaaagactatgaaggtactggttatgctttcgacatatggggtcaaggtactatggtcaccgtctctagtgcctccaccaagggcccatcggtcttcccgctagcaccctcctccaagagcacctctgggggcacagcggccctgggctgcctggtcaaggactacttccccgaaccggtgacggtgtcgtggaactcaggcgccctgaccagcggcgtccacaccttcccggctgtcctacagtcctcaggactctactccctcagcagcgtagtgaccgtgccctcttctagcttgggcacccagacctacatctgcaacgtgaatcacaagcccagcaacaccaaggtggacaagaaagttgagcccaaatcttgtgcggccgcacatcatcatcaccatcacggggccgcagaacaaaaactcatctcagaagaggatctgaatggggccgcagaggctagttctgctagtaacgcgtcttccggtgattttgattatgaaaagatggcaaacgctaataagggggctatgaccgaaaatgccgatgaaaacgcgctacagtctgacgctaaaggcaaacttgattctgtcgctactgattacggtgctgctatcgatggtttcattggtgacgtttccggccttgctaatggtaatggtgctactggtgattttgctggctctaattcccaaatggctcaagtcggtgacggtgataattcacctttaatgaataatttccgtcaatatttaccttccctccctcaatcggttgaatgtcgcccttttgtctttggcgctggtaaaccatatgaattttctattgattgtgacaaaataaacttattccgtggtgtctttgcgtttcttttatatgttgccacctttatgtatgtattttctacgtttgctaacatactgcgtaataaggagtcttaatgaaacgcgtgatgagaattc

SEQ ID NO: 894 - DNA, 9501 bp, Artificial Sequence
  Description of Artificial Sequence Synthetic polynucleotide
aatgctactactattagtagaattgatgccaccttttcagctcgcgccccaaatgaaaatatagctaaacaggttattgaccatttgcgaaatgtatctaatggtcaaactaaatctactcgttcgcagaattgggaatcaactgttatatggaatgaaacttccagacaccgtactttagttgcatatttaaaacatgttgagctacagcattatattcagcaattaagctctaagccatccgcaaaaatgacctcttatcaaaaggagcaattaaaggtactctctaatcctgacctgttggagtttgcttccggtctggttcgctttgaagctcgaattaaaacgcgatatttgaagtctttcgggcttcctcttaatctttttgatgcaatccgctttgcttctgactataatagtcagggtaaagacctgatttttgatttatggtcattctcgttttctgaactgtttaaagcatttgagggggattcaatgaatatttatgacgattccgcagtattggacgctatccagtctaaacattttactattaccccctctggcaaaacttcttttgcaaaagcctctcgctattttggtttttatcgtcgtctggtaaacgagggttatgatagtgttgctcttactatgcctcgtaattccttttggcgttatgtatctgcattagttgaatgtggtattcctaaatctcaactgatgaatctttctacctgtaataatgttgttccgttagttcgttttattaacgtagatttttcttcccaacgtcctgactggtataatgagccagttcttaaaatcgcataaggtaattcacaatgattaaagttgaaattaaaccatctcaagcccaatttactactcgttctggtgtttctcgtcagggcaagccttattcactgaatgagcagctttgttacgttgatttgggtaatgaatatccggttcttgtcaagattactcttgatgaaggtcagccagcctatgcgcctggtctgtacaccgttcatctgtcctctttcaaagttggtcagttcggttcccttatgattgaccgtctgcgcctcgttccggctaagtaacatggagcaggtcgcggatttcgacacaatttatcaggcgatgatacaaatctccgttgtactttgtttcgcgcttggtataatcgctgggggtcaaagatgagtgttttagtgtattcttttgcctctttcgttttaggttggtgccttcgtagtggcattacgtattttacccgtttaatggaaacttcctcatgaaaaagtctttagtcctcaaagcctctgtagccgttgctaccctcgttccgatgctgtctttcgctgctgagggtgacgatcccgcaaaagcggcctttaactccctgcaagcctcagcgaccgaatatatcggttatgcgtgggcgatggttgttgtcattgtcggcgcaactatcggtatcaagctgtttaagaaattcacctcgaaagcaagctgataaaccgatacaattaaaggctccttttggagcctttttttttggagattttcaacgtgaaaaaattattattcgcaattcctttagttgttcctttctattctcactccgctgaaactgttgaaagttgtttagcaaaatcccatacagaaaattcatttactaacgtctggaaagacgacaaaactttagatcgttacgctaactatgagggctgtctgtggaatgctacaggcgttgtagtttgtactggtgacgaaactcagtgttacggtacatgggttcctattgggcttgctatccctgaaaatgagggtggtggctctgagggtggcggttctgagggtggcggttctgagggtggcggtactaaacctcctgagtacggtgatacacctattccgggctatacttatatcaaccctctcgacggcacttatccgcctggtactgagcaaaaccccgctaatcctaatccttctcttgaggagtctcagcctcttaatactttcatgtttcagaataataggttccgaaataggcagggggcattaactgtttatacgggcactgttactcaaggcactgaccccgttaaaacttattaccagtacactcctgtatcatcaaaagccatgtatgacgcttactggaacggtaaattcagagactgcgctttccattctggctttaatgaggatttatttgtttgtgaatatcaaggccaatcgtctgacctgcctcaacctcctgtcaatgctggcggcggctctggtggtggttctggtggcggctctgagggtggtggctctgagggtggcggttctgagggtggcggctctgagggaggcggttccggtggtggctctggttccggtgattttgattatgaaaagatggcaaacgctaataagggggctatgaccgaaaatgccgatgaaaacgcgctacagtctgacgctaaaggcaaacttgattctgtcgctactgattacggtgctgctatcgatggtttcattggtgacgtttccggccttgctaatggtaatggtgctactggtgattttgctggctctaattcccaaatggctcaagtcggtgacggtgataattcacctttaatgaataatttccgtcaatatttaccttccctccctcaatcggttgaatgtcgcccttttgtctttggcgctggtaaaccatatgaattttctattgattgtgacaaaataaacttattccgtggtgtctttgcgtttcttttatatgttgccacctttatgtatgtattttctacgtttgctaacatactgcgtaataaggagtcttaatcatgccagttcttttgggtattccgttattattgcgtttcctcggtttccttctggtaactttgttcggctatctgcttacttttcttaaaaagggcttcggtaagatagctattgctatttcattgtttcttgctcttattattgggcttaactcaattcttgtgggttatctctctgatattagcgctcaattaccctctgactttgttcagggtgttcagttaattctcccgtctaatgcgcttccctgtttttatgttattctctctgtaaaggctgctattttcatttttgacgttaaacaaaaaatcgtttcttatttggattgggataaataatatggctgtttattttgtaactggcaaattaggctctggaaagacgctcgttagcgttggtaagattcaggataaaattgtagctgggtgcaaaatagcaactaatcttgatttaaggcttcaaaacctcccgcaagtcgggaggttcgctaaaacgcctcgcgttcttagaataccggataagccttctatatctgatttgcttgctattgggcgcggtaatgattcctacgatgaaaataaaaacggcttgcttgttctcgatgagtgcggtacttggtttaatacccgttcttggaatgataaggaaagacagccgattattgattggtttctacatgctcgtaaattaggatgggatattatttttcttgttcaggacttatctattgttgataaacaggcgcgttctgcattagctgaacatgttgtttattgtcgtcgtctggacagaattactttaccttttgtcggtactttatattctcttattactggctcgaaaatgcctctgcctaaattacatgttggcgttgttaaatatggcgattctcaattaagccctactgttgagcgttggctttatactggtaagaatttgtataacgcatatgatactaaacaggctttttctagtaattatgattccggtgtttattcttatttaacgccttatttatcacacggtcggtatttcaaaccattaaatttaggtcagaagatgaaattaactaaaatatatttgaaaaagttttctcgcgttctttgtcttgcgattggatttgcatcagcatttacatatagttatataacccaacctaagccggaggttaaaaaggtagtctctcagacctatgattttgataaattcactattgactcttctcagcgtcttaatctaagctatcgctatgttttcaaggattctaagggaaaattaattaatagcgacgatttacagaagcaaggttattcactcacatatattgatttatgtactgtttccattaaaaaaggtaattcaaatgaaattgttaaatgtaattaattttgttttcttgatgtttgtttcatcatcttcttttgctcaggtaattgaaatgaataattcgcctctgcgcgattttgtaacttggtattcaaagcaatcaggcgaatccgttattgtttctcccgatgtaaaaggtactgttactgtatattcatctgacgttaaacctgaaaatctacgcaatttctttatttctgttttacgtgcaaataattttgatatggtaggttctaacccttccataattcagaagtataatccaaacaatcaggattatattgatgaattgccatcatctgataatcaggaatatgatgataattccgctccttctggtggtttctttgttccgcaaaatgataatgttactcaaacttttaaaattaataacgttcgggcaaaggatttaatacgagttgtcgaattgtttgtaaagtctaatacttctaaatcctcaaatgtattatctattgacggctctaatctattagttgttagtgctcctaaagatattttagataaccttcctcaattcctttcaactgttgatttgccaactgaccagatattgattgagggtttgatatttgaggttcagcaaggtgatgctttagatttttcatttgctgctggctctcagcgtggcactgttgcaggcggtgttaatactgaccgcctcacctctgttttatcttctgctggtggttcgttcggtatttttaatggcgatgttttagggctatcagttcgcgcattaaagactaatagccattcaaaaatattgtctgtgccacgtattcttacgctttcaggtcagaagggttctatctctgttggccagaatgtcccttttattactggtcgtgtgactggtgaatctgccaatgtaaataatccatttcagacgattgagcgtcaaaatgtaggtatttccatgagcgtttttcctgttgcaatggctggcggtaatattgttctggatattaccagcaaggccgatagtttgagttcttctactcaggcaagtgatgttattactaatcaaagaagtattgctacaacggttaatttgcgtgatggacagactcttttactcggtggcctcactgattataaaaacacttctcaggattctggcgtaccgttcctgtctaaaatccctttaatcggcctcctgtttagctcccgctctgattctaacgaggaaagcacgttatacgtgctcgtcaaagcaaccatagtacgcgccctgtagcggcgcattaagcgcggcgggtgtggtggttacgcgcagcgtgaccgctacacttgccagcgccctagcgcccgctcctttcgctttcttcccttcctttctcgccacgttcgccggctttccccgtcaagctctaaatcgggggctccctttagggttccgatttagtgctttacggcacctcgaccccaaaaaacttgatttgggtgatggttcacgtagtgggccatcgccctgatagacggtttttcgccctttgacgttggagtccacgttctttaatagtggactcttgttccaaactggaacaacactcaaccctatctcgggctattcttttgatttataagggattttgccgatttcggaaccaccatcaaacaggattttcgcctgctggggcaaaccagcgtggaccgcttgctgcaactctctcagggccaggcggtgaagggcaatcagctgttgcccgtctcactggtgaaaagaaaaaccaccctggatccaagcttgcaggtggcacttttcggggaaatgtgcgcggaacccctatttgtttatttttctaaatacattcaaatatgtatccgctcatgagacaataaccctgataaatgcttcaataatattgaaaaaggaagagtatgagtattcaacatttccgtgtcgcccttattcccttttttgcggcattttgccttcctgtttttgctcacccagaaacgctggtgaaagtaaaagatgctgaagatcagttgggcgcactagtgggttacatcgaactggatctcaacagcggtaagatccttgagagttttcgccccgaagaacgttttccaatgatgagcacttttaaagttctgctatgtggcgcggtattatcccgtattgacgccgggcaagagcaactcggtcgccgcatacactattctcagaatgacttggttgagtactcaccagtcacagaaaagcatcttacggatggcatgacagtaagagaattatgcagtgctgccataaccatgagtgataacactgcggccaacttacttctgacaacgatcggaggaccgaaggagctaaccgcttttttgcacaacatgggggatcatgtaactcgccttgatcgttgggaaccggagctgaatgaagccataccaaacgacgagcgtgacaccacgatgcctgtagcaatggcaacaacgttgcgcaaactattaactggcgaactacttactctagcttcccggcaacaattaatagactggatggaggcggataaagttgcaggaccacttctgcgctcggcccttccggctggctggtttattgctgataaatctggagccggtgagcgtgggtctcgcggtatcattgcagcactggggccagatggtaagccctcccgtatcgtagttatctacacgacggggagtcaggcaactatggatgaacgaaatagacagatcgctgagataggtgcctcactgattaagcattggtaactgtcagaccaagtttactcatatatactttagattgatttaaaacttcatttttaatttaaaaggatctaggtgaagatcctttttgataatctcatgaccaaaatcccttaacgtgagttttcgttccactgtacgtaagacccccaagcttgtcgactgaatggcgaatggcgctttgcctggtttccggcaccagaagcggtgccggaaagctggctggagtgcgatcttcctgacgctcgagcgcaacgcaattaatgtgagttagctcactcattaggcaccccaggctttacactttatgcttccggctcgtatgttgtgtggaattgtgagcggataacaatttcacacaggaaacagctatgaccatgattacgccaagctttggagccttttttttggagattttcaacatgaaatacctattgcctacggcagccgctggattgttattactcgcggcccagccggccatggccgaagttcaattgttagagtctggtggcggtcttgttcagcctggtggttctttacgtctttcttgcgctgcttccggattcactttctcttcgtacgctatgtcttgggttcgccaagctcctggtaaaggtttggagtgggtttctgctatctctggttctggtggcagtacttactatgctgactccgttaaaggtcgcttcactatctctagagacaactctaagaatactctctacttgcagatgaacagcttaagggctgaggacactgcagtctactattgcgctaaagcctatcgtccttcttatcatgacatatggggtcaaggtactatggtcaccgtctctagtgcctccaccaagggcccatcggtcttcccgctagcaccctcctccaagagcacctctgggggcacagcggccctgggctgcctggtcaaggactacttccccgaaccggtgacggtgtcgtggaactcaggcgccctgaccagcggcgtccacaccttcccggctgtcctacagtcctcaggactctactccctcagcagcgtagtgaccgtgccctccagcagcttgggcacccagacctacatctgcaacgtgaatcacaagcccagcaacaccaaggtggacaagaaagttgagcccaaatcttgtgcggccgcacatcatcatcaccatcacggggccgcagaacaaaaactcatctcagaagaggatctgaatggggccgcagaggctagctctgctagtggcgacttcgactacgagaaaatggctaatgccaacaaaggcgccatgactgagaacgctgacgagaatgctttgcaaagcgatgccaagggtaagttagacagcgtcgcgaccgactatggcgccgccatcgacggctttatcggcgatgtcagtggtttggccaacggcaacggagccaccggagacttcgcaggttcgaattctcagatggcccaggttggagatggggacaacagtccgcttatgaacaactttagacagtaccttccgtctcttccgcagagtgtcgagtgccgtccattcgttttcggtgccggcaagccttacgagttcagcatcgactgcgataagatcaatcttttccgcggcgttttcgctttcttgctatacgtcgctactttcatgtacgttttcagcactttcgccaatattttacgcaacaaagaaagctagtgatctcctaggaagcccgcctaatgagcgggctttttttttctggtatgcatcctgaggccgatactgtcgtcgtcccctcaaactggcagatgcacggttacgatgcgcccatctacaccaacgtgacctatcccattacggtcaatccgccgtttgttcccacggagaatccgacgggttgttactcgctcacatttaatgttgatgaaagctggctacaggaaggccagacgcgaattatttttgatggcgttcctattggttaaaaaatgagctgatttaacaaaaatttaatgcgaattttaacaaaatattaacgtttacaatttaaatatttgcttatacaatcttcctgtttttggggcttttctgattatcaaccggggtacatatgattgacatgctagttttacgattaccgttcatcgattctcttgtttgctccagactctcaggcaatgacctgatagcctttgtagatctctcaaaaatagctaccctctccggcattaatttatcagctagaacggttgaatatcatattgatggtgatttgactgtctccggcctttctcacccttttgaatctttacctacacattactcaggcattgcatttaaaatatatgagggttctaaaaatttttatccttgcgttgaaataaaggcttctcccgcaaaagtattacagggtcataatgtttttggtacaaccgatttagctttatgctctgaggctttattgcttaattttgctaattctttgccttgcctgtatgatttattggatgtt

SEQ ID NO: 895 - DNA, 5957 bp, Artificial Sequence
  Description of Artificial Sequence Synthetic polynucleotide
gacgaaagggcctcgtgatacgcctatttttataggttaatgtcatgataataatggtttcttagacgtcaggtggcacttttcggggaaatgtgcgcggaacccctatttgtttatttttctaaatacattcaaatatgtatccgctcatgagacaataaccctgataaatgcttcaataatattgaaaaaggaagagtatgagtattcaacatttccgtgtcgcccttattcccttttttgcggcattttgccttcctgtttttgctcacccagaaacgctggtgaaagtaaaagatgctgaagatcagttgggtgcccgagtgggttacatcgaactggatctcaacagcggtaagatccttgagagttttcgccccgaagaacgttttccaatgatgagcacttttaaagttctgctatgtggcgcggtattatcccgtattgacgccgggcaagagcaactcggtcgccgcatacactattctcagaatgacttggttgagtactcaccagtcacagaaaagcatcttacggatggcatgacagtaagagaattatgcagtgctgccataaccatgagtgataacactgcggccaacttacttctgacaacgatcggaggaccgaaggagctaaccgcttttttgcacaacatgggggatcatgtaactcgccttgatcgttgggaaccggagctgaatgaagccataccaaacgacgagcgtgacaccacgatgcctgtagcaatggcaacaacgttgcgcaaactattaactggcgaactacttactctagcttcccggcaacaattaatagactggatggaggcggataaagttgcaggaccacttctgcgctcggcccttccggctggctggtttattgctgataaatctggagccggtgagcgtgggtctcgcggtatcattgcagcactggggccagatggtaagccctcccgtatcgtagttatctacacgacggggagtcaggcaactatggatgaacgaaatagacagatcgctgagataggtgcctcactgattaagcattggtaactgtcagaccaagtttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgttcttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcatacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaagagcgcccaatacgcaaaccgcctctccccgcgcgttggccgattcattaatgcagctggcacgacaggtttcccgactggaaagcgggcagtgagcgcaacgcaattaatgtgagttagctcactcattaggcaccccaggctttacactttatgcttccggctcgtatgttgtgtggaattgtgagcggataacaatttcacacaggaaacagctatgaccatgattacgccaagctttggagccttttttttggagattttcaacgtgaaaaaattattattcgcaattcctttagttgttcctttctattctcacagtgcacaggtccaactgcaggagctcgagatcaaacgtggaactgtggctgcaccatctgtcttcatcttcccgccatctgatgagcagttgaaatctggaactgcctctgttgtgtgcctgctgaataacttctatcccagagaggccaaagtacagtggaaggtggataacgccctccaatcgggtaactcccaggagagtgtcacagagcaggacagcaaggacagcacctacagcctcagcagcaccctgacgctgagcaaagcagactacgagaaacacaaagtctacgcctgcgaagtcacccatcagggcctgagttcaccggtgacaaagagcttcaacaggggagagtgttaataaggcgcgcctaaccatctatttcaaggaacagtcttaatgaaaaagcttttattcatgatcccgttagttgtaccgttcgtggcccagccggcctctgctgaagttcaattgttagagtctggtggcggtcttgttcagcctggtggttctttacgtctttcttgcgctgcttccggagcttcagatctgtttgcctttttgtggggtggtgcagatcgcgttacggagatcgaccgactgcttgagcaaaagccacgcttaactgctgatcaggcatgggatgttattcgccaaaccagtcgtcaggatcttaacctgaggctttttttacctactctgcaagcagcgacatctggtttgacacagagcgatccgcgtcgtcagttggtagaaacattaacacgttgggatggcatcaatttgcttaatgatgatggtaaaacctggcagcagccaggctctgccatcctgaacgtttggctgaccagtatgttgaagcgtaccgtagtggctgccgtacctatgccatttgataagtggtacagcgccagtggctacgaaacaacccaggacggcccaactggttcgctgaatataagtgttggagcaaaaattttgtatgaggcggtgcagggagacaaatcaccaatcccacaggcggttgatctgtttgctgggaaaccacagcaggaggttgtgttggctgcgctggaagatacctgggagactctttccaaacgctatggcaataatgtgagtaactggaaaacaccggcaatggccttaacgttccgggcaaataatttctttggtgtaccgcaggccgcagcggaagaaacgcgtcatcaggcggagtatcaaaaccgtggaacagaaaacgatatgattgttttctcaccaacgacaagcgatcgtcctgtgcttgcctgggatgtggtcgcacccggtcagagtgggtttattgctcccgatggaacagttgataagcactatgaagatcagctgaaaatgtacgaaaattttggccgtaagtcgctctggttaacgaagcaggatgtggaggcgcataaggagttctagagacaactctaagaatactctctacttgcagatgaacagcttaagtctgagcattcggtccgggcaacattctccaaactgaccagacgacacaaacggcttacgctaaatcccgcgcatgggatggtaaagaggtggcgtctttgctggcctggactcatcagatgaaggccaaaaattggcaggagtggacacagcaggcagcgaaacaagcactgaccatcaactggtactatgctgatgtaaacggcaatattggttatgttcatactggtgcttatccagatcgtcaatcaggccatgatccgcgattacccgttcctggtacgggaaaatgggactggaaagggctattgccttttgaaatgaaccctaaggtgtataacccccagcagctagccatattctctcggtcaccgtctcaagcgcctccaccaagggcccatcggtcttcccgctagcaccctcctccaagagcacctctgggggcacagcggccctgggctgcctggtcaaggactacttccccgaaccggtgacggtgtcgtggaactcaggcgccctgaccagcggcgtccacaccttcccggctgtcctacagtctagcggactctactccctcagcagcgtagtgaccgtgccctcttctagcttgggcacccagacctacatctgcaacgtgaatcacaagcccagcaacaccaaggtggacaagaaagttgagcccaaatcttgtgcggccgcacatcatcatcaccatcacggggccgcagaacaaaaactcatctcagaagaggatctgaatggggccgcagaggctagttctgctagtaacgcgtcttccggtgattttgattatgaaaagatggcaaacgctaataagggggctatgaccgaaaatgccgatgaaaacgcgctacagtctgacgctaaaggcaaacttgattctgtcgctactgattacggtgctgctatcgatggtttcattggtgacgtttccggccttgctaatggtaatggtgctactggtgattttgctggctctaattcccaaatggctcaagtcggtgacggtgataattcacctttaatgaataatttccgtcaatatttaccttccctccctcaatcggttgaatgtcgcccttttgtctttggcgctggtaaaccatatgaattttctattgattgtgacaaaataaacttattccgtggtgtctttgcgtttcttttatatgttgccacctttatgtatgtattttctacgtttgctaacatactgcgtaataaggagtcttaatgaaacgcgtgatgagaattcactggccgtcgttttacaacgtcgtgactgggaaaaccctggcgttacccaacttaatcgccttgcagcacatccccctttcgccagctggcgtaatagcgaagaggcccgcaccgatcgcccttcccaacagttgcgcagcctgaatggcgaatggcgcctgatgcggtattttctccttacgcatctgtgcggtatttcacaccgcatacgtcaaagcaaccatagtacgcgccctgtagcggcgcattaagcgcggcgggtgtggtggttacgcgcagcgtgaccgctacacttgccagcgccttagcgcccgctcctttcgctttcttcccttcctttctcgccacgttcgccggctttccccgtcaagctctaaatcgggggctccctttagggttccgatttagtgctttacggcacctcgaccccaaaaaacttgatttgggtgatggttcacgtagtgggccatcgccctgatagacggtttttcgccctttgacgttggagtccacgttctttaatagtggactcttgttccaaactggaacaacactcaactctatctcgggctattcttttgatttataagggattttgccgatttcggtctattggttaaaaaatgagctgatttaacaaaaatttaacgcgaattttaacaaaatattaacgtttacaattttatggtgcagtctcagtacaatctgctctgatgccgcatagttaagccagccccgacacccgccaacacccgctgacgcgccctgacgggcttgtctgctcccggcatccgcttacagacaagctgtgaccgtctccgggagctgcatgtgtcagaggttttcaccgtcatcaccgaaacgcgcga

SEQ ID NO: 896 - DNA, 3412 bp, Artificial Sequence
  Description of Artificial Sequence Synthetic polynucleotide
gacgaaagggcctgctctgccagtgttacaaccaattaaccaattctgattagaaaaactcatcgagcatcaaatgaaactgcaatttattcatatcaggattatcaataccatatttttgaaaaagccgtttctgtaatgaaggagaaaactcaccgaggcagttccataggatggcaagatcctggtatcggtctgcgattccgactcgtccaacatcaatacaacctattaatttcccctcgtcaaaaataaggttatcaagtgagaaatcaccatgagtgacgactgaatccggtgagaatggcaaaagcttatgcatttctttccagacttgttcaacaggccagccattacgctcgtcatcaaaatcactcgcatcaaccaaaccgttattcattcgtgattgcgcctgagcgagacgaaatacgcgatcgctgttaaaaggacaattacaaacaggaattgaatgcaaccggcgcaggaacactgccagcgcatcaacaatattttcacctgaatcaggatattcttctaatacctggaatgctgttttcccggggatcgcagtggtgagtaaccatgcatcatcaggagtacggataaaatgcttgatggtcggaagaggcataaattccgtcagccagtttagtctgaccatctcatctgtaacatcattggcaacgctacctttgccatgtttcagaaacaactctggcgcatcgggcttcccatacaatcgatagattgtcgcacctgattgcccgacattatcgcgagcccatttatacccatataaatcagcatccatgttggaatttaatcgcggcctcgagcaagacgtttcccgttgaatatggctcataacaccccttgtattactgtttatgtaagcagacagttttattgttcatgatgatatatttttatcttgtgcaatgtaacatcagagattttgagacacaacgtggctttccccccccccccctgcaggtctcgggctattcctgtcagaccaagtttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgttcttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcatacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaagagcgcccaatacgcaaaccgcctctccccgcgcgttggccgattcattaatgcagctggcacgacaggtttcccgactggaaagcgggcagtgagcgcaacgcaattaatgtgagttagctcactcattaggcaccccaggctttacactttatgcttccggctcgtatgttgtgtggaattgtgagcggataacaatttcacacaggaaacagctatgaccatgattacgccaagctttggagccttttttttggagattttcaacatgaagaagctcctctttgctatcccgctcgtcgttccttttgtggcccagccggccatggccgacatccagatgacccagtctccatcctccctgtctgcatctgtaggagacagagtcaccatcacttgccgggcaagtcagagcattagcagctatttaaattggtatcagcagaaaccagggaaagcccctaagctcctgatctatgctgcatccagtttgcaaagtggggtcccatcaaggttcagtggcagtggatctgggacagatttcactctcaccatcagcagtctgcaacctgaagattttgcaacttactactgtcaacagagttacagtacccctttcactttcggccctgggaccaaagtggatatcaaacgtggtaccgtggctgcaccatctgtcttcatcttcccgccatctgatgagcagttgaaatctggaactgcctctgttgtgtgcctgctgaataacttctatcccagagaggccaaagtacagtggaaggtggataacgccctccaatcgggtaactcccaggagagtgtcacagagcaggacagcaaggacagcacctacagcctcagcagcaccctgacgctgagcaaagcagactacgagaaacacaaagtctacgcctgcgaagtcacccatcagggcctgagttcaccggtgacaaagagcttcaacaggggagagtgtgcggccgctggtaagcctatccctaaccctctcctcggtctcgattctacgtgataacttcaccggtcaacgcgtgatgagaattcactggccgtcgttttacaacgtcgtgactgggaaaaccctggcgttacccaacttaatcgccttgcagcacatccccctttcgccagctggcgtaatagcgaagaggcccgcaccgatcgcccttcccaacagttgcgcagcctgaatggcgaatggcgcctgatgcggtattttctccttacgcatctgtgcggtatttcacaccgcatacgtcaaagcaaccatagtctcagtacaatctgctctgatgccgcatagttaagccagccccgacacccgccaacacccgctgacgcgccctgacaggcttgtctgctcccggcatccgcttacagacaagctgtgaccgtctccgggagctgcatgtgtcagaggttttcaccgtcatcaccgaaacgcgcga

SEQ ID NO: 897 - protein, 232 aa, Artificial Sequence
  Description of Artificial Sequence Synthetic polypeptide
DIQMTQSPSSLSASVGDRVTITCRASQSISSYLNWYQQKPGKAPKLLIYAASSLQSGVPSRFSGSGSGTDFTLTISSLQPEDFATYYCQQSYSTPFTFGPGTKVDIKRGTVAAPSVFIFPPSDEQLKSGTASVVCLLNNFYPREAKVQWKVDNALQSGNSQESVTEQDSKDSTYSLSSTLTLSKADYEKHKVYACEVTHQGLSSPVTKSFNRGECAAAGKPIPNPLLGLDST

SEQ ID NO: 898 - protein, 39 aa, Artificial Sequence
  Description of Artificial Sequence Synthetic polypeptide
YYCAKDGGYCSSTSCYTYGYSYAEYFQHWGQGTLVTVSS

SEQ ID NO: 899 - protein, 39 aa, Artificial Sequence
  Description of Artificial Sequence Synthetic polypeptide
YYCAKGSYYYGSGSYYNMDSYYAEYFQHWGQGTLVTVSS

SEQ ID NO: 900 - protein, 39 aa, Artificial Sequence
  Description of Artificial Sequence Synthetic polypeptide
YYCAKDSYYYGSGSYYNSDSYSAEYFQHWGQGTLVTVSS

SEQ ID NO: 901 - protein, 51 aa, Artificial Sequence
  Description of Artificial Sequence Synthetic polypeptide
YYCAKYYSFSYYPYYYDSSGYYYAYYSDYSYSYYAEYFQHWGQGTLVTVSS

SEQ ID NO: 902 - protein, 39 aa, Artificial Sequence
  Description of Artificial Sequence Synthetic polypeptide
YYCAKSSGYCSSTSCYTNPYYYAEYFQHWGQGTLVTVSS

SEQ ID NO: 903 - protein, 51 aa, Artificial Sequence
  Description of Artificial Sequence Synthetic polypeptide
YYCAKSYQYYGYCSSTSCYTYYSYWSYSSYYSYYAEYFQHWGQGTLVTVSS

SEQ ID NO: 904 - protein, 51 aa, Artificial Sequence
  Description of Artificial Sequence Synthetic polypeptide
YYCAKYYSYYGYCSSTSCYTYSSSPSYSYYSSYYAEYFQHWGQGTLVTVSS

SEQ ID NO: 905 - protein, 50 aa, Artificial Sequence
  Description of Artificial Sequence Synthetic polypeptide
YYCAKSPSYYDYVWGSYRYTSSYTYYSYSYSSYAEYFQHWGQGTLVTVSS

SEQ ID NO: 906 - protein, 50 aa, Artificial Sequence
  Description of Artificial Sequence Synthetic polypeptide
YYCAKYAYSSESYYSSYYDYVWGSYRYTYSSYYAEYFQHWGQGTLVTVSS

SEQ ID NO: 907 - protein, 40 aa, Artificial Sequence
  Description of Artificial Sequence Synthetic polypeptide
YYCAKGSSYYYGSGSYYNSEYYSAEYFQHWGQGTLVTVSS

SEQ ID NO: 908 - protein, 49 aa, Artificial Sequence
  Description of Artificial Sequence Synthetic polypeptide
YYCARSSYYSYGYCTNGVCYTYSYSYYSYSYSYWYFDLWGRGTLVTVSS

SEQ ID NO: 909 - DNA, 18 bp, Artificial Sequence
  Description of Artificial Sequence Synthetic oligonucleotide
gcagtttattactgcgct

SEQ ID NO: 910 - DNA, 17 bp, Artificial Sequence
  Description of Artificial Sequence Synthetic oligonucleotide
agagtaccctggcccca

SEQ ID NO: 911 - DNA, 137 bp, Artificial Sequence
  Description of Artificial Sequence Synthetic polynucleotide
gcagtttattactgcgctaggtcttcctactattcctacggttattgtacaaatggcgtgactcctacatactcctactcttattattcctattcttactcttactggtactttgatctgtggggccagggtactct

SEQ ID NO: 912 - protein, 50 aa, Artificial Sequence
  Description of Artificial Sequence Synthetic polypeptide
YYCARSSSYYSYYSSGYCTNGVCYTYSSYYSSYYWYFDLWGRGTLVTVSS

SEQ ID NO: 913 - protein, 50 aa, Artificial Sequence
  Description of Artificial Sequence Synthetic polypeptide
YYCAKYSYYSSSYYYSDYVWGSYRYTSYYSYYYAEYFQHWGQGTLVTVSS

SEQ ID NO: 914 - protein, 51 aa, Artificial Sequence
  Description of Artificial Sequence Synthetic polypeptide
YYCAKSYYYSSYSYYYDYVWGSYRYTSYSSSSYYAEYFQHWGQGTLVTVSS

SEQ ID NO: 915 - protein, 51 aa, Artificial Sequence
  Description of Artificial Sequence Synthetic polypeptide
YYCAKSSSYYSYSYSGYCSGGSCYSSYYYSSYYSAEYFQGWGQGTLVTVSS

SEQ ID NO: 916 - protein, 50 aa, Artificial Sequence
  Description of Artificial Sequence Synthetic polypeptide
YYCAKYSSYSYYDYVWGSYRYTSSSYSYYSYYYAEYFQGWGQGTLVTVSS

SEQ ID NO: 917 - protein, 50 aa, Artificial Sequence
  Description of Artificial Sequence Synthetic polypeptide
YYCAKSSYYYSSSYYDYVWGSYRYTSSYYSYSYAEYFQGWGQGTLVTVSS

SEQ ID NO: 918 - protein, 51 aa, Artificial Sequence
  Description of Artificial Sequence Synthetic polypeptide
YYCAKYSSSSYSYYYYDSSGYYYSYYSSSYYSYYAEYFQGWGQGTLVTVSS

SEQ ID NO: 919 - protein, 49 aa, Artificial Sequence
  Description of Artificial Sequence Synthetic polypeptide
YYCAKYSSYSSYYYYDSSGYYYSSYSSYSYYYAEYFQGWGQGTLVTVSS

SEQ ID NO: 920 - DNA, 97 bp, Artificial Sequence; identical to SEQ ID NO: 151
  Description of Artificial Sequence Synthetic oligonucleotide

SEQ ID NO: 921 - DNA, 5225 bp, Artificial Sequence
  Description of Artificial Sequence Synthetic polynucleotide
gacgaaagggcctcgtgatacgcctatttttataggttaatgtcatgataataatggtttcttagacgtcaggtggcacttttcggggaaatgtgcgcggaacccctatttgtttatttttctaaatacattcaaatatgtatccgctcatgagacaataaccctgataaatgcttcaataatattgaaaaaggaagagtatgagtattcaacatttccgtgtcgcccttattcccttttttgcggcattttgccttcctgtttttgctcacccagaaacgctggtgaaagtaaaagatgctgaagatcagttgggtgcccgagtgggttacatcgaactggatctcaacagcggtaagatccttgagagttttcgccccgaagaacgttttccaatgatgagcacttttaaagttctgctatgtggcgcggtattatcccgtattgacgccgggcaagagcaactcggtcgccgcatacactattctcagaatgacttggttgagtactcaccagtcacagaaaagcatcttacggatggcatgacagtaagagaattatgcagtgctgccataaccatgagtgataacactgcggccaacttacttctgacaacgatcggaggaccgaaggagctaaccgcttttttgcacaacatgggggatcatgtaactcgccttgatcgttgggaaccggagctgaatgaagccataccaaacgacgagcgtgacaccacgatgcctgtagcaatggcaacaacgttgcgcaaactattaactggcgaactacttactctagcttcccggcaacaattaatagactggatggaggcggataaagttgcaggaccacttctgcgctcggcccttccggctggctggtttattgctgataaatctggagccggtgagcgtgggtctcgcggtatcattgcagcactggggccagatggtaagccctcccgtatcgtagttatctacacgacggggagtcaggcaactatggatgaacgaaatagacagatcgctgagataggtgcctcactgattaagcattggtaactgtcagaccaagtttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgttcttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcatacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaagagcgcccaatacgcaaaccgcctctccccgcgcgttggccgattcattaatgcagctggcacgacaggtttcccgactggaaagcgggcagtgagcgcaacgcaattaatgtgagttagctcactcattaggcaccccaggctttacactttatgcttccggctcgtatgttgtgtggaattgtgagcggataacaatttcacacaggaaacagctatgaccatgattacgccaagctttggagccttttttttggagattttcaacatgaagaaactgctgtctgctatcccactagttgtccctttctattctcatagtgaaatcgttctgacccagtccccggggaccctgtctctgtctccgggtgaacgtgctacgctgagctgtcgtgcttctcaatccgttagctcctcttatttagcttggtatcagcaaaagccgggtcaagctccgcggctgttgatctatggtgcctctagtcgtgctactggcatccctgatcgtttctctggctctggctccggaaccgatttcactctgaccatttctcgtctcgagccggaagatttcgctgtctactattgtcaacagtatggttctagtccgctgactttcggtggcggtaccaaagtcgaaatcaagcgtggaactgtggctgcaccatctgtcttcatcttcccgccatctgatgagcagttgaaatctggaactgcctctgttgtgtgcctgctgaataacttctatcccagagaggccaaagtacagtggaaggtggataacgccctccaatcgggtaactcccaggagagtgtcacagagcaggacagcaaggacagcacctacagcctcagcagcaccctgactctgtccaaagcagactacgagaaacacaaagtctacgcctgcgaagtcacccatcagggcctgagttcaccggtgacaaagagcttcaacaggggagagtgttaataaggcgcgccaatttaaccatctatttcaaggaacagtcttaatgaagaagctcctctttgctatcccgctcgtcgttccttttgtggcccagccggccatggccgaagttcaattgttagagtctggtggcggtcttgttcagcctggtggttctttacgtctttcttgcgctgcttccggattcactttctctcgttacaagatgaagtgggttcgccaagctcctggtaaaggtttggagtgggtttctgttatctatccttctggtggcggtactggttatgctgactccgttaaaggtcgcttcactatctctagagacaactctaagaatactctctacttgcagatgaacagcttaagggctgaggacactgcagtctactattgtgcgagagtcaattactatgatagtagtggttacggtcctatagctcctggacttgactactggggccagggaaccctggtcaccgtctcaagcgcctccaccaagggtccgtcggtcttcccgctagcaccctcctccaagagcacctctgggggcacagcggccctgggctgcctggtcaaggactacttccccgaaccggtgacggtgtcgtggaactcaggcgccctgaccagcggcgtccacaccttcccggctgtcctacagtctagcggactctactccctcagcagcgtagtgaccgtgccctcttctagcttgggcacccagacctacatctgcaacgtgaatcacaagcccagcaacaccaaggtggacaagaaagttgagcccaaatcttgtgcggccgcacatcatcatcaccatcacggggccgcagaacaaaaactcatctcagaagaggatctgaatggggccgcagaggctagttctgctagtaacgcgtcttccggtgattttgattatgaaaagatggcaaacgctaataagggggctatgaccgaaaatgccgatgaaaacgcgctacagtctgacgctaaaggcaaacttgattctgtcgctactgattacggtgctgctatcgatggtttcattggtgacgtttccggccttgctaatggtaatggtgctactggtgattttgctggctctaattcccaaatggctcaagtcggtgacggtgataattcacctttaatgaataatttccgtcaatatttaccttccctccctcaatcggttgaatgtcgcccttttgtctttggcgctggtaaaccatatgaattttctattgattgtgacaaaataaacttattccgtggtgtctttgcgtttcttttatatgttgccacctttatgtatgtattttctacgtttgctaacatactgcgtaataaggagtcttaatgaaacgcgtgatgagaattcactggccgtcgttttacaacgtcgtgactgggaaaaccctggcgttacccaacttaatcgccttgcagcacatccccctttcgccagctggcgtaatagcgaagaggcccgcaccgatcgcccttcccaacagttgcgcagcctgaatggcgaatggcgcctgatgcggtattttctccttacgcatctgtgcggtatttcacaccgcatacgtcaaagcaaccatagtacgcgccctgtagcggcgcattaagcgcggcgggtgtggtggttacgcgcagcgtgaccgctacacttgccagcgccttagcgcccgctcctttcgctttcttcccttcctttctcgccacgttcgccggctttccccgtcaagctctaaatcgggggctccctttagggttccgatttagtgctttacggcacctcgaccccaaaaaacttgatttgggtgatggttcacgtagtgggccatcgccctgatagacggtttttcgccctttgacgttggagtccacgttctttaatagtggactcttgttccaaactggaacaacactcaactctatctcgggctattcttttgatttataagggattttgccgatttcggtctattggttaaaaaatgagctgatttaacaaaaatttaacgcgaattttaacaaaatattaacgtttacaattttatggtgcagtctcagtacaatctgctctgatgccgcatagttaagccagccccgacacccgccaacacccgctgacgcgccctgacgggcttgtctgctcccggcatccgcttacagacaagctgtgaccgtctccgggagctgcatgtgtcagaggttttcaccgtcatcaccgaaacgcgcga

SEQ ID NO: 922 - protein, 7 aa, Artificial Sequence
  Description of Artificial Sequence Synthetic peptide
GASQSVS

SEQ ID NO: 923 - protein, 7 aa, Artificial Sequence
  Description of Artificial Sequence Synthetic peptide
DASSRAT

SEQ ID NO: 924 - protein, 9 aa, Artificial Sequence
  Description of Artificial Sequence Synthetic peptide
QQYGSSPLY

SEQ ID NO: 925 - protein, 12 aa, Artificial Sequence
  Description of Artificial Sequence Synthetic peptide
RASQSVSSSYLA

SEQ ID NO: 926 - protein, 7 aa, Artificial Sequence
  Description of Artificial Sequence Synthetic peptide
GASSRAT

SEQ ID NO: 927 - protein, 9 aa, Artificial Sequence
  Description of Artificial Sequence Synthetic polypeptide
QQSYSSPWT

SEQ ID NO: 928 - protein, 234 aa, Artificial Sequence
  Description of Artificial Sequence Synthetic polypeptide
MKKLLSAIPLVVPFYSHSEIVLTQSPGTLSLSPGERATLSCRASQSVSSSYLAWYQQKPGQAPRLLIYGASSRATGIPDRFSGSGSGTDFTLTISRLEPEDFAVYYCQQYGSSPLTFGGGTKVEIKRGTVAAPSVFIFPPSDEQLKSGTASVVCLLNNFYPREAKVQWKVDNALQSGNSQESVTEQDSKDSTYSLSSTLTLSKADYEKHKVYACEVTHQGLSSPVTKSFNRGEC

SEQ ID NO: 929 - DNA, 754 bp, Artificial Sequence
  Description of Artificial Sequence Synthetic polynucleotide
aagctttggagccttttttttggagattttcaacatgaagaaactgctgtctgctatcccactagttgtccctttctattctcatagtgaaatcgttctgacccagtccccggggaccctgtctctgtctccgggtgaacgtgctacgctgagctgtcgtgcttctcaatccgttagctcctcttatttagcttggtatcagcaaaagccgggtcaagctccgcggctgttgatctatggtgcctctagtcgtgctactggcatccctgatcgtttctctggctctggctccggaaccgatttcactctgaccatttctcgtctcgagccggaagatttcgctgtctactattgtcaacagtatggttctagtccgctgactttcggtggcggtaccaaagtcgaaatcaagcgtggaactgtggctgcaccatctgtcttcatcttcccgccatctgatgagcagttgaaatctggaactgcctctgttgtgtgcctgctgaataacttctatcccagagaggccaaagtacagtggaaggtggataacgccctccaatcgggtaactcccaggagagtgtcacagagcaggacagcaaggacagcacctacagcctcagcagcaccctgactctgtccaaagcagactacgagaaacacaaagtctacgcctgcgaagtcacccatcagggcctgagttcaccggtgacaaagagcttcaacaggggagagtgttaataaggcgcgccaatt

SEQ ID NO: 930 - protein, 31 aa, Artificial Sequence
  Description of Artificial Sequence Synthetic polypeptide
YYCAKSDGYYYDSSGYYYDYWGQGTLVTVSS

SEQ ID NO: 931 - protein, 31 aa, Artificial Sequence
  Description of Artificial Sequence Synthetic polypeptide
YYCAKGSGYCSGGSCYSFDYWGQGTLVTVSS

SEQ ID NO: 932 - protein, 6 aa, Artificial Sequence
  Description of Artificial Sequence Synthetic peptide
GYSSGY

SEQ ID NO: 933 - protein, 5 aa, Artificial Sequence
  Description of Artificial Sequence Synthetic peptide
GIAAA

SEQ ID NO: 934 - protein, 3 aa, Artificial Sequence
  Description of Artificial Sequence Synthetic peptide
QRL

SEQ ID NO: 935 - protein, 11 aa, Homo sapiens
RASQSISSYLN

SEQ ID NO: 936 - protein, 5 aa, Artificial Sequence
  Description of Artificial Sequence Synthetic peptide
YYCAX

SEQ ID NO: 937 - protein, 5 aa, Artificial Sequence
  Description of Artificial Sequence Synthetic peptide
YGYSY

SEQ ID NO: 938 - protein, 4 aa, Artificial Sequence
  Description of Artificial Sequence Synthetic peptide
YYCA

SEQ ID NO: 939 - protein, 4 aa, Artificial Sequence
  Description of Artificial Sequence Synthetic peptide
WGQG

SEQ ID NO: 940 - protein, 39 aa, Artificial Sequence
  Description of Artificial Sequence Synthetic polypeptide
YYCAKXXYXXGXGXXYNXXXYXAXXFQHWGQGTLVTVSS

SEQ ID NO: 941 - protein, 4 aa, Homo sapiens
SGWY

SEQ ID NO: 942 - protein, 4 aa, Artificial Sequence
  Description of Artificial Sequence Synthetic peptide
YYSS

SEQ ID NO: 943 - protein, 6 aa, Artificial Sequence
  Description of Artificial Sequence Synthetic peptide
YDGSYS

SEQ ID NO: 944 - protein, 4 aa, Artificial Sequence
  Description of Artificial Sequence Synthetic peptide
YFQH

SEQ ID NO: 945 - protein, 8 aa, Artificial Sequence
  Description of Artificial Sequence Synthetic peptide
SYRYSGYS

SEQ ID NO: 946 - protein, 10 aa, Artificial Sequence
  Description of Artificial Sequence Synthetic peptide
SYDSYRSYGS

SEQ ID NO: 947 - protein, 4 aa, Artificial Sequence
  Description of Artificial Sequence Synthetic peptide
SYSY

SEQ ID NO: 948 - protein, 4 aa, Artificial Sequence
  Description of Artificial Sequence Synthetic peptide
YSSY

SEQ ID NO: 949 - protein, 4 aa, Artificial Sequence
  Description of Artificial Sequence Synthetic peptide
SYYS

SEQ ID NO: 950 - DNA, 7423 bp, Artificial Sequence
  Description of Artificial Sequence Synthetic polynucleotide
aatgctactactattagtagaattgatgccaccttttcagctcgcgccccaaatgaaaatatagctaaacaggttattgaccatttgcgaaatgtatctaatggtcaaactaaatctactcgttcgcagaattgggaatcaactgttatatggaatgaaacttccagacaccgtactttagttgcatatttaaaacatgttgagctacagcattatattcagcaattaagctctaagccatccgcaaaaatgacctcttatcaaaaggagcaattaaaggtactctctaatcctgacctgttggagtttgcttccggtctggttcgctttgaagctcgaattaaaacgcgatatttgaagtctttcgggcttcctcttaatctttttgatgcaatccgctttgcttctgactataatagtcagggtaaagacctgatttttgatttatggtcattctcgttttctgaactgtttaaagcatttgagggggattcaatgaatatttatgacgattccgcagtattggacgctatccagtctaaacattttactattaccccctctggcaaaacttcttttgcaaaagcctctcgctattttggtttttatcgtcgtctggtaaacgagggttatgatagtgttgctcttactatgcctcgtaattccttttggcgttatgtatctgcattagttgaatgtggtattcctaaatctcaactgatgaatctttctacctgtaataatgttgttccgttagttcgttttattaacgtagatttttcttcccaacgtcctgactggtataatgagccagttcttaaaatcgcataaggtaattcacaatgattaaagttgaaattaaaccatctcaagcccaatttactactcgttctggtgtttctcgtcagggcaagccttattcactgaatgagcagctttgttacgttgatttgggtaatgaatatccggttcttgtcaagattactcttgatgaaggtcagccagcctatgcgcctggtctgtacaccgttcatctgtcctctttcaaagttggtcagttcggttcccttatgattgaccgtctgcgcctcgttccggctaagtaacatggagcaggtcgcggatttcgacacaatttatcaggcgatgatacaaatctccgttgtactttgtttcgcgcttggtataatcgctgggggtcaaagatgagtgttttagtgtattcttttgcctctttcgttttaggttggtgccttcgtagtggcattacgtattttacccgtttaatggaaacttcctcatgaaaaagtctttagtcctcaaagcctctgtagccgttgctaccctcgttccgatgctgtctttcgctgctgagggtgacgatcccgcaaaagcggcctttaactccctgcaagcctcagcgaccgaatatatcggttatgcgtgggcgatggttgttgtcattgtcggcgcaactatcggtatcaagctgtttaagaaattcacctcgaaagcaagctgataaaccgatacaattaaaggctccttttggagccttttttttggagattttcaacgtgaaaaaattattattcgcaattcctttagttgttcctttctattctcactccgctgaaactgttgaaagttgtttagcaaaatcccatacagaaaattcatttactaacgtctggaaagacgacaaaactttagatcgttacgctaactatgagggctgtctgtggaatgctacaggcgttgtagtttgtactggtgacgaaactcagtgttacggtacatgggttcctattgggcttgctatccctgaaaatgagggtggtggctctgagggtggcggttctgagggtggcggttctgagggtggcggtactaaacctcctgagtacggtgatacacctattccgggctatacttatatcaaccctctcgacggcacttatccgcctggtactgagcaaaaccccgctaatcctaatccttctcttgaggagtctcagcctcttaatactttcatgtttcagaataataggttccgaaataggcagggggcattaactgtttatacgggcactgttactcaaggcactgaccccgttaaaacttattaccagtacactcctgtatcatcaaaagccatgtatgacgcttactggaacggtaaattcagagactgcgctttccattctggctttaatgaggatttatttgtttgtgaatatcaaggccaatcgtctgacctgcctcaacctcctgtcaatgctggcggcggctctggtggtggttctggtggcggctctgagggtggtggctctgagggtggcggttctgagggtggcggctctgagggaggcggttccggtggtggctctggttccggtgattttgattatgaaaagatggcaaacgctaataagggggctatgaccgaaaatgccgatgaaaacgcgctacagtctgacgctaaaggcaaacttgattctgtcgctactgattacggtgctgctatcgatggtttcattggtgacgtttccggccttgctaatggtaatggtgctactggtgattttgctggctctaattcccaaatggctcaagtcggtgacggtgataattcacctttaatgaataatttccgtcaatatttaccttccctccctcaatcggttgaatgtcgcccttttgtctttggcgctggtaaaccatatgaattttctattgattgtgacaaaataaacttattccgtggtgtctttgcgtttcttttatatgttgccacctttatgtatgtattttctacgtttgctaacatactgcgtaataaggagtcttaatcatgccagttcttttgggtattccgttattattgcgtttcctcggtttccttctggtaactttgttcggctatctgcttacttttcttaaaaagggcttcggtaagatagctattgctatttcattgtttcttgctcttattattgggcttaactcaattcttgtgggttatctctctgatattagcgctcaattaccctctgactttgttcagggtgttcagttaattctcccgtctaatgcgcttccctgtttttatgttattctctctgtaaaggctgctattttcatttttgacgttaaacaaaaaatcgtttcttatttggattgggataaataatatggctgtttattttgtaactggcaaattaggctctggaaagacgctcgttagcgttggtaagattcaggataaaattgtagctgggtgcaaaatagcaactaatcttgatttaaggcttcaaaacctcccgcaagtcgggaggttcgctaaaacgcctcgcgttcttagaataccggataagccttctatatctgatttgcttgctattgggcgcggtaatgattcctacgatgaaaataaaaacggcttgcttgttctcgatgagtgcggtacttggtttaatacccgttcttggaatgataaggaaagacagccgattattgattggtttctacatgctcgtaaattaggatgggatattatttttcttgttcaggacttatctattgttgataaacaggcgcgttctgcattagctgaacatgttgtttattgtcgtcgtctggacagaattactttaccttttgtcggtactttatattctcttattactggctcgaaaatgcctctgcctaaattacatgttggcgttgttaaatatggcgattctcaattaagccctactgttgagcgttggctttatactggtaagaatttgtataacgcatatgatactaaacaggctttttctagtaattatgattccggtgtttattcttatttaacgccttatttatcacacggtcggtatttcaaaccattaaatttaggtcagaagatgaaattaactaaaatatatttgaaaaagttttctcgcgttctttgtcttgcgattggatttgcatcagcatttacatatagttatataacccaacctaagccggaggttaaaaaggtagtctctcagacctatgattttgataaattcactattgactcttctcagcgtcttaatctaagctatcgctatgttttcaaggattctaagggaaaattaattaatagcgacgatttacagaagcaaggttattcactcacatatattgatttatgtactgtttccattaaaaaaggtaattcaaatgaaattgttaaatgtaattaattttgttttcttgatgtttgtttcatcatcttcttttgctcaggtaattgaaatgaataattcgcctctgcgcgattttgtaacttggtattcaaagcaatcaggcgaatccgttattgtttctcccgatgtaaaaggtactgttactgtatattcatctgacgttaaacctgaaaatctacgcaatttctttatttctgttttacgtgcaaataattttgatatggtaggttctaacccttccataattcagaagtataatccaaacaatcaggattatattgatgaattgccatcatctgataatcaggaatatgatgataattccgctccttctggtggtttctttgttccgcaaaatgataatgttactcaaacttttaaaattaataacgttcgggcaaaggatttaatacgagttgtcgaattgtttgtaaagtctaatacttctaaatcctcaaatgtattatctattgacggctctaatctattagttgttagtgctcctaaagatattttagataaccttcctcaattcctttcaactgttgatttgccaactgaccagatattgattgagggtttgatatttgaggttcagcaaggtgatgctttagatttttcatttgctgctggctctcagcgtggcactgttgcaggcggtgttaatactgaccgcctcacctctgttttatcttctgctggtggttcgttcggtatttttaatggcgatgttttagggctatcagttcgcgcattaaagactaatagccattcaaaaatattgtctgtgccacgtattcttacgctttcaggtcagaagggttctatctctgttggccagaatgtcccttttattactggtcgtgtgactggtgaatctgccaatgtaaataatccatttcagacgattgagcgtcaaaatgtaggtatttccatgagcgtttttcctgttgcaatggctggcggtaatattgttctggatattaccagcaaggccgatagtttgagttcttctactcaggcaagtgatgttattactaatcaaagaagtattgctacaacggttaatttgcgtgatggacagactcttttactcggtggcctcactgattataaaaacacttctcaggattctggcgtaccgttcctgtctaaaatccctttaatcggcctcctgtttagctcccgctctgattctaacgaggaaagcacgttatacgtgctcgtcaaagcaaccatagtacgcgccctgtagcggcgcattaagcgcggcgggtgtggtggttacgcgcagcgtgaccgctacacttgccagcgccctagcgcccgctcctttcgctttcttcccttcctttctcgccacgttcgccggctttccccgtcaagctctaaatcgggggctccctttagggttccgatttagtgctttacggcacctcgaccccaaaaaacttgatttgggtgatggttcacgtagtgggccatcgccctgatagacggtttttcgccctttgacgttggagtccacgttctttaatagtggactcttgttccaaactggaacaacactcaaccctatctcgggctattcttttgatttataagggattttgccgatttcggaaccaccatcaaacaggattttcgcctgctggggcaaaccagcgtggaccgcttgctgcaactctctcagggccaggcggtgaagggcaatcagctgttgcccgtctcactggtgaaaagaaaaaccaccctggatccaagcttgcaggtggcacttttcggggaaatgtgcgcggaacccctatttgtttatttttctaaatacattcaaatatgtatccgctcatgagacaataaccctgataaatgcttcaataatattgaaaaaggaagagtatgagtattcaacatttccgtgtcgcccttattcccttttttgcggcattttgccttcctgtttttgctcacccagaaacgctggtgaaagtaaaagatgctgaagatcagttgggcgcactagtgggttacatcgaactggatctcaacagcggtaagatccttgagagttttcgccccgaagaacgttttccaatgatgagcacttttaaagttctgctatgtggcgcggtattatcccgtattgacgccgggcaagagcaactcggtcgccgcatacactattctcagaatgacttggttgagtactcaccagtcacagaaaagcatcttacggatggcatgacagtaagagaattatgcagtgctgccataaccatgagtgataacactgcggccaacttacttctgacaacgatcggaggaccgaaggagctaaccgcttttttgcacaacatgggggatcatgtaactcgccttgatcgttgggaaccggagctgaatgaagccataccaaacgacgagcgtgacaccacgatgcctgtagcaatggcaacaacgttgcgcaaactattaactggcgaactacttactctagcttcccggcaacaattaatagactggatggaggcggataaagttgcaggaccacttctgcgctcggcccttccggctggctggtttattgctgataaatctggagccggtgagcgtgggtctcgcggtatcattgcagcactggggccagatggtaagccctcccgtatcgtagttatctacacgacggggagtcaggcaactatggatgaacgaaatagacagatcgctgagataggtgcctcactgattaagcattggtaactgtcagaccaagtttactcatatatactttagattgatttaaaacttcatttttaatttaaaaggatctaggtgaagatcctttttgataatctcatgaccaaaatcccttaacgtgagttttcgttccactgtacgtaagacccccaagcttgtcgactgaatggcgaatggcgctttgcctggtttccggcaccagaagcggtgccggaaagctggctggagtgcgatcttcctgacgctcgagcgcaacgcaattaatgtgagttagctcactcattaggcaccccaggctttacactttatgcttccggctcgtatgttgtgtggaattgtgagcggataacaatttcacacaggaaacagctatgaccatgattacgccaagctttggagccttttttttggagattttcaac

SEQ ID NO: 951 - protein, 4 aa, Artificial Sequence
  Description of Artificial Sequence Synthetic peptide
KFQH

SEQ ID NO: 952 - protein, 4 aa, Artificial Sequence
  Description of Artificial Sequence Synthetic peptide
KTTG

SEQ ID NO: 953 - protein, 5 aa, Artificial Sequence
  Description of Artificial Sequence Synthetic peptide
KYFDL

SEQ ID NO: 954 - protein, 5 aa, Artificial Sequence
  Description of Artificial Sequence Synthetic peptide
KLLWF

SEQ ID NO: 955 - protein, 18 aa, Artificial Sequence
  Description of Artificial Sequence Synthetic peptide
KYYYDSSGYYYAEYFQHW

SEQ ID NO: 956 - protein, 18 aa, Artificial Sequence
  Description of Artificial Sequence Synthetic peptide
KGYCSSTSCYTAEYFQHW

SEQ ID NO: 957 - protein, 25 aa, Artificial Sequence
  Description of Artificial Sequence Synthetic peptide
KDYGYCSSTSCYTYGYSYAEYFQHW

SEQ ID NO: 958 - protein, 17 aa, Artificial Sequence
  Description of Artificial Sequence Synthetic peptide
KGSGYCSGGSCYSFDYW

SEQ ID NO: 959 - protein, 4 aa, Artificial Sequence
  Description of Artificial Sequence Synthetic peptide
NYLA

SEQ ID NO: 960 - protein, 96 aa, Artificial Sequence
  Description of Artificial Sequence Synthetic polypeptide
EIVLTQSPGTLSLSPGERATLSCRASQSVSSSYLAWYQQKPGQAPRLLIYGASSRATGIPDRFSGSGSGTDFTLTISRLEPEDFAVYYCQQYGSSP

SEQ ID NO: 961 - protein, 96 aa, Artificial Sequence
  Description of Artificial Sequence Synthetic polypeptide
EIVLTQSPATLSLSPGERATLSCGASQSVSSSYLAWYQQKPGLAPRLLIYDASSRATGIPDRFSGSGSGTDFTLTISRLEPEDFAVYYCQQYGSSP

SEQ ID NO: 962 - protein, 95 aa, Artificial Sequence
  Description of Artificial Sequence Synthetic polypeptide
EIVMTQSPATLSVSPGERATLSCRASQSVSSNLAWYQQKPGQAPRLLIYGASTRATGIPARFSGSGSGTEFTLTISSLQSEDFAVYYCQQYNNWP

SEQ ID NO: 963 - protein, 95 aa, Artificial Sequence
  Description of Artificial Sequence Synthetic polypeptide
EIVLTQSPATLSLSPGERATLSCRASQSVSSYLAWYQQKPGQAPRLLIYDASNRATGIPARFSGSGSGTDFTLTISSLEPEDFAVYYCQQRSNWP

SEQ ID NO: 964 - protein, 95 aa, Artificial Sequence
  Description of Artificial Sequence Synthetic polypeptide
EIVLTQSPATLSLSPGERATLSCRASQGVSSYLAWYQQKPGQAPRLLIYDASNRATGIPARFSGSGPGTDFTLTISSLEPEDFAVYYCQQRSNWH

SEQ ID NO: 965 - protein, 96 aa, Artificial Sequence
  Description of Artificial Sequence Synthetic polypeptide
EIVMTQSPATLSLSPGERATLSCRASQSVSSSYLSWYQQKPGQAPRLLIYGASTRATGIPARFSGSGSGTDFTLTISSLQPEDFAVYYCQQDYNLP

SEQ ID NO: 966 - protein, 9 aa, Artificial Sequence
  Description of Artificial Sequence Synthetic peptide
QQYGSSPLT

SEQ ID NO: 967 - DNA, 171 bp, Artificial Sequence
  Description of Artificial Sequence Synthetic polynucleotide
actatctctagagacaactctaagaatactctctacttgcagatgaacagcttaagggctgaggacactgcagtctactattgcgctaaannnnnnnnnnnnnnnnnntgtnnnnnnnnnnnntgtnnnnnnnnnnnntggggtcaaggtactttggtcaccgtctctagt

SEQ ID NO: 968 - protein, 57 aa, Artificial Sequence
  Description of Artificial Sequence Synthetic polypeptide
TISRDNSKNTLYLQMNSLRAEDTAVYYCAKSYSYGYCSSTSCYTQHWGQGTLVTVSS

SEQ ID NO: 969 - DNA, 48 bp, Artificial Sequence
  Description of Artificial Sequence Synthetic oligonucleotide
nnnnnnnnnnnnnnnnnntgtnnnnnnnnnnnntgtnnnnnnnnnnnn

SEQ ID NO: 970 - protein, 16 aa, Artificial Sequence
  Description of Artificial Sequence Synthetic peptide
SYSYGYCSSTSCYTQH

SEQ ID NO: 971 - DNA, 366 bp, Artificial Sequence
  Description of Artificial Sequence Synthetic polynucleotide
ggtgtacacagtgctcaggatattcagatgactcaatctccctcgagtctgtctgcttctgtcggcgatcgcgttactattacttgtcgtgcttcccagtccatttctagctatctgaattggtaccagcaaaagccgggtaaggctccgaaactgttaatctatgccgcttctagtctgcagtctggtgttccgtctagattctctggctctggttctggtactgattttactctgactatttcctctctgcaaccggaggactttgctacctattactgccaacagtcttatagtactccgtggactttcggtcaaggcactaaagttgagattaagcgtacggtggctgctccgtctgtcttc

SEQ ID NO: 972 - protein, 122 aa, Artificial Sequence
  Description of Artificial Sequence Synthetic polypeptide
GVHSAQDIQMTQSPSSLSASVGDRVTITCRASQSISSYLNWYQQKPGKAPKLLIYAASSLQSGVPSRFSGSGSGTDFTLTISSLQPEDFATYYCQQSYSTPWTFGQGTKVEIKRTVAAPSVF

SEQ ID NO: 973 - protein, 11 aa, Artificial Sequence
  Description of Artificial Sequence Synthetic peptide
RASQSISSYLN

SEQ ID NO: 974 - protein, 8 aa, Artificial Sequence
  Description of Artificial Sequence Synthetic peptide
YYDSSGYY

SEQ ID NO: 975 - protein, 42 aa, Artificial Sequence
  Description of Artificial Sequence Synthetic polypeptide
SRDNSKNTLYLQMNSLRAEDTAVYYCAKXXXWGQGTLVTVSS

SEQ ID NO: 976 - protein, 28 aa, Artificial Sequence
  Description of Artificial Sequence Synthetic peptide
SRDNSKNTLYLQMNSLRAEDTAVYYCAK

SEQ ID NO: 977 - protein, 11 aa, Artificial Sequence
  Description of Artificial Sequence Synthetic peptide
WGQGTLVTVSS

SEQ ID NO: 978 - protein, 43 aa, Artificial Sequence
  Description of Artificial Sequence Synthetic polypeptide
SRDNSKNTLYLQMNSLRAEDTAVYYCAKXXXXWGQGTLVTVSS

SEQ ID NO: 979 - protein, 44 aa, Artificial Sequence
  Description of Artificial Sequence Synthetic polypeptide
SRDNSKNTLYLQMNSLRAEDTAVYYCAKXXXXXWGQGTLVTVSS

SEQ ID NO: 980 - protein, 5 aa, Artificial Sequence
  Description of Artificial Sequence Synthetic peptide
YYCAK

SEQ ID NO: 981 - protein, 39 aa, Artificial Sequence
  Description of Artificial Sequence Synthetic polypeptide
YYCARSSRSGYCTNGVCYRSGSYWYFDLWGRGTLVTVSS

SEQ ID NO: 982 - protein, 3 aa, Artificial Sequence
  Description of Artificial Sequence Synthetic peptide
PEP

SEQ ID NO: 983 - protein, 5 aa, Artificial Sequence
  Description of Artificial Sequence Synthetic peptide
YNRNH

SEQ ID NO: 984 - DNA, 471 bp, Artificial Sequence
  Description of Artificial Sequence Synthetic polynucleotide
atgaaatacctattgcctacggcagccgctggattgttattactcgcggcccagccggccatggccgaggttcaattggtcgaatctggcggtggtcttgtacagccgggtggttctctgcggctgagctgtgctgcctctggctttactgtctcctctaattacatgtcttgggtccgtcaagctccgggtaagggtctagaatgggtttccgttatctactctggtgggtcgacttactatgctgattccgttaagggccgtttcacgatatcccgggacaactctaaaaatactttgtacctgcagatgaattctttacgcgctgaagacactgctgtctactattgtgcacgtggttctggctctggctcttattggtacttcgatttatggggtcgtggcactttggtgaccgtgagctctgcctccaccaagggcccatcggtcttcccgctagcaccctcctcc

SEQ ID NO: 985 - protein, 157 aa, Artificial Sequence
  Description of Artificial Sequence Synthetic polypeptide
MKYLLPTAAAGLLLLAAQPAMAEVQLVESGGGLVQPGGSLRLSCAASGFTVSSNYMSWVRQAPGKGLEWVSVIYSGGSTYYADSVKGRFTISRDNSKNTLYLQMNSLRAEDTAVYYCARGSGSGSYWYFDLWGRGTLVTVSSASTKGPSVFPLAPSS

SEQ ID NO: 986 - DNA, 471 bp, Artificial Sequence
  Description of Artificial Sequence Synthetic polynucleotide
atgaaatacctattgcctacggcagccgctggattgttattactcgcggcccagccggccatggccgaggttcaattggtcgaatctggcggtggtcttgtacagccgggtggttctctgcggctgagctgtgctgcttccggatttaatatcaaagatacttacatccattgggttcgtcaagccccgggtaagggtctagaatgggtcgctcgtatttatccgactaatggttatactcgttatgctgactccgttaaaggtcgtttcactatctctgcagacacttcgaaaaatactgcctatttgcagatgaactctttgcgtgctgaggacactgctgtttactattgctcgagatggggtggtgatggcttttacgctatggactattggggccaaggtactttggtcaccgtgagctctgcttccactaaaggtccgtctgtcttcccgctagccccgtcttcc

SEQ ID NO: 987 - protein, 157 aa, Artificial Sequence
  Description of Artificial Sequence Synthetic polypeptide
MKYLLPTAAAGLLLLAAQPAMAEVQLVESGGGLVQPGGSLRLSCAASGFNIKDTYIHWVRQAPGKGLEWVARIYPTNGYTRYADSVKGRFTISADTSKNTAYLQMNSLRAEDTAVYYCSRWGGDGFYAMDYWGQGTLVTVSSASTKGPSVFPLAPSS

SEQ ID NO: 988 - protein, 10 aa, Artificial Sequence
  Description of Artificial Sequence Synthetic peptide
QQYGSSPXLT

SEQ ID NO: 989 - DNA, 366 bp, Artificial Sequence; identical to SEQ ID NO: 971
  Description of Artificial Sequence Synthetic polynucleotide

SEQ ID NO: 990 - protein, 122 aa, Artificial Sequence; identical to SEQ ID NO: 972
  Description of Artificial Sequence Synthetic polypeptide

SEQ ID NO: 991 - protein, 9 aa, Artificial Sequence
  Description of Artificial Sequence Synthetic peptide
YYDFWSYYN

SEQ ID NO: 992 - protein, 5 aa, Artificial Sequence
  Description of Artificial Sequence Synthetic peptide
NWFDP

SEQ ID NO: 993 - protein, 8 aa, Artificial Sequence
  Description of Artificial Sequence Synthetic peptide
YYDFWSGY

SEQ ID NO: 994 - protein, 5 aa, Artificial Sequence
  Description of Artificial Sequence Synthetic peptide
DTAPT

SEQ ID NO: 995 - protein, 18 aa, Artificial Sequence
  Description of Artificial Sequence Synthetic peptide
FGSDLWRGTNQTVWYQPA

SEQ ID NO: 996 - DNA, 168 bp, Artificial Sequence
  Description of Artificial Sequence Synthetic polynucleotide
ttcactatctctagagacaactctaagaatactctctacttgcagatgaacagcttaagggctgaggatactgcagtttattactgcgctaagnnknnknnknnknnknnknnknnknnknnknnkttcgattattggggccagggtactctggtcaccgtctccagt

SEQ ID NO: 997 - protein, 53 aa, Artificial Sequence
  Description of Artificial Sequence Synthetic polypeptide
SRDNSKNTLYLQMNSLRAEDTAVYYCAKXXXXXXXXXXXFDYWGQGTLVTVSS

SEQ ID NO: 998 - DNA, 159 bp, Artificial Sequence
  Description of Artificial Sequence Synthetic polynucleotide
ttcactatctctagagacaactctaagaatactctctacttgcagatgaacagcttaagggctgaggatactgcagtttattactgcgctaagnnknnknnknnknnknnknnknnkttcgattattggggccagggtactctggtcaccgtctccagt

SEQ ID NO: 999 - protein, 50 aa, Artificial Sequence
  Description of Artificial Sequence Synthetic polypeptide
SRDNSKNTLYLQMNSLRAEDTAVYYCAKXXXXXXXXFDYWGQGTLVTVSS

SEQ ID NO: 1000 - protein, 7 aa, Artificial Sequence
  Description of Artificial Sequence Synthetic peptide
YYDSSGY

SEQ ID NO: 1001 - protein, 8 aa, Artificial Sequence
  Description of Artificial Sequence Synthetic peptide
YDFWSAYY

SEQ ID NO: 1002 - protein, 8 aa, Artificial Sequence
  Description of Artificial Sequence Synthetic peptide
YDFWSGYY

SEQ ID NO: 1003 - protein, 19 aa, Artificial Sequence
  Description of Artificial Sequence Synthetic peptide
XXXXXDSSGYXXXXXXXDY

SEQ ID NO: 1004 - protein, 4 aa, Artificial Sequence
  Description of Artificial Sequence Synthetic peptide
AFDI

SEQ ID NO: 1005 - protein, 5 aa, Artificial Sequence
  Description of Artificial Sequence Synthetic peptide
DYGDX

SEQ ID NO: 1006 - protein, 5 aa, Artificial Sequence
  Description of Artificial Sequence Synthetic peptide
XYGDY

SEQ ID NO: 1007 - protein, 13 aa, Artificial Sequence
  Description of Artificial Sequence Synthetic peptide
XXDYGDYXXXFDI

SEQ ID NO: 1008 - protein, 12 aa, Artificial Sequence
  Description of Artificial Sequence Synthetic peptide
XXDYGDYXXFDI

SEQ ID NO: 1009 - protein, 11 aa, Artificial Sequence
  Description of Artificial Sequence Synthetic peptide
XXDYGDYXFDI

SEQ ID NO: 1010 - protein, 12 aa, Artificial Sequence
  Description of Artificial Sequence Synthetic peptide
XDYGDYXXXFDI

SEQ ID NO: 1011 - protein, 11 aa, Artificial Sequence
  Description of Artificial Sequence Synthetic peptide
XDYGDYXXFDI

SEQ ID NO: 1012 - protein, 10 aa, Artificial Sequence
  Description of Artificial Sequence Synthetic peptide
XDYGDYXFDI

SEQ ID NO: 1013 - protein, 11 aa, Artificial Sequence
  Description of Artificial Sequence Synthetic peptide
DYGDYXXXFDI

SEQ ID NO: 1014 - protein, 10 aa, Artificial Sequence
  Description of Artificial Sequence Synthetic peptide
DYGDYXXFDI

SEQ ID NO: 1015 - protein, 9 aa, Artificial Sequence
  Description of Artificial Sequence Synthetic peptide
DYGDYXFDI

SEQ ID NO: 1016 - protein, 13 aa, Artificial Sequence
  Description of Artificial Sequence Synthetic peptide
XXXXSSXWXXFDL

SEQ ID NO: 1017 - protein, 13 aa, Artificial Sequence
  Description of Artificial Sequence Synthetic peptide
XXGYSSXWYXFDL

SEQ ID NO: 1018 - protein, 12 aa, Artificial Sequence
  Description of Artificial Sequence Synthetic peptide
XGYSSXWYXFDL

SEQ ID NO: 1019 - protein, 11 aa, Artificial Sequence
  Description of Artificial Sequence Synthetic peptide
GYSSXWYXFDL

SEQ ID NO: 1020 - protein, 7 aa, Artificial Sequence
  Description of Artificial Sequence Synthetic peptide
GYSSXWY

SEQ ID NO: 1021 - protein, 11 aa, Artificial Sequence
  Description of Artificial Sequence Synthetic peptide
WGRGTLVTVSS

SEQ ID NO: 1022 - protein, 13 aa, Artificial Sequence
  Description of Artificial Sequence Synthetic peptide
XXGYSSXWYXFDL

SEQ ID NO: 1023 - protein, 12 aa, Artificial Sequence
  Description of Artificial Sequence Synthetic peptide
XGYSSXWYXFDL

SEQ ID NO: 1024 - protein, 11 aa, Artificial Sequence
  Description of Artificial Sequence Synthetic peptide
GYSSXWYXFDL

SEQ ID NO: 1025 - protein, 12 aa, Artificial Sequence
  Description of Artificial Sequence Synthetic peptide
XXGYSSXWYFDL

SEQ ID NO: 1026 - protein, 11 aa, Artificial Sequence
  Description of Artificial Sequence Synthetic peptide
XGYSSXWYFDL

SEQ ID NO: 1027 - protein, 10 aa, Artificial Sequence
  Description of Artificial Sequence Synthetic peptide
GYSSXWYFDL

SEQ ID NO: 1028 - protein, 10 aa, Artificial Sequence
  Description of Artificial Sequence Synthetic peptide
GYCSGGSCYS

SEQ ID NO: 1029 - protein, 17 aa, Artificial Sequence
  Description of Artificial Sequence Synthetic peptide
XXXXCXXXXCXXXXFDL

SEQ ID NO: 1030 - protein, 16 aa, Artificial Sequence
  Description of Artificial Sequence Synthetic peptide
XXXCXXXXCXXXXFDL

SEQ ID NO: 1031 - protein, 15 aa, Artificial Sequence
  Description of Artificial Sequence Synthetic peptide
XXCXXXXCXXXXFDL

SEQ ID NO: 1032 - protein, 14 aa, Artificial Sequence
  Description of Artificial Sequence Synthetic peptide
XCXXXXCXXXXFDL

SEQ ID NO: 1033 - protein, 16 aa, Artificial Sequence
  Description of Artificial Sequence Synthetic peptide
XXXXCXXXXCXXXFDL

SEQ ID NO: 1034 - protein, 15 aa, Artificial Sequence
  Description of Artificial Sequence Synthetic peptide
XXXCXXXXCXXXFDL

SEQ ID NO: 1035 - protein, 14 aa, Artificial Sequence
  Description of Artificial Sequence Synthetic peptide
XXCXXXXCXXXFDL

SEQ ID NO: 1036 - protein, 13 aa, Artificial Sequence
  Description of Artificial Sequence Synthetic peptide
XCXXXXCXXXFDL

SEQ ID NO: 1037 - protein, 15 aa, Artificial Sequence
  Description of Artificial Sequence Synthetic peptide
XXXXCXXXXCXXFDL

SEQ ID NO: 1038 - protein, 14 aa, Artificial Sequence
  Description of Artificial Sequence Synthetic peptide
XXXCXXXXCXXFDL

SEQ ID NO: 1039 - protein, 13 aa, Artificial Sequence
  Description of Artificial Sequence Synthetic peptide
XXCXXXXCXXFDL

SEQ ID NO: 1040 - protein, 12 aa, Artificial Sequence
  Description of Artificial Sequence Synthetic peptide
XCXXXXCXXFDL

SEQ ID NO: 1041 - protein, 14 aa, Artificial Sequence
  Description of Artificial Sequence Synthetic peptide
XXXXCXXXXCXFDL

SEQ ID NO: 1042 - protein, 13 aa, Artificial Sequence
  Description of Artificial Sequence Synthetic peptide
XXXCXXXXCXFDL

SEQ ID NO: 1043 - protein, 12 aa, Artificial Sequence
  Description of Artificial Sequence Synthetic peptide
XXCXXXXCXFDL

SEQ ID NO: 1044 - protein, 11 aa, Artificial Sequence
  Description of Artificial Sequence Synthetic peptide
XCXXXXCXFDL

SEQ ID NO: 1045 - DNA, 750 bp, Artificial Sequence
  Description of Artificial Sequence Synthetic polynucleotide
aagctttggagccttttttttggagattttcaacatgaagaaactgctgtctgctatcccactagttgtccctttctattctcatagtgaaatcgttctgacccagtccccggggaccctgtctctgtctccgggtgaacgtgctacgctgagctgtcgtgcttctcaatccgttagctcctcttatttagcttggtatcagcaaaagccgggtcaagctccgcggctgttgatctatggtgcctctagtcgtgctactggcatccctgatcgtttctctggctctggctctggcaccgatttcactctgaccatttctcgtctcgagccggaagatttcgctgtctactattgtcaacagtatggttctagtccgctgactttcggtggcggtaccaaagtcgaaatcaagcgtggaactgtggctgcaccatctgtcttcatcttcccgccatctgatgagcagttgaaatctggaactgcctctgttgtgtgcctgctgaataacttctatcccagagaggccaaagtacagtggaaggtggataacgccctccaatcgggtaactcccaggagagtgtcacagagcaggacagcaaggacagcacctacagcctcagcagcaccctgactctgtccaaagcagactacgagaaacacaaagtctacgcctgcgaagtcacccatcagggcctgagttcaccggtgacaaagagcttcaacaggggagagtgttaataaggcgcgcc

SEQ ID NO: 1046 - protein, 234 aa, Artificial Sequence; identical to SEQ ID NO: 928
  Description of Artificial Sequence Synthetic polypeptide

SEQ ID NO: 1047 - DNA, 10 bp, Artificial Sequence
  Description of Artificial Sequence Synthetic oligonucleotide
gatnnnnatc

SEQ ID NO: 1048 - DNA, 15 bp, Artificial Sequence
  Description of Artificial Sequence Synthetic oligonucleotide
nnnnnnnnngcaggt

SEQ ID NO: 1049 - DNA, 11 bp, Artificial Sequence
  Description of Artificial Sequence Synthetic oligonucleotide
gcannnnntgc

SEQ ID NO: 1050 - DNA, 10 bp, Artificial Sequence
  Description of Artificial Sequence Synthetic oligonucleotide
gacnnnngtc

SEQ ID NO: 1051 - DNA, 15 bp, Artificial Sequence
  Description of Artificial Sequence Synthetic oligonucleotide
ccannnnnnnnntgg

SEQ ID NO: 1052 - DNA, 10 bp, Artificial Sequence
  Description of Artificial Sequence Synthetic oligonucleotide
ctcttcnnnn

SEQ ID NO: 1053 - DNA, 12 bp, Artificial Sequence
  Description of Artificial Sequence Synthetic oligonucleotide
nnnnnnngcggg

SEQ ID NO: 1054 - DNA, 12 bp, Artificial Sequence
  Description of Artificial Sequence Synthetic oligonucleotide
gtatccnnnnnn

SEQ ID NO: 1055 - DNA, 12 bp, Artificial Sequence
  Description of Artificial Sequence Synthetic oligonucleotide
gcannnnnntcg

SEQ ID NO: 1056 - DNA, 11 bp, Artificial Sequence
  Description of Artificial Sequence Synthetic oligonucleotide
gccnnnnnggc

SEQ ID NO: 1057 - DNA, 11 bp, Artificial Sequence
  Description of Artificial Sequence Synthetic oligonucleotide
ggtctcnnnnn

SEQ ID NO: 1058 - DNA, 11 bp, Artificial Sequence
  Description of Artificial Sequence Synthetic oligonucleotide
gacnnnnngtc

SEQ ID NO: 1059 - DNA, 12 bp, Artificial Sequence
  Description of Artificial Sequence Synthetic oligonucleotide
gacnnnnnngtc

SEQ ID NO: 1060 - DNA, 11 bp, Artificial Sequence
  Description of Artificial Sequence Synthetic oligonucleotide
ccannnnntgg

SEQ ID NO: 1061 - DNA, 20 bp, Artificial Sequence
  Description of Artificial Sequence Synthetic oligonucleotide
nnnnnnnnnnnnnnngtccc

SEQ ID NO: 1062 - DNA, 17 bp, Artificial Sequence
  Description of Artificial Sequence Synthetic oligonucleotide
gggacnnnnnnnnnnnn

SEQ ID NO: 1063 - DNA, 16 bp, Artificial Sequence
  Description of Artificial Sequence Synthetic oligonucleotide
nnnnnnnnnnctcctc

SEQ ID NO: 1064 - DNA, 11 bp, Artificial Sequence
  Description of Artificial Sequence Synthetic oligonucleotide
cgtctcnnnnn

SEQ ID NO: 1065 - DNA, 12 bp, Artificial Sequence
  Description of Artificial Sequence Synthetic oligonucleotide
nnnnnngagacg

SEQ ID NO: 1066 - DNA, 13 bp, Artificial Sequence
  Description of Artificial Sequence Synthetic oligonucleotide
ggccnnnnnggcc

SEQ ID NO: 1067 - DNA, 12 bp, Artificial Sequence
  Description of Artificial Sequence Synthetic oligonucleotide
ccannnnnntgg

SEQ ID NO: 1068 - DNA, 11 bp, Artificial Sequence
  Description of Artificial Sequence Synthetic oligonucleotide
cctnnnnnagg

SEQ ID NO: 1069 - DNA, 5200 bp, Artificial Sequence
  Description of Artificial Sequence Synthetic polynucleotide
gacgaaagggcctcgtgatacgcctatttttataggttaatgtcatgataataatggtttcttagacgtcaggtggcacttttcggggaaatgtgcgcggaacccctatttgtttatttttctaaatacattcaaatatgtatccgctcatgagacaataaccctgataaatgcttcaataatattgaaaaaggaagagtatgagtattcaacatttccgtgtcgcccttattcccttttttgcggcattttgccttcctgtttttgctcacccagaaacgctggtgaaagtaaaagatgctgaagatcagttgggtgcccgagtgggttacatcgaactggatctcaacagcggtaagatccttgagagttttcgccccgaagaacgttttccaatgatgagcacttttaaagttctgctatgtggcgcggtattatcccgtattgacgccgggcaagagcaactcggtcgccgcatacactattctcagaatgacttggttgagtactcaccagtcacagaaaagcatcttacggatggcatgacagtaagagaattatgcagtgctgccataaccatgagtgataacactgcggccaacttacttctgacaacgatcggaggaccgaaggagctaaccgcttttttgcacaacatgggggatcatgtaactcgccttgatcgttgggaaccggagctgaatgaagccataccaaacgacgagcgtgacaccacgatgcctgtagcaatggcaacaacgttgcgcaaactattaactggcgaactacttactctagcttcccggcaacaattaatagactggatggaggcggataaagttgcaggaccacttctgcgctcggcccttccggctggctggtttattgctgataaatctggagccggtgagcgtgggtctcgcggtatcattgcagcactggggccagatggtaagccctcccgtatcgtagttatctacacgacggggagtcaggcaactatggatgaacgaaatagacagatcgctgagataggtgcctcactgattaagcattggtaactgtcagaccaagtttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgttcttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcatacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaagagcgcccaatacgcaaaccgcctctccccgcgcgttggccgattcattaatgcagctggcacgacaggtttcccgactggaaagcgggcagtgagcgcaacgcaattaatgtgagttagctcactcattaggcaccccaggctttacactttatgcttccggctcgtatgttgtgtggaattgtgagcggataacaatttcacacaggaaacagctatgaccatgattacgccaagctttggagccttttttttggagattttcaacatgaagaaactgctgtctgctatcccactagttgtccctttctattctcatagtgaaatcgttctgacccagtccccggggaccctgtctctgtctccgggtgaacgtgctacgctgagctgtcgtgcttctcaatccgttagctcctcttatttagcttggtatcagcaaaagccgggtcaagctccgcggctgttgatctatggtgcctctagtcgtgctactggcatccctgatcgtttctctggctctggctctggcaccgatttcactctgaccatttctcgtctcgagccggaagatttcgctgtctactattgtcaacagtatggttctagtccgctgactttcggtggcggtaccaaagtcgaaatcaagcgtggaactgtggctgcaccatctgtcttcatcttcccgccatctgatgagcagttgaaatctggaactgcctctgttgtgtgcctgctgaataacttctatcccagagaggccaaagtacagtggaaggtggataacgccctccaatcgggtaactcccaggagagtgtcacagagcaggacagcaaggacagcacctacagcctcagcagcaccctgactctgtccaaagcagactacgagaaacacaaagtctacgcctgcgaagtcacccatcagggcctgagttcaccggtgacaaagagcttcaacaggggagagtgttaataaggcgcgcctaaccatctatttcaaggaacagtcttaatgaagaaactgttattcatgatcccgttagttgtaccgttcgtggcccagccggcctctgctgaagttcaattgttagagtctggtggcggtcttgttcagcctggtggttctttacgtctttcttgcgctgcttccggattcactttctcttcgtacgctatgtcttgggttcgccaagctcctggtaaaggtttggagtgggtttctgctatctctggttctggtggcagtacttactatgctgactccgttaaaggtcgcttcactatctctagagacaactctaagaatactctctacttgcagatgaacagcttaagggctgaggacactgcagtctactattgcgctaaagactatgaaggtactggttatgctttcgactattggggtcaaggtactctggtcaccgtctcaagcgcctccaccaagggcccatcggtcttcccgctagcaccctcctccaagagcacctctgggggcacagcggccctgggctgcctggtcaaggactacttccccgaaccggtgacggtgtcgtggaactcaggcgccctgaccagcggcgtccacaccttcccggctgtcctacagtctagcggactctactccctcagcagcgtagtgaccgtgccctcttctagcttgggcacccagacctacatctgcaacgtgaatcacaagcccagcaacaccaaggtggacaagaaagttgagcccaaatcttgtgcggccgcacatcatcatcaccatcacggggccgcagaacaaaaactcatctcagaagaggatctgaatggggccgcagaggctagttctgctagtaacgcgtcttccggtgattttgattatgaaaagatggcaaacgctaataagggggctatgaccgaaaatgccgatgaaaacgcgctacagtctgacgctaaaggcaaacttgattctgtcgctactgattacggtgctgctatcgatggtttcattggtgacgtttccggccttgctaatggtaatggtgctactggtgattttgctggctctaattcccaaatggctcaagtcggtgacggtgataattcacctttaatgaataatttccgtcaatatttaccttccctccctcaatcggttgaatgtcgcccttttgtctttggcgctggtaaaccatatgaattttctattgattgtgacaaaataaacttattccgtggtgtctttgcgtttcttttatatgttgccacctttatgtatgtattttctacgtttgctaacatactgcgtaataaggagtcttaatgaaacgcgtgatgagaattcactggccgtcgttttacaacgtcgtgactgggaaaaccctggcgttacccaacttaatcgccttgcagcacatccccctttcgccagctggcgtaatagcgaagaggcccgcaccgatcgcccttcccaacagttgcgcagcctgaatggcgaatggcgcctgatgcggtattttctccttacgcatctgtgcggtatttcacaccgcatacgtcaaagcaaccatagtacgcgccctgtagcggcgcattaagcgcggcgggtgtggtggttacgcgcagcgtgaccgctacacttgccagcgccttagcgcccgctcctttcgctttcttcccttcctttctcgccacgttcgccggctttccccgtcaagctctaaatcgggggctccctttagggttccgatttagtgctttacggcacctcgaccccaaaaaacttgatttgggtgatggttcacgtagtgggccatcgccctgatagacggtttttcgccctttgacgttggagtccacgttctttaatagtggactcttgttccaaactggaacaacactcaactctatctcgggctattcttttgatttataagggattttgccgatttcggtctattggttaaaaaatgagctgatttaacaaaaatttaacgcgaattttaacaaaatattaacgtttacaattttatggtgcagtctcagtacaatctgctctgatgccgcatagttaagccagccccgacacccgccaacacccgctgacgcgccctgacgggcttgtctgctcccggcatccgcttacagacaagctgtgaccgtctccgggagctgcatgtgtcagaggttttcaccgtcatcaccgaaacgcgcga

SEQ ID NO: 1070 - protein, 234 aa, Artificial Sequence; identical to SEQ ID NO: 928
  Description of Artificial Sequence Synthetic polypeptide

SEQ ID NO: 1071 - protein, 141 aa, Artificial Sequence
  Description of Artificial Sequence Synthetic polypeptide
MKKLLFMIPLVVPFVAQPASAEVQLLESGGGLVQPGGSLRLSCAASGFTFSSYAMSWVRQAPGKGLEWVSAISGSGGSTYYADSVKGRFTISRDNSKNTLYLQMNSLRAEDTAVYYCAKDYEGTGYAFDYWGQGTLVTVSS

SEQ ID NO: 1072 - DNA, 5200 bp, Artificial Sequence
  Description of Artificial Sequence Synthetic polynucleotide
gacgaaagggcctcgtgatacgcctatttttataggttaatgtcatgataataatggtttcttagacgtcaggtggcacttttcggggaaatgtgcgcggaacccctatttgtttatttttctaaatacattcaaatatgtatccgctcatgagacaataaccctgataaatgcttcaataatattgaaaaaggaagagtatgagtattcaacatttccgtgtcgcccttattcccttttttgcggcattttgccttcctgtttttgctcacccagaaacgctggtgaaagtaaaagatgctgaagatcagttgggtgcccgagtgggttacatcgaactggatctcaacagcggtaagatccttgagagttttcgccccgaagaacgttttccaatgatgagcacttttaaagttctgctatgtggcgcggtattatcccgtattgacgccgggcaagagcaactcggtcgccgcatacactattctcagaatgacttggttgagtactcaccagtcacagaaaagcatcttacggatggcatgacagtaagagaattatgcagtgctgccataaccatgagtgataacactgcggccaacttacttctgacaacgatcggaggaccgaaggagctaaccgcttttttgcacaacatgggggatcatgtaactcgccttgatcgttgggaaccggagctgaatgaagccataccaaacgacgagcgtgacaccacgatgcctgtagcaatggcaacaacgttgcgcaaactattaactggcgaactacttactctagcttcccggcaacaattaatagactggatggaggcggataaagttgcaggaccacttctgcgctcggcccttccggctggctggtttattgctgataaatctggagccggtgagcgtgggtctcgcggtatcattgcagcactggggccagatggtaagccctcccgtatcgtagttatctacacgacggggagtcaggcaactatggatgaacgaaatagacagatcgctgagataggtgcctcactgattaagcattggtaactgtcagaccaagtttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgttcttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcatacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaaaacgccagcaacgcggcctttttacggttcctggccttttgctggccttttgctcacatgttctttcctgcgttatcccctgattctgtggataaccgtattaccgcctttgagtgagctgataccgctcgccgcagccgaacgaccgagcgcagcgagtcagtgagcgaggaagcggaagagcgcccaatacgcaaaccgcctctccccgcgcgttggccgattcattaatgcagctggcacgacaggtttcccgactggaaagcgggcagtgagcgcaacgcaattaatgtgagttagctcactcattaggcaccccaggctttacactttatgcttccggctcgtatgttgtgtggaattgtgagcggataacaatttcacacaggaaacagctatgaccatgattacgccaagctttggagccttttttttggagattttcaacatgaagaaactgctgtctgctatcccactagttgtccctttctattctcatagtgaaatcgttctgacccagtccccggggaccctgtctctgtctccgggtgaacgtgctacgctgagctgtcgtgcttctcaatccgttagctcctcttatttagcttggtatcagcaaaagccgggtcaagctccgcggctgttgatctatggtgcctctagtcgtgctactggcatccctgatcgtttctctggctctggctctggcaccgatttcactctgaccatttctcgtctcgagccggaagatttcgctgtctactattgtcaacagtatggttctagtccgctgactttcggtggcggtaccaaagtcgaaatcaagcgtggaactgtggctgcaccatctgtcttcatcttcccgccatctgatgagcagttgaaatctggaactgcctctgttgtgtgcctgctgaataacttctatcccagagaggccaaagtacagtggaaggtggataacgccctccaatcgggtaactcccaggagagtgtcacagagcaggacagcaaggacagcacctacagcctcagcagcaccctgactctgtccaaagcagactacgagaaacacaaagtctacgcctgcgaagtcacccatcagggcctgagttcaccggtgacaaagagcttcaacaggggagagtgttaataaggcgcgcctaaccatctatttcaaggaacagtcttaatgaagaaactgttattcatgatcccgttagttgtaccgttcgtggcccagccggcctctgctgaagttcaattgttagagtctggtggcggtcttgttcagcctggtggttctttacgtctttcttgcgctgcttccggattcactttctcttcgtacgctatgtcttgggttcgccaagctcctggtaaaggtttggagtgggtttctgctatctctggttctggtggcagtacttactatgctgactccgttaaaggtcgcttcactatctctagagacaactctaagaatactctctacttgcagatgaacagcttaagggctgaggacactgcagtctactattgcgctaaagactatgaaggtactggttatgctttcgacatatggggtcaaggtactatggtcaccgtctcaagcgcctccaccaagggcccatcggtcttcccgctagcaccctcctccaagagcacctctgggggcacagcggccctgggctgcctggtcaaggactacttccccgaaccggtgacggtgtcgtggaactcaggcgccctgaccagcggcgtccacaccttcccggctgtcctacagtctagcggactctactccctcagcagcgtagtgaccgtgccctcttctagcttgggcacccagacctacatctgcaacgtgaatcacaagcccagcaacaccaaggtggacaagaaagttgagcccaaatcttgtgcggccgcacatcatcatcaccatcacggggccgcagaacaaaaactcatctcagaagaggatctgaatggggccgcagaggctagttctgctagtaacgcgtcttccggtgattttgattatgaaaagatggcaaacgctaataagggggctatgaccgaaaatgccgatgaaaacgcgctacagtctgacgctaaaggcaaacttgattctgtcgctactgattacggtgctgctatcgatggtttcattggtgacgtttccggccttgctaatggtaatggtgctactggtgattttgctggctctaattcccaaatggctcaagtcggtgacggtgataattcacctttaatgaataatttccgtcaatatttaccttccctccctcaatcggttgaatgtcgcccttttgtctttggcgctggtaaaccatatgaattttctattgattgtgacaaaataaacttattccgtggtgtctttgcgtttcttttatatgttgccacctttatgtatgtattttctacgtttgctaacatactgcgtaataaggagtcttaatgaaacgcgtgatgagaattcactggccgtcgttttacaacgtcgtgactgggaaaaccctggcgttacccaacttaatcgccttgcagcacatccccctttcgccagctggcgtaatagcgaagaggcccgcaccgatcgcccttcccaacagttgcgcagcctgaatggcgaatggcgcctgatgcggtattttctccttacgcatctgtgcggtatttcacaccgcatacgtcaaagcaaccatagtacgcgccctgtagcggcgcattaagcgcggcgggtgtggtggttacgcgcagcgtgaccgctacacttgccagcgccttagcgcccgctcctttcgctttcttcccttcctttctcgccacgttcgccggctttccccgtcaagctctaaatcgggggctccctttagggttccgatttagtgctttacggcacctcgaccccaaaaaacttgatttgggtgatggttcacgtagtgggccatcgccctgatagacggtttttcgccctttgacgttggagtccacgttctttaatagtggactcttgttccaaactggaacaacactcaactctatctcgggctattcttttgatttataagggattttgccgatttcggtctattggttaaaaaatgagctgatttaacaaaaatttaacgcgaattttaacaaaatattaacgtttacaattttatggtgcagtctcagtacaatctgctctgatgccgcatagttaagccagccccgacacccgccaacacccgctgacgcgccctgacgggcttgtctgctcccggcatccgcttacagacaagctgtgaccgtctccgggagctgcatgtgtcagaggttttcaccgtcatcaccgaaacgcgcga

SEQ ID NO: 1073 - protein, 36 aa, Artificial Sequence
  Description of Artificial Sequence Synthetic polypeptide
DTAPTYYDFWSGYFGSDLWRGTNQTVWYQPANWFDP

SEQ ID NO: 1074 - protein, 20 aa, Artificial Sequence
  Description of Artificial Sequence Synthetic peptide
YQPANWFDPWGQGTLVTVSS

SEQ ID NO: 1075 - protein, 5 aa, Artificial Sequence
  Description of Artificial Sequence Synthetic peptide
NWFDP

SEQ ID NO: 1076 - protein, 9 aa, Artificial Sequence
  Description of Artificial Sequence Synthetic peptide
YYDFWSGYF

SEQ ID NO: 1077 - protein, 9 aa, Artificial Sequence
  Description of Artificial Sequence Synthetic peptide
YYYDSSGYY

SEQ ID NO: 1078 - protein, 9 aa, Artificial Sequence
  Description of Artificial Sequence Synthetic peptide
YYDSSGYYY

SEQ ID NO: 1079 - protein, 8 aa, Artificial Sequence
  Description of Artificial Sequence Synthetic peptide
YYYDSSGY

SEQ ID NO: 1080 - protein, 8 aa, Artificial Sequence
  Description of Artificial Sequence Synthetic peptide
YYDSSGYY

SEQ ID NO: 1081 - protein, 8 aa, Artificial Sequence
  Description of Artificial Sequence Synthetic peptide
YDSSGYYY

SEQ ID NO: 1082 - protein, 7 aa, Artificial Sequence
  Description of Artificial Sequence Synthetic peptide
YYYDSSG

SEQ ID NO: 1083 - protein, 7 aa, Artificial Sequence
  Description of Artificial Sequence Synthetic peptide
YYDSSGY

SEQ ID NO: 1084 - protein, 7 aa, Artificial Sequence
  Description of Artificial Sequence Synthetic peptide
YDSSGYY

SEQ ID NO: 1085 - protein, 7 aa, Artificial Sequence
  Description of Artificial Sequence Synthetic peptide
DSSGYYY

SEQ ID NO: 1086 - protein, 6 aa, Artificial Sequence
  Description of Artificial Sequence Synthetic peptide
YYYDSS

SEQ ID NO: 1087 - protein, 6 aa, Artificial Sequence
  Description of Artificial Sequence Synthetic peptide
YYDSSG

SEQ ID NO: 1088 - protein, 6 aa, Artificial Sequence
  Description of Artificial Sequence Synthetic peptide
YDSSGY

SEQ ID NO: 1089 - protein, 6 aa, Artificial Sequence
  Description of Artificial Sequence Synthetic peptide
DSSGYY

SEQ ID NO: 1090 - protein, 6 aa, Artificial Sequence
  Description of Artificial Sequence Synthetic peptide
SSGYYY

SEQ ID NO: 1091 - protein, 5 aa, Artificial Sequence
  Description of Artificial Sequence Synthetic peptide
YYYDS

SEQ ID NO: 1092 - protein, 5 aa, Artificial Sequence
  Description of Artificial Sequence Synthetic peptide
YYDSS

SEQ ID NO: 1093 - protein, 5 aa, Artificial Sequence
  Description of Artificial Sequence Synthetic peptide
YDSSG

SEQ ID NO: 1094 - protein, 5 aa, Artificial Sequence
  Description of Artificial Sequence Synthetic peptide
DSSGY

SEQ ID NO: 1095 - protein, 5 aa, Artificial Sequence
  Description of Artificial Sequence Synthetic peptide
SSGYY

SEQ ID NO: 1096 - protein, 5 aa, Artificial Sequence
  Description of Artificial Sequence Synthetic peptide
SGYYY

SEQ ID NO: 1097 - protein, 4 aa, Artificial Sequence
  Description of Artificial Sequence Synthetic peptide
YYYD

SEQ ID NO: 1098 - protein, 4 aa, Artificial Sequence
  Description of Artificial Sequence Synthetic peptide
YYDS

SEQ ID NO: 1099 - protein, 4 aa, Artificial Sequence
  Description of Artificial Sequence Synthetic peptide
YDSS

SEQ ID NO: 1100 - protein, 4 aa, Artificial Sequence
  Description of Artificial Sequence Synthetic peptide
DSSG

SEQ ID NO: 1101 - protein, 4 aa, Artificial Sequence
  Description of Artificial Sequence Synthetic peptide
SSGY

SEQ ID NO: 1102 - protein, 4 aa, Artificial Sequence
  Description of Artificial Sequence Synthetic peptide
SGYY

SEQ ID NO: 1103 - protein, 4 aa, Artificial Sequence
  Description of Artificial Sequence Synthetic peptide
GYYY

SEQ ID NO: 1104 - protein, 9 aa, Artificial Sequence
  Description of Artificial Sequence Synthetic peptide
YYDFWSGYY

SEQ ID NO: 1105 - protein, 9 aa, Artificial Sequence
  Description of Artificial Sequence Synthetic peptide
YDFWSGYYT

SEQ ID NO: 1106 - protein, 8 aa, Artificial Sequence
  Description of Artificial Sequence Synthetic peptide
YYDFWSGY

SEQ ID NO: 1107 - protein, 8 aa, Artificial Sequence
  Description of Artificial Sequence Synthetic peptide
YDFWSGYY

SEQ ID NO: 1108 - protein, 8 aa, Artificial Sequence
  Description of Artificial Sequence Synthetic peptide
DFWSGYYT

SEQ ID NO: 1109 - protein, 7 aa, Artificial Sequence
  Description of Artificial Sequence Synthetic peptide
YYDFWSG

SEQ ID NO: 1110 - protein, 7 aa, Artificial Sequence
  Description of Artificial Sequence Synthetic peptide
YDFWSGY

SEQ ID NO: 1111 - protein, 7 aa, Artificial Sequence
  Description of Artificial Sequence Synthetic peptide
DFWSGYY

SEQ ID NO: 1112 - protein, 7 aa, Artificial Sequence
  Description of Artificial Sequence Synthetic peptide
FWSGYYT

SEQ ID NO: 1113 - protein, 6 aa, Artificial Sequence
  Description of Artificial Sequence Synthetic peptide
YYDFWS

SEQ ID NO: 1114 - protein, 6 aa, Artificial Sequence
  Description of Artificial Sequence Synthetic peptide
YDFWSG

SEQ ID NO: 1115 - protein, 6 aa, Artificial Sequence
  Description of Artificial Sequence Synthetic peptide
DFWSGY

SEQ ID NO: 1116 - protein, 6 aa, Artificial Sequence
  Description of Artificial Sequence Synthetic peptide
FWSGYY

SEQ ID NO: 1117 - protein, 6 aa, Artificial Sequence
  Description of Artificial Sequence Synthetic peptide
WSGYYT

SEQ ID NO: 1118 - protein, 5 aa, Artificial Sequence
  Description of Artificial Sequence Synthetic peptide
YYDFW

SEQ ID NO: 1119 - protein, 5 aa, Artificial Sequence
  Description of Artificial Sequence Synthetic peptide
YDFWS

SEQ ID NO: 1120 - protein, 5 aa, Artificial Sequence
  Description of Artificial Sequence Synthetic peptide
DFWSG

SEQ ID NO: 1121 - protein, 5 aa, Artificial Sequence
  Description of Artificial Sequence Synthetic peptide
FWSGY

SEQ ID NO: 1122 - protein, 5 aa, Artificial Sequence
  Description of Artificial Sequence Synthetic peptide
WSGYY

SEQ ID NO: 1123 - protein, 5 aa, Artificial Sequence
  Description of Artificial Sequence Synthetic peptide
SGYYT

SEQ ID NO: 1124 - protein, 4 aa, Artificial Sequence
  Description of Artificial Sequence Synthetic peptide
YYDF

SEQ ID NO: 1125 - protein, 4 aa, Artificial Sequence
  Description of Artificial Sequence Synthetic peptide
YDFW

SEQ ID NO: 1126 - protein, 4 aa, Artificial Sequence
  Description of Artificial Sequence Synthetic peptide
DFWS

SEQ ID NO: 1127 - protein, 4 aa, Artificial Sequence
  Description of Artificial Sequence Synthetic peptide
FWSG

SEQ ID NO: 1128 - protein, 4 aa, Artificial Sequence
  Description of Artificial Sequence Synthetic peptide
WSGY

SEQ ID NO: 1129 - protein, 4 aa, Artificial Sequence
  Description of Artificial Sequence Synthetic peptide
SGYY

SEQ ID NO: 1130 - protein, 4 aa, Artificial Sequence
  Description of Artificial Sequence Synthetic peptide
GYYT

SEQ ID NO: 1131 - DNA, 156 bp, Artificial Sequence
  Description of Artificial Sequence Synthetic polynucleotide
actatctctagagacaactctaagaatactctctacttgcagatgaacagcttaagggctgaggacactgcagtctactattgcgctaaagactatgaaggtactggttatgctttcgacatatggggtcaaggtactatggtcaccgtctctagt

SEQ ID NO: 1132 - protein, 52 aa, Artificial Sequence
  Description of Artificial Sequence Synthetic polypeptide
TISRDNSKNTLYLQMNSLRAEDTAVYYCAKDYEGTGYAFDIWGQGTMVTVSS

SEQ ID NO: 1133 - protein, 12 aa, Artificial Sequence
  Description of Artificial Sequence Synthetic peptide
WTFGQGTKVEIK

SEQ ID NO: 1134 - protein, 12 aa, Artificial Sequence
  Description of Artificial Sequence Synthetic peptide
YTFGQGTKLEIK

SEQ ID NO: 1135 - protein, 12 aa, Artificial Sequence
  Description of Artificial Sequence Synthetic peptide
FTFGPGTKVDIK

SEQ ID NO: 1136 - protein, 12 aa, Artificial Sequence
  Description of Artificial Sequence Synthetic peptide
LTFGGGTKVEIK

SEQ ID NO: 1137 - protein, 12 aa, Artificial Sequence
  Description of Artificial Sequence Synthetic peptide
ITFGQGTRLEIK

SEQ ID NO: 1138 - protein, 6 aa, Artificial Sequence
  Description of Artificial Sequence Synthetic peptide
HQFYEA

SEQ ID NO: 1139 - protein, 6 aa, Artificial Sequence
  Description of Artificial Sequence Synthetic peptide
LDFYWY

SEQ ID NO: 1140 - protein, 5 aa, Artificial Sequence
  Description of Artificial Sequence Synthetic peptide
IDFAX

SEQ ID NO: 1141 - protein, 5 aa, Artificial Sequence
  Description of Artificial Sequence Synthetic peptide
YDFYX

SEQ ID NO: 1142 - protein, 6 aa, Artificial Sequence
  Description of Artificial Sequence Synthetic peptide
PDFWNX

SEQ ID NO: 1143 - protein, 9 aa, Artificial Sequence
  Description of Artificial Sequence Synthetic peptide
VDMGYYYYY

SEQ ID NO: 1144 - protein, 11 aa, Artificial Sequence
  Description of Artificial Sequence Synthetic peptide
RASQSVSSYLA

SEQ ID NO: 1145 - protein, 8 aa, Artificial Sequence
  Description of Artificial Sequence Synthetic peptide
YGASSRAT

SEQ ID NO: 1146 - protein, 8 aa, Artificial Sequence
  Description of Artificial Sequence Synthetic peptide
QQYGSSXT

SEQ ID NO: 1147 - protein, 10 aa, Artificial Sequence
  Description of Artificial Sequence Synthetic peptide
QQYGSSPXXT

SEQ ID NO: 1148 - protein, 12 aa, Artificial Sequence
  Description of Artificial Sequence Synthetic peptide
RASXXVXXXXLA

SEQ ID NO: 1149 - protein, 7 aa, Artificial Sequence
  Description of Artificial Sequence Synthetic peptide
XASXRAX

SEQ ID NO: 1150 - DNA, 12 bp, Artificial Sequence
  Description of Artificial Sequence Synthetic oligonucleotide
nnnnnnngcggg

SEQ ID NO: 1151 - DNA, 11 bp, Artificial Sequence
  Description of Artificial Sequence Synthetic oligonucleotide
nnnnngaagag

SEQ ID NO: 1152 - DNA, 12 bp, Artificial Sequence
  Description of Artificial Sequence Synthetic oligonucleotide
cgannnnnntgc

SEQ ID NO: 1153 - DNA, 11 bp, Artificial Sequence
  Description of Artificial Sequence Synthetic oligonucleotide
gacnnnnngtc

SEQ ID NO: 1154 - DNA, 11 bp, Artificial Sequence
  Description of Artificial Sequence Synthetic oligonucleotide
ccaagctttgg

SEQ ID NO: 1155 - DNA, 12 bp, Artificial Sequence
  Description of Artificial Sequence Synthetic oligonucleotide
gtcttcnnnnnn

SEQ ID NO: 1156 - DNA, 13 bp, Artificial Sequence
  Description of Artificial Sequence Synthetic oligonucleotide
ggcccagccggcc

SEQ ID NO: 1157 - DNA, 4626 bp, Artificial Sequence
  Description of Artificial Sequence Synthetic polynucleotide
ggtaccgattacgatcggccggcacttttcggggaaatgtgcgcggaacccctatttgtttatttttctaaatacattcaaatatgtatccgctcatgagacaataaccctgataaatgcttcaataatattgaaaaaggaagagtatgagtattcaacatttccgtgtcgcccttattcccttttttgcggcattttgccttcctgtttttgctcacccagaaaccttggtgaaagtaaaagatgctgaagatcagttgggtgcccgagtgggttacatcgaactagatctcaacagcggtaagatccttgagagttttaggcctgaagaacgttttccaatgatgagcacttttaaagttctgctatgtggcgcggtgctgagccgtattgacgctggccaagagcaactcggtactcccgccggatccactattctcagaatgacctggttgagtactcaccagtcacagaaaagcatcttacggatggcatgaccgtacgagaattatgcagtgctgccataaccatgagtgataacactgcggccaacttactgttaacaacgatcggaggacctaaggagctaaccgcttttttgcacaacatgggggatcacgtgactcgccttgatcgttgggaaccggagctgaatgaagccataccaaacgacgagcgtgacaccacgatgcctgtagcaatggcaacaacgttgcgcaaactattaactggcgaactacttactctagcttcccggcaacaattaatagactggatggaggcggataaagtggccggcccacttcttcgaagtgcccttccggctggctggtttattgctgataaatctggagccggtgagcgtgggtctcgcggtatcattgcagcactcggaccggatggtaagccctcccgtatcgtagttatctacacgacggggagtcaggcaactatggatgaacgaaatagacagatcgctgagataggtgcctcattaattaagcattggtaatgacggccgatggtcatccacgtcctgtcagaccaagtttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgttcttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcatacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaagagctcctcactcattaggcaccccaggctttacactttatgcttccggctcgtatgttgtgtggaattgtgagcggataacaatttcacacaggaaacagctatgaccatgattacgccaagctttggagccttttttttggagattttcaacatgaagaaactgctgtctgctatcccactagttgtccctttctattctcatagtgaaattgtgttgacgcagtccccggggaccctgtctttgtctccaggggaaagagccacgctgagctgctaggcatagcagagtgttagcagcagctacttagcctggtatcagcagaaaccgggtcaggctccgcggctcctcatctatggtgcataaagctaggccactggcatcccagacaggttcagtggcagtgggtctgggacagacttcactctcaccatcagcagactcgagcctgaagattttgcagtgtattactgtcagcagtagggtagctaacctctcactttcggcggaggcactaaggtggagatcaaacgtggaactgtggctgcaccatctgtcttcatcttcccgccatctgatgagcagttgaaatctggaactgcctctgttgtgtgcctgctgaataacttctatcccagagaggccaaagtacagtggaaggtggataacgccctccaatcggggaattcccaggagagtgtcacagagcaggacagcaaggacagcacctacagcctcagcagcaccctgactctgtccaaagcagactacgagaaacacaaagtctacgcctgcgaagtcacccatcagggcctgagttcaccggtgacaaagagcttcaacaggggagagtgttaataaggcgcgcctaaccatctatttcaaggaacagtcttaatgaagaaactgctctttgctatcccgctcgtcgttccttttgtggcccagccggccatggccgaagttcaattgttagagtctggtggcggtcttgttcagcctggtggttctttacgtctttcttgcgctgcttccggattcactttctcttcgtaggcttaatcttgggttcgccaagctcctggtaaaggtttggagtgggtttcttgaatctaaggttctggtggcagtacttactatgctgactccgttaaaggtcgcttcactatctctagagacaactctaagaatactctctacttgcagatgaacagcttaagggctgaggacactgcagtctactattgcgctaaagattaggaaggttagggttatgctttcgatatatggggtcaaggtactatggtcaccgtctctagtgcctccaccaaaggtccatcggtcttcccgctagcaccctcctccaagagcacctctgggggcacagcggccctgggctgcctggtcaaggactacttccccgaaccggtgacggtgtcgtggaactcaggtgctctgaccagcggcgtccacaccttcccggctgtcctacagtctagcggactctactccctcagcagcgtagtgaccgtgccctcttctagcttgggcacccagacctacatctgcaacgtgaatcacaagcccagcaacaccaaggtggacaagaaagttgagcccaaatcttgtgctgggccccatcatcatcaccatcacggggccgcagaacaaaaactcatctcagaagaggatctgaatggggccgcagaggctagttctgctagtaacgcgtcttccggtgattttgattatgaaaagatggcaaacgctaataagggggctatgaccgaaaatgccgatgaaaacgcgctacagtctgacgctaaaggcaaacttgattctgtcgctactgattacggtgctgctatcgatggtttcattggtgacgtttccggccttgctaatggtaatggtgctactggtgattttgctggctctaattcccaaatggctcaagtcggtgacggtgataattcacctttaatgaataatttccgtcaatatttaccttccctccctcaatcggttgaatgtcgcccttttgtctttggcgctggtaaaccatatgaattttctattgattgtgacaaaataaacttattccgtggtgtctttgcgtttcttttatatgttgccacctttatgtatgtattttctacgtttgctaacatactgcgtaataaggagtcttaatgaaacgcgtgatgagatatcactggccgtcgttttacaacgtcgtgactgggaaaaccctggcgttacccaacttaatcgccttgcagcacatccccctttcgccagctggcgtaatagcgaagaggcccgcaccgatcgcccttcccaacagttgcgcagcctgaatggcgaatggcgcctgatgcggtattttctccttacgcatctgtgcggtatttcacaccgcatacgtcaaagcaaccatagtgtgcacacgcgccctgtagcggcgcattaagcgcggcgggtgtggtggttacgcgcagcgtgaccgctacacttgccagcgccttagcgcccgctcctttcgctttcttcccttcctttctcgccacgttcgccggctttccccgtcaagctctaaatcgggggctccctttagggttccgatttagtgctttacggcacctcgaccccaaaaaacttgatttgggtgatggttcacgtagtgggccatcgccctgatagacggtttttcgccctttgacgttggagtccacgttctttaatagtggactcttgttccaaactggaacaacactcaactctatctcgggctattcttttgatttataagggattttgccgatttcgg

SEQ ID NO: 1158 - protein, 286 aa, Artificial Sequence
  Description of Artificial Sequence Synthetic polypeptide
MSIQHFRVALIPFFAAFCLPVFAHPETLVKVKDAEDQLGARVGYIELDLNSGKILESFRPEERFPMMSTFKVLLCGAVLSRIDAGQEQLGRRIHYSQNDLVEYSPVTEKHLTDGMTVRELCSAAITMSDNTAANLLLTTIGGPKELTAFLHNMGDHVTRLDRWEPELNEAIPNDERDTTMPVAMATTLRKLLTGELLTLASRQQLIDWMEADKVAGPLLRSALPAGWFIADKSGAGERGSRGIIAALGPDGKPSRIVVIYTTGSQATMDERNRQIAEIGASLIKHW

SEQ ID NO: 1159 - protein, 235 aa, Artificial Sequence
  Description of Artificial Sequence Synthetic polypeptide
MKKLLSAIPLVVPFYSHSEIVLTQSPGTLSLSPGERATLSCRASQSVSSSAYLAWYQQKPGQAPRLLIYGASSRATGIPDRFSGSGSGTDFTLTISRLEPEDFAVYYCQQYGSSPLTFGGGTKVEIKRGTVAAPSVFIFPPSDEQLKSGTASVVCLLNNFYPREAKVQWKVDNALQSGNSQESVTEQDSKDSTYSLSSTLTLSKADYEKHKVYACEVTHQGLSSPVTKSFNRGEC

SEQ ID NO: 1160 - protein, 431 aa, Artificial Sequence
  Description of Artificial Sequence Synthetic polypeptide
MKKLLFAIPLVVPFVAQPAMAEVQLLESGGGLVQPGGSLRLSCAASGFTFSSYAMSWVRQAPGKGLEWVSAISGSGGSTYYADSVKGRFTISRDNSKNTLYLQMNSLRAEDTAVYYCAKDYEGTGYAFDIWGQGTMVTVSSASTKGPSVFPLAPSSKSTSGGTAALGCLVKDYFPEPVTVSWNSGALTSGVHTFPAVLQSSGLYSLTSVVTVPSSSLGTQTYICNVNHKPSNTKVDKKVEPKSCAGPHHHHHHGAAEQKLISEEDLNGAAEASSASNASSGDFDYEKMANANKGAMTENADENALQSDAKGKLDSVATDYGAAIDGFIGDVSGLANGNGATGDFAGSNSQMAQVGDGDNSPLMNNFRQYLPSLPQSVECRPFVFGAGKPYEFSIDCDKINLFRGVFAFLLYVATFMYVFSTFANILRNKES

SEQ ID NO: 1161 - DNA, 4621 bp, Artificial Sequence
  Description of Artificial Sequence Synthetic polynucleotide
ggtaccgattacgatcggccggcacttttcggggaaatgtgcgcggaacccctatttgtttatttttctaaatacattcaaatatgtatccgctcatgagacaataaccctgataaatgcttcaataatattgaaaaaggaagagtatgagtattcaacatttccgtgtcgcccttattcccttttttgcggcattttgccttcctgtttttgctcacccagaaaccttggtgaaagtaaaagatgctgaagatcagttgggtgcccgagtgggttacatcgaactagatctcaacagcggtaagatccttgagagttttaggcctgaagaacgttttccaatgatgagcacttttaaagttctgctatgtggcgcggtgctgagccgtattgacgctggccaagagcaactcggtcgccggatccactattctcagaatgacctggttgagtactcaccagtcacagaaaagcatcttacggatggcatgaccgtacgagaattatgcagtgctgccataaccatgagtgataacactgcggccaacttactgttaacaacgatcggaggacctaaggagctaaccgcttttttgcacaacatgggggatcacgtgactcgccttgatcgttgggaaccggagctgaatgaagccataccaaacgacgagcgtgacaccacgatgcctgtagcaatggcaacaacgttgcgcaaactattaactggcgaactacttactctagcttcccggcaacaattaatagactggatggaggcggataaagtggccggcccacttcttcgaagtgcccttccggctggctggtttattgctgataaatctggagccggtgagcgtgggtctcgcggtatcattgcagcactcggaccggatggtaagccctcccgtatcgtagttatctacacgacggggagtcaggcaactatggatgaacgaaatagacagatcgctgagataggtgcctcattaattaagcattggtaatgacggccgatggtcatccacgtcctgtcagaccaagtttactcatatatactttagattgatttaaaacttcatttttaatttaaaaggatctaggtgaagatcctttttgataatctcatgaccaaaatcccttaacgtgagttttcgttccactgagcgtcagaccccgtagaaaagatcaaaggatcttcttgagatcctttttttctgcgcgtaatctgctgcttgcaaacaaaaaaaccaccgctaccagcggtggtttgtttgccggatcaagagctaccaactctttttccgaaggtaactggcttcagcagagcgcagataccaaatactgttcttctagtgtagccgtagttaggccaccacttcaagaactctgtagcaccgcctacatacctcgctctgctaatcctgttaccagtggctgctgccagtggcgataagtcgtgtcttaccgggttggactcaagacgatagttaccggataaggcgcagcggtcgggctgaacggggggttcgtgcatacagcccagcttggagcgaacgacctacaccgaactgagatacctacagcgtgagctatgagaaagcgccacgcttcccgaagggagaaaggcggacaggtatccggtaagcggcagggtcggaacaggagagcgcacgagggagcttccagggggaaacgcctggtatctttatagtcctgtcgggtttcgccacctctgacttgagcgtcgatttttgtgatgctcgtcaggggggcggagcctatggaaagagctcctcactcattaggcaccccaggctttacactttatgcttccggctcgtatgttgtgtggaattgtgagcggataacaatttcacacaggaaacagctatgaccatgattacgccaagctttggagccttttttttggagattttcaacatgaagaaactgctgtctgctatcccactagttgtccctttctattctcatagtgaaattgtgttgacgcagtccccggggaccctgtctttgtctccaggggaaagagccacgctgagctgctaggcatagcagagtgttagcagcagctacttagcctggtatcagcagaaaccgggtcaggctccgcggctcctcatctatggtgcataaagctaggccactggcatcccagacaggttcagtggcagtgggtctgggacagacttcactctcaccatcagcagactcgagcctgaagattttgcagtgtattactgtcagcagtagggtagctaacctctcactttcggcggaggcactaaggtggagatcaaacgtggaactgtggctgcaccatctgtcttcatcttcccgccatctgatgagcagttgaaatctggaactgcctctgttgtgtgcctgctgaataacttctatcccagagaggccaaagtacagtggaaggtggataacgccctccaatcggggaattcccaggagagtgtcacagagcaggacagcaaggacagcacctacagcctcagcagcaccctgactctgtccaaagcagactacgagaaacacaaagtctacgcctgcgaagtcacccatcagggcctgagttcaccggtgacaaagagcttcaacaggggagagtgttaataaggcgcgcctaaccatctatttcaaggaacagtcttaatgaagaaactgctctttgctatcccgctcgtcgttccttttgtggcccagccggccatggccgaagttcaattgttagagtctggtggcggtcttgttcagcctggtggttctttacgtctttcttgcgctgcttccggattcactttctcttcgtaggcttaatcttgggttcgccaagctcctggtaaaggtttggagtgggtttcttgaatctaaggttctggtggcagtacttactatgctgactccgttaaaggtcgcttcactatctctagagacaactctaagaatactctctacttgcagatgaacagcttaagggctgaggacactgcagtctactattgcgctaaagattaggaaggttagggttatgctttcgatatatggggtcaaggtactatggtcaccgtctctagtgcctccaccaaaggtccatcggtcttcccgctagcaccctcctccaagagcacctctgggggcacagcggccctgggctgcctggtcaaggactacttccccgaaccggtgacggtgtcgtggaactcaggtgctctgaccagcggcgtccacaccttcccggctgtcctacagtctagcggactctactccctcagcagcgtagtgaccgtgccctcttctagcttgggcacccagacctacatctgcaacgtgaatcacaagcccagcaacaccaaggtggacaagaaagttgagcccaaatcttgtgctgggccccatcatcatcaccatcacggggccgcagaacaaaaactcatctcagaagaggatctgaatggggccgcagaggctagttctgctagtaacgcgtcttccggtgattttgattatgaaaagatggcaaacgctaataagggggctatgaccgaaaatgccgatgaaaacgcgctacagtctgacgctaaaggcaaacttgattctgtcgctactgattacggtgctgctatcgatggtttcattggtgacgtttccggccttgctaatggtaatggtgctactggtgattttgctggctctaattcccaaatggctcaagtcggtgacggtgataattcacctttaatgaataatttccgtcaatatttaccttccctccctcaatcggttgaatgtcgcccttttgtctttggcgctggtaaaccatatgaattttctattgattgtgacaaaataaacttattccgtggtgtctttgcgtttcttttatatgttgccacctttatgtatgtattttctacgtttgctaacatactgcgtaataaggagtcttaatgaaacgcgtgatgagatatcactggccgtcgttttacaacgtcgtgactgggaaaaccctggcgttacccaacttaatcgccttgcagcacatccccctttcgccagctggcgtaatagcgaagaggcccgcaccgatcgcccttcccaacagttgcgcagcctgaatggcgaatggcgcctgatgcggtattttctccttacgcatctgtgcggtatttcacaccgcatacgtcaaagcaaccatagtgtgcacacgcgccctgtagcggcgcattaagcgcggcgggtgtggtggttacgcgcagcgtgaccgctacacttgccagcgccttagcgcccgctcctttcgctttcttcccttcctttctcgccacgttcgccggctttccccgtcaagctctaaatcgggggctccctttagggttccgatttagtgctttacggcacctcgaccccaaaaaacttgatttgggtgatggttcacgtagtgggccatcgccctgatagacggtttttcgccctttgacgttggagtccacgttctttaatagtggactcttgttccaaactggaacaacactcaactctatctcgggctattcttttgatttataagggattttgccgatttcgg

SEQ ID NO: 1162 - protein, 12 aa, Artificial Sequence
  Description of Artificial Sequence Synthetic peptide
RASHSVSSSYLA

SEQ ID NO: 1163 - protein, 12 aa, Artificial Sequence
  Description of Artificial Sequence Synthetic peptide
RASESVSSSYLA

SEQ ID NO: 1164 - protein, 12 aa, Artificial Sequence
  Description of Artificial Sequence Synthetic peptide
RASRSVSSSYLA

SEQ ID NO: 1165 - protein, 12 aa, Artificial Sequence
  Description of Artificial Sequence Synthetic peptide
RASQSVRSSYLA

SEQ ID NO: 1166 - protein, 12 aa, Artificial Sequence
  Description of Artificial Sequence Synthetic peptide
RASQSVTSSYLA

SEQ ID NO: 1167 - protein, 12 aa, Artificial Sequence
  Description of Artificial Sequence Synthetic peptide
RASQSVGSSYLA

SEQ ID NO: 1168 - protein, 12 aa, Artificial Sequence
  Description of Artificial Sequence Synthetic peptide
RASQSVNSSYLA

SEQ ID NO: 1169 - protein, 12 aa, Artificial Sequence
  Description of Artificial Sequence Synthetic peptide
RASQSVSSFYLA

SEQ ID NO: 1170 - protein, 12 aa, Artificial Sequence
  Description of Artificial Sequence Synthetic peptide
RASQSVSSSYLA

SEQ ID NO: 1171 - protein, 12 aa, Artificial Sequence
  Description of Artificial Sequence Synthetic peptide
RASQSVSSHYLA

SEQ ID NO: 1172 - protein, 11 aa, Artificial Sequence
  Description of Artificial Sequence Synthetic peptide
RASQSVSSYLA

SEQ ID NO: 1173 - protein, 11 aa, Artificial Sequence
  Description of Artificial Sequence Synthetic peptide
RASQSVRSYLA

SEQ ID NO: 1174 - protein, 9 aa, Artificial Sequence
  Description of Artificial Sequence Synthetic peptide
QQRGSSPLT

SEQ ID NO: 1175 - protein, 9 aa, Artificial Sequence
  Description of Artificial Sequence Synthetic peptide
QQSGSSPLT

SEQ ID NO: 1176 - protein, 9 aa, Artificial Sequence
  Description of Artificial Sequence Synthetic peptide
QQFGSSPLT

SEQ ID NO: 1177 - protein, 9 aa, Artificial Sequence
  Description of Artificial Sequence Synthetic peptide
QQYSSSPLT

SEQ ID NO: 1178 - protein, 9 aa, Artificial Sequence
  Description of Artificial Sequence Synthetic peptide
QQYASSPLT

SEQ ID NO: 1179 - protein, 9 aa, Artificial Sequence
  Description of Artificial Sequence Synthetic peptide
QQYDSSPLT

SEQ ID NO: 1180 - protein, 9 aa, Artificial Sequence
  Description of Artificial Sequence Synthetic peptide
QQYGNSPLT

SEQ ID NO: 1181 - protein, 9 aa, Artificial Sequence
  Description of Artificial Sequence Synthetic peptide
QQYGRSPLT

SEQ ID NO: 1182 - protein, 9 aa, Artificial Sequence
  Description of Artificial Sequence Synthetic peptide
QQYGGSPLT

SEQ ID NO: 1183 - protein, 9 aa, Artificial Sequence
  Description of Artificial Sequence Synthetic peptide
QQYGDSPLT

SEQ ID NO: 1184 - protein, 9 aa, Artificial Sequence
  Description of Artificial Sequence Synthetic peptide
QQYGSWPLT

SEQ ID NO: 1185 - protein, 9 aa, Artificial Sequence
  Description of Artificial Sequence Synthetic peptide
QQYGSPPLT

SEQ ID NO: 1186 - protein, 9 aa, Artificial Sequence
  Description of Artificial Sequence Synthetic peptide
QQYGSFPLT

SEQ ID NO: 1187 - protein, 9 aa, Artificial Sequence
  Description of Artificial Sequence Synthetic peptide
QQYGSSPRT

SEQ ID NO: 1188 - protein, 9 aa, Artificial Sequence
  Description of Artificial Sequence Synthetic peptide
QQYGSSPYT

SEQ ID NO: 1189 - protein, 10 aa, Artificial Sequence
  Description of Artificial Sequence Synthetic peptide
QQYGSSPPLT

SEQ ID NO: 1190 - protein, 10 aa, Artificial Sequence
  Description of Artificial Sequence Synthetic peptide
QQYGSSLPLT

SEQ ID NO: 1191 - protein, 10 aa, Artificial Sequence
  Description of Artificial Sequence Synthetic peptide
QQRGSSPPLT

SEQ ID NO: 1192 - protein, 10 aa, Artificial Sequence
  Description of Artificial Sequence Synthetic peptide
QQYSSSPPLT

SEQ ID NO: 1193 - protein, 10 aa, Artificial Sequence
  Description of Artificial Sequence Synthetic peptide
QQYGNSPPLT

SEQ ID NO: 1194 - protein, 10 aa, Artificial Sequence
  Description of Artificial Sequence Synthetic peptide
QQYGSWPPLT

SEQ ID NO: 1195 - protein, 10 aa, Artificial Sequence
  Description of Artificial Sequence Synthetic peptide
QQYGSWPPYT

SEQ ID NO: 1196 - protein, 12 aa, Artificial Sequence
  Description of Artificial Sequence Synthetic peptide
RASXXVXXXXLA

SEQ ID NO: 1197 - protein, 7 aa, Artificial Sequence
  Description of Artificial Sequence Synthetic peptide
XASXRAX

SEQ ID NO: 1198 - protein, 16 aa, Artificial Sequence
  Description of Artificial Sequence Synthetic peptide
XXXXDSSXXXGXXXXX

SEQ ID NO: 1199 - protein, 19 aa, Artificial Sequence
  Description of Artificial Sequence Synthetic peptide
XXXXYDSSGYYYXXXXFDY

SEQ ID NO: 1200 - protein, 13 aa, Artificial Sequence
  Description of Artificial Sequence Synthetic peptide
XXDYGDYXXAFDY

SEQ ID NO: 1201 - protein, 13 aa, Artificial Sequence
  Description of Artificial Sequence Synthetic peptide
XXGYSSSWYXXXX

SEQ ID NO: 1202 - protein, 17 aa, Artificial Sequence
  Description of Artificial Sequence Synthetic peptide
XXGYCSGGSCYSXXFDY

SEQ ID NO: 1203 - protein, 6 aa, Artificial Sequence
  Description of Artificial Sequence Synthetic peptide
AEYFQH

SEQ ID NO: 1204 - protein, 6 aa, Artificial Sequence
  Description of Artificial Sequence Synthetic peptide
YDYGDY

SEQ ID NO: 1205 - protein, 6 aa, Artificial Sequence
  Description of Artificial Sequence Synthetic peptide
GYSYGY

SEQ ID NO: 1206 - protein, 6 aa, Artificial Sequence
  Description of Artificial Sequence Synthetic peptide
SYYFDY

SEQ ID NO: 1207 - protein, 8 aa, Artificial Sequence
  Description of Artificial Sequence Synthetic peptide
YYAEYFQH

SEQ ID NO: 1208 - protein, 8 aa, Artificial Sequence
  Description of Artificial Sequence Synthetic peptide
YGYSSSWY

SEQ ID NO: 1209 - protein, 8 aa, Artificial Sequence
  Description of Artificial Sequence Synthetic peptide
YGDYYFDY

SEQ ID NO: 1210 - protein, 10 aa, Artificial Sequence
  Description of Artificial Sequence Synthetic peptide
YYYDSSGYYY

SEQ ID NO: 1211 - protein, 10 aa, Artificial Sequence
  Description of Artificial Sequence Synthetic peptide
GYCSSTSCYT

SEQ ID NO: 1212 - protein, 10 aa, Artificial Sequence
  Description of Artificial Sequence Synthetic peptide
YYSSAEYFQH

SEQ ID NO: 1213 - protein, 10 aa, Artificial Sequence
  Description of Artificial Sequence Synthetic peptide
GYSYGYYFDY

SEQ ID NO: 1214 - protein, 12 aa, Artificial Sequence
  Description of Artificial Sequence Synthetic peptide
YYYDSSGYYYQH

SEQ ID NO: 1215 - protein, 12 aa, Artificial Sequence
  Description of Artificial Sequence Synthetic peptide
GYCSSTSCYTQH

SEQ ID NO: 1216 - protein, 12 aa, Artificial Sequence
  Description of Artificial Sequence Synthetic peptide
YDGSYSAEYFQH

SEQ ID NO: 1217 - protein, 12 aa, Artificial Sequence
  Description of Artificial Sequence Synthetic peptide
YYDYVWGSYRYT

SEQ ID NO: 1218 - protein, 12 aa, Artificial Sequence
  Description of Artificial Sequence Synthetic peptide
GYSYGYYWYFDL

SEQ ID NO: 1219 - protein, 14 aa, Artificial Sequence
  Description of Artificial Sequence Synthetic peptide
YYYDSSGYYYYFQH

SEQ ID NO: 1220 - protein, 14 aa, Artificial Sequence
  Description of Artificial Sequence Synthetic peptide
GYCSSTSCYTYFQH

SEQ ID NO: 1221 - protein, 14 aa, Artificial Sequence
  Description of Artificial Sequence Synthetic peptide
SYGYCSSTSCYTQH

SEQ ID NO: 1222 - protein, 14 aa, Artificial Sequence
  Description of Artificial Sequence Synthetic peptide
SYRYSGYSAEYFQH

SEQ ID NO: 1223 - protein, 14 aa, Artificial Sequence
  Description of Artificial Sequence Synthetic peptide
AYCGGDCYSNWFDP

SEQ ID NO: 1224 - protein, 15 aa, Artificial Sequence
  Description of Artificial Sequence Synthetic peptide
SDGYYYDSSGYYYDY

SEQ ID NO: 1225 - protein, 15 aa, Artificial Sequence
  Description of Artificial Sequence Synthetic peptide
GSGYCSGGSCYSFDY

SEQ ID NO: 1226 - protein, 15 aa, Artificial Sequence
  Description of Artificial Sequence Synthetic peptide
GGRGYSSGWYRAFDI

SEQ ID NO: 1227 - protein, 16 aa, Artificial Sequence
  Description of Artificial Sequence Synthetic peptide
YYYDSSGYYYAEYFQH

SEQ ID NO: 1228 - protein, 16 aa, Artificial Sequence
  Description of Artificial Sequence Synthetic peptide
GYCSSTSCYTAEYFQH

SEQ ID NO: 1229 - protein, 16 aa, Artificial Sequence
  Description of Artificial Sequence Synthetic peptide
SYDSYRSYGSAEYFQH

SEQ ID NO: 1230 - protein, 16 aa, Artificial Sequence
  Description of Artificial Sequence Synthetic peptide
SYSYGYCSSTSCYTQH

SEQ ID NO: 1231 - protein, 17 aa, Artificial Sequence
  Description of Artificial Sequence Synthetic peptide
SRPGYSSSWYYYYGMDV

SEQ ID NO: 1232 - protein, 18 aa, Artificial Sequence
  Description of Artificial Sequence Synthetic peptide
GYCSGGSCYSYYYYGMDV

SEQ ID NO: 1233 - protein, 18 aa, Artificial Sequence
  Description of Artificial Sequence Synthetic peptide
DGYCSGGSCYSYYYGMDV

SEQ ID NO: 1234 - protein, 19 aa, Artificial Sequence
  Description of Artificial Sequence Synthetic peptide
DGYYYDSSGYYYRGYYFDY

SEQ ID NO: 1235 - protein, 20 aa, Artificial Sequence
  Description of Artificial Sequence Synthetic peptide
YSSYYYYDSSGYYYAEYFQH

SEQ ID NO: 1236 - protein, 20 aa, Artificial Sequence
  Description of Artificial Sequence Synthetic peptide
SYYSGYCSSTSCYTAEYFQH

SEQ ID NO: 1237 - protein, 20 aa, Artificial Sequence
  Description of Artificial Sequence Synthetic peptide
SGYCSSTSCYTYYSAEYFQH

SEQ ID NO: 1238 - protein, 20 aa, Artificial Sequence
  Description of Artificial Sequence Synthetic peptide
YYYYDYVWGSYRYTSNWFDP

SEQ ID NO: 1239 - protein, 20 aa, Artificial Sequence
  Description of Artificial Sequence Synthetic peptide
YYYYDYVWGSYRYTSSYFDY

SEQ ID NO: 1240 - protein, 15 aa, Artificial Sequence
  Description of Artificial Sequence Synthetic peptide
GSGYCSGGSCYSFDY

SEQ ID NO: 1241 - protein, 8 aa, Artificial Sequence
  Description of Artificial Sequence Synthetic peptide
YDSSGYYY

SEQ ID NO: 1242 - protein, 5 aa, Artificial Sequence
  Description of Artificial Sequence Synthetic peptide
DYGDY

SEQ ID NO: 1243 - protein, 7 aa, Artificial Sequence
  Description of Artificial Sequence Synthetic peptide
GYSSSWY

SEQ ID NO: 1244 - protein, 10 aa, Artificial Sequence
  Description of Artificial Sequence Synthetic peptide
GYCSGGSCYS

SEQ ID NO: 1245 - protein, 4 aa, Artificial Sequence
  Description of Artificial Sequence Synthetic peptide
YYSS

SEQ ID NO: 1246 - protein, 6 aa, Artificial Sequence
  Description of Artificial Sequence Synthetic peptide
YDGSYS

SEQ ID NO: 1247 - protein, 4 aa, Artificial Sequence
  Description of Artificial Sequence Synthetic peptide
YFQH

SEQ ID NO: 1248 - protein, 8 aa, Artificial Sequence
  Description of Artificial Sequence Synthetic peptide
SYRYSGYS

SEQ ID NO: 1249 - protein, 10 aa, Artificial Sequence
  Description of Artificial Sequence Synthetic peptide
SYDSYRSYGS

SEQ ID NO: 1250 - protein, 4 aa, Artificial Sequence
  Description of Artificial Sequence Synthetic peptide
SYSY

SEQ ID NO: 1251 - protein, 4 aa, Artificial Sequence
  Description of Artificial Sequence Synthetic peptide
YSSY

SEQ ID NO: 1252 - protein, 4 aa, Artificial Sequence
  Description of Artificial Sequence Synthetic peptide
SYYS

SEQ ID NO: 1253 - protein, 5 aa, Artificial Sequence
  Description of Artificial Sequence Synthetic peptide
YGYSY

SEQ ID NO: 1254 - protein, 14 aa, Artificial Sequence
  Description of Artificial Sequence Synthetic peptide
XXGXGXXXXXXFDY

SEQ ID NO: 1255 - protein, 16 aa, Artificial Sequence
  Description of Artificial Sequence Synthetic peptide
XXXXDSSXXXGXXFDY

SEQ ID NO: 1256 - protein, 19 aa, Artificial Sequence
  Description of Artificial Sequence Synthetic peptide
XXXXXDSSGYXXXXXXXDY

SEQ ID NO: 1257 - protein, 13 aa, Artificial Sequence
  Description of Artificial Sequence Synthetic peptide
XXXYGDXXXXFDI

SEQ ID NO: 1258 - protein, 13 aa, Artificial Sequence
  Description of Artificial Sequence Synthetic peptide
XXXXSSXWXXFDL

SEQ ID NO: 1259 - protein, 17 aa, Artificial Sequence
  Description of Artificial Sequence Synthetic peptide
XXXXCXXXXCXXXXFDL

SEQ ID NO: 1260 - DNA, 273 bp, Artificial Sequence
  Description of Artificial Sequence Synthetic polynucleotide
ttcgtggcccagccggcctctgctgaagttcaattgttagagtctggtggcggtcttgttcagcctggtggttctttacgtctttcttgcgctgcttccggattcactttctctnnntacnnnatgnnntgggttcgccaagctcctggtaaaggtttggagtgggtttctnnnatcnnnnnnnnnnnnnnnnnnactnnntatgctgactccgttaaaggtcgcttcactatctctagagacaactctaagaatactctctacttgcagatg

SEQ ID NO: 1261 - protein, 91 aa, Artificial Sequence
  Description of Artificial Sequence Synthetic polypeptide
FVAQPASAEVQLLESGGGLVQPGGSLRLSCAASGFTFSSYAMSWVRQAPGKGLEWVSAISGSGGSTYYADSVKGRFTISRDNSKNTLYLQM

SEQ ID NO: 1262 - protein, 17 aa, Artificial Sequence
  Description of Artificial Sequence Synthetic peptide
GIIPIFGTANYAQKFQG

SEQ ID NO: 1263 - protein, 13 aa, Artificial Sequence
  Description of Artificial Sequence Synthetic peptide
XXXYGDXXXXFDI

SEQ ID NO: 1264 - protein, 4 aa, Artificial Sequence
  Description of Artificial Sequence Synthetic peptide
AFDY

SEQ ID NO: 1265 - protein, 4 aa, Artificial Sequence
  Description of Artificial Sequence Synthetic peptide
YDSY

SEQ ID NO: 1266 - protein, 6 aa, Artificial Sequence
  Description of Artificial Sequence Synthetic 6xHis tag
HHHHHH

SEQ ID NO: 1267 - protein, 17 aa, Artificial Sequence
  Description of Artificial Sequence Synthetic peptide
XXXXCXXXXCXXXXFDL

SEQ ID NO: 1268 - DNA, 11 bp, Artificial Sequence
  Description of Artificial Sequence Synthetic oligonucleotide
nnnnngaagag

(19) United States
(12) Patent Application Publication
(10) Pub. No.: US 2011/0082054 A1
(43) Pub. Date: Apr. 7, 2011

(54) LIBRARIES OF GENETIC PACKAGES COMPRISING NOVEL HC CDR3 DESIGNS

(75) Inventor: Robert C. Ladner, Ijamsville, MD (US)

(73) Assignee: DYAX CORP., Cambridge, MA (US)

(21) Appl. No.: 12/882,180

(22) Filed: Sep. 14, 2010

Related U.S. Application Data
(60) Provisional application No. 61/242,172, filed on Sep. 14, 2009.

(51) Int. Cl. C40B 40/08; C40B 40/10

(52) U.S. Cl. 506/17; 506/18

(57) ABSTRACT

Provided are compositions and methods for preparing and identifying antibodies having CDR3s that vary in sequence and in length from very short to very long. Libraries encoding antibodies with the CDR3s are also provided. The libraries can be provided by modifying a pre-existing nucleic acid library.

This application claims priority to U.S. Application Ser. No. 61/242,172, filed on Sep. 14, 2009. The disclosure of the prior application is considered part of (and is incorporated by reference in) the disclosure of this application.

### SEQUENCE LISTING

The instant application contains a Sequence Listing which has been submitted in ASCII format via EFS-Web and is hereby incorporated by reference in its entirety. Said ASCII copy, created on Oct. 27, 2010, is named D2033713.txt and is 464,303 bytes in size.

### BACKGROUND

It is now common practice in the art to prepare libraries of genetic packages that individually display, display and express, or comprise a member of a diverse family of peptides, polypeptides or proteins and collectively display, display and express, or comprise at least a portion of the amino acid diversity of the family. In many common libraries, the peptides, polypeptides or proteins are antibodies (e.g., single chain Fv (scFv), Fv (a complex of VH and VL), Fab (a complex of VH-CH1 and VL-CL), whole antibodies, or minibodies (e.g., dimers that consist of V_{H} linked to V_{L} linked to CH2-CH3)). Often, they comprise one or more of the complementarity determining regions (CDRs) and framework regions (FR) of the heavy chains (HC) and light chains (LC) of human antibodies.

Peptide, polypeptide or protein libraries have been produced in several ways. See, e.g., Knappik et al., J. Mol. Biol., 296, pp. 57-86 (2000). One method is to capture the diversity of native donors, either naive or immunized. Another way is to generate libraries having synthetic diversity. A third method is a combination of the first two (Hoet et al. Nat. BIotechnol, 23, pp. 344-8 (2005)). Typically, the diversity produced by these methods is limited to sequence diversity, i.e., each member of the library has the same length but differs from the other members of the family by having different amino acids or variegation at a given position in the peptide, polypeptide or protein chain. Naturally diverse peptides, polypeptides or proteins, however, are not limited to diversity only in their amino acid sequences. For example, human antibodies are not limited to sequence diversity in their amino acids, they are also diverse in the lengths of their amino acid chains.

### SUMMARY

For antibodies, HC diversity in length occurs, for example, during variable region rearrangements. See e.g., Corbett et al., J. Mol. Biol., 270, pp. 587-97 (1997). The joining of Variable (V) genes to Joining (J) genes, for example, results in the inclusion of a recognizable Diversity (D) segment in CDR3 in about half of the heavy chain antibody sequences, thus creating regions encoding varying lengths of amino acids. D segments are more common in antibodies having long HC CDR3s. As shown in Table 76, the median length of CDR3 is 11.5 overall, 9.5 in CDRs having no D segment, and 13.8 in CDRs having a D segment. The following also may occur during joining of antibody gene segments: (i) the end of the V gene may have zero to several bases deleted or changed; (ii) the 5′ or 3′ end of the D segment may have zero to many bases removed or changed; (iii) a number of not random bases may be inserted between V and D (VD fill), between D and J (DJ fill), or between V and J (VJ fill); and (iv) the 5′ end of J may be edited to remove or have several bases changed. These rearrangements result in antibodies that are diverse both in amino acid sequence and in length. HC CDR3s of different lengths may fold into different shapes, giving the antibodies novel shapes with which to bind antigens. In addition, having variable length in VD fill and in DJ fill positions the D segment differently giving a additional kind of diversity, positional diversity. The conformation of CDR3 depends on both the length and the sequence of the CDR3. It should be remembered that a HC CDR3 of length 8, for example, and of any sequence cannot adequately mimic the behavior of a CDR3 of length 22, for example.

As demonstrated in the present disclosure, the immune system produces antibodies that differ in length in CDRs, especially HC CDR3, LC CDR1, and LC CDR3. A preferred embodiment is a library that contains a variety of differing HC CDR3 lengths. For example, one embodiment has a library of antibodies in which about 25%, 30%, 40%, 50%, 60%, or 100% of the antibodies have a HC CDR3 that contains no D segment and, e.g., have lengths of 8, 9, 10, and 11, e.g., with Len8:Len9:Len10:Len11::1:2:2:1 (e.g. HC CDR3 library #1 Version 3). In one embodiment, the library of antibodies has about 25%, 30%, 40%, 50%, 60%, or 100% of the members of the library having a HC CDR3 that contains no D segment and, e.g., have lengths of 5, 6, 7, 8, 9, 10, and 11, e.g., with Len5:Len6:Len7:Len8:Len9:Len10:Len11::1:1:1:1:1:1:1 or 3:2:2:2:1:1:1 or 1:1:1:2:2:2:3. In some embodiments, the library of antibodies have about 60%, 50%, 40% of the antibodies having a HC CDR3 that have a portion of D3-22.2 (e.g. Library number 3 of example 1) and, e.g., have a length distribution of Len12:Len13:Len14:Len15:Len16::10:8:6:5:3. Different targets may require different length distributions.

Libraries that contain only amino acid sequence diversity are, thus, disadvantaged in that they do not reflect the natural diversity of the peptide, polypeptide or protein that the library is intended to mimic. Further, diversity in length may be important to the ultimate functioning of the protein, peptide or polypeptide. For example, with regard to a library comprising antibody regions, many of the peptides, polypeptides, proteins displayed, displayed and expressed, or comprised by the genetic packages of the library may not fold properly or their binding to an antigen may be disadvantaged, if diversity both in sequence and length are not represented in the library.

An additional disadvantage of such libraries of genetic packages that display, display and express, or comprise peptides, polypeptides and proteins is that they are not focused on those members that are based on natural occurring diversity and thus on members that are most likely to be functional and least likely to be immunogenic. Rather, the libraries, typically, attempt to include as much diversity or variegation as possible at every CDR position. This makes library construction time-consuming and less efficient than necessary. The large number of members that are produced by trying to capture complete diversity also makes screening more cumbersome than it needs to be. This is particularly true given that many members of the library will not be functional or will be non-specifically sticky.

In addition to the labor of constructing synthetic libraries is the question of immunogenicity. For example, there are libraries in which all CDR residues are either Tyr (Y) or Ser (S). Although antibodies (Abs) selected from these libraries show high affinity and specificity, their very unusual composition may make them immunogenic.

The present invention is directed toward making Abs that could well have come from the human immune system and so are less likely to be immunogenic. The libraries of the present invention retain as many residues from V-D-J or V-J fusions as possible. To reduce the risk of immunogenicity, it may be prudent to change each non-germline amino acid in both framework and CDRs back to germline to determine whether the change from germline is needed to retain binding affinity. Thus, a library that is biased at each varied position toward germline will reduce the likelihood of isolating Abs that have unneeded non-germline amino acids.

Abs are large proteins and are subject to various forms of degradation. One form of degradation is the deamidation of Asn and Gln residues (especially in Asn-Gly or Gln-Gly) and the isomerization of Asp residues. Another form of degration is the oxidation of methionine, cysteine, and tryptophan. Extraneous Cysteines in CDRs may lead to unwanted disulfides that will adversely affect the structure of the antibody or to antibodies that dimerize or are subject to cysteinylization or addition of other moieties. Thus, in some embodiments, methionine, cysteine, and tryptophan may be avoided in CDRs of the antibodies of the library. In other embodiments, methionine and cysteine may be avoided. Another form of degradation is the cleavage of Asp-Pro dipeptides. Another form of degradation is the formation of pyroglutamate from N-terminal Glu or Gln. It is advantageous to provide a library in which the occurrence of problematic sequences is minimized.

When expressed in eukaryotic cells, sequences that contain N—X—(S/T) (where X is not P) are often glycosylated on the Asn (N) residue. In E. coli, these sequences are not glycosylated, thus sequences that contain N—X—(S/T) may be isolated as binders but not be useful due to glycosylation when expressed in CHO cells as IgGs. Hence, in some embodiments, the proportions of N or S are reduced to minimize or eliminate the probability of isolating antibody sequences that contain N—X—(S/T) in any CDR. Alternatively, one could replace N with Q to allow an amide functionality without allowing N-linked glycosylation. In some embodiments, the fraction of members that have N—X—(S/T) sequences is less that 2%, 1%, 0.5%, 0.1%, or N—X—(S/T) may be absent from the library.

Provided are libraries of vectors or packages that encode members of a diverse family of proteins (e.g., antibodies, e.g., human antibodies in the sense that the antibodies are modeled on antibodies that exist naturally in humans) comprising heavy chain (HC) CDR3s. The HC CDR3s may also, in certain embodiments, may be rich in Tyr (Y) and Ser (S) and/or comprise diversified D regions and/or use distributions of amino acids most often seen in particular parts of HC CDR3 in actual antibodies and/or comprise extended JH regions. For example, the HC CDR3s may be rich in Tyr at Jstump (e.g., about 20%, 25%, 28%, 30%, 35%, 40% Tyr) and/or D segments (e.g., about 15%, 19%, 20%, 25% Tyr), e.g., as provided in the examples herein. Also provided are libraries comprising such HC CDR3s.

In some embodiments, the HC CDR3s of each member of a library comprises 4 to 16 amino acids. In some embodiments, a HC CDR3s having the lengths 9 and 10 are equally likely in a library. In some embodiments, HC CDR3s of the library have a median CDR3 length of 9.5. In some embodiments, HC CDRs of the library have a median CDR3 length of 7, 7.25, 7.5, 7.75, 8, 8.25, 8.5 or 8.75. In some embodiments, the first 5 to 7, 8 or 9 amino acids of the HC CDR3 are allowed amino acid types (AATs) which are any of the five, six, seven, eight, nine, ten, eleven, twelve, thirteen, fourteen most frequently occurring amino acids at each position in actual VJ fill (e.g., in a sampling of antibody sequences, e.g., as described herein, e.g., as shown in Table 3010). In some embodiments, the allowed amino acid types are allowed in proportion to the frequency in which these are seen in actual VJ fill (e.g., in a sampling of antibody sequences, e.g., as described herein, e.g., as shown in Table 3010). In some embodiments, the allowed amino acids are allowed in proportion to the frequency shown in any of Tables 3020 to Table 3028. In some embodiments, the length of the Jstump is modeled after the Jstumps seen in actual HC CDR3s that occur in HC CDR3s that lack D segments. In some embodiments, the length of the Jstump is 1 to 9 amino acids. In some embodiments, there is no Jstump. In all embodiments, the FR4 of the library is taken from a human JH region.

In some embodiments, an amino acid that is one of the five to twelve most frequently occurring amino acids at a position in the HC CDR3 (e.g., in the VJ fill and/or J stump) is not allowed, e.g., because it is associated with a negative property such as protein degradation. For example, an amino acid that frequently occurs at a position in the HC CDR (e.g., in the VJ fill and/or J stump) may not be allowed at a position because the amino acid (or combination of amino acids) is degraded, e.g., by oxidation, deamidation, isomerization, enzymatic cleavage, etc. In some embodiments, an amino acid that is not one of the five to twelve most frequently occurring amino acids at a position in the HC CDR3 (e.g., in the VJ fill and/or J stump) is allowed, e.g., because it is associated with a beneficial property. Two beneficial properties are binding specificity and high affinity. Antibodies bind to antigens by being complementary to the antigen in shape, hydrophobicity, and/or charge. Hence, in some embodiments, an allowed amino acid can be an amino acid that alters the shape, hydrophobicity, and/or charge of the CDR, preferably those that do not cause instability or lability such as Asp, Gly, Arg, Ala, Ser, Thr, Tyr, Phe, Leu, Ile, and Val, e.g., at any position.

In some aspects, the present disclosure features libraries that achieve a higher fraction of useful antibodies by limiting the diversity to the between five and twelve allowed amino acids at each variegated position that are most often seen AATs in actual antibodies at corresponding positions. In some contexts, the immune system uses some of these AATs more often than others. In a library that allows variegation, e.g., at 10 positions, reducing the number of allowed amino acids at each position from 20 to 14 reduces the number of sequences by more than 35-fold; reducing the number of allowed amino-acid types to 11 at ten positions reduces the number of possible sequences by 395-fold. Most of the sequences excluded are ones the immune system is unlikely to make and so are less likely to be useful binders. In some embodiments, the allowed amino acid is selected from the 14 AATs because it has a beneficial property. For example, Pro, His, Glu, and Lys do not cause instability and may be introduced in many positions; Tip may be useful but introduces a large amount of hydrophobicity and can be oxidized. In other embodiments, the allowed amino acid is not selected from the 14 AATs because it has a negative property. For example, Asn and Gln can lead to instability via deamidation. In addition, Met and Cys can be omitted. Tryptophan on the other hand has a much larger side group than Phe or Tyr. Thus, in some embodiments, Trp can be allowed in a library, but allowed amino acids at that position can also be Phe, Tyr, or Leu which may be able to replace Trp without unacceptable loss in affinity. In other embodiments, a Trp residues is important to the structure of the antibody, such as Trp₁₀₃ at the beginning of HC FR4, and, e.g., therefore is fixed. In other embodiments, tryptophan can have a negative property, e.g., insolubility or oxidation sensitivity, and therefore is not selected when it is among the 14 most-often seen AATs at a given position.

In some aspects, the disclosure features a library (Biblioteca 1) of vectors or genetic packages that display, display and express, or comprise a member of a diverse family of human antibody peptides, polypeptides or proteins and collectively display, display and express or comprise variegated DNA sequences that encode a HC CDR3, where the HC CDR3s is X₁-X₂-X₃-X₄-X₅-X₆-X₇-X₈-X₉-X₁₀-X₁₁-X₁₂-X₁₃-X₁₄-X₁₅ and where X₁-X₈ have 5 to 12 allowed amino acids which are the AATs seen most often at these positions in actual VJ fill (e.g., in a sampling of antibody sequences, e.g., as described herein). Each of X₆, X₇, and X₈ may independently be absent. In one embodiment, the allowed amino acids at each position are the 5 to 12 amino acids most frequently seen at each position in actual VJ fill as shown in Table 3010. In some embodiments, the most common allowed amino acid at each position is the one most often seen at that position in actual antibodies (e.g., in a sampling of antibody sequences, e.g., as described herein). A preferred embodiment has X₉ through X₁₅ as Jstump from (e.g., corresponding to) residues 94-102 of a human JH (as shown in Table 3). A preferred embodiment has a variegated X₁₀-X₁₅. Each of X₁₀ through X₁₅ may independently be absent.

In some aspects, the disclosure features a library of vectors or genetic packages that display, display and express, or comprise a member of a diverse family of human antibody peptides, polypeptides or proteins and collectively display, display and express or comprise variegated DNA sequences that encode a HC CDR3, where the HC CDR3s have lengths from 4 to 12 and have a sequence X₁-X₂-X₃-X₄-X₅-X₆-X₇-X₈-X₉-X₁₀-X₁₁-X₁₂, wherein each of X₄, X₅, X₆, X₇, X₈, X₉ and X₁₀, can independently be absent. The allowed amino-acid types and proportions at each position are taken from a Table that reflects the frequency at which AATs are seen in antibodies that do not have D segments in HC CDR3. The use of such tables are defined in the examples.

In some aspects, the disclosure features a library of vectors or genetic packages that display, display and express, or comprise a member of a diverse family of human antibody peptides, polypeptides or proteins and collectively display, display and express or comprise variegated DNA sequences that encode a HC CDR3, where the HC CDR3s has the sequence X₁-X₂-X₃-X₄-X₅-X₆-X₇-X₈-X₉-X₁₀-X₁₁-X₁₂ and where X₁-X₉ have 5 to 12 allowed amino acids which are the AATs seen most often at these positions in actual VJ fill (e.g., in a sampling of antibody sequences, e.g., as described herein). Each of X₄, X₅, X₆, X₇, X₈, X₉, X₁₀, X₁₁, and X₁₂ may independently be absent. In some embodiments, the members have a HC CDR3 with lengths from 4 to 12. In one embodiment, the allowed amino acids at each position are the 5 to 12 amino acids most frequently seen at each position in actual VJ fill as shown in Table 3010. In some embodiments, the allowed amino acid types are present in the ratios shown in Table 3010. In some embodiments, the allowed amino acid types are present in the ratios shown, for example, in any of Tables 3020 to 3028. In some embodiments, the most common allowed amino acid at each position is the one most often seen at that position in actual antibodies (e.g., in a sampling of antibody sequences, e.g., as described herein). In some embodiments, when and of X₁₀, X₁₁ and X₁₂ are present, X₁₀, X₁₁ and/or X₁₂ is an amino acid has Jstump from (e.g., corresponding to) residues 102a-102c of a human JH. In some embodiments, the proportions of amino acids at X₁₀, X₁₁ and/or X₁₂ can be an average of a VJ fill position with a Jstump position, as in Example 11.

In some aspects, the disclosure features a library (Biblioteca 98) of vectors or genetic packages that display, display and express, or comprise a member of a diverse family of human antibody peptides, polypeptides or proteins and collectively display, display and express or comprise variegated DNA sequences that encode a HC CDR3, where the HC CDR3s has the sequence X₁-X₂-X₃-X₄-X₅-X₆-X₇-X₈-X₉-X₁₀-X₁₁ and where X₁-X₈ have 5 to 12 allowed amino acids which are the AATs seen most often at these positions in actual VJ fill (e.g., in a sampling of antibody sequences, e.g., as described herein). Each of X₄, X₅, X₆, X₇, X₈, X₉, X₁₀ and X₁₁ may independently be absent. In some embodiments, the members have a HC CDR3 of lengths from 4 to 11 or from 5 to 11. In one embodiment, the allowed amino acids at each position are the 5 to 12 amino acids most frequently seen at each position in actual VJ fill as shown in Table 3010. In one embodiment, the allowed amino acids at each position are present in the ratios shown in Table 3010 In some embodiments. The allowed amino acids at each position are present in the ratios shown in any of Table 3020 through 3028. In some embodiments, the most common allowed amino acid at each position is the one most often seen at that position in actual antibodies (e.g., in a sampling of antibody sequences, e.g., as described herein). In some embodiments, when X₉, X₁₀ and/or X₁₁ is present, the amino acid at that position is an amino acid of a Jstump from (e.g., corresponding to) residues 102a-102c of a human JH. In some embodiments, the proportions of amino acids at X₉, X₁₀ and/or X₁₁ can be an average of a VJ fill position with a Jstump position, as in Example 11.

In some aspects, the disclosure features a library (Biblioteca 2) of vectors or genetic packages that display, display and express, or comprise a member of a diverse family of human antibody peptides, polypeptides or proteins and collectively display, display and express or comprise variegated DNA sequences that encode a HC CDR3, where the HC CDR3s has the sequence X₁-X₂-X₃-X₄-X₅-X₆-X₇-X₈-X₉-X₁₀-X₁₁, where X₁-X₈ have 5 to 12 allowed amino acids which are the AATs seen most often at these positions in actual VJ fill (e.g., in a sampling of antibody sequences, e.g., as described herein). Each of X₆, X₇, and X₈ may independently be absent. In one embodiment, the most frequently occurring amino acids at each position are the 5 to 12 most frequently seen amino acids at each position in actual VJ fill as shown in Table 3010A and Table 3010B. Alternatively, one could use the distributions shown in Table 2211A and Table 2211B. In one embodiment, X₉, X₁₀ and/or X₁₁ can be an amino acid of a Jstump from (e.g., corresponding to) residues 100-102 of a human JH. In another embodiment, X₉, X₁₀ and/or X₁₁ can be variegated.

In some aspects, the disclosure features a library (Biblioteca 3) of vectors or genetic packages that display, display and express, or comprise a member of a diverse family of human antibody peptides, polypeptides or proteins and collectively display, display and express or comprise variegated DNA sequences that encode a HC CDR3, where the HC CDR3s comprise: a) zero to four amino acids of VD fill, b) all or a fragment of 3 or more amino acids of a D segment, c) zero to four amino acids of DJ fill, and d) zero to nine amino acids of Jstump. In some embodiments, the zero to four amino acids of VD fill allow the 5 to 12 AATs that are seen in actual VD fill at those positions (e.g., in a sampling of antibody sequences, e.g., as described herein). In some embodiments, the most common allowed amino acid at each position is the one most often seen at that position in actual antibodies (e.g., in a sampling of antibody sequences, e.g., as described herein). In one embodiment, the allowed amino acids at each position are the 5 to 12 most frequently seen amino acids at each position in actual VD fill as shown in Table 3008, or each is independently absent. Alternatively, the allowed amino acids at each position are the 5 to 12 most frequently seen amino acids at each position in actual VD fill of Tables 2212A and B. In some embodiments, the allowed amino acid in the VD fill are allowed in proportion to the frequency at which they are seen in actual antibodies (e.g., in a sampling of antibody sequences, e.g., as described herein). In some embodiments, the D segments or fragments of D segments are modeled after the D segments or fragments thereof that are most often seen in actual antibodies. In some embodiments, the fragments of D segments used in the library of HC CDR3s are modeled after the fragments most often seen in actual antibodies (e.g., in a sampling of antibody sequences, e.g., as described herein). In some embodiments, D segments containing Cys residues have the Cys residues fixed (not variegated). In some embodiments, the zero to four DJ fill amino acids are allowed to be the 5 to 12 AATs that are seen in actual DJ fill (e.g., in a sampling of antibody sequences, e.g., as described herein). In some embodiments, the most often seen allowed amino acid at each position in the DJ fill is the most often seen AAT in actual DJ fill (e.g., in a sampling of antibody sequences, e.g., as described herein). In one embodiment, the allowed amino acids at each position are the 5 to 12 most frequently seen AATs at each position in actual DJ fill as shown in Table 75 or 2217, or each is independently absent. In some embodiments, the amino acids allowed in the DJ fill are allowed in proportion to their frequency in actual DJ fill at each position (e.g., in a sampling of antibody sequences, e.g., as described herein). In some embodiments, the Jstump amino acids are modeled after the occurrence of amino acids in actual Jstumps, e.g., in Jstumps shown in Table 3006. In all embodiments, the FR4 corresponds to the Jstump in HC CDR3, if any.

In some embodiments, an amino acid that is one of the five to twelve AATs at a position in the HC CDR3 (e.g., in the VD fill, the D segment, the VJ fill and/or the J stump) is not allowed, e.g., because it is associated with a negative property such as protein degradation. For example, an amino acid that frequently occurs at a position in the HC CDR (e.g., in the VD fill, the D segment, the VJ fill and/or the J stump) may not be allowed at a position because the amino acid (or combination of amino acids) is degraded, e.g., by oxidation, deamidation, isomerization, enzymatic cleavage, etc. In some embodiments, an amino acid that is not one of the five to twelve most frequently occurring amino acids at a position in the HC CDR3 (e.g., in the VD fill, the D segment, the VJ fill and/or the J stump) is allowed, e.g., because it is associated with a beneficial property, e.g., a beneficial property described herein.

A diversified D region is a D region into which one or more amino acid changes have been introduced (e.g., as compared to the sequence of a naturally occurring D region; for example, a stop codon can be changed to a Tyr residue). Herein, “D region” and “D segment” are used interchangeably and mean the same thing.

An extended JH region is a JH region that has one or more amino acid residues present at the amino terminus of the framework sequence of the JH region (e.g., amino terminal to FR4 sequences, e.g., which commence with WGQ . . . , See Table 3). For example, JH1 is an extended JH region. As other examples, JH2, JH3, JH4, JH5, and JH6 are extended JH regions. The segments that contribute part of CDR3 and FR4 in the genome are referred to as JH segments: JH1-JH6. “J” stands for “joining” because these segments join V to CH1. These segments contribute FR4 which conventionally begin with a strongly conserved Trp₁₀₃-GlY₁₀₄. Before the Trp-Gly, the JHs have from 4 to 9 additional amino acids that, if present, are considered to be part of CDR3. The most common modification of the JH is truncation at the 5′ end to varying extents. The amino acids found in CDR3 but resulting from inclusion from JH are herein referred to as “J stump” or “Jstump” (which are identical). That is, Jstump is the part of CDR3 that comes from the JH genes and can be identified either by examination of the DNA or the amino-acid sequence. “Jstump” and “extended J region” refer to the same thing and have the same meaning.

Designing the length of J stump in a library can be informed by the tabulation in Table 3006. Table 3006 shows the number of antibodies having Jstumps of lengths from 0 to 9 sorted by JH and by whether there was or was not a D segment in the CDR3. N is the length of the stump. Each entry shows how many Abs had a Jstump of the stated length. For example, if one wants a library based on JH2, we see that a large fraction ( 704/965) cases with no D segment have full length stumps. On the other hand, for JH1, most of the cases have 0, 1, or 2 residues of Jstump. JH4-containing Abs have a strong tendency to have a stump of FDY.

In analyzing CDR3, we first find the Jstump and remove it. The remainder is searched for a D segment. If a D segment is found, then any amino acids prior to the D segment are tallied as “VD fill”. Any amino acids between D and Jstump (or J if there is no Jstump) are called “DJ fill”. If there is no D segment, the amino acids between FR3 and Jstump (or J if there is no Jstump) are called either “VJ fill” or “Lead-in, no D”.

In some aspects, the disclosure features a library (Biblioteca 4) of vectors or genetic packages that display, display and express, or comprise a member of a diverse family of human antibody peptides, polypeptides or proteins and collectively display, display and express, or comprise (e.g., include) at least a portion of the diversity of the antibody family, wherein the vectors or genetic packages comprise variegated DNA sequences that encode a heavy chain (HC) CDR3, wherein the HC CDR3 is X₁-X₂-X₃-X₄-X₅-X₆-X₇-X₈-X₉-X₁₀-X₁₁-X₁₂-X₁₃-X₁₄, wherein each of X₁ through X₈ are each independently occupied by the amino acids that most frequently occur, e.g., in a sampling of antibody sequences, e.g., as described herein, at each of positions X₁ through X₈, e.g., as shown in Table 3010; wherein any one of residues X₈ through X₁₁ are each independently absent or have the same distribution as X₈ (e.g., are each independently occupied by the amino acids that most frequently occur at the position corresponding to X₈, e.g., in a sampling of antibody sequences (e.g., naturally occurring antibody sequences), e.g., as described herein, e.g., as shown in Table 3010 and X₁₂ through X₁₄ correspond to residues 100-102 of a human JH, e.g., as shown in Table 3. In some embodiments, the member includes a framework region 4 (FR4), wherein the FR4 corresponds to the same human JH. Alternatively, the fraction of N, S, or T may be reduced to minimize the fraction of members that include N—X—(S/T).

In some embodiments of the aspects described herein, the antibody peptides are Fabs.

In some embodiments of the aspects described herein, the antibody peptides are scFvs.

In some embodiments of the aspects described herein, the members comprise diversity in HC CDR1 and/or CDR2.

In some embodiments of the aspects described herein, the library comprises diversity in light chain (LC) CDR1, CDR2, and/or CDR3. In some embodiments, the members comprise diversity in light chain (LC) CDR1, CDR2, and CDR3.

In some embodiments of the aspects described herein, the length distribution of HC CDR3 in the library is: length 9 is 10%, length 10 is 10%, length 11 is 20%, length 12 is 30%, length 13 is 20%, and length 14 is 10%.

In some embodiments of the aspects described herein, the members further encode framework (FR) regions 1-4. In some embodiments, the FR regions 1-4 correspond to FR regions 1-4 from 3-23.

In some embodiments of the aspects described herein, the members encode framework regions 1-4 and diversified CDRs1-3 from VH 3-66, e.g., as shown in Example 43.

In some embodiments of the aspects described herein, the members encode framework regions 1-4 and diversified CDRs1-3 from trastuzimab, e.g., as shown in Example 44.

In some embodiments of the aspects described herein, the members encode HC CDR1, HC CDR2 and FR regions 1-4.

In some embodiments of the aspects described herein, the members comprise a 3-23 HC framework.

In some embodiments of the aspects described herein, the library further comprises a LC variable region.

In some embodiments of the aspects described herein, the library comprises members encoding diverse LC variable regions.

In some embodiments of the aspects described herein, the members comprising a LC variable region comprise an A27 LC framework.

In some embodiments of the aspects described herein, the library is a display library, e.g., a phage display library.

In some embodiments of the aspects described herein, the phage used is derived from M13.

In some embodiments of the aspects described herein, the antibody fragments are displayed on an M13-derived phagemid.

In some embodiments of the aspects described herein, the HC is attached to a III protein of M13. In some embodiments, the III of M13 is full length. In some embodiments, the III of M13 is IIIstump.

In some embodiments of the aspects described herein, the library has at least 10⁴, 10⁵ 10⁶, 10⁷, 10⁸, 10⁹ 10¹⁰, 10¹¹ diverse members.

In some embodiments of the aspects described herein, when the amino acid (or amino acids) that most frequently occurs at a position (or positions) may result in degradation, that amino acid or amino acids is not present at one or more of positions X₁-X₁₄ of the library, or the proportion of frequency with which the amino acid (or amino acids) occurs at any given position is reduced, e.g., as compared to the frequency the amino acid occurs in actual antibodies (e.g., a sampling of antibodies, e.g., as described herein). For example, an amino acid that frequently occurs at a position in the HC CDR (e.g., in the VJ fill and/or J stump) may not be allowed at a position because the amino acid (or combination of amino acids) is degraded, e.g., by oxidation, deamidation, isomerization, enzymatic cleavage, etc. In some embodiments, an amino acid that is not one of the five to twelve most frequently occurring amino acids at a position in the HC CDR3 (e.g., in the VJ fill and/or J stump) is allowed, e.g., because it is associated with a beneficial property, e.g., a beneficial property described herein.

Also provided are designs for HC CDR1, HC CDR2, and a library of VKIII A27 with diversity in the CDRs. In particular, length variation is allowed in LC CDR1 and in LC CDR3. A library of vectors or packages that encode members of a diverse family of human antibodies comprising HC CDR3s described herein can further have diversity at one or more (e.g., at one, two, three, four, or all) of HC CDR1, HC CDR2, LC CDR1, LC CDR2, and LC CDR3. For example, the library can have diversity at one or more (e.g., at one, two, three, four, or five) of HC CDR1, HC CDR2, LC CDR1, LC CDR2, and LC CDR3 as described herein.

In some aspects, the disclosure features a library (Biblioteca 5) of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is X₁-X₂-X₃-X₄-X₅-X₆-X₇-X₈-X₉-X₁₀-X₁₁-X₁₂-X₁₃-X₁₄-X₁₅-X₁₆-X₁₇, wherein
X₁ through X₄ are each independently absent or have the same distribution as X₁ through X₄, e.g., are each independently occupied by the amino acids that most frequently occur, e.g., in a sampling of antibody sequences (e.g., naturally occurring antibody sequences), e.g., as described herein, e.g., as shown in Table 3008,
2, 3, 4, 5, 6, 7, or 8 of X₅ through X₁₂ are each independently absent or are independently occupied by amino acids that most frequently occur at positions corresponding to X₅ through X₁₂, e.g., in a sampling of antibody sequences (e.g., naturally occurring antibody sequences), in a human D segment, e.g., as described herein,
X₁₃ and X₁₄ are each independently absent or are occupied by the 5 to 12 amino acids that most frequently occur in a DJ fill in Table 75, and
X₁₅ through X₁₇ are occupied by amino acids that correspond to residues 100-102 of a human JH, e.g., as shown in Table 3.

In some embodiments, X₅ through X₁₂ include five to eight amino acids of D3-22.2. In some embodiments, the fragment of D3-22.2 is a variegated version of YYDSSGYY (SEQ ID NO: 974).

In some embodiments, X₃ and X₄ are absent and X₁ and X₂ are present.

In some embodiments, X₁₃ and X₁₄ are present.

In some embodiments, X₁₃ and X₁₄ are independently occupied by 5 to 12 amino acids that most frequently occur at the P1 and P2 positions of Table 75, e.g., in a sampling of antibody sequences (e.g., naturally occurring antibody sequences). In some embodiments, X₁₃ and X₁₄ are independently occupied by 5 to 12 amino acids that most frequently occur at the P1 and P2 positions of Table 75, e.g., in a sampling of antibody sequences (e.g., naturally occurring antibody sequences) and in the proportions shown in Table 75.

In some embodiments, the members comprise diversity in HC CDR1 and/or CDR2.

In some embodiments, when the amino acid (or amino acids) that most frequently occurs at a position (or positions) may result in degradation, that amino acid (or amino acids) is not present at one or more of positions X₁-X₁₄ of the library, or the proportion of frequency with which the amino acid (or amino acids) occurs at any given position is reduced, e.g., as compared to the frequency the amino acid occurs in actual antibodies (e.g., a sampling of antibodies, e.g., as described herein).

In some embodiments, the library comprises diversity in light chain (LC) CDR1, CDR2, and/or CDR3. In some embodiments, the members comprise diversity in light chain (LC) CDR1, CDR2, and/or CDR3.

In some embodiments, the members further encode framework (FR) regions 1-4. In some embodiments, the FR regions 1-4 correspond to FR regions 1-4 from 3-23.

In some embodiments, the members encode HC CDR1, HC CDR2 and FR regions 1-4.

In some embodiments, the members comprise a 3-23 HC framework

In some embodiments, the library further comprises a LC variable region.

In some embodiments, the library comprises members encoding diverse LC variable regions.

In some embodiments, the members comprising a LC variable region comprise an A27

LC framework.

In some embodiments, the library is prepared by wobbling.

In some embodiments, the library is prepared by dobbling.

In some embodiments, the library is a display library, e.g., a phage display library.

In some embodiments, the library has at least 10⁴, 10⁵ 10⁶, 10⁷, 10⁸, 10⁹ 10¹⁰, 10¹¹, or 3×10¹¹ diverse members.

In some aspects, the disclosure features a library (Library P65) (Biblioteca 6) of vectors or genetic packages that display, display and express, or comprise a member of a diverse family of human antibody related peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is
X₁-X₂-X₃-X₄-X₅-X₆-X₇-X₈-X₉-X₁₀-X₁₁ wherein:
X₁ is G, D, V, E, A, S, R, L, I, H, T, or Q, e.g., in the ratios for G:D:V:E:A:S:R:L:I:H:T:Q of 217:185:84:83:71:68:58:43:33:28:25:20, or in the ratios provided in (other ratios could be used (ORCBU));
X₂ is G, R, S, L, P, V, A, T, D, K, N, Q, or I, e.g., in the ratios for G:R:S:L:P:V:A:T:D:K:N:Q:I of 186:142:99:83:76:49:46:44:35:29:29:29:29 (ORCBU) (equivalent to 0.2123:0.1621:0.1130:0.0947:0.0868:0.0559:0.0525:0.0502:0.0400:0.0331:0.0331:0.0331:0.0331);
X₃ is G, R, S, L, A, P, Y, V, W, T, or D, e.g., in the ratios for G:R:S:L:A:P:Y:V:W:T:D of 203:130:92:61:60:54:52:48:48:42:36 (ORCBU);
X4 is G, S, R, L, A, W, Y, V, P, T, or D, e.g., in the ratios for G:S:R:L:A:W:Y:V:P:T:D of 210:103:91:64:63:59:59:47:47:47:40 (equivalent to 0.2530:0.1241:0.1096:0.0771:0.0759:0.0711:0.0711:0.0566:0.0566:0.0566:0.0482) (ORCBU);
X5 is G, S, R, L, A, Y, W, D, T, P, or V, e.g., in the ratios for G:S:R:L:A:Y:W:D:T:P:V of 190:96:89:71:64:59:59:56:46:43:42 (ORCBU);
X6 is G, S, R, D, L, A, P, Y, T, W, V, or Δ (absent), e.g., in the ratios for G:S:R:D:L:A:P:Y:T:W:V:Δ of 173:93:88:73:71:63:58:57:56:44:39:* (ORCBU);
X₇ is G, S, R, D, L, A, P, Y, T, W, V, or Δ (absent), e.g., in the ratios for G:S:R:D:L:A:P:Y:T:W:V:Δ of 173:93:88:73:71:63:58:57:56:44:39:* (ORCBU);
X₈ is G, S, R, D, L, A, P, Y, T, W, V, or Δ (absent), e.g., in the ratios for G:S:R:D:L:A:P:Y:T:W:V:Δ of 173:93:88:73:71:63:58:57:56:44:39:* (ORCBU);
X₉ is F;
X₁₀ is D; and is Y.

“*” indicates that the fraction of Δ is determined by the length distribution. And, e.g., the distribution of lengths is Len 8:Len 9:Len 10:Len 11::2:3:3:2. The proportion of Δ is determined by the prescribed lengths under the rule that each deleteable codon is deleted with the same frequency. Other length distributions could be used.

At position 2, N occurs with a frequency of 0.0331 and the combined frequency of S and T at position 4 is 0.18 so that N—X—(S/T) occurs with a frequency of 0.006 which is acceptable. One could reduce the fraction of N at position 2. Alternatively, one could replace N with Q.

For example, the ratios of Table 6503 and 6504, or the ratios of Tables 6505 and 6506 could be used for X₁-X₈ with the understanding that some of the members will lack X₆-X₈ (i.e. have CDR3 length 8), some of the members will lack X₇-X₈ (i.e. have CDR3 length 9), and some of the members will lack X₈ (having length 10).

TABLE 6503
Alternative variegation for the HC CDR3 of Library P65, Part 1

| 95 (x₁) | | | 96 (x₂) | | | 97 (x₃) | | | 98 (x₄) | | |
|---|---|---|---|---|---|---|---|---|---|---|---|
| D | 0.2367 | 9.25 | G | 0.1937 | 5.43 | R | 0.2174 | 11.15 | G | 0.1763 | 8.32 |
| G | 0.1802 | 7.04 | R | 0.1852 | 5.19 | G | 0.1706 | 8.75 | R | 0.1522 | 7.18 |
| V | 0.1075 | 4.20 | L | 0.1082 | 3.03 | L | 0.1020 | 5.23 | L | 0.1070 | 5.05 |
| E | 0.1062 | 4.15 | P | 0.0991 | 2.78 | A | 0.1003 | 5.14 | A | 0.1054 | 4.97 |
| R | 0.0742 | 2.90 | V | 0.0639 | 1.79 | V | 0.0803 | 4.12 | W | 0.0987 | 4.66 |
| A | 0.0715 | 2.79 | A | 0.06 | 1.68 | W | 0.0803 | 4.12 | P | 0.0786 | 3.71 |
| L | 0.0550 | 2.15 | T | 0.0574 | 1.61 | T | 0.0702 | 3.60 | T | 0.0786 | 3.71 |
| I | 0.0422 | 1.65 | D | 0.0456 | 1.28 | P | 0.0654 | 3.35 | V | 0.0786 | 3.71 |
| H | 0.0358 | 1.40 | I | 0.0378 | 1.06 | D | 0.0602 | 3.09 | D | 0.0669 | 3.16 |
| S | 0.0332 | 1.30 | K | 0.0378 | 1.06 | S | 0.0338 | 1.74 | S | 0.0366 | 1.72 |
| T | 0.0320 | 1.25 | N | 0.0378 | 1.06 | Y | 0.0195 | 1.00 | Y | 0.0212 | 1.00 |
| Q | 0.0256 | 1.00 | Q | 0.0378 | 1.06 | | | | | | |
| | | | S | 0.0357 | 1.00 | | | | | | |

TABLE 6504
Alternative variegation for the HC CDR3 of Library P65, Part 2

| 99 (x₅) | | | 100 (x₆) | | | 101 (x₇) | | | 102 (x₈) | | |
|---|---|---|---|---|---|---|---|---|---|---|---|
| G | 0.1763 | 8.40 | G | 0.1839 | 4.58 | G | 0.2000 | 4.12 | G | 0.2000 | 4.12 |
| R | 0.1441 | 6.86 | R | 0.1293 | 3.22 | S | 0.1159 | 2.39 | S | 0.1159 | 2.39 |
| L | 0.1149 | 5.48 | D | 0.1072 | 2.67 | R | 0.1097 | 2.26 | R | 0.1097 | 2.26 |
| A | 0.1036 | 4.93 | L | 0.1043 | 2.60 | D | 0.0910 | 1.87 | D | 0.0910 | 1.87 |
| W | 0.0955 | 4.55 | A | 0.0925 | 2.31 | L | 0.0885 | 1.82 | L | 0.0885 | 1.82 |
| D | 0.0906 | 4.32 | P | 0.0852 | 2.12 | A | 0.0785 | 1.62 | A | 0.0785 | 1.62 |
| T | 0.0745 | 3.55 | T | 0.0823 | 2.05 | P | 0.0723 | 1.49 | P | 0.0723 | 1.49 |
| P | 0.0696 | 3.31 | W | 0.0646 | 1.61 | Y | 0.0710 | 1.46 | Y | 0.0710 | 1.46 |
| V | 0.0680 | 3.24 | V | 0.0573 | 1.43 | T | 0.0698 | 1.44 | T | 0.0698 | 1.44 |
| S | 0.0420 | 2.00 | Y | 0.0533 | 1.33 | W | 0.0548 | 1.13 | W | 0.0548 | 1.13 |
| Y | 0.0210 | 1.00 | S | 0.0401 | 1.00 | V | 0.0486 | 1.00 | V | 0.0486 | 1.00 |

The probability of N—X—(S/T) at 96-98 is 0.00436, which is acceptable. One could reduce or eliminate N at 96. Alternatively, one could replace N with Q.

TABLE 6505
Alternative variegation for the HC CDR3 of Library P65, Part 1

| 95 | | | 96 | | | 97 | | | 98 | | |
|---|---|---|---|---|---|---|---|---|---|---|---|
| G | 0.3049 | 21.53 | G | 0.3050 | 14.28 | G | 0.3112 | 30.66 | G | 0.3074 | 30.65 |
| S | 0.2594 | 18.32 | S | 0.2596 | 12.15 | S | 0.2531 | 24.93 | S | 0.2621 | 26.13 |
| D | 0.1311 | 9.26 | R | 0.1046 | 4.90 | R | 0.1192 | 11.74 | R | 0.0836 | 8.33 |
| V | 0.0595 | 4.20 | L | 0.0612 | 2.86 | L | 0.0560 | 5.51 | L | 0.0588 | 5.86 |
| E | 0.0588 | 4.15 | P | 0.0560 | 2.62 | A | 0.0550 | 5.42 | A | 0.0578 | 5.77 |
| R | 0.0411 | 2.90 | V | 0.0361 | 1.69 | V | 0.0440 | 4.33 | W | 0.0541 | 5.40 |
| A | 0.0396 | 2.80 | A | 0.0339 | 1.59 | W | 0.0440 | 4.33 | P | 0.0432 | 4.30 |
| L | 0.0305 | 2.15 | T | 0.0324 | 1.52 | T | 0.0385 | 3.80 | T | 0.0432 | 4.30 |
| I | 0.0234 | 1.65 | D | 0.0258 | 1.21 | P | 0.0359 | 3.53 | V | 0.0432 | 4.30 |
| H | 0.0199 | 1.40 | I | 0.0214 | 1.00 | D | 0.0330 | 3.25 | D | 0.0367 | 3.66 |
| T | 0.0177 | 1.25 | K | 0.0214 | 1.00 | Y | 0.0102 | 1.00 | Y | 0.0100 | 1.00 |
| Q | 0.0142 | 1.00 | N | 0.0214 | 1.00 | | | | | | |
| | | | Q | 0.0214 | 1.00 | | | | | | |

TABLE 6506
Alternative variegation for the HC CDR3 of Library P65, Part 2

| 99 | | | 100 | | | 101 | | | 102 | | |
|---|---|---|---|---|---|---|---|---|---|---|---|
| G | 0.3316 | 30.64 | G | 0.3272 | 16.17 | G | 0.3282 | 16.22 | G | 0.3282 | 16.22 |
| S | 0.2041 | 18.86 | S | 0.3170 | 15.67 | S | 0.3189 | 15.76 | S | 0.3189 | 15.76 |
| R | 0.0859 | 7.94 | R | 0.0600 | 2.97 | R | 0.0595 | 2.94 | R | 0.0595 | 2.94 |
| L | 0.0685 | 6.33 | D | 0.0498 | 2.46 | D | 0.0494 | 2.44 | D | 0.0494 | 2.44 |
| A | 0.0618 | 5.71 | L | 0.0485 | 2.39 | L | 0.0480 | 2.37 | L | 0.0480 | 2.37 |
| W | 0.0569 | 5.26 | A | 0.0430 | 2.12 | A | 0.0426 | 2.11 | A | 0.0426 | 2.11 |
| D | 0.0540 | 4.99 | P | 0.0395 | 1.95 | P | 0.0392 | 1.94 | P | 0.0392 | 1.94 |
| T | 0.0444 | 4.11 | T | 0.0382 | 1.89 | T | 0.0379 | 1.87 | T | 0.0379 | 1.87 |
| P | 0.0415 | 3.83 | W | 0.0300 | 1.48 | W | 0.0297 | 1.47 | W | 0.0297 | 1.47 |
| V | 0.0405 | 3.74 | V | 0.0266 | 1.31 | V | 0.0264 | 1.30 | V | 0.0264 | 1.30 |
| Y | 0.0108 | 1.00 | Y | 0.0202 | 1.00 | Y | 0.0202 | 1.00 | Y | 0.0202 | 1.00 |

This gives the probability of N—X—(S/T) at 96-98 as 0.0065 which is acceptable. One could reduce or eliminate the probability of N at 96.

Δ(delta) is allowed at three positions and the members are represented as xxx, xxd, xdx, dxx, xdd, dxd, ddx, and ddd where x means there is an amino acid at a deleteable position and d means there is a deletion. If the length distribution is Len 8:Len 9:Len 10:Len 11::2:3:4:5, then two copies of ddd, three copies of xdd, dxd, and ddx, four copies of xxd, xdx, and dxx, and five copies of xxx are needed. Thus, at the first position, the numbers that have x is (3+2*4+5)=16. The numbers that have d at the first position is (2+3*2+4)=12. Thus the fraction of Δ is 12/(12+16)=0.428. The sum of 173 . . . 39 is 815. The fraction of Δ (delta) is D in the equation d/(815+d)=0.428. Hence, the fraction of Δ is 609.8. The other positions are the same. Different length distributions give different proportions of Δ (delta).

In some embodiments, the diversity is greater than 1.E6. In some embodiments, the diversity is 3E8.

In some embodiments, the library comprises diversity in light chain (LC) CDR1, CDR2, and/or CDR3. In some embodiments, the members comprise diversity in light chain (LC) CDR1, CDR2, and/or CDR3.

In some embodiments, the members comprise diversity in HC CDR1 and/or CDR2.

In some embodiments, the members comprise a HC FR3 region.

In some embodiments, the final position of the HC FR3 region is Lys.

In some embodiments, the library is prepared by wobbling.

In some embodiments, the library is prepared by dobbling.

In some embodiments, the members further encode framework (FR) regions 1-4. In some embodiments, the FR regions 1-4 correspond to FR regions 1-4 from 3-23.

In some embodiments, the members encode HC CDR1, HC CDR2 and FR regions 1-4.

In some embodiments, the members comprise a 3-23 HC framework

In some embodiments, the library further comprises a LC variable region.

In some embodiments, the library comprises members encoding diverse LC variable regions.

In some embodiments, the members comprising a LC variable region comprise an A27 LC framework.

In some embodiments, the library is a display library, e.g., a phage display library.

In some embodiments, the library has at least 10⁴, 10⁵ 10⁶, 10⁷, 10⁸, 10⁹ 10¹⁰, 10¹¹ diverse members.

In some aspects, the disclosure features a library (Biblioteca 99) of vectors or genetic packages that display, display and express, or comprise a member of a diverse family of human antibody related peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is
X₁-X₂-X₃-X₄-X₅-X₆-X₇-X₈-X₉-X₁₀-X₁₁ wherein:
X₁ is G, S, Y, D, V, E, R, A, L, I, H, T or Q, e.g., in the ratios for G:S:Y:D:V:E:R:A:L:I:H:T:Q provided in Table 6501;
X₂ is G, S, Y, R, L, P, V, A, T, D, I, K, N or Q, e.g., in the ratios for G:S:Y:R:L:P:V:A:T:D:I:K:N:Q PROVIDED IN Table 6501;
X₃ is G, R, S, L, A, P, Y, V, W, T, or D, e.g., in the ratios for G:R:S:L:A:P:Y:V:W:T:D provided in Table 6501;
X₄ is G, S, R, L, A, W, Y, V, P, T, or D, e.g., in the ratios for G:S:R:L:A:W:Y:V:P:T:D provided in Table 6501;
X₅ is G, S, R, L, A, Y, W, D, T, P, or V, e.g., in the ratios for G:S:R:L:A:Y:W:D:T:P:V provided in Table 6502;
X₆ is G, S, R, D, L, A, P, Y, T, W, V, or Δ (absent), e.g., in the ratios for G:S:R:D:L:A:P:Y:T:W:V:Δ provided in Table 6502;
X₇ is G, S, R, D, L, A, P, Y, T, W, V, or Δ (absent), e.g., in the ratios for G:S:R:D:L:A:P:Y:T:W:V:Δ provided in Table 6502;
X₈ is G, S, R, D, L, A, P, Y, T, W, V, or Δ (absent), e.g., in the ratios for G:S:R:D:L:A:P:Y:T:W:V:Δ provided in Table 6502;
X₉ is F;
X₁₀ is D; and
X₁₁ is Y.

TABLE 6501
HC CDR3 of Library X, Part 1

| 95 | | | 96 | | | 97 | | | 98 | | |
|---|---|---|---|---|---|---|---|---|---|---|---|
| G | 0.2824 | 56.94 | G | 0.2827 | 37.95 | G | 0.2826 | 23.91 | G | 0.2825 | 21.21 |
| S | 0.2824 | 56.94 | S | 0.2827 | 37.95 | S | 0.2826 | 23.91 | S | 0.2825 | 21.21 |
| Y | 0.2824 | 56.94 | Y | 0.2827 | 37.95 | Y | 0.2826 | 23.91 | Y | 0.2825 | 21.21 |
| D | 0.0460 | 9.27 | R | 0.0365 | 4.90 | R | 0.0427 | 3.61 | R | 0.0303 | 2.27 |
| V | 0.0209 | 4.21 | L | 0.0213 | 2.86 | L | 0.0200 | 1.69 | L | 0.0213 | 1.60 |
| E | 0.0206 | 4.16 | P | 0.0195 | 2.62 | A | 0.0197 | 1.66 | A | 0.0210 | 1.57 |
| R | 0.0144 | 2.91 | V | 0.0126 | 1.69 | V | 0.0158 | 1.33 | W | 0.0196 | 1.47 |
| A | 0.0139 | 2.80 | A | 0.0118 | 1.59 | W | 0.0158 | 1.33 | P | 0.0157 | 1.17 |
| L | 0.0107 | 2.15 | T | 0.0113 | 1.52 | T | 0.0138 | 1.17 | T | 0.0157 | 1.17 |
| I | 0.0082 | 1.65 | D | 0.0090 | 1.21 | P | 0.0128 | 1.09 | V | 0.0157 | 1.17 |
| H | 0.0070 | 1.40 | I | 0.0075 | 1.00 | D | 0.0118 | 1.00 | D | 0.0133 | 1.00 |
| T | 0.0062 | 1.25 | K | 0.0075 | 1.00 | | | | | | |
| Q | 0.0050 | 1.00 | N | 0.0075 | 1.00 | | | | | | |
| | | | Q | 0.0075 | 1.00 | | | | | | |

TABLE 6502
Alternative variegation for the HC CDR3 of Library P65, Part 2

| 99 | | | 100 | | | 101 | | | 102 | | |
|---|---|---|---|---|---|---|---|---|---|---|---|
| G | 0.2825 | 20.72 | G | 0.2828 | 23.52 | G | 0.2840 | 24.19 | G | 0.2840 | 24.19 |
| S | 0.2825 | 20.72 | S | 0.2828 | 23.52 | S | 0.2840 | 24.19 | S | 0.2840 | 24.19 |
| Y | 0.2825 | 20.72 | Y | 0.2828 | 23.52 | Y | 0.2840 | 24.19 | Y | 0.2840 | 24.19 |
| R | 0.0289 | 2.12 | R | 0.0272 | 2.26 | R | 0.0265 | 2.26 | R | 0.0265 | 2.26 |
| L | 0.0231 | 1.69 | D | 0.0225 | 1.87 | D | 0.0220 | 1.87 | D | 0.0220 | 1.87 |
| A | 0.0208 | 1.52 | L | 0.0219 | 1.82 | L | 0.0214 | 1.82 | L | 0.0214 | 1.82 |
| W | 0.0192 | 1.40 | A | 0.0194 | 1.62 | A | 0.0190 | 1.61 | A | 0.0190 | 1.61 |
| D | 0.0182 | 1.33 | P | 0.0179 | 1.49 | P | 0.0175 | 1.49 | P | 0.0175 | 1.49 |
| T | 0.0149 | 1.10 | T | 0.0173 | 1.44 | T | 0.0169 | 1.44 | T | 0.0169 | 1.44 |
| P | 0.0140 | 1.02 | W | 0.0136 | 1.13 | W | 0.0133 | 1.13 | W | 0.0133 | 1.13 |
| V | 0.0136 | 1.00 | V | 0.0120 | 1.00 | V | 0.0117 | 1.00 | V | 0.0117 | 1.00 |

The probability of N—X—(S/T) at 96-98 is 0.0022 which is acceptable. One could reduce or eliminate N at position 96. Alternatively, one could replace N with Q.

Δ(delta) is allowed at three positions and the members are represented as xxx, xxd, xdx, dxx, xdd, dxd, ddx, and ddd where x means there is an amino acid at a deleteable position and d means there is a deletion. If the length distribution is Len 8:Len 9:Len 10:Len 11::2:3:4:5, then two copies of ddd, three copies of xdd, dxd, and ddx, four copies of xxd, xdx, and dxx, and five copies of xxx are needed. Thus, at the first position, the numbers that have x is (3+2*4+5)=16. The numbers that have d at the first position is (2+3*2+4)=12. Thus the fraction of Δ is 12/(12+16)=0.428. The sum of 173 . . . 39 is 815. The fraction of Δ (delta) is D in the equation d/(815+d)=0.428. Hence, the fraction of Δ is 609.8. The other positions are the same. Different length distributions give different proportions of Δ (delta).

In some embodiments, the diversity is greater than 1.E6. In some embodiments, the diversity is 3E8.

In some embodiments, the library comprises diversity in light chain (LC) CDR1, CDR2, and/or CDR3. In some embodiments, the members comprise diversity in light chain (LC) CDR1, CDR2, and/or CDR3.

In some embodiments, the members comprise diversity in HC CDR1 and/or CDR2.

In some embodiments, the members comprise a HC FR3 region.

In some embodiments, the final position of the HC FR3 region is Lys.

In some embodiments, the library is prepared by wobbling.

In some embodiments, the library is prepared by dobbling.

In some embodiments, the members further encode framework (FR) regions 1-4. In some embodiments, the FR regions 1-4 correspond to FR regions 1-4 from 3-23.

In some embodiments, the members encode HC CDR1, HC CDR2 and FR regions 1-4.

In some embodiments, the members comprise a 3-23 HC framework

In some embodiments, the library further comprises a LC variable region.

In some embodiments, the library comprises members encoding diverse LC variable regions.

In some embodiments, the members comprising a LC variable region comprise an A27 LC framework.

In some embodiments, the library is a display library, e.g., a phage display library.

In some embodiments, the library has at least 10⁴, 10⁵ 10⁶, 10⁷, 10⁸, 10⁹ 10¹⁰, 10¹¹ diverse members.

In some aspects, the disclosure features a library (Biblioteca 100) of vectors or genetic packages that display, display and express, or comprise a member of a diverse family of human antibody related peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is
X₁-X₂-X₃-X₄-X₅-X₆-X₇-X₈-X₉-X₁₀-X₁₁ wherein:
X₁ is A, D, E, G, H, I, L, R, S, T, V or Y, e.g., in the ratios for A:D:E:G:H:I:L:R:S:T:V:Y described herein, e.g., in Example 11;
X₂ is A, D, G, I, K, L, P, R, S, T, V or Y, e.g., in the ratios for A:D:G:I:K:L:P:R:S:T:V:Y described herein, e.g., in Example 11;
X₃ is A, D, G, L, P, R, S, T, V, W or Y, e.g., in the ratios for A:D:G:L:P:R:S:T:V:W:Y described herein, e.g., in Example 11;
X₄ is A, D, G, L, N, P, R, S, T, V, W or Y, e.g., in the ratios for A:D:G:L:N:P:R:S:T:V:W:Y described herein, e.g., in Example 11;
X₅ is A, D, G, L, P, R, S, T, V, W or Y, e.g., in the ratios for A:D:G:L:P:R:S:T:V:W:Y described herein, e.g., in Example 11;
X₆ is A, D, G, L, P, R, S, T, V, W or Y, e.g., in the ratios for A:D:G:L:P:R:S:T:V:W:Y described herein, e.g., in Example 11;
X₇ is A, D, G, L, P, R, S, T, V, W, Y or Δ (absent), e.g., in the ratios for A:D:G:L:P:R:S:T:V:W:Y:* described herein, e.g., in Example 11;
X₈ is A, D, F, G, L, P, R, S, T, V, W or Y, e.g., in the ratios for A:D:F:G:L:P:R:S:T:V:W:Y described herein, e.g., in Example 11;
X₉ is A, D, F, G, L, P, R, S, T, V, W, Y or Δ (absent), e.g., in the ratios for A:D:F:G:L:P:R:S:T:V:W:Y:* described herein, e.g., in Example 11;
X₁₀ is D or Δ (absent), e.g., as described herein, e.g., in Example 11; and
X₁₁ is Y.

Δ(delta) is allowed at two positions and the members are represented as xxx, xxd, xdx, dxx, xdd, dxd, ddx, and ddd where x means there is an amino acid at a deleteable position and d means there is a deletion. If the length distribution is Len 9:Len 10:Len 11::2:3:4:5, then two copies of ddd, three copies of xdd, dxd, and ddx, four copies of xxd, xdx, and dxx, and five copies of xxx are needed. Thus, at the first position, the numbers that have x is (3+2*4+5)=16. The numbers that have d at the first position is (2+3*2+4)=12. Thus the fraction of Δ is 12/(12+16)=0.428. The sum of 173 . . . 39 is 815. The fraction of Δ (delta) is D in the equation d/(815+d)=0.428. Hence, the fraction of Δ is 609.8. The other positions are the same. Different length distributions give different proportions of Δ (delta).

In some embodiments, the diversity is greater than 1.E6. In some embodiments, the diversity is 3E8.

In some embodiments, the library comprises diversity in light chain (LC) CDR1, CDR2, and/or CDR3. In some embodiments, the members comprise diversity in light chain (LC) CDR1, CDR2, and/or CDR3.

In some embodiments, the members comprise diversity in HC CDR1 and/or CDR2.

In some embodiments, the members comprise a HC FR3 region.

In some embodiments, the final position of the HC FR3 region is Lys.

In some embodiments, the library is prepared by wobbling.

In some embodiments, the library is prepared by dobbling.

In some embodiments, the members further encode framework (FR) regions 1-4. In some embodiments, the FR regions 1-4 correspond to FR regions 1-4 from 3-23.

In some embodiments, the members encode HC CDR1, HC CDR2 and FR regions 1-4.

In some embodiments, the members comprise a 3-23 HC framework

In some embodiments, the library further comprises a LC variable region.

In some embodiments, the library comprises members encoding diverse LC variable regions.

In some embodiments, the members comprising a LC variable region comprise an A27 LC framework.

In some embodiments, the library is a display library, e.g., a phage display library.

In some embodiments, the library has at least 10⁴, 10⁵ 10⁶, 10⁷, 10⁸, 10⁹ 10¹⁰, 10¹¹ diverse members.

In some aspects, the disclosure features a library (Biblioteca 101) of vectors or genetic packages that display, display and express, or comprise a member of a diverse family of human antibody related peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is
X₁-X₂-X₃-X₄-X₅-X₆-X₇-X₈ wherein:
X₁ is A, D, E, G, H, I, L, R, S, T, V or Y, e.g., in the ratios for A:D:E:G:H:I:L:R:S:T:V:Y described herein, e.g., in Example 11;
X₂ is A, D, G, I, K, L, P, R, S, T, V or Y, e.g., in the ratios for A:D:G:I:K:L:P:R:S:T:V:Y described herein, e.g., in Example 11;
X₃ is A, D, G, L, P, R, S, T, V, W or Y, e.g., in the ratios for A:D:G:L:P:R:S:T:V:W:Y described herein, e.g., in Example 11;
X₄ is A, D, G, L, N, P, R, S, T, V, W, Y, or Δ (absent), e.g., in the ratios for A:D:G:L:N:P:R:S:T:V:W:Y:* described herein, e.g., in Example 11;
X₅ is A, D, G, L, P, R, S, T, V, W, Y, or Δ (absent), e.g., in the ratios for A:D:G:L:P:R:S:T:V:W:Y described herein, e.g., in Example 11;
X₆ is A, D, F, G, L, P, R, S, T, V, W or Y, e.g., in the ratios for A:D:F:G:L:P:R:S:T:V:W:Y described herein, e.g., in Example 11;
X₇ is A, D, F, G, L, P, R, S, T, V, W or Y, e.g., in the ratios for A:D:F:G:L:P:R:S:T:V:W:Y described herein, e.g., in Example 11;
X₈ is A, D, F, G, L, P, R, S, T, V, W or Y, e.g., in the ratios described herein, e.g., in Example 11;

Δ(delta) is allowed at two positions and the members are represented as xxx, xxd, xdx, dxx, xdd, dxd, ddx, and ddd where x means there is an amino acid at a deleteable position and d means there is a deletion. If the length distribution is Len 6:Len 7:Len 8::2:3:4, then two copies of ddd, three copies of xdd, dxd, and ddx, and four copies of xxd, xdx, and dxx. Thus, at the first position, the numbers that have x is (3+2*4+5)=16. The numbers that have d at the first position is (2+3*2+4)=12. Thus the fraction of Δ is 12/(12+16)=0.428. The sum of 173 . . . 39 is 815. The fraction of Δ (delta) is D in the equation d/(815+d)=0.428. Hence, the fraction of Δ is 609.8. The other positions are the same. Different length distributions give different proportions of Δ (delta).

In some embodiments, the diversity is greater than 1.E6. In some embodiments, the diversity is 3E8.

In some embodiments, the library comprises diversity in light chain (LC) CDR1, CDR2, and/or CDR3. In some embodiments, the members comprise diversity in light chain (LC) CDR1, CDR2, and/or CDR3.

In some embodiments, the members comprise diversity in HC CDR1 and/or CDR2.

In some embodiments, the members comprise a HC FR3 region.

In some embodiments, the final position of the HC FR3 region is Lys.

In some embodiments, the library is prepared by wobbling.

In some embodiments, the library is prepared by dobbling.

In some embodiments, the members further encode framework (FR) regions 1-4. In some embodiments, the FR regions 1-4 correspond to FR regions 1-4 from 3-23.

In some embodiments, the members encode HC CDR1, HC CDR2 and FR regions 1-4.

In some embodiments, the members comprise a 3-23 HC framework

In some embodiments, the library further comprises a LC variable region.

In some embodiments, the library comprises members encoding diverse LC variable regions.

In some embodiments, the members comprising a LC variable region comprise an A27 LC framework.

In some embodiments, the library is a display library, e.g., a phage display library.

In some embodiments, the library has at least 10⁴, 10⁵ 10⁶, 10⁷, 10⁸, 10⁹ 10¹⁰, 10¹¹ diverse members.

In some aspects, the disclosure features a library (Biblioteca 102) of vectors or genetic packages that display, display and express, or comprise a member of a diverse family of human antibody related peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is
X₁-X₂-X₃-X₄-X₅ wherein:
X₁ is A, D, E, G, H, I, L, R, S, T, V or Y, e.g., in the ratios for A:D:E:G:H:I:L:R:S:T:V:Y described herein, e.g., in Example 11;
X₂ is A, D, G, I, K, L, P, R, S, T, V or Y, e.g., in the ratios for A:D:G:I:K:L:P:R:S:T:V:Y described herein, e.g., in Example 11;
X₃ is A, D, G, L, P, R, S, T, V, W or Y, e.g., in the ratios for A:D:G:L:P:R:S:T:V:W:Y described herein, e.g., in Example 11;
X₄ is A, D, G, L, N, P, R, S, T, V, W or Y, e.g., in the ratios for A:D:G:L:N:P:R:S:T:V:W:Y described herein, e.g., in Example 11;
X₅ is A, D, G, L, P, R, S, T, V, W or Y, e.g., in the ratios for A:D:G:L:P:R:S:T:V:W:Y described herein, e.g., in Example 11;

In some embodiments, the diversity is greater than 1.E6. In some embodiments, the diversity is 3E8.

In some embodiments, the library comprises diversity in light chain (LC) CDR1, CDR2, and/or CDR3. In some embodiments, the members comprise diversity in light chain (LC) CDR1, CDR2, and/or CDR3.

In some embodiments, the members comprise diversity in HC CDR1 and/or CDR2.

In some embodiments, the members comprise a HC FR3 region.

In some embodiments, the final position of the HC FR3 region is Lys.

In some embodiments, the library is prepared by wobbling.

In some embodiments, the library is prepared by dobbling.

In some embodiments, the members further encode framework (FR) regions 1-4. In some embodiments, the FR regions 1-4 correspond to FR regions 1-4 from 3-23.

In some embodiments, the members encode HC CDR1, HC CDR2 and FR regions 1-4.

In some embodiments, the members comprise a 3-23 HC framework

In some embodiments, the library further comprises a LC variable region.

In some embodiments, the library comprises members encoding diverse LC variable regions.

In some embodiments, the members comprising a LC variable region comprise an A27 LC framework.

In some embodiments, the library is a display library, e.g., a phage display library.

In some embodiments, the library has at least 10⁴, 10⁵ 10⁶, 10⁷, 10⁸, 10⁹ 10¹⁰, 10¹¹ diverse members.

In some aspects, the disclosure features a library (Biblioteca 7) of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is
X₁-X₂-X₃-X₄-X₅-X₆-X₇-X₈-X₉-X₁₀-X₁₁-X₁₂-X₁₃-X₁₄, wherein
X₁ is G, D, E, V, S, A, R, L, I, H, T, or Q, e.g., in the ratios for G:D:V:E:A:S:R:L:I:H:T:Q of 217:185:84:83:71:68:58:43:33:28:25:20 (ORCBU);
X₂ is G, R, S, L, P, V, A, T, D, K, N, Q, or I, e.g., in the ratios for G:R:S:L:P:V:A:T:D:K:N:Q:I of 186:142:99:83:76:49:46:44:35:29:29:29:29 (ORCBU);
X₃ is G, R, S, L, A, P, Y, V, W, T, or D, e.g., in the ratios for G:R:S:L:A:P:Y:V:W:T:D of 203:130:92:61:60:54:52:48:48:42:36 (ORCBU);
X₄ is G, S, R, L, A, W, Y, V, P, T, or D, e.g., in the ratios for G:S:R:L:A:W:Y:V:P:T:D of 210:103:91:64:63:59:59:47:47:47:40 (ORCBU);
X₅ is G, S, R, L, A, Y, W, D, T, P, or V, e.g., in the ratios for G:S:R:L:A:Y:W:D:T:P:V of 190:96:89:71:64:59:59:56:46:43:42 (ORCBU);
X₆ is G, S, R, D, L, A, P, Y, T, W, or V, e.g., in the ratios for G:S:R:D:L:A:P:Y:T:W:V of 173:93:88:73:71:63:58:57:56:44:39 (ORCBU);
X₇ is G, R, S, L, P, D, A, Y, T, W, V, or Δ (absent), e.g., in the ratios for G:R:S:L:P:D:A:Y:T:W:V:Δ of 179:92:86:74:70:69:56:55:44:41:39:* (ORCBU);
X₈ is G, S, R, L, D, P, Y, A, T, F, V, or Δ, e.g., in the ratios for G:S:R:L:D:P:Y:A:T:F:V:Δ of 141:94:93:83:78:69:65:59:47:41:41:* (ORCBU);
X₉ is the same as X₈;
X₁₀ is the same as X₈;
X₁₁ is the same as X₈;
X₁₂ is F;
X₁₃ is D; and
X₁₄ is Y;
   and, e.g., the length distribution is Len9:Len10:Len11:Len12:Len13:Len14::n1:n2:n3:n4:n5:n6. The length distribution determines the percentage of delta at each position where delta is allowed provided that each deletable position is deleted with equal probability. In some embodiments, n1 through n6 are all 1. In some embodiments, n1-1, n2-2, n3-4, n4-8, n5-8, and n6=16.

Alternatively, the amino-acids could be used in the ratios shown in Tables 6511A, 6511B, and 6511C. For each position in HC CDR3 there are 3 columns: the amino-acid type, the fraction of the mix that is to be that AAT, and the ratio of that AAT to the least used AAT.

TABLE 6511A
HC CDR3 proportions, Length = 11, 12, 13, 14 part 1

| 95 | | | 96 | | | 97 | | | 98 | | | 99 | | |
|---|---|---|---|---|---|---|---|---|---|---|---|---|---|---|
| D | 0.2397 | 9.25 | R | 0.2061 | 5.01 | R | 0.2038 | 9.81 | G | 0.1876 | 9.00 | G | 0.1868 | 9.00 |
| G | 0.1854 | 7.15 | G | 0.1853 | 4.50 | G | 0.1869 | 9.00 | R | 0.1490 | 7.15 | R | 0.1422 | 6.85 |
| W | 0.1088 | 4.20 | L | 0.1205 | 2.93 | L | 0.0956 | 4.60 | L | 0.1048 | 5.03 | L | 0.1135 | 5.47 |
| E | 0.1075 | 4.15 | P | 0.1103 | 2.68 | A | 0.0941 | 4.53 | A | 0.1032 | 4.95 | A | 0.1023 | 4.93 |
| A | 0.0920 | 3.55 | V | 0.0711 | 1.73 | P | 0.0846 | 4.08 | W | 0.0966 | 4.63 | W | 0.0943 | 4.54 |
| T | 0.0881 | 3.40 | A | 0.0668 | 1.62 | V | 0.0752 | 3.62 | P | 0.0770 | 3.69 | D | 0.0895 | 4.31 |
| I | 0.0428 | 1.65 | T | 0.0639 | 1.55 | W | 0.0752 | 3.62 | T | 0.0770 | 3.69 | T | 0.0735 | 3.54 |
| S | 0.0412 | 1.59 | D | 0.0508 | 1.23 | T | 0.0658 | 3.17 | V | 0.0770 | 3.69 | P | 0.0687 | 3.31 |
| H | 0.0363 | 1.40 | I | 0.0421 | 1.02 | D | 0.0564 | 2.72 | D | 0.0655 | 3.14 | V | 0.0671 | 3.23 |
| V | 0.0324 | 1.25 | Q | 0.0421 | 1.02 | S | 0.0415 | 2.00 | S | 0.0417 | 2.00 | S | 0.0415 | 2.00 |
| R | 0.0259 | 1.00 | S | 0.0412 | 1.00 | Y | 0.0208 | 1.00 | Y | 0.0208 | 1.00 | Y | 0.0208 | 1.00 |

TABLE 6511B
HC CDR3 proportions, Length = 11, 12, 13, 14 part 2

| 100 | | | 101 | | | 102 | | | 102a | | | 102b | | |
|---|---|---|---|---|---|---|---|---|---|---|---|---|---|---|
| G | 0.1860 | 9.00 | G | 0.1863 | 9.00 | G | 0.1849 | 9.00 | G | 0.1863 | 4.47 | G | 0.1863 | 4.49 |
| R | 0.1345 | 6.51 | R | 0.1465 | 7.08 | R | 0.1371 | 6.67 | R | 0.1362 | 3.27 | R | 0.1362 | 3.28 |
| D | 0.1116 | 5.40 | L | 0.1178 | 5.69 | L | 0.1224 | 5.96 | L | 0.1216 | 2.92 | L | 0.1216 | 2.93 |
| L | 0.1085 | 5.25 | P | 0.1115 | 5.38 | D | 0.1150 | 5.60 | D | 0.1143 | 2.74 | D | 0.1143 | 2.75 |
| A | 0.0963 | 4.66 | A | 0.0892 | 4.31 | P | 0.1017 | 4.95 | P | 0.1011 | 2.43 | P | 0.1011 | 2.44 |
| P | 0.0887 | 4.29 | D | 0.0892 | 4.31 | A | 0.0870 | 4.23 | A | 0.0864 | 2.07 | A | 0.0864 | 2.08 |
| T | 0.0856 | 4.14 | T | 0.0701 | 3.39 | T | 0.0693 | 3.37 | T | 0.0689 | 1.65 | T | 0.0689 | 1.66 |
| W | 0.0673 | 3.25 | W | 0.0653 | 3.15 | F | 0.0604 | 2.94 | F | 0.0601 | 1.44 | F | 0.0601 | 1.45 |
| V | 0.0596 | 2.88 | V | 0.0621 | 3.00 | V | 0.0604 | 2.94 | V | 0.0601 | 1.44 | V | 0.0601 | 1.45 |
| S | 0.0413 | 2.00 | S | 0.0414 | 2.00 | S | 0.0411 | 2.00 | S | 0.0414 | 0.99 | S | 0.0414 | 1.00 |
| Y | 0.0207 | 1.00 | Y | 0.0207 | 1.00 | Y | 0.0206 | 1.00 | Y | 0.0238 | 0.57 | Y | 0.0238 | 0.57 |

TABLE 6511C
HC CDR3 proportions, Length = 11-14 part 3

| | 102c | |
|---|---|---|
| G | 0.1863 | 5.75 |
| R | 0.1362 | 4.21 |
| L | 0.1216 | 3.75 |
| D | 0.1143 | 3.53 |
| P | 0.1011 | 3.12 |
| A | 0.0864 | 2.67 |
| T | 0.0689 | 2.13 |
| F | 0.0601 | 1.85 |
| V | 0.0601 | 1.85 |
| S | 0.0414 | 1.28 |
| Y | 0.0238 | 0.73 |

In some embodiments, the members comprise a framework region 4 (FR4) and the FR4 is identical to JH4.

In some embodiments, the diversity is 5E8.

In some embodiments, the diversity is 2E9.

In some embodiments, the diversity is 6E10.

In some embodiments, X₁₁ is absent.

In some embodiments, X₁₀ and X₁₁ are absent.

In some embodiments, a Gly residue is inserted after X₁₁.

In some embodiments, Gly-Gly is inserted after X₁₁.

In some embodiments, the library comprises diversity in light chain (LC) CDR1, CDR2, and/or CDR3. In some embodiments, the members comprise diversity in light chain (LC) CDR1, CDR2, and/or CDR3.

In some embodiments, the members comprise diversity in HC CDR1 and/or CDR2.

In some embodiments, the members comprise a HC FR3 region.

In some embodiments, the final position of the HC FR3 region is Lys.

In some embodiments, the library is prepared by wobbling.

In some embodiments, the library is prepared by dobbling.

In some embodiments, the members further encode framework (FR) regions 1-4. In some embodiments, the FR regions 1-4 correspond to FR regions 1-4 from 3-23.

In some embodiments, the members encode HC CDR1, HC CDR2 and FR regions 1-4.

In some embodiments, the members comprise a 3-23 HC framework

In some embodiments, the library further comprises a LC variable region.

In some embodiments, the library comprises members encoding diverse LC variable regions.

In some embodiments, the members comprising a LC variable region comprise an A27 LC framework.

In some embodiments, the library is a display library, e.g., a phage display library.

In some embodiments, the library has at least 10⁴, 10⁵ 10⁶, 10⁷, 10⁸, 10⁹ 10¹⁰, 10¹¹ diverse members.

In some aspects, the disclosure features a library (Biblioteca 8) of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is
X₁-X₂-X₃-X₄-X₅-X₆-X₇-X₈-X₉-X₁₀-X₁₁-X₁₂-X₁₃-X₁₄, wherein
X₁ is G, D, V, E, A, S:R:L, I:H, T, or Q, e.g., in the ratios for G:D:V:E:A:S:R:L:I:H:T:Q of 217:185:84:83:71:68:58:43:33:28:25:20 (ORCBU);
X₂ is G, R, S, L, P, V, A, T, D, K, N, Q, or I, e.g., in the ratios for G:R:S:L:P:V:A:T:D:K:N:Q:I of 186:142:99:83:76:49:46:44:35:29:29:29:29 (ORCBU);
X₃ is G, R, S, L, A, P, Y, V, W, T, or D, e.g., in the ratios for G:R:S:L:A:P:Y:V:W:T:D of 203:130:92:61:60:54:52:48:48:42:36 (ORCBU);
X₄ is G, S, R, L, A, W, Y, V, P, T, or D, e.g., in the ratios for G:S:R:L:A:W:Y:V:P:T:D of 210:103:91:64:63:59:59:47:47:47:40 (ORCBU);
X₅ is G, S, R, L, A, Y, W, D, T, P, or V, e.g., in the ratios for G:S:R:L:A:Y:W:D:T:P:V of 190:96:89:71:64:59:59:56:46:43:42 (ORCBU);
X₆ is G, S, R, D, L, A, P, Y, T, W, or V, e.g., in the ratios for G:S:R:D:L:A:P:Y:T:W:V of 173:93:88:73:71:63:58:57:56:44:39 (ORCBU);
X₇ is G, R, S, L, P, D, A, Y, T, W, or V, e.g., in the ratios for G:R:S:L:P:D:A:Y:T:W:V of 179:92:86:74:70:69:56:55:44:41:39 (ORCBU);
X₈ is G, S, R, L, D, P, Y, A, T, F, V, or Δ (absent), e.g., in the ratios for G:S:R:L:D:P:Y:A:T:F:V:Δ of 141:94:93:83:78:69:65:59:47:41:41:* (ORCBU);
X₉ is G, S, R, L, D, P, Y, A, T, F, V, or Δ, e.g., in the ratios for G:S:R:L:D:P:Y:A:T:F:V:Δ of 141:94:93:83:78:69:65:59:47:41:41:* (ORCBU);
X₁₀ is G, S, R, L, D, P, Y, A, T, F, V, or Δ, e.g., in the ratios for G:S:R:L:D:P:Y:A:T:F:V:Δ of 141:94:93:83:78:69:65:59:47:41:41:* (ORCBU);
X₁₁ is G, S, R, L, D, P, Y, A, T, F, V, or Δ, e.g., in the ratios for G:S:R:L:D:P:Y:A:T:F:V:Δ of 141:94:93:83:78:69:65:59:47:41:41:* (ORCBU);
X₁₂ is F;
X₁₃ is D; and
X₁₄ is Y.

The ratios of the lengths can be Len10:Len11:Len12:Len13:Len14::n1:n2:n3:n4:n5. In some embodiments, n1=n2=n3=n4=n5-1. In some embodiments, n1=1, n2=2, n3=4, n4=2, n5=1. The length distribution determines the percentage of delta at each position where Δ is allowed provided that each deletable position is deleted with equal probability. If the length distribution is 1:2:4:2:1, then one copy of xxxx (where x is any amino acid), 2 copies of xxxd, xxdx, xdxx, dxxx (where d is a deletion), 4 copies of xxdd, xdxd, xddx, dxxd, dxdx, and ddxx, 2 copies of xddd, dxdd, ddxd, and dddx, and one copy of dddd are needed. The versions with x at position 1 are (1+2*3+4*3+2*1)=21. The versions with d at position 1 are (2+4*3+2*3+1)=21. Thus Δ should be present at each deleteable position at 21/(21+21)=0.50.

In some embodiments, the members comprise a framework region 4 (FR4) and the FR4 is identical to JH4.

In some embodiments, the diversity is greater than 1.E6. In some embodiments the diversity is greater than 1.E8.

In some embodiments, the library comprises diversity in light chain (LC) CDR1, CDR2, and/or CDR3. In some embodiments, the members comprise diversity in light chain (LC) CDR1, CDR2, and/or CDR3.

In some embodiments, the members comprise diversity in HC CDR1 and/or CDR2.

In some embodiments, the members comprise a HC FR3 region.

In some embodiments, the final position of the HC FR3 region is Lys.

In some embodiments, the library is prepared by wobbling.

In some embodiments, the library is prepared by dobbling.

In some embodiments, the members further encode framework (FR) regions 1-4. In some embodiments, the FR regions 1-4 correspond to FR regions 1-4 from 3-23.

In some embodiments, the members encode HC CDR1, HC CDR2 and FR regions 1-4.

In some embodiments, the members comprise a 3-23 HC framework

In some embodiments, the library further comprises a LC variable region.

In some embodiments, the library comprises members encoding diverse LC variable regions.

In some embodiments, the members comprising a LC variable region comprise an A27 LC framework.

In some embodiments, the library is a display library, e.g., a phage display library.

In some embodiments, the library has at least 10⁴, 10⁵ 10⁶, 10⁷, 10⁸, 10⁹ 10¹⁰, 10¹¹ diverse members.

In some aspects, the disclosure features a library (Biblioteca 9) of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is
X₁-X₂-G₃-X₄-G₅-X₆-X₇-X₈-X₉-X₁₀-X₁₁-X₁₂-X₁₃-X₁₄ (SEQ ID NO: 1254) wherein
X₁ is G, D, E, V, S, A, R, L, I, H, T, or Q, e.g., in the ratios for G:D:V:E:A:S:R:L:I:H:T:Q of 217:185:84:83:71:68:58:43:33:28:25:20 (ORCBU);
X₂ is G, R, S, L, P, V, A, T, D, K, N, Q, or I, e.g., in the ratios for G:R:S:L:P:V:A:T:D:K:N:Q:I of 186:142:99:83:76:49:46:44:35:29:29:29:29 (ORCBU);
X₃ is G;
X₄ is G, S, R, L, A, W, Y, V, P, T, or D, e.g., in the ratios for G:S:R:L:A:W:Y:V:P:T:D of 210:103:91:64:63:59:59:47:47:47:40 (ORCBU);
X₅ is G;
X₆ is G, S, R, D, L, A, P, Y, T, W, or V, e.g., in the ratios for G:S:R:D:L:A:P:Y:T:W:V of 173:93:88:73:71:63:58:57:56:44:39 (ORCBU);
X₇ is R or absent (Δ) with equal frequency;
X₈ is G, S, R, L, D, P, Y, A, T, F, V, or Δ, e.g., in the ratios for G:S:R:L:D:P:Y:A:T:F:V:Δ of 141:94:93:83:78:69:65:59:47:41:41:* (ORCBU);
X₉ is the same as X₈;
X₁₀ is the same as X₈;
X₁₁ is the same as X₈;
X₁₂ is F;
X₁₃ is D; and
X₁₄ is Y.

The length distribution can be, e.g., Len9:Len10:Len11:Len12:Len13:Len14::n1:n2:n3:n4:n5:n6. In some embodiments, n1=n2=n3=n4=n5=n6-1. In some embodiments, n1-1, n2-2, n3-4, n4-4, n5-4, and n6=4. Other values on n1-n6 may be used. The proportion of delta (where delta is allowed) is determined by the values of n1-n6 and the rule that each deletable position is deleted with equal frequency.

In some embodiments, the members comprise a framework region 4 (FR4) and the FR4 is identical to JH4.

In some embodiments, the diversity is 5E8.

In some embodiments, the diversity is 9E8.

In some embodiments, the diversity is 2E9.

In some embodiments, the library comprises diversity in light chain (LC) CDR1, CDR2, and/or CDR3. In some embodiments, the members comprise diversity in light chain (LC) CDR1, CDR2, and/or CDR3.

In some embodiments, the members comprise diversity in HC CDR1 and/or CDR2.

In some embodiments, the members comprise a HC FR3 region.

In some embodiments, the final position of the HC FR3 region is Lys.

In some embodiments, the library is prepared by wobbling.

In some embodiments, the library is prepared by dobbling.

In some embodiments, the members further encode framework (FR) regions 1-4. In some embodiments, the FR regions 1-4 correspond to FR regions 1-4 from 3-23.

In some embodiments, the members encode HC CDR1, HC CDR2 and FR regions 1-4.

In some embodiments, the members comprise a 3-23 HC framework

In some embodiments, the library further comprises a LC variable region.

In some embodiments, the library comprises members encoding diverse LC variable regions.

In some embodiments, the members comprising a LC variable region comprise an A27 LC framework.

In some embodiments, the library is a display library, e.g., a phage display library.

In some embodiments, the library has at least 10⁴, 10⁵ 10⁶, 10⁷, 10⁸, 10⁹ 10¹⁰, 10¹¹ diverse members.

In some aspects, the disclosure features a library (Biblioteca 10) of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is
X₁-X₂-X₃-X₄-X₅-X₆-X₇-X₈-X₉-X₁₀-X₁₁-X₁₂-X₁₃-X₁₄-X₁₅-X₁₆ (SEQ ID NO: 1255) wherein
X₁ is D, G, V, E, A, S, R, L, T, H, P, or Δ (absent), e.g., in the ratios for D:G:V:E:A:S:R:L:T:H:P:Δ of 214:192:92:90:86:52:50:39:32:32:25:* (ORCBU);
X₂ is G, R, P, L, S, A, V, T, K, D, Q, or Δ, e.g., in the ratios G:R:P:L:S:A:V:T:K:D:Q:Δ of 171:153:107:83:81:51:40:40:34:32:30:* (ORCBU);
X₃ is Y, G, D, R, H, P, S, L, N, A, or I, e.g., in the ratios for Y:G:D:R:H:P:S:L:N:A:I of 30:1:1:1:1:1:1:1:1:1:1 (ORCBU);
X₄ is Y, G, S, F, L, D, E, P, A, R, or H, e.g., in the ratios for Y:G:S:F:L:D:E:P:A:R:H of 30:1:1:1:1:1:1:1:1:1:1 (ORCBU);
X₅ is D;
X₆ is S;
X₇ is S;
X₈ is G, A, D, P, V, L, S, R, T, Y, or N, e.g., in the ratios for G:A:D:P:V:L:S:R:T:Y:N of 30:1:1:1:1:1:1:1:1:1:1 (ORCBU);
X₉ is Y, P, L, S, W, H, R, F, D, G, N, e.g., in the ratios for Y:P:L:S:W:H:R:F:D:G:N of 30:1:1:1:1:1:1:1:1:1:1 (ORCBU);
X₁₀ is Y, S, P, L, R, F, G, W, H, D, V, e.g., in the ratios for Y:S:P:L:R:F:G:W:H:D:V of 30:1:1:1:1:1:1:1:1:1:1 (ORCBU);
X₁₁ is G;
X₁₂ is G, P, D, R, S, L, A, N, H, T, Y, or Δ, e.g., in the ratios for G:P:D:R:S:L:A:N:H:T:Y:Δ of 185:101:96:92:88:67:48:43:36:35:33:* (ORCBU);
X₁₃ is G, D, R, P, S, N, L, A, Y, V, T, or Δ, e.g., in the ratios for G:D:R:P:S:N:L:A:Y:V:T:Δ of 204:103:96:78:72:67:67:45:42:36:34:* (ORCBU);
X₁₄ is F;
X₁₅ is D; and
X₁₆ is Y.

The length distribution can be, e.g., Len12:Len13:Len14:Len15:Len16::n1:n2:n3:n4:n5. In some embodiments, n1=n2=n3=n4=n5-1. In some embodiments, n1=4, n2=4, n3=4, n4=2, n5=1. The proportion of Δ is determined by the length distribution with each deleteable position being deleted with equal frequency. The only possible N—X—(S/T) is at X₈-X₁₀ and the frequency is very low and acceptable. One could change N to Q at X₈.

In some embodiments, the diversity is 3.3E9. In some embodiments, the diversity is greater than 1.E6.

In some embodiments, the diversity is greater than 5E8.

In some embodiments, the diversity is greater than 2E9.

In some embodiments, the library comprises diversity in light chain (LC) CDR1, CDR2, and/or CDR3. In some embodiments, the members comprise diversity in light chain (LC) CDR1, CDR2, and/or CDR3.

In some embodiments, the members comprise diversity in HC CDR1 and/or CDR2.

In some embodiments, the members comprise a HC FR3 region.

In some embodiments, the final position of the HC FR3 region is Lys.

In some embodiments, the library is prepared by wobbling.

In some embodiments, the library is prepared by dobbling.

In some embodiments, the members further encode framework (FR) regions 1-4. In some embodiments, the FR regions 1-4 correspond to FR regions 1-4 from 3-23.

In some embodiments, the members encode HC CDR1, HC CDR2 and FR regions 1-4.

In some embodiments, the members comprise a 3-23 HC framework

In some embodiments, the library further comprises a LC variable region.

In some embodiments, the library comprises members encoding diverse LC variable regions.

In some embodiments, the members comprising a LC variable region comprise an A27 LC framework.

In some embodiments, the library is a display library, e.g., a phage display library.

In some embodiments, the library has at least 10⁴, 10⁵ 10⁶, 10⁷, 10⁸, 10⁹ 10¹⁰, 10¹¹ diverse members.

In some aspects, the disclosure features a library (Biblioteca 11) of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is
X₁-X₂-X₃-X₄-X₅-X₆-X₇-X₈-X₉-X₁₀-X₁₁-X₁₂-X₁₃-X₁₄-X₁₅-X₁₆-X₁₇-X₁₈-X₁₉ (SEQ ID NO: 1256), wherein
X₁ is D, G, V, E, A, S, R, L, T, H, P, or Δ (absent), e.g., in the ratios for D:G:V:E:A:S:R:L:T:H:P:Δ of 214:192:92:90:86:52:50:39:32:32:25:* (ORCBU);
X₂ is G, R, P, L, S, A, V, T, K, D, Q, or Δ, e.g., in the ratios for G:R:P:L:S:A:V:T:K:D:Q:Δ of 171:153:107:83:81:51:40:40:34:32:30:* (ORCBU);
X₃ is G or Δ at a ratio determined by the prescribed length distribution;
X₄ is G or Δ at a ratio determined by the prescribed length distribution;
X₅ is Y, G, S, F, L, D, E, P, A, R, or H, e.g., in the ratios for Y:G:S:F:L:D:E:P:A:R:H of 30:1:1:1:1:1:1:1:1:1:1 (ORCBU);
X₆ is D;
X₇ is S;
X₈ is S;
X₉ is G;
X₁₀ is Y;
X₁₁ is Y, S, P, L, R, F, G, W, H, D, or V, e.g., in the ratios for Y:S:P:L:R:F:G:W:H:D:V of 50:5:5:5:5:5:5:5:5:5:5 (ORCBU);
X₁₂ is Y, P, S, G, R, F, L, D, H, W, or V, e.g., in the ratios for Y:P:S:G:R:F:L:D:H:W:V of 50:5:5:5:5:5:5:5:5:5:5 (ORCBU);
X₁₃ is G, R, S, L, D, P, A, T, F, I, Y, or Δ, e.g., in the ratios for G:R:S:L:D:P:A:T:F:I:Y:Δ of 5:1:1:1:1:1:1:1:1:1:1:15 (ORCBU);
X₁₄ is G or Δ, at a ratio determined by the prescribed length distribution;
X₁ is the same as X₁₃;
X₁₆ is the same as X₁₃;
X₁₇ is F, G, P, S, R, D, L, A, T, N, or H, e.g., in the ratios for F:G:P:S:R:D:L:A:T:N:H of 500:103:66:62:61:52:45:32:28:28:22 (ORCBU);
X₁₈ is D; and
X₁₉ is Y.

The length distribution can be, e.g., Len15:Len16:Len17:Len18:Len19::n1:n2:n3:n4:n5.

In some embodiments, n1=n2=n3=n4=n5-1. In some embodiments, n1=10, n2=8, n3=6, n4=4, and n5=1. Other values of n1-n5 could be used. At positions where Δ is allowed, the fraction of Δ is determined by the length distribution using the rule that each deleteable position is deleted with equal frequency. N—X—(S/T) cannot occur in this library.

In some embodiments, X₁₇ is F.

In some embodiments, the diversity of HC CDR3 is greater than 1.E6.

In some embodiments, the diversity of HC CDR3 is 5E8.

In some embodiments, the diversity of HC CDR3 is 2E9.

In some embodiments, the diversity of HC CDR3 is 2.6E9.

In some embodiments, the library comprises diversity in light chain (LC) CDR1, CDR2, and/or CDR3.

In some embodiments, members comprise diversity in HC CDR1 and/or CDR2.

In some embodiments, the members comprise a HC FR3 region.

In some embodiments, the final position of the HC FR3 region is Lys.

In some embodiments, the library is prepared by wobbling.

In some embodiments, the library is prepared by dobbling.

In some embodiments, the members further encode framework (FR) regions 1-4. In some embodiments, the FR regions 1-4 correspond to FR regions 1-4 from 3-23.

In some embodiments, the members encode HC CDR1, HC CDR2 and FR regions 1-4.

In some embodiments, the members comprise a 3-23 HC framework

In some embodiments, the library further comprises a LC variable region.

In some embodiments, the library comprises members encoding diverse LC variable regions.

In some embodiments, the members comprising a LC variable region comprise an A27 LC framework.

In some embodiments, the library is a display library, e.g., a phage display library.

In some embodiments, the library has at least 10⁴, 10⁵ 10⁶, 10⁷, 10⁸, 10⁹ 10¹⁰, 10¹¹ diverse members.

In some aspects, the disclosure features a library (Biblioteca 12) of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is
X₁-X₂-X₃-X₄-X₅-X₆-X₇-X₈-X₉-X₁₀-X₁₁-X₁₂-X₁₃ (SEQ ID NO: 1257) wherein
X₁ is D, G, V, E, A, S, R, L, T, H, P, or Δ (absent), e.g., in the ratios for D:G:V:E:A:S:R:L:T:H:P:Δ of 214:192:92:90:86:52:50:39:32:32:25:* (ORCBU);
X₂ is G, R, P, L, S, A, V, T, K, D, Q, or Δ, e.g., in the ratios for G:R:P:L:S:A:V:T:K:D:Q:Δ of 171:153:107:83:81:51:40:40:34:32:30:* (ORCBU);
X₃ is D, G, P, L, S, N, A, H, F, R, T, or V, e.g., in the ratios for D:G:P:L:S:N:A:H:F:R:T:V of 10:1:1:1:1:1:1:1:1:1:1:1 (ORCBU);
X₄ is Y;
X₅ is G;
X₆ is D;
X₇ is Y, F, L, S, H, G, P, A, R, D, or E, e.g., in the ratios for Y:F:L:S:H:G:P:A:R:D:E of 10:1:1:1:1:1:1:1:1:1:1 (ORCBU);
X₈ is G, R, S, L, D, P, A, T, F, I, Y, or Δ, e.g., in the ratios for G:R:S:L:D:P:A:T:F:I:Y:Δ of 5:1:1:1:1:1:1:1:1:1:1:* (ORCBU);
X₉ is the same as X₈;
X₁₀ is A, F, G, P, S, R, D, L, T, N, or H, e.g., in the ratios for A:F:G:P:S:R:D:L:T:N:H of 10:1:1:1:1:1:1:1:1:1:1 (ORCBU);
X₁₁ is F;
X₁₂ is D; and
X₁₃ is I.

The length distribution can be, e.g., Len10:Len11:Len12:Len13::n1:n2:n3:n4. In some embodiments, n1=n2=n3=n4=1. In some embodiments, n1=1, n2=3, n3=6, n4=6. Other values of n1-n4 could be used. The proportion of Δ at each deleteable position is determined by the length distribution under the rule that each deleteable position is deleted with equal frequency.

In some embodiments, the members comprise a framework region 4 (FR4) and the FR4 is identical to JH3.

In some embodiments, the diversity is greater than 1.E6. In some embodiments, the diversity is 3E7.

In some embodiments, the diversity is 3E8.

In some embodiments, the library comprises diversity in light chain (LC) CDR1, CDR2, and/or CDR3. In some embodiments, the members comprise diversity in light chain (LC) CDR1, CDR2, and/or CDR3.

In some embodiments, the members comprise diversity in HC CDR1 and/or CDR2.

In some embodiments, the members comprise a HC FR3 region.

In some embodiments, the final position of the HC FR3 region is Lys.

In some embodiments, the library is prepared by wobbling.

In some embodiments, the library is prepared by dobbling.

In some embodiments, the members further encode framework (FR) regions 1-4. In some embodiments, the FR regions 1-4 correspond to FR regions 1-4 from 3-23.

In some embodiments, the members encode HC CDR1, HC CDR2 and FR regions 1-4.

In some embodiments, the members comprise a 3-23 HC framework

In some embodiments, the library further comprises a LC variable region.

In some embodiments, the library comprises members encoding diverse LC variable regions.

In some embodiments, the members comprising a LC variable region comprise an A27 LC framework.

In some embodiments, the library is a display library, e.g., a phage display library.

In some embodiments, the library has at least 10⁴, 10⁵ 10⁶, 10⁷, 10⁸, 10⁹ 10¹⁰, 10¹¹, or 3.×10¹¹ diverse members.

In some aspects, the disclosure features a library (Biblioteca 13) of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is
X₁-X₂-X₃-X₄-X₅-X₆-X₇-X₈-X₉-X₁₀-X₁₁-X₁₂-X₁₃ (SEQ ID NO: 1258) wherein:
X₁ is D, G, V, E, A, S, R, L, T, H, P, or Δ, e.g., in the ratios for D:G:V:E:A:S:R:L:T:H:P:Δ of 214:192:92:90:86:52:50:39:32:32:25:* (ORCBU);
X₂ is G, R, P, L, S, A, V, T, K, D, Q, or Δ, e.g., in the ratios for G:R:P:L:S:A:V:T:K:D:Q:Δ of 171:153:107:83:81:51:40:40:34:32:30:* (ORCBU);
X₃ is G, P, R, S, T, W, A, D, L, E, or K, e.g., in the ratios for G:P:R:S:T:W:A:D:L:E:K of 10:1:1:1:1:1:1:1:1:1:1 (ORCBU);
X₄ is Y, G, D, R, S, F, A, V, P, L, or E, e.g., in the ratios for Y:G:D:R:S:F:A:V:P:L:E of 10:1:1:1:1:1:1:1:1:1:1 (ORCBU);
X₅ is S;
X₆ is S;
X₇ is S, G, R, D, N, P, A, V, Y, T, or L, e.g., in the ratios for S:G:R:D:N:P:A:V:Y:T:L of 10:10:1:1:1:1:1:1:1:1:1 (ORCBU);
X₈ is W;
X₉ is Y, S, G, D, P, R, A, F, H, K, or T, e.g., in the ratios for Y:S:G:D:P:R:A:F:H:K:T of 10:1:1:1:1:1:1:1:1:1:1 (ORCBU);
X₁₀ is Y, P, S, G, R, L, T, F, A, D, or K, e.g., in the ratios for Y:P:S:G:R:L:T:F:A:D:K of 10:1:1:1:1:1:1:1:1:1:1 (ORCBU) or X₁₀ is Y, P, S, G, R, L, T, F, A, D, K, or Δ in the ratios for Y:P:S:G:R:L:T:F:A:D:K:Δ of 10:1:1:1:1:1:1:1:1:1:1:* (ORCBU);
X₁₁ is F;
X₁₂ is D; and
X₁₃ is L.

The length distribution can be, e.g., Len10:Len11:Len12:Len13::n1:n2:n3:n4. In some embodiments n1=n2=n3=n4=1. In some embodiments, n1=1, n2=2, n3=4, and n4=8. The proportion of Δ at each deleteable position is determined by the length distribution under the rule that each deleteable position is deleted with equal frequency.

In some embodiments, X₁₀ is Y, P, S, G, R, L, T, F, A, D, or K, e.g., in the ratios for Y:P:S:G:R:L:T:F:A:D:K of 10:1:1:1:1:1:1:1:1:1:1 (ORCBU).

In some embodiments, X₁₀ is Y, P, S, G, R, L, T, F, A, D, K, or Δ, e.g., in the ratios for Y:P:S:G:R:L:T:F:A:D:K:Δ of 10:1:1:1:1:1:1:1:1:1:1:* (ORCBU).

In some embodiments, the members comprise a framework region 4 (FR4) and the FR4 is identical to JH2.

In some embodiments, the diversity is greater than 1.E6. In some embodiments, the diversity is 2.3E7.

In some embodiments, the library comprises diversity in light chain (LC) CDR1, CDR2, and/or CDR3. In some embodiments, the members comprise diversity in light chain (LC) CDR1, CDR2, and/or CDR3.

In some embodiments, the members comprise diversity in HC CDR1 and/or CDR2.

In some embodiments, the members comprise a HC FR3 region.

In some embodiments, the final position of the HC FR3 region is Lys.

In some embodiments, the library is prepared by wobbling.

In some embodiments, the library is prepared by dobbling.

In some embodiments, the members further encode framework (FR) regions 1-4. In some embodiments, the FR regions 1-4 correspond to FR regions 1-4 from 3-23.

In some embodiments, the members encode HC CDR1, HC CDR2 and FR regions 1-4.

In some embodiments, the members comprise a 3-23 HC framework

In some embodiments, the library further comprises a LC variable region.

In some embodiments, the library comprises members encoding diverse LC variable regions.

In some embodiments, the members comprising a LC variable region comprise an A27 LC framework.

In some embodiments, the library is a display library, e.g., a phage display library.

In some embodiments, the library has at least 10⁴, 10⁵ 10⁶, 10⁷, 10⁸, 10⁹ 10¹⁰, 10¹¹ diverse members.

In some aspects, the disclosure features a library (Biblioteca 14) of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is
X₁-X₂-X₃-X₄-X₅-X₆-X₇-X₈-X₉-X₁₀-X₁₁-X₁₂-X₁₃-X₁₄-X₁₅-X₁₆-X₁₇ (SEQ ID NO: 1259) wherein:
X₁ is D, G, V, E, A, S, R, L, T, H, P, or Δ (absent), e.g., in the ratios for D:G:V:E:A:S:R:L:T:H:P:Δ of 214:192:92:90:86:52:50:39:32:32:25:* (ORCBU);
X₂ is G, R, P, L, S, A, V, T, K, D, Q, or Δ, e.g., in the ratios for G:R:P:L:S:A:V:T:K:D:Q:Δ of 171:153:107:83:81:51:40:40:34:32:30:* (ORCBU);
X₃ is G, R, P, S, T, E, H, V, Y, A, L, or Δ, e.g., in the ratios for G:R:P:S:T:E:H:V:Y:A:L:Δ of 20:1:1:1:1:1:1:1:1:1:1:* (ORCBU);
X₄ is Y, D, G, H, P, N, R, S, V, A, or L, e.g., in the ratios for Y:D:G:H:P:N:R:S:V:A:L of 20:1:1:1:1:1:1:1:1:1:1 (ORCBU);
X₅ is Cys;
X₆ is S, G, D, R, T, Y, F, L, N, V, or W, e.g., in the ratios for S:G:D:R:T:Y:F:L:N:V:W of 20:1:1:1:1:1:1:1:1:1:1 (ORCBU);
X₇ is G, S, D, R, T, Y, F, L, N, V, or W, e.g., in the ratios for G:S:D:R:T:Y:F:L:N:V:W of 20:20:1:1:1:1:1:1:1:1:1 (ORCBU);
X₈ is G, T, D, R, S, Y, F, L, N, V, or W, e.g., in the ratios for G:T:D:R:S:Y:F:L:N:V:W of 20:20:1:1:1:1:1:1:1:1:1 (ORCBU);
X₉ is S, G, T, D, R, Y, F, L, N, V, or W, e.g., in the ratios for S:G:T:D:R:Y:F:L:N:V:W of 20:1:1:1:1:1:1:1:1:1:1 (ORCBU);
X₁₀ is Cys;
X₁₁ is Y, F, W, D, R, S, H, A, L, N, or K, e.g., in the ratios for Y:F:W:D:R:S:H:A:L:N:K of 20:1:1:1:1:1:1:1:1:1:1 (ORCBU);
X₁₂ is S, G, T, R, A, D, Y, W, P, L, F, or Δ, e.g., in the ratios for S:G:T:R:A:D:Y:W:P:L:F:Δ of 20:1:1:1:1:1:1:1:1:1:1:* (ORCBU);
X₁₃ is G, R, S, L, D, P, A, T, F, I, Y, or Δ, e.g., in the ratios for G:R:S:L:D:P:A:T:F:I:Y:Δ of 5:1:1:1:1:1:1:1:1:1:1:* (ORCBU);
X₁₄ is the same as X₁₃;
X₁₅ is F;
X₁₆ is D; and
X₁₇ is L.

The length distribution can be, e.g., Len12:Len13:Len14:Len15:Len16:Len17::n1:n2:n3:n4:n5:n6. In some embodiments, n1=n2=n3=n4=n5=n6-1. In some embodiments, n1-10, n2-10, n3-8, n4-8, n5-6, and n6=3. The fraction of Δ at each deleteable position is determined by the length distribution under the rule that each deleteable position is deleted with equal frequency.

In some embodiments, the members comprise a framework region 4 (FR4) and the FR4 is identical to JH2.

In some embodiments, the diversity is greater than 1.E6. In some embodiments, the diversity is 1.E9.

In some embodiments, the diversity is 1.E10.

In some embodiments, the library comprises diversity in light chain (LC) CDR1, CDR2, and/or CDR3. In some embodiments, the members comprise diversity in light chain (LC) CDR1, CDR2, and/or CDR3.

In some embodiments, the members comprise diversity in HC CDR1 and/or CDR2.

In some embodiments, the members comprise a HC FR3 region.

In some embodiments, the final position of the HC FR3 region is Lys.

In some embodiments, the library is prepared by wobbling.

In some embodiments, the library is prepared by dobbling.

In some embodiments, the members further encode framework (FR) regions 1-4. In some embodiments, the FR regions 1-4 correspond to FR regions 1-4 from 3-23.

In some embodiments, the members encode HC CDR1, HC CDR2 and FR regions 1-4.

In some embodiments, the members comprise a 3-23 HC framework

In some embodiments, the library further comprises a LC variable region.

In some embodiments, the library comprises members encoding diverse LC variable regions.

In some embodiments, the members comprising a LC variable region comprise an A27 LC framework.

In some embodiments, the library is a display library, e.g., a phage display library.

In some embodiments, the library has at least 10⁴, 10⁵ 10⁶, 10⁷, 10⁸, 10⁹ 10¹⁰, 10¹¹ diverse members.

In some aspects, the disclosure features a library of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode a heavy chain CDR3 and the HC CDR3s of the library are a combination of the HC CDR3 libraries described herein. For example, the library comprises (or consists of) members having HC CDR3s from Biblioteca 5, Biblioteca 6, Biblioteca 99, Biblioteca 100, Biblioteca 101, Biblioteca 102, Biblioteca 7, Biblioteca 8, Biblioteca 9, Biblioteca 10, Biblioteca 11, Biblioteca 12, Biblioteca 13 and/or Biblioteca 14. In one embodiment, the members of the library have a HC CDR3 from: Biblioteca 5, 6 and 7; Biblioteca 6, 99 and 100; Biblioteca 99, 100, and 101; Biblioteca 100, 101 and 102; Biblioteca 7, 8 and 9; Biblioteca 10, 11 and 12; and Biblioteca 12, 13 and 14.

In some embodiments, the members comprise a framework region 4 (FR4) and the FR4 is identical to JH2.

In some embodiments, the diversity is greater than 1.E6. In some embodiments, the diversity is 1.E9.

In some embodiments, the diversity is 1.E10.

In some embodiments, the library comprises diversity in light chain (LC) CDR1, CDR2, and/or CDR3. In some embodiments, the members comprise diversity in light chain (LC) CDR1, CDR2, and/or CDR3.

In some embodiments, the members comprise diversity in HC CDR1 and/or CDR2.

In some embodiments, the members comprise a HC FR3 region.

In some embodiments, the final position of the HC FR3 region is Lys.

In some embodiments, the library is prepared by wobbling.

In some embodiments, the library is prepared by dobbling.

In some embodiments, the members further encode framework (FR) regions 1-4. In some embodiments, the FR regions 1-4 correspond to FR regions 1-4 from 3-23.

In some embodiments, the members encode HC CDR1, HC CDR2 and FR regions 1-4.

In some embodiments, the members comprise a 3-23 HC framework

In some embodiments, the library further comprises a LC variable region.

In some embodiments, the library comprises members encoding diverse LC variable regions.

In some embodiments, the members comprising a LC variable region comprise an A27 LC framework.

In some embodiments, the library is a display library, e.g., a phage display library.

In some embodiments, the library has at least 10⁴, 10⁵ 10⁶, 10⁷, 10⁸, 10⁹ 10¹⁰, 10¹¹ diverse members.

In some aspects, the disclosure features a library described herein, e.g., a library described in the Examples.

Provided also are methods of making and screening the above libraries and the HC CDR3s and antibodies obtained in such screening. Compositions and kits for the practice of these methods are also described herein.

In some aspects, the disclosure features a focused library of vectors or genetic packages that display, display and express, or comprise a member of a diverse family of human antibody peptides, polypeptides and proteins (e.g., a diverse family of antibodies) and collectively display, display and express, or comprise at least a portion of the diversity of the family, wherein the vectors or genetic packages comprise variegated DNA sequences that encode a heavy chain (HC) CDR3, e.g., a HC CDR3 described herein.

In some embodiments, the HC CDR3 comprises amino acids from a D region (e.g., a diversified D region) (or fragment thereof (e.g., 3 or more amino acids of the D region, e.g., diversified D region)) and/or a JH region (e.g., an extended JH region). In some embodiments, the HC CDR3 comprises zero to four VD fill residues, 3 to 10 residues from a D region, zero to four DJ fill residues, and zero to nine Jstump residues. In some embodiments, the 3 to 10 residues from a D region are variegated. In some embodiments, the variegation is such that the amino-acid type from the D region is the most common type at that position.

In some embodiments, the library (e.g., the vectors or genetic packages thereof) comprises a D region or a fragment of a D region (e.g., wherein the D region is adjacent to a JH region).

In some embodiments, the library comprises a JH region, e.g., an extended JH region. In other embodiments, only the FR4 portion of JH is included.

In some embodiments, the HC CDR3 comprises amino acids from a D region or a fragment of a D region (e.g., wherein the D region is adjacent to a JH region).

In some embodiments, the D region is selected from the group consisting of D3-22.2, D3-3.2, D6-19.1, D3-10.2, D6-13.1, D5-18.3, D3-10.1, D6-13.2, D1-26.3, D3-10.1, D3-16.2, D4-17.2, D6-19.2, D3-10.3, D3-9.2, D5-12.3, D2-15.2, D6-6.1, D1-26.1, D2-2.2, D6-6.2, D2-2.3, D4-23.2, D5-24.3, D3-3.3, D3-3.1, D1-7.3, and D6-19.3.

In some embodiments that contain a D segment, a fragment of a D segment, a variegated D segment, or a variegated fragment of a D segment, there is VD fill between FR3 and the D segment or fragment thereof. In some embodiments that contain a D segment, a fragment of a D segment, a variegated D segment, or a variegated fragment of a D segment, there is no VD fill between FR3 and the D segment or fragment thereof.

In some embodiments that contain a D segment, a fragment of a D segment, a variegated D segment, or a variegated fragment of a D segment, there is DJ fill between D segment or fragment thereof and the JH region. In some embodiments that contain a D segment, a fragment of a D segment, a variegated D segment, or a variegated fragment of a D segment, there is DJ fill between D segment or fragment thereof and the JH region.

In one embodiment, the library comprises several sublibraries. For example, the library may comprise a sublibrary of, for example, 5×10⁹ diversity having:

1) a sampling from a pool of, for example, 10⁹ LCs, such as a diversified VKIII A27 LC,
2) a sampling from a pool of, for example, 10⁸ HC CDR1s and CDR2s, and
3) a HC CDR3 diversity (Biblioteca 15) comprising FR3::X1-X2-X3-X4-X5-X6-X7-X8-X9-X10-X11-X12-X13::FR4 where X1- . . . -X6 are allowed to have the amino acids observed in natural VJ fill regions, X7-X8-X9-X10 are either from VJ fill or are absent, and X11-X13 correspond to residues 7, 8, and 9 of the Jstump of the JH that is used to form FR4. This component has CDR3 lengths of 10, 11, 12, and 13 in a ratio that may be picked. For example, the ratio can be set at 1:2:2;2. A second component is formed from the same pools for LC and HC CDR1&2 while HC CDR3 has (Biblioteca 16) the form FR3::X1-X2-X3-X4-X5-X6-X7-X8-X9-X10-X11-X12-X13-X14-X15-X16::FR4 where X1-X2 are taken from VD fill distributions or each can be independently absent, X3-X11 are a variegated D segment, X12-X13 are taken from DJ fill distribution or may each be absent, and X14-X15-X16 are, for example, the J stump of JH4, and the FR4 matches JH4. A third component (Biblioteca 16) could have a different D segment and a different distribution of VD and DJ fill residues.

In some embodiments, the HC CDR3 comprises amino acids from a JH region. The JH region may be an extended JH region. In some embodiments, the extended JH region is selected from the group consisting of JH1, JH2, JH3, JH4, JH5, and JH6.

In some embodiments, the D region comprises one or more cysteine (Cys) residues and in some embodiments, the one or more Cys residues are held constant (e.g., are not varied).

In some embodiments, the HC CDR3 (e.g., the DNA encoding the HC CDR3) comprises one or more VD fill codons between FR3 and the D region and each VD fill codon is individually NNK, TMY, TMT, or TMC (TMY, TMT, or TMC encode S or Y).

In some embodiments, the HC CDR3 (e.g., the DNA encoding the HC CDR3) comprises one or more filling codons between the D region and JH and each filling codon is individually NNK, TMY, TMT, or TMC.

In some embodiments, the library (e.g., the vectors or genetic packages of the library) further comprises a HC CDR1, HC CDR2, and/or a light chain and also comprises diversity in the HC CDR1, HC CDR2, or light chain comprises diversity in HC CDR1 and/or HC CDR2, and/or a light chain (e.g., kappa or lambda light chain) (respectively). For example, HC CDR3 diversity can be constructed in the background of diversity in HC CDR1, HC CDR2, and/or light chain (LC) CDR1, LC, CDR2, and/or LC CDR3 (e.g., a library member can contain diversity in HC CDR3 and diversity in HC CDR1 and/or HC CDR2, and/or in LC CDR1, LC CDR2, and/or LC CDR3). For example, the light-chain diversity may be encoded in the same DNA molecule as the HC diversity or the LC and HC diversities may be encoded in separate DNA molecules.

In some aspects, the disclosure provides a method of diversifying a library, the method comprising mutagenizing a library described herein.

In some embodiments, the mutagenizing comprises error-prone PCR.

In some embodiments, the mutagenizing comprises wobbling.

In some embodiments, the mutagenizing comprises dobbling (defined below).

In some embodiments, the mutagenizing introduces on average about 1 to about 10 mutations (e.g., about 1, about 2, about 3, about 4, about 5, about 6, about 7, about 8, about 9, about 10 mutations; e.g., base changes) per HC CDR3.

“Wobbling” is a method of making variegated DNA so that an original sequence is favored. If the original sequence had, for example, an Ala that could be encoded with GCT the mixture (0.7 G, 0.1 A, 0.1 T, 0.1 C) can be used for the first position, (0.7 C, 0.1 A, 0.1 T, 0.1 G) at the second position, and (0.7 T, 0.1 A, 0.1 G, 0.1 C) at the third. Other ratios of “doping” can be used. This allows Ala to appear about 50% of the time while V, D, G, T, P, and S occur about 7% of the time. Other AA types occur at lower frequency.

In some aspects, the present disclosure is drawn, e.g., to keeping a HC CDR1-2 repertoire (e.g., a purified repertoire), and building synthetic HC CDR3 and/or LC diversity.

In some embodiments, the disclosure provides a cassette for displaying a wobbled heavy chain (HC) CDR3, for example, the cassette comprises the cassette shown in Table 400.

In some aspects, the disclosure features a library of light chains having germline framework regions and wherein the CDRs are varied such that residues remote from the combining site or having buried side groups are held constant. In some embodiments, a method of variable DNA synthesis is used so that germline sequence is the most likely one (e.g., by wobbling).

In some aspects, the disclosure features a library of diverse members encoding antigen binding variable regions as disclosed herein.

In some embodiments, the members further encode framework (FR) regions 1-4. In some embodiments, the FR regions 1-4 correspond to FR regions 1-4 from 3-23.

In some embodiments, the members encode HC CDR1, HC CDR2 and FR regions 1-4.

In some embodiments, the members comprise a 3-23 HC framework

In some embodiments, the library further comprises a LC variable region.

In some embodiments, the library comprises members encoding diverse LC variable regions.

In some embodiments, the members comprising a LC variable region comprise an A27 LC framework.

In some embodiments, the library is a display library, e.g., a phage display library.

In some embodiments, the library has at least 10⁴, 10⁵ 10⁶, 10⁷, 10⁸, 10⁹ 10¹⁰, 10¹¹ diverse members.

In some embodiments, a library of LCs has LC CDR1s of various lengths. In some embodiments, a library of LCs has LC CDR1s of lengths 11 or 12. In some embodiments, a library of LCs has LC CDR2s of various lengths. In some embodiments, a library of LCs has LC CDRs of lengths 7 or 8. In some embodiments, a library of LCs has LC CDR3s of various lengths. In some embodiments, a library of LCs has LC CDR3s of lengths 7, 8, 9, or 10. In some embodiments, the lengths of LC CDR1 and LC CDR3 are varied. In some embodiments, the lengths of LC CDR1, LC CDR2, and LC CDR3 are varied. In some embodiments, seventeen positions of LC CDRs are varied, allowing 11 amino-acid types at each varied position according to the types seen in actual LCs. In some embodiments, the most likely amino-acid type at each varied position is the germline type.

In some embodiments, a library is constructed with pairs of restriction enzymes in which one member of the pair produces a 5′ overhang of at least 4 bases and the other enzyme produces a 3′ overhang of at least four bases.

In some aspects, the disclosure features a method of selecting a library member, comprising, contacting a library described herein with a target, allowing a member to bind to said target, and recovering the member which binds the target.

These embodiments of the present invention, other embodiments, and their features and characteristics will be apparent from the description, drawings, and claims that follow.

### DETAILED DESCRIPTION

Antibodies (“Abs”) concentrate their diversity into those regions that are involved in determining affinity and specificity of the Ab for particular targets. These regions may be diverse in sequence and/or in length. Generally, they are diverse in both ways. However, within families of human antibodies the diversities, both in sequence and in length, are not truly random. Rather, some amino acid residues are preferred at certain positions of the CDRs and some CDR lengths are preferred. These preferred diversities account for the natural diversity of the antibody family.

According to embodiments of this invention, and as more fully described below, libraries of vectors and genetic packages that encode members of a diverse family of human antibodies comprising heavy chain (HC) CDR3s that are between about 3 to about 35 amino acids in length may be prepared and used. The HC CDR3s may also, in certain embodiments, may be rich in Y and S and/or comprise diversified D regions. Also provided are focused libraries comprising such HC CDR3s.

When an immune cell constructs an antibody heavy chain, it connects a V segment to a D segment and that to a J segment. The D segment is optional and about 50% of human Abs have recognizable Ds. The cell may perform considerable editing at the junction sites (V-to-D, D-to-J, or V-to-J) both removing and adding bases, but not exactly randomly. The initially rearranged antibody is presented on the surface of the cell and if it binds an antigen (Ag), the cell is stimulated to perform somatic mutations to improve the affinity. There are hot spots encoded in the immunoglobulin germline genes so that certain places in the Ab gene are very likely to go through a particular set of mutations in search of a better binder to a persistent Ag. In nature, some of the mutations are in framework positions but most are in the complementarity determining regions (CDRs). Of particular interest is the CDR3 of the heavy chain (HC) because it shows not only a high degree of sequence diversity but also length diversity. Antibody (Ab) libraries have been built in which the CDRs are replaced with random DNA, and useful Abs have been obtained. However, some therapeutic Abs show a significant degree of antigenicity. It is possible that Abs that are closer to human germline would be less antigenic.

### DEFINITIONS

The amino-acid sequences encoded by D regions and their frequencies of use are shown in Table 20. The D region genes have names such as “D3-3”. These can be used in any of the three forward reading frames. The amino-acid sequences have names such as “D3-3.2” or “D3-3(2)” (to show use of the second reading frame). The terms “D region” and “D segments” are used interchangeably to mean either the DNA or the amino-acid sequences that are encoded by the diversity regions of the human immunoglobulin genes.

For convenience, before further description of the present invention, certain terms employed in the specification, examples and appended claims are defined here.

The singular forms “a”, “an”, and “the” include plural references unless the context clearly dictates otherwise.

The term “affinity” or “binding affinity” refers to the apparent association constant or Kₐ. The Kₐ is the reciprocal of the dissociation constant (K_{d}). A binding protein may, for example, have a binding affinity of at least 10⁵, 10⁶, 10⁷,10⁸, 10⁹, 10¹⁰ and 10¹¹ M⁻¹ for a particular target molecule. Higher affinity binding of a binding protein to a first target relative to a second target can be indicated by a higher K_{A} (or a smaller numerical value K_{D}) for binding the first target than the K_{A} (or numerical value K_{D}) for binding the second target. In such cases, the binding protein has specificity for the first target (e.g., a protein in a first conformation or mimic thereof) relative to the second target (e.g., the same protein in a second conformation or mimic thereof; or a second protein). Differences in binding affinity (e.g., for specificity or other comparisons) can be at least 1.5, 2, 3, 4, 5, 10, 15, 20, 37.5, 50, 70, 80, 91, 100, 500, 1000, or 10⁵ fold.

Binding affinity can be determined by a variety of methods including equilibrium dialysis, equilibrium binding, gel filtration, ELISA, surface act cc resonance, or spectroscopy (e.g., using a fluorescence assay). Exemplary conditions for evaluating binding affinity are in TRIS-buffer (50 mM TRIS, 150 mM NaCl, 5 mM CaCl₂ at pH7.5). These techniques can be used to measure the concentration of bound and free binding protein as a function of binding protein (or target) concentration. The concentration of bound binding protein ([Bound]) is related to the concentration of free binding protein ([Free]) and the concentration of binding sites for the binding protein on the target where (N) is the number of binding sites per target molecule by the following equation:

[Bound]=N·[Free]/((1/K_{A})+[Free]).

It is not always necessary to make an exact determination of K_{A}, though, since sometimes it is sufficient to obtain a quantitative measurement of affinity, e.g., determined using a method such as ELISA or FACS analysis, is proportional to K_{A}, and thus can be used for comparisons, such as determining whether a higher affinity is, e.g., 2-fold higher, to obtain a qualitative measurement of affinity, or to obtain an inference of affinity, e.g., by activity in a functional assay, e.g., an in vitro or in vivo assay.

The term “antibody” refers to a protein that includes at least one immunoglobulin variable domain or immunoglobulin variable domain sequence. For example, an antibody can include a heavy (H) chain variable region (abbreviated herein as VH), and a light (L) chain variable region (abbreviated herein as VL). In another example, an antibody includes two heavy (H) chain variable regions and two light (L) chain variable regions. Heavy chain and light chain may also be abbreviated as HC and LC, respectively. The term “antibody” encompasses antigen-binding fragments of antibodies (e.g., single chain antibodies, Fab and sFab fragments, F(ab′)₂, Fd fragments, Fv fragments, scFv, and domain antibodies (dAb) fragments (de Wildt et al., Eur J Immunol. 1996; 26(3):629-39.)) as well as complete antibodies. An antibody can have the structural features of IgA, IgG, IgE, IgD, IgM (as well as subtypes thereof). Antibodies may be from any source, but primate (human and non-human primate) and primatized are preferred.

The VH and VL regions can be further subdivided into regions of hypervariability, termed “complementarity determining regions” (“CDR”), interspersed with regions that are more conserved, termed “framework regions” (“FR”). The extent of the framework region and CDRs has been precisely defined (see, Kabat, E. A., et al. (1991) Sequences of Proteins of Immunological Interest, Fifth Edition, U.S. Department of Health and Human Services, NIH Publication No. 91-3242, and Chothia, C. et al. (1987) J. Mol. Biol. 196:901-917, see also www.hgmp.mrc.ac.uk). Kabat definitions are used herein. Each VH and VL is typically composed of three CDRs and four FRs, arranged from amino-terminus to carboxy-terminus in the following order: FR1, CDR1, FR2, CDR2, FR3, CDR3, FR4.

The VH or VL chain of the antibody can further include all or part of a heavy or light chain constant region, to thereby form a heavy or light immunoglobulin chain, respectively. In one embodiment, the antibody is a tetramer of two heavy immunoglobulin chains and two light immunoglobulin chains, wherein the heavy and light immunoglobulin chains are inter-connected by, e.g., disulfide bonds. In IgGs, the heavy chain constant region includes three immunoglobulin domains, CH1, CH2 and CH3. The light chain constant region includes a CL domain. The variable region of the heavy and light chains contains a binding domain that interacts with an antigen. The constant regions of the antibodies typically mediate the binding of the antibody to host tissues or factors, including various cells of the immune system (e.g., effector cells) and the first component (Clq) of the classical complement system. The light chains of the immunoglobulin may be of types, kappa or lambda. In one embodiment, the antibody is glycosylated. An antibody can be functional for antibody-dependent cytotoxicity and/or complement-mediated cytotoxicity.

One or more regions of an antibody can be human or effectively human. For example, one or more of the variable regions can be human or effectively human. For example, one or more of the CDRs can be human, e.g., HC CDR1, HC CDR2, HC CDR3, LC CDR1, LC CDR2, and LC CDR3. Each of the light chain CDRs can be human. HC CDR3 can be human. One or more of the framework regions can be human, e.g., FR1, FR2, FR3, and FR4 of the HC or LC. For example, the Fc region can be human. In one embodiment, all the framework regions are human, e.g., derived from a human somatic cell, e.g., a hematopoietic cell that produces immunoglobulins or a non-hematopoietic cell. In one embodiment, the human sequences are germline sequences, e.g., encoded by a germline nucleic acid. In one embodiment, the framework (FR) residues of a selected Fab can be converted to the amino-acid type of the corresponding residue in the most similar primate germline gene, especially the human germline gene. One or more of the constant regions can be human or effectively human. For example, at least 70, 75, 80, 85, 90, 92, 95, 98, or 100% of an immunoglobulin variable domain, the constant region, the constant domains (CH1, CH2, CH3, CL), or the entire antibody can be human or effectively human.

All or part of an antibody can be encoded by an immunoglobulin gene or a segment thereof. Exemplary human immunoglobulin genes include the kappa, lambda, alpha (IgA1 and IgA2), gamma (IgG1, IgG2, IgG3, IgG4), delta, epsilon and mu constant region genes, as well as the many immunoglobulin variable region genes. Full-length immunoglobulin “light chains” (about 25 KDa or about 214 amino acids) are encoded by a variable region gene at the NH₂-terminus (about 110 amino acids) and a kappa or lambda constant region gene at the COOH— terminus. Full-length immunoglobulin “heavy chains” (about 50 KDa or about 446 amino acids), are similarly encoded by a variable region gene (about 116 amino acids) and one of the other aforementioned constant region genes, e.g., gamma (encoding about 330 amino acids). The length of human HC varies considerably because HC CDR3 varies from about 3 amino-acid residues to over 35 amino-acid residues.

Herein, the terms “D segment” and “D region” are used interchangeably and are identical. It is to be understood that these items have both DNA and amino-acid representations and that which is meant is clear from the context.

A “library” or “display library” refers to a collection of nucleotide, e.g., DNA, sequences within clones; or a genetically diverse collection of polypeptides displayed on replicable display packages capable of selection or screening to provide an individual polypeptide or a mixed population of polypeptides.

The term “package” as used herein refers to a replicable genetic display package in which the particle is displaying a polypeptide at its surface. The package may be a bacteriophage which displays an antigen binding domain at its surface. This type of package has been called a phage antibody (pAb).

A “pre-determined target” refers to a target molecule whose identity is known prior to using it in any of the disclosed methods.

The term “replicable display package” as used herein refers to a biological particle which has genetic information providing the particle with the ability to replicate. The particle can display on its surface at least part of a polypeptide. The polypeptide can be encoded by genetic information native to the particle and/or artificially placed into the particle or an ancestor of it. The displayed polypeptide may be any member of a specific binding pair e.g., heavy or light chain domains based on an immunoglobulin molecule, an enzyme or a receptor etc. The particle may be, for example, a virus e.g., a bacteriophage such as fd or M13. The particle may be a phagemid.

The term “vector” refers to a DNA molecule, capable of replication in a host organism, into which a gene is inserted to construct a recombinant DNA molecule. A “phage vector” is a vector derived by modification of a phage genome, containing an origin of replication for a bacteriophage, but not one for a plasmid. A “phagemid vector” is a vector derived by modification of a plasmid genome, containing an origin of replication and packaging signal for a bacteriophage as well as the plasmid origin of replication. When a cell that harbors a phagemid is infected with a helper phage, the helper phage genome supplies all the need genes to allow construction of particles that are infectious to F+ E. coli but which, in most cases, contain the phagemid genome. The phagemid also contains display genes so that the encoded Fab or scFv is displayed on the particles. The phagemid serves as a connector between the gene and the protein encoded by the gene.

In discussing oligonucleotides, the notation “[RC]” indicates that the Reverse Complement of the oligonucleotide shown is the one to be used.

### Human Antibody Heavy Chain CDK3s

The heavy chain (“HC”) Germ-Line Gene (GLG) 3-23 (also known as VP-47) accounts for about 12% of all human Abs and is preferred as the framework in the preferred embodiment of the invention. It should, however, be understood that other well-known frameworks, such as 4-34, 3-30, 3-30.3 and 4-30.1, may also be used without departing from the principles of the focused diversities of this invention.

In addition, JH4 (YFDYW₁₀₃GQGTLVTVSS (SEQ ID NO:1)) occurs more often than JH3 in native antibodies. Hence, it is preferred for the focused libraries of this invention. However, JH3 (AFDIW₁₀₃GQGTMVTVSS (SEQ ID NO:2)), JH6 (YYYYYGMDVW₁₀₃GQGTTVTVSS (SEQ ID NO:3)), JH1, JH2, or JH5 could be used as well. JH2 has the advantage of having RG at 105-106 instead of QG in all the other human JHs. JH3 has the disadvantage of M₁₀₈. In a collection of 21,578 Abs that were ELISA positive for at least one target, we saw 828 JH1s, 1,311 JH2s, 5,471 JH3s, 7,917 JH4s, 1,360 JH5s, and 4,701 JH6s by analysis of the DNA sequences. If present, the double underscored portions of the JHs are considered to be part of CDR3. In Table 3, the FR4 parts of the JHs are underscored.

The frequency at which each amino-acid appeared in the HC CDR3s of these 21578 Abs was tabulated and recorded in Table 75 in the columns marked overall and %. Note that the most common amino acid is Tyr (15.6%) with Gly (13.7%), Asp (12.5%), Ser (8.2%), and Arg (5.1%) following in that order. Hence, in one embodiment, the preferred amino-acid types to substitute into HC CDR3s are Y, G, D, S, and R.

Other columns in Table 75 show the frequencies of amino acids when the CDRs are dissected as follows. First the correct JH segment is determined. If part of CDR3 is derived from JH, this is removed as the “J stump”. The remainder is examined for a D segment. When matching the DNA of the D segment a scoring algorithm allots one point for a first match, adds two point for a second consecutive match, three points for a third match and four points for a forth and all subsequent matches. When a mismatch is found, the value of the next match is set back to one. A D segment is identified if more than 9 consecutive matches are found or if the score exceeds 41. With these conditions, 11,149 of 21,578 had a D segment and 10,439 did not.

If there was no D, the CDR3 is divided into VJ fill and Jstump. Note that in VJ fill, Tyr is not enriched and accounts for only 4.6% of the amino acids. In Jstump, Tyr is highly enriched, accounting for 26.5% of the amino acids.

If there is a D region, then the CDR3 is divided into VD fill (possibly empty), D, DJ fill, and Jstump (possibly empty). Tyr is prominent only in the part derived from D and Jstump. Tyr is less than 2% in VD fill and in DJ fill. One the other hand, Gly is prominent in all regions except Jstump.

Table 75 also shows that Cys© and Met (M) are rare. Met rises to the ˜5% level in Jstump even though the commonly used JH6 includes one M (Table 3).

Naturally, HC CDR3s vary in length. About half of human HCs consist of the components: V::nz::D::ny::JHn where V is a V gene, nz is a series of bases that are essentially random, D is a D segment, often with heavy editing at both ends, ny is a series of bases that are essentially random, and JHn is one of the six JH segments, often with heavy editing at the 5′ end. The D segments appear to provide spacer segments that allow folding of the IgG. The greatest diversity is at the junctions of V with D and of D with JH.

Corbett et al. (Corbett S J, Tomlinson I M, Sonnhammer E L, Buck D, Winter G. J Mol. Biol. 1997 V 270:587-97.) showed that the human immune system does not insert multiple D segments and recombing D segments. Nevertheless, D segments have been selected to be good components of HC CDR3s and the present invention comprises HC CDR3 that contain D segment, fragments of D segments, variegated D segments, and variegated fragments of D segments.

Human D segments have some very strong biases. The tally of the 523 amino-acids in human D segments is Y 70 (12.6%), L 63 (11.4%), V 544 (9.7%), G 54 (9.7%), 143 (7.72%), T 42 (7.6%), S 35 (6.3%), W 25 4.5%), D 21 (3.8%), A 22 (4.02%), R 20 (3.6%), TAG 13 (2.3%), N 16 (2.9%), Q 13 (2.3%), C 10 (1.8%), E 10 (1.8%), F 10 (1.8%), M 7 (1.3%), TGA 10 (1.8%), TAA 9 (1.6%), P 5 (0.9%), H 2 (0.4%), and K 1 (0.2%). There is one D (2-8 RF 1) that has an unpaired Cys but also a TGA stop codon, so it is little used. Thus, D segments are primarily hydrophobic. The frequencies of amino acids in human HC CDR3s are shown in Table 75. There are both similarities and differences in the frequencies. In HC CDR3s overall, Tyr is the most common and only Gly comes close (96% as common as Tyr). Asp (75% as common as Tyr), Ser (53% as common as Tyr). Leu, Val, and Ile are relatively common in the D segments if all the D segments are counted as equal. The immune system does not use the D segments with equal frequency. Table 20 shows the frequency of utilization of D segments. The D segments that are often used are very rich in Tyr, Gly, Ser, and Asp. Arg is not found in the most often used D segments nor is Arg encoded in any of the CDR portions of JH segments. Arg comes to prominence either by mutation of V, D, and J or in the filler regions between V and D, D and J, or V and J. In this sample, 50% of all the amino acids are Tyr, Gly, Asp, Ser, or Arg.

In one embodiment of the present invention, substitutions of “parental” HC CDR3 sequences is limited to the set of amino acids consisting of Tyr, Gly, Ser, Asp, and Arg. In one embodiment of the present invention, Arg is made common in the filler regions between V and D, between D and J, or between V and J.

In the preferred libraries of this invention, both types of HC CDR3s are used. In HC CDR3s that have no identifiable D segment, the structure is V::nz::JHn (n=1, 6) where JH is usually edited at the 5′ end. In HC CDR3s that have an identifiable D segment, the structure is V::nz::D::ny::JHn.

Provided herein are HC CDR3s that are between about 3 to about 35 amino acids in length. The HC CDR3s may also, in certain embodiments, be rich in Y and S and/or comprise diversified D regions, where a D region is present. For example, the HC CDR3s may contain between about 43% and about 80% Y and/or S residues, e.g., about 43%, about 48%, about 69%, about 63%, about 71%, about 62%, about 58%, about 68%, about 80%, about 77%, or greater than about 40%, or about 40% to less than about 100%, of the residues are Y and/or S. For example, not all of the residues in the CDR3 are Y and/or S. The HC CDR3s may, in certain embodiments, comprise an extended JH region. Exemplary HC CDR3 component designs of the preferred libraries of this invention are shown and described in Examples 1, 2, and 3.

In some embodiments, diversity (e.g., in a CDR, e.g., HC CDR3, or framework region (e.g., framework region near or adjacent to a CDR, e.g., CDR3, e.g., HC CDR3) is generated to create on average about 1, about 2, about 3, about 4, about 5, about 6, about 7, about 8, about 9, about 10, or about 1 to about 10 mutations (e.g., base change), e.g., per CDR (e.g., HC CDR3) or framework region (e.g., framework region near or adjacent to a CDR, e.g., CDR3, e.g., HC CDR3). In some implementations, the mutagenesis is targeted to regions known or likely to be at the binding interface. Further, mutagenesis can be directed to framework regions near or adjacent to the CDRs. In the case of antibodies, mutagenesis can also be limited to one or a few of the CDRs, e.g., to make precise step-wise improvements. Likewise, if the identified ligands are enzymes, mutagenesis can provide antibodies that are able to bind to the active site and vicinity. The CDR or framework region (e.g., an HC CDR3 described herein) may be, in certain embodiments, subjected to error-prone PCR to generate the diversity. This approach uses a “sloppy” version of PCR, in which the polymerase has a fairly high error rate (up to 2%), to amplify the wild-type sequence, and is generally described in Pritchard, et al. (2005) J. Theor. Biol. 234: 497-509 and Leung et al. (1989) Technique 1:11-15. Other exemplary mutagenesis techniques include DNA shuffling using random cleavage (Stemmer (1994) Nature 389-391; termed “nucleic acid shuffling”), RACHITT™ (Coco et al. (2001) Nature Biotech. 19:354), site-directed mutagenesis (Zoller et al. (1987) Nucl Acids Res 10:6487-6504), cassette mutagenesis (Reidhaar-Olson (1991) Methods Enzymol. 208:564-586) and incorporation of degenerate oligonucleotides (Griffiths et al. (1994) EMBO J. 13:3245).

In some embodiments of the invention, D segments in which half or more of the residues are either Ser or Tyr are picked (e.g. D1-26.3, D2-2.2, D2-15.2, D3-10.2, or D3-22.2). In some embodiments, when the DNA encoding the D region or a portion of the D region is synthesized, each Ser or Tyr residue is encoded by TMT, TMC, or TMY so that the encoded amino acid is either Ser or Tyr. In some embodiments, some or all of the codons for the D region or fragment of the D region are synthesized so that the amino acid of the D region (or fragment thereof) is the most likely codon, but other amino acids are allowed.

In some embodiments, the HC CDR3 sequences described herein may be subjected to selection for open reading frames by fusing the sequence encoding the HC CDR3 of interest in frame to an antibiotic resistance gene, such as Kan^{R} gene and selecting for kanamycin resistance. Cells in which the potential CDR3 has a stop codon or a frame shift will not have the antibiotic resistance and that sequence will be eliminated.

### Methods of Analyzing Antibody Sequences.

Antibody sequences have been obtained from the FAB-310 and FAB-410 libraries which were built using the same diversity pools and described by Hoet et al. (Nat. Biotechnol, 23, pp. 344-8 (2005)). A large collection from about 89 targets was amassed. In one analysis, the amino-acid sequences were examined. A set of 19,051 distinct CDR3 sequences were found, JH sequences were identified, Jstump was removed, D segment were sought, and VJ, VD, Dseg, and DJ distributions were identified. In a second analysis, the DNA of CDR3 and FR4 were examined. A set of 21,578 CDR3::Fr4 fragments were identified. The difference is due to silent mutations that make Abs having different DNA have the same AA sequence. The DNA analysis may be slightly better for some purposes, but the differences are not important and both forms of analysis are valid. Very similar results were obtained with a subset of 1,707 Abs that bound one of ten targets. The larger number added detail, particularly for antibodies with very short CDR3 and for the preference for particular D segments. Even 500 antibodies for 8-10 targets would give much the same picture, especially if all distinct binders were included.

### Methods of Construction of Libraries Comprising Human Antibody Heavy Chain CDR3s and Libraries Comprising Human Antibody Heavy Chain CDR3s

An antibody library is a collection of proteins that include proteins that have at least one immunoglobulin variable domain sequence. For example, camelized variable domains (e.g., VH domains) can be used as a scaffold for a library of proteins that include only one immunoglobulin variable domain sequence. In another example, the proteins include two variable domains sequences, e.g., a VH and VL domain, that are able to pair. An antibody library can be prepared from a nucleic acid library (an antibody-coding library) that includes antibody-coding sequences, e.g., comprising the sequences encoding the HC CDR3s provided herein.

In cases where a display library is used, each member of the antibody-coding library can be associated with the antibody that it encodes. In the case of phage display, the antibody protein is physically associated (directly or indirectly) with a phage coat protein. A typical antibody display library member displays a polypeptide that includes a VH domain and a VL domain. The display library member can display the antibody as a Fab fragment (e.g., using two polypeptide chains) or a single chain Fv (e.g., using a single polypeptide chain). Other formats can also be used.

As in the case of the Fab and other formats, the displayed antibody can include one or more constant regions as part of a light and/or heavy chain. In one embodiment, each chain includes one constant region, e.g., as in the case of a Fab. In other embodiments, additional constant regions are included. It is also possible to add one or more constant regions to a molecule after it is identified as having useful antigen binding site. See, e.g., US 2003-0224408.

Antibody libraries can be constructed by a number of processes (see, e.g., de Haard et al. (1999) J. Biol. Chem 274:18218-30; Hoogenboom et al. (1998) Immunotechnology 4:1-20, Hoogenboom et al. (2000) Immunol Today 21:371-8, and Hoet et al. (2005) Nat Biotechnol. 23(3):344-8.

In certain embodiments for constructing libraries, the heavy chains comprising the CDR3s described herein and the kappa and lambda light chains are best constructed in separate vectors. First, a synthetic gene is designed to embody each of the synthetic variable domains. The light chains may be bounded by restriction sites for ApaLI (positioned at the very end of the signal sequence) or a SpeI site (positioned in the signal sequence) and AscI (positioned after the stop codon). The heavy chain may be bounded by SfiI (positioned within the Pe1B signal sequence) and NotI (positioned in the linker between CH1 and the anchor protein). Signal sequences other than Pe1B may also be used, e.g., a M13 pIII signal sequence.

The initial genes may be made with “stuffer” sequences in place of the desired CDRs. A “stuffer” is a sequence that is to be cut away and replaced by diverse DNA, but which does not allow expression of a functional antibody gene. For example, the stuffer may contain several stop codons and restriction sites that will not occur in the correct finished library vector. Stutters are used to avoid have any one CDR sequence highly represented.

In another embodiment of the present invention, the heavy chain and the kappa or lambda light chains are constructed in a single vector or genetic packages (e.g., for display or display and expression) having appropriate restriction sites that allow cloning of these chains. The processes to construct such vectors are well known and widely used in the art. Preferably, a heavy chain and kappa light chain library and a heavy chain and lambda light chain library would be prepared separately.

Most preferably, the display is on the surface of a derivative of M13 phage. A preferred vector contains all the genes of M13, an antibiotic resistance gene, and the display cassette. The preferred vector is provided with restriction sites that allow introduction and excision of members of the diverse family of genes, as cassettes. The preferred vector is stable against rearrangement under the growth conditions used to amplify phage.

In another preferred embodiment of this invention, the diversity captured by the methods of the present invention may be displayed and/or expressed in a phagemid vector (e.g., pMID21 (DNA sequence shown in Table 35)) that displays and/or expresses the peptide, polypeptide or protein. Such vectors may also be used to store the diversity for subsequent display and/or expression using other vectors or phage.

In still other embodiments, a method termed the Rapid Optimization of LIght Chains or “ROLIC”, described in U.S. Ser. No. 61/028,265 filed Feb. 13, 2008, U.S. Ser. No. 61/043,938 filed Apr. 10, 2008, and U.S. Ser. No. 12/371,000 filed Feb. 13, 2009, a large population of LCs is placed in a phage vector that causes them to be displayed on phage. A small population (e.g., 3, 10, or 25) of HCs are cloned into E. coli so that the HCs are secreted into the periplasm, e.g., those HCs having the CDR3s described herein. The E. coli are then infected with the phage vectors encoding the large population of LCs to produce the HC/LC protein pairings on the phage. The phage particles carry only a LC gene.

In another aspect, in a method termed the Economical Selection of Heavy Chains or “ESCH”, also described in U.S. Ser. No. 61/028,265 filed Feb. 13, 2008, U.S. Ser. No. 61/043,938 filed Apr. 10, 2008, and U.S. Ser. No. 12/371,000 filed Feb. 13, 2009, a small population of LCs may be placed in a vector that causes them to be secreted. A new library of HCs in phage is constructed, such as those provided herein comprising the CDR3s. The LCs and HCs can then be combined by the much more efficient method of infection. Once a small set of effective HC are selected, these can be used as is, fed into ROLIC to obtain an optimal HC/LC pairing, or cloned into a Fab library of LCs for classical selection.

In another embodiment of this invention, the diversity captured by the methods of the present invention may be displayed and/or expressed using a vector suitable for expression in a eukaryotic cell, e.g., a yeast vector, e.g., for expression in a yeast cell.

Other types of protein display include cell-based display (see, e.g., WO 03/029,456); ribosome display (see, e.g., Mattheakis et al. (1994) Proc. Natl. Acad. Sci. USA 91:9022 and Hanes et al. (2000) Nat Biotechnol. 18:1287-92); protein-nucleic acid fusions (see, e.g., U.S. Pat. No. 6,207,446); and immobilization to a non-biological tag (see, e.g., U.S. Pat. No. 5,874,214).

Antibodies isolated from the libraries of the present disclosure may be analyzed to determine the type of the LC and the closest germline gene. In a preferred embodiment, non-germline framework residues are changed back to the germline amino acid so long as binding affinity and specificity are not adversely affected to an unacceptable extent. The substitutions may be done as a group or singly. Human germline sequences are disclosed in Tomlinson, I. A. et al., 1992, J. Mol. Biol. 227:776-798; Cook, G. P. et al., 1995, Immunol. Today 16 (5): 237-242; Chothia, D. et al., 1992, J. Mol. Bio. 227:799-817. The V BASE directory provides a comprehensive directory of human immunoglobulin variable region sequences (compiled by Tomlinson, I. A. et al. MRC Centre for Protein Engineering, Cambridge, UK). Antibodies are “germlined” by reverting one or more non-germline amino acids in framework regions to corresponding germline amino acids of the antibody, so long as binding properties are substantially retained. Similar methods can also be used in the constant region, e.g., in constant immunoglobulin domains.

For example, an antibody can include one, two, three, or more amino acid substitutions, e.g., in a framework, CDR, or constant region, to make it more similar to a reference germline sequence. One exemplary germlining method can include identifying one or more germline sequences that are similar (e.g., most similar in a particular database) to the sequence of the isolated antibody. Mutations (at the amino acid level) are then made in the isolated antibody, either incrementally or in combination with other mutations. For example, a nucleic acid library that includes sequences encoding some or all possible germline mutations is made. The mutated antibodies are then evaluated, e.g., to identify an antibody that has one or more additional germline residues relative to the isolated antibody and that is still useful (e.g., has a functional activity). In one embodiment, as many germline residues are introduced into an isolated antibody as possible.

In one embodiment, mutagenesis is used to substitute or insert one or more germline residues into a framework and/or constant region. For example, a germline framework and/or constant region residue can be from a germline sequence that is similar (e.g., most similar) to the non-variable region being modified. After mutagenesis, activity (e.g., binding or other functional activity) of the antibody can be evaluated to determine if the germline residue or residues are tolerated (i.e., do not abrogate activity). Similar mutagenesis can be performed in the framework regions.

Selecting a germline sequence can be performed in different ways. For example, a germline sequence can be selected if it meets a predetermined criteria for selectivity or similarity, e.g., at least a certain percentage identity, e.g., at least 75, 80, 85, 90, 91, 92, 93, 94, 95, 96, 97, 98, 99, or 99.5% identity. The selection can be performed using at least 2, 3, 5, or 10 germline sequences. In the case of CDR1 and CDR2, identifying a similar germline sequence can include selecting one such sequence. In the case of CDR3, identifying a similar germline sequence can include selecting one such sequence, but may include using two germline sequences that separately contribute to the amino-terminal portion and the carboxy-terminal portion. In other implementations, more than one or two germline sequences are used, e.g., to form a consensus sequence.

### CDR1, CDR2, and Light-Chain Diversity

It is to be understood that the libraries of HC CDR3 are constructed in the background of diversity in HC CDR1, HC CDR2, and light chains. The light-chain diversity may be encoded in the same DNA molecule as the HC diversity or the LC and HC diversities may be encoded in separate DNA molecules. In Table 22 the fusion of a signal sequence::VH::CH1::His6::Myc::IIIstump (“His6” disclosed as SEQ ID NO: 1266). CDR1 comprises residues 31-35; there is diversity at residues 31, 33, and 35. In one embodiment, residues 31, 33, and 35 can be any amino-acid type except cysteine. CDR2 comprises residues 50 through 65. There is diversity at positions 50, 52, 52a, 56, and 58. In one embodiment, residues 50, and 52 can be any of the types Ser, Gly, Val, Trp, Arg, Tyr; residue 52a can be Pro or Ser and residues 56 and 58 can be any amino-acid type except Cys. The diversity of HC CDR3 is cloned into a diversity of HC CDR1 and 2 that is at least 1.E4, 1.E5, 1.E6, 1.E7, 5.E7, or 1.E8.

In one embodiment, residues 31, 33, 35, 50, 52, 56, and 58 can be any amino-acid type except Cys or Met and residue 52a can be Gly, Ser, Pro, or Tyr. The diversity of HC CDR3 is cloned into a diversity of HC CDR1 and 2 that is at least 1.E4, 1.E5, 1.E6, 1.E7, 5.E7, or 1.E8.

In one embodiment, the diversity of the HC is cloned into a vector (phage or phagemid) that contains a diversity of light chains. This diversity is at least 25, 50, 100, 500, 1.E3, 1.E4, 1.E5, 1.E6, or 1.E7. The diversity of HC CDR3 is at least 221, 272, 500, 1000, 1.E4, 1.E5, 1.E6, 1.E7, 1.E8, or 1.E9.

In one embodiment, the diversity of the HC is cloned into a phage vector that displays the HC on a phage protein such as III, VIII, VII, VI, or IX or a fragment of one of these sufficient to cause display and light chains are combined with the HC by infecting a cell collection wherein each cell secrets a light chain. The diversity of the light chains in the cells is at least 5, 10, 15, 20, 25, 30, 35, 40, 50, 75, or 100. The diversity of HC CDR3 is at least 221, 272, 500, 1000, 1.E4, 1.E5, 1.E6, 1.E7, 1.E8, or 1.E9.

Table 30 shows the sequence of the phage vector DY3FHC87 (SEQ ID NO:894) which carries a bla gene, a display cassette for heavy chains under control of a P_{lac} promoter. DY3FHC87 contains all the genes of M13 as well. Infecting F+ E. coli cells that harbor a diversity of light chains in a vector such as pLCSK23 (Sequence in Table 40) (SEQ ID NO:896). The vector pLCSK23 carries a Kan^{R} gene. Under the control of Plac promoter, there is a gene beginning at base 2215 having a signal sequence (bases 2215-2277), a VL (in this sequence the VL encodes the sequence shown in (SEQ ID NO:897) from base 2278 to base 2598, Ckappa from base 2599 to 2922, a linker that allows an NotI site from 2923 to 2931, and a V5 tag (bases 2932-2973). There are an SfiI site at 2259-2271 and a KpnI site at 2602-2605 to allow easy replacement of Vkappas. (SEQ ID NO:897) is an example of the proteins that are secreted. It is to be understood that CKappa and the V5 tag are constant. All of the proteins shown in Table 19 (VK1O2gl-JK3, VK1O2var1, VK1O2var2, VK1O2var3, VK1O2var4, VK1O2var5, VK3L6gl-JK4, VK3L6var1, VK3L6var2, VK3L6var3, VK3L6var4, VK3L6var5, VK3L6var6, VK3L6var7, VK3L6var8, VK3A27gl-JK3, VK3A27var1, VK3A27var2, VK3A27var3, VK3A27var4, VK3A27var5, VK3A27var6, VK3A27var7, VK3L2gl-JK3, and VK1glL8-JK5) will have these sequences attached at the carboxy end.

### Light Chain Diversity

Table 800 shows a kappa LC (light chain) that is known to pair well with 3-23 and with five CDR mutations with one HC based on 3-23, LC K1(O12)::JK1 makes a high affinity Ab to a protein target. O12 is a frequently used VKI. The gene has been designed to have useful, distinct restriction sites in the signal sequence (ApaLI), FR1 (XhoI, SgfI), FR2 (KpnI), FR3(XbaI), and Fr4::Ckappa (BsiWI) so that each CDR and be replaced with a varied population.

Table 3001 shows the frequency of use of each of the human JKs in 1483 LC having A27 VKs. JK1 is most used and JK2 is next.

In human LCs, CDR3 is most important and CDR1 is next most important. CDR2 seldom makes contact with the Ag. Diversity is introduced into the CDRs as shown in Table 900 and Table 1000 (CDR1), Table 1100 and Table 1200 (CDR2), Tables 1300, 1400, and 1500 (CDR3). For Economical Selection of Heavy Chains (ESHC), a small number, for example, 50 LCs with diversity in CDR3 as in Table 1200 are picked for expression in pLCSK24 for secretion into the periplasm. More LCs can be used if several cell lines are maintained so that each cell line contains, for example, 50 or fewer LC.

Table 900 shows diversity for LC CDR1. The library can contain the O12 residue with the added diversity of the AA types shown as “allowed”; reading “allowed” as “additional allowed types” in Tables 900, 1000, 1100, 1200, 1300, 1400. O12 has R₂₄ASQSISSYLN₃₄ (SEQ ID NO: 935). Other VK1 loci have Q at 24. Other loci have M at 25. S₂₆ and Q₂₇ are invariant in VKI. Other VKI loci have D or G at 28. I₂₉ and L₃₃ are invariant in VKI and the side groups are oriented inward. Other VKI loci allow the diversity shown in Table 900 at positions 30, 31, 32, and 34. In Table 900, only seven of the eleven positions are varied and the total diversity is 576.

Table 1000 shows a higher level of diversity for LC CDR1. Here 8 of 11 positions have been varied. Those that are constant are either far from the combining site or have buried side groups.

Table 1100 shows a low level variegation for CDR2. CDR2 is far from the antigen combining site and diversity here may not be very useful. Indeed, the GL diversity is very limited. Table 1100 includes the GL diversity. Table 1200 contains a higher level of diversity, 1920 sequences allowed.

Table 1300 shows a low level of diversity for LC CDR3, 2160 sequences. Table 1400 shows a higher level which allows 105,840 sequences.

For ROLIC, about 3×10⁷ LC are produced having the diversity shown in Tables 900, 1100, and 1300.

### Heavy Chain Diversity

Ab HC (heavy chain) have diversity in CDR1, CDR2, and CDR3. The diversity in CDR3 is especially complex because there is both sequence and length diversity. The sequence diversity is not random. Cells making Ab genes join a V segment to a D segment to a JH segment. The D segment is optional; about half of natural human Abs have a recognizable D. There can be extensive editing at the V-D, D-J, or V-J boundaries with none to many bases added or removed. An Ab that has a germline V::D::JH could be viewed as a germline Ab.

Human D segments are shown in Table 20. Each germline (GL) D segment may appear in an Ab gene in any of the three forward reading frames. In some reading frames, some of the D segments encode stop codons. These D segments do occur rarely with the stop codon modified. Table 20 shows the frequency of each D segment in a sample of 21,578 distinct HC CDR3s. Most of the examples herein that contain D segments use Ds that are fairly common (>2% of all observed Ds).

In one aspect, the present invention involves composing Ab HC genes by fusing 3-23 (or another VH, such as 4-34) to one of a) a number of amino acids picked from the set comprising (S, Y, D, R, N), b) a D region, c) a JH region, and d) the FR4 portion of a JH region. These fusions can be a GL 3-23 or a 3-23 that has synthetic diversity in CDR1 and/or CDR2. The lengths of the HC CDR3 and be any number from about 3 to about 24. Preferably, the library would contain member with HC CDR3 of lengths 6, 8, 10, 12, 14, 16, 18, and 20. Alternatively, the lengths could be 5, 8, 11, 14, 17, and 20 or any other combination.

Table 21 shows a number of examples of designs of suitable CDR3s with lengths from 6 to 20. The codons that specify the uppercase letters in column 2 are to be synthesized with wobbling. Column 3 shows the level of doping. Table 100 shows ratios in which the various lengths of HC CDR3 could be combined to form a library that is expected to contain Abs that bind almost all protein targets. Other ratios could be used.

TABLE 100
Length diversity in a library of HC CDR3s

| Length | 6 | 8 | 10 | 12 | 14 | 16 | 20 |
|---|---|---|---|---|---|---|---|
| Diversity | 1. × 10⁵ | 2. × 10⁵ | 4. × 10⁵ | 8. × 10⁵ | 8. × 10⁵ | 8. × 10⁵ | 4. × 10⁵ |

For length 6, Table 21 four examples are given. For example, 6a has VH(3-23) joined directly to JH1 with the first six AAs wobbled, 6b has Tyr joined to D4-17 in second reading frame joined to the FR4AAs of JH1, and 6c has D5-5(3) joined to the FR residues of JH1. Since these give different kinds of diversity, including all is preferred, but a library containing only one of these should give useful Abs.

For length 8, Table 21 shows three examples. 8a has YY fused to all of JH1 while 8b has one Y fused to D6-13(1) fused to the FR region of JH1. Lengths 10, 12, 14, 16, and 20 are also shown in Table 21. The HC CDR3 diversity could be built in a germline 3-23 or 3-23 containing synthetic diversity. Alternatively, a different VH, such as 4-34 could be used.

ROLIC is a method in which a small population of HCs are expressed in F⁺ E. coli as soluble proteins. The population is infected with phage that carry LC::IIₛₜᵤₘₚ fusions. The phage produced obtain a HC from the periplasm of the cell that produces them. These phage can be bound to immobilized target and the binder are separated from the non-binders. The size of the population is important because when the recovered phage are propagated, the recovered phage must find the same type of cell as it came from to continue the association between LC and HC. Thus it is desirable that the number of HC be small in each cell line. Thus it may be desirable to maintain a number of cell lines with up to 10, 20, 30, or 40 different HC in each cell line. Thus we may have 1, 2, 4, 6, 8, 10, 24, 48, or 96 cell lines and we perform the same number of parallel phage productions, selections, and amplifications. After one or two rounds, we test colonies for production of phage that bind the target by an ELISA assay. Each ELISA⁺ colony contains a useful LC and a useful HC, but they are not on the same piece of DNA. Nevertheless, we know the start and end of each LC and each HC and can therefore use PCR on the colony to produce a Fab display or Fab secretion cassette that can be put into a display phage or phagemid or into a Fab-production plasmid.

In Efficient Selection of HCs (ESHC), we reverse the roles of LC and HC in ROLIC and have LCs in a plasmid so that they are produced as soluble proteins in the periplasm of F⁺ E. coli. We produce the HC diversity in a phage vector that has no LC gene. We infect the LC-producing F⁺ E. coli with the HC-carrying phage. We obtain phage that carry an HC gene and both HC and LC proteins. We select these phage for binding to the target. In many Abs, the LC is permissive and does not contribute greatly to binding affinity. Picking the best LC can greatly increase affinity, but it is usually possible to select a Fab with a very limited repertoire of LCs. Thus, we place a small set of LCs, preferable germline in the framework regions in the LC-producing F⁺ E. coli. If there are, for example, 25 LC in the LC cell line, then we obtain a 25-fold reduction in the number of cell transformants that need to be made.

The libraries described have a range of HC CDR3 lengths. To favor proper folding, the HC CDR3 have either a D segment or no D segment joined to most, all, or the framework portion of a JH segment. The sequences are diversified by using wobble DNA synthesis. Although this theoretically allows any amino-acid type at any position, in practice, the actual sequences are strongly biased toward the parental sequences and AA types that are close in the genetic code table.

By using ESHC, we can sample new designs of synthetic HC CDR3 diversity. In the examples given, we use a pool of, for example, 50 LCs. A library of 5×10⁸ HC should perform as well as an old-style library of 2.5×10¹⁰ but require far less effort.

When wobbling a sequence, picking the initial codons affects the actual mixture of AAs seen in the library. Table 300 shows which amino-acid substitutions require 1, 2, or 3 base changes from each starting parental codon. For example, if we start with get or gcc for Ala, all three stop codons require three base changes and so are rare. If using 76:8:8:8 mixtures, Ala will appear in 57% of the cases (0.76*0.76). V, G, T, P, S will each appear in about 6% and D about 3%. E, I, L, F, Y, H, N, C, and R will be down about 10-fold. M, W, Q, K, Am, Oc, and Op will be even rarer. If we started with gca, then E would replace D in needing only one base change, but opal and ochre stops require only two base changes, which is undesirable. The preferred codons are marked with a star (*). The choice for serine is complicate our desire to have Y substitute for S with high frequency. This brings Op and Oc into the group that differ from the parent by only two bases. This problem can be overcome by cloning the HC CDR3 repertoire before an antibiotic resistance gene such as KanR or AmpR and selecting for resistance, thus eliminating the members that contain stop codons. In addition, the library can be produced in supE E. coli which insert Q instead of stopping.

TABLE 300
Results of 1, 2, or 3 base changes from parental codons

| Amino | Parental | | | |
|---|---|---|---|---|
| acid | codon | 1 base change | 2 base changes | 3 base changes |
| A * | gct, gcc | V, D, G, T, P, S | E, I, L, F, Y, H, N, C, R | M, W, Q, K, Am, Oc, Op |
| A | gca | V, E, G, T, P, S | D, I, L, Oc, Q, K, Op, R | M, W, H, N, C, Am, F, Y |
| A | gcg | V, E, G, T, P, S | D, M, L, Am, Q, K, R, W | I, F, Y, Oc, Op, H, N, C |
| C | tgt, tgc | Y, S, F, W, Op, R, G | L, H, N, D, P, T, A, V, I | Am, Oc, Q, K, E, M |
| D | gat, gac | E, G, A, V, N, H, Y | F, S, C, L, P, Q, K, R, Oc, | M, W, Op |
| | | | Am, I, T | |
| E | gaa | D, G, A, V, K, Q, | Am, L, I, S, P, T, R, Op, Y, | M, F, C, W |
| | | Oc | H, N | |
| E * | gag | D, G, A, V, K, Q, | M, L, S, P, T, Y, H, N, Oc, | F, C, I, Op |
| | | Am | R, W | |
| F | ttt, ttc | L, I, V, S, Y, C | M, Am, Op, Oc, W, P, T, | Q, K, E |
| | | | A, H, N, D, R, G | |
| G * | ggt, ggc | D, A, V, S, R, C | E, W, F, L, I, T, P, Y, H, N | Am, Oc, Op, M, Q, K |
| G | gga | E, A, V, R, Oc | D, W, L, I, S, P, T, Op, Q, K | Am, Oc, M, F, Y, H, N |
| G | ggg | E, A, V, R, W | D, Oc, L, M, S, P, T, Am, | Oc, I, F, Y, H, N |
| | | | Op, Q, K | |
| H | cat, cac | Q, Y, N, D, L, P, R | F, S, C, I, T, V, A, D, G, | Op, W, M, E |
| | | | Am, Oc | |
| I * | att, atc | M, L, F, V, T, N, S | Y, C, P, H, R, A, D, G | Am, Op, Oc, W, Q, K, E |
| I | ata | M, L, V, T, K, R | Op, Oc, S, P, Q, A, E, G, | Am, C, D, H, W, Y |
| | | | F, N | |
| K | aaa | N, Q, Oc, E, P, I, R | H, Y, D, M, L, V, S, T, A, | C, F, W |
| | | | Am, Op, G | |
| K * | aag | N, Q, Am, E, P, | H, Y, D, I, L, V, S, T, A, | C, F, Op |
| | | M, R | Oc, G, W | |
| L | tta | F, S, Oc, Op, I, V | Y, C, W, M, P, T, A, Q, K, | D, H, N |
| | | | E, R, G, Am | |
| L | ttg | F, S, Am, W, M, V | Y, C, Oc, Op, P, T, A, Q, | D, H, N |
| | | | K, E, R, G, I | |
| L * | ctt, ctc | F, I, V, P, H, R | M, S, Y, C, T, N, A, D, G | Am, Oc, Op, W, E, K, Q |
| L | cta | I, V, P, Q, R | F, M, S, Oc, Op, T, K, A, | Am, W, D, N, C, Y |
| | | | E, G, H | |
| L | ctg | M, V, P, Q, R | F, I, S, Am, T, K, A, E, G, | Oc, Op, D, N, C, Y |
| | | | H, W | |
| M | atg | L, V, T, K, R, I | F, N, S, P, A, Am, Q, E, | Oc, Op, Y, C, H, D |
| | | | W, G | |
| N | aat, aac | K, Y, H, D, I, T, S | F, C, L, P, R, V, A, G, M, | Op, W |
| | | | Q, E, Am, Oc | |
| P * | cct, ccc | S, T, A, L, H, R | F, Y, C, I, N, V, D, G, Q | Am, Oc, Op, W, M, E, K |
| P | cca | S, T, A, L, Q, R | Oc, Op, I, K, V, E, G, H | Am, W, M, D, N, C, F, Y |
| P | ccg | S, T, A, L, Q, R | Am, M, K, V, E, G, H | C, D, F, I, N, W, Y, Oc, Op |
| Q | caa | Oc, K, E, R, P, L, H | Y, Am, N, D, S, T, A, I, V, | F, C, W, M |
| | | | G, Op | |
| Q * | cag | H, Am, K, E, R, | N, D, Y, M, T, V, A, G, W, | C, F, Op, I |
| | | P, L | Oc, S | |
| R * | cgt, cgc | C, S, G, H, P, L | Op, W, Q, F, Y, I, T, N, V, | Am, Oc, M, E, K |
| | | | A, D | |
| R | cga | G, Op, Q, P, L | Oc, S, C, W, H, I, V, T, A, | Am, M, C, D, N, F, Y |
| | | | E, K | |
| R | cgg | G, W, Q, P, L | Am, Op, S, M, V, T, A, K, | F, Y, I, Oc, D, N |
| | | | E, H, C | |
| R | aga | G, Op, S, K, T, I | C, W, N, M, L, V, P, A, | F, Y, H, D, Am |
| | | | Oc, Q, E | |
| R | agg | G, W, S, K, T, M | C, Op, Am, L, I, V, A, Q, | F, Y, H, D, Oc |
| | | | P, E, N | |
| S * | tct, tcc | F, Y, C, P, T, A | L, Oc, Op, Am, W, I, V, N, | E, K, M, Q |
| | | | D, R, G, H | |
| S | tca | L, Oc, Op, P, T, A | F, Y, C, W, Q, R, I, K, V, | M, W, D, N, H |
| | | | E, G, Am | |
| S | tcg | L, Am, W, P, T, A | F, Y, C, Op, Oc, Q, R, M, | I, D, N, H |
| | | | K, V, E, G | |
| S | agt, agc | C, R, G, N, T, I | F, Y, L, P, H, V, A, D, K, | Am, Oc, M, E, Q |
| | | | W, Op | |
| T * | act, acc | S, P, A, I, N | F, Y, C, L, H, R, M, K, V, | Am, Oc, Op, W, E, Q |
| | | | D, G | |
| T | aca | S, P, A, I, K, R | L, Oc, Op, Q, M, E, G, V, N | F, Y, C, Am, W, D, H |
| T | acg | S, P, A, M, K, R | I, N, L, Am, W, Q, V, E, G | C, F, Y, Oc, Op, D, H |
| V * | gtt, gtc | F, L, I, A, D, G | S, P, T, Y, H, N, E, C, R, M | Am, Oc, Op, W, Q, K |
| V | gta | L, I, A, E, G | F, M, D, S, P, T, Oc, Op, | Am, W, C, Y, H, N |
| | | | Q, R, K | |
| V | gtg | L, M, A, E, G | F, I, D, S, P, T, Am, Q, R, | Oc, Op, C, Y, H, N |
| | | | K, W | |
| W | tgg | C, R, G, Am, S, L, | P, Q, F, M, T, K, V, A, E, | D, N, H, I |
| | | Op | Oc, Y | |
| Y | tat, tac | C, S, F, N, H, D, | L, W, Q, K, E, P, I, T, V, | M |
| | | Oc, Am | A, G, Op, R | |

Am is TAG stop,
Op is TGA,
Oc is TAA

### Methods of Using the Libraries

Off-Rate Selection. Since a slow dissociation rate can be predictive of high affinity, particularly with respect to interactions between polypeptides and their targets, the methods described herein can be used to isolate ligands with a desired kinetic dissociation rate (i.e., reduced) for a binding interaction to a target.

To select for slow dissociating antibodies from a display library, the library is contacted to an immobilized target. The immobilized target is then washed with a first solution that removes non-specifically or weakly bound antibodies. Then the bound antibodies are eluted with a second solution that includes a saturating amount of free target, i.e., replicates of the target that are not attached to the particle. The free target binds to antibodies that dissociate from the target. Rebinding of the eluted antibodies is effectively prevented by the saturating amount of free target relative to the much lower concentration of immobilized target.

The second solution can have solution conditions that are substantially physiological or that are stringent (e.g., low pH, high pH, or high salt). Typically, the solution conditions of the second solution are identical to the solution conditions of the first solution. Fractions of the second solution are collected in temporal order to distinguish early from late fractions. Later fractions include antibodies that dissociate at a slower rate from the target than biomolecules in the early fractions. Further, it is also possible to recover antibodies that remain bound to the target even after extended incubation. These can either be dissociated using chaotropic conditions or can be amplified while attached to the target. For example, phage bound to the target can be contacted to bacterial cells.

Selecting or Screening for Specificity. The display library screening methods described herein can include a selection or screening process that discards antibodies that bind to a non-target molecule. Examples of non-target molecules include, e.g., a carbohydrate molecule that differs structurally from the target molecule, e.g., a carbohydrate molecule that has a different biological property from the target molecule. In the case of a sulfated carbohydrate, a non-target may be the same carbohydrate without the sulfate or with the sulfate in a different position. In the case of a phosphopeptide, the non-target may be the same peptide without the phosphate or a different phosphopeptide.

In one implementation, a so-called “negative selection” step is used to discriminate between the target and related non-target molecule and a related, but distinct non-target molecules. The display library or a pool thereof is contacted to the non-target molecule. Members that do not bind the non-target are collected and used in subsequent selections for binding to the target molecule or even for subsequent negative selections. The negative selection step can be prior to or after selecting library members that bind to the target molecule.

In another implementation, a screening step is used. After display library members are isolated for binding to the target molecule, each isolated library member is tested for its ability to bind to a non-target molecule (e.g., a non-target listed above). For example, a high-throughput ELISA screen can be used to obtain this data. The ELISA screen can also be used to obtain quantitative data for binding of each library member to the target. The non-target and target binding data are compared (e.g., using a computer and software) to identify library members that specifically bind to the target.

In certain embodiments, the antibodies comprising the CDR3s of the invention may be able to bind carbohydrates. Methods for evaluating antibodies for carbohydrate binding include ELISA, immunohistochemistry, immunoblotting, and fluorescence-activated cell sorting. These methods can be used to identify antibodies which have a K_{D} of better than a threshold, e.g., better than 100 nM, 50 nM, 10 nM, 5 nM, 1 nM, 500 pM, 100 pM, or 10 pM.

ELISA. Proteins encoded by a display library can also be screened for a binding property using an ELISA assay. For example, each protein is contacted to a microtitre plate whose bottom surface has been coated with the target, e.g., a limiting amount of the target. The plate is washed with buffer to remove non-specifically bound polypeptides. Then the amount of the protein bound to the plate is determined by probing the plate with an antibody that can recognize the polypeptide, e.g., a tag or constant portion of the polypeptide. The antibody is linked to an enzyme such as alkaline phosphatase, which produces a calorimetric product when appropriate substrates are provided. The protein can be purified from cells or assayed in a display library format, e.g., as a fusion to a filamentous bacteriophage coat. Alternatively, cells (e.g., live or fixed) that express the target molecule, e.g., a target that contains a carbohydrate moiety, can be plated in a microtitre plate and used to test the affinity of the peptides/antibodies present in the display library or obtained by selection from the display library.

In another version of the ELISA assay, each polypeptide of a diversity strand library is used to coat a different well of a microtitre plate. The ELISA then proceeds using a constant target molecule to query each well.

Cell Binding Assays. Antibodies can be evaluated for their ability to interact with one or more cell types, e.g., a hematopoietic cell. Fluorescent activated cell sorting (FACS) is one exemplary method for testing an interaction between a protein and a cell. The antibody is labeled directly or indirectly with a fluorophore, before or after, binding to the cells, and then cells are counted in a FACS sorter.

Other cell types can be prepared for FACS by methods known in the art.

Homogeneous Binding Assays. The binding interaction of candidate polypeptide with a target can be analyzed using a homogenous assay, i.e., after all components of the assay are added, additional fluid manipulations are not required. For example, fluorescence resonance energy transfer (FRET) can be used as a homogenous assay (see, for example, Lakowicz et al., U.S. Pat. No. 5,631,169; Stavrianopoulos, et al., U.S. Pat. No. 4,868,103). A fluorophore label on the first molecule (e.g., the molecule identified in the fraction) is selected such that its emitted fluorescent energy can be absorbed by a fluorescent label on a second molecule (e.g., the target) if the second molecule is in proximity to the first molecule. The fluorescent label on the second molecule fluoresces when it absorbs to the transferred energy. Since the efficiency of energy transfer between the labels is related to the distance separating the molecules, the spatial relationship between the molecules can be assessed. In a situation in which binding occurs between the molecules, the fluorescent emission of the ‘acceptor’ molecule label in the assay should be maximal. A binding event that is configured for monitoring by FRET can be conveniently measured through standard fluorometric detection means well known in the art (e.g., using a fluorimeter). By titrating the amount of the first or second binding molecule, a binding curve can be generated to estimate the equilibrium binding constant.

Another example of a homogenous assay is Alpha Screen (Packard Bioscience, Meriden Conn.). Alpha Screen uses two labeled beads. One bead generates singlet oxygen when excited by a laser. The other bead generates a light signal when singlet oxygen diffuses from the first bead and collides with it. The signal is only generated when the two beads are in proximity. One bead can be attached to the display library member, the other to the target. Signals are measured to determine the extent of binding.

The homogenous assays can be performed while the candidate polypeptide is attached to the display library vehicle, e.g., a bacteriophage.

Surface Plasmon Resonance (SPR). The binding interaction of a molecule isolated from a display library and a target can be analyzed using SPR. SPR or Biomolecular Interaction Analysis (BIA) detects biospecific interactions in real time, without labeling any of the interactants. Changes in the mass at the binding surface (indicative of a binding event) of the BIA chip result in alterations of the refractive index of light near the surface (the optical phenomenon of surfa act ccmon resonance (SPR)). The changes in the refractivity generate a detectable signal, which are measured as an indication of real-time reactions between biological molecules. Methods for using SPR are described, for example, in U.S. Pat. No. 5,641,640; Raether (1988) Surface Plasmons Springer Verlag; Sjolander and Urbaniczky (1991) Anal. Chem. 63:2338-2345; Szabo et al. (1995) Curr. Opin. Struct. Biol. 5:699-705 and on-line resources provide by BIAcore International AB (Uppsala, Sweden).

Information from SPR can be used to provide an accurate and quantitative measure of the equilibrium dissociation constant (K_{D}), and kinetic parameters, including kₒₙ and k_{off}, for the binding of a biomolecule to a target. Such data can be used to compare different biomolecules. For example, proteins encoded by nucleic acid selected from a library of diversity strands can be compared to identify individuals that have high affinity for the target or that have a slow k_{off}. This information can also be used to develop structure-activity relationships (SAR). For example, the kinetic and equilibrium binding parameters of matured versions of a parent protein can be compared to the parameters of the parent protein. Variant amino acids at given positions can be identified that correlate with particular binding parameters, e.g., high affinity and slow k_{off}. This information can be combined with structural modeling (e.g., using homology modeling, energy minimization, or structure determination by crystallography or NMR). As a result, an understanding of the physical interaction between the protein and its target can be formulated and used to guide other design processes.

Protein Arrays. Proteins identified from the display library can be immobilized on a solid support, for example, on a bead or an array. For a protein array, each of the polypeptides is immobilized at a unique address on a support. Typically, the address is a two-dimensional address. Methods of producing polypeptide arrays are described, e.g., in De Wildt et al. (2000) Nat. Biotechnol. 18:989-994; Lueking et al. (1999) Anal. Biochem. 270:103-111; Ge (2000) Nucleic Acids Res. 28, e3, I-VII; MacBeath and Schreiber (2000) Science 289:1760-1763; WO 01/40803 and WO 99/51773A1. Polypeptides for the array can be spotted at high speed, e.g., using commercially available robotic apparati, e.g., from Genetic MicroSystems or BioRobotics. The array substrate can be, for example, nitrocellulose, plastic, glass, e.g., surface-modified glass. The array can also include a porous matrix, e.g., acrylamide, agarose, or another polymer.

### Vectors

Also provided are vectors for use in carrying out a method according to any aspect of the invention. One such vector will typically have an origin of replication for single stranded bacteriophage and either contain the sbp member nucleic acid or have a restriction site for its insertion in the 5′ end region of the mature coding sequence of a phage capsid protein, and with a secretory leader coding sequence upstream of said site which directs a fusion of the capsid protein exogenous polypeptide to the periplasmic space.

The vector can be a phage vector (e.g., DY3F87HC) which has a site for insertion of HC CDR3s for expression of the encoded polypeptide in free form. The vector can be a plasmid vector for expression of soluble light chains, e.g., pLCSK23.

The diversity of light chains encoded by pLCSK23 may be 10, 15, 20, 25, 30, or 50. The LCs in the diversity may be constructed or picked to have certain desirable properties, such as, being germline in the framework regions and having diversity in CDR3 and/or CDR1. The germlines may be of highly utilized ones, e.g., VK1_{—}2-O2, VK3_{—}1-A27, VK3_{—}5-L6, VK3_{—}3-L2 for kappa and VL2_{—}2a2, VL1_{—}1c, VL1_{—}1g, VL3_{—}3r for lambda.

For example, one could clone genes for VK1O2gl-JK3, VK1O2var1, VK1O2var2, VK1O2var3, VK1O2var4, VK1O2var5, VK3L6gl-JK4, VK3L6var1, VK3L6var2, VK3L6var3, VK3L6var4, VK3L6var5, VK3L6var6, VK3L6var7, VK3L6var8, VK3A27gl-JK3, VK3A27var1, VK3A27var2, VK3A27var3, VK3A27var4, VK3A27var5, VK3A27var6, VK3A27var7, VK3L2gl-JK3, VK1glL8-JK5, and VK1GLO12-JK3 (amino-acid sequences shown in Table 19) into pLCSK23.

TABLE 19
26 VL to be used in pLCSK23.

VK1O2g1-JK3

(SEQ ID NO: 4)

| | |
|---|---|
| DIQMTQSPSS LSASVGDRVT ITCRASQSIS SYLNWYQQKP GKAPKLLIYA ASSLQSGVPS | 60 |
| RFSGSGSGTD FTLTISSLQP EDFATYYCQQ SYSTPFTFGP GTKVDIK | 107 |
| VK1O2var1 | |

(SEQ ID NO: 5)

| | |
|---|---|
| S28D | |
| DIQMTQSPSS LSASVGDRVT ITCRASQDIS SYLNWYQQKP GKAPKLLIYA ASSLQSGVPS | 60 |
| RFSGSGSGTD FTLTISSLQP EDFATYYCQQ SYSTPFTFGP GTKVDIK | 107 |
| VK1O2var2 | |

(SEQ ID NO: 6)

| | |
|---|---|
| S91R | |
| DIQMTQSPSS LSASVGDRVT ITCRASQSIS SYLNWYQQKP GKAPKLLIYA ASSLQSGVPS | 60 |
| RFSGSGSGTD FTLTISSLQP EDFATYYCQQ RYSTPFTFGP GTKVDIK | 107 |
| VK1O2var3 | |

(SEQ ID NO: 7)

| | |
|---|---|
| S91E | |
| DIQMTQSPSS LSASVGDRVT ITCRASQSIS SYLNWYQQKP GKAPKLLIYA ASSLQSGVPS | 60 |
| RFSGSGSGTD FTLTISSLQP EDFATYYCQQ EYSTPFTFGP GTKVDIK | 107 |
| VK1O2var4 | |

(SEQ ID NO: 8)

| | |
|---|---|
| S31R | |
| DIQMTQSPSS LSASVGDRVT ITCRASQSIS RYLNWYQQKP GKAPKLLIYA ASSLQSGVPS | 60 |
| RFSGSGSGTD FTLTISSLQP EDFATYYCQQ SYSTPFTFGP GTKVDIK | 107 |
| VK1O2var5 | |

(SEQ ID NO: 9)

| | |
|---|---|
| S31E, S93R | |
| DIQMTQSPSS LSASVGDRVT ITCRASQSIS EYLNWYQQKP GKAPKLLIYA ASSLQSGVPS | 60 |
| RFSGSGSGTD FTLTISSLQP EDFATYYCQQ SYRTPFTFGP GTKVDIK | 107 |
| VK3L6g1-JK4 | |

(SEQ ID NO: 10)

| | |
|---|---|
| EIVLTQSPAT LSLSPGERAT LSCRASQSVS SYLAWYQQKP GQAPRLLIYD ASNRATGIPA | 60 |
| RFSGSGSGTD FTLTISSLEP EDFAVYYCQQ RSNWPLTFGG GTKVEIK | 107 |
| VK3L6var1 | |

(SEQ ID NO: 11)

| | |
|---|---|
| S31R | |
| EIVLTQSPAT LSLSPGERAT LSCRASQSVS RYLAWYQQKP GQAPRLLIYD ASNRATGIPA | 60 |
| RFSGSGSGTD FTLTISSLEP EDFAVYYCQQ RSNWPLTFGG GTKVEIK | 107 |
| VK3L6var2 | |

(SEQ ID NO: 12)

| | |
|---|---|
| S92R | |
| EIVLTQSPAT LSLSPGERAT LSCRASQSVS SYLAWYQQKP GQAPRLLIYD ASNRATGIPA | 60 |
| RFSGSGSGTD FTLTISSLEP EDFAVYYCQQ RRNWPLTFGG GTKVEIK | 107 |
| VK3L6var3 | |

(SEQ ID NO: 13)

| | |
|---|---|
| S92G | |
| EIVLTQSPAT LSLSPGERAT LSCRASQSVS SYLAWYQQKP GQAPRLLIYD ASNRATGIPA | 60 |
| RFSGSGSGTD FTLTISSLEP EDFAVYYCQQ RGNWPLTFGG GTKVEIK | 107 |
| VK3L6var4 | |

(SEQ ID NO: 14)

| | |
|---|---|
| S92Y | |
| EIVLTQSPAT LSLSPGERAT LSCRASQSVS SYLAWYQQKP GQAPRLLIYD ASNRATGIPA | 60 |
| RFSGSGSGTD FTLTISSLEP EDFAVYYCQQ RYNWPLTFGG GTKVEIK | 107 |
| VK3L6var5 | |

(SEQ ID NO: 15)

| | |
|---|---|
| S92E | |
| EIVLTQSPAT LSLSPGERAT LSCRASQSVS SYLAWYQQKP GQAPRLLIYD ASNRATGIPA | 60 |
| RFSGSGSGTD FTLTISSLEP EDFAVYYCQQ RENWPLTFGG GTKVEIK | 107 |
| VK3L6var6 | |

(SEQ ID NO: 16)

| | |
|---|---|
| Y32F | |
| EIVLTQSPAT LSLSPGERAT LSCRASQSVS SFLAWYQQKP GQAPRLLIYD ASNRATGIPA | 60 |
| RFSGSGSGTD FTLTISSLEP EDFAVYYCQQ RSNWPLTFGG GTKVEIK | 107 |
| VK3L6var7 | |

(SEQ ID NO: 17)

| | |
|---|---|
| Y32D | |
| EIVLTQSPAT LSLSPGERAT LSCRASQSVS SDLAWYQQKP GQAPRLLIYD ASNRATGIPA | 60 |
| RFSGSGSGTD FTLTISSLEP EDFAVYYCQQ RSNWPLTFGG GTKVEIK | 107 |
| VK3L6var8 | |

(SEQ ID NO: 18)

| | |
|---|---|
| N93G | |
| EIVLTQSPAT LSLSPGERAT LSCRASQSVS SYLAWYQQKP GQAPRLLIYD ASNRATGIPA | 60 |
| RFSGSGSGTD FTLTISSLEP EDFAVYYCQQ RSGWPLTFGG GTKVEIK | 107 |
| VK3A27g1-JK3 | |

(SEQ ID NO: 19)

| | |
|---|---|
| EIVLTQSPGT LSLSPGERAT LSCRASQSVS SSYLAWYQQK PGQAPRLLIY GASSRATGIP | 60 |
| DRFSGSGSGT DFTLTISRLE PEDFAVYYCQ QYGSSPFTFG PGTKVDIK | 108 |
| VK3A27var1 | |

(SEQ ID NO: 20)

| | |
|---|---|
| S31R | |
| EIVLTQSPGT LSLSPGERAT LSCRASQSVS RSYLAWYQQK PGQAPRLLIY GASSRATGIP | 60 |
| DRFSGSGSGT DFTLTISRLE PEDFAVYYCQ QYGSSPFTFG PGTKVDIK | 108 |
| VK3A27var2 | |

(SEQ ID NO: 21)

| | |
|---|---|
| S32R | |
| EIVLTQSPGT LSLSPGERAT LSCRASQSVS SRYLAWYQQK PGQAPRLLIY GASSRATGIP | 60 |
| DRFSGSGSGT DFTLTISRLE PEDFAVYYCQ QYGSSPFTFG PGTKVDIK | 108 |
| VK3A27var3 | |

(SEQ ID NO: 22)

| | |
|---|---|
| S32D | |
| EIVLTQSPGT LSLSPGERAT LSCRASQSVS SDYLAWYQQK PGQAPRLLIY GASSRATGIP | 60 |
| DRFSGSGSGT DFTLTISRLE PEDFAVYYCQ QYGSSPFTFG PGTKVDIK | 108 |
| VK3A27var4 | |

(SEQ ID NO: 23)

| | |
|---|---|
| G93E | |
| EIVLTQSPGT LSLSPGERAT LSCRASQSVS SSYLAWYQQK PGQAPRLLIY GASSRATGIP | 60 |
| DRFSGSGSGT DFTLTISRLE PEDFAVYYCQ QYESSPFTFG PGTKVDIK | 108 |
| VK3A27var5 | |

(SEQ ID NO: 24)

| | |
|---|---|
| G93R | |
| EIVLTQSPGT LSLSPGERAT LSCRASQSVS SSYLAWYQQK PGQAPRLLIY GASSRATGIP | 60 |
| DRFSGSGSGT DFTLTISRLE PEDFAVYYCQ QYRSSPFTFG PGTKVDIK | 108 |
| VK3A27var6 | |

(SEQ ID NO: 25)

| | |
|---|---|
| S30D, G93E | |
| EIVLTQSPGT LSLSPGERAT LSCRASQSVD SSYLAWYQQK PGQAPRLLIY GASSRATGIP | 60 |
| DRFSGSGSGT DFTLTISRLE PEDFAVYYCQ QYESSPFTFG PGTKVDIK | 108 |
| VK3A27var7 | |

(SEQ ID NO: 26)

| | |
|---|---|
| S94R | |
| EIVLTQSPGT LSLSPGERAT LSCRASQSVS SSYLAWYQQK PGQAPRLLIY GASSRATGIP | 60 |
| DRFSGSGSGT DFTLTISRLE PEDFAVYYCQ QYGRSPFTFG PGTKVDIK | 108 |
| VK3L2g1-JK3 | |

(SEQ ID NO: 27)

| | |
|---|---|
| EIVMTQSPAT LSVSPGERAT LSCRASQSVS SNLAWYQQKP GQAPRLLIYG ASTRATGIPA | 60 |
| RFSGSGSGTE FTLTISSLQS EDFAVYYCQQ YNNWPFTFGP GTKVDIK | 107 |
| VK1g1L8-JK5 | |

(SEQ ID NO: 28)

| | |
|---|---|
| DIQLTQSPSF LSASVGDRVT ITCRASQGIS SYLAWYQQKP GKAPKLLIYA ASTLQSGVPS | 60 |
| RFSGSGSGTE FTLTISSLQP EDFATYYCQQ LNSYPITFGQ GTRLEIK | 107 |
| VK1GLO12-JK3 | |

(SEQ ID NO: 897)

| | |
|---|---|
| DIQMTQSPSS LSASVGDRV TITCRASQSI SSYLNWYQQK PGKAPKLLIY AASSLQSGVP | 60 |
| SRFSGSGSGT DFTLTISSL QPEDFATYYC QQSYSTPFTF GPGTKVDIKR GTVAAPSVFI | 120 |
| FPPSDEQLKS GTASVVCLL NNFYPREAKV QWKVDNALQS GNSQESVTEQ DSKDSTYSLS | 180 |
| STLTLSKADY EKHKVYACE VTHQGLSSPV TKSFNRGECA AAGKPIPNPL LGLDST | 236 |

### Kits

Also provided are kits for use in carrying out a method according to any aspect of the invention. The kits may include the necessary vectors. One such vector will typically have an origin of replication for single stranded bacteriophage and either contain the sbp member nucleic acid or have a restriction site for its insertion in the 5′ end region of the mature coding sequence of a phage capsid protein, and with a secretory leader coding sequence upstream of said site which directs a fusion of the capsid protein exogenous polypeptide to the periplasmic space.

Also provided are packages encoding the HC CDR3s as defined above and polypeptides comprising the HC CDR3s and fragments and derivatives thereof, obtainable by use of any of the above defined methods. The derivatives may comprise polypeptides fused to another molecule such as an enzyme or a Fc tail.

The kit may include a phage vector (e.g., DY3F87HC) which has a site for insertion of HC CDR3s for expression of the encoded polypeptide in free form. The kit may also include a plasmid vector for expression of soluble light chains, e.g., pLCSK23. The kit may also include a suitable cell line (e.g., TG1).

The diversity of light chains encoded by pLCSK23 may be 10, 15, 20, 25, 30, or 50. The LCs in the diversity may be constructed or picked to have certain desirable properties, such as, being germline in the framework regions and having diversity in CDR3 and/or CDR1. The germlines may be of highly utilized ones, e.g., VK1_{—}2-O2, VK3_{—}1-A27, VK3_{—}5-L6, VK3_{—}3-L2 for kappa and VL2_{—}2a2, VL1_{—}1c, VL1_{—}1g, VL3_{—}3r for lambda.

For example, one could clone genes for VK1O2gl-JK3, VK1O2var1, VK1O2var2, VK1O2var3, VK1O2var4, VK1O2var5, VK3L6gl-JK4, VK3L6var1, VK3L6var2, VK3L6var3, VK3L6var4, VK3L6var5, VK3L6var6, VK3L6var7, VK3L6var8, VK3A27gl-JK3, VK3A27var1, VK3A27var2, VK3A27var3, VK3A27var4, VK3A27var5, VK3A27var6, VK3A27var7, VK3L2gl-JK3, VK1glL8-JK5, and VK1GLO12-JK3 (amino-acid sequences shown in Table 19) into pLCSK23.

The kits may include ancillary components required for carrying out the method, the nature of such components depending of course on the particular method employed. Useful ancillary components may comprise helper phage, PCR primers, buffers, and/or enzymes of various kinds Buffers and enzymes are typically used to enable preparation of nucleotide sequences encoding Fv, scFv or Fab fragments derived from rearranged or unrearranged immunoglobulin genes according to the strategies described herein.

### Methods of Introducing Diversity

There are many ways of generating DNA that is variable. One way is to use mixed-nucleotide synthesis (MNS). One version of MNS uses equimolar mixtures of nucleotides as shown in Table 5. For example, using NNK codons gives all twenty amino acids and one TAG stop codon. The distribution is 3(R/S/L): 2(A/G/V/T/P): 1(C/D/E/F/H/I/K/M/N/Q/W/Y) (e.g., 3 of each of Arg, Ser, and Leu, and so forth). An alternative, herein termed “wobbling”, uses mixed nucleotides but not in equimolar amounts. For example, if a parental codon were TTC (encoding Phe), we could use a mixture of (0.082 T, 0.06 C, 0.06 A, and 0.06 G) in place of T and a mixture of (0.082 C, 0.06 T, 0.06 A, and 0.06 G) in place of C. This would give TTC or TTT (encoding Phe) 59% of the time and Leu 13%, S/V/I/C/Y ˜5%, and other amino-acid types less often.

Van den Brulle et al. (Biotechniques 45:340-3 (2008)) describe a method of synthesis of variable DNA in which type IIs restriction enzymes are used to transfer trinucleotides from an anchored hair-pin oligonucleotide (PHONs) to a so called “splinker”. See also EP patents 1 181 395, EP 1 411 122, EP 1 314 783 and EP applications EP 01127864.5, EP 04001462.3, EP 08006472.8. By using mixtures of anchored PHONs and splinkers, one can build libraries in which desired amino-acid types are allowed in designer-determined ratios. Thus, one can direct that one amino-acid type is present, for example 82% of the time and 18 other amino-acid types (all non-parental amino-acid types except Cys) are present at 2% each. Herein, we will refer to such a synthesis as “dobbling” (digital wobbling). In some aspects, dobbling is preferred to wobbling, but wobbling provides useful embodiments, partly because the structure of the genetic code table causes wobbling to make mostly conservative substitutions. Dobbling does offer the possibility to exclude unwanted amino-acid types. In CDRs, unpaired cysteines are known, even in Abs approved as therapeutics, but in some embodiments, one would like to avoid them. In some embodiments, when diversifying a D region that contains a pair of cysteines, the cysteins are not allowed to vary because the disulfide-closed loop is an important structural element and because one does not want unpaired cysteines.

In addition, one can synthesize a DNA molecule that encodes a parental amino-acid sequence and subject that DNA to error-prone PCR using primers that cover the framework regions so that mutations in the framework regions are avoided.

TABLE 5
Standard codes for mixed nucleotides

| | |
|---|---|
| N is equimolar A, C, G, T | |
| B is equimolar C, G, T | (not A) |
| D is equimolar A, G, T | (not C) |
| H is equimolar A, C, T | (not G) |
| V is equimolar A, C, G | (not T) |
| K is equimolar G, T | (Keto) |
| M is equimolar A, C | (aMino) |
| R is equimolar A, G | (puRine) |
| S is equimolar C, G | (Strong) |
| W is equimolar A, T | (weak) |
| Y is equimolar C, T | (pYrimidine) |

TABLE 6
Example of mixed nucleotides for wobbling

e = 0.82 A + 0.06 C + 0.06 G + 0.06 T
q = 0.06 A + 0.82 C + 0.06 G + 0.06 T
j = 0.06 A + 0.06 C + 0.82 G + 0.06 T
z = 0.06 A + 0.06 C + 0.06 G + 0.82 T

### EXEMPLIFICATION

The present invention is further illustrated by the following examples which should not be construed as limiting in any way. The contents of all references, pending patent applications and published patents, cited throughout this application are hereby expressly incorporated by reference.

### Prophetic Example 1

### Libraries with Very Short HC CDR3s

Very short HC CDR3s have been described in the art. Kadirvelraj et al. (2006) Proc. Natl. Acad. Sci. USA 103:8149-54 have described a four amino-acid HC CDR3 sequence in an antibody that binds Streptococcus Type B III Ag (GBS-Ag) but not to Streptococcus pneumoniae capsular Ag. GBS-Ag is sialylated at regular intervals. S. pneumoniae capsular Ag (SPC-Ag) is very similar but lacks the sialic acid groups. Such a short HC CDR3 creates a wide groove into which a carbohydrate could bind, and such Abs are very, very rare in existing antibody libraries. Thus, current libraries do not afford a large variety of potential binders to carbohydrates.

Ab 1B1 is the murine mAb that binds GBS-Ag; Ab 1QFU is the mAb having a known 3D structure and the closest sequence; and 1NSN is an antibody of known 3D structure having a HC CDR3 of length 4. Examination of a 3-23 HC structure gives a distance from Cα of R₉₄ (which ends FR3) to the Cα of the W₁₀₄ (which begins FR4) of ˜10 Å. The CDR3 of 1B1 (NWDY (SEQ ID NO:29)) shows that the AAs need not have only small side groups or be mostly of glycine. Three amino acids (AAs) can bridge 10 Å, although PPP might not work. Indeed, we have obtained a few Fabs with CDR3s as short as 3 AAs, but they are very rare.

Although short and very short HC CDR3s have been described, no one has suggested making an Ab library having many members (e.g., greater than about 50%, about 60%, about 70%, about 80%, about 90%, or about 95% of members) with short HC CDR3s (e.g., HC CDR3s of 3 to 5 amino acids). One approach to building an effective library is to first design amino-acid sequences that could arise from V-J or V-D-J coupling. For CDR3 length 3, 4, or 5, we start with the amino-acid sequences shown in Table 7. For example, Sequence V-3JH1 shows the C-terminal end of 3-23 FR3 (TAVYYCAK (SEQ ID NO:30)) followed by JH1 which has been trimmed from the N-terminal end until three amino-acids before the Trp-Gly that starts FR4. V-3JH2 shows the end of FR3 followed by the trimmed JH2. The sequence following V-3JH6 are constructed by joining FR4 to a trimer taken from a human D segment followed by the FR4 region of a human JH segment. 3D3-3.3.2 would be a trimer from segment D3-3, third reading frame starting at the second amino acid. 5D5-12.2.3 is a pentamer from D5-12 in reading frame 2 starting at amino acid 3. Some of the germ-line D segments contain stop codons, yet they appear in natural antibodies when the stop codons are edited away. Here we assume that the most likely change fro TAA and TAG codons is to Tyr (Y) and that TGA stops are most likely mutated to Trp (W). Table 20 shows the amino-acid sequences of the human D segments; the types of stop codons is indicated by the use of * for TAG, @ for TAA, and $ for TGA. In Table 11 are 266 distinct trimers that can be constructed from human D segments. The TAA and TAG stops have been changed to Tyr shown as “y” (i.e., lowercase). These could also be changed to Ser, Cys, Phe, Gln, Lys, or Glu by single base changes. TAG could be changed by single base changes to Trp as well as Tyr, Gln, Lys, Glu, Ser, and Leu. Table 12 shows the 266 distinct tetramers that can be obtained by trimming human D segments. Table 13 shows the 215 pentamers that can be obtained from trimming human D segments. Table 14 shows the 155 hexamers that can be obtained by trimming human D segments. The libraries to be built have substantial diversity in HC CDR1 and HC CDR2. The sequence diversity of HC CDR3 may be less important than having a short, but acceptable sequence. The diversity of JH segments or fragments (e.g., 3 or more amino acids) of D segments provides sequences that could be built by the human immune system and so are less likely to be immunogenic.

In one embodiment, the trimers, tetramers, and pentamers that contain a Cys are eliminated.

In one embodiment, the trimers, tetramers, and pentamers that contain a Cys or the came from a D fragment containing a stop are eliminated.

The short libraries constructed using the trimers of Table 11, tetramers of Table 12, pentamers of Table 13 have substantial diversity: 266, 266, and 215 respectively. This is to be compared to the number of peptides of these lengths: 8000, 160000, and 3200000 respectively.

V-3D1-1.1.1-JH1 contains the final portion of FR3 followed by three amino acids from D1-1 (RF1), viz. GTT (SEQ ID NO:257). V-3D1-1.2-JH1 uses amino acids 2-4 of D1-1 (RF1) as the parental CDR3. V-3D3-3.3.3-JH2 shows the end of FR3 followed by amino acids 3-5 of D3-3 (RF 3). The invention comprises any amino-acid sequence comprising FR3::(three, four, or five stop-free AAs of a human D segment)::FR4 from a human JH. Fragments of D regions containing unpaired Cys residues are less preferred than those that are free of unpaired Cys residues. In V-5JH3, there is a Tyr shown as ‘y’ because JH3 has only 4 codons before the codons for Trp-Gly that define the beginning of FR4. V-5JH4 has a Ser shown as ‘s’ for the same reason. If wobbling is used, the preferred level of purity is between 0.75 and 0.90. The invention comprises the sequences V-3JH1 through V-3JH6, V-4JH1 through V-4JH6, and V-5JH1 through V-5JH6, and libraries containing the same The invention also comprises the sequences in which the CDR region is replaced by a 3, 4, or 5 amino-acid segment from a human D region, and libraries containing the same. The invention further comprises DNA in which the parental sequence has been mutated in the CDR3 region, and libraries containing the same. A preferred embodiment is one in which the average number of base changes per CDR3 is one, two, or three. The methods of mutagenesis include error-prone PCR, wobbling, and dobbling.

TABLE 7
Amino-acid sequences of parental CDR3s of lengths 3, 4, 5

| | ...FR3----- | CDR3- | FR4-------- | |
|---|---|---|---|---|
| Length 3 | | | | |
| V-3JH1 | TAVYYCAK | FQH | WGQGTLVTVSS | (SEQ ID NO: 31) |
| V-3JH2 | TAVYYCAK | FDL | WGRGTLVTVSS | (SEQ ID NO: 32) |
| V-3JH3 | TAVYYCAK | FDI | WGQGTMVTVSS | (SEQ ID NO: 33) |
| V-3JH4 | TAVYYCAK | FDY | WGQGTLVTVSS | (SEQ ID NO: 34) |
| V-3JH5 | TAVYYCAK | FDP | WGQGTLVTVSS | (SEQ ID NO: 35) |
| V-3JH6 | TAVYYCAK | MDV | WGQGTTVTVSS | (SEQ ID NO: 36) |
| V-3D1-1.1.1-JH1 | TAVYYCAK | GTT | WGQGTLVTVSS | (SEQ ID NO: 37) |
| V-3D1-1.1.2-JH1 | TAVYYCAK | TTG | WGQGTLVTVSS | (SEQ ID NO: 38) |
| V-3D3-3.3.3-JH2 | TAVYYCAK | IFG | WGRGTLVTVSS | (SEQ ID NO: 39) |
| Length 4 | | | | |
| V-4JH1 | TAVYYCAK | YFQH | WGQGTLVTVSS | (SEQ ID NO: 40) |
| V-4JH2 | TAVYYCAK | YFDL | WGRGTLVTVSS | (SEQ ID NO: 41) |
| V-4JH3 | TAVYYCAK | AFDI | WGQGTMVTVSS | (SEQ ID NO: 42) |
| V-4JH4 | TAVYYCAK | YFDY | WGQGTLVTVSS | (SEQ ID NO: 43) |
| V-4JH5 | TAVYYCAK | WFDP | WGQGTLVTVSS | (SEQ ID NO: 44) |
| V-4JH6 | TAVYYCAK | GMDV | WGQGTTVTVSS | (SEQ ID NO: 45) |
| V-4D3-10.1a-JH2 | TAVYYCAK | LLWF | WGRGTLVTVSS | (SEQ ID NO: 46) |
| Length 5 | | | | |
| V-5JH1 | TAVYYCAK | EYFQH | WGQGTLVTVSS | (SEQ ID NO: 47) |
| V-5JH2 | TAVYYCAK | WYFDL | WGRGTLVTVSS | (SEQ ID NO: 48) |
| V-5JH3 | TAVYYCAK | yAFDI | WGQGTMVTVSS | (SEQ ID NO: 49) |
| V-5JH4 | TAVYYCAK | sYFDY | WGQGTLVTVSS | (SEQ ID NO: 50) |
| V-5JH5 | TAVYYCAK | NWFDP | WGQGTLVTVSS | (SEQ ID NO: 51) |
| V-5JH6 | TAVYYCAK | YGMDV | WGQGTTVTVSS | (SEQ ID NO: 52) |
| V-5D2-8.2a-JH2 | TAVYYCAK | DIVLM | WGRGTLVTVSS | (SEQ ID NO: 53) |

TABLE 8
DNA encoding V-5D2-8.2a-JH2 for wobbling

! CDR3.......
! A E D T A V Y Y C A K D I V L M
5′-|gct|gag|gaT|aCT|GCA|GtT|taT|taC|tgc|gct aag jez ezq jzz qzz ezj
!

| | |
|---|---|
| ! W G Q G T T V T V S S | (SEQ ID NO: 54) |
| tgg ggc cag ggt act acG GTC ACC gtc tcc agt-3′ ! | (SEQ ID NO: 55) |
| ! BstEII . . . | |
| !------------------------------------------------------------------------- | |
| ! (Table 8 and other tables of the present application are annotated DNA. | |
| ! In each line, everything after an exclaimation point (!) is a comment. | |
| ! Thus, the net DNA from Table 8 is: | |
| ! 5′-gctgaggaTaCTGCAGtTtaTtaCtgcgctaagjezezqjzzqzzezj- | (SEQ ID NO: 55) |
| ! tggggccagggtactacGGTCACCgtctccagt-3′ | |

Alternatively, one could synthesize three fragments of DNA that correspond to the region from XbaI to BstEII and having residue 94 being K or R followed by 3, 4, or 5 NNK codons, followed by WG . . . of FR4. The allowed variation is 20³+20⁴+20⁵=3,368,000. After amplification, these DNA molecules would be mixed in the ratio 1:10:100 (so that shorter sequences are relatively oversampled) and cloned into the phagemid encoding the kappa library with HC CDR½ diversity. A library of 1×10⁹ would give significant diversity and will allow isolation of antibodies that bind to targets that have small to medium protrusions. For example, various carbohydrates, loops of proteins that are not well ordered (such as GPCRs) may benefit from a groove in the antibody created by having a very short HC CDR3. We can also build a lambda library. The ratio of AA sequences is 1:20:400, and it may be important to sample the shorter sequences more densely. Getting a big, wide gulley in the Ab may require exactly one 3 AA CDR3, but with a 4 AA CDR3, one probably has more leeway and with 5 AAs, even more leeway. In this Example, we use the JH6 version of FR4 from the WG motif onward.

We can select from our current kappa library a collection of, for example, 25 kappa light chains that are a) germline in the framework regions, b) show suitable diversity in CDRs, and c) are of types that produce well and pair well with 3-23. These LCₛ will be made in E. coli from a vector that carries Kan^{R} and no phage packaging signal. We would then build our HC library in a phage vector that has no LC. HC and LC will be crossed by infecting the LC producing cells with the HC phage. HC phage that are selected can be combined with the LC of the cell that produces ELISA phage or the HCs can be cloned into pMID21 that have the whole LC diversity. Alternatively, the selected HC can be moved into pHCSK85 and used with ROLIC to combine with all the LCs of our collection. Lambda LCs could also be used. Thus, a library of 1×10⁹ HC in phage can be expanded into a Fab library of 1.2×10¹¹ (1.×10⁹×117). If we combined 1×10⁷ CDR1-2s with 10⁶ HC CDR3s, we could make a library of 5×10⁷ in which each CDR3 is coupled with 50 CDR1-2s. A library of 5×10⁷ HCs in phage could give results similar to an old-style library of 6×10⁹.

TABLE 1
Designs of very short exemplary HC CDR3s

c3xxx
! scab DNA S R D N S K N T L Y L Q M N S
5′-ttc|act|atc|TCT|AGA|gac|aac|tct|aag|aat|act|ctc|tac|ttg|cag|atg|aac|agC-
! XbaI...
!
! CDR3.......
! L R A E D T A V Y Y C A K|R any any any W G
|TTA|AGg|gct|gag|gaT|aCT|GCA|GtT|taT|taC|tgc|gct aRg nnk nnk nnk tgg ggc-
!

| | |
|---|---|
| ! Q G T T V T V S S | (SEQ ID NO: 56) |
| cag ggt act acG GTC ACC gtc tcc agt-3′ | (SEQ ID NO: 57) |
| ! BstEII... | |
| ! | |
| (C3XXX)5′-T\|GCA\|GtT\|taT\|taC\|tgc\|gct aRg nnk nnk nnk tgg ggc cag ggt act ac-3′ | (SEQ ID NO: 58) |
| (ON_5) 5′-AcTggAgAcggTgAccgTAgTAcccTggccccA-3′ ! 33 bases | (SEQ ID NO: 58 |
| 256) | |
| (ON_5 is reverse complement of | |
| 5′-tgg ggc cag ggt act acG GTC ACC gtc tcc agt-3′ | (SEQ ID NO: 59)) |
| ! Use ON-1 and ON-3 shown below | |
| !----------------------------------------------- | |
| ! | |
| C3X4 | |
| ! scab DNA S R D N S K N T L Y L Q M N S | |
| 5′-ttc\|act\|atc\|TCT\|AGA\|gac\|aac\|tct\|aag\|aat\|act\|ctc\|tac\|ttg\|cag\|atg\|aac\|agC- | |
| ! XbaI... | |
| ! | |
| ! CDR3........... | |
| ! L R A E D T A V Y Y C A K\|R any any any any W | |
| \|TTA\|AGg\|gct\|gag\|gaT\|aCT\|GCA\|GtT\|taT\|taC\|tgc\|gct aRg nnk nnk nnk nnk tgg- | |
| ! | |
| ! G Q G T T V T V S S | (SEQ ID NO: 60) |
| ggc cag ggt act acG GTC ACC gtc tcc agt-3′ | (SEQ ID NO: 61) |
| ! BstEII... | |
| ! | |
| (C3X4)5′-GCA\|GtT\|taT\|taC\|tgc\|gct aRg nnk nnk nnk nnk tgg- | |
| ggc cag ggt act ac-3′ | (SEQ ID NO: 62) |
| ! Use ON-1, ON-3, and ON-5 | |
| !---------------------------------------------------------- | |
| C3X5 | |
| ! scab DNA S R D N S K N T L Y L Q M N S | |
| 5′-ttc\|act\|atc\|TCT\|AGA\|gac\|aac\|tct\|aag\|aat\|act\|ctc\|tac\|ttg\|cag\|atg\|aac\|agC- | |
| ! XbaI... | |
| ! | |
| ! CDR3............... | |
| ! L R A E D T A V Y Y C A K/R any any any any any | |
| \|TTA\|AGg\|gct\|gag\|gaT\|aCT\|GCA\|GtT\|taT\|taC\|tgc\|gct aRg nnk nnk nnk nnk nnk- | |
| ! | |
| ! W G Q G T T V T V S S | (SEQ ID NO: 63) |
| tgg ggc cag ggt act acG GTC ACC gtc tcc agt-3′ | (SEQ ID NO: 64) |
| ! BstEII... | |
| (C3X5)5′-GCA\|GtT\|taT\|taC\|tgc\|gct aRg nnk nnk nnk nnk nnk tgg- | |
| ggc cag ggt act ac-3′ | (SEQ ID NO: 65) |
| !------------------------------------------------- | |
| aRg encodes K or R | |

Alternatively, the current HC diversity can be cloned into DY3F87HC and the CDR3 diversity described above is cloned into that diversity as XbaI-BstEII fragments. A library of, for example, 25 LC are cloned into pLCSK23 and used to create a cell line in TG1 E. coli. These cells are infected with the DY3F87HC phage which harbor the novel HC CDR3 (and CDR1-2) diversity. The phage obtained from this infection are selected for binding to a desired target. After two to four rounds of selection, the selected HCs a©red to pHCSK22 and used to create a cell line which can be used with ROLIC to combine the selected HC with all the LCs in the ROLIC LC library. In this way, a library of 1.E9 can be give Abs that normally would require construction of a library of 1.E16 (assuming a LC diversity of 1.E7).

### Further Examples of Libraries Having Very Short HC CDR3s

In one embodiment, a library has CDR3s of length 3, P1-P2-P3, wherein the allowed amino-acid types of P1 is picked from those seen in actual Abs as shown in Table 3305, His and Ala, the allowed amino-acid types of P2 is picked from those seen in actual Abs as shown in Table 3305 and the allowed amino-acid types of P3 is picked from those seen in actual Abs as shown in Table 3305. For example, the library includes an amino-acid sequence SRDNSKNTLYLQMNSLRAEDTAVYYCAK-X1-X2-X3-WGQGTLVTVSS (SEQ ID NO: 975) wherein:
X1 may be G, E, R, S, I, F, L, N, Q, H, or A in the ratios 5000:938:938:938:625:313:313:313:313:313:313;
X2 may be G, D, S, E, R, F, H, I, K, N, Q, W, or Y in the ratios 3438:1563:1250:625:625:313:313:313:313:313:313:313:313; and
X3 may be Y, L, R, V, F, N, A, H, G, I, or T in the ratios 1875:1563:1250:1250:938:938:625:625:313:313:313.

The diversity of this library is 1,573 in HC CDR3. Met occurs at position X1, but we exclude it because we do not want to select ant act cc onsth methionine in CDR3. Ala and His do not occur at P1 in the sample of 32 antibodies examined. We include Ala and His at P1 to achieve more sequence diversity. Allowing any amino acid at three positions allows 8000 sequences. SRDNSKNTLYLQMNSLRAEDTAVYYCAK (SEQ ID NO: 976) is part of FR3 starting at the XbaI site. WGQGTLVTVSS (SEQ ID NO: 977) is FR4 containing the BstEII site. The FR4 sequences of JH1 and JH4 are identical. The most preferred method of construction is by dobbling. It is to be understood that there is also diversity in HC CDR1 & CDR2 and in LC. These 1,573 sequences are more likely to give working antibodies than are the 6,427 (8000-1573) that we are omitting.

In one embodiment, a library has CDR3s of length 4 wherein the allowed amino-acid types are picked from those seen in actual Abs as shown in Table 3306. For example, the library has an amino-acid sequence SRDNSKNTLYLQMNSLRAEDTAVYYCAK-X1-X2-X3-X4-WGQGTLVTVSS (SEQ ID NO: 978) wherein:
X1 is allowed to be D, G, S, R, Q, E, P, A, V, F, K, L, N, T, W, or Y in the ratios 27:21:9:8:6:5:5:4:4:2:2:2:2:2:2:2;
X2 is allowed to be G, L, F, R, S, A, P, E, T, Y, D, K, V, or W in the ratios 18:17:16:11:7:5:5:4:4:4:2:2:2:2 (Met omitted);
X3 is allowed to be G, D, E, K, R, A, S, V, L, Q, T, or Y in the ratios 30:23:9:6:6:4:4:4:3:3:3:3; and
X4 is allowed to be Y, I, V, D, H, G, N, P, R, F, S, or T in the ratios 37:8:8:6:6:5:5:5:5:4:4:3.
   The diversity of CDR3 in this library is 32,256 whereas NNK four times allows 160,000 amino-acid sequences.

In one embodiment, a library has CDR3s of length 5 wherein the allowed amino-acid types are those seen in actual Abs as shown in Table 3307. For example, the library has an amino-acid sequence SRDNSKNTLYLQMNSLRAEDTAVYYCAK-X1-X2-X3-X4-X5-WGQGTLVTVSS (SEQ ID NO: 979) wherein:
X1 is allowed to be G, D, L, V, A, S, F, H, I, R, Q, or W in the ratios 40:12:10:8:7:7:6:5:4:3:2:2;
X2 is allowed to be G, P, T, D, Y, R, V, A, L, Q, W, or S in the ratios 16:12:11:9:9:7:7:6:6:5:5:4;
X3 is allowed to be G, F, L, R, S, W, A, K, M, P, D, or E in the ratios 39:18:12:6:6:5:4:4:3:3:2:2;
X4 is allowed to be D, G, A, R, E, S, Y, F, I, K, or L in the ratios 38:31:6:5:4:4:3:2:2:2:2; and
X5 is allowed to be Y, V, D, I, N, S, F, G, A, H, or L in the ratios 37:12:11:10:6:6:4:4:3:3:3.
   This CDR3 library allows 209,088 sequences compared to 3,200,000 for NNK five times. Excluding the AATs that are seldom or never seen in actual Abs having CDR3 of length 5 reduces the number of sequence by 15-fold. Although Met occurs at position 4, we omit it because we do not want to sel act cc onsth methionine in CDR3.

### Prophetic Example 2

### Libraries with Very Long HC CDR3s

Sidhu et al. (J Mol Biol. 2004 338:299-310. and US application 20050119455A1) report high-affinity Abs selected from a library in which only Y and S were allowed in the CDRs which were limited in length to 20 amino acids. It may be possible to generate high affinity Abs from a library that has HC CDR3s with one or more of the following forms of diversity: a) several (but not all) sites allowing Y or S, b) including 4-6 NNK codons, c) introducing D segments (with or without diversification in the D), and/or d) using error-prone PCR. We have already sampled the Ab space in which HC CDR3 is in the range ˜8 to ˜22 with a median length of 13. Thus, libraries in which HC CDR3 is either ˜23 AAs or ˜35 AAs are possible and may have advantages with certain types of targets. For example, GPCRs are integral membrane proteins with seven helical segments transversing the lipid bilayer of the call that are thought to have multiple states. An antibody having a very long HC CDR3 could form a protuberance that fits into the channel formed by the seven strands. Finding Abs that bind GPCRs has been difficult and intentionally building libraries in which all the members have very long HC CDR3s may ameliorate this problem. The lengths may be made somewhat variable, say 23, 24, or 25 in one library and 33, 34, or 35 in a second.

Below are a number of representative designs. The CDR3 have been broken up and diversity generated that lets the various parts have differing relationships depending on the value of X. A full-length JH1 has been used, and in some designs diversity allowed diversity in the CDR3 part of JH1. Other JHs could be used. In the designs, the D segments are either rich in Y or have an S-rich disulfide loop. The amino-acid sequences of human D segments are shown in Table 3. The places where the D region has either S or Y or allowed other combinations have in particular been varied. Table 3 shows the amino-acid sequences of human J regions and their frequencies in 21,578 Abs.

Each of the libraries could be built in at least four ways: 1) DNA encoding a particular amino acid sequence is first synthesized and subjected to error-prone PCR, 2) the library can be synthesized by wobbling or with mixtures of nucleotides, 3) the library can be built using dobbling, and 4) routes (2) or (3) could be followed by error-prone PCR. As an example of route (1), in Design 12, DNA encoding SEQ ID NO:908 could be synthesized, as shown in SEQ ID NO:911. This DNA could be subjected to error-prone PCR using the primers shown in SEQ ID NO:909 and SEQ ID NO:910. Because these primers cover the framework regions, the errors will occur only in the CDR3.

A library of HCs with CDR3 with length 23 of, for example, 2×10⁹ members and a second library with HC CDR3s of length ˜35 also having 2×10⁹ members could be built. Alternatively, the DNA could be mixed to build one library of 4×10⁹.

In each of the following designs, the amino-acid sequence begins with YYCA(K/R) (SEQ ID NO: 936) which is the end of FR3. It is also within the scope of the invention to limit the initial sequence to YYCAK (SEQ ID NO: 980), which is the germline of 3-23. FR4 starts with WG and is shown bold.

### Design 1

SEQ ID NO:898 comprises the end of FR3 joined to two residues (DG) of types often found in the filler sequence that the immune system places between V and D. These are followed by D2-2.2, preferred because it has a disulfide loop and is rich in Ser and Tyr residues. This is followed by YGYSY (SEQ ID NO: 937), which is rich in Tyr and Ser residues, which is followed by full-length JH1.

In ON-C23D222-2, the NNK codons are replaced by codons that encode the amino-acid sequence shown in SEQ ID NO:898. This DNA can then be subjected to error-prone PCR to introduce a suitable level of diversity. Primers that correspond to the double underscored parts during error-prone PCR will limit the mutations to CDR3.

| XX::D2-2.2::XX::JH1 | |
|---|---|
| 1 1 2 2 | |
| FR3 1 5 0 5 0 3FR4 | |
| YYCAK DGGYCSSTSCYTYGYSYAEYFQHWGQGTLVTVSS | (SEQ ID NO: 898) |
| YYCAK XXGYCSXXSCYTXXYSYAEYFQHWGQGTLVTVSS | (SEQ ID NO: 69) |
| R GYCSSTSCYT AEYFQHWGQGTLVTVSS | (JH1) |

| (SEQ ID NO: 70) (SEQ ID NO: 66) | |
|---|---|
| 1 1 1 1 | |
| 9 9 0 0 0 1 | |
| 4 5 0 2abcdefghijklmnp3 0 | |
| Amino-acid diversity = | 1.28 E 8 |
| DNA diversity = | 2.15 E 9 |
| Stop-free = | 83% |
| Gratuitous Cys-free = | 83% |
| Free of stop and Cys = | 68% |

Design 1(C23D222) has 94 being R or K, then 2 Xs, D2-2 in second reading frame with two Xs in the loop, followed by two Xs, and JH1. D2-2 2^{nd} reading frame has a disulfide-closed loop into which diversity at two points has been introduced. This CDR3 is 23 long. Using primers that include DNA up to . . . YYCA (SEQ ID NO: 938) and from WGQG . . . (SEQ ID NO: 939), error-prone PCR on the CDR3 could be performed before amplifying out to XbaI and BstEII for cloning into the library of kappa LC and HC CDR½. Thus, the AAs that are shown as fixed will be allowed to vary some. The AAs that are part of the PCR overlap region will be reinforced by the final non-error prone PCR. Error-prone PCR is not a necessary part of the design.

```
C23D222JH1
!  scab DNA S R D N S K N T L Y L Q M N S
5′-ttc|act|atc|TCT|AGA|gac|aac|tct|aag|aat|act|ctc|tac|ttg|cag|atg|aac|agC-
!  XbaI...
!
!  L R A E D T A V Y Y C A K|R
    |TTA|AGg|gct|gag|gaT|aCT|GCA|GtT|taT|taC|tgc|gct aRg -
!
! CDR3----------------------------------------------------------------
!  X X D2-2 RF2............................. X X JH1..
!  any any G Y C S any any S C Y T any any Y S Y A
      nnk nnk ggt tat tgt tcc nnk nnk tct tgc tat act nnk nnk tat tcc tac gct-
!
!  CDR3---------------
!  E Y F Q H
      gaa tat ttc cag cac-
!
```

| | |
|---|---|
| ! W G Q G T L V T V S S | (SEQ ID NO: 71) |
| tgg ggc cag ggt act ctG GTC ACC gtc tcc agt-3′ | (SEQ ID NO: 72) |
| ! BstEII... | |
| (ON_C23D222) 5′-GCA\|GtT\|taT\|taC\|tgc\|gct aRg nnk nnk ggt tat tgt tcc nnk- | (SEQ ID NO: 73) |
| nnk tct tgc tat act nnk nnk tat tcc tac gct gaa tat ttc cag cac- | |
| tgg ggc cag ggt act ct-3′ ! 107 bases | |
| (ON_C23D222-2) 5′-GCA\|GtT\|taT\|taC\|tgc\|gct aag tcc ggt ggt tat tgt tcc agt- | (SEQ ID NO: 224) |
| tct tct tgc tat act tat ggt tat tcc tac gct gaa tat ttc cag cac- | |
| tgg ggc cag ggt act ct-3′ ! 107 bases | |
| (ON_1) 5′-GCA\|GtT\|taT\|taC\|tgc\|gct-3′ | (SEQ ID NO: 74) |
| (ON_2) 5′-AgAgTAcccTggccccAgAcgTccATAccgTAATAgT-3′ ! 37 bases | (SEQ ID NO: 75) |
| (ON_2 is reverse complement of 5′-ac tat tac ggt atg gac gtc tgg | (SEQ ID NO: 76) |
| ggc cag ggt act ct-3′) | |
| (ON_3) 5′-ttc\|act\|atc\|TCT\|AGA\|gac\|aac\|tct\|aag\|aat\|act\|ctc\|tac\|ttg\|cag\|atg\|- | (SEQ ID NO: 77) |
| aac\|agC\|TTA\|AGg\|gct\|gag\|gaT\|aCT\|GCA\|GtT\|taT\|taC\|tgc\|gct-3′ | |
| (ON_4) 5′-AcTggAgAcggTgAccAgAgTAcccTggccccA-3′ ! 33 bases | (SEQ ID NO: 78) |
| (5′-tgg ggc cag ggt act ctG GTC ACC gtc tcc agt-3′ [RC] | (SEQ ID NO: 79)) |

### Design 2

| 1 1 2 2 | |
|---|---|
| 1 5 0 5 0 3 | |
| YYCAK GSYYYGSGSYYNVDSYYAEYFQHWGQGTLVTVSS | (SEQ ID NO: 899) |
| YYCAK XXYYYGXGSXYNXXSYYAEYFQHWGQGTLVTVSS | (SEQ ID NO: 80) |
| R YYYGSGSYYN AEYFQHWGQGTLVTVSS | (JH1) |

| (SEQ ID NO: 81) (SEQ ID NO: 66) | |
|---|---|
| Amino-acid diversity = | 1.28 E 8 |
| DNA diversity = | 2.15 E 9 |
| Stop-free = | 83% |
| Gratuitous Cys-free = | 83% |
| Free of stop and Cys = | 68% |

Design 2 (C23D310) has 94 as R or K, two Xs, D3-10 (RF2) with 5^{th} and 8^{th} residues changed to X, 2 Xs, SYY, and JH1. The CDR3 is 23 AA long and could be further diversified by use of error-prone PCR.

```
C23D310JH1
!  scab DNA S R D N S K N T L Y L Q M N S
5′-ttc|act|atc|TCT|AGA|gac|aac|tct|aag|aat|act|ctc|tac|ttg|cag|atg|aac|agC-
!  XbaI...
!
!  L R A E D T A V Y Y C A K|R
    |TTA|AGg|gct|gag|gaT|aCT|GCA|GtT|taT|taC|tgc|gct aRg -
!
! CDR3-------------------------------------------------------------------
!
!  any any Y Y Y G any G S any Y N any any S Y Y
      nnk nnk tac tac tat ggt nnk ggc tct nnk tac aat nnk nnk tct tat tac
!
!  A E Y F Q H
      gct gag tac ttt caa cat
!
! JH1......................................
```

| | |
|---|---|
| ! W G Q G T L V T V S S | (SEQ ID NO: 82) |
| tgg ggc cag ggt act ctG GTC ACC gtc tcc agt-3′ | (SEQ ID NO: 83) |
| ! BstEII... | |
| (C23D310) 5′-GCA\|GtT\|taT\|taC\|tgc\|gct act cck nnk tac tac tat ggt nnk ggc- | (SEQ ID NO: 84) |
| tct nnk tac aat nnk nnk tct tat tac gct gag tac ttt caa cat tgg ggc cag- | |
| ggt act ct-3′ | |
| ON_1, ON_2, ON_3, and ON_4 as above. | |

### Design 3

| 1 1 2 2 | |
|---|---|
| 1 5 0 5 0 3 | |
| YYCAK DSYYYGSGSYYNSDSYSAEYFQHWGQGTLVTVSS | (SEQ ID NO: 900) |
| YYCAK XZYZZGZGZXYNZXZYZAXZFQHWGQGTLVTVSS | (SEQ ID NO: 84 940) |
| R YYYGSGSYYN AEYFQHWGQGTLVTVSS | (JH1) |
| (SEQ ID NO: 81) (SEQ ID NO: 66) | |

| | |
|---|---|
| Amino-acid diversity = | 1.64 E 8 |
| DNA diversity = | 1.07 E 9 |
| Stop-free = | 88% |
| Gratuitous Cys-free = | 88% |
| Free of stop and Cys = | 77% |

Design 3 (C23D310B) has 94 as R or K, XZ, D3-10 (RF2) with 2^{nd}, 3^{rd}, 5^{th}, and 7^{th} as Z(Y|S) and 8^{th} residue changed to X, ZXZYZ, and JH1 (with the E changed to X). Z is either Y or S. The CDR3 is 23 AA long and could be further diversified by use of error-prone PCR.

| A V Y Y C A R\|K any Y\|S Y Y\|S Y\|S G Y\|S | |
|---|---|
| (C23D310b) 5′-GCA\|GtT\|taT\|taC\|tgc\|gct aRg nnk tmc tac tmc tmt ggt tmc ggc- | |
| Y\|S any Y N Y\|S any Y\|S Y Y\|S A any Y\|S F Q H W G Q | |
| tmt nnk tac aat tmt nnk tmc tat tmc gct nnk tmc ttt caa cat tgg ggc cag- | |
| G T L | (SEQ ID NO: 85) |
| ggt act ct-3′ | (SEQ ID NO: 86) |

ON_1, ON_2, ON_3, and ON_4 as above.

### Design 4

| 1 1 2 2 2 3 3 | |
|---|---|
| 1 5 0 5 0 3 5 0 5 | |
| YYCAK YYSFSYYPYYYDSSGYYYGYYSDYSYSYYAEYFQHWGQGTLVTVSS | (SEQ ID NO: 901) |
| YYCAK YYSXSYYXYZYDSZGYZYXYYSXYZYZZZAZZFQHWGQGTLVTVSS | (SEQ ID NO: 87) |
| R YYYDSSGYYY AEYFQHWGQGTLVTVSS | (JH1) |

| (SEQ ID NO: 88) (SEQ ID NO: 66) | |
|---|---|
| 1 1 1 1 | |
| 9 9 0 0 0 1 | |
| 4 5 0 2abcdefghijklmnopqrstuvwxyab3 0 | |
| ′′ | |
| Amino-acid diversity = | 1.64 E 8 |
| DNA diversity = | 1.07 E 9 |
| Stop-free = | 88% |
| Gratuitous Cys-free = | 88% |
| Free of stop and Cys = | 77% |

Design 4 has CDR3 of length 35. Residue 94 can be K or R, then YYS::X::SYY::X::D3-22(2^{nd} RF with one S as X and 3 Zs)::X::YYS::X::YZZZ::JH1(with 2 Zs). Error-prone PCR could be used to add more diversity.

```
C35D322JH1
!  scab DNA S R D N S K N T L Y L Q M N S
5′-ttc|act|atc|TCT|AGA|gac|aac|tct|aag|aat|act|ctc|tac|ttg|cag|atg|aac|agC-
!  XbaI . . .
!
!  L R A E D T A V Y Y C A K|R
    |TTA|AGg|gct|gag|gaT|aCT|GCA|GtT|taT|taC|tgc|gct aRg -
!
!  CDR3-------------------------------------------------------------------
!
!  Y Y S any S Y Y any Y Y|S Y D S Y|S G Y Y|S Y
      tac tat tcc nnk tct tac tat nnk tat tmt tac gat agt tmt ggt tac tmc tat
!
      any Y Y S any Y Y|S Y Y|S Y|S Y|S A Y|S Y|S F Q H
      nnk tac tat agc nnk tat tmc tac tmc tmt tmc gct tmt tmc ttc caa cac
!
```

| | |
|---|---|
| ! W G Q G T L V T V S S | (SEQ ID NO: 89) |
| tgg ggc cag ggt act ctG GTC ACC gtc tcc agt-3′ | (SEQ ID NO: 90) |
| ! BstEII . . . | |
| (c35d322B) 5′-GCA\|GtT\|taT\|taC\|tgc\|gct aRg tac tat tcc nnk tct tac tat nnk- | (SEQ ID NO: 91) |
| tat tmt tac gat act cct ggt tac tmc tat nnk tac tat agc nnk tat tmc tac- | |
| tmc tmt tmc gct tmt tmc ttc caa cac tgg ggc cag ggt act ct-3′ | |
| ON_1, ON_2, ON_3, and ON_4 as above. | |

### Design 5

| 1 1 2 2 | |
|---|---|
| 1 5 0 5 0 3 | |
| YYCAK SSGYCSSTSCYTGVYYYAEYFQHWGQGTLVTVSS | (SEQ ID NO: 902) |
| YYCAK ZZGZCZZXZCZTXXYZYXZYFQHWGQGTLVTVSS | (SEQ ID NO: 92) |
| R GYCSSTSCYT AEYFQHWGQGTLVTVSS | (JH1) |

| (SEQ ID NO: 70) (SEQ ID NO: 66) | |
|---|---|
| Amino-acid diversity = | 1.64 E 8 |
| DNA diversity = | 1.07 E 9 |
| Stop-free = | 88% |
| Gratuitous Cys-free = | 88% |
| Free of stop and Cys = | 77% |

Design 5(C23D222b) is like design 1 but uses many Z (Y or S) variable codons. This CDR3 is 23 long.

```
C23D222JH1b
!  scab DNA S R D N S K N T L Y L Q M N S
5′-ttc|act|atc|TCT|AGA|gac|aac|tct|aag|aat|act|ctc|tac|ttg|cag|atg|aac|agC-
!  XbaI . . .
!
!  L R A E D T A V Y Y C A K|R
    |TTA|AGg|gct|gag|gaT|aCT|GCA|GtT|taT|taC|tgc|gct aRg -
!
!CDR3-------------------------------------------------------------------
!  Y|S Y|S G Y|S C Y|S Y|S any Y|S C Y|S T any any Y Y|S Y any
      tmc tmt ggt tmt tgc tmc tmt nnk tmt tgt tmc acc nnk nnk tat tmt tac nnk
!
!  Y|S Y F Q H
      tmt tat ttc cag cac
!
```

| | |
|---|---|
| ! W G Q G T L V T V S S | (SEQ ID NO: 93) |
| tgg ggc cag ggt act ctG GTC ACC gtc tcc agt-3′ | (SEQ ID NO: 94) |
| ! BstEII . . . | |
| (C23D222JH1b) 5′-GCA\|GtT\|taT\|taC\|tgc\|gct aRg tmc tmt ggt tmt tgc tmc tmt- | (SEQ ID NO: 95) |
| nnk tmt tgt tmc acc nnk nnk tat tmt tac nnk tmt tat ttc cag cac | |
| tgg ggc-cag ggt act ct-3′ | |

### Design 6

```
                              1 1 2 2 2 3 3
            1 5 0 5 0 3 5 0 5
```

| | |
|---|---|
| YYCAK SYDYYGYCSSTSCYTYYSYVSYSSYYSYYAEYFQHWGQGTLVTVSS | (SEQ ID NO: 903) |
| YYCAK ZYXZYGZCZZXSCZTYZSZXZYSZYZSZYAEZFQHWGQGTLVTVSS | (SEQ ID NO: 96) |
| R GYCSSTSCYT D2-2.2 AEYFQHWGQGTLVTVSS | (JH1) |

(SEQ ID NO: 70) (SEQ ID NO: 66)

| | |
|---|---|
| Amino-acid diversity = | 2.00 E 8 |
| DNA diversity = | 5.37 E 8 |
| Stop-free = | 91% |
| Gratuitous Cys-free = | 91% |
| Free of stop and Cys = | 83% |

```
C35D222JH1
!
!  scab DNA S R D N S K N T L Y L Q M N S
5′-ttc|act|atc|TCT|AGA|gac|aac|tct|aag|aat|act|ctc|tac|ttg|cag|atg|aac|agC-
!  XbaI . . .
!
!  L R A E D T A V Y Y C A K|R
    |TTA|AGg|gct|gag|gaT|aCT|GCA|GtT|taT|taC|tgc|gct aRg -
!
! CDR3-------------------------------------------------------------------
! Y|S Y any Y|S Y G Y|S C Y|S Y|S any S C Y|S T Y Y|S S
    tmt tac nnk tmc tac ggc tMt tgc tmt tmc nnk tCt tgt tmc acc tat tmt tcc
!
! Y|S any Y|S Y S any Y Y|S S Y|S Y A E Y F Q H
    tmt nnk tmc Tat tct nnk tac tmc agt tmt tat gct gag tat ttc cag cac
!
```

| | |
|---|---|
| ! W G Q G T L V T V S S | (SEQ ID NO: 97) |
| tgg ggc cag ggt act ctG GTC ACC gtc tcc agt-3′ | (SEQ ID NO: 98) |
| ! BstEII . . . | |
| (C35D222JH1)5′-GCA\|GtT\|taT\|taC\|tgc\|gct aRg tmt tac nnk tmc tac ggc tat- | (SEQ ID NO: 99) |
| tgc tmt tmc nnk tmt tgt tmc acc tat tmt tcc tmt nnk tmc tat tct nnk tac- | |
| tmc agt tmt tat gct gag tat ttc cag cac tgg ggc cag ggt act ct-3′ | |

### Design 7

```
                              1 1 2 2 2 3 3
            1 5 0 5 0 3 5 0 5
```

| | |
|---|---|
| YYCAK YYSYYGYCSSTSCYTYSSSVSYSYYSSYYAEYFQHWGQGTLVTVSS | (SEQ ID NO: 904) |
| YYCAK ZYZZYGZCZZXZCZTYZSZXZYSZYZSZYAψZJQBWGQGTLVTVSS | (SEQ ID NO: 100) |
| R GYCSSTSCYT D2-2.2 AEYFQHWGQGTLVTVSS | (JH1) |

(SEQ ID NO: 70) (SEQ ID NO: 66)
(J = FSY, B = YHND, ψ = EKQ)

| | |
|---|---|
| Amino-acid diversity = | 9.44 E 8 |
| DNA diversity = | 2.42 E 9 |
| Stop-free = | 93% |
| Gratuitous Cys-free = | 93% |
| Free of stop and Cys = | 88% |

```
C35D222JH1B
!
!  scab DNA S R D N S K N T L Y L Q M N S
5′-ttc|act|atc|TCT|AGA|gac|aac|tct|aag|aat|act|ctc|tac|ttg|cag|atg|aac|agC-
!  XbaI . . .
!
!  L R A E D T A V Y Y C A K|R
    |TTA|AGg|gct|gag|gaT|aCT|GCA|GtT|taT|taC|tgc|gct aRg -
!
!  CDR3----------------------------------------------------------------
!  Y|S Y Y|S Y|S Y G Y|S C Y|S Y|S any Y|S C Y|S T Y Y|S S
      tmt tac tmc tmc tac ggc tMt tgc tmt tmc nnk tmt tgt tmc acc tat tmt tcc
!
!  Q Y N|D
!  Y|S any Y|S Y S Y|S Y Y|S S Y|S Y A E|K Y|S F|S Q H|Y
      tmt nnk tmc tat tct tmt tac tmc agt tmt tat gct Vag tmt tHc cag Nac
!
```

| | |
|---|---|
| ! W G Q G T L V T V S S | (SEQ ID NO: 101) |
| tgg ggc cag ggt act ctG GTC ACC gtc tcc agt-3′ | (SEQ ID NO: 102) |
| ! BstEII . . . | |

### Design 8

```
                              1 1 2 2 2 3 3
            1 5 0 5 0 3 5 0 5
```

| | |
|---|---|
| YYCAK SRSYYDYVWGSYRYTSSYSYYSYSYSSYAEYFQHWGQGTLVTVSS | (SEQ ID NO: 905) |
| YYCAK ZXZYZBZVWGZZRZTZSZXZYZZZYZSZAψZFQHWGQGTLVTVSS | (SEQ ID NO: 103) |
| R YYDYVWGSYRYT D3-16.2 AEYFQHWGQGTLVTVSS | (JH1) |

(SEQ ID NO: 104) (SEQ ID NO: 66)
(J = FSY, B = YHND ψ = EKQ)

| | |
|---|---|
| Amino-acid diversity = | 9.44 E 8 |
| DNA diversity = | 1.61 E 9 |
| Stop-free = | 93% |
| Gratuitous Cys-free = | 93% |
| Free of stop and Cys = | 88% |

```
C34D316JH1A
!
!  scab DNA S R D N S K N T L Y L Q M N S
5′-ttc|act|atc|TCT|AGA|gac|aac|tct|aag|aat|act|ctc|tac|ttg|cag|atg|aac|agC-
!  XbaI . . .
!
!  L R A E D T A V Y Y C A K|R
    |TTA|AGg|gct|gag|gaT|aCT|GCA|GtT|taT|taC|tgc|gct aRg -
! CDR3----------------------------------------------------------------
!  N|D
!  Y|S any Y|S Y Y|S Y|H Y|S V W G Y|S Y|S R Y|S T Y|S
      tmt nnk tmc tac tmt Nat tmt gtt tgg ggt tmt tmc cgt tmt act tmt
!
!  S Y|S any Y|S Y Y|S Y|S Y|S Y Y|S S Y|S
      agt tmt nnk tmt tac tmc tmt tmc tat tmc agt tmt
!
!  Q
!  A E|K Y|S F Q H
      GCT vag tmc ttc cag cat
!
```

| | |
|---|---|
| ! W G Q G T L V T V S S | (SEQ ID NO: 105) |
| tgg ggc cag ggt act ctG GTC ACC gtc tcc agt-3′ | (SEQ ID NO: 106) |
| ! BstEII . . . | |
| (C34D316JH1A) 5′-GCA\|GtT\|taT\|taC\|tgc\|gct aRg tmt nnk tmc tac tmt Nat tmt- | (SEQ ID NO: 107) |
| gtt tgg ggt tmt tmc cgt tmt act tmt agtact cck tmt tac tmc tmt tmc tat- | |
| tmc agt tmt GCT vag tmc ttc cag cat tgg ggc cag ggt act ct -3′ | |

### Design 9

Design 9 is like 8 except the D segment is moved to the right

```
                              1 1 2 2 2 3 3
            1 5 0 5 0 3 5 0 5
```

| | |
|---|---|
| YYCAK YGYSSDSYYSSYYDYVWGSYRYTYSSYYAEYFQHWGQGTLVTVSS | (SEQ ID NO: 906) |
| YYCAK ZXZZZXZYZZZYZBZVWGZZRZTYZSZYAψZFQHWGQGTLVTVSS | (SEQ ID NO: 108) |
| R D3-16.2 YYDYVWGSYRYT AEYFQHWGQGTLVTVSS | (JH1) |

(SEQ ID NO: 104) (SEQ ID NO: 66)
(J = FSY, B = YHND, ψ = EKQ)

| | |
|---|---|
| Amino-acid diversity = | 1.31 E 8 |
| DNA diversity = | 5.37 E 8 |
| Stop-free = | 91% |
| Gratuitous Cys-free = | 91% |
| Free of stop and Cys = | 83% |

```
C34D316JH1B
!
!  scab DNA S R D N S K N T L Y L Q M N S
5′-ttc|act|atc|TCT|AGA|gac|aac|tct|aag|aat|act|ctc|tac|ttg|cag|atg|aac|agC-
!  XbaI . . .
!
!  L R A E D T A V Y Y C A K|R
    |TTA|AGg|gct|gag|gaT|aCT|GCA|GtT|taT|taC|tgc|gct aRg -
!
! CDR3-------------------------------------------------------------------
!  Y|S any Y|S Y|S Y|S any Y|S Y Y|S Y|S Y|S
      tmt nnk tmc tmt tmc nnk tmt tac tmc tmt tmc
!
!  N|D
!  Y Y|S Y|H Y|S V W G Y|S Y|S R Y|S T
      tac tmt Nat tmt gtt tgg ggt tmt tmc cgt tmt act
!
!  Y Y|S S Y|S Y
      tat tmc agt tmt tac
!
!  Q
!  A E|K Y|S F Q H
      GCT vag tmc ttc cag cat
!
```

| | |
|---|---|
| ! W G Q G T L V T V S S | (SEQ ID NO: 109) |
| tgg ggc cag ggt act ctG GTC ACC gtc tcc agt-3′ | (SEQ ID NO: 110) |
| ! BstEII . . . | |
| (C35D316JH1B) | |
| 5′-GCA\|GtT\|taT\|taC\|tgc\|gct aRg tmt nnk tmc tmt act cck tmt tac tmc tmt tmc | (SEQ ID NO: 111) |
| tac tmt Nat tmt gtt tgg ggt tmt tmc cgt tmt act tat tmc agt tmt tac GCT | |
| vag tmc ttc cag cat tgg ggc cag ggt act ct-3′ | |

### Design 10

| 1 1 2 2 | |
|---|---|
| 1 5 0 5 0 4 | |
| YYCAK GSSYYYGSGSYYNSDYYSAEYFQHWGQGTLVTVSS | (SEQ ID NO: 907) |
| YYCAK XZZYZZGZGZXYNZXZYZAXZFQHWGQGTLVTVSS | (SEQ ID NO: 112) |
| R YYYGSGSYYN AEYFQHWGQGTLVTVSS | (JH1) |

(SEQ ID NO: 81) (SEQ ID NO: 66)

Design 10 (C24D310B) is like Design 3, but the CDR3 is of length 24. Design 10 has 94 as R or K, XZZ, D3-10 (RF2) with 2^{nd}, 3^{rd}, 5^{th}, and 7^{th} as Z(Y|S) and 8^{th} residue changed to X, ZXZYZ, and JH1 (with the E changed to X). Z is either Y or S. The CDR3 is 24 AA long and could be further diversified by use of error-prone PCR.

| | |
|---|---|
| (C24D310b) 5′-GCA\|GtT\|taT\|taC\|tgc\|gct aRg act ccc tmc tac tmc tmt ggt | (SEQ ID NO: 113) |
| tmc-ggc tmt nnk tac aat tmt nnk tmc tat tmc gct nnk tmc ttt caa cat | |
| tgg ggc-cag ggt act ct-3′ | |
| ON_1, ON_2, ON_3, and ON_4 as above. | |

### Design 11

```
                              1 1 2 2
            1 5 0 5 0 5
```

| | |
|---|---|
| YYCAR SSRSGYCTNGVCYRSGSYWYFDLWGRGTLVTVSS | (SEQ ID NO: 907 981) |
| YYCAR ZZXZGZC32GVCZ3ZXZZ4Z12LWGRGTLVTVSS | (SEQ ID NO: 114) |
| K GYCTNGVCYT YWYFDLWGRGTLVTVSS D2-8.2 | JH2 |

(SEQ ID NO: 115) (SEQ ID NO: 67)
(1 = FYS(THT), 2 = YHND(NAT), 3 = ITKR(ANA), 4 = LSW(TBG))

| | |
|---|---|
| (C24D282) 5′-GCA\|GtT\|taT\|taC\|tgc\|gct aRg tmc tmt nnk tmt ggt tmc tgt ana- | (SEQ ID NO: 116) |
| nat ggt gtc tgc tmt ana tmc nnk tmt tmt tbg tmt tht nat ctg tgg ggc- | |
| cag ggt act ct-3′ | |
| (C24D282.1) 5′-GCA\|GtT\|taT\|taC\|tgc\|gct aRg tmc tmt nnk tmc ggt tmc tgc | (SEQ ID NO: 117) |
| ana-nat ggc gtc tgc tmt ana tmc nnk tmt tmt tbg tmt tht nat ctg tgg | |
| ggc-cag ggt act ct-3′ | |
| (C24D282.1) 5′-GCA\|GtT\|taT\|taC\|tgc\|gct aRg tmc tmt nnk tmc ggt tmc tgc | (SEQ ID NO: 118) |
| ana-nat ggc gtc tgc t-3′ | |
| (needs R, M, N, K) | |
| (C24D282.2) 5′-Ag AgT Acc cTg gcc ccA cAg ATN ADA AKA cVA AKA AKA MNN | (SEQ ID NO: 119) |
| gKA TNT AKA gcA gAc gcc ATN TNT gcA gKA Acc g-3′ | |
| ! 75 bases | |
| (5′-c ggt tmc tgc ana- | (SEQ ID NO: 120) |
| nat ggc gtc tgc tmt ana tmc nnk tmt tmt tbg tmt tht nat ctg tgg ggc- | |
| cag ggt act ct-3′ [RC] | |
| (needs N, M, K, B, H)) | |

### Design 12

```
                              1 1 2 2 3 3
            1 5 0 5 0 5 0 5
```

| | |
|---|---|
| YYCAR SSYYSYGYCTNGVCYTYSYSYYSYSYSYWYFDLWGRGTLVTVSS | (SEQ ID NO: 908) |
| YYCAR ZZZZZZGZC32GVCZ3ZZZZYZZYZYZZ4Z12LWGRGTLVTVSS | (SEQ ID NO: 121) |
| K GYCTNGVCYT YWYFDLWGRGTLVTVSS D2-8.2 | JH2 |

(SEQ ID NO: 115) (SEQ ID NO: 67)
(1 = FYS, 2 = YHND, 3 = ITKR, 4 = LSW, Z = YS)

| | |
|---|---|
| (C33D282TP) 5′-GCA\|GtT\|taT\|taC\|tgc\|gct-3′ | (SEQ ID NO: 909) |
| C33D282BP) 5′-ag agt acc ctg gcc cca-3′ | (SEQ ID NO: 910) |
| (C33D282) 5′-GCA\|GtT\|taT\|taC\|tgc\|gct aRg tmt tmc tmc tmt tmc tmc ggt- | (SEQ ID NO: 122) |
| tmt tgt ana nat ggc gtg tgc tmt ana tmc tmc tmc tmt tat tmt tmc tat | |
| tmt-tac tmt tmc tbg tmc tht nat ctg tgg ggc cag ggt act ct-3′ | |
| (C33D282F) 5′-GCA\|GtT\|taT\|taC\|tgc\|gct agg tct tcc tac tat tcc tac ggt- | (SEQ ID NO: 911) |
| tat tgt aca aat ggc gtg act cct aca tac tcc tac tct tat tat tcc tat | |
| tct-tac tct tac tgg tac ttt gat ctg tgg ggc cag ggt act ct-3′ | |

### Design 13

Design 13 places a germ-line D segment in the middle of a sea of Zs so that one can make two pieces of DNA that overlap throughout the constant region. HC CDR3 is 34 long and diversity is 2²³˜8×10⁶.

```
                              1 1 2 2 3 3
            1 5 0 5 0 5 0 5
```

| | |
|---|---|
| YYCAR SSSYYSYYSSGYCTNGVCYTYSSYYSSYYWYFDLWGRGTLVTVSS | (SEQ ID NO: 912) |
| YYCAR ZZZZZZZZZZGYCTNGVCYTZZZZZZZZZWZF2LWGRGTLVTVSS | (SEQ ID NO: 123) |
| K GYCTNGVCYT YWYFDLWGRGTLVTVSS D2-8.2 | JH2 |

(SEQ ID NO: 115) (SEQ ID NO: 67)
(2 = YHND)

| | |
|---|---|
| (C34D282.2A) 5′-GCA\|GtT\|taT\|taC\|tgc\|gct aRg tmt tmc tmc tmt tmt tmc tmc | (SEQ ID NO: 124) |
| tmt-tmc tmc ggt tat tgt act aac ggc gtt tgc tat act-3′ | |
| (C34D282.2B) 5′-Ag AgT Acc cTg gcc ccA cAg gTN gAA AKA ccA AKA AKA AKA | (SEQ ID NO: 125) |
| gKA-gKA gKA gKA AKA AKA AgT ATA gcA AAc gcc gTT AgT AcA ATA-3′ | |
| ! 86 bases | |
| (5′- tat tgt act aac ggc gtt tgc tat act tmt tmt tmc tmc tmc tmc- | (SEQ ID NO: 126) [RC]) |
| tmt tmt tmt tgg tmt ttc Nac ctg tgg ggc cag ggt act ct-3′ | |

### Design 14

Design 14 is like 9 except the D segment is mostly germline.

| 1 1 2 2 2 3 3 | |
|---|---|
| 1 5 0 5 0 3 5 0 5 | |
| YYCAK YSYYSGSYYYSDYVWGSYRYTSYDSYYYAEYFQHWGQGTLVTVSS | (SEQ ID NO: 913) |
| YYCAK ZZZZZZZZZZZDYVWGSYRZTZZZZZZZAEZFQHWGQGTLVTVSS | (SEQ ID NO: 127) |
| R D3-16.2 YYDYVWGSYRYT AEYFQHWGQGTLVTVSS (JH1) | |
| (SEQ ID NO: 104) (SEQ ID NO: 66^{a}) | |
| (C34D316.2A) | |
| 5′-GCA\|GtT\|taT\|taC\|tgc\|gct aRg tmt tmc tmc tmt tmt tmc tmc tmt- | (SEQ ID NO: 128) |
| tmc tmc tmc gat tat gtc tgg ggt act tat cgt-3′ | |
| (C34D316.2B) | |
| 5′-Ag AgT Acc cTg gcc ccA ATg cTg gAA AKA cTc Agc gKA gKA gKA- | (SEQ ID NO: 129) |
| gKA gKA gKA AKA AgT gKA Acg ATA AgT Acc ccA gAc ATA ATc-3′ ! 86 bases | |
| (5′-gat tat gtc tgg ggt act tat cgt tmc act tmt tmc tmc tmc tmc- | (SEQ ID NO: 130) |
| tmc tmc gct gag tmt ttc cag cat tgg ggc cag ggt act ct-3′ [RC]) | |

### Design 15

Design 15 allows some diversity in the overlap, 5 two-way flip-flops. There are only 32 overlap sequences and even if there are mismatches, they will not change the allowed diversity.

| 1 1 2 2 2 3 3 | |
|---|---|
| 1 5 0 5 0 3 5 0 5 | |
| YYCAK SYDYSSYSYYYDYVWGSYRYTSYSGDSYYAEYFQHWGQGTLVTVSS | (SEQ ID NO: 914) |
| YYCAK ZZZZZZZZZZZDZVWGZZRZTZZZZZZZZAEZFQHWGQGTLVTVSS | (SEQ ID NO: 131) |
| YYDYVWGSYRYT AEYFQHWGQGTLVTVSS | |
| (SEQ ID NO: 104) (SEQ ID NO: 66) | |
| (C35D316.2A) | |
| 5′-GCA\|GtT\|taT\|taC\|tgc\|gct aRg tmt tmc tmc tmt tmt tmc tmc tmt- | (SEQ ID NO: 132) |
| tmc tmc tmc gac tmt gtc tgg ggt tmc tmc cgt tmc acc t-3′ | |
| (C35D316.2B) | |
| 5′Ag AgT Acc cTg gcc ccA ATg cTg gAA AKA cTc Agc gKA gKA- | (SEQ ID NO: 133) |
| gKa gKA gKA gKA gKA AKA ggT gKA Acg gKA gKA Acc ccA gAc AKA gTc | |
| gKA g-3′ | |
| (5′-c tmc gac tmt gtc tgg ggt tmc tmc cgt tmc acc tmt tmc tmc- | (SEQ ID NO: 134) |
| tmc tmc tmc tmc tmc gct gag tmt ttc cag cat tgg ggc cag ggt act | |
| ct-3′ [RC]) | |

### Design 16

Design 16 provides a CDR3 of 35. There are 4 two-way flip-flops in the overlap, thus 16 sequences.

| 1 1 2 2 2 3 3 | |
|---|---|
| 1 5 0 5 0 3 5 0 5 | |
| YYCAK SSSYYSYSYSGYCSGGSCYSSYYYSSYYSAEYFQGWGQGTLVTVSS | (SEQ ID NO: 915) |
| YYCAK ZZZZZZZZZZGZCZGGZCZSZZZZZZZZZAEZFQHWGQGTLVTVSS | (SEQ ID NO: 135) |
| R GYCSGGSCYS 2-25.2 AEYFQHWGQGTLVTVSSJH1 | |
| (SEQ ID NO: 136) (SEQ ID NO: 66) | |
| (C35D225.2A) | |
| 5′-GCA\|GtT\|taT\|taC\|tgc\|gct aRg tmt tmt tmt tmt tmt tmt tmt tmt- | (SEQ ID NO: 137) |
| tmc tmc ggc tmc tgt tmc ggt ggc tmc tgc tmc tcc t-3′ | |
| (C35D225.2B) | |
| 5′-Ag AgT Acc cTg gcc ccA ATg TTg gAA AKA TTc Agc gKA gKA- | (SEQ ID NO: 138) |
| gKA gKA gKA gKA gKA gKA gKA gKA ggA gcA gKA gcc Acc gKA AcA | |
| gKA gcc gKA g-3′! 96 bases | |

If we add C34D225.2A and C34D225.2B to the mixture, then we get CDR3s of lengths 33, 34, and 35.

(C34D225.2A)
(SEQ ID NO: 139)
5'-GCA|GtT|taT|taC|tgc|gct aRg tmt tmt tmt tmt tmt tmt tmt-
tmc tmc ggc tmc tgt tmc ggt ggc tmc tgc tmc tcc t-3′
(C34D225.2B)
(SEQ ID NO: 140)
5'-Ag AgT Acc cTg gcc ccA ATg TTg gAA AKA TTc Agc gKA gKA-
gKA gKA gKA gKA gKA gKA gKA ggA gcA gKA gcc Acc gKA AcA gKA gcc gKA g-3'!
93 bases

### Design 17

| 1 1 2 2 2 3 3 | |
|---|---|
| 1 5 0 5 0 3 5 0 5 | |
| YYCAK YSSYSYYDYVWGSYRYTSSSYSYYSYYYAEYFQGWGQGTLVTVSS | (SEQ ID NO: 916) |
| YYCAK ZZZZZZZDZVWGZZRZTZZZZZZZZZZZAEZFQHWGQGTLVTVSS | (SEQ ID NO: 141) |
| R YYDYVWGSYRYT D3-16.2 AEYFQHWGQGTLVTVSS (JH1) | |
| (SEQ ID NO: 104) (SEQ ID NO: 66) | |
| (C35D3162A) | |
| 5′-GCA\|GtT\|taT\|taC\|tgc\|gct aRg tmt tmt tmt tmt tmt tmt tmc gac- | (SEQ ID NO: 142) |
| tmc gtc tgg ggt tmt tmc cgt tmt acc t-3′ | |
| (C35D3162B) | |
| 5′-Ag AgT Acc cTg gcc ccA gTg cTg gAA gKA cTc Agc gKA gKA gKA- | (SEQ ID NO: 143) |
| gKA gKA gKA gKA gKA gKA gKA gKA gKA gKA ggT AKA Acg gKA AKA Acc | |
| ccA gAc-gKA gTc g-3′ | |

### Design 18

| 1 1 2 2 2 3 3 | |
|---|---|
| 1 5 0 5 0 3 5 0 5 | |
| YYCAK SSYYYSSSYYDYVWGSYRYTSSYYSYSYAEYFQGWGQGTLVTVSS | (SEQ ID NO: 917) |
| YYCAK ZZZZZZZZZZDZVWGZZRZTZZZZZZZZAEZFQHWGQGTLVTVSS | (SEQ ID NO: 144) |
| R YYDYVWGSYRYT D3-16.2AEYFQHWGQGTLVTVSS (JH1) | |
| (SEQ ID NO: 104) (SEQ ID NO: 66) | |
| (C35D3162C) | |
| 5′-GCA\|GtT\|taT\|taC\|tgc\|gct aRg tmt tmt tmt tmt tmt tmt tmc- | (SEQ ID NO: 145) |
| tmc tmc tmc gac tmc gtc tgg ggt tmc tmc cgt tmc acc t-3′ | |
| 82 bases | |
| (C35D3162B) | |
| 5′-Ag AgT Acc cTg gcc ccA gTg cTg gAA gKA cTc Agc gKA gKA- | (SEQ ID NO: 146) |
| gKA gKA gKA gKA gKA gKA gKA gKA ggT gKA Acg gKA gKA Acc ccA | |
| gAc gKA-gTc g-3′ | |

### Design 19

| 1 1 2 2 2 3 3 | |
|---|---|
| 1 5 0 5 0 3 5 0 5 | |
| YYCAK YSGDSYSYYYYDSSGYYYSYYSSSYYSYYAEYFQGWGQGTLVTVSS | (SEQ ID NO: 918) |
| YYCAK ZZZZZZZZZZZDSSGZZZZZZZZZZZZZZAEZFQHWGQGTLVTVSS | (SEQ ID NO: 147) |
| R YYYDSSGYYY AEYFQHWGQGTLVTVSS (JH1) | |
| (SEQ ID NO: 88) (SEQ ID NO: 66) | |
| 1 1 1 1 | |
| 9 9 0 0 0 1 | |
| 4 5 0 2abcdefghijklmnopqrstuvwxyab3 0 | |
| ′′ | |
| Amino-acid diversity = 6.7 E 7 | |
| DNA diversity = 6.7 E 7 | |
| Stop-free = 100 | |
| Gratuitous Cys-free = 100 | |
| Free of stop and Cys = 100% | |

Design 19 has CDR3 of length 35. Residue 94 can be K or R, The ZZZZZZZZZ::D3-22(2^{nd} RF with six Ys as Z)::ZZZZZZZZZZZ::JIH1(with 1 Z). Error-prone PCR could be used to add more diversity.

```
C35D322AJH1
!  scab DNA S R D N S K N T L Y L Q M N S
5′-ttc|act|atc|TCT|AGA|gac|aac|tct|aag|aat|act|ctc|tac|ttg|cag|atg|aac|agC-
!  XbaI...
!
!  L R A E D T A V Y Y C A K|R
    |TTA|AGg|gct|gag|gaT|aCT|GCA|GtT|taT|taC|tgc|gct aRg -
!
!  CDR3-------------------------------------------------------------------
!
!  Y|S Y|S Y|S Y|S Y|S Y|S Y|S Y|S Y|S Y|S Y|S D S S G Y|S Y|S Y|S
      tmc tmt tmc tmc tmt tmc tmt tmc tmc tmc tmc gac agc tcc ggc tmc tmc tmt
!
      Y|S Y|S Y|S Y|S Y|S Y|S Y|S Y|S Y|S Y|S Y|S A E Y|S F Q H
      tmc tmt tmc tmc tmt tmc tmt tmc tmc tmc tmc gct gaa tmc ttc caa cac
!
!  W G Q G T L V T V S S (SEQ ID NO: 148)
      tgg ggc cag ggt act ctG GTC ACC gtc tcc agt-3′  (SEQ ID NO: 149)
!  BstEII...
(C35D322AJH1_T) 5′-GCA|GtT|taT|taC|tgc|gct aRg tmc tmt tmc tmc tmt-
  tmc tmt tmc tmc tmc tmc gac agc tcc ggc tmc tmc t-3′ (SEQ ID NO: 150)
(C35D322AJH1_B) 5′-cAg AgT Acc cTg gcc ccA gTg TTg gAA gKA TTc Agc gKA-
      gKA gKA gKA AKA gKA AKA gKA gKA AKA gKA AKA gKA gKA gcc ggA gcT gTc-
      gKA gKA g-3′  (SEQ ID NO: 151)
ON_1, ON_2, ON_3, and ON_4 as above.
```

### Design 20

| 1 1 2 2 2 3 3 | |
|---|---|
| 1 5 0 5 0 3 5 0 5 | |
| YYCAK YSSYSS YYYYDSSGYYYSSYSSYS YYYAEYFQGWGQGTLVTVSS | (SEQ ID NO: 919) |
| YYCAK ZZZZZZ(Z)ZZZZDSSGZZZZZZZZZZ(Z)ZZZAEZFQHWGQGTLVTVSS | (SEQ ID NO: 152) |
| R YYYDSSGYYY AEYFQHWGQGTLVTVSS (JH1) | |
| (SEQ ID NO: 88) (SEQ ID NO: 66) | |
| 1 1 1 1 | |
| 9 9 0 0 0 1 | |
| 4 5 0 3abcdefghijklmnop q rstuvwxya4 0 | |
| ′ | |
| Amino-acid diversity = 6.7 E 7 | |
| DNA diversity = 6.7 E 7 | |
| Stop-free = 100 | |
| Gratuitous Cys-free = 100 | |
| Free of stop and Cys = 100% | |

Design 20 has CDR3s of length 33, 34, or 35. Residue 94 can be K or R, The ZZZZZZ(Z)ZZ::D3-22(2^{nd} RF with six Ys as Z)::ZZZZZZZ(Z)ZZZ::JH1(with 1 Z). PCR combining (C35D322AJH1_T), (C34D322AJH1_T), (C35D322AJH1_B), and (C34D322AJH1_B) allows length as well as sequence diversity.

(C35D322AJH1_T)
(SEQ ID NO: 153)
5′-GCA|GtT|taT|taC|tgc|gct aRg tmc tmt tmc tmc-
tmt tmc tmt tmc tmc tmc tmc gac agc tcc ggc tmc
tmc t-3′
(C34D322AJH1_T)
(SEQ ID NO: 154)
5′-GCA|GtT|taT|taC|tgc|gct aRg tmc tmc tmc tmt-
tmc tmt tmc tmc tmc tmc gac agc tcc ggc tmc tmc
t-3′
(C35D322AJH1_B)
(SEQ ID NO: 920)
5′-cAg AgT Acc cTg gcc ccA gTg TTg gAA gKA TTc
Agc gKA-gKA gKA gKA AKA gKA AKA gKA gKA AKA gKA
AKA gKA gKA gcc ggA gcT gTc-gKA gKA g-3′
(C34D322AJH1_B)
(SEQ ID NO: 155)
5′-cAg AgT Acc cTg gcc ccA gTg TTg gAA gKA TTc
Agc gKA-gKA gKA gKA AKA gKA AKA gKA gKA AKA AKA
gKA gKA gcc ggA gcT gTc-gKA gKA g-3′

### Selection Against Stop Codons:

Because some of these libraries have NNK codons, they will have some TAG stop codons. We could remove the clones with TAG by cloning the amplified DNA into an XbaI-BstEII site between the signal sequence for a bla gene and the actual bla protein and express in Sup⁰ cells. Bla^{R} colonies do not contain TAG stops. Alternatively, we could clone the XbaI-BstEII fragments ahead of a kanamycin-resistance gene and select for Kan^{R}. We would then move the XbaI-BstEII cassette into the phage library.

Also, because wobbling allows some stop codons, we can improve the library by removing the clones with stops by cloning the amplified DNA into an XbaI-BstEII site between the signal sequence for a bla gene and the actual bla protein and express in Sup⁰ cells. Bla^{R} colonies do not contain stops. Alternatively, we can clone the XbaI-BstEII fragments ahead of a kanamycin-resistance gene and select for Kan^{R}. We can then move the XbaI-BstEII cassette into the phage library.

TABLE 20
Frequency of D segments i21,578 Abs

| D1-1.1 | (SEQ ID NO: 156) | D1-1.2 | (SEQ ID NO: 157) | D1-1.3 | (SEQ ID NO: 158) |
|---|---|---|---|---|---|
| | GTTGT | | VQLER | | YNWND |
| | 23 | | 12 | | 44 |
| D1-7.1 | (SEQ ID NO: 159) | D1-7.2 | (SEQ ID NO: 160) | D1-7.3 | (SEQ ID NO: 161) |
| | GITGT | | V@LEL | | YNWNY |
| | 55 | | 5 | | 111 |
| D1-14.1 | (SEQ ID NO: 159) | D1-14.2 | (SEQ ID NO: 930 982) | D1-14.3 | (SEQ ID NO: 931 983) |
| | GITGT | | V@PEP | | YNRNH |
| | 0 | | 0 | | 0 |
| D1-20.1 | (SEQ ID NO: 159) | D1-20.2 | (SEQ ID NO: 162) | D1-20.3 | (SEQ ID NO: 163) |
| | GITGT | | V@LER | | YNWND |
| | 15 | | 0 | | 41 |
| D1-26.1 | (SEQ ID NO: 164) | D1-26.2 | (SEQ ID NO: 165) | D1-26.3 | (SEQ ID NO: 166) |
| | GIVGAT | | V*WELL | | YSGSYY |
| | 191 | | 72 | | 333 |
| D2-2.1 | (SEQ ID NO: 171 & 167) | D2-2.2 | (SEQ ID NO: 70) | D2-2.3 | (SEQ ID NO: 168) |
| | RIL**YQLLY | | GYCSSTSCYT | | DIVVVPAAI |
| | 27 | | 175 | | 142 |
| D2-8.1 | (SEQ ID NO: 169 & 392) | D2-8.2 | (SEQ ID NO: 115) | D2-8.3 | (SEQ ID NO: 170) |
| | RILY@WCMLY | | GYCTNGVCYT | | DIVLMVYAI |
| | 3 | | 34 | | 12 |
| D2-15.1 | (SEQ ID NO: 171) | D2-15.2 | (SEQ ID NO: 136) | D2-15.3 | (SEQ ID NO: 172) |
| | RIL*WW*LLL | | GYCSGGSCYS | | DIVVVVAAT |
| | 3 | | 233 | | 63 |
| D2-21.1 | (SEQ ID NO: 173) | D2-21.2 | (SEQ ID NO: 174) | D2-21.3 | (SEQ ID NO: 175) |
| | SILWW$LLF | | AYCGGDCYS | | HIVVVTAI |
| | 4 | | 52 | | 33 |
| D3-3.1 | (SEQ ID NO: 176) | D3-3.2 | (SEQ ID NO: 177) | D3-3.3 | (SEQ ID NO: 178) |
| | VLRFLEWLLY | | YYDFWSGYYT | | ITIFGVVII |
| | 114 | | 1236 | | 121 |
| D3-9.1 | (SEQ ID NO: 179) | D3-9.2 | (SEQ ID NO: 180) | D3-9.3 | (SEQ ID NO: 181 & 579) |
| | VLRYFDWLL@ | | YYDILTGYYN | | ITIF$LVI1 |
| | 145 | | 239 | | 2 |
| D3-10.1 | (SEQ ID NO: 182) | D3-10.2 | (SEQ ID NO: 81) | D3-10.3 | (SEQ ID NO: 183) |
| | VLLWFGELL@ | | YYYGSGSYYN | | ITMVRGVII |
| | 396 | | 724 | | 281 |
| D3-16.1 | (SEQ ID NO: 184) | D3-16.2 | (SEQ ID NO: 104) | D3-16.3 | (SEQ ID NO: 185) |
| | VL$LRLGELSLY | | YYDYVWGSYRYT | | IMITFGGVIVI |
| | 19 | | 305 | | 48 |
| D3-22.1 | (SEQ ID NO: 186) | D3-22.2 | (SEQ ID NO: 187) | D3-22.3 | (SEQ ID NO: 188) |
| | VLL$**WLLL | | YYYDSSGYYY | | ITMIVVVIT |
| | 8 | | 1290 | | 37 |
| D4-4.1 | (SEQ ID NO: 189) | D4-4.2 | (SEQ ID NO: 88 192) | D4-4.3 | (SEQ ID NO: 190) |
| | $LQ@L | | DYSNY | | TTVT |
| | 0 | | 47 | | 20 |
| D4-11.1 | (SEQ ID NO: 191) | D4-11.2 | (SEQ ID NO: 192) | D4-11.3 | (SEQ ID NO: 193) |
| | $LQ@L | | DYSNY | | TTVT |
| | 0 | | 0 | | 0 |
| D4-17.1 | (SEQ ID NO: 194) | D4-17.2 | (SEQ ID NO: 195) | D4-17.3 | (SEQ ID NO: 196) |
| | $LR$L | | DYGDY | | TTVT |
| | 0 | | 297 | | 93 |
| D4-23.1 | (SEQ ID NO: 197) | D4-23.2 | (SEQ ID NO: 198) | D4-23.3 | (SEQ ID NO: 199) |
| | $LRW@L | | DYGGNS | | TTVVT |
| | 11 | | 136 | | 25 |
| D5-5.1 | (SEQ ID NO: 200) | D5-5.2 | (SEQ ID NO: 201) | D5-5.3 | (SEQ ID NO: 202) |
| | QGFLPR | | KGFCPD | | RVSAQT |
| | 0 | | 0 | | 0 |
| D5-12.1 | (SEQ ID NO: 203) | D5-12.2 | (SEQ ID NO: 204) | D5-12.3 | (SEQ ID NO: 205) |
| | VDIVATI | | WI*WLRL | | GYSGYDY |
| | 37 | | 24 | | 235 |
| D5-18.1 | (SEQ ID NO: 206) | D5-18.2 | (SEQ ID NO: 207) | D5-18.3 | (SEQ ID NO: 208) |
| | VDTAMV | | WIQLWL | | GYSYGY |
| | 82 | | 65 | | 404 |
| D5-24.1 | (SEQ ID NO: 209) | D5-24.2 | (SEQ ID NO: 210) | D5-24.3 | (SEQ ID NO: 211) |
| | VEMATI | | *RWLQL | | RDGYNY |
| | 35 | | 83 | | 126 |
| D6-6.1 | (SEQ ID NO: 212) | D6-6.2 | (SEQ ID NO: 213) | D6-6.3 | (SEQ ID NO: 214) |
| | EYSSSS | | SIAAR | | V*QLV |
| | 221 | | 145 | | 6 |
| D6-13.1 | (SEQ ID NO: 215) | D6-13.2 | (SEQ ID NO: 216) | D6-13.3 | (SEQ ID NO: 217) |
| | GYSSSWY | | GIAVAG | | V*QQLV |
| | 683 | | 383 | | 52 |
| D6-19.1 | (SEQ ID NO: 218) | D6-19.2 | (SEQ ID NO: 219) | D6-19.3 | (SEQ ID NO: 220) |
| | GYSSGWY | | GIAVAG | | V*QWLV |
| | 866 | | 286 | | 106 |
| D6-25.1 | (SEQ ID NO: 932) | D6-25.2 | (SEQ ID NO: 933) | D6-25.3 | (SEQ ID NO: 934) |
| | GYSSGY | | GIAAA | | V*QRL |
| | 12 | | 2 | | 0 |
| D7-27.1 | (SEQ ID NO: 221) | D7-27.2 | (SEQ ID NO: 222) | D7-27.3 | (SEQ ID NO: 223) |
| | LTG | | @LG | | NWG |
| | 5 | | 0 | | 13 |

*for TAG; @ for TAA; $ for TGA

TABLE 3
Human JH segments

| JH-Amino acid sequences and | | | |
|---|---|---|---|
| frequencies of use | | | |
| | CDR3 | | |
| | --------- | | |
| | 100 110 | | |
| | \| FR4-----\|-- | Frequency | |
| JH1 | ---AEYFQHWGQGTLVTVSS | 828 | (SEQ ID NO: 66) |
| JH2 | ---YWYFDLWGRGTLVTVSS | 1311 | (SEQ ID NO: 67) |
| JH3 | -----AFDIWGQGTMVTVSS | 5471 | (SEQ ID NO: 2) |
| JH4 | -----YFDYWGQGTLVTVSS | 7917 | (SEQ ID NO: 1) |
| JH5 | ----NWFDPWGQGTLVTVSS | 1360 | (SEQ ID NO: 68) |
| JH6 | YYYYYGMDVWGQGTTVTVSS | 4691 | (SEQ ID NO: 3) |
| | 111 | | |
| | 999999000 | | |
| | 456789012 | 21578 = | |
| | | total | |
| | Jstump...FR4........ | | |

TABLE 11
Trimers that can be extracted from human D segments

| | | | |
|---|---|---|---|
| GTT | D1-1.1.1 | 1 | |
| VQL | D1-1.2.1 | 2 | |
| YNW | D1-1.3.1 | 3 | |
| TTG | D1-1.1.2 | 4 | |
| QLE | D1-1.2.2 | 5 | |
| NWN | D1-1.3.2 | 6 | |
| TGT | D1-1.1.3 | 7 | |
| LER | D1-1.2.3 | 8 | (SEQ ID NO: 162) |
| WND | D1-1.3.3 | 9 | |
| GIT | D1-7.1.1 | 10 | |
| VyL | D1-7.2.1 | 11 | * |
| ITG | D1-7.1.2 | 12 | |
| yLE | D1-7.2.2 | 13 | * |
| LEL | D1-7.2.3 | 14 | (SEQ ID NO: 160) |
| WNY | D1-7.3.3 | 15 | |
| GIV | D1-26.1.1 | 16 | |
| VyW | D1-26.2.1 | 17 | * |
| YSG | D1-26.3.1 | 18 | |
| IVG | D1-26.1.2 | 19 | |
| yWE | D1-26.2.2 | 20 | * |
| SGS | D1-26.3.2 | 21 | |
| VGA | D1-26.1.3 | 22 | |
| WEL | D1-26.2.3 | 23 | |
| GSY | D1-26.3.3 | 24 | |
| GAT | D1-26.1.4 | 25 | |
| ELL | D1-26.2.4 | 26 | |
| SYY | D1-26.3.4 | 27 | |
| RIL | D2-2.1.1 | 28 | (SEQ ID NO: 171) |
| GYC | D2-2.2.1 | 29 | # |
| DIV | D2-2.3.1 | 30 | |
| ILy | D2-2.1.2 | 31 | * |
| YCS | D2-2.2.2 | 32 | # |
| IVV | D2-2.3.2 | 33 | |
| Lyy | D2-2.1.3 | 34 | * |
| CSS | D2-2.2.3 | 35 | # |
| VVV | D2-2.3.3 | 36 | |
| yyY | D2-2.1.4 | 37 | * |
| SST | D2-2.2.4 | 38 | |
| VVP | D2-2.3.4 | 39 | |
| yYQ | D2-2.1.5 | 40 | * |
| STS | D2-2.2.5 | 41 | |
| VPA | D2-2.3.5 | 42 | |
| YQL | D2-2.1.6 | 43 | |
| TSC | D2-2.2.6 | 44 | # |
| PAA | D2-2.3.6 | 45 | |
| QLL | D2-2.1.7 | 46 | |
| SCY | D2-2.2.7 | 47 | # |
| AAI | D2-2.3.7 | 48 | |
| LLY | D2-2.1.8 | 49 | |
| CYT | D2-2.2.8 | 50 | # |
| ILY | D2-8.1.2 | 51 | |
| YCT | D2-8.2.2 | 52 | # |
| IVL | D2-8.3.2 | 53 | |
| LYy | D2-8.1.3 | 54 | * |
| CTN | D2-8.2.3 | 55 | # |
| VLM | D2-8.3.3 | 56 | |
| YyW | D2-8.1.4 | 57 | * |
| TNG | D2-8.2.4 | 58 | |
| LMV | D2-8.3.4 | 59 | |
| yWC | D2-8.1.5 | 60 | * # |
| NGV | D2-8.2.5 | 61 | |
| MVY | D2-8.3.5 | 62 | |
| WCM | D2-8.1.6 | 63 | # |
| GVC | D2-8.2.6 | 64 | # |
| VYA | D2-8.3.6 | 65 | |
| CML | D2-8.1.7 | 66 | # |
| VCY | D2-8.2.7 | 67 | # |
| YAI | D2-8.3.7 | 68 | |
| MLY | D2-8.1.8 | 69 | |
| LyW | D2-15.1.3 | 70 | * |
| CSG | D2-15.2.3 | 71 | # |
| yWW | D2-15.1.4 | 72 | * |
| SGG | D2-15.2.4 | 73 | |
| WWy | D2-15.1.5 | 74 | * |
| GGS | D2-15.2.5 | 75 | |
| VVA | D2-15.3.5 | 76 | |
| WyL | D2-15.1.6 | 77 | * |
| GSC | D2-15.2.6 | 78 | # |
| VAA | D2-15.3.6 | 79 | |
| yLL | D2-15.1.7 | 80 | * |
| AAT | D2-15.3.7 | 81 | |
| LLL | D2-15.1.8 | 82 | |
| CYS | D2-15.2.8 | 83 | # |
| SIL | D2-21.1.1 | 84 | |
| AYC | D2-21.2.1 | 85 | # |
| HIV | D2-21.3.1 | 86 | |
| ILW | D2-21.1.2 | 87 | |
| YCG | D2-21.2.2 | 88 | # |
| LWW | D2-21.1.3 | 89 | |
| CGG | D2-21.2.3 | 90 | # |
| WWw | D2-21.1.4 | 91 | * |
| GGD | D2-21.2.4 | 92 | |
| VVT | D2-21.3.4 | 93 | |
| WwL | D2-21.1.5 | 94 | * |
| GDC | D2-21.2.5 | 95 | # |
| VTA | D2-21.3.5 | 96 | |
| wLL | D2-21.1.6 | 97 | * |
| DCY | D2-21.2.6 | 98 | # |
| TAI | D2-21.3.6 | 99 | |
| LLF | D2-21.1.7 | 100 | |
| VLR | D3-3.1.1 | 101 | |
| YYD | D3-3.2.1 | 102 | |
| ITI | D3-3.3.1 | 103 | |
| LRF | D3-3.1.2 | 104 | |
| YDF | D3-3.2.2 | 105 | |
| TIF | D3-3.3.2 | 106 | |
| RFL | D3-3.1.3 | 107 | |
| DFW | D3-3.2.3 | 108 | |
| IFG | D3-3.3.3 | 109 | |
| FLE | D3-3.1.4 | 110 | |
| FWS | D3-3.2.4 | 111 | |
| FGV | D3-3.3.4 | 112 | |
| LEW | D3-3.1.5 | 113 | |
| WSG | D3-3.2.5 | 114 | |
| GVV | D3-3.3.5 | 115 | |
| EWL | D3-3.1.6 | 116 | |
| SGY | D3-3.2.6 | 117 | |
| VVI | D3-3.3.6 | 118 | |
| WLL | D3-3.1.7 | 119 | |
| GYY | D3-3.2.7 | 120 | |
| VII | D3-3.3.7 | 121 | |
| YYT | D3-3.2.8 | 122 | |
| LRY | D3-9.1.2 | 123 | |
| YDI | D3-9.2.2 | 124 | |
| RYF | D3-9.1.3 | 125 | |
| DIL | D3-9.2.3 | 126 | |
| IFy | D3-9.3.3 | 127 | * |
| YFD | D3-9.1.4 | 128 | |
| ILT | D3-9.2.4 | 129 | |
| FyL | D3-9.3.4 | 130 | * |
| FDW | D3-9.1.5 | 131 | |
| LTG | D3-9.2.5 | 132 | (SEQ ID NO: 221) |
| yLV | D3-9.3.5 | 133 | * |
| DWL | D3-9.1.6 | 134 | |
| TGY | D3-9.2.6 | 135 | |
| LVI | D3-9.3.6 | 136 | |
| LLy | D3-9.1.8 | 137 | * |
| YYN | D3-9.2.8 | 138 | |
| VLL | D3-10.1.1 | 139 | |
| YYY | D3-10.2.1 | 140 | |
| ITM | D3-10.3.1 | 141 | |
| LLW | D3-10.1.2 | 142 | |
| YYG | D3-10.2.2 | 143 | |
| TMV | D3-10.3.2 | 144 | |
| LWF | D3-10.1.3 | 145 | |
| YGS | D3-10.2.3 | 146 | |
| MVR | D3-10.3.3 | 147 | |
| WFG | D3-10.1.4 | 148 | |
| GSG | D3-10.2.4 | 149 | |
| VRG | D3-10.3.4 | 150 | |
| FGE | D3-10.1.5 | 151 | |
| RGV | D3-10.3.5 | 152 | |
| GEL | D3-10.1.6 | 153 | |
| GVI | D3-10.3.6 | 154 | |
| VLw | D3-16.1.1 | 155 | * |
| IMI | D3-16.3.1 | 156 | |
| LwL | D3-16.1.2 | 157 | * |
| YDY | D3-16.2.2 | 158 | |
| MIT | D3-16.3.2 | 159 | |
| wLR | D3-16.1.3 | 160 | * |
| DYV | D3-16.2.3 | 161 | |
| ITF | D3-16.3.3 | 162 | |
| LRL | D3-16.1.4 | 163 | |
| YVW | D3-16.2.4 | 164 | |
| TFG | D3-16.3.4 | 165 | |
| RLG | D3-16.1.5 | 166 | |
| VWG | D3-16.2.5 | 167 | |
| FGG | D3-16.3.5 | 168 | |
| LGE | D3-16.1.6 | 169 | |
| WGS | D3-16.2.6 | 170 | |
| GGV | D3-16.3.6 | 171 | |
| ELS | D3-16.1.8 | 172 | |
| SYR | D3-16.2.8 | 173 | |
| VIV | D3-16.3.8 | 174 | |
| LSL | D3-16.1.9 | 175 | |
| YRY | D3-16.2.9 | 176 | |
| IVI | D3-16.3.9 | 177 | |
| SLY | D3-16.1.10 | 178 | |
| RYT | D3-16.2.10 | 179 | |
| LLw | D3-22.1.2 | 180 | * |
| TMI | D3-22.3.2 | 181 | |
| Lwy | D3-22.1.3 | 182 | * |
| YDS | D3-22.2.3 | 183 | |
| MIV | D3-22.3.3 | 184 | |
| wyy | D3-22.1.4 | 185 | * |
| DSS | D3-22.2.4 | 186 | |
| yyW | D3-22.1.5 | 187 | * |
| SSG | D3-22.2.5 | 188 | |
| yWL | D3-22.1.6 | 189 | * |
| VIT | D3-22.3.7 | 190 | |
| wLQ | D4-4.1.1 | 191 | * |
| DYS | D4-4.2.1 | 192 | |
| TTV | D4-4.3.1 | 193 | |
| LQy | D4-4.1.2 | 194 | * |
| YSN | D4-4.2.2 | 195 | |
| TVT | D4-4.3.2 | 196 | |
| QyL | D4-4.1.3 | 197 | * |
| SNY | D4-4.2.3 | 198 | |
| DYG | D4-17.2.1 | 199 | |
| LRw | D4-17.1.2 | 200 | * (SEQ ID NO: 197) |
| YGD | D4-17.2.2 | 201 | |
| RwL | D4-17.1.3 | 202 | * |
| GDY | D4-17.2.3 | 203 | |
| LRW | D4-23.1.2 | 204 | (SEQ ID NO: 197) |
| YGG | D4-23.2.2 | 205 | |
| TVV | D4-23.3.2 | 206 | |
| RWy | D4-23.1.3 | 207 | * |
| GGN | D4-23.2.3 | 208 | |
| GNS | D4-23.2.4 | 209 | |
| VDT | D5-5.1.1 | 210 | |
| WIQ | D5-5.2.1 | 211 | |
| GYS | D5-5.3.1 | 212 | |
| DTA | D5-5.1.2 | 213 | |
| IQL | D5-5.2.2 | 214 | |
| YSY | D5-5.3.2 | 215 | |
| TAM | D5-5.1.3 | 216 | |
| QLW | D5-5.2.3 | 217 | |
| SYG | D5-5.3.3 | 218 | |
| AMV | D5-5.1.4 | 219 | |
| LWL | D5-5.2.4 | 220 | |
| YGY | D5-5.3.4 | 221 | |
| VDI | D5-12.1.1 | 222 | |
| WIy | D5-12.2.1 | 223 | * |
| IyW | D5-12.2.2 | 224 | * |
| IVA | D5-12.1.3 | 225 | |
| VAT | D5-12.1.4 | 226 | |
| WLR | D5-12.2.4 | 227 | |
| GYD | D5-12.3.4 | 228 | |
| ATI | D5-12.1.5 | 229 | |
| VEM | D5-24.1.1 | 230 | |
| yRW | D5-24.2.1 | 231 | * |
| RDG | D5-24.3.1 | 232 | |
| EMA | D5-24.1.2 | 233 | |
| RWL | D5-24.2.2 | 234 | |
| DGY | D5-24.3.2 | 235 | |
| MAT | D5-24.1.3 | 236 | |
| WLQ | D5-24.2.3 | 237 | |
| GYN | D5-24.3.3 | 238 | |
| LQL | D5-24.2.4 | 239 | |
| YNY | D5-24.3.4 | 240 | |
| EYS | D6-6.1.1 | 241 | |
| SIA | D6-6.2.1 | 242 | |
| VyQ | D6-6.3.1 | 243 | * |
| YSS | D6-6.1.2 | 244 | |
| IAA | D6-6.2.2 | 245 | |
| yQL | D6-6.3.2 | 246 | * |
| SSS | D6-6.1.3 | 247 | |
| AAR | D6-6.2.3 | 248 | |
| QLV | D6-6.3.3 | 249 | (SEQ ID NO: 214) |
| GIA | D6-13.2.1 | 250 | |
| yQQ | D6-13.3.2 | 251 | * |
| AAA | D6-13.2.3 | 252 | |
| QQL | D6-13.3.3 | 253 | |
| SSW | D6-13.1.4 | 254 | |
| AAG | D6-13.2.4 | 255 | |
| SWY | D6-13.1.5 | 256 | |
| IAV | D6-19.2.2 | 257 | |
| yQW | D6-19.3.2 | 258 | * |
| AVA | D6-19.2.3 | 259 | |
| QWL | D6-19.3.3 | 260 | |
| SGW | D6-19.1.4 | 261 | |
| VAG | D6-19.2.4 | 262 | |
| WLV | D6-19.3.4 | 263 | |
| GWY | D6-19.1.5 | 264 | |
| yLG | D7-27.2.1 | 265 | * |
| NWG | D7-27.3.1 | 266 | (SEQ ID NO: 223) |

In Tables 11-14, the use of a lower case letter in an amino acid sequence indicates that a stop codon was changed to the residue listed as the lower case letter. For example, in the amino acid sequence “yLE”, a Tyr residue was introduced in place of a stop codon.

TABLE 12
Distinct tetramers that can be extracted from
human D segments

| | | | |
|---|---|---|---|
| GTTG | D1-1.1.1 | (SEQ ID NO: 257) | 1 |
| VQLE | D1-1.2.1 | (SEQ ID NO: 258) | 2 |
| YNWN | D1-1.3.1 | (SEQ ID NO: 259) | 3 |
| TTGT | D1-1.1.2 | (SEQ ID NO: 263) | 4 |
| QLER | D1-1.2.2 | (SEQ ID NO: 264) | 5 |
| NWND | D1-1.3.2 | (SEQ ID NO: 265) | 6 |
| GITG | D1-7.1.1 | (SEQ ID NO: 266) | 7 |
| VyLE | D1-7.2.1 | (SEQ ID NO: 267) | 8 |
| ITGT | D1-7.1.2 | (SEQ ID NO: 271) | 9 |
| yLEL | D1-7.2.2 | (SEQ ID NO: 272) | 10 |
| NWNY | D1-7.3.2 | (SEQ ID NO: 273) | 11 |
| yLER | D1-20.2.2 | (SEQ ID NO: 275) | 12 |
| GIVG | D1-26.1.1 | (SEQ ID NO: 276) | 13 |
| VyWE | D1-26.2.1 | (SEQ ID NO: 277) | 14 |
| YSGS | D1-26.3.1 | (SEQ ID NO: 278) | 15 |
| IVGA | D1-26.1.2 | (SEQ ID NO: 285) | 16 |
| yWEL | D1-26.2.2 | (SEQ ID NO: 286) | 17 |
| SGSY | D1-26.3.2 | (SEQ ID NO: 287) | 18 |
| VGAT | D1-26.1.3 | (SEQ ID NO: 291) | 19 |
| WELL | D1-26.2.3 | (SEQ ID NO: 292) | 20 |
| GSYY | D1-26.3.3 | (SEQ ID NO: 293) | 21 |
| RILy | D2-2.1.1 | (SEQ ID NO: 294) | 22 |
| GYCS | D2-2.2.1 | (SEQ ID NO: 295) | 23 |
| DIVV | D2-2.3.1 | (SEQ ID NO: 296) | 24 |
| ILyy | D2-2.1.2 | (SEQ ID NO: 303) | 25 |
| YCSS | D2-2.2.2 | (SEQ ID NO: 304) | 26 |
| IVVV | D2-2.3.2 | (SEQ ID NO: 305) | 27 |
| LyyY | D2-2.1.3 | (SEQ ID NO: 312) | 28 |
| CSST | D2-2.2.3 | (SEQ ID NO: 313) | 29 |
| VVVP | D2-2.3.3 | (SEQ ID NO: 314) | 30 |
| yyYQ | D2-2.1.4 | (SEQ ID NO: 321) | 31 |
| SSTS | D2-2.2.4 | (SEQ ID NO: 322) | 32 |
| VVPA | D2-2.3.4 | (SEQ ID NO: 323) | 33 |
| yYQL | D2-2.1.5 | (SEQ ID NO: 330) | 34 |
| STSC | D2-2.2.5 | (SEQ ID NO: 331) | 35 |
| VPAA | D2-2.3.5 | (SEQ ID NO: 332) | 36 |
| YQLL | D2-2.1.6 | (SEQ ID NO: 338) | 37 |
| TSCY | D2-2.2.6 | (SEQ ID NO: 339) | 38 |
| PAAI | D2-2.3.6 | (SEQ ID NO: 340) | 39 |
| QLLY | D2-2.1.7 | (SEQ ID NO: 343) | 40 |
| SCYT | D2-2.2.7 | (SEQ ID NO: 344) | 41 |
| RILY | D2-8.1.1 | (SEQ ID NO: 345) | 42 |
| GYCT | D2-8.2.1 | (SEQ ID NO: 346) | 43 |
| DIVL | D2-8.3.1 | (SEQ ID NO: 347) | 44 |
| ILYy | D2-8.1.2 | (SEQ ID NO: 354) | 45 |
| YCTN | D2-8.2.2 | (SEQ ID NO: 355) | 46 |
| IVLM | D2-8.3.2 | (SEQ ID NO: 356) | 47 |
| LYyW | D2-8.1.3 | (SEQ ID NO: 363) | 48 |
| CTNG | D2-8.2.3 | (SEQ ID NO: 364) | 49 |
| VLMV | D2-8.3.3 | (SEQ ID NO: 365) | 50 |
| YyWC | D2-8.1.4 | (SEQ ID NO: 372) | 51 |
| TNGV | D2-8.2.4 | (SEQ ID NO: 373) | 52 |
| LMVY | D2-8.3.4 | (SEQ ID NO: 374) | 53 |
| yWCM | D2-8.1.5 | (SEQ ID NO: 381) | 54 |
| NGVC | D2-8.2.5 | (SEQ ID NO: 382) | 55 |
| MVYA | D2-8.3.5 | (SEQ ID NO: 383) | 56 |
| WCML | D2-8.1.6 | (SEQ ID NO: 389) | 57 |
| GVCY | D2-8.2.6 | (SEQ ID NO: 390) | 58 |
| VYAI | D2-8.3.6 | (SEQ ID NO: 391) | 59 |
| CMLY | D2-8.1.7 | (SEQ ID NO: 394) | 60 |
| VCYT | D2-8.2.7 | (SEQ ID NO: 395) | 61 |
| ILyW | D2-15.1.2 | (SEQ ID NO: 401) | 62 |
| YCSG | D2-15.2.2 | (SEQ ID NO: 402) | 63 |
| LyWW | D2-15.1.3 | (SEQ ID NO: 409) | 64 |
| CSGG | D2-15.2.3 | (SEQ ID NO: 410) | 65 |
| VVVV | D2-15.3.3 | (SEQ ID NO: 411) | 66 |
| yWWy | D2-15.1.4 | (SEQ ID NO: 418) | 67 |
| SGGS | D2-15.2.4 | (SEQ ID NO: 419) | 68 |
| VVVA | D2-15.3.4 | (SEQ ID NO: 420) | 69 |
| WWyL | D2-15.1.5 | (SEQ ID NO: 427) | 70 |
| GGSC | D2-15.2.5 | (SEQ ID NO: 428) | 71 |
| VVAA | D2-15.3.5 | (SEQ ID NO: 429) | 72 |
| WyLL | D2-15.1.6 | (SEQ ID NO: 435) | 73 |
| GSCY | D2-15.2.6 | (SEQ ID NO: 436) | 74 |
| VAAT | D2-15.3.6 | (SEQ ID NO: 437) | 75 |
| yLLL | D2-15.1.7 | (SEQ ID NO: 440) | 76 |
| SCYS | D2-15.2.7 | (SEQ ID NO: 441) | 77 |
| SILW | D2-21.1.1 | (SEQ ID NO: 442) | 78 |
| AYCG | D2-21.2.1 | (SEQ ID NO: 443) | 79 |
| HIVV | D2-21.3.1 | (SEQ ID NO: 444) | 80 |
| ILWW | D2-21.1.2 | (SEQ ID NO: 451) | 81 |
| YCGG | D2-21.2.2 | (SEQ ID NO: 452) | 82 |
| LWWw | D2-21.1.3 | (SEQ ID NO: 459) | 83 |
| CGGD | D2-21.2.3 | (SEQ ID NO: 460) | 84 |
| VVVT | D2-21.3.3 | (SEQ ID NO: 461) | 85 |
| WWwL | D2-21.1.4 | (SEQ ID NO: 468) | 86 |
| GGDC | D2-21.2.4 | (SEQ ID NO: 469) | 87 |
| VVTA | D2-21.3.4 | (SEQ ID NO: 470) | 88 |
| WwLL | D2-21.1.5 | (SEQ ID NO: 476) | 89 |
| GDCY | D2-21.2.5 | (SEQ ID NO: 477) | 90 |
| VTAI | D2-21.3.5 | (SEQ ID NO: 478) | 91 |
| wLLF | D2-21.1.6 | (SEQ ID NO: 481) | 92 |
| DCYS | D2-21.2.6 | (SEQ ID NO: 482) | 93 |
| VLRF | D3-3.1.1 | (SEQ ID NO: 483) | 94 |
| YYDF | D3-3.2.1 | (SEQ ID NO: 484) | 95 |
| ITIF | D3-3.3.1 | (SEQ ID NO: 485) | 96 |
| LRFL | D3-3.1.2 | (SEQ ID NO: 492) | 97 |
| YDFW | D3-3.2.2 | (SEQ ID NO: 493) | 98 |
| TIFG | D3-3.3.2 | (SEQ ID NO: 494) | 99 |
| RFLE | D3-3.1.3 | (SEQ ID NO: 501) | 100 |
| DFWS | D3-3.2.3 | (SEQ ID NO: 502) | 101 |
| IFGV | D3-3.3.3 | (SEQ ID NO: 503) | 102 |
| FLEW | D3-3.1.4 | (SEQ ID NO: 510) | 103 |
| FWSG | D3-3.2.4 | (SEQ ID NO: 511) | 104 |
| FGVV | D3-3.3.4 | (SEQ ID NO: 512) | 105 |
| LEWL | D3-3.1.5 | (SEQ ID NO: 519) | 106 |
| WSGY | D3-3.2.5 | (SEQ ID NO: 520) | 107 |
| GVVI | D3-3.3.5 | (SEQ ID NO: 521) | 108 |
| EWLL | D3-3.1.6 | (SEQ ID NO: 527) | 109 |
| SGYY | D3-3.2.6 | (SEQ ID NO: 528) | 110 |
| VVII | D3-3.3.6 | (SEQ ID NO: 529) | 111 |
| WLLY | D3-3.1.7 | (SEQ ID NO: 532) | 112 |
| GYYT | D3-3.2.7 | (SEQ ID NO: 533) | 113 |
| VLRY | D3-9.1.1 | (SEQ ID NO: 534) | 114 |
| YYDI | D3-9.2.1 | (SEQ ID NO: 535) | 115 |
| LRYF | D3-9.1.2 | (SEQ ID NO: 542) | 116 |
| YDIL | D3-9.2.2 | (SEQ ID NO: 543) | 117 |
| TIFy | D3-9.3.2 | (SEQ ID NO: 544) | 118 |
| RYFD | D3-9.1.3 | (SEQ ID NO: 551) | 119 |
| DILT | D3-9.2.3 | (SEQ ID NO: 552) | 120 |
| IFyL | D3-9.3.3 | (SEQ ID NO: 553) | 121 |
| YFDW | D3-9.1.4 | (SEQ ID NO: 560) | 122 |
| ILTG | D3-9.2.4 | (SEQ ID NO: 561) | 123 |
| FyLV | D3-9.3.4 | (SEQ ID NO: 562) | 124 |
| FDWL | D3-9.1.5 | (SEQ ID NO: 569) | 125 |
| LTGY | D3-9.2.5 | (SEQ ID NO: 570) | 126 |
| yLVI | D3-9.3.5 | (SEQ ID NO: 571) | 127 |
| DWLL | D3-9.1.6 | (SEQ ID NO: 577) | 128 |
| TGYY | D3-9.2.6 | (SEQ ID NO: 578) | 129 |
| LVII | D3-9.3.6 | (SEQ ID NO: 579) | 130 |
| WLLy | D3-9.1.7 | (SEQ ID NO: 582) | 131 |
| GYYN | D3-9.2.7 | (SEQ ID NO: 583) | 132 |
| VLLW | D3-10.1.1 | (SEQ ID NO: 584) | 133 |
| YYYG | D3-10.2.1 | (SEQ ID NO: 585) | 134 |
| ITMV | D3-10.3.1 | (SEQ ID NO: 586) | 135 |
| LLWF | D3-10.1.2 | (SEQ ID NO: 593) | 136 |
| YYGS | D3-10.2.2 | (SEQ ID NO: 594) | 137 |
| TMVR | D3-10.3.2 | (SEQ ID NO: 595) | 138 |
| LWFG | D3-10.1.3 | (SEQ ID NO: 602) | 139 |
| YGSG | D3-10.2.3 | (SEQ ID NO: 603) | 140 |
| MVRG | D3-10.3.3 | (SEQ ID NO: 604) | 141 |
| WFGE | D3-10.1.4 | (SEQ ID NO: 611) | 142 |
| GSGS | D3-10.2.4 | (SEQ ID NO: 612) | 143 |
| VRGV | D3-10.3.4 | (SEQ ID NO: 613) | 144 |
| FGEL | D3-10.1.5 | (SEQ ID NO: 620) | 145 |
| RGVI | D3-10.3.5 | (SEQ ID NO: 621) | 146 |
| GELL | D3-10.1.6 | (SEQ ID NO: 626) | 147 |
| GVII | D3-10.3.6 | (SEQ ID NO: 627) | 148 |
| ELLy | D3-10.1.7 | (SEQ ID NO: 630) | 149 |
| SYYN | D3-10.2.7 | (SEQ ID NO: 631) | 150 |
| VLwL | D3-16.1.1 | (SEQ ID NO: 632) | 151 |
| YYDY | D3-16.2.1 | (SEQ ID NO: 633) | 152 |
| IMIT | D3-16.3.1 | (SEQ ID NO: 634) | 153 |
| LwLR | D3-16.1.2 | (SEQ ID NO: 641) | 154 |
| YDYV | D3-16.2.2 | (SEQ ID NO: 642) | 155 |
| MITF | D3-16.3.2 | (SEQ ID NO: 643) | 156 |
| wLRL | D3-16.1.3 | (SEQ ID NO: 650) | 157 |
| DYVW | D3-16.2.3 | (SEQ ID NO: 651) | 158 |
| ITFG | D3-16.3.3 | (SEQ ID NO: 652) | 159 |
| LRLG | D3-16.1.4 | (SEQ ID NO: 659) | 160 |
| YVWG | D3-16.2.4 | (SEQ ID NO: 660) | 161 |
| TFGG | D3-16.3.4 | (SEQ ID NO: 661) | 162 |
| RLGE | D3-16.1.5 | (SEQ ID NO: 668) | 163 |
| VWGS | D3-16.2.5 | (SEQ ID NO: 669) | 164 |
| FGGV | D3-16.3.5 | (SEQ ID NO: 670) | 165 |
| LGEL | D3-16.1.6 | (SEQ ID NO: 677) | 166 |
| WGSY | D3-16.2.6 | (SEQ ID NO: 678) | 167 |
| GGVI | D3-16.3.6 | (SEQ ID NO: 679) | 168 |
| GELS | D3-16.1.7 | (SEQ ID NO: 686) | 169 |
| GSYR | D3-16.2.7 | (SEQ ID NO: 687) | 170 |
| GVIV | D3-16.3.7 | (SEQ ID NO: 688) | 171 |
| ELSL | D3-16.1.8 | (SEQ ID NO: 694) | 172 |
| SYRY | D3-16.2.8 | (SEQ ID NO: 695) | 173 |
| VIVI | D3-16.3.8 | (SEQ ID NO: 696) | 174 |
| LSLY | D3-16.1.9 | (SEQ ID NO: 699) | 175 |
| YRYT | D3-16.2.9 | (SEQ ID NO: 700) | 176 |
| VLLw | D3-22.1.1 | (SEQ ID NO: 701) | 177 |
| YYYD | D3-22.2.1 | (SEQ ID NO: 702) | 178 |
| ITMI | D3-22.3.1 | (SEQ ID NO: 703) | 179 |
| LLwy | D3-22.1.2 | (SEQ ID NO: 710) | 180 |
| YYDS | D3-22.2.2 | (SEQ ID NO: 711) | 181 |
| TMIV | D3-22.3.2 | (SEQ ID NO: 712) | 182 |
| Lwyy | D3-22.1.3 | (SEQ ID NO: 719) | 183 |
| YDSS | D3-22.2.3 | (SEQ ID NO: 720) | 184 |
| MIVV | D3-22.3.3 | (SEQ ID NO: 721) | 185 |
| wyyW | D3-22.1.4 | (SEQ ID NO: 728) | 186 |
| DSSG | D3-22.2.4 | (SEQ ID NO: 729) | 187 |
| yyWL | D3-22.1.5 | (SEQ ID NO: 736) | 188 |
| SSGY | D3-22.2.5 | (SEQ ID NO: 737) | 189 |
| VVVI | D3-22.3.5 | (SEQ ID NO: 738) | 190 |
| yWLL | D3-22.1.6 | (SEQ ID NO: 744) | 191 |
| VVIT | D3-22.3.6 | (SEQ ID NO: 745) | 192 |
| WLLL | D3-22.1.7 | (SEQ ID NO: 748) | 193 |
| GYYY | D3-22.2.7 | (SEQ ID NO: 749) | 194 |
| wLQy | D4-4.1.1 | (SEQ ID NO: 750) | 195 |
| DYSN | D4-4.2.1 | (SEQ ID NO: 751) | 196 |
| TTVT | D4-4.3.1 | (SEQ ID NO: 752) | 197 |
| LQyL | D4-4.1.2 | (SEQ ID NO: 755) | 198 |
| YSNY | D4-4.2.2 | (SEQ ID NO: 756) | 199 |
| wLRw | D4-17.1.1 | (SEQ ID NO: 757) | 200 |
| DYGD | D4-17.2.1 | (SEQ ID NO: 758) | 201 |
| LRwL | D4-17.1.2 | (SEQ ID NO: 761) | 202 |
| YGDY | D4-17.2.2 | (SEQ ID NO: 762) | 203 |
| wLRW | D4-23.1.1 | (SEQ ID NO: 763) | 204 |
| DYGG | D4-23.2.1 | (SEQ ID NO: 764) | 205 |
| TTVV | D4-23.3.1 | (SEQ ID NO: 765) | 206 |
| LRWy | D4-23.1.2 | (SEQ ID NO: 771) | 207 |
| YGGN | D4-23.2.2 | (SEQ ID NO: 772) | 208 |
| TVVT | D4-23.3.2 | (SEQ ID NO: 773) | 209 |
| RWyL | D4-23.1.3 | (SEQ ID NO: 776) | 210 |
| GGNS | D4-23.2.3 | (SEQ ID NO: 777) | 211 |
| VDTA | D5-5.1.1 | (SEQ ID NO: 778) | 212 |
| WIQL | D5-5.2.1 | (SEQ ID NO: 779) | 213 |
| GYSY | D5-5.3.1 | (SEQ ID NO: 780) | 214 |
| DTAM | D5-5.1.2 | (SEQ ID NO: 787) | 215 |
| IQLW | D5-5.2.2 | (SEQ ID NO: 788) | 216 |
| YSYG | D5-5.3.2 | (SEQ ID NO: 789) | 217 |
| TAMV | D5-5.1.3 | (SEQ ID NO: 793) | 218 |
| QLWL | D5-5.2.3 | (SEQ ID NO: 794) | 219 |
| SYGY | D5-5.3.3 | (SEQ ID NO: 795) | 220 |
| VDIV | D5-12.1.1 | (SEQ ID NO: 796) | 221 |
| WIyW | D5-12.2.1 | (SEQ ID NO: 797) | 222 |
| GYSG | D5-12.3.1 | (SEQ ID NO: 798) | 223 |
| DIVA | D5-12.1.2 | (SEQ ID NO: 805) | 224 |
| IyWL | D5-12.2.2 | (SEQ ID NO: 806) | 225 |
| YSGY | D5-12.3.2 | (SEQ ID NO: 807) | 226 |
| IVAT | D5-12.1.3 | (SEQ ID NO: 814) | 227 |
| yWLR | D5-12.2.3 | (SEQ ID NO: 815) | 228 |
| SGYD | D5-12.3.3 | (SEQ ID NO: 816) | 229 |
| VATI | D5-12.1.4 | (SEQ ID NO: 820) | 230 |
| WLRL | D5-12.2.4 | (SEQ ID NO: 821) | 231 |
| GYDY | D5-12.3.4 | (SEQ ID NO: 822) | 232 |
| VEMA | D5-24.1.1 | (SEQ ID NO: 823) | 233 |
| yRWL | D5-24.2.1 | (SEQ ID NO: 824) | 234 |
| RDGY | D5-24.3.1 | (SEQ ID NO: 825) | 235 |
| EMAT | D5-24.1.2 | (SEQ ID NO: 832) | 236 |
| RWLQ | D5-24.2.2 | (SEQ ID NO: 833) | 237 |
| DGYN | D5-24.3.2 | (SEQ ID NO: 834) | 238 |
| MATI | D5-24.1.3 | (SEQ ID NO: 838) | 239 |
| WLQL | D5-24.2.3 | (SEQ ID NO: 839) | 240 |
| GYNY | D5-24.3.3 | (SEQ ID NO: 840) | 241 |
| EYSS | D6-6.1.1 | (SEQ ID NO: 841) | 242 |
| SIAA | D6-6.2.1 | (SEQ ID NO: 842) | 243 |
| VyQL | D6-6.3.1 | (SEQ ID NO: 843) | 244 |
| YSSS | D6-6.1.2 | (SEQ ID NO: 848) | 245 |
| IAAR | D6-6.2.2 | (SEQ ID NO: 849) | 246 |
| yQLV | D6-6.3.2 | (SEQ ID NO: 850) | 247 |
| SSSS | D6-6.1.3 | (SEQ ID NO: 852) | 248 |
| GYSS | D6-13.1.1 | (SEQ ID NO: 853) | 249 |
| GIAA | D6-13.2.1 | (SEQ ID NO: 854) | 250 |
| VyQQ | D6-13.3.1 | (SEQ ID NO: 855) | 251 |
| IAAA | D6-13.2.2 | (SEQ ID NO: 862) | 252 |
| yQQL | D6-13.3.2 | (SEQ ID NO: 863) | 253 |
| SSSW | D6-13.1.3 | (SEQ ID NO: 868) | 254 |
| AAAG | D6-13.2.3 | (SEQ ID NO: 869) | 255 |
| QQLV | D6-13.3.3 | (SEQ ID NO: 870) | 256 |
| SSWY | D6-13.1.4 | (SEQ ID NO: 872) | 257 |
| GIAV | D6-19.2.1 | (SEQ ID NO: 873) | 258 |
| VyQW | D6-19.3.1 | (SEQ ID NO: 874) | 259 |
| YSSG | D6-19.1.2 | (SEQ ID NO: 881) | 260 |
| IAVA | D6-19.2.2 | (SEQ ID NO: 882) | 261 |
| yQWL | D6-19.3.2 | (SEQ ID NO: 883) | 262 |
| SSGW | D6-19.1.3 | (SEQ ID NO: 888) | 263 |
| AVAG | D6-19.2.3 | (SEQ ID NO: 889) | 264 |
| QWLV | D6-19.3.3 | (SEQ ID NO: 890) | 265 |
| SGWY | D6-19.1.4 | (SEQ ID NO: 892 941) | 266 |

TABLE 13
Pentamers that can be extracted from human
D segments

| | | | |
|---|---|---|---|
| GTTGT | D1-1.1.1 | (SEQ ID NO: 260) | 1 |
| VQLER | D1-1.2.1 | (SEQ ID NO: 261) | 2 |
| YNWND | D1-1.3.1 | (SEQ ID NO: 262) | 3 |
| GITGT | D1-7.1.1 | (SEQ ID NO: 268) | 4 |
| VyLEL | D1-7.2.1 | (SEQ ID NO: 269) | 5 |
| YNWNY | D1-7.3.1 | (SEQ ID NO: 270) | 6 |
| VyLER | D1-20.2.1 | (SEQ ID NO: 274) | 7 |
| GIVGA | D1-26.1.1 | (SEQ ID NO: 279) | 8 |
| VyWEL | D1-26.2.1 | (SEQ ID NO: 280) | 9 |
| YSGSY | D1-26.3.1 | (SEQ ID NO: 281) | 10 |
| IVGAT | D1-26.1.2 | (SEQ ID NO: 288) | 11 |
| yWELL | D1-26.2.2 | (SEQ ID NO: 289) | 12 |
| SGSYY | D1-26.3.2 | (SEQ ID NO: 290) | 13 |
| RILyy | D2-2.1.1 | (SEQ ID NO: 297) | 14 |
| GYCSS | D2-2.2.1 | (SEQ ID NO: 298) | 15 |
| DIVVV | D2-2.3.1 | (SEQ ID NO: 299) | 16 |
| ILyyY | D2-2.1.2 | (SEQ ID NO: 306) | 17 |
| YCSST | D2-2.2.2 | (SEQ ID NO: 307) | 18 |
| IVVVP | D2-2.3.2 | (SEQ ID NO: 308) | 19 |
| LyyYQ | D2-2.1.3 | (SEQ ID NO: 315) | 20 |
| CSSTS | D2-2.2.3 | (SEQ ID NO: 316) | 21 |
| VVVPA | D2-2.3.3 | (SEQ ID NO: 317) | 22 |
| yyYQL | D2-2.1.4 | (SEQ ID NO: 324) | 23 |
| SSTSC | D2-2.2.4 | (SEQ ID NO: 325) | 24 |
| VVPAA | D2-2.3.4 | (SEQ ID NO: 326) | 25 |
| yYQLL | D2-2.1.5 | (SEQ ID NO: 333) | 26 |
| STSCY | D2-2.2.5 | (SEQ ID NO: 334) | 27 |
| VPAAI | D2-2.3.5 | (SEQ ID NO: 335) | 28 |
| YQLLY | D2-2.1.6 | (SEQ ID NO: 341) | 29 |
| TSCYT | D2-2.2.6 | (SEQ ID NO: 342) | 30 |
| RILYy | D2-8.1.1 | (SEQ ID NO: 348) | 31 |
| GYCTN | D2-8.2.1 | (SEQ ID NO: 349) | 32 |
| DIVLM | D2-8.3.1 | (SEQ ID NO: 350) | 33 |
| ILYyW | D2-8.1.2 | (SEQ ID NO: 357) | 34 |
| YCTNG | D2-8.2.2 | (SEQ ID NO: 358) | 35 |
| IVLMV | D2-8.3.2 | (SEQ ID NO: 359) | 36 |
| LYyWC | D2-8.1.3 | (SEQ ID NO: 366) | 37 |
| CTNGV | D2-8.2.3 | (SEQ ID NO: 367) | 38 |
| VLMVY | D2-8.3.3 | (SEQ ID NO: 368) | 39 |
| YyWCM | D2-8.1.4 | (SEQ ID NO: 375) | 40 |
| TNGVC | D2-8.2.4 | (SEQ ID NO: 376) | 41 |
| LMVYA | D2-8.3.4 | (SEQ ID NO: 377) | 42 |
| yWCML | D2-8.1.5 | (SEQ ID NO: 384) | 43 |
| NGVCY | D2-8.2.5 | (SEQ ID NO: 385) | 44 |
| MVYAI | D2-8.3.5 | (SEQ ID NO: 386) | 45 |
| WCMLY | D2-8.1.6 | (SEQ ID NO: 392) | 46 |
| GVCYT | D2-8.2.6 | (SEQ ID NO: 393) | 47 |
| RILyW | D2-15.1.1 | (SEQ ID NO: 396) | 48 |
| GYCSG | D2-15.2.1 | (SEQ ID NO: 397) | 49 |
| ILyWW | D2-15.1.2 | (SEQ ID NO: 403) | 50 |
| YCSGG | D2-15.2.2 | (SEQ ID NO: 404) | 51 |
| IVVVV | D2-15.3.2 | (SEQ ID NO: 405) | 52 |
| LyWWy | D2-15.1.3 | (SEQ ID NO: 412) | 53 |
| CSGGS | D2-15.2.3 | (SEQ ID NO: 413) | 54 |
| VVVVA | D2-15.3.3 | (SEQ ID NO: 414) | 55 |
| yWWyL | D2-15.1.4 | (SEQ ID NO: 421) | 56 |
| SGGSC | D2-15.2.4 | (SEQ ID NO: 422) | 57 |
| VVVAA | D2-15.3.4 | (SEQ ID NO: 423) | 58 |
| WWyLL | D2-15.1.5 | (SEQ ID NO: 430) | 59 |
| GGSCY | D2-15.2.5 | (SEQ ID NO: 431) | 60 |
| VVAAT | D2-15.3.5 | (SEQ ID NO: 432) | 61 |
| WyLLL | D2-15.1.6 | (SEQ ID NO: 438) | 62 |
| GSCYS | D2-15.2.6 | (SEQ ID NO: 439) | 63 |
| SILWW | D2-21.1.1 | (SEQ ID NO: 445) | 64 |
| AYCGG | D2-21.2.1 | (SEQ ID NO: 446) | 65 |
| HIVVV | D2-21.3.1 | (SEQ ID NO: 447) | 66 |
| ILWWw | D2-21.1.2 | (SEQ ID NO: 453) | 67 |
| YCGGD | D2-21.2.2 | (SEQ ID NO: 454) | 68 |
| IVVVT | D2-21.3.2 | (SEQ ID NO: 455) | 69 |
| LWWwL | D2-21.1.3 | (SEQ ID NO: 462) | 70 |
| CGGDC | D2-21.2.3 | (SEQ ID NO: 463) | 71 |
| VVVTA | D2-21.3.3 | (SEQ ID NO: 464) | 72 |
| WWwLL | D2-21.1.4 | (SEQ ID NO: 471) | 73 |
| GGDCY | D2-21.2.4 | (SEQ ID NO: 472) | 74 |
| VVTAI | D2-21.3.4 | (SEQ ID NO: 473) | 75 |
| WwLLF | D2-21.1.5 | (SEQ ID NO: 479) | 76 |
| GDCYS | D2-21.2.5 | (SEQ ID NO: 480) | 77 |
| VLRFL | D3-3.1.1 | (SEQ ID NO: 486) | 78 |
| YYDFW | D3-3.2.1 | (SEQ ID NO: 487) | 79 |
| ITIFG | D3-3.3.1 | (SEQ ID NO: 488) | 80 |
| LRFLE | D3-3.1.2 | (SEQ ID NO: 495) | 81 |
| YDFWS | D3-3.2.2 | (SEQ ID NO: 496) | 82 |
| TIFGV | D3-3.3.2 | (SEQ ID NO: 497) | 83 |
| RFLEW | D3-3.1.3 | (SEQ ID NO: 504) | 84 |
| DFWSG | D3-3.2.3 | (SEQ ID NO: 505) | 85 |
| IFGVV | D3-3.3.3 | (SEQ ID NO: 506) | 86 |
| FLEWL | D3-3.1.4 | (SEQ ID NO: 513) | 87 |
| FWSGY | D3-3.2.4 | (SEQ ID NO: 514) | 88 |
| FGVVI | D3-3.3.4 | (SEQ ID NO: 515) | 89 |
| LEWLL | D3-3.1.5 | (SEQ ID NO: 522) | 90 |
| WSGYY | D3-3.2.5 | (SEQ ID NO: 523) | 91 |
| GVVII | D3-3.3.5 | (SEQ ID NO: 524) | 92 |
| EWLLY | D3-3.1.6 | (SEQ ID NO: 530) | 93 |
| SGYYT | D3-3.2.6 | (SEQ ID NO: 531) | 94 |
| VLRYF | D3-9.1.1 | (SEQ ID NO: 536) | 95 |
| YYDIL | D3-9.2.1 | (SEQ ID NO: 537) | 96 |
| ITIFy | D3-9.3.1 | (SEQ ID NO: 538) | 97 |
| LRYFD | D3-9.1.2 | (SEQ ID NO: 545) | 98 |
| YDILT | D3-9.2.2 | (SEQ ID NO: 546) | 99 |
| TIFyL | D3-9.3.2 | (SEQ ID NO: 547) | 100 |
| RYFDW | D3-9.1.3 | (SEQ ID NO: 554) | 101 |
| DILTG | D3-9.2.3 | (SEQ ID NO: 555) | 102 |
| IFyLV | D3-9.3.3 | (SEQ ID NO: 556) | 103 |
| YFDWL | D3-9.1.4 | (SEQ ID NO: 563) | 104 |
| ILTGY | D3-9.2.4 | (SEQ ID NO: 564) | 105 |
| FyLVI | D3-9.3.4 | (SEQ ID NO: 565) | 106 |
| FDWLL | D3-9.1.5 | (SEQ ID NO: 572) | 107 |
| LTGYY | D3-9.2.5 | (SEQ ID NO: 573) | 108 |
| yLVII | D3-9.3.5 | (SEQ ID NO: 574) | 109 |
| DWLLy | D3-9.1.6 | (SEQ ID NO: 580) | 110 |
| TGYYN | D3-9.2.6 | (SEQ ID NO: 581) | 111 |
| VLLWF | D3-10.1.1 | (SEQ ID NO: 587) | 112 |
| YYYGS | D3-10.2.1 | (SEQ ID NO: 588) | 113 |
| ITMVR | D3-10.3.1 | (SEQ ID NO: 589) | 114 |
| LLWFG | D3-10.1.2 | (SEQ ID NO: 596) | 115 |
| YYGSG | D3-10.2.2 | (SEQ ID NO: 597) | 116 |
| TMVRG | D3-10.3.2 | (SEQ ID NO: 598) | 117 |
| LWFGE | D3-10.1.3 | (SEQ ID NO: 605) | 118 |
| YGSGS | D3-10.2.3 | (SEQ ID NO: 606) | 119 |
| MVRGV | D3-10.3.3 | (SEQ ID NO: 607) | 120 |
| WFGEL | D3-10.1.4 | (SEQ ID NO: 614) | 121 |
| GSGSY | D3-10.2.4 | (SEQ ID NO: 615) | 122 |
| VRGVI | D3-10.3.4 | (SEQ ID NO: 616) | 123 |
| FGELL | D3-10.1.5 | (SEQ ID NO: 622) | 124 |
| RGVII | D3-10.3.5 | (SEQ ID NO: 623) | 125 |
| GELLy | D3-10.1.6 | (SEQ ID NO: 628) | 126 |
| GSYYN | D3-10.2.6 | (SEQ ID NO: 629) | 127 |
| VLwLR | D3-16.1.1 | (SEQ ID NO: 635) | 128 |
| YYDYV | D3-16.2.1 | (SEQ ID NO: 636) | 129 |
| IMITF | D3-16.3.1 | (SEQ ID NO: 637) | 130 |
| LwLRL | D3-16.1.2 | (SEQ ID NO: 644) | 131 |
| YDYVW | D3-16.2.2 | (SEQ ID NO: 645) | 132 |
| MITFG | D3-16.3.2 | (SEQ ID NO: 646) | 133 |
| wLRLG | D3-16.1.3 | (SEQ ID NO: 653) | 134 |
| DYVWG | D3-16.2.3 | (SEQ ID NO: 654) | 135 |
| ITFGG | D3-16.3.3 | (SEQ ID NO: 655) | 136 |
| LRLGE | D3-16.1.4 | (SEQ ID NO: 662) | 137 |
| YVWGS | D3-16.2.4 | (SEQ ID NO: 663) | 138 |
| TFGGV | D3-16.3.4 | (SEQ ID NO: 664) | 139 |
| RLGEL | D3-16.1.5 | (SEQ ID NO: 671) | 140 |
| VWGSY | D3-16.2.5 | (SEQ ID NO: 672) | 141 |
| FGGVI | D3-16.3.5 | (SEQ ID NO: 673) | 142 |
| LGELS | D3-16.1.6 | (SEQ ID NO: 680) | 143 |
| WGSYR | D3-16.2.6 | (SEQ ID NO: 681) | 144 |
| GGVIV | D3-16.3.6 | (SEQ ID NO: 682) | 145 |
| GELSL | D3-16.1.7 | (SEQ ID NO: 689) | 146 |
| GSYRY | D3-16.2.7 | (SEQ ID NO: 690) | 147 |
| GVIVI | D3-16.3.7 | (SEQ ID NO: 691) | 148 |
| ELSLY | D3-16.1.8 | (SEQ ID NO: 697) | 149 |
| SYRYT | D3-16.2.8 | (SEQ ID NO: 698) | 150 |
| VLLwy | D3-22.1.1 | (SEQ ID NO: 704) | 151 |
| YYYDS | D3-22.2.1 | (SEQ ID NO: 705) | 152 |
| ITMIV | D3-22.3.1 | (SEQ ID NO: 706) | 153 |
| LLwyy | D3-22.1.2 | (SEQ ID NO: 713) | 154 |
| YYDSS | D3-22.2.2 | (SEQ ID NO: 714) | 155 |
| TMIVV | D3-22.3.2 | (SEQ ID NO: 715) | 156 |
| LwyyW | D3-22.1.3 | (SEQ ID NO: 722) | 157 |
| YDSSG | D3-22.2.3 | (SEQ ID NO: 723) | 158 |
| MIVVV | D3-22.3.3 | (SEQ ID NO: 724) | 159 |
| wyyWL | D3-22.1.4 | (SEQ ID NO: 730) | 160 |
| DSSGY | D3-22.2.4 | (SEQ ID NO: 731) | 161 |
| IVVVI | D3-22.3.4 | (SEQ ID NO: 732) | 162 |
| yyWLL | D3-22.1.5 | (SEQ ID NO: 739) | 163 |
| SSGYY | D3-22.2.5 | (SEQ ID NO: 740) | 164 |
| VVVIT | D3-22.3.5 | (SEQ ID NO: 741) | 165 |
| yWLLL | D3-22.1.6 | (SEQ ID NO: 746) | 166 |
| SGYYY | D3-22.2.6 | (SEQ ID NO: 747) | 167 |
| wLQyL | D4-4.1.1 | (SEQ ID NO: 753) | 168 |
| DYSNY | D4-4.2.1 | (SEQ ID NO: 754) | 169 |
| wLRwL | D4-17.1.1 | (SEQ ID NO: 759) | 170 |
| DYGDY | D4-17.2.1 | (SEQ ID NO: 760) | 171 |
| wLRWy | D4-23.1.1 | (SEQ ID NO: 766) | 172 |
| DYGGN | D4-23.2.1 | (SEQ ID NO: 767) | 173 |
| TTVVT | D4-23.3.1 | (SEQ ID NO: 768) | 174 |
| LRWyL | D4-23.1.2 | (SEQ ID NO: 774) | 175 |
| YGGNS | D4-23.2.2 | (SEQ ID NO: 775) | 176 |
| VDTAM | D5-5.1.1 | (SEQ ID NO: 781) | 177 |
| WIQLW | D5-5.2.1 | (SEQ ID NO: 782) | 178 |
| GYSYG | D5-5.3.1 | (SEQ ID NO: 783) | 179 |
| DTAMV | D5-5.1.2 | (SEQ ID NO: 790) | 180 |
| IQLWL | D5-5.2.2 | (SEQ ID NO: 791) | 181 |
| YSYGY | D5-5.3.2 | (SEQ ID NO: 792) | 182 |
| VDIVA | D5-12.1.1 | (SEQ ID NO: 799) | 183 |
| WIyWL | D5-12.2.1 | (SEQ ID NO: 800) | 184 |
| GYSGY | D5-12.3.1 | (SEQ ID NO: 801) | 185 |
| DIVAT | D5-12.1.2 | (SEQ ID NO: 808) | 186 |
| IyWLR | D5-12.2.2 | (SEQ ID NO: 809) | 187 |
| YSGYD | D5-12.3.2 | (SEQ ID NO: 810) | 188 |
| IVATI | D5-12.1.3 | (SEQ ID NO: 817) | 189 |
| yWLRL | D5-12.2.3 | (SEQ ID NO: 818) | 190 |
| SGYDY | D5-12.3.3 | (SEQ ID NO: 819) | 191 |
| VEMAT | D5-24.1.1 | (SEQ ID NO: 826) | 192 |
| yRWLQ | D5-24.2.1 | (SEQ ID NO: 827) | 193 |
| RDGYN | D5-24.3.1 | (SEQ ID NO: 828) | 194 |
| EMATI | D5-24.1.2 | (SEQ ID NO: 835) | 195 |
| RWLQL | D5-24.2.2 | (SEQ ID NO: 836) | 196 |
| DGYNY | D5-24.3.2 | (SEQ ID NO: 837) | 197 |
| EYSSS | D6-6.1.1 | (SEQ ID NO: 844) | 198 |
| SIAAR | D6-6.2.1 | (SEQ ID NO: 845) | 199 |
| VyQLV | D6-6.3.1 | (SEQ ID NO: 846) | 200 |
| YSSSS | D6-6.1.2 | (SEQ ID NO: 851) | 201 |
| GYSSS | D6-13.1.1 | (SEQ ID NO: 856) | 202 |
| GIAAA | D6-13.2.1 | (SEQ ID NO: 857) | 203 |
| VyQQL | D6-13.3.1 | (SEQ ID NO: 858) | 204 |
| YSSSW | D6-13.1.2 | (SEQ ID NO: 864) | 205 |
| IAAAG | D6-13.2.2 | (SEQ ID NO: 865) | 206 |
| yQQLV | D6-13.3.2 | (SEQ ID NO: 866) | 207 |
| SSSWY | D6-13.1.3 | (SEQ ID NO: 871) | 208 |
| GYSSG | D6-19.1.1 | (SEQ ID NO: 875) | 209 |
| GIAVA | D6-19.2.1 | (SEQ ID NO: 876) | 210 |
| VyQWL | D6-19.3.1 | (SEQ ID NO: 877) | 211 |
| YSSGW | D6-19.1.2 | (SEQ ID NO: 884) | 212 |
| IAVAG | D6-19.2.2 | (SEQ ID NO: 885) | 213 |
| yQWLV | D6-19.3.2 | (SEQ ID NO: 886) | 214 |
| SSGWY | D6-19.1.3 | (SEQ ID NO: 891) | 215 |

TABLE 14
All hexamers that can be extracted from human
D segments

| | | | |
|---|---|---|---|
| GIVGAT | D1-26.1.1 | (SEQ ID NO: 282) | 1 |
| VyWELL | D1-26.2.1 | (SEQ ID NO: 283) | 2 |
| YSGSYY | D1-26.3.1 | (SEQ ID NO: 284) | 3 |
| RILyyY | D2-2.1.1 | (SEQ ID NO: 300) | 4 |
| GYCSST | D2-2.2.1 | (SEQ ID NO: 301) | 5 |
| DIVVVP | D2-2.3.1 | (SEQ ID NO: 302) | 6 |
| ILyyYQ | D2-2.1.2 | (SEQ ID NO: 309) | 7 |
| YCSSTS | D2-2.2.2 | (SEQ ID NO: 310) | 8 |
| IVVVPA | D2-2.3.2 | (SEQ ID NO: 311) | 9 |
| LyyYQL | D2-2.1.3 | (SEQ ID NO: 318) | 10 |
| CSSTSC | D2-2.2.3 | (SEQ ID NO: 319) | 11 |
| VVVPAA | D2-2.3.3 | (SEQ ID NO: 320) | 12 |
| yyYQLL | D2-2.1.4 | (SEQ ID NO: 327) | 13 |
| SSTSCY | D2-2.2.4 | (SEQ ID NO: 328) | 14 |
| VVPAAI | D2-2.3.4 | (SEQ ID NO: 329) | 15 |
| yYQLLY | D2-2.1.5 | (SEQ ID NO: 336) | 16 |
| STSCYT | D2-2.2.5 | (SEQ ID NO: 337) | 17 |
| RILYyW | D2-8.1.1 | (SEQ ID NO: 351) | 18 |
| GYCTNG | D2-8.2.1 | (SEQ ID NO: 352) | 19 |
| DIVLMV | D2-8.3.1 | (SEQ ID NO: 353) | 20 |
| ILYyWC | D2-8.1.2 | (SEQ ID NO: 360) | 21 |
| YCTNGV | D2-8.2.2 | (SEQ ID NO: 361) | 22 |
| IVLMVY | D2-8.3.2 | (SEQ ID NO: 362) | 23 |
| LYyWCM | D2-8.1.3 | (SEQ ID NO: 369) | 24 |
| CTNGVC | D2-8.2.3 | (SEQ ID NO: 370) | 25 |
| VLMVYA | D2-8.3.3 | (SEQ ID NO: 371) | 26 |
| YyWCML | D2-8.1.4 | (SEQ ID NO: 378) | 27 |
| TNGVCY | D2-8.2.4 | (SEQ ID NO: 379) | 28 |
| LMVYAI | D2-8.3.4 | (SEQ ID NO: 380) | 29 |
| yWCMLY | D2-8.1.5 | (SEQ ID NO: 387) | 30 |
| NGVCYT | D2-8.2.5 | (SEQ ID NO: 388) | 31 |
| RILyWW | D2-15.1.1 | (SEQ ID NO: 398) | 32 |
| GYCSGG | D2-15.2.1 | (SEQ ID NO: 399) | 33 |
| DIVVVV | D2-15.3.1 | (SEQ ID NO: 400) | 34 |
| ILyWWy | D2-15.1.2 | (SEQ ID NO: 406) | 35 |
| YCSGGS | D2-15.2.2 | (SEQ ID NO: 407) | 36 |
| IVVVVA | D2-15.3.2 | (SEQ ID NO: 408) | 37 |
| LyWWyL | D2-15.1.3 | (SEQ ID NO: 415) | 38 |
| CSGGSC | D2-15.2.3 | (SEQ ID NO: 416) | 39 |
| VVVVAA | D2-15.3.3 | (SEQ ID NO: 417) | 40 |
| yWWyLL | D2-15.1.4 | (SEQ ID NO: 424) | 41 |
| SGGSCY | D2-15.2.4 | (SEQ ID NO: 425) | 42 |
| VVVAAT | D2-15.3.4 | (SEQ ID NO: 426) | 43 |
| WWyLLL | D2-15.1.5 | (SEQ ID NO: 433) | 44 |
| GGSCYS | D2-15.2.5 | (SEQ ID NO: 434) | 45 |
| SILWWw | D2-21.1.1 | (SEQ ID NO: 448) | 46 |
| AYCGGD | D2-21.2.1 | (SEQ ID NO: 449) | 47 |
| HIVVVT | D2-21.3.1 | (SEQ ID NO: 450) | 48 |
| ILWWwL | D2-21.1.2 | (SEQ ID NO: 456) | 49 |
| YCGGDC | D2-21.2.2 | (SEQ ID NO: 457) | 50 |
| IVVVTA | D2-21.3.2 | (SEQ ID NO: 458) | 51 |
| LWWwLL | D2-21.1.3 | (SEQ ID NO: 465) | 52 |
| CGGDCY | D2-21.2.3 | (SEQ ID NO: 466) | 53 |
| VVVTAI | D2-21.3.3 | (SEQ ID NO: 467) | 54 |
| WWwLLF | D2-21.1.4 | (SEQ ID NO: 474) | 55 |
| GGDCYS | D2-21.2.4 | (SEQ ID NO: 475) | 56 |
| VLRFLE | D3-3.1.1 | (SEQ ID NO: 489) | 57 |
| YYDFWS | D3-3.2.1 | (SEQ ID NO: 490) | 58 |
| ITIFGV | D3-3.3.1 | (SEQ ID NO: 491) | 59 |
| LRFLEW | D3-3.1.2 | (SEQ ID NO: 498) | 60 |
| YDFWSG | D3-3.2.2 | (SEQ ID NO: 499) | 61 |
| TIFGVV | D3-3.3.2 | (SEQ ID NO: 500) | 62 |
| RFLEWL | D3-3.1.3 | (SEQ ID NO: 507) | 63 |
| DFWSGY | D3-3.2.3 | (SEQ ID NO: 508) | 64 |
| IFGVVI | D3-3.3.3 | (SEQ ID NO: 509) | 65 |
| FLEWLL | D3-3.1.4 | (SEQ ID NO: 516) | 66 |
| FWSGYY | D3-3.2.4 | (SEQ ID NO: 517) | 67 |
| FGVVII | D3-3.3.4 | (SEQ ID NO: 518) | 68 |
| LEWLLY | D3-3.1.5 | (SEQ ID NO: 525) | 69 |
| WSGYYT | D3-3.2.5 | (SEQ ID NO: 526) | 70 |
| VLRYFD | D3-9.1.1 | (SEQ ID NO: 539) | 71 |
| YYDILT | D3-9.2.1 | (SEQ ID NO: 540) | 72 |
| ITIFyL | D3-9.3.1 | (SEQ ID NO: 541) | 73 |
| LRYFDW | D3-9.1.2 | (SEQ ID NO: 548) | 74 |
| YDILTG | D3-9.2.2 | (SEQ ID NO: 549) | 75 |
| TIFyLV | D3-9.3.2 | (SEQ ID NO: 550) | 76 |
| RYFDWL | D3-9.1.3 | (SEQ ID NO: 557) | 77 |
| DILTGY | D3-9.2.3 | (SEQ ID NO: 558) | 78 |
| IFyLVI | D3-9.3.3 | (SEQ ID NO: 559) | 79 |
| YFDWLL | D3-9.1.4 | (SEQ ID NO: 566) | 80 |
| ILTGYY | D3-9.2.4 | (SEQ ID NO: 567) | 81 |
| FyLVII | D3-9.3.4 | (SEQ ID NO: 568) | 82 |
| FDWLLy | D3-9.1.5 | (SEQ ID NO: 575) | 83 |
| LTGYYN | D3-9.2.5 | (SEQ ID NO: 576) | 84 |
| VLLWFG | D3-10.1.1 | (SEQ ID NO: 590) | 85 |
| YYYGSG | D3-10.2.1 | (SEQ ID NO: 591) | 86 |
| ITMVRG | D3-10.3.1 | (SEQ ID NO: 592) | 87 |
| LLWFGE | D3-10.1.2 | (SEQ ID NO: 599) | 88 |
| YYGSGS | D3-10.2.2 | (SEQ ID NO: 600) | 89 |
| TMVRGV | D3-10.3.2 | (SEQ ID NO: 601) | 90 |
| LWFGEL | D3-10.1.3 | (SEQ ID NO: 608) | 91 |
| YGSGSY | D3-10.2.3 | (SEQ ID NO: 609) | 92 |
| MVRGVI | D3-10.3.3 | (SEQ ID NO: 610) | 93 |
| WFGELL | D3-10.1.4 | (SEQ ID NO: 617) | 94 |
| GSGSYY | D3-10.2.4 | (SEQ ID NO: 618) | 95 |
| VRGVII | D3-10.3.4 | (SEQ ID NO: 619) | 96 |
| FGELLy | D3-10.1.5 | (SEQ ID NO: 624) | 97 |
| SGSYYN | D3-10.2.5 | (SEQ ID NO: 625) | 98 |
| VLwLRL | D3-16.1.1 | (SEQ ID NO: 638) | 99 |
| YYDYVW | D3-16.2.1 | (SEQ ID NO: 639) | 100 |
| IMITFG | D3-16.3.1 | (SEQ ID NO: 640) | 101 |
| LwLRLG | D3-16.1.2 | (SEQ ID NO: 647) | 102 |
| YDYVWG | D3-16.2.2 | (SEQ ID NO: 648) | 103 |
| MITFGG | D3-16.3.2 | (SEQ ID NO: 649) | 104 |
| wLRLGE | D3-16.1.3 | (SEQ ID NO: 656) | 105 |
| DYVWGS | D3-16.2.3 | (SEQ ID NO: 657) | 106 |
| ITFGGV | D3-16.3.3 | (SEQ ID NO: 658) | 107 |
| LRLGEL | D3-16.1.4 | (SEQ ID NO: 665) | 108 |
| YVWGSY | D3-16.2.4 | (SEQ ID NO: 666) | 109 |
| TFGGVI | D3-16.3.4 | (SEQ ID NO: 667) | 110 |
| RLGELS | D3-16.1.5 | (SEQ ID NO: 674) | 111 |
| VWGSYR | D3-16.2.5 | (SEQ ID NO: 675) | 112 |
| FGGVIV | D3-16.3.5 | (SEQ ID NO: 676) | 113 |
| LGELSL | D3-16.1.6 | (SEQ ID NO: 683) | 114 |
| WGSYRY | D3-16.2.6 | (SEQ ID NO: 684) | 115 |
| GGVIVI | D3-16.3.6 | (SEQ ID NO: 685) | 116 |
| GELSLY | D3-16.1.7 | (SEQ ID NO: 692) | 117 |
| GSYRYT | D3-16.2.7 | (SEQ ID NO: 693) | 118 |
| VLLwyy | D3-22.1.1 | (SEQ ID NO: 707) | 119 |
| YYYDSS | D3-22.2.1 | (SEQ ID NO: 708) | 120 |
| ITMIVV | D3-22.3.1 | (SEQ ID NO: 709) | 121 |
| LLwyyW | D3-22.1.2 | (SEQ ID NO: 716) | 122 |
| YYDSSG | D3-22.2.2 | (SEQ ID NO: 717) | 123 |
| TMIVVV | D3-22.3.2 | (SEQ ID NO: 718) | 124 |
| LwyyWL | D3-22.1.3 | (SEQ ID NO: 725) | 125 |
| YDSSGY | D3-22.2.3 | (SEQ ID NO: 726) | 126 |
| MIVVVI | D3-22.3.3 | (SEQ ID NO: 727) | 127 |
| wyyWLL | D3-22.1.4 | (SEQ ID NO: 733) | 128 |
| DSSGYY | D3-22.2.4 | (SEQ ID NO: 734) | 129 |
| IVVVIT | D3-22.3.4 | (SEQ ID NO: 735) | 130 |
| yyWLLL | D3-22.1.5 | (SEQ ID NO: 742) | 131 |
| SSGYYY | D3-22.2.5 | (SEQ ID NO: 743) | 132 |
| wLRWyL | D4-23.1.1 | (SEQ ID NO: 769) | 133 |
| DYGGNS | D4-23.2.1 | (SEQ ID NO: 770) | 134 |
| VDTAMV | D5-5.1.1 | (SEQ ID NO: 784) | 135 |
| WIQLWL | D5-5.2.1 | (SEQ ID NO: 785) | 136 |
| GYSYGY | D5-5.3.1 | (SEQ ID NO: 786) | 137 |
| VDIVAT | D5-12.1.1 | (SEQ ID NO: 802) | 138 |
| WIyWLR | D5-12.2.1 | (SEQ ID NO: 803) | 139 |
| GYSGYD | D5-12.3.1 | (SEQ ID NO: 804) | 140 |
| DIVATI | D5-12.1.2 | (SEQ ID NO: 811) | 141 |
| IyWLRL | D5-12.2.2 | (SEQ ID NO: 812) | 142 |
| YSGYDY | D5-12.3.2 | (SEQ ID NO: 813) | 143 |
| VEMATI | D5-24.1.1 | (SEQ ID NO: 829) | 144 |
| yRWLQL | D5-24.2.1 | (SEQ ID NO: 830) | 145 |
| RDGYNY | D5-24.3.1 | (SEQ ID NO: 831) | 146 |
| EYSSSS | D6-6.1.1 | (SEQ ID NO: 847) | 147 |
| GYSSSW | D6-13.1.1 | (SEQ ID NO: 859) | 148 |
| GIAAAG | D6-13.2.1 | (SEQ ID NO: 860) | 149 |
| VyQQLV | D6-13.3.1 | (SEQ ID NO: 861) | 150 |
| YSSSWY | D6-13.1.2 | (SEQ ID NO: 867) | 151 |
| GYSSGW | D6-19.1.1 | (SEQ ID NO: 878) | 152 |
| GIAVAG | D6-19.2.1 | (SEQ ID NO: 879) | 153 |
| VyQWLV | D6-19.3.1 | (SEQ ID NO: 880) | 154 |
| YSSGWY | D6-19.1.2 | (SEQ ID NO: 887) | 155 |

### Example 3

### HC CDR3 of Length 6-20

Insertion of D segments into synthetic HC CDR3s can lead to greater stability and lower immunogenicity. Libraries are designed at the amino-acid level by joining a VH to an optional filler of some length which is joined to a D segment an optional second filler and a JH. For libraries of length six or eight, a full-length JH may follow VH and a short filler. Table 20 shows the frequency of D segments in a sampling of 21,578 Abs selected from FAB-310 or FAB-410 for binding to one target or another. In the sample, 10,439 Abs had no detectable D segment (i.e., 9 or fewer consecutive base and score less than 42). Where D segments are used, the D segments D3-22.2(1290), D3-3.2(1236), D6-19.1(866), D3-10.2(724), D6-13.1(638), D5-18.3(404), D3-10.1(396), D6-13.2(383), D1-26.3(333), D3-10.1(396), D3-16.2(305), D4-17.2(297), D6-19.2(286), D3-10.3(281), D3-9.2(239), D5-12.3(235), D2-15.2(233), D6-6.1(221), D1-26.1(191), D2-2.2(175), D6-6.2(145), D2-2.3(142), D4-23.2(136), D5-24.3(126), D3-3.3(121), D3-3.1(114), D1-7.3(111), and D6-19.3(106) are preferred. The numbers in parentheses are the number of times the D segment named occurred in a sample of 21,578 Abs. In one embodiment, a HC CDR3 is constructed so that most members of the library will have a segment of 3 to ten amino acids taken from a human D segment. In some embodiments, the D segment is variegated. Some positions may be fixed and others variegated so that the amino acid of the D segment is the most common amino acid at that position.

Once the parental amino-acid sequence has been designed, it can be diversified in several ways: error-prone PCR, wobbling, and dobbling. Table 14 shows a number of hexamers that can be derived from human D regions. In one embodiment, the hexamers that contain cysteine residues are excluded. In one embodiment, the fragments of D regions that contain stops are excluded. In one embodiment, any TAG codon found in the D region is replaced by a codon picked from the set comprising TCG, TTG, TGG, CAG, AAG, TAT, and GAG. In one embodiment, any TAA codon found in the D region is replaced by a codon picked form the set comprising TCA, TTA, CAA, AAA, TAT, and GAA. In one embodiment, any TGA of the D region is replaced by a codon picked from the set comprising TGG, TCA, TTA, AGA, and GGA.

Table 21 shows exemplary parental amino-acid sequences for CDR3s from 6 to 20 amino acids. These parental sequences can be combined with diversity in HC CDR1 and CDR2 to form a library. The utility is likely to improve if the CDR3 regions are diversified by, for example, wobbling, dobbling, or error-prone PCR of the CDR3s. In Table 21, sequence 6a comprises the end of VH from 3-23 fused to whole JH1. Sequence 6b contains the end of 3-23 joined to a Y joined to D4-17 (RF 2) joined to the FR4 region of JH1. Sequence 6c contains the end of 3-23 followed by D5-5 (RF 3) followed by the FR4 part of JH1. Sequence 6d contains the end of 3-23 joined to SY joined to the whole JH4. Table 21 shows the level of doping that would be appropriate for the wobbling of the CDR3; other levels could be used as well. Other D regions or fragments of D regions could be used. Other JH sequences could be used.

TABLE 21
Parental amino-acid sequences for HC CDR3s of 6-20 AAs. (Bibl = Biblioteca)

| | | | | | SEQ ID |
|---|---|---|---|---|---|
| Length | Bibl | Parental sequence | level of doping | Comment | NO: |
| 6a | 17, | yycakAEYFQHwgqgtlvtvss | 70:10:10:10 | JH1(whole) | 226 |
| | 61 | | | | |
| 6b | 18, | yycakYDYGDYwgqgtlvtvss | 70:10:10:10 | Y::D4-17(2)::FR4 of JH1 | 227 |
| | 62 | | | | |
| 6c | 19, | yycakGYSYGYwgqgtlvtvss | 70:10:10:10 | D5-5(3)::FR4 of JH1 | 228 |
| | 63 | | | | |
| 6d | 20, | yycakSYYFDYwgqgtlvtvss | 70:10:10:10 | SY::JH4(whole) | 229 |
| | 64 | | | | |
| 8a | 21, | yycakYYAEYFQHwgqgtlvtvss | 73:9:9:9 | YY:JH1(whole) | 230 |
| | 65 | | | | |
| 8b | 22, | yycakYGYSSSWYwgqgtlvtvss | 73:9:9:9 | Y::D6-13(1)::FR4 of JH1 | 231 |
| | 66 | | | | |
| 8c | 23, | yycakYGDYYFDYwgqgtlvtvss | 73:9:9:9 | D4-17(2) [2-5]::JH4(whole) | 232 |
| | 67 | | | | |
| 10a | 24, | yycakYYYDSSGYYYwgqgtlvtvs | 73:9:9:9 | D3-22(2)::Fr4 of JH1 | 233 |
| | 68 | s | | | |
| 10b | 25, | yycakGYcSSTScYTwgqgtlvtvs | 73:9:9:9 | D2-2(2)::Fr4 of JH1 | 234 |
| | 69 | s | | | |
| 10c | 26, | yycakYYSSAEYFQHwgqgtlvtvs | 73:9:9:9 | YYSS (SEQ ID NO: | 235 |
| | 70 | s | | 942)::JH1(whole) | |
| 10d | 27, | yycakGYSYGYYFDYwgqgtlvtvs | 73:9:9:9 | D5-5(3)::JH4(whole) | 236 |
| | 71 | s | | | |
| 12a | 28, | yycakYYYDSSGYYYQHwgqgtlvt | 85:5:5:5 | D3-22(2)::QH::Fr4 of JH1 | 237 |
| | 72 | vss | | | |
| 12b | 29, | yycakGYcSSTScYTQHwgqgtlvt | 85:5:5:5 | D2-2(2)::QH::Fr4 of JH1 | 238 |
| | 73 | vss | | | |
| 12c | 30, | yycakYDGSYSAEYFQHwgqgtlvt | 85:5:5:5 | YDGSYS (SEQ ID NO: | 239 |
| | 74 | vss | | 943)::JH1(whole) | |
| 12d | 31, | yycakYYDYVWGSYRYTwgqgtlvt | 85:5:5:5 | D3-16(2)::Fr of JH1 | 240 |
| | 75 | vss | | | |
| 12e | 32, | yycakGYSYGYYWYFDLwgrgtlvt | 85:5:5:5 | D5-5(3)::JH2(whole) | 241 |
| | 76 | vss | | | |
| 14a | 33, | yycakYYYDSSGYYYYFQHwgqgtl | 73:9:9:9 | D3-22(2)::YFQH (SEQ ID NO: | 242 |
| | 77 | vtvss | | 944)::Fr of JH1 | |
| 14b | 34, | yycakGYcSSTScYTYFQHwgqgtl | 73:9:9:9 | D2-2(2)::YFQH (SEQ ID NO: | 243 |
| | 78 | vtvss | | 944)::Fr of JH1 | |
| 14c | 35, | yycakSYGYcSSTScYTQHwgqgtl | 73:9:9:9 | SY::D2-2(2)::QH::Fr of JH1 | 244 |
| | 79 | vtvss | | | |
| 14d | 36, | yycakSYRYSGYSAEYFQHwgqgtl | 73:9:9:9 | SYRYSGYS (SEQ ID NO: | 245 |
| | 80 | vtvss | | 945)::JH1(whole) | |
| 14e | 37, | yycakAYcGGDcYSNWFDPwgqgtl | 73:9:9:9 | D2-21(2)::JH5(whole) | 246 |
| | 81 | vtvss | | | |
| 15a | 38, | yycakSDGYYYDSSGYYYDYwgqgt | 73:9:9:9 | SD::D3-22.2::JH4(101ff) | 930 |
| | 82 | lvtvss | | | |
| 15b | 39, | yycakGSGYcSGGScYSFDYwgqgt | 73:9:9:9 | GS::D2-15.2::JH4(100ff) | 931 |
| | 83 | lvtvss | | | |
| 15c | 40, | yycakGGRGYSSGWYRAFDIwgqgt | 73:9:9:9 | GGR::D6-19.1::R::JH3(all) | 932 |
| | 84 | mvtvss | | | |
| 16a | 41, | yycakYYYDSSGYYYAEYFQHwgqg | 73:9:9:9 | D3-22(2)::JH1(whole) | 247 |
| | 85 | tlvtvss | | | |
| 16b | 42, | yycakGYcSSTScYTAEYFQHwgqg | 73:9:9:9 | D2-2(2)::JH1(whole) | 248 |
| | 86 | tlvtvss | | | |
| 16c | 43, | yycakSYDSYRSYGSAEYFQHwgqg | 73:9:9:9 | SYDSYRSYGS (SEQ ID NO: | 249 |
| | 87 | tlvtvss | | 946)::JH1(whole) | |
| 16d | 44, | yycakSYSYGYcSSTScYTQHwgqg | 73:9:9:9 | SYSY (SEQ ID NO: 947)::D2- | 250 |
| | 88 | tlvtvss | | 2(2)::QH::Fr JH1 | |
| 17a | 45, | yycakSRPGYSSSWYYYYGMDVwgq | 73:9:9:9 | SRP::6-13.1::JH6(−1Y) | 933 |
| | 89 | gttvtvss | | | |
| 18a | 46, | yycakGYcSGGScYSYYYYGMDVwg | 73:9:9:9 | D2-15.2::JH6(−1Y) | 221 |
| | 90 | qgttvtvss | | | |
| 18b | 47, | yycakDGYcSGGScYSYYYGMDVwg | 73:9:9:9 | D::D2-15.2::JH6(−2Ys) | 222 |
| | 91 | qgttvtvss | | | |
| 19a | 48, | yycakDGYYYDSSGYYYRGYYFDYw | 73:9:9:9 | D::D3-22.2::RGY::JH4(all) | 223 |
| | 92 | gqgtlvtvss | | | |
| 20a | 49, | yycakYSSYYYYDSSGYYYAEYFQH | 73:9:9:9 | YSSY (SEQ ID NO: 948)::D3- | 251 |
| | 93 | wgqgtlvtvss | | 22(2)::JH1(whole) | |
| 20b | 50, | yycakSYYSGYcSSTScYTAEYFQH | 73:9:9:9 | SYYS (SEQ ID NO: 949)::D2- | 252 |
| | 94 | wgqgtlvtvss | | 2(2)::JH1(whole) | |
| 20c | 51, | yycakSGYcSSTScYTYYSAEYFQH | 73:9:9:9 | S::D2- | 253 |
| | 95 | wgqgtlvtvss | | 2(2)::YYS::JH1(whole) | |
| 20d | 52, | yycakYYYYDYVWGSYRYTSNWFDP | 73:9:9:9 | Y::D3-16(2)::S::JH5(whole) | 254 |
| | 96 | wgqgtlvtvss | | | |
| 20e | 53, | yycakYYYYDYVWGSYRYTSSYFDY | 73:9:9:9 | Y::D3- | 255 |
| | 97 | wgqgtlvtvss | | 16(2)::SS::JH4(whole) | |

TABLE 22
HC display cassette
The amino-acid sequence shown in Table 22 is SEQ ID NO: 892.
The DNA sequence shown in Table 22 is SEQ ID NO: 893.

```
                Signal for VH-CH1-IIIstump
                  1 2 3 4 5 6 7 8 9 10 11 12 13 14 15
                M K Y L L P T A A A G L L L L
  946 atg aaa tac cta ttg cct acg gca gcc gct gga ttg tta tta ctc
            16 17 18 19 20 21 22
            A A Q P A M A
  991 gcG GCC cag ccG GCC atg gcc
              SfiI.............
                              NgoMI...(1/2)
                                            NcoI....
VH
                                                                    FR1(DP47/V3-23)---------------
                                                                      1 2 3 4 5 6 7 8
                                                                      E V Q L L E S G
1012 gaa|gtt|CAA|TTG|tta|gag|tct|ggt|
                                                                                  | MfeI |
            --------------FR1--------------------------------------------
                9 10 11 12 13 14 15 16 17 18 19 20 21 22 23
                G G L V Q P G G S L R L S C A
1036 |ggc|ggt|ctt|gtt|cag|cct|ggt|ggt|tct|tta|cgt|ctt|tct|tgc|gct|
            ----FR1-------------------->|...CDR1............|---FR2------
              24 25 26 27 28 29 30 31 32 33 34 35 36 37 38
                A S G F T F S S Y A M S W V R
1081 |gct|TCC|GGA|ttc|act|ttc|tct|tCG|TAC|Gct|atg|tct|tgg|gtt|cgC|
                    | BspEI |  | BsiWII|  |BstXI.
              -------FR2-------------------------------->|...CDR2.........
              39 40 41 42 43 44 45 46 47 48 49 50 51 52 52a
                Q A P G K G L E W V S A I S G
1126 |CAa|gct|ccT|GGt|aaa|ggt|ttg|gag|tgg|gtt|tct|gct|atc|tct|ggt|
    ...BstXI |
          .....CDR2............................................|---FR3---
              53 54 55 56 57 58 59 60 61 62 63 64 65 66 67
                S G G S T Y Y A D S V K G R F
1171 |tct|ggt|ggc|agt|act|tac|tat|gct|gac|tcc|gtt|aaa|ggt|cgc|ttc|
            --------FR3--------------------------------------------------
              68 69 70 71 72 73 74 75 76 77 78 79 80 81 82
                T I S R D N S K N T L Y L Q M
1216 |act|atc|TCT|AGA|gac|aac|tct|aag|aat|act|ctc|tac|ttg|cag|atg|
                            | XbaI |
            ---FR3----------------------------------------------------->|
            82a 82b 82c 83 84 85 86 87 88 89 90 91 92 93 94
                N S L R A E D T A V Y Y C A K
1261 |aac|agC|TTA|AGg|gct|gag|gac|aCT|GCA|Gtc|tac|tat|tgc|gct|aaa|
                          |AflII |  | PstI |(2/2)
            .......CDR3.................................|----FR4--------
              95 96 97 98 98a 98b 98c 99 100 101 102 103 104 105 106
                D Y E G T G Y A F D I W G Q G
1306 |gac|tat|gaa|ggt|act|ggt|tat|gct|ttc|gaC|ATA|TGg|ggt|caa|ggt|
                                                                                          | NdeI |
            --------------FR4---------->|
              107 108 109 110 111 112 113
                T M V T V S S
1351 |act|atG|GTC|ACC|gtc|tct|agt
                          | BstEII |  c tcg ag = XhoI.
CH1
                    A S T K G P S V F P L A P S S
1372 gcc tcc acc aag ggc cca tcg gtc ttc ccG CTA GCa ccc tcc tcc
                                                                                              NheI....
                  151 152 153 154 155 156 157 158 159 160 161 162 163 164 165
                    K S T S G G T A A L G C L V K
1417 aag agc acc tct ggg ggc aca gcg gcc ctg ggc tgc ctg gtc aag
                  166 167 168 169 170 171 172 173 174 175 176 177 178 179 180
                    D Y F P E P V T V S W N S G A
1462 gac tac ttc ccc gaa ccg gtg acg gtg tcg tgg aac tca ggc gcc
                  181 182 183 184 185 186 187 188 189 190 191 192 193 194 195
                    L T S G V H T F P A V L Q S S
1507 ctg acc agc ggc gtc cac acc ttc ccg gct gtc cta cag tcc tca
                  196 197 198 199 200 201 202 203 204 205 206 207 208 209 210
                    G L Y S L S S V V T V P S S S
1552 gga ctc tac tcc ctc agc agc gta gtg acc gtg ccc tct tct agc
                  211 212 213 214 215 216 217 218 219 220 221 222 223 224 225
                    L G T Q T Y I C N V N H K P S
1597 tTG Ggc acc cag acc tac atc tgc aac gtg aat cac aag ccc agc
                  226 227 228 229 230 231 232 233 234 235 236 237 238
                    N T K V D K K V E P K S C
1642 aac acc aag gtg gac aaG AAA GTT GAG CCC AAA TCT TGT
          139 140 141 His tag.............. cMyc tag......................
                A A A H H H H H H G A A E Q K L I
    1681 GCG GCC GCa cat cat cat cac cat cac ggg gcc gca gaa caa aaa ctc atc
              NotI......
                EagI....
              ..................................
            S E E D L N G A A E A S S A S N A S
1732 tca gaa gag gat ctg aat ggg GCC gca gaG GCt agt tct gct agt aAC GCG Tct
                                                                  BglI.......... (3/4) MluI....
  Domain 3 (IIIstump)-----------------------------------------------------
                  S G D F D Y E K M A N A N K G A
      1786 tcc ggt gat ttt gat tat gaa aag atg gca aac gct aat aag ggg gct
                  M T E N A D E N A L Q S D A K G
      1834 atg acc gaa aat gcc gat gaa aac gcg cta cag tct gac gct aaa ggc
                  K L D S V A T D Y G A A I D G F
      1882 aaa ctt gat tct gtc gct act gat tac ggt gct gct atc gat ggt ttc
                  I G D V S G L A N G N G A T G D
      1930 att ggt gac gtt tcc ggc ctt gct aat ggt aat ggt gct act ggt gat
                  F A G S N S Q M A Q V G D G D N
      1978 ttt gct ggc tct aat tcc caa atg gct caa gtc ggt gac ggt gat aat
                  S P L M N N F R Q Y L P S L P Q
      2026 tca cct tta atg aat aat ttc cgt caa tat tta cct tcc ctc cct caa
                  S V E C R P F V F G A G K P Y E
      2074 tcg gtt gaa tgt cgc cct ttt gtc ttt ggc gct ggt aaa cca tat gaa
              F S I D C D K I N L F R
  2122 ttt tct att gat tgt gac aaa ata aac tta ttc cgt
                                                                                                    End Domain 3
                  G V F A F L L Y V A T F M Y V F140
      2158 ggt gtc ttt gcg ttt ctt tta tat gtt gcc acc ttt atg tat gta ttt
            start transmembrane segment
              S T F A N I L
  2206 tct acg ttt gct aac ata ctg
                  R N K E S (SEQ ID NO: 892)
      2227 cgt aat aag gag tct TAA tga aAC GCG Tga tga GAATTC (SEQ ID NO: 893)
        Intracellular anchor. MluI.... EcoRI.
```

TABLE 25
The DNA sequence of DY3F85LC containing a sample germline O12 kappa light
chain. The antibody sequences shown are of the form of actual antibody,
but have not been identified as binding to a particular antigen.
On each line, everything after an exclamation point (!) is commentary.
The DNA of DY3F85LC is SEQ ID NO: 27 950

!---------------------------------------------------------------------------

| | |
|---|---|
| 1 | AATGCTACTA CTATTAGTAG AATTGATGCC ACCTTTTCAG CTCGCGCCCC AAATGAAAAT |
| 61 | ATAGCTAAAC AGGTTATTGA CCATTTGCGA AATGTATCTA ATGGTCAAAC TAAATCTACT |
| 121 | CGTTCGCAGA ATTGGGAATC AACTGTTATA TGGAATGAAA CTTCCAGACA CCGTACTTTA |
| 181 | GTTGCATATT TAAAACATGT TGAGCTACAG CATTATATTC AGCAATTAAG CTCTAAGCCA |
| 241 | TCCGCAAAAA TGACCTCTTA TCAAAAGGAG CAATTAAAGG TACTCTCTAA TCCTGACCTG |
| 301 | TTGGAGTTTG CTTCCGGTCT GGTTCGCTTT GAAGCTCGAA TTAAAACGCG ATATTTGAAG |
| 361 | TCTTTCGGGC TTCCTCTTAA TCTTTTTGAT GCAATCCGCT TTGCTTCTGA CTATAATAGT |
| 421 | CAGGGTAAAG ACCTGATTTT TGATTTATGG TCATTCTCGT TTTCTGAACT GTTTAAAGCA |
| 481 | TTTGAGGGGG ATTCAATGAA TATTTATGAC GATTCCGCAG TATTGGACGC TATCCAGTCT |
| 541 | AAACATTTTA CTATTACCCC CTCTGGCAAA ACTTCTTTTG CAAAAGCCTC TCGCTATTTT |
| 601 | GGTTTTTATC GTCGTCTGGT AAACGAGGGT TATGATAGTG TTGCTCTTAC TATGCCTCGT |
| 661 | AATTCCTTTT GGCGTTATGT ATCTGCATTA GTTGAATGTG GTATTCCTAA ATCTCAACTG |
| 721 | ATGAATCTTT CTACCTGTAA TAATGTTGTT CCGTTAGTTC GTTTTATTAA CGTAGATTTT |
| 781 | TCTTCCCAAC GTCCTGACTG GTATAATGAG CCAGTTCTTA AAATCGCATA AGGTAATTCA |
| 841 | CAATGATTAA AGTTGAAATT AAACCATCTC AAGCCCAATT TACTACTCGT TCTGGTGTTT |
| 901 | CTCGTCAGGG CAAGCCTTAT TCACTGAATG AGCAGCTTTG TTACGTTGAT TTGGGTAATG |
| 961 | AATATCCGGT TCTTGTCAAG ATTACTCTTG ATGAAGGTCA GCCAGCCTAT GCGCCTGGTC |
| 1021 | TGTACACCGT TCATCTGTCC TCTTTCAAAG TTGGTCAGTT CGGTTCCCTT ATGATTGACC |
| 1081 | GTCTGCGCCT CGTTCCGGCT AAGTAACATG GAGCAGGTCG CGGATTTCGA CACAATTTAT |
| 1141 | CAGGCGATGA TACAAATCTC CGTTGTACTT TGTTTCGCGC TTGGTATAAT CGCTGGGGGT |
| 1201 | CAAAGATGAG TGTTTTAGTG TATTCTTTTG CCTCTTTCGT TTTAGGTTGG TGCCTTCGTA |
| 1261 | GTGGCATTAC GTATTTTACC CGTTTAATGG AAACTTCCTC ATGAAAAAGT CTTTAGTCCT |
| 1321 | CAAAGCCTCT GTAGCCGTTG CTACCCTCGT TCCGATGCTG TCTTTCGCTG CTGAGGGTGA |
| 1381 | CGATCCCGCA AAAGCGGCCT TTAACTCCCT GCAAGCCTCA GCGACCGAAT ATATCGGTTA |
| 1441 | TGCGTGGGCG ATGGTTGTTG TCATTGTCGG CGCAACTATC GGTATCAAGC TGTTTAAGAA |
| 1501 | ATTCACCTCG AAAGCAAGCT GATAAACCGA TACAATTAAA GGCTCCTTTT GGAGCCTTTT |
| 1561 | TTTTGGAGAT TTTCAACGTG AAAAAATTAT TATTCGCAAT TCCTTTAGTT GTTCCTTTCT |
| 1621 | ATTCTCACTC CGCTGA7ACT GTTGCATATT GTTTAGCAAA ATCCCATACA GAAAATTCAT |
| 1681 | TTACTAACGT CTGGAAAGAC GACAAAACTT TAGATCGTTA CGCTAACTAT GAGGGCTGTC |
| 1741 | TGTGGAATGC TACAGGCGTT GTAGTTTGTA CTGGTGACGA AACTCAGTGT TACGGTACAT |
| 1801 | GGGTTCCTAT TGGGCTTGCT ATCCCTGAAA ATGAGGGTGG TGGCTCTGAG GGTGGCGGTT |
| 1861 | CTGAGGGTGG CGGTTCTGAG GGTGGCGGTA CTAAACCTCC TGAGTACGGT GATACACCTA |
| 1921 | TTCCGGGCTA TACTTATATC AACCCTCTCG ACGGCACTTA TCCGCCTGGT ACTGAGCAAA |
| 1981 | ACCCCGCTAA TCCTAATCCT TCTCTTGAGG AGTCTCAGCC TCTTAATACT TTCATGTTTC |
| 2041 | AGAATAATAG GTTCCGAAAT AGGCAGGGGG CATTAACTGT TTATACGGGC ACTGTTACTC |
| 2101 | AAGGCACTGA CCCCGTTAAA ACTTATTACC AGTACACTCC TGTATCATCA AAAGCCATGT |
| 2161 | ATGACGCTTA CTGGAACGGT AAATTCAGAG ACTGCGCTTT CCATTCTGGC TTTAATGAGG |
| 2221 | ATTTATTTGT TTGTGAATAT CAAGGCCAAT CGTCTGACCT GCCTCAACCT CCTGTCAATG |
| 2281 | CTGGCGGCGG CTCTGGTGGT GGTTCTGGTG GCGGCTCTGA GGGTGGTGGC TCTGAGGGTG |
| 2341 | GCGGTTCTGA GGGTGGCGGC TCTGAGGGAG GCGGTTCCGG TGGTGGCTCT GGTTCCGGTG |
| 2401 | ATTTTGATTA TGAAAAGATG GCAAACGCTA ATAAGGGGGC TATGACCGAA AATGCCGATG |
| 2461 | AAAACGCGCT ACAGTCTGAC GCTAAAGGCA AACTTGATTC TGTCGCTACT GATTACGGTG |
| 2521 | CTGCTATCGA TGGTTTCATT GGTGACGTTT CCGGCCTTGC TAATGGTAAT GGTGCTACTG |
| 2581 | GTGATTTTGC TGGCTCTAAT TCCCAAATGG CTCAAGTCGG TGACGGTGAT AATTCACCTT |
| 2641 | TAATGAATAA TTTCCGTCAA TATTTACCTT CCCTCCCTCA ATCGGTTGAA TGTCGCCCTT |
| 2701 | TTGTCTTTGG CGCTGGTAAA CCATATGAAT TTTCTATTGA TTGTGACAAA ATAAACTTAT |
| 2761 | TCCGTGGTGT CTTTGCGTTT CTTTTATATG TTGCCACCTT TATGTATGTA TTTTCTACGT |
| 2821 | TTGCTAACAT ACTGCGTAAT AAGGAGTCTT AATCATGCCA GTTCTTTTGG GTATTCCGTT |
| 2881 | ATTATTGCGT TTCCTCGGTT TCCTTCTGGT AACTTTGTTC GGCTATCTGC TTACTTTTCT |
| 2941 | TAAAAAGGGC TTCGGTAAGA TAGCTATTGC TATTTCATTG TTTCTTGCTC TTATTATTGG |
| 3001 | GCTTAACTCA ATTCTTGTGG GTTATCTCTC TGATATTAGC GCTCAATTAC CCTCTGACTT |
| 3061 | TGTTCAGGGT GTTCAGTTAA TTCTCCCGTC TAATGCGCTT CCCTGTTTTT ATGTTATTCT |
| 3121 | CTCTGTAAAG GCTGCTATTT TCATTTTTGA CGTTAAACAA AAAATCGTTT CTTATTTGGA |
| 3181 | TTGGGATAAA TAATATGGCT GTTTATTTTG TAACTGGCAA ATTAGGCTCT GGAAAGACGC |
| 3241 | TCGTTAGCGT TGGTAAGATT CAGGATAAAA TTGTAGCTGG GTGCAAAATA GCAACTAATC |
| 3301 | TTGATTTAAG GCTTCAAAAC CTCCCGCAAG TCGGGAGGTT CGCTAAAACG CCTCGCGTTC |
| 3361 | TTAGAATACC GGATAAGCCT TCTATATCTG ATTTGCTTGC TATTGGGCGC GGTAATGATT |
| 3421 | CCTACGATGA AAATAAAAAC GGCTTGCTTG TTCTCGATGA GTGCGGTACT TGGTTTAATA |
| 3481 | CCCGTTCTTG GAATGATAAG GAAAGACAGC CGATTATTGA TTGGTTTCTA CATGCTCGTA |
| 3541 | AATTAGGATG GGATATTATT TTTCTTGTTC AGGACTTATC TATTGTTGAT AAACAGGCGC |
| 3601 | GTTCTGCATT AGCTGAACAT GTTGTTTATT GTCGTCGTCT GGACAGAATT ACTTTACCTT |
| 3661 | TTGTCGGTAC TTTATATTCT CTTATTACTG GCTCGAAAAT GCCTCTGCCT AAATTACATG |
| 3721 | TTGGCGTTGT TAAATATGGC GATTCTCAAT TAAGCCCTAC TGTTGAGCGT TGGCTTTATA |
| 3781 | CTGGTAAGAA TTTGTATAAC GCATATGATA CTAAACAGGC TTTTTCTAGT AATTATGATT |
| 3841 | CCGGTGTTTA TTCTTATTTA ACGCCTTATT TATCACACGG TCGGTATTTC AAACCATTAA |
| 3901 | ATTTAGGTCA GAAGATGAAA TTAACTAAAA TATATTTGAA AAAGTTTTCT CGCGTTCTTT |
| 3961 | GTCTTGCGAT TGGATTTGCA TCAGCATTTA CATATAGTTA TATAACCCAA CCTAAGCCGG |
| 4021 | AGGTTAAAAA GGTAGTCTCT CAGACCTATG ATTTTGATAA ATTCACTATT GACTCTTCTC |
| 4081 | AGCGTCTTAA TCTAAGCTAT CGCTATGTTT TCAAGGATTC TAAGGGAAAA TTAATTAATA |
| 4141 | GCGACGATTT ACAGAAGCAA GGTTATTCAC TCACATATAT TGATTTATGT ACTGTTTCCA |
| 4201 | TTAAAAAAGG TAATTCAAAT GAAATTGTTA AATGTAATTA ATTTTGTTTT CTTGATGTTT |
| 4261 | GTTTCATCAT CTTCTTTTGC TCAGGTAATT GAAATGAATA ATTCGCCTCT GCGCGATTTT |
| 4321 | GTAACTTGGT ATTCAAAGCA ATCAGGCGAA TCCGTTATTG TTTCTCCCGA TGTAAAAGGT |
| 4381 | ACTGTTACTG TATATTCATC TGACGTTAAA CCTGAAAATC TACGCAATTT CTTTATTTCT |
| 4441 | GTTTTACGTG CAAATAATTT TGATATGGTA GGTTCTAACC CTTCCATAAT TCAGAAGTAT |
| 4501 | AATCCAAACA ATCAGGATTA TATTGATGAA TTGCCATCAT CTGATAATCA GGAATATGAT |
| 4561 | GATAATTCCG CTCCTTCTGG TGGTTTCTTT GTTCCGCAAA ATGATAATGT TACTCAAACT |
| 4621 | TTTAAAATTA ATAACGTTCG GGCAAAGGAT TTAATACGAG TTGTCGAATT GTTTGTAAAG |
| 4681 | TCTAATACTT CTAAATCCTC AAATGTATTA TCTATTGACG GCTCTAATCT ATTAGTTGTT |
| 4741 | AGTGCTCCTA AAGATATTTT AGATAACCTT CCTCAATTCC TTTCAACTGT TGATTTGCCA |
| 4801 | ACTGACCAGA TATTGATTGA GGGTTTGATA TTTGAGGTTC AGCAAGGTGA TGCTTTAGAT |
| 4861 | TTTTCATTTG CTGCTGGCTC TCAGCGTGGC ACTGTTGCAG GCGGTGTTAA TACTGACCGC |
| 4921 | CTCACCTCTG TTTTATCTTC TGCTGGTGGT TCGTTCGGTA TTTTTAATGG CGATGTTTTA |
| 4981 | GGGCTATCAG TTCGCGCATT AAAGACTAAT AGCCATTCAA AAATATTGTC TGTGCCACGT |
| 5041 | ATTCTTACGC TTTCAGGTCA GAAGGGTTCT ATCTCTGTTG GCCAGAATGT CCCTTTTATT |
| 5101 | ACTGGTCGTG TGACTGGTGA ATCTGCCAAT GTAAATAATC CATTTCAGAC GATTGAGCGT |
| 5161 | CAAAATGTAG GTATTTCCAT GAGCGTTTTT CCTGTTGCAA TGGCTGGCGG TAATATTGTT |
| 5221 | CTGGATATTA CCAGCAAGGC CGATAGTTTG AGTTCTTCTA CTCAGGCAAG TGATGTTATT |
| 5281 | ACTAATCAAA GAAGTATTGC TACAACGGTT AATTTGCGTG ATGGACAGAC TCTTTTACTC |
| 5341 | GGTGGCCTCA CTGATTATAA AAACACTTCT CAGGATTCTG GCGTACCGTT CCTGTTGCAA |
| 5401 | ATCCCTTTAA TCGGCCTCCT GTTTAGCTCC CGCTCTGATT CTAACGAGGA AAGCACGTTA |
| 5461 | TACGTGCTCG TCAAAGCAAC CATAGTACGC GCCCTGTAGC GGCGCATTAA GCGCGGCGGG |
| 5521 | TGTGGTGGTT ACGCGCAGCG TGACCGCTAC ACTTGCCAGC GCCCTAGCGC CCGCTCCTTT |
| 5581 | CGCTTTCTTC CCTTCCTTTC TCGCCACGTT CGCCGGCTTT CCCCGTCAAG CTCTAAATCG |
| 5641 | GGGGCTCCCT TTAGGGTTCC GATTTAGTGC TTTACGGCAC CTCGACCCCA AAAAACTTGA |
| 5701 | TTTGGGTGAT GGTTCACGTA GTGGGCCATC GCCCTGATAG ACGGTTTTTC GCCCTTTGAC |
| 5761 | GTTGGAGTCC ACGTTCTTTA ATAGTGGACT CTTGTTCCAA ACTGGAACAA CACTCAACCC |
| 5821 | TATCTCGGGC TATTCTTTTG ATTTATAAGG GATTTTGCCG ATTTCGGAAC CACCATCAAA |
| 5881 | CAGGATTTTC GCCTGCTGGG GCAAACCAGC GTGGACCGCT TGCTGCAACT CTCTCAGGGC |
| 5941 | CAGGCGGTGA AGGGCAATCA GCTGTTGCCC GTCTCACTGG TGAAAAGAAA AACCACCCTG |
| 6001 | GATCCAAGCT TGCAGGTGGC ACTTTTCGGG GAAATGTGCG CGGAACCCCT ATTTGTTTAT |
| 6061 | TTTTCTAAAT ACATTCAAAT ATGTATCCGC TCATGAGACA ATAACCCTGA TAAATGCTTC |
| 6121 | AATAATATTG AAAAAGGAAG AGTATGAGTA TTCAACATTT CCGTGTCGCC CTTATTCCCT |
| 6181 | TTTTTGCGGC ATTTTGCCTT CCTGTTTTTG CTCACCCAGA AACGCTGGTG AAAGTAAAAG |
| 6241 | ATGCTGAAGA TCAGTTGGGC GCACTAGTGG GTTACATCGA ACTGGATCTC AACAGCGGTA |
| 6301 | AGATCCTTGA GAGTTTTCGC CCCGAAGAAC GTTTTCCAAT GATGAGCACT TTTAAAGTTC |
| 6361 | TGCTATGTGG CGCGGTATTA TCCCGTATTG ACGCCGGGCA AGAGCAACTC GGTCGCCGCA |
| 6421 | TACACTATTC TCAGAATGAC TTGGTTGAGT ACTCACCAGT CACAGAAAAG CATCTTACGG |
| 6481 | ATGGCATGAC AGTAAGAGAA TTATGCAGTG CTGCCATAAC CATGAGTGAT AACACTGCGG |
| 6541 | CCAACTTACT TCTGACAACG ATCGGAGGAC CGAAGGAGCT AACCGCTTTT TTGCACAACA |
| 6601 | TGGGGGATCA TGTAACTCGC CTTGATCGTT GGGAACCGGA GCTGAATGAA GCCATACCAA |
| 6661 | ACGACGAGCG TGACACCACG ATGCCTGTAG CAATGGCAAC AACGTTGCGC AAACTATTAA |
| 6721 | CTGGCGAACT ACTTACTCTA GCTTCCCGGC AACAATTAAT AGACTGGATG GAGGCGGATA |
| 6781 | AAGTTGCAGG ACCACTTCTG CGCTCGGCCC TTCCGGCTGG CTGGTTTATT GCTGATAAAT |
| 6841 | CTGGAGCCGG TGAGCGTGGG TCTCGCGGTA TCATTGCAGC ACTGGGGCCA GATGGTAAGC |
| 6901 | CCTCCCGTAT CGTAGTTATC TACACGACGG GGAGTCAGGC AACTATGGAT GAACGAAATA |
| 6961 | GACAGATCGC TGAGATAGGT GCCTCACTGA TTAAGCATTG GTAACTGTCA GACCAAGTTT |
| 7021 | ACTCATATAT ACTTTAGATT GATTTAAAAC TTCATTTTTA ATTTAAAAGG ATCTAGGTGA |
| 7081 | AGATCCTTTT TGATAATCTC ATGACCAAAA TCCCTTAACG TGAGTTTTCG TTCCACTGTA |
| 7141 | CGTAAGACCC CCAAGCTTGT CGACTGAATG GCGAATGGCG CTTTGCCTGG TTTCCGGCAC |
| 7201 | CAGAAGCGGT GCCGGAAAGC TGGCTGGAGT GCGATCTTCC TGACGCTCGA GCGCAACGCA |
| ! | XhoI... |
| 7261 | ATTAATGTGA GTTAGCTCAC TCATTAGGCA CCCCAGGCTT TACACTTTAT GCTTCCGGCT |
| 7321 | CGTATGTTGT GTGGAATTGT GAGCGGATAA CAATTTCACA CAGGAAACAG CTATGACCAT |
| 7381 | GATTACGCCA AGCTTTGGAG CCTTTTTTTT GGAGATTTTC AAC |

TABLE 30
DNA sequence of DY3FHC87 (SEQ ID NO: 894)

| | |
|---|---|
| 1 | aatgctacta ctattagtag aattgatgcc accttttcag ctcgcgcccc aaatgaaaat |
| 61 | atagctaaac aggttattga ccatttgcga aatgtatcta atggtcaaac taaatctact |
| 121 | cgttcgcaga attgggaatc aactgttata tggaatgaaa cttccagaca ccgtacttta |
| 181 | gttgcatatt taaaacatgt tgagctacag cattatattc agcaattaag ctctaagcca |
| 241 | tccgcaaaaa tgacctctta tcaaaaggag caattaaagg tactctctaa tcctgacctg |
| 301 | ttggagtttg cttccggtct ggttcgcttt gaagctcgaa ttaaaacgcg atatttgaag |
| 361 | tctttcgggc ttcctcttaa tctttttgat gcaatccgct ttgcttctga ctataatagt |
| 421 | cagggtaaag acctgatttt tgatttatgg tcattctcgt tttctgaact gtttaaagca |
| 481 | tttgaggggg attcaatgaa tatttatgac gattccgcag tattggacgc tatccagtct |
| 541 | aaacatttta ctattacccc ctctggcaaa acttcttttg caaaagcctc tcgctatttt |
| 601 | ggtttttatc gtcgtctggt aaacgagggt tatgatagtg ttgctcttac tatgcctcgt |
| 661 | aattcctttt ggcgttatgt atctgcatta gttgaatgtg gtattcctaa atctcaactg |
| 721 | atgaatcttt ctacctgtaa taatgttgtt ccgttagttc gttttattaa cgtagatttt |
| 781 | tcttcccaac gtcctgactg gtataatgag ccagttctta aaatcgcata aggtaattca |
| 841 | caatgattaa agttgaaatt aaaccatctc aagcccaatt tactactcgt tctggtgttt |
| 901 | ctcgtcaggg caagccttat tcactgaatg agcagctttg ttacgttgat ttgggtaatg |
| 961 | aatatccggt tcttgtcaag attactcttg atgaaggtca gccagcctat gcgcctggtc |
| 1021 | tgtacaccgt tcatctgtcc tctttcaaag ttggtcagtt cggttccctt atgattgacc |
| 1081 | gtctgcgcct cgttccggct aagtaacatg gagcaggtcg cggatttcga cacaatttat |
| 1141 | caggcgatga tacaaatctc cgttgtactt tgtttcgcgc ttggtataat cgctgggggt |
| 1201 | caaagatgag tgttttagtg tattcttttg cctctttcgt tttaggttgg tgccttcgta |
| 1261 | gtggcattac gtattttacc cgtttaatgg aaacttcctc atgaaaaagt ctttagtcct |
| 1321 | caaagcctct gtagccgttg ctaccctcgt tccgatgctg tctttcgctg ctgagggtga |
| 1381 | cgatcccgca aaagcggcct ttaactccct gcaagcctca gcgaccgaat atatcggtta |
| 1441 | tgcgtgggcg atggttgttg tcattgtcgg cgcaactatc ggtatcaagc tgtttaagaa |
| 1501 | attcacctcg aaagcaagct gataaaccga tacaattaaa ggctcctttt ggagcctttt |
| 1561 | tttttggaga ttttcaacgt gaaaaaatta ttattcgcaa ttcctttagt tgttcctttc |
| 1621 | tattctcact ccgctgaaac tgttgaaagt tgtttagcaa aatcccatac agaaaattca |
| 1681 | tttactaacg tctggaaaga cgacaaaact ttagatcgtt acgctaacta tgagggctgt |
| 1741 | ctgtggaatg ctacaggcgt tgtagtttgt actggtgacg aaactcagtg ttacggtaca |
| 1801 | tgggttccta ttgggcttgc tatccctgaa aatgagggtg gtggctctga gggtggcggt |
| 1861 | tctgagggtg gcggttctga gggtggcggt actaaacctc ctgagtacgg tgatacacct |
| 1921 | attccgggct atacttatat caaccctctc gacggcactt atccgcctgg tactgagcaa |
| 1981 | aaccccgcta atcctaatcc ttctcttgag gagtctcagc ctcttaatac tttcatgttt |
| 2041 | cagaataata ggttccgaaa taggcagggg gcattaactg tttatacggg cactgttact |
| 2101 | caaggcactg accccgttaa aacttattac cagtacactc ctgtatcatc aaaagccatg |
| 2161 | tatgacgctt actggaacgg taaattcaga gactgcgctt tccattctgg ctttaatgag |
| 2221 | gatttatttg tttgtgaata tcaaggccaa tcgtctgacc tgcctcaacc tcctgtcaat |
| 2281 | gctggcggcg gctctggtgg tggttctggt ggcggctctg agggtggtgg ctctgagggt |
| 2341 | ggcggttctg agggtggcgg ctctgaggga ggcggttccg gtggtggctc tggttccggt |
| 2401 | gattttgatt atgaaaagat ggcaaacgct aataaggggg ctatgaccga aaatgccgat |
| 2461 | gaaaacgcgc tacagtctga cgctaaaggc aaacttgatt ctgtcgctac tgattacggt |
| 2521 | gctgctatcg atggtttcat tggtgacgtt tccggccttg ctaatggtaa tggtgctact |
| 2581 | ggtgattttg ctggctctaa ttcccaaatg gctcaagtcg gtgacggtga taattcacct |
| 2641 | ttaatgaata atttccgtca atatttacct tccctccctc aatcggttga atgtcgccct |
| 2701 | tttgtctttg gcgctggtaa accatatgaa ttttctattg attgtgacaa aataaactta |
| 2761 | ttccgtggtg tctttgcgtt tcttttatat gttgccacct ttatgtatgt attttctacg |
| 2821 | tttgctaaca tactgcgtaa taaggagtct taatcatgcc agttcttttg ggtattccgt |
| 2881 | tattattgcg tttcctcggt ttccttctgg taactttgtt cggctatctg cttacttttc |
| 2941 | ttaaaaaggg cttcggtaag atagctattg ctatttcatt gtttcttgct cttattattg |
| 3001 | ggcttaactc aattcttgtg ggttatctct ctgatattag cgctcaatta ccctctgact |
| 3061 | ttgttcaggg tgttcagtta attctcccgt ctaatgcgct tccctgtttt tatgttattc |
| 3121 | tctctgtaaa ggctgctatt ttcatttttg acgttaaaca aaaaatcgtt tcttatttgg |
| 3181 | attgggataa ataatatggc tgtttatttt gtaactggca aattaggctc tggaaagacg |
| 3241 | ctcgttagcg ttggtaagat tcaggataaa attgtagctg ggtgcaaaat agcaactaat |
| 3301 | cttgatttaa ggcttcaaaa cctcccgcaa gtcgggaggt tcgctaaaac gcctcgcgtt |
| 3361 | cttagaatac cggataagcc ttctatatct gatttgcttg ctattgggcg cggtaatgat |
| 3421 | tcctacgatg aaaataaaaa cggcttgctt gttctcgatg agtgcggtac ttggtttaat |
| 3481 | acccgttctt ggaatgataa ggaaagacag ccgattattg attggtttct acatgctcgt |
| 3541 | aaattaggat gggatattat ttttcttgtt caggacttat ctattgttga taaacaggcg |
| 3601 | cgttctgcat tagctgaaca tgttgtttat tgtcgtcgtc tggacagaat tactttacct |
| 3661 | tttgtcggta ctttatattc tcttattact ggctcgaaaa tgcctctgcc taaattacat |
| 3721 | gttggcgttg ttaaatatgg cgattctcaa ttaagcccta ctgttgagcg ttggctttat |
| 3781 | actggtaaga atttgtataa cgcatatgat actaaacagg ctttttctag taattatgat |
| 3841 | tccggtgttt attcttattt aacgccttat ttatcacacg gtcggtattt caaaccatta |
| 3901 | aatttaggtc agaagatgaa attaactaaa atatatttga aaaagttttc tcgcgttctt |
| 3961 | tgtcttgcga ttggatttgc atcagcattt acatatagtt atataaccca acctaagccg |
| 4021 | gaggttaaaa aggtagtctc tcagacctat gattttgata aattcactat tgactcttct |
| 4081 | cagcgtctta atctaagcta tcgctatgtt ttcaaggatt ctaagggaaa attaattaat |
| 4141 | agcgacgatt tacagaagca aggttattca ctcacatata ttgatttatg tactgtttcc |
| 4201 | attaaaaaag gtaattcaaa tgaaattgtt aaatgtaatt aattttgttt tcttgatgtt |
| 4261 | tgtttcatca tcttcttttg ctcaggtaat tgaaatgaat aattcgcctc tgcgcgattt |
| 4321 | tgtaacttgg tattcaaagc aatcaggcga atccgttatt gtttctcccg atgtaaaagg |
| 4381 | tactgttact gtatattcat ctgacgttaa acctgaaaat ctacgcaatt tctttatttc |
| 4441 | tgttttacgt gcaaataatt ttgatatggt aggttctaac ccttccataa ttcagaagta |
| 4501 | taatccaaac aatcaggatt atattgatga attgccatca tctgataatc aggaatatga |
| 4561 | tgataattcc gctccttctg gtggtttctt tgttccgcaa aatgataatg ttactcaaac |
| 4621 | ttttaaaatt aataacgttc gggcaaagga tttaatacga gttgtcgaat tgtttgtaaa |
| 4681 | gtctaatact tctaaatcct caaatgtatt atctattgac ggctctaatc tattagttgt |
| 4741 | tagtgctcct aaagatattt tagataacct tcctcaattc ctttcaactg ttgatttgcc |
| 4801 | aactgaccag atattgattg agggtttgat atttgaggtt cagcaaggtg atgctttaga |
| 4861 | tttttcattt gctgctggct ctcagcgtgg cactgttgca ggcggtgtta atactgaccg |
| 4921 | cctcacctct gttttatctt ctgctggtgg ttcgttcggt atttttaatg gcgatgtttt |
| 4981 | agggctatca gttcgcgcat taaagactaa tagccattca aaaatattgt ctgtgccacg |
| 5041 | tattcttacg ctttcaggtc agaagggttc tatctctgtt ggccagaatg tcccttttat |
| 5101 | tactggtcgt gtgactggtg aatctgccaa tgtaaataat ccatttcaga cgattgagcg |
| 5161 | tcaaaatgta ggtatttcca tgagcgtttt tcctgttgca atggctggcg gtaatattgt |
| 5221 | tctggatatt accagcaagg ccgatagttt gagttcttct actcaggcaa gtgatgttat |
| 5281 | tactaatcaa agaagtattg ctacaacggt taatttgcgt gatggacaga ctcttttact |
| 5341 | cggtggcctc actgattata aaaacacttc tcaggattct ggcgtaccgt tcctgtctaa |
| 5401 | aatcccttta atcggcctcc tgtttagctc ccgctctgat tctaacgagg aaagcacgtt |
| 5461 | atacgtgctc gtcaaagcaa ccatagtacg cgccctgtag cggcgcatta agcgcggcgg |
| 5521 | gtgtggtggt tacgcgcagc gtgaccgcta cacttgccag cgccctagcg cccgctcctt |
| 5581 | tcgctttctt cccttccttt ctcgccacgt tcgccggctt tccccgtcaa gctctaaatc |
| 5641 | gggggctccc tttagggttc cgatttagtg ctttacggca cctcgacccc aaaaaacttg |
| 5701 | atttgggtga tggttcacgt agtgggccat cgccctgata gacggttttt cgccctttga |
| 5761 | cgttggagtc cacgttcttt aatagtggac tcttgttcca aactggaaca acactcaacc |
| 5821 | ctatctcggg ctattctttt gatttataag ggattttgcc gatttcggaa ccaccatcaa |
| 5881 | acaggatttt cgcctgctgg ggcaaaccag cgtggaccgc ttgctgcaac tctctcaggg |
| 5941 | ccaggcggtg aagggcaatc agctgttgcc cgtctcactg gtgaaaagaa aaaccaccct |
| 6001 | ggatccaagc ttgcaggtgg cacttttcgg ggaaatgtgc gcggaacccc tatttgttta |
| 6061 | tttttctaaa tacattcaaa tatgtatccg ctcatgagac aataaccctg ataaatgctt |
| 6121 | caataatatt gaaaaaggaa gagtatgagt attcaacatt tccgtgtcgc ccttattccc |
| 6181 | ttttttgcgg cattttgcct tcctgttttt gctcacccag aaacgctggt gaaagtaaaa |
| 6241 | gatgctgaag atcagttggg cgcactagtg ggttacatcg aactggatct caacagcggt |
| 6301 | aagatccttg agagttttcg ccccgaagaa cgttttccaa tgatgagcac ttttaaagtt |
| 6361 | ctgctatgtg gcgcggtatt atcccgtatt gacgccgggc aagagcaact cggtcgccgc |
| 6421 | atacactatt ctcagaatga cttggttgag tactcaccag tcacagaaaa gcatcttacg |
| 6481 | gatggcatga cagtaagaga attatgcagt gctgccataa ccatgagtga taacactgcg |
| 6541 | gccaacttac ttctgacaac gatcggagga ccgaaggagc taaccgcttt tttgcacaac |
| 6601 | atgggggatc atgtaactcg ccttgatcgt tgggaaccgg agctgaatga agccatacca |
| 6661 | aacgacgagc gtgacaccac gatgcctgta gcaatggcaa caacgttgcg caaactatta |
| 6721 | actggcgaac tacttactct agcttcccgg caacaattaa tagactggat ggaggcggat |
| 6781 | aaagttgcag gaccacttct gcgctcggcc cttccggctg gctggtttat tgctgataaa |
| 6841 | tctggagccg gtgagcgtgg gtctcgcggt atcattgcag cactggggcc agatggtaag |
| 6901 | ccctcccgta tcgtagttat ctacacgacg gggagtcagg caactatgga tgaacgaaat |
| 6961 | agacagatcg ctgagatagg tgcctcactg attaagcatt ggtaactgtc agaccaagtt |
| 7021 | tactcatata tactttagat tgatttaaaa cttcattttt aatttaaaag gatctaggtg |
| 7081 | aagatccttt ttgataatct catgaccaaa atcccttaac gtgagttttc gttccactgt |
| 7141 | acgtaagacc cccaagcttg tcgactgaat ggcgaatggc gctttgcctg gtttccggca |
| 7201 | ccagaagcgg tgccggaaag ctggctggag tgcgatcttc ctgacgctcg agcgcaacgc |
| 7261 | aattaatgtg agttagctca ctcattaggc accccaggct ttacacttta tgcttccggc |
| 7321 | tcgtatgttg tgtggaattg tgagcggata acaatttcac acaggaaaca gctatgacca |
| 7381 | tgattacgcc aagctttgga gccttttttt tggagatttt caacatgaaa tacctattgc |
| 7441 | ctacggcagc cgctggattg ttattactcg cGGCCcagcc GGCCatggcc gaagttcaat |
| 7501 | tgttagagtc tggtggcggt cttgttcagc ctggtggttc tttacgtctt tcttgcgctg |
| 7561 | cttccggatt cactttctct tcgtacgcta tgtcttgggt tcgccaagct cctggtaaag |
| 7621 | gtttggagtg ggtttctgct atctctggtt ctggtggcag tacttactat gctgactccg |
| 7681 | ttaaaggtcg cttcactatc tctagagaca actctaagaa tactctctac ttgcagatga |
| 7741 | acagcttaag ggctgaggac actgcagtct actattgcgc taaagcctat cgtccttctt |
| 7801 | atcatgacat atggggtcaa ggtactatgg tcaccgtctc tagtgcctcc accaagggcc |
| 7861 | catcggtctt cccgctagca ccctcctcca agagcacctc tgggggcaca gcggccctgg |
| 7921 | gctgcctggt caaggactac ttccccgaac cggtgacggt gtcgtggaac tcaggcgccc |
| 7981 | tgaccagcgg cgtccacacc ttcccggctg tcctacagtc ctcaggactc tactccctca |
| 8041 | gcagcgtagt gaccgtgccc tccagcagct tgggcaccca gacctacatc tgcaacgtga |
| 8101 | atcacaagcc cagcaacacc aaggtggaca agaaagttga gcccaaatct tgtgcggccg |
| 8161 | cacatcatca tcaccatcac ggggccgcag aacaaaaact catctcagaa gaggatctga |
| 8221 | atggggccgc agaggctagc tctgctagtg gcgacttcga ctacgagaaa atggctaatg |
| 8281 | ccaacaaagg cgccatgact gagaacgctg acgagaatgc tttgcaaagc gatgccaagg |
| 8341 | gtaagttaga cagcgtcgcg accgactatg gcgccgccat cgacggcttt atcggcgatg |
| 8401 | tcagtggttt ggccaacggc aacggagcca ccggagactt cgcaggttcg aattctcaga |
| 8461 | tggcccaggt tggagatggg gacaacagtc cgcttatgaa caactttaga cagtaccttc |
| 8521 | cgtctcttcc gcagagtgtc gagtgccgtc cattcgtttt cggtgccggc aagccttacg |
| 8581 | agttcagcat cgactgcgat aagatcaatc ttttccgcgg cgttttcgct ttcttgctat |
| 8641 | acgtcgctac tttcatgtac gttttcagca ctttcgccaa tattttacgc aacaaagaaa |
| 8701 | gctagtgatc tcctaggaag cccgcctaat gagcgggctt tttttttctg gtatgcatcc |
| 8761 | tgaggccgat actgtcgtcg tcccctcaaa ctggcagatg cacggttacg atgcgcccat |
| 8821 | ctacaccaac gtgacctatc ccattacggt caatccgccg tttgttccca cggagaatcc |
| 8881 | gacgggttgt tactcgctca catttaatgt tgatgaaagc tggctacagg aaggccagac |
| 8941 | gcgaattatt tttgatggcg ttcctattgg ttaaaaaatg agctgattta acaaaaattt |
| 9001 | aatgcgaatt ttaacaaaat attaacgttt acaatttaaa tatttgctta tacaatcttc |
| 9061 | ctgtttttgg ggcttttctg attatcaacc ggggtacata tgattgacat gctagtttta |
| 9121 | cgattaccgt tcatcgattc tcttgtttgc tccagactct caggcaatga cctgatagcc |
| 9181 | tttgtagatc tctcaaaaat agctaccctc tccggcatta atttatcagc tagaacggtt |
| 9241 | gaatatcata ttgatggtga tttgactgtc tccggccttt ctcacccttt tgaatcttta |
| 9301 | cctacacatt actcaggcat tgcatttaaa atatatgagg gttctaaaaa tttttatcct |
| 9361 | tgcgttgaaa taaaggcttc tcccgcaaaa gtattacagg gtcataatgt ttttggtaca |
| 9421 | accgatttag ctttatgctc tgaggcttta ttgcttaatt ttgctaattc tttgccttgc |
| 9481 | ctgtatgatt tattggatgt t |

TABLE 35
DNA sequence of pMID21: 5957 bp (SEQ ID NO: 895)

| | |
|---|---|
| 1 | gacgaaaggg cctcgtgata cgcctatttt tataggttaa tgtcatgata ataatggttt |
| 61 | cttagacgtc aggtggcact tttcggggaa atgtgcgcgg aacccctatt tgtttatttt |
| 121 | tctaaataca ttcaaatatg tatccgctca tgagacaata accctgataa atgcttcaat |
| 181 | aatattgaaa aaggaagagt atgagtattc aacatttccg tgtcgccctt attccctttt |
| 241 | ttgcggcatt ttgccttcct gtttttgctc acccagaaac gctggtgaaa gtaaaagatg |
| 301 | ctgaagatca gttgggtgcc cgagtgggtt acatcgaact ggatctcaac agcggtaaga |
| 361 | tccttgagag ttttcgcccc gaagaacgtt ttccaatgat gagcactttt aaagttctgc |
| 421 | tatgtggcgc ggtattatcc cgtattgacg ccgggcaaga gcaactcggt cgccgcatac |
| 481 | actattctca gaatgacttg gttgagtact caccagtcac agaaaagcat cttacggatg |
| 541 | gcatgacagt aagagaatta tgcagtgctg ccataaccat gagtgataac actgcggcca |
| 601 | acttacttct gacaacgatc ggaggaccga aggagctaac cgcttttttg cacaacatgg |
| 661 | gggatcatgt aactcgcctt gatcgttggg aaccggagct gaatgaagcc ataccaaacg |
| 721 | acgagcgtga caccacgatg cctgtagcaa tggcaacaac gttgcgcaaa ctattaactg |
| 781 | gcgaactact tactctagct tcccggcaac aattaataga ctggatggag gcggataaag |
| 841 | ttgcaggacc acttctgcgc tcggcccttc cggctggctg gtttattgct gataaatctg |
| 901 | gagccggtga gcgtgggtct cgcggtatca ttgcagcact ggggccagat ggtaagccct |
| 961 | cccgtatcgt agttatctac acgacgggga gtcaggcaac tatggatgaa cgaaatagac |
| 1021 | agatcgctga gataggtgcc tcactgatta agcattggta actgtcagac caagtttact |
| 1081 | catatatact ttagattgat ttaaaacttc atttttaatt taaaaggatc taggtgaaga |
| 1141 | tcctttttga taatctcatg accaaaatcc cttaacgtga gttttcgttc cactgagcgt |
| 1201 | cagaccccgt agaaaagatc aaaggatctt cttgagatcc tttttttctg cgcgtaatct |
| 1261 | gctgcttgca aacaaaaaaa ccaccgctac cagcggtggt ttgtttgccg gatcaagagc |
| 1321 | taccaactct ttttccgaag gtaactggct tcagcagagc gcagatacca aatactgttc |
| 1381 | ttctagtgta gccgtagtta ggccaccact tcaagaactc tgtagcaccg cctacatacc |
| 1441 | tcgctctgct aatcctgtta ccagtggctg ctgccagtgg cgataagtcg tgtcttaccg |
| 1501 | ggttggactc aagacgatag ttaccggata aggcgcagcg gtcgggctga acggggggtt |
| 1561 | cgtgcataca gcccagcttg gagcgaacga cctacaccga actgagatac ctacagcgtg |
| 1621 | agctatgaga aagcgccacg cttcccgaag ggagaaaggc ggacaggtat ccggtaagcg |
| 1681 | gcagggtcgg aacaggagag cgcacgaggg agcttccagg gggaaacgcc tggtatcttt |
| 1741 | atagtcctgt cgggtttcgc cacctctgac ttgagcgtcg atttttgtga tgctcgtcag |
| 1801 | gggggcggag cctatggaaa aacgccagca acgcggcctt tttacggttc ctggcctttt |
| 1861 | gctggccttt tgctcacatg ttctttcctg cgttatcccc tgattctgtg gataaccgta |
| 1921 | ttaccgcctt tgagtgagct gataccgctc gccgcagccg aacgaccgag cgcagcgagt |
| 1981 | cagtgagcga ggaagcggaa gagcgcccaa tacgcaaacc gcctctcccc gcgcgttggc |
| 2041 | cgattcatta atgcagctgg cacgacaggt ttcccgactg gaaagcgggc agtgagcgca |
| 2101 | acgcaattaa tgtgagttag ctcactcatt aggcacccca ggctttacac tttatgcttc |
| 2161 | cggctcgtat gttgtgtgga attgtgagcg gataacaatt tcacacagga aacagctatg |
| 2221 | accatgatta cgccaagctt tggagccttt tttttggaga ttttcaacgt gaaaaaatta |
| 2281 | ttattcgcaa ttcctttagt tgttcctttc tattctcaca gtgcacaggt ccaactgcag |
| 2341 | gagctcgaga tcaaacgtgg aactgtggct gcaccatctg tcttcatctt cccgccatct |
| 2401 | gatgagcagt tgaaatctgg aactgcctct gttgtgtgcc tgctgaataa cttctatccc |
| 2461 | agagaggcca aagtacagtg gaaggtggat aacgccctcc aatcgggtaa ctcccaggag |
| 2521 | agtgtcacag agcaggacag caaggacagc acctacagcc tcagcagcac cctgacgctg |
| 2581 | agcaaagcag actacgagaa acacaaagtc tacgcctgcg aagtcaccca tcagggcctg |
| 2641 | agttcaccgg tgacaaagag cttcaacagg ggagagtgtt aataaggcgc gcctaaccat |
| 2701 | ctatttcaag gaacagtctt aatgaaaaag cttttattca tgatcccgtt agttgtaccg |
| 2761 | ttcgtggccc agccggcctc tgctgaagtt caattgttag agtctggtgg cggtcttgtt |
| 2821 | cagcctggtg gttctttacg tctttcttgc gctgcttccg gagcttcaga tctgtttgcc |
| 2881 | tttttgtggg gtggtgcaga tcgcgttacg gagatcgacc gactgcttga gcaaaagcca |
| 2941 | cgcttaactg ctgatcaggc atgggatgtt attcgccaaa ccagtcgtca ggatcttaac |
| 3001 | ctgaggcttt ttttacctac tctgcaagca gcgacatctg gtttgacaca gagcgatccg |
| 3061 | cgtcgtcagt tggtagaaac attaacacgt tgggatggca tcaatttgct taatgatgat |
| 3121 | ggtaaaacct ggcagcagcc aggctctgcc atcctgaacg tttggctgac cagtatgttg |
| 3181 | aagcgtaccg tagtggctgc cgtacctatg ccatttgata agtggtacag cgccagtggc |
| 3241 | tacgaaacaa cccaggacgg cccaactggt tcgctgaata taagtgttgg agcaaaaatt |
| 3301 | ttgtatgagg cggtgcaggg agacaaatca ccaatcccac aggcggttga tctgtttgct |
| 3361 | gggaaaccac agcaggaggt tgtgttggct gcgctggaag atacctggga gactctttcc |
| 3421 | aaacgctatg gcaataatgt gagtaactgg aaaacaccgg caatggcctt aacgttccgg |
| 3481 | gcaaataatt tctttggtgt accgcaggcc gcagcggaag aaacgcgtca tcaggcggag |
| 3541 | tatcaaaacc gtggaacaga aaacgatatg attgttttct caccaacgac aagcgatcgt |
| 3601 | cctgtgcttg cctgggatgt ggtcgcaccc ggtcagagtg ggtttattgc tcccgatgga |
| 3661 | acagttgata agcactatga agatcagctg aaaatgtacg aaaattttgg ccgtaagtcg |
| 3721 | ctctggttaa cgaagcagga tgtggaggcg cataaggagt tctagagaca actctaagaa |
| 3781 | tactctctac ttgcagatga acagcttaag tctgagcatt cggtccgggc aacattctcc |
| 3841 | aaactgacca gacgacacaa acggcttacg ctaaatcccg cgcatgggat ggtaaagagg |
| 3901 | tggcgtcttt gctggcctgg actcatcaga tgaaggccaa aaattggcag gagtggacac |
| 3961 | agcaggcagc gaaacaagca ctgaccatca actggtacta tgctgatgta aacggcaata |
| 4021 | ttggttatgt tcatactggt gcttatccag atcgtcaatc aggccatgat ccgcgattac |
| 4081 | ccgttcctgg tacgggaaaa tgggactgga aagggctatt gccttttgaa atgaacccta |
| 4141 | aggtgtataa cccccagcag ctagccatat tctctcggtc accgtctcaa gcgcctccac |
| 4201 | caagggccca tcggtcttcc cgctagcacc ctcctccaag agcacctctg ggggcacagc |
| 4261 | ggccctgggc tgcctggtca aggactactt ccccgaaccg gtgacggtgt cgtggaactc |
| 4321 | aggcgccctg accagcggcg tccacacctt cccggctgtc ctacagtcta gcggactcta |
| 4381 | ctccctcagc agcgtagtga ccgtgccctc ttctagcttg ggcacccaga cctacatctg |
| 4441 | caacgtgaat cacaagccca gcaacaccaa ggtggacaag aaagttgagc ccaaatcttg |
| 4501 | tgcggccgca catcatcatc accatcacgg ggccgcagaa caaaaactca tctcagaaga |
| 4561 | ggatctgaat ggggccgcag aggctagttc tgctagtaac gcgtcttccg gtgattttga |
| 4621 | ttatgaaaag atggcaaacg ctaataaggg ggctatgacc gaaaatgccg atgaaaacgc |
| 4681 | gctacagtct gacgctaaag gcaaacttga ttctgtcgct actgattacg gtgctgctat |
| 4741 | cgatggtttc attggtgacg tttccggcct tgctaatggt aatggtgcta ctggtgattt |
| 4801 | tgctggctct aattcccaaa tggctcaagt cggtgacggt gataattcac ctttaatgaa |
| 4861 | taatttccgt caatatttac cttccctccc tcaatcggtt gaatgtcgcc cttttgtctt |
| 4921 | tggcgctggt aaaccatatg aattttctat tgattgtgac aaaataaact tattccgtgg |
| 4981 | tgtctttgcg tttcttttat atgttgccac ctttatgtat gtattttcta cgtttgctaa |
| 5041 | catactgcgt aataaggagt cttaatgaaa cgcgtgatga gaattcactg gccgtcgttt |
| 5101 | tacaacgtcg tgactgggaa aaccctggcg ttacccaact taatcgcctt gcagcacatc |
| 5161 | cccctttcgc cagctggcgt aatagcgaag aggcccgcac cgatcgccct tcccaacagt |
| 5221 | tgcgcagcct gaatggcgaa tggcgcctga tgcggtattt tctccttacg catctgtgcg |
| 5281 | gtatttcaca ccgcatacgt caaagcaacc atagtacgcg ccctgtagcg gcgcattaag |
| 5341 | cgcggcgggt gtggtggtta cgcgcagcgt gaccgctaca cttgccagcg ccttagcgcc |
| 5401 | cgctcctttc gctttcttcc cttcctttct cgccacgttc gccggctttc cccgtcaagc |
| 5461 | tctaaatcgg gggctccctt tagggttccg atttagtgct ttacggcacc tcgaccccaa |
| 5521 | aaaacttgat ttgggtgatg gttcacgtag tgggccatcg ccctgataga cggtttttcg |
| 5581 | ccctttgacg ttggagtcca cgttctttaa tagtggactc ttgttccaaa ctggaacaac |
| 5641 | actcaactct atctcgggct attcttttga tttataaggg attttgccga tttcggtcta |
| 5701 | ttggttaaaa aatgagctga tttaacaaaa atttaacgcg aattttaaca aaatattaac |
| 5761 | gtttacaatt ttatggtgca gtctcagtac aatctgctct gatgccgcat agttaagcca |
| 5821 | gccccgacac ccgccaacac ccgctgacgc gccctgacgg gcttgtctgc tcccggcatc |
| 5881 | cgcttacaga caagctgtga ccgtctccgg gagctgcatg tgtcagaggt tttcaccgtc |
| 5941 | atcaccgaaa cgcgcga |

TABLE 36
pM21J containing IIIss::A27::Ckappa

Number of bases 5225
(SEQ ID NO: 921)

| | |
|---|---|
| GACGAAAGGG CCTCGTGATA CGCCTATTTT TATAGGTTAA TGTCATGATA ATAATGGTTT | 60 |
| CTTAGACGTC AGGTGGCACT TTTCGGGGAA ATGTGCGCGG AACCCCTATT TGTTTATTTT | 120 |
| TCTAAATACA TTCAAATATG TATCCGCTCA TGAGACAATA ACCCTGATAA ATGCTTCAAT | 180 |
| AATATTGAAA AAGGAAGAGT ATGAGTATTC AACATTTCCG TGTCGCCCTT ATTCCCTTTT | 240 |
| TTGCGGCATT TTGCCTTCCT GTTTTTGCTC ACCCAGAAAC GCTGGTGAAA GTAAAAGATG | 300 |
| CTGAAGATCA GTTGGGTGCC CGAGTGGGTT ACATCGAACT GGATCTCAAC AGCGGTAAGA | 360 |
| TCCTTGAGAG TTTTCGCCCC GAAGAACGTT TTCCAATGAT GAGCACTTTT AAAGTTCTGC | 420 |
| TATGTGGCGC GGTATTATCC CGTATTGACG CCGGGCAAGA GCAACTCGGT CGCCGCATAC | 480 |
| ACTATTCTCA GAATGACTTG GTTGAGTACT CACCAGTCAC AGAAAAGCAT CTTACGGATG | 540 |
| GCATGACAGT AAGAGAATTA TGCAGTGCTG CCATAACCAT GAGTGATAAC ACTGCGGCCA | 600 |
| ACTTACTTCT GACAACGATC GGAGGACCGA AGGAGCTAAC CGCTTTTTTG CACAACATGG | 660 |
| GGGATCATGT AACTCGCCTT GATCGTTGGG AACCGGAGCT GAATGAAGCC ATACCAAACG | 720 |
| ACGAGCGTGA CACCACGATG CCTGTAGCAA TGGCAACAAC GTTGCGCAAA CTATTAACTG | 780 |
| GCGAACTACT TACTCTAGCT TCCCGGCAAC AATTAATAGA CTGGATGGAG GCGGATAAAG | 840 |
| TTGCAGGACC ACTTCTGCGC TCGGCCCTTC CGGCTGGCTG GTTTATTGCT GATAAATCTG | 900 |
| GAGCCGGTGA GCGTGGGTCT CGCGGTATCA TTGCAGCACT GGGGCCAGAT GGTAAGCCCT | 960 |
| CCCGTATCGT AGTTATCTAC ACGACGGGGA GTCAGGCAAC TATGGATGAA CGAAATAGAC | 1020 |
| AGATCGCTGA GATAGGTGCC TCACTGATTA AGCATTGGTA ACTGTCAGAC CAAGTTTACT | 1080 |
| CATATATACT TTAGATTGAT TTAAAACTTC ATTTTTAATT TAAAAGGATC TAGGTGAAGA | 1140 |
| TCCTTTTTGA TAATCTCATG ACCAAAATCC CTTAACGTGA GTTTTCGTTC CACTGAGCGT | 1200 |
| CAGACCCCGT AGAAAAGATC AAAGGATCTT CTTGAGATCC TTTTTTTCTG CGCGTAATCT | 1260 |
| GCTGCTTGCA AACAAAAAAA CCACCGCTAC CAGCGGTGGT TTGTTTGCCG GATCAAGAGC | 1320 |
| TACCAACTCT TTTTCCGAAG GTAACTGGCT TCAGCAGAGC GCAGATACCA AATACTGTTC | 1380 |
| TTCTAGTGTA GCCGTAGTTA GGCCACCACT TCAAGAACTC TGTAGCACCG CCTACATACC | 1440 |
| TCGCTCTGCT AATCCTGTTA CCAGTGGCTG CTGCCAGTGG CGATAAGTCG TGTCTTACCG | 1500 |
| GGTTGGACTC AAGACGATAG TTACCGGATA AGGCGCAGCG GTCGGGCTGA ACGGGGGGTT | 1560 |
| CGTGCATACA GCCCAGCTTG GAGCGAACGA CCTACACCGA ACTGAGATAC CTACAGCGTG | 1620 |
| AGCTATGAGA AAGCGCCACG CTTCCCGAAG GGAGAAAGGC GGACAGGTAT CCGGTAAGCG | 1680 |
| GCAGGGTCGG AACAGGAGAG CGCACGAGGG AGCTTCCAGG GGGAAACGCC TGGTATCTTT | 1740 |
| ATAGTCCTGT CGGGTTTCGC CACCTCTGAC TTGAGCGTCG ATTTTTGTGA TGCTCGTCAG | 1800 |
| GGGGGCGGAG CCTATGGAAA AACGCCAGCA ACGCGGCCTT TTTACGGTTC CTGGCCTTTT | 1860 |
| GCTGGCCTTT TGCTCACATG TTCTTTCCTG CGTTATCCCC TGATTCTGTG GATAACCGTA | 1920 |
| TTACCGCCTT TGAGTGAGCT GATACCGCTC GCCGCAGCCG AACGACCGAG CGCAGCGAGT | 1980 |
| CAGTGAGCGA GGAAGCGGAA GAGCGCCCAA TACGCAAACC GCCTCTCCCC GCGCGTTGGC | 2040 |
| CGATTCATTA ATGCAGCTGG CACGACAGGT TTCCCGACTG GAAAGCGGGC AGTGAGCGCA | 2100 |
| ACGCAATTAA TGTGAGTTAG CTCACTCATT AGGCACCCCA GGCTTTACAC TTTATGCTTC | 2160 |
| CGGCTCGTAT GTTGTGTGGA ATTGTGAGCG GATAACAATT TCACACAGGA AACAGCTATG | 2220 |
| ACCATGATTA CGCCAAGCTT TGGAGCCTTT TTTTTGGAGA TTTTCAACAT GAAGAAACTG | 2280 |
| CTGTCTGCTA TCCCACTAGT TGTCCCTTTC TATTCTCATA GTGAAATCGT TCTGACCCAG | 2340 |
| TCCCCGGGGA CCCTGTCTCT GTCTCCGGGT GAACGTGCTA CGCTGAGCTG TCGTGCTTCT | 2400 |
| CAATCCGTTA GCTCCTCTTA TTTAGCTTGG TATCAGCAAA AGCCGGGTCA AGCTCCGCGG | 2460 |
| CTGTTGATCT ATGGTGCCTC TAGTCGTGCT ACTGGCATCC CTGATCGTTT CTCTGGCTCT | 2520 |
| GGCTCCGGAA CCGATTTCAC TCTGACCATT TCTCGTCTCG AGCCGGAAGA TTTCGCTGTC | 2580 |
| TACTATTGTC AACAGTATGG TTCTAGTCCG CTGACTTTCG GTGGCGGTAC CAAAGTCGAA | 2640 |
| ATCAAGCGTG GAACTGTGGC TGCACCATCT GTCTTCATCT TCCCGCCATC TGATGAGCAG | 2700 |
| TTGAAATCTG GAACTGCCTC TGTTGTGTGC CTGCTGAATA ACTTCTATCC CAGAGAGGCC | 2760 |
| AAAGTACAGT GGAAGGTGGA TAACGCCCTC CAATCGGGTA ACTCCCAGGA GAGTGTCACA | 2820 |
| GAGCAGGACA GCAAGGACAG CACCTACAGC CTCAGCAGCA CCCTGACTCT GTCCAAAGCA | 2880 |
| GACTACGAGA AACACAAAGT CTACGCCTGC GAAGTCACCC ATCAGGGCCT GAGTTCACCG | 2940 |
| GTGACAAAGA GCTTCAACAG GGGAGAGTGT TAATAAGGCG CGCCAATTTA ACCATCTATT | 3000 |
| TCAAGGAACA GTCTTAATGA AGAAGCTCCT CTTTGCTATC CCGCTCGTCG TTCCTTTTGT | 3060 |
| GGCCCAGCCG GCCATGGCCG AAGTTCAATT GTTAGAGTCT GGTGGCGGTC TTGTTCAGCC | 3120 |
| TGGTGGTTCT TTACGTCTTT CTTGCGCTGC TTCCGGATTC ACTTTCTCTC GTTACAAGAT | 3180 |
| GAAGTGGGTT CGCCAAGCTC CTGGTAAAGG TTTGGAGTGG GTTTCTGTTA TCTATCCTTC | 3240 |
| TGGTGGCGGT ACTGGTTATG CTGACTCCGT TAAAGGTCGC TTCACTATCT CTAGAGACAA | 3300 |
| CTCTAAGAAT ACTCTCTACT TGCAGATGAA CAGCTTAAGG GCTGAGGACA CTGCAGTCTA | 3360 |
| CTATTGTGCG AGAGTCAATT ACTATGATAG TAGTGGTTAC GGTCCTATAG CTCCTGGACT | 3420 |
| TGACTACTGG GGCCAGGGAA CCCTGGTCAC CGTCTCAAGC GCCTCCACCA AGGGTCCGTC | 3480 |
| GGTCTTCCCG CTAGCACCCT CCTCCAAGAG CACCTCTGGG GGCACAGCGG CCCTGGGCTG | 3540 |
| CCTGGTCAAG GACTACTTCC CCGAACCGGT GACGGTGTCG TGGAACTCAG GCGCCCTGAC | 3600 |
| CAGCGGCGTC CACACCTTCC CGGCTGTCCT ACAGTCTAGC GGACTCTACT CCCTCAGCAG | 3660 |
| CGTAGTGACC GTGCCCTCTT CTAGCTTGGG CACCCAGACC TACATCTGCA ACGTGAATCA | 3720 |
| CAAGCCCAGC AACACCAAGG TGGACAAGAA AGTTGAGCCC AAATCTTGTG CGGCCGCACA | 3780 |
| TCATCATCAC CATCACGGGG CCGCAGAACA AAAACTCATC TCAGAAGAGG ATCTGAATGG | 3840 |
| GGCCGCAGAG GCTAGTTCTG CTAGTAACGC GTCTTCCGGT GATTTTGATT ATGAAAAGAT | 3900 |
| GGCAAACGCT AATAAGGGGG CTATGACCGA AAATGCCGAT GAAAACGCGC TACAGTCTGA | 3960 |
| CGCTAAAGGC AAACTTGATT CTGTCGCTAC TGATTACGGT GCTGCTATCG ATGGTTTCAT | 4020 |
| TGGTGACGTT TCCGGCCTTG CTAATGGTAA TGGTGCTACT GGTGATTTTG CTGGCTCTAA | 4080 |
| TTCCCAAATG GCTCAAGTCG GTGACGGTGA TAATTCACCT TTAATGAATA ATTTCCGTCA | 4140 |
| ATATTTACCT TCCCTCCCTC AATCGGTTGA ATGTCGCCCT TTTGTCTTTG GCGCTGGTAA | 4200 |
| ACCATATGAA TTTTCTATTG ATTGTGACAA AATAAACTTA TTCCGTGGTG TCTTTGCGTT | 4260 |
| TCTTTTATAT GTTGCCACCT TTATGTATGT ATTTTCTACG TTTGCTAACA TACTGCGTAA | 4320 |
| TAAGGAGTCT TAATGAAACG CGTGATGAGA ATTCACTGGC CGTCGTTTTA CAACGTCGTG | 4380 |
| ACTGGGAAAA CCCTGGCGTT ACCCAACTTA ATCGCCTTGC AGCACATCCC CCTTTCGCCA | 4440 |
| GCTGGCGTAA TAGCGAAGAG GCCCGCACCG ATCGCCCTTC CCAACAGTTG CGCAGCCTGA | 4500 |
| ATGGCGAATG GCGCCTGATG CGGTATTTTC TCCTTACGCA TCTGTGCGGT ATTTCACACC | 4560 |
| GCATACGTCA AAGCAACCAT AGTACGCGCC CTGTAGCGGC GCATTAAGCG CGGCGGGTGT | 4620 |
| GGTGGTTACG CGCAGCGTGA CCGCTACACT TGCCAGCGCC TTAGCGCCCG CTCCTTTCGC | 4680 |
| TTTCTTCCCT TCCTTTCTCG CCACGTTCGC CGGCTTTCCC CGTCAAGCTC TAAATCGGGG | 4740 |
| GCTCCCTTTA GGGTTCCGAT TTAGTGCTTT ACGGCACCTC GACCCCAAAA AACTTGATTT | 4800 |
| GGGTGATGGT TCACGTAGTG GGCCATCGCC CTGATAGACG GTTTTTCGCC CTTTGACGTT | 4860 |
| GGAGTCCACG TTCTTTAATA GTGGACTCTT GTTCCAAACT GGAACAACAC TCAACTCTAT | 4920 |
| CTCGGGCTAT TCTTTTGATT TATAAGGGAT TTTGCCGATT TCGGTCTATT GGTTAAAAAA | 4980 |
| TGAGCTGATT TAACAAAAAT TTAACGCGAA TTTTAACAAA ATATTAACGT TTACAATTTT | 5040 |
| ATGGTGCAGT CTCAGTACAA TCTGCTCTGA TGCCGCATAG TTAAGCCAGC CCCGACACCC | 5100 |
| GCCAACACCC GCTGACGCGC CCTGACGGGC TTGTCTGCTC CCGGCATCCG CTTACAGACA | 5160 |
| AGCTGTGACC GTCTCCGGGA GCTGCATGTG TCAGAGGTTT TCACCGTCAT CACCGAAACG | 5220 |
| CGCGA | 5225 |

TABLE 40
pLCSK23 (SEQ ID NO: 896)

| | |
|---|---|
| 1 | GACGAAAGGG CCTGCTCTGC CAGTGTTACA ACCAATTAAC CAATTCTGAT TAGAAAAACT |
| 61 | CATCGAGCAT CAAATGAAAC TGCAATTTAT TCATATCAGG ATTATCAATA CCATATTTTT |
| 121 | GAAAAAGCCG TTTCTGTAAT GAAGGAGAAA ACTCACCGAG GCAGTTCCAT AGGATGGCAA |
| 181 | GATCCTGGTA TCGGTCTGCG ATTCCGACTC GTCCAACATC AATACAACCT ATTAATTTCC |
| 241 | CCTCGTCAAA AATAAGGTTA TCAAGTGAGA AATCACCATG AGTGACGACT GAATCCGGTG |
| 301 | AGAATGGCAA AAGCTTATGC ATTTCTTTCC AGACTTGTTC AACAGGCCAG CCATTACGCT |
| 361 | CGTCATCAAA ATCACTCGCA TCAACCAAAC CGTTATTCAT TCGTGATTGC GCCTGAGCGA |
| 421 | GACGAAATAC GCGATCGCTG TTAAAAGGAC AATTACAAAC AGGAATTGAA TGCAACCGGC |
| 481 | GCAGGAACAC TGCCAGCGCA TCAACAATAT TTTCACCTGA ATCAGGATAT TCTTCTAATA |
| 541 | CCTGGAATGC TGTTTTCCCG GGGATCGCAG TGGTGAGTAA CCATGCATCA TCAGGAGTAC |
| 601 | GGATAAAATG CTTGATGGTC GGAAGAGGCA TAAATTCCGT CAGCCAGTTT AGTCTGACCA |
| 661 | TCTCATCTGT AACATCATTG GCAACGCTAC CTTTGCCATG TTTCAGAAAC AACTCTGGCG |
| 721 | CATCGGGCTT CCCATACAAT CGATAGATTG TCGCACCTGA TTGCCCGACA TTATCGCGAG |
| 781 | CCCATTTATA CCCATATAAA TCAGCATCCA TGTTGGAATT TAATCGCGGC CTCGAGCAAG |
| 841 | ACGTTTCCCG TTGAATATGG CTCATAACAC CCCTTGTATT ACTGTTTATG TAAGCAGACA |
| 901 | GTTTTATTGT TCATGATGAT ATATTTTTAT CTTGTGCAAT GTAACATCAG AGATTTTGAG |
| 961 | ACACAACGTG GCTTTCCCCC CCCCCCCCTG CAGGTCTCGG GCTATTCCTG TCAGACCAAG |
| 1021 | TTTACTCATA TATACTTTAG ATTGATTTAA AACTTCATTT TTAATTTAAA AGGATCTAGG |
| 1081 | TGAAGATCCT TTTTGATAAT CTCATGACCA AAATCCCTTA ACGTGAGTTT TCGTTCCACT |
| 1141 | GAGCGTCAGA CCCCGTAGAA AAGATCAAAG GATCTTCTTG AGATCCTTTT TTTCTGCGCG |
| 1201 | TAATCTGCTG CTTGCAAACA AAAAAACCAC CGCTACCAGC GGTGGTTTGT TTGCCGGATC |
| 1261 | AAGAGCTACC AACTCTTTTT CCGAAGGTAA CTGGCTTCAG CAGAGCGCAG ATACCAAATA |
| 1321 | CTGTTCTTCT AGTGTAGCCG TAGTTAGGCC ACCACTTCAA GAACTCTGTA GCACCGCCTA |
| 1381 | CATACCTCGC TCTGCTAATC CTGTTACCAG TGGCTGCTGC CAGTGGCGAT AAGTCGTGTC |
| 1441 | TTACCGGGTT GGACTCAAGA CGATAGTTAC CGGATAAGGC GCAGCGGTCG GGCTGAACGG |
| 1501 | GGGGTTCGTG CATACAGCCC AGCTTGGAGC GAACGACCTA CACCGAACTG AGATACCTAC |
| 1561 | AGCGTGAGCT ATGAGAAAGC GCCACGCTTC CCGAAGGGAG AAAGGCGGAC AGGTATCCGG |
| 1621 | TAAGCGGCAG GGTCGGAACA GGAGAGCGCA CGAGGGAGCT TCCAGGGGGA AACGCCTGGT |
| 1681 | ATCTTTATAG TCCTGTCGGG TTTCGCCACC TCTGACTTGA GCGTCGATTT TTGTGATGCT |
| 1741 | CGTCAGGGGG GCGGAGCCTA TGGAAAAACG CCAGCAACGC GGCCTTTTTA CGGTTCCTGG |
| 1801 | CCTTTTGCTG GCCTTTTGCT CACATGTTCT TTCCTGCGTT ATCCCCTGAT TCTGTGGATA |
| 1861 | ACCGTATTAC CGCCTTTGAG TGAGCTGATA CCGCTCGCCG CAGCCGAACG ACCGAGCGCA |
| 1921 | GCGAGTCAGT GAGCGAGGAA GCGGAAGAGC GCCCAATACG CAAACCGCCT CTCCCCGCGC |
| 1981 | GTTGGCCGAT TCATTAATGC AGCTGGCACG ACAGGTTTCC CGACTGGAAA GCGGGCAGTG |
| 2041 | AGCGCAACGC AATTAATGTG AGTTAGCTCA CTCATTAGGC ACCCCAGGCT TTACACTTTA |
| 2101 | TGCTTCCGGC TCGTATGTTG TGTGGAATTG TGAGCGGATA ACAATTTCAC ACAGGAAACA |
| 2161 | GCTATGACCA TGATTACGCC AAGCTTTGGA GCCTTTTTTT TGGAGATTTT CAACATGAAG |
| 2221 | AAGCTCCTCT TTGCTATCCC GCTCGTCGTT CCTTTTGTGG CCCAGCCGGC CATGGCCGAC |
| 2281 | ATCCAGATGA CCCAGTCTCC ATCCTCCCTG TCTGCATCTG TAGGAGACAG AGTCACCATC |
| 2341 | ACTTGCCGGG CAAGTCAGAG CATTAGCAGC TATTTAAATT GGTATCAGCA GAAACCAGGG |
| 2401 | AAAGCCCCTA AGCTCCTGAT CTATGCTGCA TCCAGTTTGC AAAGTGGGGT CCCATCAAGG |
| 2461 | TTCAGTGGCA GTGGATCTGG GACAGATTTC ACTCTCACCA TCAGCAGTCT GCAACCTGAA |
| 2521 | GATTTTGCAA CTTACTACTG TCAACAGAGT TACAGTACCC CTTTCACTTT CGGCCCTGGG |
| 2581 | ACCAAAGTGG ATATCAAACG TGGtACcGTG GCTGCACCAT CTGTCTTCAT CTTCCCGCCA |
| 2641 | TCTGATGAGC AGTTGAAATC TGGAACTGCC TCTGTTGTGT GCCTGCTGAA TAACTTCTAT |
| 2701 | CCCAGAGAGG CCAAAGTACA GTGGAAGGTG GATAACGCCC TCCAATCGGG TAACTCCCAG |
| 2761 | GAGAGTGTCA CAGAGCAGGA CAGCAAGGAC AGCACCTACA GCCTCAGCAG CACCCTGACG |
| 2821 | CTGAGCAAAG CAGACTACGA GAAACACAAA GTCTACGCCT GCGAAGTCAC CCATCAGGGC |
| 2881 | CTGAGTTCAC CGGTGACAAA GAGCTTCAAC AGGGGAGAGT GTGCGGCCGC TGGTAAGCCT |
| 2941 | ATCCCTAACC CTCTCCTCGG TCTCGATTCT ACGTGATAAC TTCACCGGTC AACGCGTGAT |
| 3001 | GAGAATTCAC TGGCCGTCGT TTTACAACGT CGTGACTGGG AAAACCCTGG CGTTACCCAA |
| 3061 | CTTAATCGCC TTGCAGCACA TCCCCCTTTC GCCAGCTGGC GTAATAGCGA AGAGGCCCGC |
| 3121 | ACCGATCGCC CTTCCCAACA GTTGCGCAGC CTGAATGGCG AATGGCGCCT GATGCGGTAT |
| 3181 | TTTCTCCTTA CGCATCTGTG CGGTATTTCA CACCGCATAC GTCAAAGCAA CCATAGTCTC |
| 3241 | AGTACAATCT GCTCTGATGC CGCATAGTTA AGCCAGCCCC GACACCCGCC AACACCCGCT |
| 3301 | GACGCGCCCT GACAGGCTTG TCTGCTCCCG GCATCCGCTT ACAGACAAGC TGTGACCGTC |
| 3361 | TCCGGGAGCT GCATGTGTCA GAGGTTTTCA CCGTCATCAC CGAAACGCGC GA |

### Example 4

### Dobbling of CDRs

The following examples exemplify the use of dobbling in constructing synthetic libraries. The parental 3-23 heavy chain (HC) is diversified in CDR1, 2, and 3. This diversity is combined with a synthetically diversified A27 light chain (LC). The diversity will be as follows:

### Example 4.1

### HC CDR1

The following dobbling diversity allows 5,832 variants. See Table 50. At position 31, Ser is the germline (GL) amino-acid type. Hence we make Ser, for example, three times more likely then the other types. Since 18 types are allowed, Ser will be allowed 15% of the time and all the others are allowed at 5%. Thus, if there is no selection for the AA type at 31, we are more likely to isolate an Ab with Ser. Similarly, at 33 the GL AA type is Ala and we make Ala, for example, 3 times as likely (15%) as all the others (5%). At 35 Ser is the GL AA type and we make it, for example, three times as likely as the others. At all three positions, we have excluded Cys and Met. We exclude Cys because we do not want gratuitous disulfides or exposed unpaired cysteines that could adversely affect the solubility and reactivity of the Ab. We exclude Met because exposed methionines side groups are subject to oxidation which can alter binding properties and shelf life. We could make the germline amino-acid type 2, 3, 4, 5, 6, 7, 8, 9, or times more likely than the other AA types. Accordingly, the GL AAT would constitute 2/19, 3/20, 4/21, 5/22, 6/23, 7/24, 8/25 9/26, or 10/27 of the allowed AATs.

Table 54 shows a diversity for HC CDR1 that does not allow N at position 53. Ser is the GL AAT at 55 and allowing N at 53 would make N—X—(S/T) too high at positions 53-55. The N at 51 is retained because A is the GL AAT at 53 and the probability of N—X—(S/T) at 51-53 will be low.

TABLE 50
Diversity for CDR1 in 3-23 (Diversity = 5832)

| Position | Parental AA | Allowed |
|---|---|---|
| 31 | S (for example, three- | ADEFGHIKINPQRSTVWY |
| | times more likely as | (no C or M) |
| | the others) | |
| 33 | A (e.g. 3-X more | ADEFGHIKLNPQRSTVWY |
| | likely) | (no C or M) |
| 35 | S (e.g. 3-X more | ADEFGHIKINPQRSTVWY |
| | likely) | (no C or M) |

TABLE 54
Diversity for CDR1 in 3-23 (Diversity = 5508)

| Position | Parental AA | Allowed |
|---|---|---|
| 31 | S (for example, four- | SADEFGHIKLNPQRTVWY |
| | times more likely as | (no C or M) |
| | the others) | |
| 33 | A (e.g. 4-X more | ADEFGHIKLPQRSTVWY |
| | likely) | (no C, N, or M) |
| 35 | S (e.g. 4-X more | SADEFGHIKLNPQRTVWY |
| | likely) | (no C or M) |

Throughout this disclosure, the shown “Allowed” amino acids are the amino acids that can be used at a given position. For example, in Table 50, at position 31, allowed amino acids “ADEFGHIKLNPQRSTVWY” are shown. This indicates that amino acids A, D, E, F, G, H, I, K, L, N, P, Q, R, S, T, V, W, and Y are all allowed at position 31.

### Example 4.2

### HC CDR2

In CDR2, we allow (as shown in Table 51) diversity at positions 50, 52, 52a, 56, and 58. At 50, 52, 56, and 58 we allow all amino-acid types except Cys and Met and we make the GL AA types more likely by three fold. We could make the GL AA type 2, 3, 4, 5, 6, 7, 8, 9, or 10 times more likely than the other AA types.

Table 55 shown a modified diversity which avoids a high frequency of N—X—(S/T) at positions 50-52. Use of Table 54 and 51Alt gives a diversity in HC CDR1/CDR2 of 2.184E9. At 52, 56, and 58 we allow all amino-acid types except Cys and Met. At position 50, we allow all AATs except C, M, and N. We make the GL AA types more likely by, for example, three fold. We could make the GL AA type 2, 3, 4, 5, 6, 7, 8, 9, or 10 times more likely than the other AA types.

TABLE 51
HC CDR2: Diversity = 419,904

| Position | Parental AA | Allowed |
|---|---|---|
| 50 | A (e.g. 3-X more | ADEFGHIKLNPQRSTVWY |
| | likely) | |
| 52 | S (e.g. 3-X more | ADEFGHIKLNPQRSTVWY |
| | likely) | |
| 52a | G (e.g. 3-X more | GPSY |
| | likely) | |
| 56 | S (e.g. 3-X more | ADEFGHIKLNPQRSTVWY |
| | likely) | |
| 58 | Y (e.g. 3-X more | ADEFGHIKLNPQRSTVWY |
| | likely) | |

TABLE 55
HC CDR2: Diversity = 396,576

| Position | Parental AA | Allowed |
|---|---|---|
| 50 | A (e.g. 3-X more | ADEFGHIKLPQRSTVWY |
| | likely) | (No C, M, or N) |
| 52 | S (e.g. 3-X more | ADEFGHIKLNPQRSTVWY |
| | likely) | |
| 52a | G (e.g. 3-X more | GPSY |
| | likely) | |
| 56 | S (e.g. 3-X more | ADEFGHIKLNPQRSTVWY |
| | likely) | |
| 58 | Y (e.g. 3-X more | ADEFGHIKLNPQRSTVWY |
| | likely) | |

Combined CDR1 and CDR2 diversity shown in Table 50 and Table 51 is 2.45E9

### Example 4.3

An alternative preferred form of variegation for HC CDR1 and CDR2 is shown in Table 190. These variegations are based in part on examination of antibodies from a variety of sources. In version 1 of this variegation, CDR1 is allowed 1944 sequences. In this embodiment, position 31 is allowed to be only DGASNR. At positions 33 and 35, we allow all AATs except Cys and Met. Cys is excluded to prevent unwanted extraneous disulfide or exposed unpaired cysteins (both are undesirable). Met is excluded to prevent methonine from being selected. Having Met in the combining site would make the Ab prone to poor shelf life. Oxidation of a Met in the combining site is very likely to change the binding properties of the Ab. Positions 31, 33, and 35 are picked for variegation because the side groups of thes act cc ons point toward the antibody combining site. A methionine in such a position is likely to greatly alter the binding properties if it is oxidized. In version 2 of the variegation of Table 190, position 31 is allowed to be any AAT except Cys or Met. The diversity is 5,822.

The pattern for variegation of CDR2 is the same for version 1 and 2. Each allows 1.49E6 amino-acid sequences in CDR2. At p©tion 50, we allow YRWVGSEA so that either a positive (R) or negative (E) charge can be selected. At 52, we allow all AATs except Cys and Met. At 52a, we allow both small and bulky side groups. At 53, we allow DGASNR so that positive and negative side groups plus hydrogen-boning side groups are allowed. At 55, we allow G or S. At 56, we allow any AAT except Cys and Met. At 58, we allow YRWVGSEA. The combined diversities are 2.9E9 and 8.7E9. Because none of the substitutions are thought to be able to ruin the antibody, undersampling is allowed. A sampling of 5.E8 would give a very useful diversity in CDR1-2. A sampling of 2.E9 would be preferred. A sampling of 5.E9 would more preferred.

In version 3, we allow Gly and Phe at position 54. This allows the Ab to resemble 1-69 in CDR2; 1-69 is often selected as a binder to viral targets. In addition, we have added Ile to the allowed AATs at position 53. In version 3, we have removed N from positions 33, 52, 53, and 56. Q is allowed at 53. The CDR1 diversity in version 3 is 1890. The CDR2 diversity is 5.97E+06. The combined diversity is 1.13E+10. A library of 1.E6, 3.E6, 1.E7, 3.E7, 1.E8 or 3.E8 would be adequate.

In versions 1, 2, and 3, the first AAT in the list of allowed AATs is the germ line AAT. This may be may more frequent than all the others by 2-, 3-, 4-, 5-, 6-, 7-, 8-, 9-, or 10-fold.

Because of the unique BstXI restriction site in FR2, we can recombine CDR1 with CDR2.

TABLE 190
Diversity in HC CDR1 and CDR2
The amino acid sequences disclosed in Table 190 are SEQ ID NOS 1261-1262.
The DNA sequence shown in Table 190 is SEQ ID NO: 1260.

```
              F V A Q P A S A
            ttc gtG GCC cag ccG GCC tct gct
                        SfiI.............
                                                                    FR1(DP47/V3-23)---------------
                                                                      1 2 3 4 5 6 7 8
                                                                      E V Q L L E S G
                                                                    gaa|gtt|CAA|TTG|tta|gag|tct|ggt|
                                                                                    MfeI...
            --------------FR1--------------------------------------------
                9 10 11 12 13 14 15 16 17 18 19 20 21 22 23
                G G L V Q P G G S L R L S C A
            |ggc|ggt|ctt|gtt|cag|cct|ggt|ggt|tct|tta|cgt|ctt|tct|tgc|gct|
            ----FR1-------------------->|...CDR1------------|---FR2------
              24 25 26 27 28 29 30 31 32 33 34 35 36 37 38
                A S G F T F S S Y A M S W V R
            |gct|TCC|GGA|ttc|act|ttc|tct|<1>|TAC|<2>|atg|<3>|tgg|gtt|cgC|
                      BspEI.. BstXI...
          -------FR2-------------------------------->|...CDR2............
        a9 40 41 42 43 44 45 46 47 48 49 50 51 52 52a
          Q A P G K G L E W V S A I S G
      1-69 G I I P
      |CAa|gct|ccT|GGt|aaa|ggt|ttg|gag|tgg|gtt|tct|<4>|atc|<5>|<6>|
...BstXI..........
          .....CDR2............................................|---FR3---
              53 54 55 56 57 58 59 60 61 62 63 64 65 66 67
                S G G S T Y Y A D S V K G R F
  1-69 I F G T A N Y A Q K F Q G
            |<7>|<B>|<8>|<9>|act|<A>|tat|gct|gac|tcc|gtt|aaa|ggt|cgc|ttc|
            --------FR3--------------------------------------------------
              68 69 70 71 72 73 74 75 76 77 78 79 80 81 82
                T I S R D N S K N T L Y L Q M
            |act|atc|TCT|AGA|gac|aac|tct|aag|aat|act|ctc|tac|ttg|cag|atg|
                            | XbaI |
```

| Version 1 | Version 2 | Version 3 |
|---|---|---|
| <1> = SADGNR | SADEFGHIKLNPQRTVWY | SADGNRY |
| <2> = ADEFGHIKLNPQRSTVWY | ADEFGHIKLNPQRSTVWY | ASDFGHIKLPRTVWY |
| <3> = SADEFGHIKLNPQRTVWY | SADEFGHIKLNPQRTVWY | SADEFGHIKLNPQRTVWY |
| <4> = AYRWVGSE | AYRWVGSE | AYRWVGSE |
| <5> = SADEFGHIKLNPQRTVWY | SADEFGHIKLNPQRTVWY | SADEFGHIKLPQRTVWY |
| <6> = GYWSPA | GYWSPA | GYWSPADRY |
| <7> = SDGANR | SDGANR | SDGAQRI |
| <8> = GS | GS | GS |
| <9> = SADEFGHIKLNPQRTVWY | SADEFGHIKLNPQRTVWY | SADEFGHIKLPQRTVWY |
| <A> = YRWVGSEA | YRWVGSEA | YRWVGSEA |
| <B> = G | G | GF |

### Example 4.4

### HC CDR3, Lengths 3, 4, 5

Very short CDR3 can be made by dobbling. Table 7 shows several parental sequences for CDR3 length 3. At 94 many VH3s have Arg and we have allowed this change, but Lys is made 3-X as likely. At 95, F is found at this position in JH1. We also allow Ser, Tyr, Asp, and Arg to allow small, large, plus charge, and minus charge. At 96, JH1 has Q. Since Q is very similar to Glu, we allow Glu as an acidic alternative plus Arg, Ser, Tyr, and Leu. At 97, His is the ger©ne AA from JH1. We allow minus charge (D), plus charge (R), small polar (S), large hydrophobic (Y), and aliphatic (L). The parental sequence makes up 4.5% of the library, but this is combined with a large diversity in CDR1 and CDR2. The dobbling allows 360 sequences in all. The least likely sequences occur at 1 in 1792. The most likely (parental) sequence occurs about 1 in 22. It is also within the scope of the invention to maintain K₉₄ as Lys, which is germline for 3-23.

TABLE 60
A dobbled HC CDR3 of length 3 (V-3JH1 of Table 7)
(Biblioteca 54)

| | Parental amino acid | |
|---|---|---|
| | (source) (“KFQH” | |
| | disclosed as | |
| Position | SEQ ID NO: 951) | Allowed |
| 94 | K (VH 3-23) | KR (3:1) |
| 95 | F (JH1) | FSYDR (3:1:1:1:1) |
| 96 | Q (JH1) | QERSYL (3:1:1:1:1:1) |
| 97 | H (JH1) | HDRSYL (3:1:1:1:1:1) |
| 103 | W (JH1) | W |

Table 61 shows a dobbled HC CDR3 of length 3. Here K₉₄ is fixed as is W103. We have made the “parental” D segment amino acid five times as likely as the other allowed AA types.

TABLE 61
A dobbled HC CDR3 of length 3 from a D fragment
(V-3D1-1.1.2-JH1 of Table 7). (Biblioteca 55)

| | Parental (“KTTG” | |
|---|---|---|
| | disclosed as | |
| Position | SEQ ID NO: 952) | Allowed |
| 94 | K (V 3-23) | K |
| 95 | T (D1-1.1.2) | TYRDL (5:1:1:1:1) |
| 96 | T (D1-1.1.2) | TYRDL (5:1:1:1:1) |
| 97 | G (D1-1.1.2) | GSYRDL (5:1:1:1:1:1) |
| 103 | W (JH1) | W |

In this example (Table 62, using V-4JH2 from Table 8), 94 is fixed as Lys. At 95, JH2 has Tyr and we have allowed Ser, Asp, Arg, and Leu so that size, charge, and hydrophobicity can alter to suit the antigen. JH2 has Phe at 96 and we have allowed Ser, Tyr, Asp, Arg, and Leu. At 97, JH2 has Asp and we have allowed Arg, Ser, Tyr, and Leu. At 98, JH2 has Leu and we have allowed Ser, Tyr, Asp, and Arg. This pattern allows 750 distinct sequences, of which the parental is the most likely (1 in 18). The least likely sequences occur at 1 in 4608 or 256 times less likely than the most likely.

TABLE 62
HC CDR3 length 4 from JH2 (V-4JH2 in Table 7)
(Biblioteca 56)

| | Parental AA (source) | |
|---|---|---|
| | (“KYFDL” disclosed | |
| Position | as SEQ ID NO: 953) | Allowed |
| 94 | K (VH 3-23) | K |
| 95 | Y (JH2) | YSDRL (4:1:1:1:1) |
| 96 | F (JH2) | FSYDRL (4:1:1:1:1:1) |
| 97 | D (JH2) | DRSYL (4:1:1:1:1) |
| 98 | L (JH2) | LSYDR (4:1:1:1:1) |
| 103 | W (JH2) | W |

In Table 63, there is a dobbling of V-4D3-10.1a-JH2 from Table 8. At 94, we allow Lys and Arg with Lys (the parental) four times as likely as Arg. At 95, D3-10.1a (i.e., D3-10 in the first reading frame and starting a AA 1) has Leu; we allow SYDR as well with Leu 4-X as likely as each of the other AA types. At 96, D3-10.1a has Leu again and we allow the same menu. At 97, D3-10.1a has Tip and we allow Ser, Tyr, Asp, and Arg with Trp 4-X as likely. At 98, D3-10.1a has Phe and we allow Ser, Tyr, Asp, and Arg as well.

TABLE 63
HC CDR3 of length four from V-4D3-10.1a in Table
8 (Biblioteca 57)

| | Parental AA (source) | |
|---|---|---|
| | (“KLLWF” disclosed as | |
| Position | SEQ ID NO: 954) | Allowed |
| 94 | K (VH 3-23) | KR (4:1) |
| 95 | L (D3-10.1a) | LSYDR (4:1:1:1:1) |
| 96 | L (D3-10.1a) | LSYDR (4:1:1:1:1) |
| 97 | W (D3-10.1a) | WSYDR (4:1:1:1:1) |
| 98 | F (D3-10.1a) | FSYDR (4:1:1:1:1) |
| 103 | W | W |

### Example 4.5

### HC CDR3 Length 10 to 20

HC CDR3

Two sublibraries, both with CDR3 of length 16:

TABLE 52
Library 1: Diversity = 5 E 11, the “parental”
sequence occurs at 1 in 1.5 E6 (Biblioteca 58)

| | “Parental” AA (source) | |
|---|---|---|
| Position | (SEQ ID NO: 955) | Allowed |
| 94 | K (3-X more likely) | KR (3:1) |
| | (3-23) | |
| 95 | Y (3-X more likely) | YSRDL (3:1:1:1:1) |
| | (D2-21(2)) | |
| 96 | Y (3-X more likely) | YSRDL (3:1:1:1:1) |
| | (D2-21(2)) | |
| 97 | Y (3-X more likely) | YSRDL (3:1:1:1:1) |
| | (D2-21(2)) | |
| 98 | D (3-X more likely) | DYSRL (3:1:1:1:1) |
| | (D2-21(2)) | |
| 99 | S (3-X more likely) | SYRDL (3:1:1:1:1) |
| | (D2-21(2)) | |
| 100 | S (3-X more likely) | SYRDL (3:1:1:1:1) |
| | (D2-21(2)) | |
| 101 | G (3-X more likely) | GASYRDL |
| | (D2-21(2)) | (3:1:1:1:1:1:1) |
| 102 | Y (3-X more likely) | YSRDL (3:1:1:1:1) |
| | (D2-21(2)) | |
| 102a | Y (3-X more likely) | YSRDL (3:1:1:1:1) |
| | (D2-21(2)) | |
| 102b | Y (3-X more likely) | YSRDL (3:1:1:1:1) |
| | (D2-21(2)) | |
| 102c | A (3-X more likely) | ASYRD (3:1:1:1:1) |
| | (JH1) | |
| 102d | E (3-X more likely) | ERSYL (3:1:1:1:1) |
| | (JH1) | |
| 102e | Y (3-X more likely) | YSRDL (3:1:1:1:1) |
| | (JH1) | |
| 102f | F (3-X more likely) | FYSRD (3:1:1:1:1) |
| | (JH1) | |
| 102g | Q (3-X more likely) | QERSY (3:1:1:1:1) |
| | (JH1) | |
| 102h | H (3-X more likely) | HERSYL (3:1:1:1:1:1) |
| | (JH1) | |
| 103 | W (JH1, fixed) | W |

TABLE 53
Library 2: CDR3 length 16; Diversity is 3.0 E 10
and the parental sequence occurs once in 3.7 E 5.
(Biblioteca 59)

| | “Parental” AA (source) | |
|---|---|---|
| Position | (SEQ ID NO: 956) | Allowed |
| 94 | K (3-X more likely) | KR (3:1) |
| | (3-23) | |
| 95 | G (3-X more likely) | GSYDRL (3:1:1:1:1:1) |
| | (D2-2(2)) | |
| 96 | Y (3-X more likely) | YSDRL (3:1:1:1:1) |
| | (D2-2(2)) | |
| 97 | C (fixed) (D2-2(2)) | C |
| 98 | S (3-X more likely) | SYRDL (3:1:1:1:1) |
| | (D2-2(2)) | |
| 99 | S (3-X more likely) | SYRDL (3:1:1:1:1) |
| | (D2-2(2)) | |
| 100 | T (3-X more likely) | TYRDL (3:1:1:1:1) |
| | (D2-2(2)) | |
| 101 | S (3-X more likely) | SYRDL (3:1:1:1:1) |
| | (D2-2(2)) | |
| 102 | C (fixed) (D2-2(2)) | C |
| 102a | Y (3-X more likely) | YSDRL (3:1:1:1:1) |
| | (D2-2(2)) | |
| 102b | T (3-X more likely) | TYRDL (3:1:1:1:1) |
| | (D2-2(2)) | |
| 102c | A (3-X more likely) | ASYDRL (3:1:1:1:1:1) |
| | (JH1) | |
| 102d | E (3-X more likely) | ERSYL (3:1:1:1:1) |
| | (JH1) | |
| 102e | Y (3-X more likely) | YSDRL (3:1:1:1:1) |
| | (JH1) | |
| 102f | F (3-X more likely) | FYSRDL (3:1:1:1:1:1) |
| | (JH1) | |
| 102g | Q (3-X more likely) | QERSYL (3:1:1:1:1:1) |
| | (JH1) | |
| 102h | H (3-X more likely) | HDRSYL (3:1:1:1:1:1) |
| | (JH1) | |
| 103 | W (JH1)) | W |

Table 65 shows a dobbling variegation of SEQ ID NO:898. The total diversity allowed is 2.1E13. A synthesis that produces 1.E8, 3.E8, 5.E8, 1.E9, or 5.E9 will sample the diversity adequately. The design of SEQ ID NO:898 was discussed above. In dobbling SEQ ID NO:898, is to allow the parental AA type at three-fold above other AA types at most positions. At positions where the parental is Tyr, then we use Tyr and Ser at equal amounts with Leu at one half that frequency. The Cys residues are fixed. Each parental AA type is allowed to go to one of Arg, Asp, Ser, Tyr, or Leu (Leu might be omitted if the parental is hydrophobic, such as Phe). The parental sequence will occur once in 1.E8 members. The least likely sequences will occur once in 9.5E16. It is not important that the library actually contain the parental sequence, only that it contains many sequences that resemble the parent. Thus, a library that contains 1.E7, 5.E7, 1.E8, 3.E8, 1.E9, or 5.E9, when combined with diversity in HC CDR1, HC CDR2, LC CDR1, LC CDR2, and LC CDR3 will provide a library that will contain many valuable Abs.

TABLE 65
Dobbling of Design 1 with SEQ ID NO: 898 as
parent (Biblioteca 60)

| | Parental (source) | |
|---|---|---|
| Position | SEQ ID NO: 957) | Allowed |
| 94 | K (VH 3-23) | K |
| 95 | D (No source) | DSYL (3:1:1:1) |
| 96 | Y (No source) | YSL (2:2:1) |
| 97 | G (D2-2.2) | GSYDRL (3:1:1:1:1:1) |
| 98 | Y (D2-2.2) | YSL (2:2:1) |
| 99 | C (D2-2.2) | C |
| 100 | S (D2-2.2) | SYDRL (3:1:1:1:1) |
| 101 | S (D2-2.2) | SYDRL (3:1:1:1:1) |
| 102 | T (D2-2.2) | TYDRL (3:1:1:1:1) |
| 102a | S (D2-2.2) | SYDRL (3:1:1:1:1) |
| 102b | C (D2-2.2) | C |
| 102c | Y (D2-2.2) | YSL (2:2:1) |
| 102d | T (D2-2.2) | TYDRL (3:1:1:1:1) |
| 102e | Y (No source) | YDSL (3:1:1:1) |
| 102f | G (No source) | GSYRD (3:1:1:1:1) |
| 102g | Y (No source) | YSL (2:2:1) |
| 102h | S (No source) | SYDRL (3:1:1:1) |
| 102i | Y (No source) | YSL (2:2:1) |
| 102j | A (JH1) | ASYDR (3:1:1:1:1) |
| 102k | E (JH1) | ERSYL (3:1:1:1:1) |
| 102l | Y (JH1) | YSL (2:2:1) |
| 102m | F (JH1) | FSYDR (3:1:1:1:1) |
| 102n | Q (JH1) | QYSDRL (3:1:1:1:1:1) |
| 102p | H (JH1) | HSYDRL (3:1:1:1:1:1) |
| 103 | W (JH1, FR4) | W |

### Example 4.6

### Dobbling of yycakGSGYCSGGSCYSFDYwgqgtivtvss (SEQ ID NO:931) (Biblioteca 61)

Table 80 shows the dobbling of SEQ ID NO:931, an example of an HC CDR3 of length 15. Position 94 is part of FR3 and is held constant. Positions 95 and 96 have “parental” amino-acid types picked from the highly used set of (YGDRS) and are G95 and S96. The next ten positions are taken from D2-15.2 (a moderately highly used D segment containing a disulfide-closed loop). The final three positions are from the JH4 positions 100, 101, and 102 as shown in Table 3. At each position, we make the parental amino-acid type three times more likely than the other allowed types. The Cys residues are fixed. At 102e, Phe is three times more likely as are YGSRD (i.e., Phe is three times more likely as are any of amino acids Y, G, S, R, or D). The diversity allowed is 1.46E9. The parental sequence is expected at 1 in 6.9E4. Each of the singly substituted sequences is about ⅓ as likely; the doubly substituted ones are 1/9 as likely and so on. The sequences that are composed entirely of other AA types occur at only 1 in 1.1E11.

Each of the other sequences in Table 21 can be dobbled in the same way.

TABLE 80
Dobbling of yycakGSGYCSGGSCYSFDYwgqgtivtvss
(SEQ ID NO: 931)

| | Parental (source) | |
|---|---|---|
| Position | (SEQ ID NO: 958) | Allowed |
| 94 | K (VH 3-23) | K |
| 95 | G (No source) | GYSRD (3:1:1:1:1) |
| 96 | S (No source) | SGYRD (3:1:1:1:1) |
| 97 | G (D2-15.2) | GYSRD (3:1:1:1:1) |
| 98 | Y (D2-15.2) | YGSRD (3:1:1:1:1) |
| 99 | C (D2-15.2) | C |
| 100 | S (D2-15.2) | SGYRD (3:1:1:1:1) |
| 101 | G (D2-15.2) | GYSRD (3:1:1:1:1) |
| 102 | G (D2-15.2) | GYSRD (3:1:1:1:1) |
| 102a | S (D2-15.2) | SGYRD (3:1:1:1:1) |
| 102b | C (D2-15.2) | C |
| 102c | Y (D2-15.2) | YGSRD (3:1:1:1:1) |
| 102d | S (D2-15.2) | SGYRD (3:1:1:1:1) |
| 102e | F (JH4) | FYGSRD (3:1:1:1:1:1) |
| 102f | D (JH4) | DGSRY (3:1:1:1:1) |
| 102g | Y (JH4) | YGSRD (3:1:1:1:1) |
| 103 | W (JH4, FR4) | W |

### Example 43

### Use of VH3-66 as a Framework

The methods of the present invention can be used in HCs other than 3-23. For example, VH 3-66 could be used. Table 3500 shows a gene that is compatible with the vectors of the present disclosure in that the portion of this gene from SfiI to NheI can be substituted for the SfiI-NheI portion of any of the other examples of the present disclosure to produce a workable display or expression gene. The gene in Table 3500 has CDR1 surrounded by SfiI, MfeI, BsrGI, and BlpI on the 5′ side and XbaI and SalI on the 3′ side. CDR2 is bounded by XbaI and SalI on the 5′ side and XmaI, PstI, and ApaLI on the 3′ side. CDR3 is bounded by XmaI, PstI, and ApaLI on the 5′ side and BstEII, SacI, and NheI on the 3′ side.

Trastuzumab has a framework similar to 3-66. Fuh et al. (Science 2009, 323:1610-4) varied residues in the HC to optimize the dual binding of an antibody based on trastuzumab. The positions that were varied were 30-33 in CDR1, 50, 52-54, 56, and 58 in CDR2, and 95-100 in CDR3. We would introduce diversity into positions 30-33 in HC CDR1, 50, 52-54, 56, and 58 in HC CDR2, and in LC CDR1 and CDR3. Then any of the CDR3 designs of the present disclosure can be introduced into that background. Since the restriction sites are different, the primers will be different, but the designs are readily adapted by one skilled in the art.

TABLE 3500
3-66 display cassette
The amino acid sequence disclosed in Table 3500 is SEQ ID NO: 985.
The DNA sequence disclosed in Table 3500 is SEQ ID NO: 984.

```
3-66::JH2
            Signal for VH-CH1-IIIstump
            1 2 3 4 5 6 7 8 9 10 11 12 13 14 15
            M K Y L L P T A A A G L L L L
      1 atg aaa tac cta ttg cct acg gca gcc gct gga ttg tta tta ctc
            16 17 18 19 20 21 22
            A A Q P A M A
    46 gcG GCC cag ccG GCC atg gcc
              SfiI.............
                              NgoMI...(1/2)
                                            NcoI....
            FR1------------------------------------------------------
              1 2 3 4 5 6 7 8 9 10 11 12 13 14 15
              E V Q L V E S G G G L V Q P G
    67 |gag|gtt|CAA|TTG|gtc|gaa|tct|ggc|ggt|ggt|ctT|GTA|CAg|ccg|ggt|
                            MfeI... BsrGI...
            FR1------------------------------------------------------
            16 17 18 19 20 21 22 23 24 25 26 27 28 29 30
              G S L R L S C A A S G F T V S
  112 |ggt|tct|ctg|cgG|CTG|AGC|tgt|gct|gcc|tct|ggc|ttt|act|gtc|tcc|
                                        BlpI.....
            CDR1--------------- FR2-----------------------------------
            31 32 33 34 35 36 37 38 39 40 41 42 43 44 45
              S N Y M S W V R Q A P G K G L
  157 |tct|aat|tac|atg|tct|tgg|gtc|cgt|caa|gct|ccg|ggt|aag|ggT|CTA|
                                                                                                                        XbaI....
            FR2------- CDR2--------------------------------------------
            46 47 48 49 50 51 52 53 54 55 56 57 58 59 60
              E W V S V I Y S G G S T Y Y A
  202 |GAa|tgg|gtt|tcc|gtt|atc|tac|tct|ggt|ggG|TCG|ACt|tac|tat|gct|
..XbaI.. SalI....
          CDR2--------------- FR3------------------------------------
            61 62 63 64 65 66 67 68 69 70 71 72 73 74 75
              D S V K G R F T I S R D N S K
  247 |gat|tcc|gtt|aag|ggc|cgt|ttc|acG|ATA|TCC|CGG|Gac|aac|tct|aaa|
                                                                        EcoRV...
                                                                                      XmaI....
          FR3--------------------------------^{a}----------------------
            76 77 78 79 80 81 82 82a 82b 82c 83 84 85 86 87
              N T L Y L Q M N S L R A E D T
  292 |aat|act|ttg|tac|CTG|CAG|atg|aat|tct|tta|cgc|gct|gaa|gac|act|
                                            PstI...
            FR3----------------------- CDR3---------------------------
            88 89 90 91 92 93 94 95 96 97 98 99 100 101 102
              A V Y Y C A R G S G S G S Y W
  337 |gct|gtc|tac|tat|tGT|GCA|Cgt|ggt|tct|ggc|tct|ggc|tct|tat|tgg|
                                              ApaLI... VJ fill................. Jstump..
          CDR3-----^{a}----- FR4--------------------------------------
            102a b c d 103 104 112 113 114 115 116 117 118 119 120
              Y F D L W G R G T L V T V S S
  382 |tac|ttc|gat|tta|tgg|ggt|cgt|ggc|act|ttG|GTG|ACC|gtG|AGC|TCt|
            Jstump of JH2... BstEII... SacI...
CH1
            A S T K G P S V F P L A P S S
  427 gcc tcc acc aag ggc cca tcg gtc ttc ccG CTA GCa ccc tcc tcc...
                                                                                      NheI....
```

### Example 44

### Diversifying Trastuzumab

Table 3508 shows a gene fragment that can be used to display the HC of trastuzumab on phage. Using any of the vectors of the present disclosure, replacement of the segment from SfiI to NheI will produce a vector that expresses or expresses and displays HC of trastuzumab. One could use the LC of trastuzumab or a library of LCs, e.g. a library of diversified A27 LCs. In Table 3508, an asterisk above a residue indicates that Fuh et al. (Science 2009, 323:1610-4) varied that position in fine tuning the binding of an antibody based on trastuzumab that binds both HER2 but also to VEGF. Note that trastuzumab uses JH4 with a Jstump of 2 amino acids.

Diversity can be introduced into HC CDR1 and CDR2 at the starred positions. In addition, any of the designs for CDR3 diversity of the present disclosure can be readily adapted to allow similar display in the framework of trastuzumab.

TABLE 3508
Herceptin display
The amino acid sequence disclosed in Table 3508 is SEQ ID NO: 987.
The DNA sequence disclosed in Table 3508 is SEQ ID NO: 986.

| | |
|---|---|
| | 1 2 3 4 5 6 7 8 9 10 11 12 13 14 15 |
| | M K Y L L P T A A A G L L L L |
| 1 | \|atg\|aaa\|tac\|cta\|ttg\|cct\|acg\|gca\|gcc\|gct\|gga\|ttg\|tta\|tta\|ctc\| |
| | FR1--------------------------- |
| | 16 17 18 19 20 21 22 1 2 3 4 5 6 7 8 |
| | A A Q P A M A E V Q L V E S G |
| 46 | \|gcG\|GCC\|cag\|ccG\|GCC\|ATG\|Gcc\|gag\|gtt\|CAA\|TTG\|gtc\|gaa\|tct\|ggc\| |
| | SfiI............. MfeI... |
| | NcoI.... |
| | FR1------------------------------------------------------- |
| | 9 10 11 12 12 14 15 16 17 18 19 20 21 22 23 |
| | G G L V Q P G G S L R L S C A |
| 91 | \|ggt\|ggt\|ctT\|GTA\|CAg\|ccg\|ggt\|ggt\|tct\|ctg\|cgG\|CTG\|AGC\|tgt\|gct\| |
| | BsrGI... BlpI..... |
| | * * * * |
| | FR1-------------------- CDR1------------------- FR2-------- |
| | 24 25 26 27 28 29 30 31 32 33 34 35 36 37 38 |
| | A S G F N I K D T Y I H W V R |
| 136 | \|gct\|TCC\|GGA\|ttt\|aat\|atc\|aaa\|gat\|act\|tac\|atc\|cat\|tgg\|gtt\|cgt\| |
| | BspEI.. |
| | * * |
| | FR2--------------------------------------- CDR2---------- |
| ^{a} | 39 40 41 42 43 44 45 46 47 48 49 50 51 52 52a |
| | Q A P G K G L E W V A R I Y P |
| 181 | \|caa\|gcC\|CCG\|GGt\|aag\|ggT\|CTA\|GAa\|tgg\|gtc\|gct\|cgt\|att\|tat\|ccg\| |
| | XmaI.... XbaI.... |
| | * * * * |
| | CDR2---------------------------------------------- FR3---- |
| | 53 54 55 56 57 58 59 60 61 62 63 64 65 66 67 |
| | T N G Y T R Y A D S V K G R F |
| 226 | \|act\|aat\|ggt\|tat\|act\|cgt\|tat\|gct\|gac\|tcc\|gtt\|aaa\|ggt\|cgt\|ttc\| |
| | FR3-------------------------------------------------------- |
| | 68 69 70 71 72 73 74 75 76 77 78 79 80 81 82 |
| | T I S A D T S K N T A Y L Q M |
| 271 | \|act\|atc\|tCT\|GCA\|Gac\|acT\|TCG\|AAa\|aat\|act\|gcc\|tat\|ttg\|cag\|atg\| |
| | PstI.... BstBI... |
| | FR3------^{o}------------------------------------------------- |
| | 82a 82b 82c 83 84 85 86 87 88 89 90 91 92 93 94 |
| | N S L R A E D T A V Y Y C S R |
| 316 | \|aac\|tct\|ttg\|cgt\|gct\|gag\|gac\|act\|gct\|gtt\|tac\|tat\|tgC\|TCG\|AGa\| |
| | XhoI.... |
| | * * * * * * |
| | CDR3-------------------------------------^{a}- FR4------------ |
| | 95 96 97 98 99 100 101 102 102a b c 103 104 105 106 |
| | W G G D G F Y A M D Y W G Q G |
| 361 | \|tgg\|ggt\|ggt\|gat\|ggc\|ttt\|tac\|gct\|atg\|gac\|tat\|tgg\|ggc\|caa\|ggt\| |
| | Jstump. JH4............ |
| | FR4------------------------ CH1---------------------------- |
| | 107 108 109 110 111 112 113 114 115 116 117 118 119 120 121 |
| | T L V T V S S A S T K G P S V |
| 406 | \|act\|ttG\|GTC\|ACC\|gtG\|AGC\|TCt\|gct\|tcc\|act\|aaa\|ggt\|ccg\|tct\|gtc\| |
| | BstEII... SacI.... |
| | CH1------------------------ |
| | 122 123 124 125 126 127 128 |
| | F P L A P S S |
| 451 | \|ttc\|ccG\|CTA\|GCc\|ccg\|tct\|tcc\| |
| | NheI.... |

### Example 5

### Synthetic Light Chain Diversity

To make whole antibodies, we need to combine a library of heavy chains with a library of light chains (LC). In natural Abs, it is often observed that HC does most of the binding and many libraries have given little attention to the LC or have obtained LC diversity from human donors. To have enough diversity to give good binders to almost any target, we have designed a diversification program that exceeds what the human immune system usually provides. Nevertheless, the program is designed to yield fully functional LC that have the same kind of changes as seen in natural Abs, only a few more. Vkappa III A27 was picked as the LC.

From a library that comprises donated kappa and lambda LCs, a collection of 1266 Abs were typed. Among VKIIIs, A27 is most often seen (Table 66) and pairs well with HC3-23.

The CDRs of A27 contain 12, 7, and 9 amino acids. In a collection of 1476 A27 LCs, 1291 have CDR1 of length 12 and 181 have length 11 (Table 3005). In the same sample, 1439 have CDR2 of length 7 and 37 have length 8. In CDR3 the frequent lengths are 8(179), 9(835), 10(312), and 11(88). Putting diversity at all of these positions might not work well: a) there might be many unstable or non-functional members, and b) diversity at some positions might not help improve binding. We have reduced the number of variable positions from 28 to 16. We allow a deletion of one amino acid in CDR1. We allow CDR3s of length 8, 9, and 10.

We have studied the 3D structure of 1QLR which has an A27 LC. The 1GLR structure is publicly available in the RCDB Protein Data Base. From this, the residues marked in Table 68 look useful to vary. The T56 is about 10 Å from a His in HC CDR3. Variation at 56 may be useful. G24 is only about 7 Å from an atom in HC CDR3. Germline is R24; thus, variation at 24 may be useful.

Table 69 shows a display cassette that we designed for use in pMID21. Thus, the restriction enzymes picked do not have other sites in pMID21. SpeI is in the iii signal sequence and AscI just after the stop codon allow the entire LC to be inserted or removed. XmaI, PpuMI, EcoO109I, and BlpI precede CDR1. SacII is in FR2, separating CDR1 from CDR2. Alternatively, an AvrII site could be inserted at the same position. BspEI and XhoI sites are in FR3 and a KpnI site is in FR4.

We gathered 1439 A27 sequences and analyzed what happens in the CDRs. Table 70, Table 3002 (CDR1), Table 3003 (CDR2), and Table 3004 (CDR3) show the analysis. In Table 70, we show what is found in the Abs from our library and what we would put at each position. In particular, Table 70 shows for each position the number of amino acids of each type other than the germline AAT. The full summary is in Tables 3001-3003. The positions fall into three categories: those that are fixed as the germline amino-acid type (AAT), those that are varied from a germline parent, and one that is an insertion. Where variation of a germline AAT, we encode the germline AAT 55% of the time, there are five AATs that are allowed 7% of the time, and a further 5 AATs that are allowed 2% each. In some cases, AATs that occur at fairly high frequency are omitted. No Met or Cys residues are allowed. Asn is excluded if the following germline AAT is Gly. By picking the germline plus the ten most often-seen mutations (rather than all 19 possible mutants) we reduce the number of sequences by approximately 14.285-fold.

Table 770 shows a pattern of variegation in A27 CDR1 and CDR3. This pattern allows 13 versions of CDR1 and 23 versions of CDR3. When these are crossed, the total variability is 299.

TABLE 68
where to vary A27

| | |
|---|---|
| | 22 3 3 5 5 89 9 |
| | 45 0a 4 0 5 90 5 |
| 1QLR | GASQSVS_NYLA DASSRAT QQYGSSPLT |
| A27 | RASQSVSSSYLA GASSR ** **** * * * * ****** |
| | + + + |

GASQSVS is (SEQID NO: 922) DASSRAT is (SEQID NO: 923) QQYGSSPLY is (SEQID NO: 924) QQYGSSPLT is (SEQ ID NO: 966) RASQSVSSSYLA is (SEQ ID NO: 925) GASSRAT is (SEQ ID NO: 926) NYLA is (SEQ ID NO: 959)

Table 68 shows where the CDRs of A27 would be variegated.

CDR1

R24, A25, and S26 are too far from the combining site to help and were held constant. The side group of V29 is buried; this position was held constant as Val. At the other positions, we allowed Y or S and a charge flip-flop (RE or RD, depending on where the sample had more of E or D at the position in question) plus other types that were frequently seen. We used an Excel spread sheet to determine that this pattern of variegation would give the parental sequence at 0.8% if the “other” AAs were substituted at 5%, at 0.1% if the “other” AAs were substituted at 6.5%, and at 0.02% if “other” was at 9%. In the sample of 155, 17 have one AA deleted (including 1QLR); thus, we will arrange to have S30a deleted in ˜8% of the members.

CDR2

From inspection of 1 QLR, we see that CDR2 is somewhat remote from the combining site. There have even been suggestions that we keep the residues in this CDR constant. Studying the 3D structure suggests that variegation at G50, S53, and T56 could be useful. S53 is the most variable in the sample of 155, but this does not prove that these changes are useful. In 1QLR, G50 has been mutated to R50. The side group of T56 is pointed toward HC CDR3 and is about 11 Å from an atom in HC CDR3.

CDR3

Q89 and Q90 are buried and nature does not vary them often; these residues are not varied. Y91 is packed against HC CDR3 and changes here would alter the combining site and do occur. At G92, φ=−80 and ψ=−15 so putting in a non-Gly is feasible; nature does it in 47/155 cases. S93 is very often varied or deleted. We allow deletion of S93 in 10% of the members. S94 is highly exposed and is highly varied. P95 is exposed and varied. An insertion of one amino acid after P95 is allowed in 30% of the members. L96 packs against HC CDR3: changes here will affect the binding site and do occur in nature. T97 is buried and has been held constant/the amino acid is not varied.

The parental sequence appears at 0.000246 or 1 in 4.06E3. The allowed diversity is about 2.1E12.

TABLE 66
Distribution of VLs in 13222 LCs

| Kappas | | | Lambdas | | |
|---|---|---|---|---|---|
| O12 | VKI | 3408 | 1a | VL1 | 81 |
| O18 | VKI | 230 | 1e | VL1 | 33 |
| A20 | VKI | 183 | 1c | VL1 | 645 |
| A30 | VKI | 207 | 1g | VL1 | 634 |
| L14 | VKI | 14 | 1b | VL1 | 9 |
| L1 | VKI | 99 | 2c | VL2 | 138 |
| L15 | VKI | 10 | 2e | VL2 | 163 |
| L5 | VKI | 778 | 2a2 | VL2 | 692 |
| L8 | VKI | 126 | 2d | VL2 | 6 |
| L9 | VKI | 8 | 3r | VL3 | 610 |
| L24 | VKI | 2 | 3j | VL3 | 16 |
| L12 | VKI | 704 | 3p | VL3 | 2 |
| O11 | VKII | 63 | 3l | VL3 | 274 |
| A17 | VKII | 162 | 3h | VL3 | 273 |
| A18 | VKII | 1 | 3m | VL3 | 11 |
| A19 | VKII | 393 | 2-19 | VL3 | 1 |
| A23 | VKII | 9 | 4a | VL4 | 11 |
| A27 | VKIII | 1483 | 4b | VL4 | 41 |
| A11 | VKIII | 14 | 5e | VL5 | 1 |
| L2 | VKIII | 492 | 5c | VL5 | 7 |
| L6 | VKIII | 758 | 6a | VL6 | 67 |
| L20 | VKIII | 1 | 7a | VL7 | 3 |
| L25 | VKIII | 156 | 9a | VL9 | 3 |
| B3 | VKIV | 169 | 10a | VL10 | 31 |
| | | 9470 | | | 3752 |

Total = 13222

Following not seen: O2; O8; L4; L18; L19; L23; L11; O1; A1; A2; A3; L16; B2; A26; A10; A14; 2b2; 3a; 3e; 4c; 5b; 7b; 8a

TABLE 69
A Display gene for A27 in pM21J.
IIIsignal::A27::Ckappa
The amino-acid sequence of Table 69 is (SEQ ID NO:928).
The DNA sequence of Table 69 is (SEQ ID NO:929).

| | |
|---|---|
| 1 | aagctt tggagccttttttttggagattttcaac |
| | HindIII |
| | signal sequence-------------------------------------------- |
| | 1 2 3 4 5 6 7 8 9 10 11 12 13 14 15 |
| | M K K L L S A I P L V V P F Y |
| 35 | \|atg\|aaG\|aaA\|ctg\|ctg\|tct\|gct\|atc\|ccA\|CTA\|GTt\|gtc\|cct\|ttc\|tat\| |
| | SpeI.... |
| | Signal------- FR1------------------------------------------- |
| | 16 17 18 19 20 21 22 23 24 25 26 27 28 29 30 |
| | S H S E1 I V3 L T5 Q S7 P G9 T L S12 |
| 80 | \|tct\|cat\|agt\|gaa\|atc\|gtt\|ctg\|acc\|cag\|tcC\|CCG\|GGG\|aCC\|Ctg\|tct\| |
| | XmaI.... |
| | PpuMI.... |
| | EcoO109I.(1/2) |
| | FR1--------------------------------------- CDR1----------- |
| | 31 32 33 34 35 36 37 38 39 40 41 42 43 44 45 |
| | L13 S P G E R A T L S C23 R24 A S Q |
| 125 | \|ctg\|tct\|ccg\|ggt\|gaa\|cgt\|gct\|acG\|CTg\|AGC\|tgt\|cgt\|gct\|tct\|caa\| |
| | BlpI..... |
| | CDR1-------------------------- FR2------------------------ |
| | 46 47 48 49 50 51 52 53 54 55 56 57 58 59 60 |
| | S28 V S S S30a Y L A34 W Y Q Q K P G |
| 170 | \|tcc\|gtt\|agC\|TCC\|TCt\|tat\|tta\|gct\|tgg\|tat\|cag\|caa\|aag\|ccg\|ggt\| |
| | BseRI... |
| | FR2--------------------------- CDR2----------------------- |
| | 61 62 63 64 65 66 67 68 69 70 71 72 73 74 75 |
| | Q A P R45 L L I Y G50 A S S R A T56 |
| 215 | \|caa\|gct\|CCG\|CGG\|ctg\|ttg\|atc\|tat\|ggt\|gcc\|tct\|agt\|cgt\|gct\|act\| |
| | SacII.. |
| | FR3------------------------------------------------------- |
| | 76 77 78 79 80 81 82 83 84 85 86 87 88 89 90 |
| | G I P D60 R F S G S65 G S G T D F |
| 260 | \|ggc\|atc\|cct\|gat\|cgt\|ttc\|tct\|ggc\|tct\|ggc\|TCC\|GGA\|acc\|gat\|ttc\| |
| | BspEI.. |
| | FR3------------------------------------------------------- |
| | 91 92 93 94 95 96 97 98 99 100 101 102 103 104 105 |
| | T L T I S R L E P E D F A V Y |
| 305 | \|act\|ctg\|acc\|att\|tct\|CGT\|CTC\|GAG\|ccg\|gaa\|gat\|ttc\|gct\|gtc\|tac\| |
| | BsmBI.. |
| | XhoI... |
| | FR3---- CDR3------------------------------ FR4----------- |
| | 106 107 108 109 110 111 112 113 114 115 116 117 118 119 120 |
| | Y C Q89 Q Y G S S P95 L T F G G G |
| 350 | \|tat\|tgt\|caa\|cag\|tat\|ggt\|tct\|agt\|ccg\|ctg\|act\|ttc\|ggt\|ggc\|GGT\| |
| | KpnI... |
| | FR4-------------------- JK4 |
| | 121 122 123 124 125 126 |
| | T K V E I K |
| 395 | \|ACC\|aaa\|gtc\|gaa\|atc\|aag |
| | KpnI. |
| | Ckappa |
| | R G T V A A P S V F I F P P S |
| 413 | cgt gga act gtg gCT GCA Cca tct GTC TTC atc ttc ccg cca tct |
| | BsgI.... BbsI... |
| | D E Q L K S G T A S V V C L L |
| 458 | gat gag cag ttg aaa tct gga act gcc tct gtt gtg tgc ctg ctg |
| | N N F Y P R E A K V Q W K V D |
| 503 | aat aac ttc tat ccc aga gag gcc aaa gta cag tgg aag gtg gat |
| | N A L Q S G N S Q E S V T E Q |
| 548 | aac gcc ctc caa tcg ggt aac tcc cag gag agt gtc aca gag cag |
| | D S K D S T Y S L S S T L T L |
| 593 | gac agc aag gac agc acc tac agc ctc agc agc acc ctg act ctg |
| | S K A D Y E K H K V Y A C E V |
| 638 | tcc aaa gca gac tac gag aaa cac aaa GTC TAC gcc tgc gaa gtc |
| | T H Q G L S S P V T K S F N R |
| 683 | acc cat cAG GGC CTg agt tCA CCG GTG aca aag agc ttc aac agg |
| | AlwNI...... SgrAI..... |
| | EcoO109I.(2/2) AgeI.... |
| | G E C • • |
| 728 | gga gag tgt taa taa |
| 743 | GG CGCGCCaatt |
| | AscI..... |
| | BssHII. |

TABLE 70
Variegation of CDRs of A27 Abs
These are taken from Table 3002, Table 3003, and Table 3004

CDR1 1291 with Len = 3212 (SEQ ID NO: 925)

| | | |
|---|---|---|
| R24 | 1, 11G, 4TW, | Fix |
| A25 | 2, 35T, 7P, 6V, | Fix |
| S26 | 3, 14T, 5R, 2N, 1G | Fix |
| Q27 | 4, 21H, 19E, 15R, 9P, 4L, 2K | 7% ERHPL 2% KAGDN |
| S28 | 5, 92T, 33R, 30N, 16G, 15I, 7Y, 5P, 3AF, 2DL, 1KV | 7% TRNGI 2% YDPAF |
| V29 | 6, ^{a}42I, 68L, 28F, 3G, 1ADMPT | Fix |
| S30 | 7, 80R, 70T, 63G, 40N, 27D, 23A, 17I, 9YP, 6FV, 4H, 2LW, 1EKMQ | 7% DNRTG 2% AIYPF |
| S30a | 8, 93N, 55R, 48G, 34T, 10I, 9Aa, 9D, 8HY, 4VP, 3F, 2K, 2L, 1PQW | 7% GNRTI 2% DAHYP^{a} |
| | (8% delete 30a) | |
| S31 | 9, 244N, 123R, 93T, 27G, 26D, 20Y, 16K, 9A, 8I, 6H, 5F, 2M, 1ELV | 7% NRTDG 2% YKAIH |
| Y32 | 10, 81F, 71S, 28H, 21N, 9Q, 7D, 6R, 4LW, 2K, 1EGV | 7% FSHNQ 2% DRLWK |
| L33 | 11, 52V, 22I, 19F, 3M, 1W | Fix |
| A34 | 12, 22V, 19G, 17T, 15S, 1MN | Fix |

CDR2 1439 with Len = 7 (SEQ ID NO: 926)

| | | |
|---|---|---|
| G50 | 1, 104D, 97A, 21S, 12R, 3H, 2N, 1EKV | 7% DASRH 2% NEKVG |
| A51 | 2, 24V, 18G, 13S, 12T, 7I, 2M, 1P | Fix |
| S52 | 3, 26F, 8A, 7T2L, 1INV, | Fix |
| S53 | 4, 191N, 152T, 76R, 27I, 16K, 14G, 13Y, 9H, 7F, 5D, 4A, 2L, 1M, | 7% NTRIK 2% GYHFD |
| R54 | 5, 2GKT, 1LM | Fix |
| A55 | 6, 19V, 14P, 9S, 7G, 2T, 1DFN | Fix |
| T56 | 7, 52A, 39S, 31P, 4I, 2K, 1DGHN | 7% ASPIK 2% DNHGR |

CDR3 (SEQ ID NO: 988)

| | | |
|---|---|---|
| Q89 | 1, 90H, 22L, 10M, 6E, 2NV | Fix |
| Q90 | 2, 96H, 12R, 8LY, 6EK, 4V, 2GMS | Fix |
| Y91 | 3, 138R, 52S, 42F, 32H, 30A, 14L, 8GT, 6CN, | 7% RSFHA 2% LGTQD |
| G92^{a} | 4, 158S, 130A, 74D, 56NY, 40R, 20E, 16V, 14F, 10T, 8H, 6L, 4K, 2IMQ, | 7% SADNY 2% REVFT |
| S93 | 5, 178N, 158T, 134R, 84G, 46D, 36Y, 26A, 14IKV, 12FHQ, 8LM, 4P, 2EW, | 7% NTRGD 2% YAIKV |
| | (8% have 93 deleted) | |
| S94 | 6, 166W, 68T, 66P, 52F, 32A, 26L, 24Y, 12G, 6IR, 4V, 2HN, | 7% WTPFA 2% LYGIR |
| P95 | 7, 96L, 76R, 74S, 30Q, 28T, 24V, 18A, 14G, 10FM, 8K, 6H, 4EW, 2Y | 9% LRSQT 2% VAGFK |
| X95a | 252P, 86L, 64R, 58G, 38M, 30S, 28T, 20A, 14Q, 12E, 10V, 6K, 4I, 2H, | 9.1% PLRGSTAQEVK |
| | (70% have X95a absent) | |
| L96 | 8, , 286R, 256Y, 196W, 126F, 124I, 60P, 52G, 46V, 36Q, 26KT, 20E, 16H, 12DS, | 7% RYWFI 2% PGVQK |
| | 8A, 2M, | |
| T97 | 9, 64S, 32A, 8P, 6GNV, 4FI, 2KM, | Fix |

Table 72 shows a pattern of diversity for A27 kappa LCs that has the frequency of N adjusted to reduced the frequency of N—X—(S/T). At position 28, N has been hanged to Q because position 30 is predominantly S. At position 30, A has been moved to the higher frequency group and N to the lower frequency group because S31 is predominant when X30a is present and S is in the higher frequency group at X32. At position 30a, D has been moved to the higher frequency group and N to the lower frequency group because S is in the higher frequency group at X32. At position 50, N has been changed to Q because 52 is fixed at S. At position 92, N has been moved to the lower frequency group and R has been moved to the higher frequency group because 94 is predominantly S. Building the LC diversity according to Table 70 Alt is a preferred embodiment.

TABLE 72
Variegation of CDRs of A27 Abs
These are taken (with some modification) from Table 3002, Table 3003, and
Table 3004
CDR1 1291 with Len = 12 (SEQ ID NO: 925)

| | | | |
|---|---|---|---|
| R24 | 1, | 11G, 4TW, | Fix |
| A25 | 2, | 35T, 7P, 6V, | Fix |
| S26 | 3, | 14T, 5R, 2N, 1G | Fix |
| Q27 | 4, | 21H, 19E, 15R, 9P, 4L, 2K | 7% ERHPL 2% KAGDN |
| S28 | 5, | 92T, 33R, 30N, 16G, 15I, 7Y, 5P, 3AF, 2DL, 1KV | 7% TRGIY 2% QDPAF * |
| V29 | 6, | ^{a}42I, 68L, 28F, 3G, 1ADMPT | Fix |
| S30 | 7, | 80R, 70T, 63G, 40N, 27D, 23A, 17I, 9YP, 6FV, 4H, 2LW, 1EKMQ | 7% DARTG 2% NIYPF * |
| S30a | 8, | 93N, 55R, 48G, 34T, 10I, 9A^{a}, 9D, 8HY, 4VP, 3F, 2K, 2L, 1PQW | 7% GDRTI 2% NAHYP^{a} * |
| | | | (8% delete 30a) |
| S31 | 9, | 244N, 123R, 93T, 27G, 26D, 20Y, 16K, 9A, 8I, 6H, 5F, 2M, 1ELV | 7% NRTDG 2% YKAIH |
| Y32 | 10, | 81F, 71S, 28H, 21N, 9Q, 7D, 6R, 4LW, 2K, 1EGV | 7% FSHNQ 2% DRLWK |
| L33 | 11, | 52V, 22I, 19F, 3M, 1W | Fix |
| A34 | 12, | 22V, 19G, 17T, 15S, 1MN | Fix |

CDR2 1439 with Len = 7 (SEQ ID NO: 926)

| | | | |
|---|---|---|---|
| G50 | 1, | 104D, 97A, 21S, 12R, 3H, 2N, 1EKV | 7% DASRH 2% QEKVG * |
| A51 | 2, | 24V, 18G, 13S, 12T, 7I, 2M, 1P | Fix |
| S52 | 3, | 26F, 8A, 7T2L, 1INV, | Fix |
| S53 | 4, | 191N, 152T, 76R, 27I, 16K, 14G, 13Y, 9H, 7F, 5D, 4A, 2L, 1M, | 7% NTRIK 2% GYHFD |
| R54 | 5, | 2GKT, 1LM | Fix |
| A55 | 6, | 19V, 14P, 9S, 7G, 2T, 1DFN | Fix |
| T56 | 7, | 52A, 39S, 31P, 4I, 2K, 1DGHN | 7% ASPIK 2% DNHGR |

CDR3 (SEQ ID NO: 988)

| | | | |
|---|---|---|---|
| Q89 | 1, | 90H, 22L, 10M, 6E, 2NV | Fix |
| Q90 | 2, | 96H, 12R, 8LY, 6EK, 4V, 2GMS | Fix |
| Y91 | 3, | 138R, 52S, 42F, 32H, 30A, 14L, 8GT, 6CN, | 7% RSFHA 2% LGTQD |
| G92^{a} | 4, | 158S, 130A, 74D, 56NY, 40R, 20E, 16V, 14F, 10T, 8H, 6L, 4K, 2IMQ, | 7% SADRY 2% NEVFT * |
| S93 | 5, | 178N, 158T, 134R, 84G, 46D, 36Y, 26A, 14IKV, 12FHQ, 8LM, 4P, 2EW, | 7% NTRGD 2% YAIKV |
| | | | (8% have 93 deleted) |
| S94 | 6, | 166W, 68T, 66P, 52F, 32A, 26L, 24Y, 12G, 6IR, 4V, 2HN, | 7% WTPFA 2% LYGIR |
| P95 | 7, | 96L, 76R, 74S, 30Q, 28T, 24V, 18A, 14G, 10FM, 8K, 6H, 4EW, 2Y | 9% LRSQT 2% VAGFK |
| X95a | | 252P, 86L, 64R, 58G, 38M, 30S, 28T, 20A, 14Q, 12E, 10V, 6K, 4I, 2H, | 9.1% PLRGSTAQEVK |
| | | | (70% have X95a absent) |
| L96 | 8, | , 286R, 256Y, 196W, 126F, 124I, 60P, 52G, 46V, 36Q, 26KT, 20E, 16H, 12DS, 8A, 2M, | 7% RYWFI 2% PGVQK |
| T97 | 9, | 64S, 32A, 8P, 6GNV, 4FI, 2KM, | Fix |

TABLE 770
Variegation of human A27 (Table 770 discloses SEQ
ID NOS 925, 1162-1173, 966 and 1174-1195,
respectively, in order of appearance)

| | CDR1 |
|---|---|
| | 2222223 3333 |
| | 4567890a1234 |
| | + + + + |
| | ** **** * |
| A27CDR1 | RASQSVSSSYLA |
| var1 | H |
| var2 | E |
| var3 | R |
| var4 | R |
| var5 | T |
| var6 | G |
| var7 | N |
| var8 | F |
| var9 | S |
| var10 | H |
| var11 | RASQSVS-SYLA |
| var12 | R |
| | CDR3 |
| | 8999999 99 |
| | 9012345a67 |
| | ***** * |
| A27CDR3 | QQYGSSP-LT |
| var13 | R |
| var14 | S |
| var15 | F |
| var16 | S |
| var17 | A |
| var18 | D |
| var19 | N |
| var20 | R (T too conservative) |
| var21 | G |
| var22 | D |
| var23 | W |
| var24 | P |
| var25 | F |
| var26 | R |
| var27 | Y |
| var28 | QQYGSSPPLT |
| var29 | L |
| var30 | R |
| var31 | S |
| var32 | N |
| var33 | W |
| var34 | Y |

TABLE 71
Allowed diversity in CDR1, 2, and 3 of A27::JK4.

| | | |
|---|---|---|
| Position | parental | allowed |

CDR1 (SEQ ID NO: 925)

| | | | |
|---|---|---|---|
| 42(24) | R | fixed | |
| 43(25) | A | fixed | |
| 44(26) | S | fixed | |
| 45(27) | Q | ERYSL | 55% Q 9% other |
| 46(28) | S | NTYERL | 46% S 9% other |
| 47(29) | V | fixed | |
| 48(30) | S | DNRTY | 55% S 9% other |
| 49(30a) | S | GNRTYD | 46% S 9% other |

8% have 30a deleted

| | | | |
|---|---|---|---|
| 50(31) | S | DFGNRTY | 44% S 8% other |
| 51(32) | Y | FDLNQRSY | 44% Y 7% other |
| 52(33) | L | fixed | |
| 53(34) | A | SY | 70% A 15% other |

CDR2 (SEQ ID NO: 926)

| | | | |
|---|---|---|---|
| 69(50) | G | DRSYL | 55% G 9% other |
| 70(51) | A | Fixed | |
| 71(52) | S | Fixed | |
| 72(53) | S | NTSYER | 52% S 8% other |
| 73(54) | R | Fixed | |
| 74(55) | A | Fixed | |
| 75(56) | T | ERSY | 64% T 9% other |

CDR3 (SEQ ID NO: 966)

| | | | |
|---|---|---|---|
| 108(89) | Q | fixed | |
| 109(90) | Q | fixed | |
| 110(91) | Y | FERS | 64% Y 9% other |
| 111(92) | G | ADRSTY | 52% G 8% other |
| 112(93) | S | DFNRTY | 52% S 8% other |
| 113(94) | S | WERYS | 55% S 9% other |
| 114(95) | P | ERYS | 64% P 9% other |

8% have P95 deleted

| | | | |
|---|---|---|---|
| 115(96) | L | ERPYS | 55% L 9% other |
| 116(97) | T | fixed | |

Table 73 shows an alternative diversity for A27 kappa LCs. At position 28, N is not allowed and Q is. At position 30, N is not allowed and Q is. At position 32, we retain N since S is present at 34 at only 0.15 frequency. These changes, relative to Table 71, reduce the frequency of N—X—(S/T).

TABLE 73
Allowed diversity in CDR1, 2, and 3 of A27::JK4.

| | | |
|---|---|---|
| Position | parental | allowed |

CDR1 (SEQ ID NO: 925)

| | | | |
|---|---|---|---|
| 42(24) | R | fixed | |
| 43(25) | A | fixed | |
| 44(26) | S | fixed | |
| 45(27) | Q | ERYSL | 55% Q 9% other |
| 46(28) | S | TYERLQ | 46% S 9% other |
| 47(29) | V | fixed | |
| 48(30) | S | DQRTY | 55% S 9% other |
| 49(30a) | S | GNRTYD | 46% S 9% other |

8% have 30a deleted

| | | | |
|---|---|---|---|
| 50(31) | S | DFGNRTY | 44% S 8% other |
| 51(32) | Y | FDLNQRSY | 44% Y 7% other |
| 52(33) | L | fixed | |
| 53(34) | A | SY | 70% A 15% other |

CDR2 (SEQ ID NO: 926)

| | | | |
|---|---|---|---|
| 69(50) | G | DRSYL | 55% G 9% other |
| 70(51) | A | Fixed | |
| 71(52) | S | Fixed | |
| 72(53) | S | NTSYER | 52% S 8% other |
| 73(54) | R | Fixed | |
| 74(55) | A | Fixed | |
| 75(56) | T | ERSY | 64% T 9% other |

CDR3 (SEQ ID NO: 966)

| | | | |
|---|---|---|---|
| 108(89) | Q | fixed | |
| 109(90) | Q | fixed | |
| 110(91) | Y | FERS | 64% Y 9% other |
| 111(92) | G | ADRSTY | 52% G 8% other |
| 112(93) | S | DFNRTY | 52% S 8% other |
| 113(94) | S | WERYS | 55% S 9% other |
| 114(95) | P | ERYS | 64% P 9% other |

8% have P95 deleted

| | | | |
|---|---|---|---|
| 115(96) | L | ERPYS | 55% L 9% other |
| 116(97) | T | fixed | |

The parental sequence appears at 5.32E−5 or 1 in 1.88E4.

Sequences with a single substitution have a probability between 1.1E−5 and 7.5E−6.

Sequences that have none of the parental AAs occurs at 1 in 6.7E16.

The allowed diversity is about 2.35E12.

TABLE 75
Frequencies of amino acids in HC CDR3s.

| | Overall | % | VJ fill | % | VD fill | % | D seg | % | DJ fill | % | Jstump | % |
|---|---|---|---|---|---|---|---|---|---|---|---|---|
| A | 14746 | 5.43 | 3655 | 5.91 | 1657 | 6.94 | 3257 | 4.59 | 890 | 5.69 | 4771 | 5.19 |
| C | 1117 | 0.41 | 83 | 0.13 | 21 | 0.09 | 891 | 1.25 | 22 | 0.14 | 90 | 0.10 |
| D | 34041 | 12.54 | 3599 | 5.82 | 2271 | 9.52 | 4751 | 6.69 | 346 | 2.21 | 21074 | 22.93 |
| E | 5985 | 2.20 | 2865 | 4.63 | 1183 | 4.96 | 1003 | 1.41 | 345 | 2.20 | 425 | 0.46 |
| F | 17563 | 6.47 | 1444 | 2.34 | 419 | 1.76 | 2517 | 3.54 | 522 | 3.34 | 11778 | 12.82 |
| G | 37189 | 13.70 | 12680 | 20.51 | 4616 | 19.34 | 11455 | 16.13 | 3319 | 21.21 | 4856 | 5.28 |
| H | 4258 | 1.57 | 1357 | 2.19 | 512 | 2.15 | 695 | 0.98 | 230 | 1.47 | 1394 | 1.52 |
| I | 9578 | 3.53 | 1604 | 2.59 | 578 | 2.42 | 1644 | 2.31 | 268 | 1.71 | 5125 | 5.58 |
| K | 2992 | 1.10 | 1254 | 2.03 | 505 | 2.12 | 520 | 0.73 | 370 | 2.36 | 326 | 0.35 |
| L | 11513 | 4.24 | 3687 | 5.96 | 1466 | 6.14 | 2637 | 3.71 | 1124 | 7.18 | 2014 | 2.19 |
| M | 5995 | 2.21 | 615 | 0.99 | 247 | 1.04 | 449 | 0.63 | 144 | 0.92 | 4454 | 4.85 |
| N | 5694 | 2.10 | 1719 | 2.78 | 306 | 1.28 | 1436 | 2.02 | 260 | 1.66 | 1905 | 2.07 |
| P | 9423 | 3.47 | 3350 | 5.42 | 1917 | 8.03 | 1158 | 1.63 | 1775 | 11.34 | 1094 | 1.19 |
| Q | 3105 | 1.14 | 1233 | 1.99 | 552 | 2.31 | 638 | 0.90 | 203 | 1.30 | 408 | 0.44 |
| R | 13803 | 5.08 | 6283 | 10.16 | 2596 | 10.88 | 2583 | 3.64 | 2026 | 12.95 | 205 | 0.22 |
| S | 22177 | 8.17 | 5507 | 8.91 | 1733 | 7.26 | 12066 | 16.99 | 1583 | 10.12 | 1059 | 1.15 |
| T | 7383 | 2.72 | 2832 | 4.58 | 1055 | 4.42 | 2531 | 3.56 | 659 | 4.21 | 177 | 0.19 |
| V | 13201 | 4.86 | 2929 | 4.74 | 1492 | 6.25 | 2835 | 3.99 | 627 | 4.01 | 5139 | 5.59 |
| W | 9320 | 3.43 | 2287 | 3.70 | 397 | 1.66 | 4175 | 5.88 | 611 | 3.90 | 1270 | 1.38 |
| Y | 42403 | 15.62 | 2840 | 4.59 | 341 | 1.43 | 13793 | 19.42 | 325 | 2.08 | 24336 | 26.48 |
| | 271486 | | 61823 | | 23864 | | 71034 | | 15649 | | 91900 | |

TABLE 76
Length distribution of 21,578 HC
CDR3

| | all | no D | with D |
|---|---|---|---|
| Length | Count | Count | Count |
| 1 | 1 | 1 | 0 |
| 2 | 3 | 3 | 0 |
| 3 | 45 | 45 | 0 |
| 4 | 117 | 114 | 3 |
| 5 | 124 | 120 | 4 |
| 6 | 537 | 519 | 18 |
| 7 | 685 | 617 | 68 |
| 8 | 1080 | 912 | 168 |
| 9 | 2271 | 1864 | 407 |
| 10 | 2707 | 2024 | 683 |
| 11 | 2126 | 1112 | 1014 |
| 12 | 2067 | 872 | 1195 |
| 13 | 1892 | 748 | 1144 |
| 14 | 1608 | 458 | 1150 |
| 15 | 1375 | 330 | 1045 |
| 16 | 1308 | 321 | 987 |
| 17 | 1107 | 187 | 920 |
| 18 | 751 | 70 | 681 |
| 19 | 575 | 57 | 518 |
| 20 | 396 | 17 | 379 |
| 21 | 280 | 12 | 268 |
| 22 | 232 | 16 | 216 |
| 23 | 127 | 4 | 123 |
| 24 | 82 | 2 | 80 |
| 25 | 31 | 1 | 30 |
| 26 | 25 | 3 | 22 |
| 27 | 9 | 0 | 9 |
| 28 | 6 | 0 | 6 |
| 29 | 2 | 0 | 2 |
| 30 | 4 | 1 | 3 |
| 31 | 2 | 0 | 2 |
| 32 | 0 | 0 | 0 |
| 33 | 1 | 0 | 1 |
| 34 | 0 | 0 | 0 |
| 35 | 0 | 0 | 0 |
| 36 | 1 | 0 | 1 |
| 37 | 0 | 0 | 0 |
| 38 | 0 | 0 | 0 |
| 39 | 0 | 0 | 0 |
| 40 | 1 | 0 | 1 |

Median length of CDR3 = 11.53
Median length of CDR3 noD = 9.50
Median length of CDR3 with D = 13.76

### Example 6

### Wobbled DNA for HC CDR316d (Biblioteca 44)

Table 400 shows a segment of DNA from an XbaI site in FR3 to a BstEII site in FR4. The HC CDR3 consists of SYSY (SEQ ID NO: 947)::D2-2(2)::QH followed by the FR4 region of JH1. The QH is found in the germline of JH1. In V-D-J joining, immune cells often edit the ends of V, D, and J. Thus the construction corresponds to what is very possible in actual immunoglobulin gene construction and maturation. By wobbling the synthesis, we obtain a large collection of genes that resemble what would come from joining 3-23 to either a D region or to a little edited JH1 followed by some mutations. In library 16d, there are two cysteines that presumably form a disulfide, these are not wobbled.

Table 500 shows the expected distribution of amino-acid types at each position in the 16d library. The wobble doping was set at 73:9:9:9. The most likely sequence is the one shown in Table 21 and should be present at a frequency of 4.8E−5. Only 55% of the sequences are stop free and 74% are free of ochre or opel. If the library is expressed in supE cells, this is the important number. It would be valuable to remove the sequences with stop codons as discussed elsewhere herein. One can see that those positions that start as S are predicted to have S 54% of the time and Y 5.4% while those that start as Y have Y 44% of the time and S 7.2%. At each position there are 7-9 AA types that appear at >1%. There are 14 variegated positions. The sequences that will be most effectively sampled number about 8¹⁴=4.3E12.

TABLE 400
Cassette for display of wobbled HC CDR3 16d
The amino acid sequence disclosed in Table 400 is SEQ ID NO: 968.
The DNA sequence disclosed in Table 400 is SEQ ID NO: 967

| | |
|---|---|
| | --------FR3-------------------------------------------------- |
| | 68 69 70 71 72 73 74 75 76 77 78 79 80 81 82 |
| | T I S R D N S K N T L Y L Q M |
| 1216 | \|act\|atc\|TCT\|AGA\|gac\|aac\|tct\|aag\|aat\|act\|ctc\|tac\|ttg\|cag\|atg\| |
| | \| XbaI \| |
| | ---FR3------------^{a}---------------------------------------->\| |
| | 82a 82b 82c 83 84 85 86 87 88 89 90 91 92 93 94 |
| | N S L R A E D T A V Y Y C A K |
| 1261 | \|aac\|agC\|TTA\|AGg\|gct\|gag\|gac\|act\|gca\|gtc\|tac\|tat\|tgc\|gct\|aaa\| |
| | \|AflII \| |

e = 0.73 A + 0.09 C + 0.09 G + 0.09 T
q = 0.09 A + 0.73 C + 0.09 G + 0.09 T
j = 0.09 A + 0.09 C + 0.73 G + 0.09 T
z = 0.09 A + 0.09 C + 0.09 G + 0.73 T
The values 0.73 and 0.09 are picked so that 0.73 + 3*0.09 = 1.0
Other ratios could be used.

```
                                                                  102 102 102 102 102 102 102 102
  95 96 97 98 99 100 101 102 a b c d e f g h
    S Y S Y G Y c S S T S c Y T Q H
  zqz zez zqz zez jjz zez TGT zqz zqz eqz zqz TGT zez eqz qej qez
  --------------FR4------------------------->|
  103 104 105 106 107 108 109 110 111 112 113
    W G Q G T L V T V S S
  TGg ggt caa ggt act ttG GTC ACC gtc tct agt
                                              | BstEII |
```

TABLE 500
Expected distribution of AA types in wobbled HC CDR3 16d
The amino acid sequence disclosed in Table 500 is SEQ ID NO: 970.
The DNA sequence disclosed in Table 500 is SEQ ID NO: 969.

“•” = TGA or TAA; “b” = TAG
S Y S Y G Y c S S T S c Y T Q H
zqz zez zqz zez jjz zez tgt zqz zqz eqz zqz tgt zez eqz qej qez
Nominal base purity = 0.7300 others = 0.0900

| | s(zqz) | y(zez) | s(zqz) | y(zez) | g(jjz) | y(zez) | C(TGT) | s(zqz) | s(zqz) | t(eqz) |
|---|---|---|---|---|---|---|---|---|---|---|
| 1 | s 5.4-01 | y 4.4-01 | s 5.4-01 | y 4.4-01 | g 5.3-01 | y 4.4-01 | c 1.000 | s 5.4-01 | s 5.4-01 | t 5.3-01 |
| 2 | p 6.6-02 | s 7.2-02 | p 6.6-02 | s 7.2-02 | r 7.8-02 | s 7.2-02 | | p 6.6-02 | p 6.6-02 | s 1.2-01 |
| 3 | a 6.6-02 | f 5.4-02 | a 6.6-02 | f 5.4-02 | a 6.6-02 | f 5.4-02 | | a 6.6-02 | a 6.6-02 | a 6.6-02 |
| 4 | t 6.6-02 | h 5.4-02 | t 6.6-02 | h 5.4-02 | v 6.6-02 | h 5.4-02 | | t 6.6-02 | t 6.6-02 | p 6.6-02 |
| 5 | f 5.4-02 | n 5.4-02 | f 5.4-02 | n 5.4-02 | s 6.2-02 | n 5.4-02 | | f 5.4-02 | f 5.4-02 | i 6.0-02 |
| 6 | c 5.4-02 | c 5.4-02 | c 5.4-02 | c 5.4-02 | c 5.4-02 | c 5.4-02 | | c 5.4-02 | c 5.4-02 | n 5.4-02 |
| 7 | y 5.4-02 | d 5.4-02 | y 5.4-02 | d 5.4-02 | d 5.4-02 | d 5.4-02 | | y 5.4-02 | y 5.4-02 | r 2.0-02 |
| 8 | l 2.0-02 | • 5.4-02 | l 2.0-02 | • 5.4-02 | e 1.2-02 | • 5.4-02 | | l 2.0-02 | l 2.0-02 | k 1.2-02 |
| 9 | • 1.2-02 | b 4.8-02 | • 1.2-02 | b 4.8-02 | l 9.6-03 | b 4.8-02 | | • 1.2-02 | • 1.2-02 | l 9.6-03 |
| 10 | r 9.6-03 | l 2.0-02 | r 9.6-03 | l 2.0-02 | t 8.1-03 | l 2.0-02 | | r 9.6-03 | r 9.6-03 | g 8.1-03 |
| 11 | g 8.1-03 | k 1.2-02 | g 8.1-03 | k 1.2-02 | p 8.1-03 | k 1.2-02 | | g 8.1-03 | g 8.1-03 | v 8.1-03 |
| 12 | v 8.1-03 | q 1.2-02 | v 8.1-03 | q 1.2-02 | l 7.4-03 | q 1.2-02 | | v 8.1-03 | v 8.1-03 | f 6.6-03 |
| 13 | i 7.4-03 | e 1.2-02 | i 7.4-03 | e 1.2-02 | • 6.6-03 | e 1.2-02 | | i 7.4-03 | i 7.4-03 | c 6.6-03 |
| 14 | h 6.6-03 | r 9.6-03 | h 6.6-03 | r 9.6-03 | f 6.6-03 | r 9.6-03 | | h 6.6-03 | h 6.6-03 | h 6.6-03 |
| 15 | n 6.6-03 | t 8.1-03 | n 6.6-03 | t 8.1-03 | h 6.6-03 | t 8.1-03 | | n 6.6-03 | n 6.6-03 | d 6.6-03 |
| 16 | d 6.6-03 | v 8.1-03 | d 6.6-03 | v 8.1-03 | y 6.6-03 | v 8.1-03 | | d 6.6-03 | d 6.6-03 | y 6.6-03 |
| 17 | w 5.9-03 | a 8.1-03 | w 5.9-03 | a 8.1-03 | n 6.6-03 | a 8.1-03 | | w 5.9-03 | w 5.9-03 | m 5.9-03 |
| 18 | b 5.9-03 | g 8.1-03 | b 5.9-03 | g 8.1-03 | w 5.9-03 | g 8.1-03 | | b 5.9-03 | b 5.9-03 | q 1.5-03 |
| 19 | q 1.5-03 | p 8.1-03 | q 1.5-03 | p 8.1-03 | q 1.5-03 | p 8.1-03 | | q 1.5-03 | q 1.5-03 | e 1.5-03 |
| 20 | k 1.5-03 | i 7.4-03 | k 1.5-03 | i 7.4-03 | k 1.5-03 | i 7.4-03 | | k 1.5-03 | k l.5-03 | • l.5-03 |
| 21 | e 1.5-03 | w 5.9-03 | e 1.5-03 | w 5.9-03 | m 7.3-04 | w 5.9-03 | | e 1.5-03 | e 1.5-03 | w 7.3-04 |
| 22 | m 7.3-04 | m 7.3-04 | m 7.3-04 | m 7.3-04 | b 7.3-04 | m 7.3-04 | | m 7.3-04 | m 7.3-04 | b 7.3-04 |
| | s(zqz) | C(TGT) | y(zez) | t(eqz) | q(qej) | h(gez) | | | | |
| 1 | s 5.4-01 | c 1.000 | y 4.4-01 | t 5.3-01 | q 4.4-01 | h 4.4-01 | | | | |
| 2 | p 6.6-02 | | s 7.2-02 | s 1.2-01 | h 9.6-02 | q 9.6-02 | | | | |
| 3 | a 6.6-02 | | f 5.4-02 | a 6.6-02 | l 7.2-02 | l 6.7-02 | | | | |
| 4 | t 6.6-02 | | h 5.4-02 | p 6.6-02 | r 7.2-02 | r 6.7-02 | | | | |
| 5 | f 5.4-02 | | n 5.4-02 | i 6.0-02 | p 6.6-02 | p 6.6-02 | | | | |
| 6 | c 5.4-02 | | c 5.4-02 | n 5.4-02 | e 5.4-02 | n 5.4-02 | | | | |
| 7 | y 5.4-02 | | d 5.4-02 | r 2.0-02 | k 5.4-02 | d 5.4-02 | | | | |
| 8 | l 2.0-02 | | • 5.4-02 | k 1.2-02 | b 4.8-02 | y 5.4-02 | | | | |
| 9 | • 1.2-02 | | b 4.8-02 | l 9.6-03 | d 1.2-02 | s 1.5-02 | | | | |
| 10 | r 9.6-03 | | l 2.0-02 | g 8.1-03 | y 1.2-02 | k 1.2-02 | | | | |
| 11 | g 8.1-03 | | k 1.2-02 | v 8.1-03 | n 1.2-02 | e 1.2-02 | | | | |
| 12 | v 8.1-03 | | q 1.2-02 | f 6.6-03 | s 9.6-03 | g 8.1-03 | | | | |
| 13 | i 7.4-03 | | e 1.2-02 | c 6.6-03 | t 8.1-03 | t 8.1-03 | | | | |
| 14 | h 6.6-03 | | r 9.6-03 | h 6.6-03 | v 8.1-03 | v 8.1-03 | | | | |
| 15 | n 6.6-03 | | t 8.1-03 | d 6.6-03 | a 8.1-03 | a 8.1-03 | | | | |
| 16 | d 6.6-03 | | v 8.1-03 | y 6.6-03 | g 8.1-03 | i 7.4-03 | | | | |
| 17 | w 5.9-03 | | a 8.1-03 | m 5.9-03 | • 6.6-03 | • 6.6-03 | | | | |
| 18 | b 5.9-03 | | g 8.1-03 | q 1.5-03 | w 5.9-03 | c 6.6-03 | | | | |
| 19 | q 1.5-03 | | p 8.1-03 | e 1.5-03 | m 5.9-03 | f 6.6-03 | | | | |
| 20 | k 1.5-03 | | i 7.4-03 | • 1.5-03 | i 2.2-03 | b 5.9-03 | | | | |
| 21 | e 1.5-03 | | w 5.9-03 | w 7.3-04 | f 1.5-03 | w 7.3-04 | | | | |
| 22 | m 7.3-04 | | m 7.3-04 | b 7.3-04 | c 1.5-03 | m 7.3-04 | | | | |

Most likely sequence has frequency = 4.8E-05
Fraction stop-free = 5.5E-01
Fraction (TAA & TGA)-free = 7.4E-01

TABLE 800
LC K1(O12)::JK1
The amino acid sequence disclosed in Table 800 is SEQ ID NO: 990.
The DNA sequence disclosed in Table 800 is SEQ ID NO: 989.

| | |
|---|---|
| | ..Leader seq. ->\|-------- FR1 -----------------------------> |
| | 1 2 3 4 5 6 7 8 9 10 11 |
| | G V H S A Q D I Q M T Q S P S S L |
| 1 | \|ggT\|GTA\|CAc\|aGT\|GCT\|Cag\|gat\|att\|cag\|atg\|act\|caa\|tct\|ccC\|TCG\|AGt\|ctg\| |
| | BsrGI... ApaLI... XhoI.... |
| | -------- FR1 ---------------------------------->\|--- CDR1 -> |
| | 12 13 14 15 16 17 18 19 20 21 22 23 24 25 26 |
| | S A S V G D R V T I T C R A S |
| 46 | \|tct\|gct\|tct\|gtc\|gGC\|GAT\|CGC\|gtt\|act\|att\|act\|tgt\|cgt\|gct\|tcc\| |
| | SgfI...... |
| | ---- CDR1 -------------------->\|---- FR2 -----------------> |
| | 27 28 29 30 31 32 33 34 35 36 37 38 39 40 41 |
| | Q S I S S Y L N W Y Q Q K P G |
| 91 | \|cag\|tcc\|att\|tct\|agc\|tat\|ctg\|aat\|tGG\|TAC\|Cag\|caa\|aag\|ccg\|ggt\| |
| | KpnI.... |
| | ------ FR2 ------------------->\|-- CDR2 ------------------>\| |
| | 42 43 44 45 46 47 48 49 50 51 52 53 54 55 56 |
| | K A P K L L I Y A A S S L Q S |
| 136 | \|aag\|gct\|ccg\|aaa\|ctg\|tta\|atc\|tat\|gcc\|gct\|tct\|agt\|ctg\|cag\|tct\| |
| | ---------- FR3 -------------------------------------------> |
| | 57 58 59 60 61 62 63 64 65 66 67 68 69 70 71 |
| | G V P S R F S G S G S G T D F |
| 181 | \|ggt\|gtt\|ccg\|TCT\|AGA\|ttc\|tct\|ggc\|tct\|ggt\|tct\|ggt\|act\|gat\|ttt\| |
| | XbaI... |
| | ---------- FR3 -------------------------------------------> |
| | 72 73 74 75 76 77 78 79 80 81 82 83 84 85 86 |
| | T L T I S S L Q P E D F A T Y |
| 226 | \|act\|ctg\|act\|att\|tcc\|tct\|ctg\|caa\|ccg\|gag\|gac\|ttt\|gct\|acc\|tat\| |
| | - FR3->\|---- CDR3 ------------------------>\|--- FR4 ------> |
| | 87 88 89 90 91 92 93 94 95 96 97 98 99 100 101 |
| | Y C Q Q S Y S T P W T F G Q G |
| 271 | \|tac\|tgc\|caa\|cag\|tct\|tat\|agt\|act\|ccg\|tgg\|act\|ttc\|ggt\|caa\|ggc\| |
| | ---- FR4 -------------->\|---- Ckappa-----------------------> |
| | 102 103 104 105 106 107 108 109 110 111 112 113 114 115 116 |
| | T K V E I K R T V A A P S V F |
| 316 | \|act\|aaa\|gtt\|gag\|att\|aag\|CGT\|ACG\|gtg\|gct\|gct\|ccg\|tct\|gtc\|ttc\| |
| | BsiWI.. |

TABLE 900
CDR1 diversity (SEQ ID NO: 973)

| | | | | | | | | | | | | Diver- |
|---|---|---|---|---|---|---|---|---|---|---|---|---|
| Position | 24 | 25 | 26 | 27 | 28 | 29 | 30 | 31 | 32 | 33 | 34 | sity |
| O12 | R | A | S | Q | S | I | S | S | Y | L | N | |
| diversity | 2 | 2 | 1 | 1 | 3 | 1 | 2 | 2 | 4 | 1 | 3 | 576 |
| allowed | Q | M | | | D | | R | N | D | | A | |
| | | | | | G | | | | W | | G | |
| | | | | | | | | | A | | | |

TABLE 1000
Big CDR1 diversity (SEQ ID NO: 973)

| | | | | | | | | | | | | Diver- |
|---|---|---|---|---|---|---|---|---|---|---|---|---|
| Position | 24 | 25 | 26 | 27 | 28 | 29 | 30 | 31 | 32 | 33 | 34 | sity |
| O12 | R | A | S | Q | S | I | S | S | Y | L | N | |
| diversity | 3 | 2 | 4 | 1 | 5 | 1 | 4 | 5 | 5 | 1 | 6 | 72000 |
| allowed | Q | M | E | | D | | R | N | D | | A | |
| | E | | R | | G | | E | E | W | | G | |
| | | | Y | | R | | Y | R | A | | D | |
| | | | | | Y | | | Y | R | | R | |
| | | | | | | | | | | | Y | |

TABLE 1100
CDR2 diversity (SEQ ID NO: 225)

| POSITION | 50 | 51 | 52 | 53 | 54 | 55 | 56 | Diversity |
|---|---|---|---|---|---|---|---|---|
| O12 | A | A | S | S | L | Q | S | |
| diversity | 2 | 1 | 1 | 3 | 1 | 2 | 2 | 24 |
| allowed | D | | | N | | E | T | |
| | | | | T | | | | |

TABLE 1200
Big CDR2 diversity (SEQ ID NO: 225)

| POSITION | 50 | 51 | 52 | 53 | 54 | 55 | 56 | Diversity |
|---|---|---|---|---|---|---|---|---|
| O12 | A | A | S | S | L | Q | S | |
| diversity | 4 | 1 | 4 | 6 | 1 | 4 | 5 | 1920 |
| allowed | D | | E | N | | E | T | |
| | R | | R | T | | R | Y | |
| | Y | | Y | E | | Y | R | |
| | | | | R | | | E | |
| | | | | Y | | | | |

TABLE 1300
CDR3 diversity (SEQ ID NO: 927)

| Position | 93 | 94 | 95 | 96 | 97 | 98 | 99 | 100 | 101 | div. tot. |
|---|---|---|---|---|---|---|---|---|---|---|
| O12 | Q | Q | S | Y | S | S | P | W | T | |
| diversity | 2 | 2 | 6 | 3 | 3 | 5 | 2 | 1 | 1 | 2160 |
| allowed | L | K | Y | D | N | T | S | | | |
| | | | H | N | Y | L | | | | |
| | | | F | | | Y | | | | |
| | | | A | | | F | | | | |
| | | | D | | | | | | | |

TABLE 1400
Big CDR3 diversity (SEQ ID NO: 927)

| Position | 93 | 94 | 95 | 96 | 97 | 98 | 99 | 100 | 101 | div. tot. |
|---|---|---|---|---|---|---|---|---|---|---|
| O12 | Q | Q | S | Y | S | S | P | W | T | |
| diversity | 6 | 1 | 7 | 7 | 6 | 5 | 2 | 6 | 1 | 105840 |
| allowed | L | | Y | D | N | T | S | F | | |
| | E | | H | N | Y | L | | Y | | |
| | R | | F | R | D | Y | | H | | |
| | Y | | A | A | R | F | | L | | |
| | A | | D | L | A | E | | I | | |
| | | | R | S | | R | | | | |

### Example 7

### Further Examples of Synthetic HC CDR3s

Two libraries of human Fabs (FAB-310 and FAB-410) were analyzed. The HC CDR3s of these libraries were obtained by PCR amplification of donor IgM DNA. Hence, these antibodies give a fair picture of what the immune system actually does in constructing human Abs. The primers used allowed all JHs and all VH regions to be captured.

We have collected 24,026 Abs that have been ELISA positive for at least one target from 88 targets. Of these, 19,919 have a distinct HC CDR3 amino-acid sequences. This collection excludes Abs that came from affinity maturation, since we wanted to get a true picture of what the immune system did. In addition, I excluded the Abs that turned up for two or more targets because this could mean they are sticky. This reduced the input number to 20,671 and the number of distinct Abs to 19,051 from 86 targets.

The CDR3s were analyzed in several steps. First, the last four amino acids of CDR3 and FR4 were joined and compared to the six human JH sequences at the corresponding residues. The CDR3 was assigned to the JH having the best match, with ties going to the lowest numbered JH. After the JH was decided, an algorithm determined what portion of the CDR3 came from JH. As shown in Table 221, the longest JH (JH6) has nine amino acids that precede the Trp-Gly that defines the start of FR4. Starting at position 9 and working toward position 1, the winning JH is compared to the actual amino acid of the CDR3 until either two mismatches in a act cc o amino acids occur or one of the sequences is exhausted. Table 2240 shows examples of the algorithm; in Table 2240, M means match and X means not matching. When two errors are found, the algorithm returns to the last amino acid that matched (if there was one). The matching amino acids (0 to 9) are assigned to the JHstump for that JH and the sequence is removed from the CDR3. Tabulations of the JHstumps (right aligned) are shown in Tables 225, 226, 227, 228, 229, and 2210.

JH4 (Table 228) was used because it is most used. From Table 228, we see that Y₆ is deleted most of the time. F₇ is present on only a little over 50% of the cases while D₈Y₉ are present in most of the examples. Libraries can be made in which the HC CDR3 ends with (F/x)₇D₈Y₉. F₇ can be arranged to be present, for example, 50% of the time while x represents a collection of 10 other amino-acid types often seen in DJ fill.

The remaining CDR3 residues are searched for a D segment. The longest D segment contains 12 residues. Hence we append 11 blanks before the remaining CDR3 and 11 blanks after it. We than slide each D over this sequence with the following scoring. One point is added for a match, two points are added for a second consecutive match, and three points are added for the third match. If more than three matches occur consecutively, the fourth and following are given three points. The highest scoring D segment is assigned to the CDR3. For Ds of five or fewer residues, a score of six is needed while longer Ds require 7 points to be accepted. Of 19,051 Abs, 8,572 (45%) had no identifiable D as shown in Table 20 Hlk231733126.

If there is a D segment, then the remaining CDR3 residues are divided into: a) VD fill, b) the part that came from D, and c) DJ fill. The VD fill and DJ fill may be empty. If there is no D segment, then the remainder of the CDR3 is put into “VJ fill”.

The most common D segments are 3-22.2 (1246, YYYDSSGYYY) (SEQ ID NO: 88), 3-3.2 (1205, YYDFWSYYN) (SEQ ID NO: 991), 3-10.2 (752, YYYGSGSYYN) (SEQ ID NO: 81), 6-19.1 (672, GYSSGWY) (SEQ ID NO: 218), and 6-13.1 (570, GYSSSWY) (SEQ ID NO: 215). Table 2229 shows the occurrences of fragments of D3-22.2 and Table 2230 shows the occurrences of fragments of D3-2.2. “Exact” gives the number of times that exactly this sequence occurred in the 19,051 CDR3s while “Inclusive.” gives the number of times the sequence appeared including appearances in larger fragments of the named D segment.

Because D3-22.2 is very common, libraries can be built containing YYDSSG (SEQ ID NO: 717) (with a low level of mutation) or YDSSGY (SEQ ID NO: 726). D3-3.2 is also very common and YDFWSG (SEQ ID NO: 499) and DFWSGY (SEQ ID NO: 508) occur at high frequency. Thus libraries in which these sequences are very likely are attractive. Diversity can also be generated by moving these fragments of common D segments around in the CDR3.

Table 223 shows the composition of the 19,051 CDR3s. Tyrosine is the most common amino-acid type with glycine, aspartic acid, serine, phenylalanine, alanine, and arginine following.

Alternatively, the sequences can be analyzed at the DNA level. The frequency at which each amino-acid appeared in the HC CDR3s of these 21578 Abs was tabulated and recorded in Table 75 in the columns marked overall and %. Note that the most common amino acid is Tyr (15.6%) with Gly (13.7%), Asp (12.5%), Ser (8.2%), and Arg (5.1%) following in that order. Hence, in one embodiment, the preferred amino-acid types to substitute into HC CDR3s are Y, G, D, S, and R.

Other columns in Table 75 show the frequencies of amino acids when the CDRs are dissected as follows. First the correct JH segment is determined. If part of CDR3 is derived from JH, this is removed as the “J stump”. The remainder is examined for a D segment. When matching the DNA of the D segment a scoring algorithm allots one point for a first match, adds two point for a second consecutive match, three points for a third match and four points for a forth and all subsequent matches. When a mismatch is found, the value of the next match is set back to one. A D segment is identified if more than 9 consecutive matches or found or if the score exceeds 41. With these conditions, 11,149 of 21,578 had a D segment and 10,439 did not.

If there was no D, the CDR3 is divided into VJ fill and Jstump. Note that in VJ fill, Tyr is not enriched and accounts for only 4.6% of the amino acids. In Jstump, Tyr is highly enriched, accounting for 26.5% of the amino acids.

If there is a D region, then the CDR3 is divided into VD fill (possibly empty), D, DJ fill, and Jstump (possibly empty). Tyr is prominent only in the part derived from D and Jstump. Tyr is less than 2% in VD fill and in DJ fill. One the other hand, Gly is prominent in all positions except Jstump.

Table 75 also shows that Cys (C) and Met (M) are rare. Met rises to the ˜5% level in Jstump even though the commonly used JH6 includes one M (Table 3). Amino-acid sequence analysis and DNA sequence analysis give essentially the same answer.

Table 2214 shows where each amino-acid type (AAT) is likely to be found in HC CDR3s. Table 2214 shows that the high levels of Tyr come to be in HC CDR3s only through Jstumps and D segments. The most commonly used D segments are rich in Y, G, and S. The first column lists the names of the regions, the second gives the number of times that the AAT was seen. The third column gives the number of amino acids seen. The fourth column gives the percent that is the AAT in question. The fifth column gives the number of Abs that contained the region in question, such as Jstump.

Ala is found at 4-6% in each of “VJ fill”, Jstump, VD fill, D segments, and DJ fill. Cys is very, very rare in all segments except the D segments where it is only rare, ˜1%. Asp is very common in Jstump, common in VD fill (10%) and DJ fill (8%), but only average in D segments and VJ fill. Glu is found at 3-5% in both VJ and VD fills but is otherwise rare. Phe is enriched in Jstump and otherwise rare. Gly is enriched everywhere except Jstump even though JH6 contains one Gly. His is underrepresented everywhere, but especially in Jstump and D segments. The little used JH1 contains the only His contributed by JHs. Ile is below average except in Jstump where the highly used JH3 often contributes an Ile. Note there are fewer Iles than there are examples of JH3. Lys is little used, especially in Jstump and D segment. Leu is found at average levels (−5%) except in Jstump. The only L in the JHs is in the little-used JH2. Met is little used and reaches average usage only in Jstump because of JH6. Asn is used little and reaches average usage only in DJ fill. Pro is used a little above average in DJ fill and VD fill. Gln is little used. Arg is used at about twice the average level in VJ fill, VD fill, and DJ fill, is excluded from Jstump, and is below average in D segments. Ser is very highly used in D segments, is used above average in VJ fill, VD fill, and DJ fill, and is almost excluded in Jstump. Thr is used below average and is nearly excluded in Jstump. Val is used at or below average level. Trp is used below average except in D segments where it rises to the average, 5.38%.

Tyr is very highly used only in Jstump and D segments. Tyr is used at average levels in VJ fill, and DJ fill, and is used below average in VD fill. Using D segments and J stumps as part of a library puts Ys into the library in a preconstructed context which nature has shown to be favorable to obtaining stable and specific antibodies. In addition, excluding Tyr or having it only at low level in the areas where it is rarely found provides more members that have the amino-acid types that the immune system uses in VJ fill, VD fill, and DJ fill.

Table 224 shows the distribution of lengths in the 19,051 Abs. The median length of HC CDR3 is 11.85. The shortest HC CDR3s are of length 2; SY, DL, and DM are used as examples. All of these Abs have substantial numbers of mutations in FR4 and probably should be ignored. The 32 distinct HC CDR3s with length 3 are much more normal. The longest HC CDR3 is of length 36 as shown in Table 2221 which also serves as an example of the analysis done on each of the 19,051 HC CDR3s in the collection. (The output runs to 4300 pages, never to be printed.) One can see that the final NWFDP (SEQ ID NO: 992) came from JH5, YYDFWSGY (SEQ ID NO: 993) came from D3-3.2, DTAPT (SEQ ID NO: 994) is VD fill segment, and FGSDLWRGTNQTVWYQPA (SEQ ID NO: 995) is DJ fill. Note that the DJ fill contains only one Y in 18 residues and that the VD fill contains no Ys. The notation “ie6=0” indicates that there were no errors in matching JH5 in residues 6-9 while “ie10=0” indicates there were no errors in 10-20.

The various D segments are associated with all the JHs, but there is some bias. The most common D segment is 3-22.2 (YYYDSSGYYY) (SEQ ID NO: 88) and it is associated with the JHs in 63, 42, 426, 518, 57, and 127 isolates, respectively, as shown in Table 2231. About 6.5% of all the Abs have a fragment of D3-22.2, 7.5% of these have JH4 while only 3.1% have JH6. D3-3.2 is connected to JH6 (10.3%) more often than it is to JH4 (5.0%), showing bias in the other direction.

Table 2211A and Table 2211B show the distribution of amino acids in VJ fill. Table 2211A shows the distribution for overall and P1, P2, P3, and P4. Table 2211B shows the distribution for positions P5-P8. Note that Gly is the most common at all positions. In addition,

R is always more common than K, D is more common than E, and that S is always very common. Tyrosine is seen less than 5% of the time overall and at most positions. At P1 and P2, Tyr is very rare. At P3, Tyr is up to 5.2% and at P4, Tyr reaches 7.6%. At the following positions, Tyr is close to 5% (the amount one would expect to see a random amino acid).

Libraries of the present invention comprise HC CDR3s having no preformed D segment of portion thereof. Other libraries of the present invention comprise HC CDR3s having a preformed D segment or a portion of one or a diversity pattern in which a D segment of portion thereof is the most likely sequence and the variations allowed incorporate amino acid types that are frequently observed in actual antibodies.

Library 1 version 1 can exist in three forms. In the first form, each of the amino acids named at each variable position are allowed with equal probability. In the second form, each of the amino acids is allowed, but the first name is, for example, three-times as likely as all the others which are allowed at the same frequency. In the third form, the proportions stated below are used.

Library number 1, version 1 (Biblioteca 4) The simplest form of HC CDR3 is one that does not contain a preformed D segment. In natural Abs, these tend to be shorter than those that do have D segments. Thus, a preferred antibody library could have a HC CDR3 as follows:
X₁-X₂-X₃-X₄-X₅-X₆-X₇-X₈-X₉-X₁₀-X₁₁-X₁₂-X₁₃-X₁₄ wherein
X₁ is allowed to be G, D, E, V, S, A, R, L, I, H, T, or Q with the frequencies shown in Table 2211A under P1, % (viz. G:D:V:E:A:S:R:L:I:H:T:Q::217:185:84:83:71:68:58:43:33:28:25:20 (ORCBU)) (All the percentages have been multiplied by ten to avoid having colons and decimal points);
X₂ is allowed to be G, R, S, L, P, V, A, T, D, K, N, Q, or I with the frequencies shown in Table 2211A under P2% (viz. G:R:S:L:P:V:A:T:D:K:N:Q:I::186:142:99:83:76:49:46:44:35:29:29:29:29; equivalent to 0.2123:0.1621:0.1130:0.0947:0.0868:0.0559:0.0525:0.0502:0.0400:0.0331:0.0331:0.0331:0.0331) (ORCBU);
X₃ is allowed to be G, R, S, L, A, P, Y, V, W, T, or D with the frequencies shown in Table 2211A under P3% (viz. G:R:S:L:A:P:Y:V:W:T:D::203:130:92:61:60:54:52:48:48:42:36) (ORCBU);
X₄ is allowed to be G, S, R, L, A, W, Y, V, P, T, or D with the frequencies shown in Table 2211A under P4, % (viz. G:S:R:L:A:W:Y:V:P:T:D::210:103:91:64:63:59:59:47:47:47:40 (equivalent to 0.2530, 0.1241, 0.1096, 0.0771, 0.0759, 0.0711, 0.0711, 0.0566, 0.0566, 0.0566, 0.0482) (ORCBU);
X₅ is allowed to be G, S, R, L, A, Y, W, D, T, P, or V with the frequencies shown in Table 2211B under P5, % (viz. G:S:R:L:A:Y:W:D:T:P:V::190:96:89:71:64:59:59:56:46:43:42) (ORCBU).
X₆ is allowed to be G, S, R, D, L, A, P, Y, T, W, or V with the frequencies shown in Table 2211B under P6, % (viz. G:S:R:D:L:A:P:Y:T:W:V::173:93:88:73:71:63:58:57:56:44:39) (ORCBU).
X₇ is allowed to be G, R, S, L, P, D, A, Y, T, W, V, or Δ (no amino acid) with the frequencies shown in Table 2211B under P7, % where Δ has the frequency determined by the prescribed length distribution (viz. G:R:S:L:P:D:A:Y:T:W:V:Δ::179:92:86:74:70:69:56:55:44:41:39:*) (ORCBU);
X₈ is allowed to be or G, S, R, L, D, P, Y, A, T, F, V, or Δ with the frequencies shown in Table 2211B under P8, % where Δ has the frequency determined by the length distribution (viz. G:S:R:L:D:P:Y:A:T:F:V:Δ::141:94:93:83:78:69:65:59:47:41:41:*) (ORCBU);
X₉ is the same as X₈;
X₁₀ is the same as X₈;
X₁₁ is the same as X₈;
X₁₂ is F;
X₁₃ is D;
X₁₄ is Y. The length distribution is Len9:Len10:Len11:Len12:Len13::n1:n2:n3:n4:n5. In some embodiments n1=n2=n3=n4=n5-1. In some embodiments, n1=10, n2=8, n3=6, n4=4, and n5=3. Other length distributions could be used. The proportion of Δ at each deleteable position is determined by the length distribution under the rule that each deleteable position is deleted with the same frequency. N is allowed only at the second position in HC CDR3. The frequency of N—X—(S/T) is only 0.0054 which is acceptable. One could reduce or eliminate N at the second position.

If the length distribution is, for example, Len9:Len10:Len11:Len12:Len13::1:5:7:9:8. The are four positions at which Δ can occur. We need 8 copies of xxxx (where x is an amino acid). We need 9 copies of xxxd, xxdx, xdxx, and dxxx (where d is a deletion). We need 7 copies of xxdd, xdxd, xddx, dxxd, and ddxx. We need 5 copy of xddd, dxdd, ddxd, and dddx and one copy of dddd. If we add up the items that have x in position 1 it totals (8+27+21)=56 while the items that have d in position 1 (9+14+15+1) totals 39. Thus Δ should make up 39/(39+56) of the codons at each Δ-permitting position.

FR4 would be identical to JH4. The allowed lengths are 9, 10, 11, 12, 13, and 14 and these lengths are allowed in the ratios 1:2:3:3:2:1 so that the expected median length is 11.5. The allowed diversity is 6E11. A sample of 1.E8 is likely to provide adequate representation of Abs having CDR3s in this length range and lacking D regions. A sample of 5.E8 is more preferred and a sample of 2.E9 is most preferred.

Additional preferred libraries would have a) residue 11 deleted, b) residues 10 and 11 deleted, c) a Gly inserted after residue 11, or d) Gly-Gly inserted after residue 11.

An alternative preferred embodiment is as follows:

| | |
|---|---|
| HC CDR3 library #1 Version 2 | |
| N.B. Δ means no codon. This is used at positions 8, 9, 10, and 11. | |
| The allowed lengths are 10, 11, 12, 13, and 14 and are present in the ratios | |
| 4:4:4:3:3. | |
| scab DNA \| S R D N S K N T L Y L Q M N S | (SEQ ID NO: 997) |
| 5′-ttc\|act\|atc\|TCT\|AGA\|gac\|aac\|tct\|aag\|aat\|act\|ctc\|tac\|ttg\|cag\|atg\|aac\|agC- | (SEQ ID NO: 996) |
| XbaI... | |
| L R A E D T A V Y Y C A K | |
| \|TTA\|AGg\|gct\|gag\|gaT\|aCT\|GCA\|GtT\|taT\|taC\|tgc\|gct aag- | |
| X₁-X₂-X₃-X₄-X₅-X₆-X₇-X₈-X₉-X₁₀-X₁₁-X₁₂-X₁₃ | |
| Wherein the Xs are as follows: | |
| X₁ is G:D:V:E:A:S:R:L:I:H:T:Q::217:185:84:83:71:68:58:43:33:28:25:20 | |
| Allowed: G D V E A S R L I H T Q | |
| % ages: 23.72 20.22 9.18 9.07 7.76 7.43 6.34 4.70 3.61 3.06 2.73 2.19 | |
| NNK | |
| X₂ is G:R:S:L:P:V:A:T:D:K:N:Q:I::186:142:99:83:76:49:46:44:35:29:29:29:29 | |
| Allowed: G R S L P V A T D K N Q I | |
| % ages: 21.23 16.21 11.30 9.47 8.68 5.59 5.25 5.02 4.00 3.31 3.31 3.31 3.31 | |
| NNK | |
| X₃ is G:R:S:L:A:P:Y:V:W:T:D::203:130:92:61:60:54:52:48:48:42:36 | |
| Allowed: G R S L A P Y V W T D | |
| % ages: 24.58 15.74 11.14 7.38 7.26 6.54 6.30 5.81 5.81 5.08 4.36 | |
| NNK | |
| X₄ is G:S:R:L:A:W:Y:V:P:T:D::210:103:91:64:63:59:59:47:47:47:40 | |
| Allowed: G S R L A W Y V P T D | |
| % ages: 25.30 12.41 10.96 7.71 7.59 7.11 7.11 5.66 5.66 5.66 4.82 | |
| NNK | |
| X₅ is G:S:R:L:A:Y:W:D:T:P:V::190:96:89:71:64:59:59:56:46:43:42 | |
| Allowed: G S R L A Y W D T P V | |
| % ages: 23.31 11.78 10.92 8.71 7.85 7.24 7.24 6.87 5.64 5.28 5.15 | |
| NNK | |
| X₆ is G:S:R:D:L:A:P:Y:T:W:V::173:93:88:73:71:63:58:57:56:44:39 | |
| Allowed: G S R D L A P Y T W V | |
| % ages: 21.23 11.41 10.80 8.96 8.71 7.73 7.12 6.99 6.87 5.40 4.79 | |
| NNK | |
| X₇ is G:R:S:L:P:D:A:Y:T:W:V::179:92:86:74:70:69:56:55:44:41:39 | |
| Allowed: G R S L P D A Y T W V | |
| % ages: 22.24 11.43 10.68 9.19 8.70 8.57 6.96 6.83 5.47 5.09 4.84 | |
| NNK | |
| X₈ is G:S:R:L:D:P:Y:A:T:F:V: Δ::141:94:93:83:78:69:65:59:47:41:41:* | |
| Allowed: G S R L D P Y A T F V | |
| % ages: 17.39 11.59 11.47 10.23 9.62 8.51 8.01 7.27 5.80 5.06 5.06 | |
| NNK | |
| X₉ is G:S:R:L:D:P:Y:A:T:F:V: Δ::141:94:93:83:78:69:65:59:47:41:41:811 | |
| Allowed: G S R L D P Y A T F V | |
| % ages: 17.39 11.59 11.47 10.23 9.62 8.51 8.01 7.27 5.80 5.06 5.06 | |
| NNK | |
| X₁₀ is G:S:R:L:D:P:Y:A:T:F:V: Δ::141:94:93:83:78:69:65:59:47:41:41:811 | |
| Allowed: G S R L D P Y A T F V | |
| % ages: 17.39 11.59 11.47 10.23 9.62 8.51 8.01 7.27 5.80 5.06 5.06 | |
| NNK | |
| X₁₁ is G:S:R:L:D:P:Y:A:T:F:V: Δ::141:94:93:83:78:69:65:59:47:41:41:811 | |
| Allowed: G S R L D P Y A T F V | |
| % ages: 17.39 11.59 11.47 10.23 9.62 8.51 8.01 7.27 5.80 5.06 5.06 | |
| NNK | |
| F12 D13 Y14 | |
| TTC GAT TAT | |
| W G Q G T L V T V S S | |
| tgg ggc cag ggt act ctG GTC ACC gtc tcc agt-3′ | |
| BstEII... | |

N is allowed only at the second position of HC CDR3 with a frequency of 0.0331. S and T occur at the fourth position with frequencies of 0.1241 and 0.0566. Hence, the frequency of N—X—(S/T) is 0.006 which is acceptable. The frequency of N at the second position could be reduced or eliminated.

The allowed diversity is 5.2E11. None of the designed sequences is thought to be capable of preventing the member from folding and binding to some antigen. Thus, undersampling is permissible. A library comprising 1.E6 members of this design will contain a useful diversity of binders to many targets. A library of 1.E7 is more preferred. A library of 1.E8 member of this design is even more preferred. It is not at all necessary to make 5.E11 members to obtain a valuable library.

| | |
|---|---|
| HC CDR3 library #1 Version 3 Length 9 and 10 equally likely | |
| Lengths can be 8, 9, 10, and 11; these are in the ratio 1:2:2:1 | |
| Library #1-V3 type 1 has all the allowed amino-acid types at equal | |
| likelihood; | |
| Library #1-V3 type 2 has all the allowed amino-acid types at equal likelihood | |
| except the first which is 3-times as likely at all the others; | |
| Library #1-V3 type 3 has all the allowed amino-acid types in the ratios shown | |
| below. | |
| N.B. Δ means no codon. This is used at positions 6, 7, and 8. | |
| scab DNA \| S R D N S K N T L Y L Q M N S | (SEQ ID NO: 999) |
| 5′-ttc\|act\|atc\|TCT\|AGA\|gac\|aac\|tct\|aag\|aat\|act\|ctc\|tac\|ttg\|cag\|atg\|aac\|agC- | (SEQ ID NO: 998) |
| XbaI... | |
| L R A E D T A V Y Y C A K | |
| \|TTA\|AGg\|gct\|gag\|gaT\|aCT\|GCA\|GtT\|taT\|taC\|tgc\|gct aag- | |
| X₁-X₂-X₃-X₄-X₅-X₆-X₇-X₈-X₉-X₁₀-X₁₁ | |
| Wherein the Xs are as follows: | |
| X₁ is G:D:V:E:A:S:R:L:I:H:T:Q::217:185:84:83:71:68:58:43:33:28:25:20 | |
| Allowed: G D V E A S R L I H T Q | |
| % ages: 23.72 20.22 9.18 9.07 7.76 7.43 6.34 4.70 3.61 3.06 2.73 2.19 | |
| X₂ is G:R:S:L:P:V:A:T:D:K:N:Q:I::186:142:99:83:76:49:46:44:35:29:29:29:29 | |
| Allowed: G R S L P V A T D K N Q I | |
| % ages: 21.23 16.21 11.30 9.47 8.68 5.59 5.25 5.02 4.00 3.31 3.31 3.31 3.31 | |
| X₃ is G:R:S:L:A:P:Y:V:W:T:D::203:130:92:61:60:54:52:48:48:42:36 | |
| Allowed: G R S L A P Y V W T D | |
| % ages: 24.58 15.74 11.14 7.38 7.26 6.54 6.30 5.81 5.81 5.08 4.36 | |
| X₄ is G:S:R:L:A:W:Y:V:P:T:D::210:103:91:64:63:59:59:47:47:47:40 | |
| Allowed: G S R L A W Y V P T D | |
| % ages: 25.30 12.41 10.96 7.71 7.59 7.11 7.11 5.66 5.66 5.66 4.82 | |
| X₅ is G:S:R:L:A:Y:W:D:T:P:V::190:96:89:71:64:59:59:56:46:43:42 | |
| Allowed: G S R L A Y W D T P V | |
| % ages: 23.31 11.78 10.92 8.71 7.85 7.24 7.24 6.87 5.64 5.28 5.15 | |
| X₆ is G:S:R:D:L:A:P:Y:T:W:V:0::173:93:88:73:71:63:58:57:56:44:39:* | |
| Allowed: G S R D L A P Y T W V | |
| % ages: 21.23 11.41 10.80 8.96 8.71 7.73 7.12 6.99 6.87 5.40 4.79 | |
| X₇ is the same as X₆ | |
| X₈ is the same as X₆ | |
| F9 D10 Y11 | |
| TTC GAT TAT | |
| W G Q G T L V T V S S | |
| tgg ggc cag ggt act ctG GTC ACC gtc tcc agt-3′ | |
| BstEII... | |

N is allowed only at the second position of HC CDR3 with a frequency of 0.0331. S and T occur at the fourth position with frequencies of 0.1241 and 0.0566. Hence, the frequency of N—X—(S/T) is 0.006 which is acceptable. The frequency of N at the second position could be reduced or eliminated by reducing the frequency of N or by replacing N with Q.

The allowed diversity is 3×10⁸. A library containing 1.E6 will contain binders to many targets. A library of 1.E7 is preferred. A library having 1.E8 is more preferred.

Library 2 can exist in three forms. In the first form, each of the amino acids named at each variable position are allowed with equal probability. In the second form, each of the amino acids is allowed, but the first name is, for example, three-times as likely as all the others which are allowed at the same frequency. In the third form, the proportions stated below are used.

Library number 2: An alternative preferred antibody library would have a HC CDR3 as follows:
X₁-X₂-G₃-X₄-G₅-X₆-(R/Δ)₇-X₈-X₉-X₁₀-X₁₁-X₁₂-X₁₃-X₁₄ (SEQ ID NO: 1254) wherein
X₁ is allowed to be G, D, E, V, S, A, R, L, I, H, T, or Q with the frequencies shown in Table 2211A under P1, % (viz. G:D:V:E:A:S:R:L:I:H:T:Q::217:185:84:83:71:68:58:43:33:28:25:20);
X₂ is allowed to be G, R, S, L, P, V, A, T, D, K, N, Q, or I with the frequencies shown in Table 2211A under P2% (viz. G:R:S:L:P:V:A:T:D:K:N:Q:I::186:142:99:83:76:49:46:44:35:29:29:29:29);
X₃ is G which allows the CDR3 to fold in various ways determined by the adjacent residues;
X₄ is allowed to be G, S, R, L, A, W, Y, V, P, T, or D with the frequencies shown in Table 2211A under P4, %;
X₅ is G which allows the CDR3 to fold in various ways determined by the adjacent residues;
X₆ is allowed to be G, S, R, D, L, A, P, Y, T, W, or V with the frequencies shown in Table 2211B under P6, %.
X₇ is allowed to be R or is absent with frequency determined by the length distribution;
X₈ is allowed to be or G, S, R, L, D, P, Y, A, T, F, V, or Δ with the frequencies shown in Table 2211B under P8, % where Δ has the frequency determined by the length distribution (viz. G:S:R:L:D:P:Y:A:T:F:V:Δ::141:94:93:83:78:69:65:59:47:41:41:*);
X₉ is the same as X₈;
X₁₀ is the same as X₈;
X₁₁ is the same as X₈;
X₁₂ is F;
X₁₃ is D;
X₁₄ is Y.

The length distribution is Len9:Len10:Len11:Len12:Len13:Len14::n1:n2:n3:n4:n5. In some embodiments, n1=n2=n3=n4=n5-1. The fraction of Δ at each position that allows Δ is determined by the length distribution under the rule that each deleteable position is deleted with the same frequency.

FR4 would be identical to JH4. The allowed lengths are 9, 10, 11, 12, 13, and 14 and the expectation of obtaining CDR3s of these lengths is shown in Table 2215. Keeping some positions fixed increases the level of sampling at the varied positions and may facilitate the synthesis of the DNA.

The allowed diversity is 9E8. A sample of 1.E8 is likely to provide adequate representation of Abs having CDR3s in this length range and lacking D regions. A sample of 5.E8 is more preferred and a sample of 2.E9 is most preferred.

Library 3 can exist in three forms. In the first form, each of the amino acids named at each variable position are allowed with equal probability. In the second form, each of the amino acids is allowed, but the first name is, for example, three-times as likely as all the others which are allowed at the same frequency. In the third form, the proportions stated below are used.

Library number 3: Almost half the Abs in the sample of 19,051 Fabs contained a recognizable D segment, most often only a fragment with mutations. The most common D segment in our sample is D3-22.2 which is seen 1246 times (6.5%). D3-3.2 has been seen for 72 of the 86 targets for which Abs were collected. Table 2229 shows a tally of the N-mers of D3-22.2 (YYYDSSGYYY) (SEQ ID NO: 88). Library 3 comprises 0-2 residues having the composition seen for VD fill, then the octamer YYDSSGYY (SEQ ID NO: 974) with some mutations, then one to three residues having the amino acids seen in DJ fill (Table 2217) followed by FDY from JH4. Thus one preferred antibody library would have a HC CDR3 as follows:
X₁-X₂-X₃-X₄-X₅-S₆-S₇-X₈-X₉-X₁₀-X₁₁-X₁₂-X₁₃-X₁₄-X₁₅-X₁₆ (SEQ ID NO: 1255) wherein
X₁ is allowed to be D, G, V, E, A, S, R, L, T, H, P, or Δ in the ratios shown in Table 2212A under P1, % with Δ being used at a level determined by the designed length distribution (viz. D:G:V:E:A:S:R:L:T:H:P:Δ::214:192:92:90:86:52:50:39:32:32:25:*);
X₂ is allowed to be G, R, P, L, S, A, V, T, K, D, Q, or Δ in the ratios 171:153:107:83:81:51:40:40:34:32:30:* (shown in Table 2212 under P2, % with the fraction for A being determined by the length distribution;
X₃ is allowed to be Y, G, D, R, H, P, S, L, N, A, or I (i.e. the first 11 amino acids of P2 in Table 2232A) in the ratios Y:G:D:R:H:P:S:L:N:A:I::30:1:1:1:1:1:1:1:1:1:1;
X₄ is allowed to be Y, G, S, F, L, D, E, P, A, R, or H (i.e. the first 11 amino acids of P3 in Table 2232A) in the ratios Y:G:S:F:L:D:E:P:A:R:H::30:1:1:1:1:1:1:1:1:1:1;
X₅ is D (P4 of Table 2232A);
X₆ is S (P5 of Table 2232A);
X₇ is S (P6 of Table 2232B);
X₈ allowed to be G, A, D, P, V, L, S, R, T, Y, or N (P7 of Table 2232B) in the ratios G:A:D:P:V:L:S:R:T:Y:N::30:1:1:1:1:1:1:1:1:1:1;
X₉ allowed to be Y, P, L, S, W, H, R, F, D, G, N (P8 of Table 2232B) in the ratios Y:P:L:S:W:H:R:F:D:G:N::30:1:1:1:1:1:1:1:1:1:1;
X₁₀ allowed to be Y, S, P, L, R, F, G, W, H, D, V (P9 of Table 2232B) in the ratios Y:S:P:L:R:F:G:W:H:D:V::30:1:1:1:1:1:1:1:1:1:1;
X₁₁ is G;
X₁₂ allowed to be G, P, D, R, S, L, A, N, H, T, Y, or Δ (the AAs are the first 11 from P2 of Table 2217) in the ratios G:P:D:R:S:L:A:N:H:T:Y:Δ::185:101:96:92:88:67:48:43:36:35:33:*;
X₁₃ allowed to be G, D, R, P, S, N, L, A, Y, V, T, or Δ in the ratios G:D:R:P:S:N:L:A:Y:V:T:Δ::204:103:96:78:72:67:67:45:42:36:34:*;
X₁₄ is F;
X₁₅ is D;
X₁₆ is Y.

The length distribution is Len12:Len13:Len14:Len15:Len16::n1:n2:n3:n4:n5. In some embodiments, n1=10, n2=8, n3=6, n4=5, and n5=3. Other length distributions could be used.

The allowed diversity is 3.3E9. A sample of 1.E8 is likely to provide adequate representation of Abs having CDR3s in this length range and with D 3-3.2. A sample of 5.E8 is more preferred and a sample of 2.E9 is most preferred. The allowed lengths are 12, 13, 14, 15, and 16. The prescribed distribution of lengths in Library 3 is given in Table 2219.

The median length of VD fill is 0.5 residues. Thus, 0, 1, or 2 residues are allowed before the region that encodes a mutagenized version of residues 2-8 of 3-22.2 (YYDSSGY, bold AAs are constant) (SEQ ID NO: 1000).

Because of the use of Δ, the constant DSS motif appears at different positions in the CDR3, just as it does in the sample of Fabs that I have examined. It is not necessary for any of the side groups in DSS to touch the antigen (Ag), rather these residues may help to create a structure that hold the rest of the CDR in the proper form to bind Ag. It is also possible that one or more of the side groups of DSS actually touch the Ag. In the Ab contained in PDB file 3H42, the main chain of the related fragment of D3-3.2 (YDFWSAYY, containing a G-to-A mutation) (SEQ ID NO: 1001) make a beta loop and all the side groups touch antigen or other parts of the antibody. Moving this structure relative to the beginning and end of the loop and embedding it in a variety of HC CDR½ and LC environments will produce a wide variety of binding specificities. D3-22.2 was picked over D3-3.2 partly because it occurs more often and partly because having constant DFWS (SEQ ID NO: 502) might give sticky antibodies.

Library number 4: Library 4 is similar to Library 3 but the CDR3s are longer. Table 2261A and Table 2261B show the observed lengths of CDR3s containing D3-22.2; the peak is at 13-16. Library 4 comprises 0-4 residues having the composition seen for VD fill, then the octamer YDFWSGYY (SEQ ID NO: 1002) with some mutations, then three to four residues having the amino acids seen in DJ fill followed by FDY from JH4. Thus a preferred antibody library would have a HC CDR3 as follows:
X₁-X₂-(G/Δ)₃-(G/Δ)₄-X₅-D₆-S₇-S₈-G₉-Y₁₀-X₁₁-X₁₂-X₁₃-(G/Δ)₁₄-X₁₅-X₁₆-F₁₇-D₁₈-Y₁₉ (SEQ ID NO: 1003) wherein
X₁ is allowed to be D, G, V, E, A, S, R, L, T, H, P, or Δ in the ratios shown in Table 2212A under P1, % with Δ being used with a frequency determined by the length distribution (viz. D:G:V:E:A:S:R:L:T:H:P:Δ::214:192:92:90:86:52:50:39:32:32:25:*) (as in Library 3);
X₂ is allowed to be G, R, P, L, S, A, V, T, K, D, Q, or Δ in the ratios 171:153:107:83:81:51:40:40:34:32:30:* (shown in Table 2212 under P2, % with the fraction for A being at a frequency determined by the length distribution (as in library 3);
X₃ is allowed to be G or Δ in the proportions determined by the length distribution;
X₄ is allowed to be G or Δ in the proportions determined by the length distribution
X₅ is allowed to be Y, G, S, F, L, D, E, P, A, R, or H (i.e. the first 11 amino acids of P3 in Table 2232A) in the ratios Y:G:S:F:L:D:E:P:A:R:H::30:1:1:1:1:1:1:1:1:1:1 (as in X₄ of library 3);
X₆ is D;
X₇ is S;
X₈ is S;
X₉ is G;
X₁₀ is Y;
X₁₁ allowed to be Y, S, P, L, R, F, G, W, H, D, or V in the ratios Y:S:P:L:R:F:G:W:H:D:V::50:5:5:5:5:5:5:5:5:5:5;
X₁₂ allowed to be Y, P, S, G, R, F, L, D, H, W, or V in the ratios Y:P:S:G:R:F:L:D:H:W:V::50:5:5:5:5:5:5:5:5:5:5;
X₁₃ allowed to be G, R, S, L, D, P, A, T, F, I, Y, or Δ in the ratios 5:1:1:1:1:1:1:1:1:1:1:*;
X₁₄ allowed to be G or Δ in the ratio determined by the length distribution;
X₁₅ is the same as X₁₃;
X₁₆ is the same as X₁₃;
X₁₇ is allowed to be F, G, P, S, R, D, L, A, T, N, or H in the ratios F:G:P:S:R:D:L:A:T:N:H::500:103:66:62:61:52:45:32:28:28:22 (which are the ratios shown in Table 2217 under overall (OA));
X₁₈ is D;
X₁₉ is Y.

The length distribution is Len12:Len13:Len14:Len15:Len16:Len17:Len18:Len19::n1:n2:n3:n4:n5:n6:n7:n8. In some embodiments, n1-10, n2-9, n3-8, n4-7, n5-6, n6-5, n7-5, and n8=5. Other length distributions could be used. The fraction of Δ at each deleteable position is determined by the length distribution under the rule that each deleteable position is deleted with the same frequency.

The allowed diversity is 2.6E9. A sample of 1.E8 is likely to provide adequate representation of Abs having CDR3s in this length range and with D 3-3.2. A sample of 5.E8 is more preferred and a sample of 2.E9 is most preferred. The allowed lengths are 12-19. The prescribed distribution of lengths in Library 4 is given in Table 2220; alternatively, one could use other distributions of length, for example, 0.2:0.2:0.1:0.1:0.1:0.1:0.1:0.1 would give a median length of 14.

Library Number 5: The segment D4-17.2 is found rather often (386/19,051 or 2%) and is short (DYGDY) (SEQ ID NO: 195). Even though both DY and YD are found in D segments, DY is more common in CDR3s than is YD. D4-17.2 contains two DY dipeptices. Hence, a preferred library has a CDR3 comprising 0-2 amino acids, followed by DYGDY (SEQ ID NO: 195) (with the underlined residues constant), followed by 0-2 amino acids followed by AFDI (SEQ ID NO: 1004) of JH3 (with the underlined residues constant). Table 2280 shows a tally of the 386 D4-17.2 fragments found in our sample of Abs. The identities of the amino-acid types allowed at position 10 are taken from position 17 of Library 4 and the frequencies picked to make A the most common amino-acid type. The distributions at positions 1 and 5 were used to pick the amino-acid types used at positions 3 and 7 of the library. FR4 is identical to the FR4 part of JH3. That is, CDR3 is
X₁-X₂-X₃-Y₄-G₅-D₆-X₇-X₈-X₉-X₁₀-F₁₁-D₁₂-I₁₃ (SEQ ID NO: 1263) wherein
X₁ is allowed to be D, G, V, E, A, S, R, L, T, H, P, or Δ in the ratios shown in Table 2212A under P1, % with Δ being used at a frequency determined by the length distribution (viz. D:G:V:E:A:S:R:L:T:H:P:Δ::214:192:92:90:86:52:50:39:32:32:25:*);
X₂ is allowed to be G, R, P, L, S, A, V, T, K, D, Q, or Δ in the ratios 171:153:107:83:81:51:40:40:34:32:30:* (shown in Table 2212 under P2, % with the fraction for A being determined by the length distribution);
X₃ is D, G, P, L, S, N, A, H, F, R, T, or V in the ratios D:G:P:L:S:N:A:H:F:R:T:V::10:1:1:1:1:1:1:1:1:1:1:1;
Y₄ is Y;
G₅ is G;
D₆ is D;
X₇ is allowed to be Y, F, L, S, H, G, P, A, R, D, or E in the ratios Y:F:L:S:H:G:P:A:R:D:E::10:1:1:1:1:1:1:1:1:1:1;
X₈ is allowed to be G, R, S, L, D, P, A, T, F, I, Y, or Δ in the ratios 5:1:1:1:1:1:1:1:1:1:1:*;
X₉ is the same as X₈;
X₁₀ is allowed to be A, F, G, P, S, R, D, L, T, N, or H, in the ratios 10:1:1:1:1:1:1:1:1:1:1;
F₁₁ is F;
D₁₂ is D; and
I₁₃ is I.

The allowed lengths are 9, 10, 11, 12, and 13. The distribution of lengths is as shown in Table 2219 if 3 is subtracted from each length in the table. For example, the length 12 in Table 2219 corresponds to the length 9 in Library 5. The allowed diversity is 3.0E7. A construction that contains 3.0E8 transformants will contain essentially the full diversity of the library. About one quarter of the members will contain the full DYGDY (SEQ ID NO: 195) sequence; ¼ will contain DYGDx (x not Y) (SEQ ID NO: 1005), ¼ will contain xYGDY (x not D) (SEQ ID NO: 1006), and ¼ will contain xYGDx (1^{st} x not D, 2^{nd} x not Y). Because Δ is allowed at four positions that bracket DYGDY (SEQ ID NO: 195), DYGDY (SEQ ID NO: 195) is allowed in nine contexts: xxDYGDYxxxFDI (L=13) (SEQ ID NO: 1007), xxDYGDYxxFDI (L=12) (SEQ ID NO: 1008), xxDYGDYxFDI (L=11) (SEQ ID NO: 1009), xDYGDYxxxFDI (L=12) (SEQ ID NO: 1010), xDYGDYxxFDI (L=11) (SEQ ID NO: 1011), xDYGDYxFDI (L=10) (SEQ ID NO: 1012), DYGDYxxxFDI (L=11) (SEQ ID NO: 1013), DYGDYxxFDI (L=10) (SEQ ID NO: 1014), and DYGDYxFDI (L=9) (SEQ ID NO: 1015).

Other libraries could be built in which, for example, fragments of 6-19.1 (GYSSGWY) (SEQ ID NO: 218) or 6-13.1 (GYSSSWY) (SEQ ID NO: 215) are included with some degree of diversity. These D segments occur in a notable fraction of natural antibodies and lend themselves to Abs with HC CDR3s in the 10-14 range. It is likely to be easier to build libraries with shorter CDR3s. In these libraries, one or two of the residues constant. For example, S₃, S₄, and W₆ can be kept constant while allowing a diversity at the other positions. In addition, by having, for example, 0-2 amino acids before the D segment, and, for example, no amino acids between D and J, the D segment can appear at different positions. In a preferred embodiment, JH2 is used with XFDL Jstump (where X is biased toward Y). This gives CDR3s from 11 to 13 in length. Table 2273 shows the frequencies of the AATs in D6-13.1, D6-19.1, and the composite of these very similar D segments.

Library number 6: Library 6 incorporates a composite of 6-19.1 (GYSSGWY) (SEQ ID NO: 218) and 6-13.1 (GYSSSWY) (SEQ ID NO: 215) joined to JH2. Thus, a preferred library will have X₁-X₂-X₃-X₄-S₅-S₆-X₇-W₈-X₉-X₁₀-F₁₁-D₁₂-L₁₃ (SEQ ID NO: 1016) wherein:
X₁ is allowed to be D, G, V, E, A, S, R, L, T, H, P, or Δ in the ratios shown in Table 2212A under P1, % with Δ being used at a frequency determined by the length distribution (viz. D:G:V:E:A:S:R:L:T:H:P:Δ::214:192:92:90:86:52:50:39:32:32:25:*);
X₂ is allowed to be G, R, P, L, S, A, V, T, K, D, Q, or Δ in the ratios 171:153:107:83:81:51:40:40:34:32:30:* (shown in Table 12 under P2, % with the fraction for A being determined by the length distribution);
X₃ is allowed to be G, P, R, S, T, W, A, D, L, E, or K in the ratios 10:1:1:1:1:1:1:1:1:1:1;
X₄ is allowed to be Y, G, D, R, S, F, A, V, P, L, or E in the ratios 10:1:1:1:1:1:1:1:1:1:1;
S₅ is S;
S₆ is S;
X₇ is allowed to be S, G, R, D, N, P, A, V, Y, T, or L in the ratios 10:10:1:1:1:1:1:1:1:1:1;
W₈ is W;
X₉ is allowed to be Y, S, G, D, P, R, A, F, H, K, or T in the ratios 10:1:1:1:1:1:1:1:1:1:1;
X₁₀ is allowed to be Y, P, S, G, R, L, T, F, A, D, or K in the ratios 10:1:1:1:1:1:1:1:1:1:1;
F₁₁ is F;
D₁₂ is D;
L₁₃ is L.

Because two positions allow deletion, the lengths can be 11, 12, or 13 that a length distribution of Len11:Len12:Len13::1:2:1 corresponds to 50% deletion at each deleteable position. The length distribution is, for example, Len11:Len12:Len13::1:5:7. There are 2 positions at which Δ can occur. We need 7 copies of xx (where x is an amino acid). We need 5 copies of xd and dx (where d is a deletion). We need 1 copies of dd. If we add up the items that have x in position 1 it totals (7+5)=12 while the items that have d in position 1 is (5+1)=6. Thus Δ should make up 6/(6+12)=0.333 of the codons at each Δ-permitting position.

The possible conformations are xxGYSS(G/S) WYxFDL (L=13) (SEQ ID NO: 1017), xGYSS(G/S) WYxFDL (L=12) (SEQ ID NO: 1018), or GYSS(G/S) WYxFDL (L=11) (SEQ ID NO: 1019). The underscored amino acids are constant. In the GYSS(G/S) WY (SEQ ID NO: 1020), the amino acids that are not underscored are varied so that about ½ of the members have the AA shown. The other ten types were picked from Table 2273. All of the other AAs were given the same proportion. In this library, FR3 end with a fixed K₉₄. FR4 is from JH2: WGRGTLVTVSS (SEQ ID NO: 1021). This avoids the somewhat troublesome GQG sequence found in other JHs. The allowed diversity is 2.3E7.

Alternatively, the library could have:
X₁₀ is allowed to be Y, P, S, G, R, L, T, F, A, D, K, or Δ in the ratios 10:1:1:1:1:1:1:1:1:1:1:20. This allows the length to be 10, 11, 12, or 13 in the ratios 1:3:3:1. The conformations are xxGYSS(G/S)WYxFDL (L=13) (SEQ ID NO: 1022), xGYSS(G/S)WYxFDL (L=12) (SEQ ID NO: 1023), GYSS(G/S)WYxFDL (L=11) (SEQ ID NO: 1024), xxGYSS(G/S)WYFDL (L=12) (SEQ ID NO: 1025), xGYSS(G/S)WYFDL (L=11) (SEQ ID NO: 1026), or GYSS(G/S)WYFDL (L=10) (SEQ ID NO: 1027). The allowed diversity is 2.5E7. A sample of 2.E8 is adequate, but a sample of 1.E9 is preferred.

Library Number 7: Library 7 contains a variegated version of D2-15.2 (GYCSGGSCYS) (SEQ ID NO: 1028) with variability in the number of residues before and after the D segment. There will be 0-2 amino acids, D2-15.2, 0-2 amino acids, and FDL; FR4 is identical to JH2 (so that we do not have GQG). In this library, CDR3 comprises X₁-X₂-X₃-X₄-C₅-X₆-X₇-X₈-X₉-C₁₀-X₁₁-X₁₂-X₁₃-X₁₄-F₁₅-D₁₆-L₁₇ (SEQ ID NO: 1267) wherein:
X₁ is allowed to be D, G, V, E, A, S, R, L, T, H, P, or Δ in the ratios shown in Table 2212A under P1, % with Δ being used at a frequency determined by the length distribution (viz. D:G:V:E:A:S:R:L:T:H:P:Δ::214:192:92:90:86:52:50:39:32:32:25:*);
X₂ is allowed to be G, R, P, L, S, A, V, T, K, D, Q, or Δ in the ratios 171:153:107:83:81:51:40:40:34:32:30:* (shown in Table 12 under P2, % with the fraction for A being determined by the length distribution);
X₃ is allowed to be G, R, P, S, T, E, H, V, Y, A, L, or Δ in the ratios 20:1:1:1:1:1:1:1:1:1:1:*;
X₄ is allowed to be Y, D, G, H, P, N, R, S, V, A, or L in the ratios 20:1:1:1:1:1:1:1:1:1:1;
C₅ is Cys;
X₆ is allowed to be S, G, D, R, T, Y, F, L, N, V, or Win the ratios 20:1:1:1:1:1:1:1:1:1:1;
X₇ is allowed to be G, S, D, R, T, Y, F, L, N, V, or W in the ratios 20:20:1:1:1:1:1:1:1:1:1;
X₈ is allowed to be G, T, D, R, S, Y, F, L, N, V, or W in the ratios 20:20:1:1:1:1:1:1:1:1:1;
X₉ is allowed to be S, G, T, D, R, Y, F, L, N, V, or Win the ratios 20:1:1:1:1:1:1:1:1:1:1;
C₁₀ is Cys;
X₁₁ is allowed to be Y, F, W, D, R, S, H, A, L, N, or K in the ratios 20:1:1:1:1:1:1:1:1:1:1;
X₁₂ is allowed to be S, G, T, R, A, D, Y, W, P, L, F, or Δ in the ratios 20:1:1:1:1:1:1:1:1:1:1:*;
X₁₃ is allowed to be G, R, S, L, D, P, A, T, F, I, Y, or Δ in the ratios 5:1:1:1:1:1:1:1:1:1:1:*;
X₁₄ is the same as X₁₃;
F₁₅ is Phe;
D₁₆ is Asp; and
L₁₇ is Leu.

The length distribution is Len11:Len12:Len13:Len14:Len15:Len16:Len17::n1:n2:n3:n4:n5:n6:n7. In some embodiments, n1=n2=n3=n4=n5=n6=n7-1. A length distribution of n1-1, n2-2, n3-4, n4-5, n5-4, n6-3, n7-2 gives a median length between 13 and 14. Other length distributions can be used.

Although seventeen positions are named, six of them can be absent. Thus, the allowed lengths are 11, 12, 13, 14, 15, 16, and 17. The allowed diversity is 5.4E12. A library containing 1.E8 of the allowed sequences will give a useful diversity. A library containing 1.E9 is more preferred. The presence of a constant pair of cysteine residues will impose structural constraints and will affect the binding properties of the Abs.

The disulfide-closed loop can appear in 16 contexts: 1) xxXXCXXXXCXXxxFDL (SEQ ID NO: 1029), 2) xXXCXXXXCXXxxFDL (SEQ ID NO: 1030), 3) XXCXXXXCXXxxFDL (SEQ ID NO: 1031), 4) XCXXXXCXXxxFDL (SEQ ID NO: 1032), 5) xxXXCXXXXCXXxFDL (SEQ ID NO: 1033), 6) xXXCXXXXCXXxFDL (SEQ ID NO: 1034), 7) XXCXXXXCXXxFDL (SEQ ID NO: 1035), 8) XCXXXXCXXxFDL (SEQ ID NO: 1036), 9) xxXXCXXXXCXXFDL (SEQ ID NO: 1037), 10) xXXCXXXXCXXFDL (SEQ ID NO: 1038), 11) XXCXXXXCXXFDL (SEQ ID NO: 1039), 12) XCXXXXCXXFDL (SEQ ID NO: 1040), 13) xxXXCXXXXCXFDL (SEQ ID NO: 1041), 14) xXXCXXXXCXFDL (SEQ ID NO: 1042), 15) XXCXXXXCXFDL (SEQ ID NO: 1043), and 16) XCXXXXCXFDL (SEQ ID NO: 1044).

The identities of amino-acid types to allow at positions 3-12 are taken from Table 2293 which shows the tallies of types for D2-15.2, D2-2.2, and the composite of these two.

### Example 50

### A Having No D Segments in HC CDR3

The object of the present example is to provide a library of human Abs having sufficient diversity that bioactive antibodies with affinities below 10 nM can be selected for almost any protein target. The methods of improving the performance of the Ab library are two fold: a) the length of HC CDR3s having no D segment is shorter than has been stated in the literature (9.5 vs 12.5), and b) the amino-acid distribution will be closer to that seen in Abs that do not have D segments.

Analysis of 19,051 Abs from FAB-310 or FAB-410 showed that 5,523 (over ¼) had no discernable D segment (i.e. there were not three consecutive AAs that could have come from a D segment). Although the median length of all the HC CDR3s is close to 12, the Abs that lack a D segment have a median length of 9.3 AAs. The distribution of AATs is also very different for the D-less Abs. In the overall population of HC CDR3s, Tyr is the most common AAT. In the D-less population, Tyr is present at only about 2.5% and Gly is the most common AAT. Met and Cys are essentially absent from the D-less population. The distribution is position dependent. That is, the frequency of AATs at the first position of HC CDR3 is different from that at position 2 which is different from position 3 etc.

The Abs of the present invention could be displayed on phage, phagemid, or yeast. The diversity described could be embodied in Fabs, scFvs, or Igs (such as IgG, IgM, IgA, etc.).

The proposed antibody (Ab) libraries will have Fabs displayed on phagemid or phage. All of the diversity will be synthetic. All the heavy chain (HC) frameworks will be 3-23 and all the light chain (LC) frameworks will be A27.

At each variable position, eleven or more amino-acid types will be allowed.

HC Diversity:

The HC diversity in complementarity determining region 1 (CDR1) will be at positions 31, 33, and 35, which are allowed to be any amino-acid types (AAT) except Cys or Met giving 5,832 variants. CDR2 will vary at positions 50, 52, 52a, 56, and 58. At positions 50, 52, 56, and 58, all AATs except Cys and Met. At each of these positions in CDR1 and CDR2, the germline (GL) AAT will be 3× more likely than the non-GL AATs. At position 52a, we allow GPSY with equal likelihood. This gives 419,904 CDR2 variants. The diversity allowed in HC CDR1-2 is 2.45E9. There is a unique site between CDR1 and CDR2 (BstXI) so that one can introduce diversity into one or the other if desired. If we make only 1.E8 isolates, we get only about 4% of the allowed diversity (as shown in Table 200). We do get all the CDR1 diversity and we get all the CDR2 diversity, but not all the combinations. Thus, if we have a distinct restriction site between CDR1 and CDR2, we can put the diversity of CDR1 into a selectant and test all the combinations with the selected CDR2 and vise versa for putting the diversity of CDR2 into a selected Ab.

TABLE 200
Expected actual diversity of CDR1/2 vs number of isolates

| Nisolates | 1.00E+08 | 2.00E+08 | 5.00E+08 | 1.00E+09 |
|---|---|---|---|---|
| Nd | 9.80E+07 | 1.92E+08 | 4.52E+08 | 8.21E+08 |
| fraction | 0.039995 | 0.07839 | 0.184604 | 0.33513 |

HC CDR3 diversity is a sublibrary in which there is no D segment, the allowed lengths are 8-11, and the median length is 9.5 (allowed diversity 3.61E8, actual diversity 2.71E8 (assuming Poisson statistics and 5E8 isolates (75% sampling)). Table 201 shows the number of distinct CDR3 (Nd) that can be expected for various numbers of isolates (Nisolates).

TABLE 201
Expected actual diversity of CDR3 vs number of isolates

| Nisolates | 1.00E+08 | 2.00E+08 | 3.00E+08 | 5.00E+08 | 1.00E+09 |
|---|---|---|---|---|---|
| Nd | 8.74E+07 | 1.54E+08 | 2.04E+08 | 2.71E+08 | 3.39E+08 |
| fraction | 0.241777 | 0.425099 | 0.564097 | 0.749399 | 0.937199 |

Table 202 shows the distribution of amino-acid types (AAT) that can be used into one embodiment of HC CDR3. In another embodiment, each AAT that has a non-zero entry in Table 3 will have the same probability as all other AATs having non-zero entries at that position. These were picked to be the 11 or 12 most often seen AATs at each position in Abs that have no discernable D segment. The numbers were adjusted to alter the frequencies of certain i:i+1, i:i+2, and i:i+3 duplets. The AAT “-” shown for positions 100, 101, and 102 means that no amino acid is there and the CDR3 is shorter. The fractional omission of amino acids at these ratios give the lengths 8:9:10:11 roughly in the ratio 1:2:2:1.

TABLE 202
LC CDR3 diversity

| | Position | | | | | | | | | | |
|---|---|---|---|---|---|---|---|---|---|---|---|
| AAT | 95 | 96 | 97 | 98 | 99 | 100 | 101 | 102 | 102A | 102B | 102C |
| A | 0.0799 | 0.0774 | 0.0728 | 0.0721 | 0.0774 | 0.0364 | 0.0364 | 0.0364 | 0 | 0 | 0 |
| C | 0.0 | 0.0 | 0.0 | 0.0 | 0.0 | 0.0 | 0.0 | 0.0 | 0 | 0 | 0 |
| D | 0.1305 | 0.0753 | 0.1411 | 0.1517 | 0.1653 | 0.0779 | 0.0779 | 0.0779 | 0 | 1.0 | 0 |
| E | 0.0 | 0.0 | 0.0 | 0.0 | 0.0 | 0.0 | 0.0 | 0.0 | 0 | 0 | 0 |
| F | 0.0 | 0.0759 | 0.0 | 0.0 | 0.0 | 0.0 | 0.0 | 0.0 | 1.0 | 0 | 0 |
| G | 0.0942 | 0.0865 | 0.0859 | 0.0874 | 0.0931 | 0.0439 | 0.0439 | 0.0439 | 0 | 0 | 0 |
| H | 0.0538 | 0.0 | 0.0508 | 0.0495 | 0.0626 | 0.0295 | 0.0295 | 0.0295 | 0 | 0 | 0 |
| I | 0.0 | 0.0 | 0.0 | 0.0 | 0.0 | 0.0 | 0.0 | 0.0 | 0 | 0 | 0 |
| K | 0.0 | 0.0 | 0.0 | 0.0 | 0.0 | 0.0 | 0.0 | 0.0 | 0 | 0 | 0 |
| L | 0.1144 | 0.1042 | 0.1023 | 0.0965 | 0.1134 | 0.0534 | 0.0534 | 0.0534 | 0 | 0 | 0 |
| M | 0.0 | 0.0 | 0.0 | 0.0 | 0.0 | 0.0 | 0.0 | 0.0 | 0 | 0 | 0 |
| N | 0.0673 | 0.0 | 0.0635 | 0.0777 | 0.0565 | 0.0266 | 0.0266 | 0.0266 | 0 | 0 | 0 |
| P | 0.1460 | 0.1572 | 0.1408 | 0.1111 | 0.1165 | 0.0549 | 0.0549 | 0.0549 | 0 | 0 | 0 |
| Q | 0.0 | 0.0 | 0.0 | 0.0 | 0.0 | 0.0 | 0.0 | 0.0 | 0 | 0 | 0 |
| R | 0.1447 | 0.1351 | 0.1319 | 0.1407 | 0.1404 | 0.0661 | 0.0661 | 0.0661 | 0 | 0 | 0 |
| S | 0.0748 | 0.0658 | 0.0658 | 0.0659 | 0.0735 | 0.0346 | 0.0346 | 0.0346 | 0 | 0 | 0 |
| T | 0.0 | 0.0776 | 0.0551 | 0.0542 | 0.0565 | 0.0266 | 0.0266 | 0.0266 | 0 | 0 | 0 |
| V | 0.0544 | 0.0484 | 0.0500 | 0.0532 | 0.0 | 0.0 | 0.0 | 0.0 | 0 | 0 | 0 |
| W | 0.0 | 0.0565 | 0.0 | 0.0 | 0.0 | 0.0 | 0.0 | 0.0 | 0 | 0 | 0 |
| Y | 0.0400 | 0.0401 | 0.0401 | 0.0401 | 0.0449 | 0.0212 | 0.0212 | 0.0212 | 0 | 0 | 1.0 |
| — | 0.0 | 0.0 | 0.0 | 0.0 | 0.0 | 0.5290 | 0.5290 | 0.5290 | 0 | 0 | 0 |

LC Diversity

All the LCs will have A27 (VK-III) frameworks (Table 204). Variation is allowed at positions 27, 28, 30, 31, 31a, 32, and 34 of CDR1. Variation is allowed at positions 50, 53, and 56 of CDR2. Variation is allowed at positions 91-96 of CDR3. JK4 and JK3 are preferred. The allowed diversity is 4.6E16. The actual diversity should be greater than 1.E8. Eleven or more AATs are allowed at each variable position with the GL AAT being more likely than each of the other ten AATs. A unique site (XhoI) has been engineered between CDR2 and CDR3 so that CDR1-2 and CDR3 can be manipulated separately. A unique SacII site is between CDR1 and CDR2.

Table 209 shows a distribution to be used to introduce diversity into LC CDR1 in one embodiment. In another embodiment, each AAT that has a non-zero entry in Table 209 is used with the same frequency as every other AAT having a non-zero entry. Table 210 shows a distributions for LC CDR2 for one embodiment. In another embodiment, each AAT having a non-zero entry in Table 210 is used at the same frequency as all other AATs having non-zero entries in Table 210. Table 211 shows a distribution for LC CDR3 that is used in one embodiment. In another embodiment, the AATs having non-zero entries are used at the same frequency. Table 212 shows the amount of diversity allowed in each LC CDR.

Table 213 shows the annotated DNA sequence of the vector pM21J. The un-annotated DNA sequence is found in Table 215.

TABLE 204
LC backbone
The amino acid sequence disclosed in Table 204 is SEQ ID NO: 1046.
The DNA sequence disclosed in Table 204 is SEQ ID NO: 1045.

| | |
|---|---|
| 2233 | AAGCTT tggagccttttttttggagattttcaac |
| | HindIII |
| | signal sequence-------------------------------------------- |
| | 1 2 3 4 5 6 7 8 9 10 11 12 13 14 15 |
| | M K K L L S A I P L V V P F Y |
| 2269 | \|atg\|aaG\|aaA\|ctg\|ctg\|tct\|gct\|atc\|ccA\|CTA\|GTt\|gtc\|cct\|ttc\|tat\| |
| | SpeI.... |
| | Signal------- FR1------------------------------------------- |
| | 16 17 18 19 20 21 22 23 24 25 26 27 28 29 30 |
| | S H S E1 I V3 L T5 Q S7 P G9 T L S12 |
| 2314 | \|tct\|cat\|agt\|gaa\|atc\|gtt\|ctg\|acc\|cag\|tcC\|CCG\|GGG\|aCC\|Ctg\|tct\| |
| | XmaI.... |
| | PpuMI.... |
| | FR1---------------------------------------- CDR1----------- |
| | 31 32 33 34 35 36 37 38 39 40 41 42 43 44 45 |
| | L13 S P G E R A T L S C23 R24 A S Q |
| 2359 | \|ctg\|tct\|ccg\|ggt\|gaa\|cgt\|gct\|acG\|CTg\|AGC\|tgt\|cgt\|gct\|tct\|caa\| |
| | BlpI..... |
| | CDR1--------------------------- FR2------------------------ |
| | 46 47 48 49 50 51 52 53 54 55 56 57 58 59 60 |
| | S28 V S S31 S31a Y L A34 W Y Q Q K P G |
| 2404 | \|tcc\|gtt\|agC\|TCC\|TCt\|tat\|tta\|gct\|tgg\|tat\|cag\|caa\|aag\|ccg\|ggt\| |
| | FR2---------------------------- CDR2----------------------- |
| | 61 62 63 64 65 66 67 68 69 70 71 72 73 74 75 |
| | Q A P R45 L L I Y G50 A S S R A T56 |
| 2449 | \|caa\|gct\|CCG\|CGG\|ctg\|ttg\|atc\|tat\|ggt\|gcc\|tct\|agt\|cgt\|gct\|act\| |
| | SacII.. |
| | FR3------------------------------------------------------- |
| | 76 77 78 79 80 81 82 83 84 85 86 87 88 89 90 |
| | G I P D60 R F S G S65 G S G T D F |
| 2494 | \|ggc\|atc\|cct\|gat\|cgt\|ttc\|tct\|ggc\|tct\|ggc\|tct\|ggc\|acc\|gat\|ttc\| |
| | FR3------------------------------------------------------- |
| | 91 92 93 94 95 96 97 98 99 100 101 102 103 104 105 |
| | T L T I S R L E P E D F A V Y |
| 2539 | \|act\|ctg\|acc\|att\|tct\|cgt\|CTC\|GAG\|ccg\|gaa\|gat\|ttc\|gct\|gtc\|tac\| |
| | XhoI... |
| | FR3---- CDR3------------------------------ FR4----------- |
| | 106 107 108 109 110 111 112 113 114 115 116 117 118 119 120 |
| | Y C Q89 Q Y G S S P95 L T F G G G |
| 2584 | \|tat\|tgt\|caa\|cag\|tat\|ggt\|tct\|agt\|ccg\|ctg\|act\|ttc\|ggt\|ggc\|GGT\| |
| | KpnI... |
| | FR4-------------------- JK4 |
| | 121 122 123 124 125 126 |
| | T K V E I K |
| 2629 | \|ACC\|aaa\|gtc\|gaa\|atc\|aag |
| | KpnI. |
| | Ckappa---------------------------------------------------- |
| | R G T V A A P S V F I F P P S |
| 2647 | cgt gga act gtg get gca cca tct gtc ttc atc ttc ccg cca tct |
| | D E Q L K S G T A S V V C L L |
| 2692 | gat gag cag ttg aaa tct gga act gcc tct gtt gtg tgc ctg ctg |
| | N N F Y P R E A K V Q W K V D |
| 2737 | aat aac ttc tat ccc aga gag gcc aaa gta cag tgg aag gtg gat |
| | N A L Q S G N S Q E S V T E Q |
| 2782 | aac gcc ctc caa tcg ggt aac tcc cag gag agt gtc aca gag cag |
| | D S K D S T Y S L S S T L T L |
| 2827 | gac agc aag gac agc acc tac agc ctc agc agc acc ctg act ctg |
| | S K A D Y E K H K V Y A C E V |
| 2872 | tcc aaa gca gac tac gag aaa cac aaa GTC TAC gcc tgc gaa gtc |
| | T H Q G L S S P V T K S F N R |
| 2917 | acc cat cag ggc ctg agt tCA CCG GTG aca aag agc ttc aac agg |
| | SgrAI..... |
| | G E C . . |
| 2962 | gga gag tgt taa taa |
| 2977 | GG CGCGCC |
| | AscI..... |
| | BssHII. |

TABLE 209
LC CDR1

| | Positions in VK CDR1 | | | | | | | | | | | |
|---|---|---|---|---|---|---|---|---|---|---|---|---|
| | 24 | 25 | 26 | 27 | 28 | 29 | 30 | 30a | 31 | 32 | 33 | 34 |
| A | 0 | 1.0 | 0 | 0.02 | 0.02 | 0 | 0.02 | 0.0185 | 0.02 | 0 | 0 | 1.0 |
| C | 0 | 0 | 0 | 0 | 0 | 0 | 0 | 0 | 0 | 0 | 0 | 0 |
| D | 0 | 0 | 0 | 0.02 | 0.02 | 0 | 0.07 | 0.0185 | 0.07 | 0.02 | 0 | 0 |
| E | 0 | 0 | 0 | 0.07 | 0 | 0 | 0 | 0 | 0 | 0 | 0 | 0 |
| F | 0 | 0 | 0 | 0 | 0.02 | 0 | 0.02 | 0 | 0 | 0.07 | 0 | 0 |
| G | 0 | 0 | 0 | 0.02 | 0.07 | 0 | 0.07 | 0.0648 | 0.07 | 0 | 0 | 0 |
| H | 0 | 0 | 0 | 0.07 | 0 | 0 | 0 | 0.0185 | 0.02 | 0.07 | 0 | 0 |
| I | 0 | 0 | 0 | 0 | 0.07 | 0 | 0.02 | 0.0648 | 0.02 | 0 | 0 | 0 |
| K | 0 | 0 | 0 | 0.02 | 0 | 0 | 0 | 0 | 0.02 | 0.02 | 0 | 0 |
| L | 0 | 0 | 0 | 0.07 | 0 | 0 | 0 | 0 | 0 | 0.02 | 1.0 | 0 |
| M | 0 | 0 | 0 | 0 | 0 | 0 | 0 | 0 | 0 | 0 | 0 | 0 |
| N | 0 | 0 | 0 | 0.02 | 0.07 | 0 | 0.07 | 0.0648 | 0.07 | 0.07 | 0 | 0 |
| P | 0 | 0 | 0 | 0.07 | 0.02 | 0 | 0.02 | 0.0185 | 0 | 0 | 0 | 0 |
| Q | 0 | 0 | 0 | 0.55 | 0 | 0 | 0 | 0 | 0 | 0.07 | 0 | 0 |
| R | 1.0 | 0 | 0 | 0.07 | 0.07 | 0 | 0.07 | 0.0648 | 0.07 | 0.02 | 0 | 0 |
| S | 0 | 0 | 1.0 | 0 | 0.55 | 0 | 0.55 | 0.5093 | 0.55 | 0.07 | 0 | 0 |
| T | 0 | 0 | 0 | 0 | 0.07 | 0 | 0.07 | 0.0648 | 0.07 | 0 | 0 | 0 |
| V | 0 | 0 | 0 | 0 | 0 | 1.0 | 0 | 0 | 0 | 0 | 0 | 0 |
| W | 0 | 0 | 0 | 0 | 0 | 0 | 0 | 0 | 0 | 0.02 | 0 | 0 |
| Y | 0 | 0 | 0 | 0 | 0.02 | 0 | 0.02 | 0.0185 | 0.02 | 0.55 | 0 | 0 |
| — | 0 | 0 | 0 | 0 | 0 | 0 | 0 | 0.0741 | 0 | 0 | 0 | 0 |

Allowed diversity = 1.93E+06

TABLE 210
LC CDR2

| | Position in CDR2 | | | | | | |
|---|---|---|---|---|---|---|---|
| | 50 | 51 | 52 | 53 | 54 | 55 | 56 |
| A | 0.07 | 1.0 | 0 | 0 | 0 | 1.0 | 0.07 |
| C | 0 | 0 | 0 | 0 | 0 | 0 | 0 |
| D | 0.07 | 0 | 0 | 0.02 | 0 | 0 | 0.02 |
| E | 0.02 | 0 | 0 | 0 | 0 | 0 | 0 |
| F | 0 | 0 | 0 | 0.02 | 0 | 0 | 0 |
| G | 0.55 | 0 | 0 | 0.02 | 0 | 0 | 0.02 |
| H | 0.07 | 0 | 0 | 0.02 | 0 | 0 | 0.02 |
| I | 0 | 0 | 0 | 0.07 | 0 | 0 | 0.07 |
| K | 0.02 | 0 | 0 | 0.07 | 0 | 0 | 0.07 |
| L | 0.02 | 0 | 0 | 0 | 0 | 0 | 0 |
| M | 0 | 0 | 0 | 0 | 0 | 0 | 0 |
| N | 0.02 | 0 | 0 | 0.07 | 0 | 0 | 0.02 |
| P | 0 | 0 | 0 | 0 | 0 | 0 | 0.07 |
| Q | 0 | 0 | 0 | 0 | 0 | 0 | 0 |
| R | 0.07 | 0 | 0 | 0.07 | 1.0 | 0 | 0.02 |
| S | 0.07 | 0 | 1.0 | 0.55 | 0 | 0 | 0.07 |
| T | 0 | 0 | 0 | 0.07 | 0 | 0 | 0.55 |
| V | 0.02 | 0 | 0 | 0 | 0 | 0 | 0 |
| W | 0 | 0 | 0 | 0 | 0 | 0 | 0 |
| Y | 0 | 0 | 0 | 0.02 | 0 | 0 | 0 |
| — | 0 | 0 | 0 | 0 | 0 | 0 | 0 |

Diversity = 1.3310E+03

TABLE 211
LC CDR3

| | Position | | | | | | | | |
|---|---|---|---|---|---|---|---|---|---|
| AAT | 89 | 90 | 91 | 92 | 93 | 94 | 95 | 96 | 97 |
| A | 0 | 0 | 0.07 | 0.07 | 0.0192 | 0.07 | 0.02 | 0 | 0 |
| C | 0 | 0 | 0 | 0 | 0 | 0 | 0 | 0 | 0 |
| D | 0 | 0 | 0.02 | 0.07 | 0.0673 | 0 | 0 | 0 | 0 |
| E | 0 | 0 | 0 | 0.02 | 0 | 0 | 0 | 0 | 0 |
| F | 0 | 0 | 0.07 | 0.02 | 0 | 0.07 | 0.02 | 0.07 | 0 |
| G | 0 | 0 | 0.02 | 0.55 | 0.0673 | 0.02 | 0.02 | 0.02 | 0 |
| H | 0 | 0 | 0.07 | 0 | 0 | 0 | 0 | 0 | 0 |
| I | 0 | 0 | 0 | 0 | 0.0192 | 0.02 | 0 | 0.07 | 0 |
| K | 0 | 0 | 0 | 0 | 0.0192 | 0 | 0.02 | 0.02 | 0 |
| L | 0 | 0 | 0.02 | 0 | 0 | 0.02 | 0.07 | 0.55 | 0 |
| M | 0 | 0 | 0 | 0 | 0 | 0 | 0 | 0 | 0 |
| N | 0 | 0 | 0 | 0.07 | 0.0673 | 0 | 0 | 0 | 0 |
| P | 0 | 0 | 0 | 0 | 0 | 0.07 | 0.55 | 0.02 | 0 |
| Q | 1 | 1 | 0.02 | 0 | 0 | 0 | 0.07 | 0.02 | 0 |
| R | 0 | 0 | 0.07 | 0.02 | 0.0673 | 0.02 | 0.07 | 0.07 | 0 |
| S | 0 | 0 | 0.07 | 0.07 | 0.5288 | 0.55 | 0.07 | 0 | 0 |
| T | 0 | 0 | 0.02 | 0.02 | 0.0192 | 0.07 | 0.07 | 0 | 1 |
| V | 0 | 0 | 0 | 0.02 | 0.0192 | 0 | 0.02 | 0.02 | 0 |
| W | 0 | 0 | 0 | 0 | 0 | 0.07 | 0 | 0.07 | 0 |
| Y | 0 | 0 | 0.55 | 0.07 | 0.0192 | 0.02 | 0 | 0.07 | 0 |
| — | 0 | 0 | 0 | 0 | 0.0865 | 0 | 0 | 0 | 0 |

A sublibrary containing CDR1 and CDR2 would be built. The allowed diversity in these two CDRs is 2.57E9; a sample containing 1.E7 might be sufficient. A sample having 1.E8 would be better. A sample having 1.E9 would be even better. If a sublibrary of 1.E8 CDR1-2 is combined with a library of 2E7 of CDR3, the allowed diversity would be 2E15, but a sampling of 1.E8 would contain many useful kappa light chains. A sample of 1.E9 is preferred.

TABLE 212
amount of diversity allowed in each LC CDR.

| Where | Diversity |
|---|---|
| CDR1 | 1.93E+06 |
| CDR2 | 1.33E+03 |
| CDR3 | 1.93E+06 |
| overall | 4.95E+15 |

### Overall Library

The overall diversity will be greater than 1.E10 and perhaps as large as 5.E10. Each of the regions of diversity is bounded by a pair of unique restriction sites suitable for cloning the diversity of the library into an initial set of isolates. Diversity can be maintained at each of the diversity units (HC CDR1-2, HC CDR3 (4 versions), LC CDR1-2, and LC CDR3) in separate plasmids.

TABLE 213
pM21J

```
  pMID21T_xHin3_newA27_HCback = pM21J
Input =
F:\zzback\PATENTS\Applications\AbLib_Claims\New_Libr\
                                                                                            tablel3.ibi
LOCUS pMID21T 5200 CIRCULAR
  pMID21T_xHin3_newA27_HCback = pM21J
    Ngene = 5200
Useful REs (cut MAnoLI fewer than 3 times) 2003.02.04
Non-cutters
```

| | | |
|---|---|---|
| AfeI AGCgct | ApaLI Gtgcac | AvrII Cctagg |
| BamHI Ggatcc | BclI Tgatca | BglII Agatct |
| BmgBI CACgtc | BsaBI GATNNnnatc | BsmI NGcattc |
| | (SEQ ID NO: 1047) | |
| BspMI Nnnnnnnnngcaggt | BsrGI Tgtaca | BstAPI GCANNNNntgc |
| (SEQ ID NO: 1048) | | (SEQ ID NO: 1049) |
| BstBI TTcgaa | BstZ17I GTAtac | Bsu36I CCtnagg |
| BtrI CACgtg | Ecl136I GAGctc | EcoRV GATatc |
| FseI GGCCGGcc | HpaI GTTaac | MscI TGGcca |
| NcoI Ccatgg | NruI TCGcga | NsiI ATGCAt |
| PacI TTAATtaa | PmeI GTTTaaac | PmlI CACgtg |
| PshAI GACNNnngtc | RsrII CGgwccg | SacI GAGCTc |
| (SEQ ID NO: 1050) | | |
| SalI Gtcgac | SbfI CCTGCAgg | SexAI Accwggt |
| SgfI GCGATcgc | SnaBI TACgta | SphI GCATGc |
| Sse8387I CCTGCAgg | StuI AGGcct | SwaI ATTTaaat |
| XcmI CCANNNNNnnnntgg | | |
| (SEQ ID NO: 1051) | | |

cutters
Enzymes that cut more than 5 times.

| | | |
|---|---|---|
| EarI CTCTTCNnnn | 6 | (SEQ ID NO: 1052) |
| FauI nNNNNNNGCGGG | 9 | (SEQ ID NO: 1053) |

Enzymes that cut from 1 to 5 times.
$ = DAM site, * = DCM site, & = both

| | | | | | | |
|---|---|---|---|---|---|---|
| EcoO109I RGgnccy | 4 | 7 | 2347 | 2924 | 3446 | |
| BssSI Ctcgtg | 1 | 12 | | | | |
| -″- Cacgag | 1 | 1703 | | | | |
| BspHI Tcatga | 4 | 43 | 148 | 1156 | 3029$ | |
| AatII GACGTc | 1 | 65 | | | | |
| BciVI GTATCCNNNNNN | 2 | 140 | 1667 | | | |
| (SEQ ID NO: 1054) | | | | | | |
| Eco57I CTGAAG | 2 | 301$ | 3074 | | | |
| -″- cttcag | 1 | 1349 | | | | |
| AvaI Cycgrg | 4 | 319 | 2343 | 2557 | 4896 | |
| BsiHKAI GWGCWc | 2 | 401 | 3483 | | | |
| HgiAI GWGCWc | 2 | 401 | 3483 | | | |
| BcgI gcannnnnntcg | 1 | 461 | | | | |
| (SEQ ID NO: 1055) | | | | | | |
| ScaI AGTact | 2 | 505 | 3244 | | | |
| PvuI CGATcg | 2 | 616$ | 4444$ | | | |
| FspI TGCgca | 2 | 763 | 4464 | | | |
| BglI GCCNNNNnggc | 4 | 864 | 3058 | 3817 | 4470 | |
| (SEQ ID NO: 1056) | | | | | | |
| BpmI CTGGAG 1 898 | | | | | | |
| BsrFI Rccggy | 5 | 903 | 2937 | 3063 | 3540 | 4684 |
| BsaI GGTCTCNnnnn | 1 | 916 | | | | |
| (SEQ ID NO: 1057) | | | | | | |
| AhdI GACNNNnngtc | 1 | 983 | | | | |
| (SEQ ID NO: 1058) | | | | | | |
| Eam1105I GACNNNnngtc | 1 | 983 | | | | |
| (SEQ ID NO: 1058) | | | | | | |
| AlwNI CAGNNNctg | 2 | 1462 | 2923 | | | |
| DrdI GACNNNNnngtc | 4 | 1768 | 3343 | 4830 | 5099 | |
| (SEQ ID NO: 1059) | | | | | | |
| PciI Acatgt | 1 | 1876 | | | | |
| SapI gaagagc | 1 | 1998 | | | | |
| PvuII CAGctg | 2 | 2054 | 4414 | | | |
| PflMI CCANNNNntgg | 1 | 2233 | | | | |
| (SEQ ID NO: 1060) | | | | | | |
| HindIII Aagctt | 1 | 2235 | | | | |
| BsmFI Nnnnnnnnnnnnnnngtccc | 2 | 2287 | 2325 | | | |
| (SEQ ID NO: 1061) | | | | | | |
| -″- GGGACNNNNNNNNNNnn | 1 | 2347 | | | | |
| (SEQ ID NO: 1062) | | | | | | |
| SpeI Actagt | 1 | 2295 | | | | |
| PflFI GACNnngtc | 4 | 2334 | 2349 | 2865 | 3546 | |
| Tth111I GACNnngtc | 4 | 2334 | 2349 | 2865 | 3546 | |
| XmaI Cccggg | 1 | 2343 | | | | |
| PpuMI RGgwccy | 1 | 2347 | | | | |
| SanDI GGgwccc | 1 | 2347 | | | | |
| BlpI GCtnagc | 1 | 2382 | | | | |
| EspI GCtnagc | 1 | 2382 | | | | |
| BseRI NNnnnnnnnnctcctc | 2 | 2402 | 3464 | | | |
| (SEQ ID NO: 1063) | | | | | | |
| BtgI Ccrygg | 2 | 2455 | 4218 | | | |
| DsaI Ccrygg | 2 | 2455 | 4218 | | | |
| SacII CCGCgg | 1 | 2455 | | | | |
| BsmBI CGTCTCNnnnn | 3 | 2554 | 3426 | 5145 | | |
| (SEQ ID NO: 1064) | | | | | | |
| -″- Nnnnnngagacg | 1 | 5193 | | | | |
| (SEQ ID NO: 1065) | | | | | | |
| TliI Ctcgag | 1 | 2557 | | | | |
| XhoI Ctcgag | 1 | 2557 | | | | |
| AccI GTmkac | 3 | 2578 | 2899 | 3352 | | |
| HincII GTYrac | 1 | 2588 | | | | |
| Acc65I Ggtacc | 1 | 2626 | | | | |
| KpnI GGTACc | 1 | 2626 | | | | |
| BsgI ctgcac | 1 | 2660 | | | | |
| -″- GTGCAG | 1 | 5019 | | | | |
| BbsI gtcttc | 3 | 2671 | 3457 | 3846 | | |
| SgrAI CRccggyg | 1 | 2936 | | | | |
| AgeI Accggt | 2 | 2937 | 3540 | | | |
| AscI GGcgcgcc | 1 | 2977 | | | | |
| BssHII Gcgcgc | 1 | 2978 | | | | |
| SfiI GGCCNNNNnggcc | 1 | 3057 | | | | |
| (SEQ ID NO: 1066) | | | | | | |
| NaeI GCCggc | 2 | 3063 | 4684 | | | |
| NgoMIV Gccggc | 2 | 3063 | 4684 | | | |
| MfeI Caattg | 1 | 3082 | | | | |
| BspEI Tccgga | 1 | 3148 | | | | |
| BsiWI Cgtacg | 1 | 3167 | | | | |
| BstXI CCANNNNNntgg | 1 | 3189* | | | | |
| (SEQ ID NO: 1067) | | | | | | |
| EcoNI CCTNNnnnagg | 2 | 3196* | 3516* | | | |
| (SEQ ID NO: 1068) | | | | | | |
| XbaI Tctaga | 1 | 3286 | | | | |
| AflII Cttaag | 1 | 3330 | | | | |
| PstI CTGCAg | 1 | 3347 | | | | |
| BstEII Ggtnacc | 1 | 3420 | | | | |
| StyI Ccwwgg | 2 | 3443 | 3710 | | | |
| ApaI GGGCCc | 1 | 3447 | | | | |
| BanII GRGCYc | 3 | 3447 | 3730 | 4714 | | |
| Bsp120I Gggccc | 1 | 3447 | | | | |
| PspOMI Gggccc | 1 | 3447 | | | | |
| NheI Gctagc | 1 | 3465 | | | | |
| KasI Ggcgcc | 2 | 3565 | 4485 | | | |
| NotI GCggccgc | 1 | 3745 | | | | |
| EagI Cggccg | 1 | 3746 | | | | |
| MluI Acgcgt | 2 | 3842 | 4313 | | | |
| BspDI ATcgat | 1 | 3982 | | | | |
| NdeI CAtatg | 1 | 4178 | | | | |
| EcoRI Gaattc | 1 | 4324 | | | | |
| BsaAI YACgtr | 1 | 4787 | | | | |
| DraIII CACNNNgtg | 1 | 4787 | | | | |
| PsiI TTAtaa | 1 | 4915 | | | | |

```
-------------------------------------------------------------------------
(The amino acid sequences disclosed below are SEQ ID NOS 1070-1071 and the
DNA sequence disclosed below is SEQ ID NO: 1069)
        1 gacgaaaggg cctcgtgata cgcctatttt tataggttaa tgtcatgata ataatggttt
      61 cttagacgtc aggtggcact tttcggggaa atgtgcgcgg aacccctatt tgtttatttt
    121 tctaaataca ttcaaatatg tatccgctca tgagacaata accctgataa atgcttcaat
    181 aatattgaaa aaggaagagt atgagtattc aacatttccg tgtcgccctt attccctttt
    241 ttgcggcatt ttgccttcct gtttttgctc acccagaaac gctggtgaaa gtaaaagatg
    301 ctgaagatca gttgggtgcc cgagtgggtt acatcgaact ggatctcaac agcggtaaga
    361 tccttgagag ttttcgcccc gaagaacgtt ttccaatgat gagcactttt aaagttctgc
    421 tatgtggcgc ggtattatcc cgtattgacg ccgggcaaga gcaactcggt cgccgcatac
    481 actattctca gaatgacttg gttgagtact caccagtcac agaaaagcat cttacggatg
    541 gcatgacagt aagagaatta tgcagtgctg ccataaccat gagtgataac actgcggcca
    601 acttacttct gacaacgatc ggaggaccga aggagctaac cgcttttttg cacaacatgg
    661 gggatcatgt aactcgcctt gatcgttggg aaccggagct gaatgaagcc ataccaaacg
    721 acgagcgtga caccacgatg cctgtagcaa tggcaacaac gttgcgcaaa ctattaactg
    781 gcgaactact tactctagct tcccggcaac aattaataga ctggatggag gcggataaag
    841 ttgcaggacc acttctgcgc tcggcccttc cggctggctg gtttattgct gataaatctg
    901 gagccggtga gcgtgggtct cgcggtatca ttgcagcact ggggccagat ggtaagccct
    961 cccgtatcgt agttatctac acgacgggga gtcaggcaac tatggatgaa cgaaatagac
  1021 agatcgctga gataggtgcc tcactgatta agcattggta actgtcagac caagtttact
  1081 catatatact ttagattgat ttaaaacttc atttttaatt taaaaggatc taggtgaaga
  1141 tcctttttga taatctcatg accaaaatcc cttaacgtga gttttcgttc cactgagcgt
  1201 cagaccccgt agaaaagatc aaaggatctt cttgagatcc tttttttctg cgcgtaatct
  1261 gctgcttgca aacaaaaaaa ccaccgctac cagcggtggt ttgtttgccg gatcaagagc
  1321 taccaactct ttttccgaag gtaactggct tcagcagagc gcagatacca aatactgttc
  1381 ttctagtgta gccgtagtta ggccaccact tcaagaactc tgtagcaccg cctacatacc
  1441 tcgctctgct aatcctgtta ccagtggctg ctgccagtgg cgataagtcg tgtcttaccg
  1501 ggttggactc aagacgatag ttaccggata aggcgcagcg gtcgggctga acggggggtt
  1561 cgtgcataca gcccagcttg gagcgaacga cctacaccga actgagatac ctacagcgtg
  1621 agctatgaga aagcgccacg cttcccgaag ggagaaaggc ggacaggtat ccggtaagcg
  1681 gcagggtcgg aacaggagag cgcacgaggg agcttccagg gggaaacgcc tggtatcttt
  1741 atagtcctgt cgggtttcgc cacctctgac ttgagcgtcg atttttgtga tgctcgtcag
  1801 gggggcggag cctatggaaa aacgccagca acgcggcctt tttacggttc ctggcctttt
  1861 gctggccttt tgctcacatg ttctttcctg cgttatcccc tgattctgtg gataaccgta
  1921 ttaccgcctt tgagtgagct gataccgctc gccgcagccg aacgaccgag cgcagcgagt
  1981 cagtgagcga ggaagcggaa gagcgcccaa tacgcaaacc gcctctcccc gcgcgttggc
  2041 cgattcatta atgcagctgg cacgacaggt ttcccgactg gaaagcgggc agtgagcgca
  2101 acgcaattaa tgtgagttag ctcactcatt aggcacccca ggctttacac tttatgcttc
  2161 cggctcgtat gttgtgtgga attgtgagcg gataacaatt tcacacagga aacagctatg
  2221 accatgatta cg
  2233 cc AAGCTT tggagccttttttttggagattttcaac
                    HindIII
              signal sequence--------------------------------------------
                  1 2 3 4 5 6 7 8 9 10 11 12 13 14 15
                  M K K L L S A I P L V V P F Y
  2269 |atg|aaG|aaA|ctg|ctg|tct|gct|atc|ccA|CTA|GTt|gtc|cct|ttc|tat|
                                                                                    SpeI....
            Signal------- FR1-------------------------------------------
                16 17 18 19 20 21 22 23 24 25 26 27 28 29 30
                  S H S E1 I V3 L T5 Q S7 P G9 T L S12
  2314 |tct|cat|agt|gaa|atc|gtt|ctg|acc|cag|tcC|CCG|GGG|aCC|Ctg|tct|
                                                                                            XmaI....
                                                                                                        PpuMI....
                FR1---------------------------------------- CDR1-----------
                31 32 33 34 35 36 37 38 39 40 41 42 43 44 45
                L13 S P G E R A T L S C23 R24 A S Q
  2359 |ctg|tct|ccg|ggt|gaa|cgt|gct|acG|CTg|AGC|tgt|cgt|gct|tct|caa|
                                                                            BlpI.....
                CDR1-------------------------- FR2------------------------
                46 47 48 49 50 51 52 53 54 55 56 57 58 59 60
                S28 V S S31 S31a Y L A34 W Y Q Q K P G
  2404 |tcc|gtt|agC|TCC|TCt|tat|tta|gct|tgg|tat|cag|caa|aag|ccg|ggt|
                FR2--------------------------- CDR2-----------------------
                61 62 63 64 65 66 67 68 69 70 71 72 73 74 75
                  Q A P R45 L L I Y G50 A S S R A T56
  2449 |caa|gct|CCG|CGG|ctg|ttg|atc|tat|ggt|gcc|tct|agt|cgt|gct|act|
                                  SacII..
                FR3-------------------------------------------------------
                76 77 78 79 80 81 82 83 84 85 86 87 88 89 90
                  G I P D60 R F S G S65 G S G T D F
  2494 |ggc|atc|cct|gat|cgt|ttc|tct|ggc|tct|ggc|tct|ggc|acc|gat|ttc|
                FR3-------------------------------------------------------
                91 92 93 94 95 96 97 98 99 100 101 102 103 104 105
                  T L T I S R L E P E D F A V Y
  2539 |act|ctg|acc|att|tct|cgt|CTC|GAG|ccg|gaa|gat|ttc|gct|gtc|tac|
                                                                  XhoI...
                FR3---- CDR3------------------------------ FR4-----------
              106 107 108 109 110 111 112 113 114 115 116 117 118 119 120
                  Y C Q89 Q Y G S S P95 L T F G G G
  2584 |tat|tgt|caa|cag|tat|ggt|tct|agt|ccg|ctg|act|ttc|ggt|ggc|GGT|
                                                                                                                                  KpnI...
              FR4-------------------- JK4
              121 122 123 124 125 126
                  T K V E I K
  2629 |ACC|aaa|gtc|gaa|atc|aag
            KpnI.
                    Ckappa
                    R G T V A A P S V F I F P P S
  2647 cgt gga act gtg gct gca cca tct gtc ttc atc ttc ccg cca tct
                    D E Q L K S G T A S V V C L L
  2692 gat gag cag ttg aaa tct gga act gcc tct gtt gtg tgc ctg ctg
                    N N F Y P R E A K V Q W K V D
  2737 aat aac ttc tat ccc aga gag gcc aaa gta cag tgg aag gtg gat
                    N A L Q S G N S Q E S V T E Q
  2782 aac gcc ctc caa tcg ggt aac tcc cag gag agt gtc aca gag cag
                    D S K D S T Y S L S S T L T L
  2827 gac agc aag gac agc acc tac agc ctc agc agc acc ctg act ctg
                    S K A D Y E K H K V Y A C E V
  2872 tcc aaa gca gac tac gag aaa cac aaa GTC TAC gcc tgc gaa gtc
                    T H Q G L S S P V T K S F N R
  2917 acc cat cag ggc ctg agt tCA CCG GTG aca aag agc ttc aac agg
                                                                      SgrAI.....
                    G E C •  •
  2962 gga gag tgt taa taa
  2977 GG CGCGCC
                                                        AscI.....
                                                          BssHII.
  2985 taaccat
  2992 ctatttcaag gaacagtctt a
    HC signal sequence
              M K K L L F M I P L V V P
  3013 atg aaG aaA ctG tta ttc atg atc ccg tta gtt gta ccg
              F V A Q P A S A
  3052 ttc gtG GCC CAG CCG GCC tct gct
                      SfiI.............
VH
                                                                    FR1(DP47/V3-23)---------------
                                                                      1 2 3 4 5 6 7 8
                                                                      E V Q L L E S G
  3076 gaa|gtt|CAA|TTG|tta|gag|tct|ggt|
                                                                                  | MfeI |
              --------------FR1--------------------------------------------
                  9 10 11 12 13 14 15 16 17 18 19 20 21 22 23
                  G G L V Q P G G S L R L S C A
  3100 |ggc|ggt|ctt|gtt|cag|cct|ggt|ggt|tct|tta|cgt|ctt|tct|tgc|gct|
              ----FR1-------------------->|...CDR1............|---FR2------
                24 25 26 27 28 29 30 31 32 33 34 35 36 37 38
                  A S G F T F S S Y A M S W V R
  3145 |gct|TCC|GGA|ttc|act|ttc|tct|tCG|TAC|Gct|atg|tct|tgg|gtt|cgC|
                      | BspEI |  | BsiWI|  |BstXI.
                -------FR2-------------------------------->|...CDR2.........
                39 40 41 42 43 44 45 46 47 48 49 50 51 52 52a
                  Q A P G K G L E W V S A I S G
  3190 |CAa|gct|ccT|GGt|aaa|ggt|ttg|gag|tgg|gtt|tct|gct|atc|tct|ggt|
      ...BstXI
            .....CDR2............................................|---FR3---
                53 54 55 56 57 58 59 60 61 62 63 64 65 66 67
                  S G G S T Y Y A D S V K G R F
  3235 |tct|ggt|ggc|agt|act|tac|tat|gct|gac|tcc|gtt|aaa|ggt|cgc|ttc|
                --------FR3-------------------------------------------------
                68 69 70 71 72 73 74 75 76 77 78 79 80 81 82
                  T I S R D N S K N T L Y L Q M
  3280 |act|atc|TCT|AGA|gac|aac|tct|aag|aat|act|ctc|tac|ttg|cag|atg|
                              | XbaI |
              ---FR3----------------------------------------------------->|
              82a 82b 82c 83 84 85 86 87 88 89 90 91 92 93 94
                  N S L R A E D T A V Y Y C A K
  3325 |aac|agC|TTA|AGg|gct|gag|gac|aCT|GCA|Gtc|tac|tat|tgc|gct|aaa|
                            |AflII |  | PstI |
              .......CDR3.................Jstump.........|----FR4----------
                95 96 97 98 98a 98b 98c 99 100 101 102 103 104 105 106
                  D Y E G T G Y A F D Y W G Q G
  3370 |gac|tat|gaa|ggt|act|ggt|tat|gct|ttc|gaC|TAT|TGg|ggt|caa|ggt|
              --------------FR4---------->|  (JK4)
                107 108 109 110 111 112 113
                  T L V T V S S
  3415 |act|CtG|GTC|ACC|gtc tca agc
                            | BstEII |
  3436 gcctccac
  3444 caaGGGCCCa tcggtcttcc cGCTAGCacc ctcctccaag agcacctctg ggggcacagc
                  ApaI.. NheI..
  3504 ggccctgggc tgcctggtca aggactactt ccccgaaccg gtgacggtgt cgtggaactc
  3564 aggcgccctg accagcggcg tccacacctt cccggctgtc ctacagtcta gcggactcta
  3624 ctccctcagc agcgtagtga ccgtgccctc ttctagcttg ggcacccaga cctacatctg
  3684 caacgtgaat cacaagccca gcaacaccaa ggtggacaag aaagttgagc ccaaatcttg
  3744 tGCGGCCGCa catcatcatc accatcacgg ggccgcagaa caaaaactca tctcagaaga
              NotI....
  3804 ggatctgaat ggggccgcag aggctagttc tgctagtaAC GCGTcttccg gtgattttga
                                                                                              MluI...(1/2)
  3864 ttatgaaaag atggcaaacg ctaataaggg ggctatgacc gaaaatgccg atgaaaacgc
  3924 gctacagtct gacgctaaag gcaaacttga ttctgtcgct actgattacg gtgctgctAT
  3984 CGATggtttc attggtgacg tttccggcct tgctaatggt aatggtgcta ctggtgattt
  4044 tgctggctct aattcccaaa tggctcaagt cggtgacggt gataattcac ctttaatgaa
  4104 taatttccgt caatatttac cttccctccc tcaatcggtt gaatgtcgcc cttttgtctt
  4164 tggcgctggt aaaccatatg aattttctat tgattgtgac aaaataaact tattccgtgg
  4224 tgtctttgcg tttcttttat atgttgccac ctttatgtat gtattttcta cgtttgctaa
  4284 catactgcgt aataaggagt cttaatgaaA CGCGTgatga GAATTCactg gccgtcgttt
                                                                          MluI...(2/2) EcoRI.
  4344 tacaacgtcg tgactgggaa aaccctggcg ttacccaact taatcgcctt gcagcacatc
  4404 cccctttcgc cagctggcgt aatagcgaag aggcccgcac cgatcgccct tcccaacagt
  4464 tgcgcagcct gaatggcgaa tggcgcctga tgcggtattt tctccttacg catctgtgcg
  4524 gtatttcaca ccgcatacgt caaagcaacc atagtacgcg ccctgtagcg gcgcattaag
  4584 cgcggcgggt gtggtggtta cgcgcagcgt gaccgctaca cttgccagcg ccttagcgcc
  4644 cgctcctttc gctttcttcc cttcctttct cgccacgttc gccggctttc cccgtcaagc
  4704 tctaaatcgg gggctccctt tagggttccg atttagtgct ttacggcacc tcgaccccaa
  4764 aaaacttgat ttgggtgatg gttcacgtag tgggccatcg ccctgataga cggtttttcg
  4824 ccctttgacg ttggagtcca cgttctttaa tagtggactc ttgttccaaa ctggaacaac
  4884 actcaactct atctcgggct attcttttga tttataaggg attttgccga tttcggtcta
  4944 ttggttaaaa aatgagctga tttaacaaaa atttaacgcg aattttaaca aaatattaac
  5004 gtttacaatt ttatggtgca gtctcagtac aatctgctct gatgccgcat agttaagcca
  5064 gccccgacac ccgccaacac ccgctgacgc gccctgacgg gcttgtctgc tcccggcatc
  5124 cgcttacaga caagctgtga ccgtctccgg gagctgcatg tgtcagaggt tttcaccgtc
  5184 atcaccgaaa cgcgcga
```

TABLE 215
Unannotated DNA sequence of pM21J (SEQ ID NO: 1072)

| pM21J | 5200 CIRCULAR |
|---|---|
| 1 | GACGAAAGGG CCTCGTGATA CGCCTATTTT TATAGGTTAA TGTCATGATA ATAATGGTTT |
| 61 | CTTAGACGTC AGGTGGCACT TTTCGGGGAA ATGTGCGCGG AACCCCTATT TGTTTATTTT |
| 121 | TCTAAATACA TTCAAATATG TATCCGCTCA TGAGACAATA ACCCTGATAA ATGCTTCAAT |
| 181 | AATATTGAAA AAGGAAGAGT ATGAGTATTC AACATTTCCG TGTCGCCCTT ATTCCCTTTT |
| 241 | TTGCGGCATT TTGCCTTCCT GTTTTTGCTC ACCCAGAAAC GCTGGTGAAA GTAAAAGATG |
| 301 | CTGAAGATCA GTTGGGTGCC CGAGTGGGTT ACATCGAACT GGATCTCAAC AGCGGTAAGA |
| 361 | TCCTTGAGAG TTTTCGCCCC GAAGAACGTT TTCCAATGAT GAGCACTTTT AAAGTTCTGC |
| 421 | TATGTGGCGC GGTATTATCC CGTATTGACG CCGGGCAAGA GCAACTCGGT CGCCGCATAC |
| 481 | ACTATTCTCA GAATGACTTG GTTGAGTACT CACCAGTCAC AGAAAAGCAT CTTACGGATG |
| 541 | GCATGACAGT AAGAGAATTA TGCAGTGCTG CCATAACCAT GAGTGATAAC ACTGCGGCCA |
| 601 | ACTTACTTCT GACAACGATC GGAGGACCGA AGGAGCTAAC CGCTTTTTTG CACAACATGG |
| 661 | GGGATCATGT AACTCGCCTT GATCGTTGGG AACCGGAGCT GAATGAAGCC ATACCAAACG |
| 721 | ACGAGCGTGA CACCACGATG CCTGTAGCAA TGGCAACAAC GTTGCGCAAA CTATTAACTG |
| 781 | GCGAACTACT TACTCTAGCT TCCCGGCAAC AATTAATAGA CTGGATGGAG GCGGATAAAG |
| 841 | TTGCAGGACC ACTTCTGCGC TCGGCCCTTC CGGCTGGCTG GTTTATTGCT GATAAATCTG |
| 901 | GAGCCGGTGA GCGTGGGTCT CGCGGTATCA TTGCAGCACT GGGGCCAGAT GGTAAGCCCT |
| 961 | CCCGTATCGT AGTTATCTAC ACGACGGGGA GTCAGGCAAC TATGGATGAA CGAAATAGAC |
| 1021 | AGATCGCTGA GATAGGTGCC TCACTGATTA AGCATTGGTA ACTGTCAGAC CAAGTTTACT |
| 1081 | CATATATACT TTAGATTGAT TTAAAACTTC ATTTTTAATT TAAAAGGATC TAGGTGAAGA |
| 1141 | TCCTTTTTGA TAATCTCATG ACCAAAATCC CTTAACGTGA GTTTTCGTTC CACTGAGCGT |
| 1201 | CAGACCCCGT AGAAAAGATC AAAGGATCTT CTTGAGATCC TTTTTTTCTG CGCGTAATCT |
| 1261 | GCTGCTTGCA AACAAAAAAA CCACCGCTAC CAGCGGTGGT TTGTTTGCCG GATCAAGAGC |
| 1321 | TACCAACTCT TTTTCCGAAG GTAACTGGCT TCAGCAGAGC GCAGATACCA AATACTGTTC |
| 1381 | TTCTAGTGTA GCCGTAGTTA GGCCACCACT TCAAGAACTC TGTAGCACCG CCTACATACC |
| 1441 | TCGCTCTGCT AATCCTGTTA CCAGTGGCTG CTGCCAGTGG CGATAAGTCG TGTCTTACCG |
| 1501 | GGTTGGACTC AAGACGATAG TTACCGGATA AGGCGCAGCG GTCGGGCTGA ACGGGGGGTT |
| 1561 | CGTGCATACA GCCCAGCTTG GAGCGAACGA CCTACACCGA ACTGAGATAC CTACAGCGTG |
| 1621 | AGCTATGAGA AAGCGCCACG CTTCCCGAAG GGAGAAAGGC GGACAGGTAT CCGGTAAGCG |
| 1681 | GCAGGGTCGG AACAGGAGAG CGCACGAGGG AGCTTCCAGG GGGAAACGCC TGGTATCTTT |
| 1741 | ATAGTCCTGT CGGGTTTCGC CACCTCTGAC TTGAGCGTCG ATTTTTGTGA TGCTCGTCAG |
| 1801 | GGGGGCGGAG CCTATGGAAA AACGCCAGCA ACGCGGCCTT TTTACGGTTC CTGGCCTTTT |
| 1861 | GCTGGCCTTT TGCTCACATG TTCTTTCCTG CGTTATCCCC TGATTCTGTG GATAACCGTA |
| 1921 | TTACCGCCTT TGAGTGAGCT GATACCGCTC GCCGCAGCCG AACGACCGAG CGCAGCGAGT |
| 1981 | CAGTGAGCGA GGAAGCGGAA GAGCGCCCAA TACGCAAACC GCCTCTCCCC GCGCGTTGGC |
| 2041 | CGATTCATTA ATGCAGCTGG CACGACAGGT TTCCCGACTG GAAAGCGGGC AGTGAGCGCA |
| 2101 | ACGCAATTAA TGTGAGTTAG CTCACTCATT AGGCACCCCA GGCTTTACAC TTTATGCTTC |
| 2161 | CGGCTCGTAT GTTGTGTGGA ATTGTGAGCG GATAACAATT TCACACAGGA AACAGCTATG |
| 2221 | ACCATGATTA CGCCAAGCTT TGGAGCCTTT TTTTTGGAGA TTTTCAACAT GAAGAAACTG |
| 2281 | CTGTCTGCTA TCCCACTAGT TGTCCCTTTC TATTCTCATA GTGAAATCGT TCTGACCCAG |
| 2341 | TCCCCGGGGA CCCTGTCTCT GTCTCCGGGT GAACGTGCTA CGCTGAGCTG TCGTGCTTCT |
| 2401 | CAATCCGTTA GCTCCTCTTA TTTAGCTTGG TATCAGCAAA AGCCGGGTCA AGCTCCGCGG |
| 2461 | CTGTTGATCT ATGGTGCCTC TAGTCGTGCT ACTGGCATCC CTGATCGTTT CTCTGGCTCT |
| 2521 | GGCTCTGGCA CCGATTTCAC TCTGACCATT TCTCGTCTCG AGCCGGAAGA TTTCGCTGTC |
| 2581 | TACTATTGTC AACAGTATGG TTCTAGTCCG CTGACTTTCG GTGGCGGTAC CAAAGTCGAA |
| 2641 | ATCAAGCGTG GAACTGTGGC TGCACCATCT GTCTTCATCT TCCCGCCATC TGATGAGCAG |
| 2701 | TTGAAATCTG GAACTGCCTC TGTTGTGTGC CTGCTGAATA ACTTCTATCC CAGAGAGGCC |
| 2761 | AAAGTACAGT GGAAGGTGGA TAACGCCCTC CAATCGGGTA ACTCCCAGGA GAGTGTCACA |
| 2821 | GAGCAGGACA GCAAGGACAG CACCTACAGC CTCAGCAGCA CCCTGACTCT GTCCAAAGCA |
| 2881 | GACTACGAGA AACACAAAGT CTACGCCTGC GAAGTCACCC ATCAGGGCCT GAGTTCACCG |
| 2941 | GTGACAAAGA GCTTCAACAG GGGAGAGTGT TAATAAGGCG CGCCTAACCA TCTATTTCAA |
| 3001 | GGAACAGTCT TAATGAAGAA ACTGTTATTC ATGATCCCGT TAGTTGTACC GTTCGTGGCC |
| 3061 | CAGCCGGCCT CTGCTGAAGT TCAATTGTTA GAGTCTGGTG GCGGTCTTGT TCAGCCTGGT |
| 3121 | GGTTCTTTAC GTCTTTCTTG CGCTGCTTCC GGATTCACTT TCTCTTCGTA CGCTATGTCT |
| 3181 | TGGGTTCGCC AAGCTCCTGG TAAAGGTTTG GAGTGGGTTT CTGCTATCTC TGGTTCTGGT |
| 3241 | GGCAGTACTT ACTATGCTGA CTCCGTTAAA GGTCGCTTCA CTATCTCTAG AGACAACTCT |
| 3301 | AAGAATACTC TCTACTTGCA GATGAACAGC TTAAGGGCTG AGGACACTGC AGTCTACTAT |
| 3361 | TGCGCTAAAG ACTATGAAGG TACTGGTTAT GCTTTCGACA TATGGGGTCA AGGTACTATG |
| 3421 | GTCACCGTCT CAAGCGCCTC CACCAAGGGC CCATCGGTCT TCCCGCTAGC ACCCTCCTCC |
| 3481 | AAGAGCACCT CTGGGGGCAC AGCGGCCCTG GGCTGCCTGG TCAAGGACTA CTTCCCCGAA |
| 3541 | CCGGTGACGG TGTCGTGGAA CTCAGGCGCC CTGACCAGCG GCGTCCACAC CTTCCCGGCT |
| 3601 | GTCCTACAGT CTAGCGGACT CTACTCCCTC AGCAGCGTAG TGACCGTGCC CTCTTCTAGC |
| 3661 | TTGGGCACCC AGACCTACAT CTGCAACGTG AATCACAAGC CCAGCAACAC CAAGGTGGAC |
| 3721 | AAGAAAGTTG AGCCCAAATC TTGTGCGGCC GCACATCATC ATCACCATCA CGGGGCCGCA |
| 3781 | GAACAAAAAC TCATCTCAGA AGAGGATCTG AATGGGGCCG CAGAGGCTAG TTCTGCTAGT |
| 3841 | AACGCGTCTT CCGGTGATTT TGATTATGAA AAGATGGCAA ACGCTAATAA GGGGGCTATG |
| 3901 | ACCGAAAATG CCGATGAAAA CGCGCTACAG TCTGACGCTA AAGGCAAACT TGATTCTGTC |
| 3961 | GCTACTGATT ACGGTGCTGC TATCGATGGT TTCATTGGTG ACGTTTCCGG CCTTGCTAAT |
| 4021 | GGTAATGGTG CTACTGGTGA TTTTGCTGGC TCTAATTCCC AAATGGCTCA AGTCGGTGAC |
| 4081 | GGTGATAATT CACCTTTAAT GAATAATTTC CGTCAATATT TACCTTCCCT CCCTCAATCG |
| 4141 | GTTGAATGTC GCCCTTTTGT CTTTGGCGCT GGTAAACCAT ATGAATTTTC TATTGATTGT |
| 4201 | GACAAAATAA ACTTATTCCG TGGTGTCTTT GCGTTTCTTT TATATGTTGC CACCTTTATG |
| 4261 | TATGTATTTT CTACGTTTGC TAACATACTG CGTAATAAGG AGTCTTAATG AAACGCGTGA |
| 4321 | TGAGAATTCA CTGGCCGTCG TTTTACAACG TCGTGACTGG GAAAACCCTG GCGTTACCCA |
| 4381 | ACTTAATCGC CTTGCAGCAC ATCCCCCTTT CGCCAGCTGG CGTAATAGCG AAGAGGCCCG |
| 4441 | CACCGATCGC CCTTCCCAAC AGTTGCGCAG CCTGAATGGC GAATGGCGCC TGATGCGGTA |
| 4501 | TTTTCTCCTT ACGCATCTGT GCGGTATTTC ACACCGCATA CGTCAAAGCA ACCATAGTAC |
| 4561 | GCGCCCTGTA GCGGCGCATT AAGCGCGGCG GGTGTGGTGG TTACGCGCAG CGTGACCGCT |
| 4621 | ACACTTGCCA GCGCCTTAGC GCCCGCTCCT TTCGCTTTCT TCCCTTCCTT TCTCGCCACG |
| 4681 | TTCGCCGGCT TTCCCCGTCA AGCTCTAAAT CGGGGGCTCC CTTTAGGGTT CCGATTTAGT |
| 4741 | GCTTTACGGC ACCTCGACCC CAAAAAACTT GATTTGGGTG ATGGTTCACG TAGTGGGCCA |
| 4801 | TCGCCCTGAT AGACGGTTTT TCGCCCTTTG ACGTTGGAGT CCACGTTCTT TAATAGTGGA |
| 4861 | CTCTTGTTCC AAACTGGAAC AACACTCAAC TCTATCTCGG GCTATTCTTT TGATTTATAA |
| 4921 | GGGATTTTGC CGATTTCGGT CTATTGGTTA AAAAATGAGC TGATTTAACA AAAATTTAAC |
| 4981 | GCGAATTTTA ACAAAATATT AACGTTTACA ATTTTATGGT GCAGTCTCAG TACAATCTGC |
| 5041 | TCTGATGCCG CATAGTTAAG CCAGCCCCGA CACCCGCCAA CACCCGCTGA CGCGCCCTGA |
| 5101 | CGGGCTTGTC TGCTCCCGGC ATCCGCTTAC AGACAAGCTG TGACCGTCTC CGGGAGCTGC |
| 5161 | ATGTGTCAGA GGTTTTCACC GTCATCACCG AAACGCGCGA |

TABLE 216
Sampling of allowed diversity in LC CDRs

| | allowed LC diversity | | |
|---|---|---|---|
| | CDR1 | CDR2 | CDR3 |
| Allowed | 1.93E+06 | 1.33E+03 | 1.93E+06 |
| Cumulative | 1.93E+06 | 2.57E+09 | 4.95E+15 |

Sampling statistics

| | CDR1 or CDR3 (1.93E6) | | |
|---|---|---|---|
| Number of isolates | 1.00E+08 | 3.00E+08 | 1.00E+09 |
| Number distinct | 1.93E+06 | 1.93E+06 | 1.93E+06 |

| | CDR1 & CDR2 (2.57E9) | | | |
|---|---|---|---|---|
| Number of isolates | 1.00E+08 | 3.00E+08 | 1.00E+09 | 3.00E+09 |
| Number distinct | 9.81E+07 | 2.83E+08 | 8.28E+08 | 1.77E+09 |

Overall (4.96E15)

| | | | |
|---|---|---|---|
| Number of isolates | 1.00E+08 | 3.00E+08 | 1.00E+09 |
| Number distinct | 1.00E+08 | 3.00E+08 | 1.00E+09 |

TABLE 221
Tally Utilization of JHs based on AA
sequences from amino-acid sequence analysis

| | | 123456789FR4 | |
|---|---|---|---|
| JH1 | 1101 | ---AEYFQHWGQGTLVTVSS | (SEQ ID NO: 66) |
| JH2 | 792 | ---YWYFDLWGRGTLVTVSS | (SEQ ID NO: 67) |
| JH3 | 4677 | -----AFDIWGQGTMVTVSS | (SEQ ID NO: 2) |
| JH4 | 7092 | -----YFDYWGQGTLVTVSS | (SEQ ID NO: 1) |
| JH5 | 1007 | ----NWFDPWGQGTLVTVSS | (SEQ ID NO: 68) |
| JH6 | 4382 | YYYYYGMDVWGQGTTVTVSS | (SEQ ID NO: 3) |

TABLE 223
Use of AAs HC CDR3 (19,051 Abs; 244,343 amino acids

| AA | Number | percent | cumulative percent |
|---|---|---|---|
| Y | 39058 | 16.0 | 16.0 |
| G | 33690 | 13.8 | 29.8 |
| D | 29671 | 12.1 | 41.9 |
| S | 20630 | 8.4 | 50.4 |
| F | 15575 | 6.4 | 56.7 |
| A | 13282 | 5.4 | 62.2 |
| R | 12597 | 5.2 | 67.3 |
| V | 12227 | 5.0 | 72.3 |
| L | 10260 | 4.2 | 76.5 |
| P | 8797 | 3.6 | 80.1 |
| I | 8498 | 3.5 | 83.6 |
| W | 8196 | 3.4 | 87.0 |
| T | 6813 | 2.8 | 89.7 |
| M | 5575 | 2.3 | 92.0 |
| N | 4835 | 2.0 | 94.0 |
| E | 4397 | 1.8 | 95.8 |
| H | 3659 | 1.5 | 97.3 |
| K | 2794 | 1.1 | 98.4 |
| Q | 2768 | 1.1 | 99.6 |
| C | 1021 | 0.4 | 100.0 |
| | 244343 | | |

TABLE 224
Lengths of CDR3

| Length | Number | Length | Number | Length | Number |
|---|---|---|---|---|---|
| 1 | 0 | 13 | 1712 | 25 | 32 |
| 2 | 3 | 14 | 1529 | 26 | 23 |
| 3 | 32 | 15 | 1286 | 27 | 9 |
| 4 | 104 | 16 | 1199 | 28 | 6 |
| 5 | 109 | 17 | 1065 | 29 | 2 |
| 6 | 471 | 18 | 724 | 30 | 3 |
| 7 | 600 | 19 | 555 | 31 | 2 |
| 8 | 993 | 20 | 382 | 32 | 0 |
| 9 | 1661 | 21 | 274 | 33 | 1 |
| 10 | 1912 | 22 | 224 | 34 | 0 |
| 11 | 1976 | 23 | 127 | 35 | 0 |
| 12 | 1955 | 24 | 79 | 36 | 1 |

Total AAs = 244343
Total Abs = 19051
Median length = 11.85

TABLE 2212A
VD fill

| OA | | % | cum % | P1 | | % | cum % | P2 | | % | cum % |
|---|---|---|---|---|---|---|---|---|---|---|---|
| G | 5010 | 18.0 | 18.0 | D | 2064 | 21.4 | 21.4 | G | 1354 | 17.1 | 17.1 |
| R | 3144 | 11.3 | 29.3 | G | 1849 | 19.2 | 40.6 | R | 1211 | 15.3 | 32.4 |
| D | 2806 | 10.1 | 39.4 | V | 886 | 9.2 | 49.8 | P | 850 | 10.7 | 43.1 |
| S | 1960 | 7.1 | 46.5 | E | 866 | 9.0 | 58.7 | L | 657 | 8.3 | 51.4 |
| P | 1921 | 6.9 | 53.4 | A | 831 | 8.6 | 67.4 | S | 640 | 8.1 | 59.5 |
| A | 1808 | 6.5 | 59.9 | S | 504 | 5.2 | 72.6 | A | 401 | 5.1 | 64.6 |
| L | 1719 | 6.2 | 66.1 | R | 484 | 5.0 | 77.6 | V | 317 | 4.0 | 68.6 |
| V | 1646 | 5.9 | 72.0 | L | 375 | 3.9 | 81.5 | T | 314 | 4.0 | 72.5 |
| E | 1399 | 5.0 | 77.1 | T | 308 | 3.2 | 84.7 | K | 273 | 3.4 | 76.0 |
| T | 1149 | 4.1 | 81.2 | H | 306 | 3.2 | 87.9 | D | 250 | 3.2 | 79.1 |
| H | 867 | 3.1 | 84.3 | P | 237 | 2.5 | 90.3 | Q | 241 | 3.0 | 82.2 |
| N | 679 | 2.4 | 86.8 | Q | 222 | 2.3 | 92.6 | H | 230 | 2.9 | 85.1 |
| I | 652 | 2.3 | 89.1 | I | 207 | 2.1 | 94.8 | N | 223 | 2.8 | 87.9 |
| Q | 638 | 2.3 | 91.4 | N | 98 | 1.0 | 95.8 | I | 219 | 2.8 | 90.7 |
| K | 597 | 2.1 | 93.6 | W | 94 | 1.0 | 96.8 | E | 217 | 2.7 | 93.4 |
| F | 554 | 2.0 | 95.5 | F | 93 | 1.0 | 97.7 | F | 168 | 2.1 | 95.5 |
| W | 525 | 1.9 | 97.4 | M | 93 | 1.0 | 98.7 | W | 147 | 1.9 | 97.4 |
| Y | 382 | 1.4 | 98.8 | K | 58 | 0.6 | 99.3 | Y | 105 | 1.3 | 98.7 |
| M | 295 | 1.1 | 99.9 | Y | 52 | 0.5 | 99.8 | M | 94 | 1.2 | 99.9 |
| C | 36 | 0.1 | 100.0 | C | 17 | 0.2 | 100.0 | C | 8 | 0.1 | 100.0 |
| | 27787 | | | | 9644 | | | | 7919 | | |

TABLE 2212B
VD fill

| P3 | | % | cum % | P4 | | % | cum % | P5 | | | |
|---|---|---|---|---|---|---|---|---|---|---|---|
| G | 961 | 18.6 | 18.6 | G | 451 | 16.5 | 16.5 | G | 215 | 17.0 | 17.0 |
| R | 756 | 14.6 | 33.2 | R | 355 | 13.0 | 29.5 | R | 184 | 14.6 | 31.6 |
| P | 416 | 8.0 | 41.3 | P | 243 | 8.9 | 38.4 | P | 100 | 7.9 | 39.5 |
| S | 411 | 8.0 | 49.2 | S | 220 | 8.1 | 46.5 | S | 96 | 7.6 | 47.1 |
| L | 371 | 7.2 | 56.4 | L | 192 | 7.0 | 53.5 | D | 74 | 5.9 | 52.9 |
| A | 299 | 5.8 | 62.2 | A | 154 | 5.6 | 59.1 | L | 69 | 5.5 | 58.4 |
| T | 280 | 5.4 | 67.6 | D | 153 | 5.6 | 64.7 | A | 65 | 5.1 | 63.5 |
| D | 221 | 4.3 | 71.9 | V | 135 | 4.9 | 69.7 | T | 61 | 4.8 | 68.4 |
| V | 218 | 4.2 | 76.1 | T | 127 | 4.7 | 74.3 | V | 53 | 4.2 | 72.5 |
| E | 174 | 3.4 | 79.5 | N | 110 | 4.0 | 78.4 | N | 51 | 4.0 | 76.6 |
| H | 159 | 3.1 | 82.5 | E | 85 | 3.1 | 81.5 | W | 51 | 4.0 | 80.6 |
| N | 151 | 2.9 | 85.5 | H | 85 | 3.1 | 84.6 | H | 44 | 3.5 | 84.1 |
| F | 141 | 2.7 | 88.2 | F | 77 | 2.8 | 87.4 | K | 34 | 2.7 | 86.8 |
| K | 131 | 2.5 | 90.7 | W | 76 | 2.8 | 90.2 | E | 33 | 2.6 | 89.4 |
| W | 120 | 2.3 | 93.1 | I | 69 | 2.5 | 92.7 | F | 33 | 2.6 | 92.0 |
| I | 110 | 2.1 | 95.2 | K | 63 | 2.3 | 95.0 | Y | 33 | 2.6 | 94.6 |
| Y | 104 | 2.0 | 97.2 | Y | 58 | 2.1 | 97.1 | I | 28 | 2.2 | 96.8 |
| Q | 87 | 1.7 | 98.9 | Q | 45 | 1.6 | 98.8 | Q | 23 | 1.8 | 98.7 |
| M | 52 | 1.0 | 99.9 | M | 30 | 1.1 | 99.9 | M | 16 | 1.3 | 99.9 |
| C | 6 | 0.1 | 100.0 | C | 3 | 0.1 | 100.0 | C | 1 | 0.1 | 100.0 |
| | 5168 | | | | 2731 | | | | 1264 | | |

TABLE 2214
Where are the various amino-acid types
found

| | | | |
|---|---|---|---|
| Item | #AA | % | #items |

Ala

| | | | | |
|---|---|---|---|---|
| | #A | | | |
| VJ fill | 3549 | 59947 | 5.92 | 8567 |
| Jstump | 4176 | 72388 | 5.77 | 17967 |
| VVD fill | 1808 | 27787 | 6.51 | 9644 |
| D segment | 3268 | 74297 | 4.40 | 10479 |
| DJ fill | 1232 | 25084 | 4.91 | 9364 |

Cys

| | | | | |
|---|---|---|---|---|
| | #C | | | |
| VJ fill | 95 | 59947 | 0.16 | 8567 |
| Jstump | 21 | 72388 | 0.03 | 17967 |
| VVD fill | 36 | 27787 | 0.13 | 9644 |
| D segment | 853 | 74297 | 1.15 | 10479 |
| DJ fill | 43 | 25084 | 0.17 | 9364 |

Asp

| | | | | |
|---|---|---|---|---|
| | #D | | | |
| VJ fill | 4388 | 59947 | 7.32 | 8567 |
| Jstump | 16529 | 72388 | 22.83 | 17967 |
| VVD fill | 2806 | 27787 | 10.10 | 9644 |
| D segment | 4882 | 74297 | 6.57 | 10479 |
| DJ fill | 2089 | 25084 | 8.33 | 9364 |

Glu

| | | | | |
|---|---|---|---|---|
| | #E | | | |
| VJ fill | 1806 | 59947 | 3.01 | 8567 |
| Jstump | 87 | 72388 | 0.12 | 17967 |
| VD fill | 1399 | 27787 | 5.03 | 9644 |
| D segment | 970 | 74297 | 1.31 | 10479 |
| DJ fill | 557 | 25084 | 2.22 | 9364 |

Phe

| | | | | |
|---|---|---|---|---|
| | #F | | | |
| VJ fill | 1706 | 59947 | 2.85 | 8567 |
| Jstump | 10380 | 72388 | 14.34 | 17967 |
| VD fill | 554 | 27787 | 1.99 | 9644 |
| D segment | 2563 | 74297 | 3.45 | 10479 |
| DJ fill | 1053 | 25084 | 4.20 | 9364 |

Gly

| | | | | |
|---|---|---|---|---|
| | #G | | | |
| VJ fill | 11325 | 59947 | 18.89 | 8567 |
| Jstump | 3268 | 72388 | 4.51 | 17967 |
| VD fill | 5010 | 27787 | 18.03 | 9644 |
| D segment | 12333 | 74297 | 16.60 | 10479 |
| DJ fill | 3868 | 25084 | 15.42 | 9364 |

His

| | | | | |
|---|---|---|---|---|
| | #H | | | |
| VJ fill | 1377 | 59947 | 2.3 | 8567 |
| Jstump | 453 | 72388 | 0.63 | 17967 |
| VD fill | 867 | 27787 | 3.12 | 9644 |
| D segment | 727 | 74297 | 0.98 | 10479 |
| DJ fill | 881 | 25084 | 3.51 | 9364 |

Ile

| | | | | |
|---|---|---|---|---|
| | #I | | | |
| VJ fill | 1479 | 59947 | 2.47 | 8567 |
| Jstump | 4404 | 72388 | 6.08 | 17967 |
| VD fill | 652 | 27787 | 2.35 | 9644 |
| D segment | 1757 | 74297 | 2.36 | 10479 |
| DJ fill | 523 | 25084 | 2.08 | 9364 |

Lys

| | | | | |
|---|---|---|---|---|
| | #K | | | |
| VJ fill | 1427 | 59947 | 2.38 | 8567 |
| Jstump | 5 | 72388 | 0.01 | 17967 |
| VD fill | 597 | 27787 | 2.15 | 9644 |
| D segment | 538 | 74297 | 0.72 | 10479 |
| DJ fill | 703 | 25084 | 2.8 | 9364 |

Leu

| | | | | |
|---|---|---|---|---|
| | #L | | | |
| VJ fill | 4055 | 59947 | 6.76 | 8567 |
| Jstump | 731 | 72388 | 1.01 | 17967 |
| VD fill | 1719 | 27787 | 6.19 | 9644 |
| D segment | 3139 | 74297 | 4.22 | 10479 |
| DJ fill | 1777 | 25084 | 7.08 | 9364 |

Met

| | | | | |
|---|---|---|---|---|
| | #M | | | |
| VJ fill | 646 | 59947 | 1.08 | 8567 |
| Jstump | 4137 | 72388 | 5.72 | 17967 |
| VD fill | 295 | 27787 | 1.06 | 9644 |
| D segment | 426 | 74297 | 0.57 | 10479 |
| DJ fill | 201 | 25084 | 0.8 | 9364 |

Asn

| | | | | |
|---|---|---|---|---|
| | #N | | | |
| VJ fill | 1718 | 59947 | 2.87 | 8567 |
| Jstump | 445 | 72388 | 0.61 | 17967 |
| VD fill | 679 | 27787 | 2.44 | 9644 |
| D segment | 1531 | 74297 | 2.06 | 10479 |
| DJ fill | 1068 | 25084 | 4.26 | 9364 |

Pro

| | | | | |
|---|---|---|---|---|
| | #P | | | |
| VJ fill | 3218 | 59947 | 5.37 | 8567 |
| Jstump | 966 | 72388 | 1.33 | 17967 |
| VD fill | 1921 | 27787 | 6.91 | 9644 |
| D segment | 1716 | 74297 | 2.31 | 10479 |
| DJ fill | 2426 | 25084 | 9.67 | 9364 |

Gln

| | | | | |
|---|---|---|---|---|
| | #Q | | | |
| VJ fill | 1226 | 59947 | 2.05 | 8567 |
| Jstump | 229 | 72388 | 0.32 | 17967 |
| VD fill | 638 | 27787 | 2.3 | 9644 |
| D segment | 552 | 74297 | 0.74 | 10479 |
| DJ fill | 393 | 25084 | 1.57 | 9364 |

Arg

| | | | | |
|---|---|---|---|---|
| | #R | | | |
| VJ fill | 5866 | 59947 | 9.79 | 8567 |
| Jstump | 10 | 72388 | 0.01 | 17967 |
| VD fill | 3144 | 27787 | 11.31 | 9644 |
| D segment | 2935 | 74297 | 3.95 | 10479 |
| DJ fill | 2241 | 25084 | 8.93 | 9364 |

Ser

| | | | | |
|---|---|---|---|---|
| | #S | | | |
| VJ fill | 5384 | 59947 | 8.98 | 8567 |
| Jstump | 172 | 72388 | 0.24 | 17967 |
| VD fill | 1960 | 27787 | 7.05 | 9644 |
| D segment | 12272 | 74297 | 16.52 | 10479 |
| DJ fill | 2386 | 25084 | 9.51 | 9364 |

Thr

| | | | | |
|---|---|---|---|---|
| | #T | | | |
| VJ fill | 2612 | 59947 | 4.36 | 8567 |
| Jstump | 13 | 72388 | 0.02 | 17967 |
| VD fill | 1149 | 27787 | 4.14 | 9644 |
| D segment | 2640 | 74297 | 3.55 | 10479 |
| DJ fill | 1033 | 25084 | 4.12 | 9364 |

Val

| | | | | |
|---|---|---|---|---|
| | #V | | | |
| VJ fill | 2936 | 59947 | 4.9 | 8567 |
| Jstump | 4445 | 72388 | 6.14 | 17967 |
| VD fill | 1646 | 27787 | 5.92 | 9644 |
| D segment | 2954 | 74297 | 3.98 | 10479 |
| DJ fill | 837 | 25084 | 3.34 | 9364 |

Trp

| | | | | |
|---|---|---|---|---|
| | #W | | | |
| VJ fill | 2318 | 59947 | 3.87 | 8567 |
| Jstump | 1147 | 72388 | 1.58 | 17967 |
| VD fill | 525 | 27787 | 1.89 | 9644 |
| D segment | 3996 | 74297 | 5.38 | 10479 |
| DJ fill | 664 | 25084 | 2.65 | 9364 |

Tyr

| | | | | |
|---|---|---|---|---|
| | #Y | | | |
| VJ fill | 2816 | 59947 | 4.7 | 8567 |
| Jstump | 20770 | 72388 | 28.69 | 17967 |
| VD fill | 382 | 27787 | 1.37 | 9644 |
| D segment | 14245 | 74297 | 19.17 | 10479 |
| DJ fill | 1109 | 25084 | 4.42 | 9364 |

TABLE 2215
Prescribed lengths of
CDR3

| Prescribed | Length |
|---|---|
| 0.10 | 14 |
| 0.20 | 13 |
| 0.30 | 12 |
| 0.20 | 11 |
| 0.10 | 10 |
| 0.10 | 9 |

TABLE 2219
Prescribeded lengths
in Library 3

| Length | Fraction |
|---|---|
| 12 | 0.10 |
| 13 | 0.30 |
| 14 | 0.30 |
| 15 | 0.20 |
| 16 | 0.10 |

TABLE 2220
Prescribed lengths in Library 4

| Length | Prescribed Fraction |
|---|---|
| 12 | 0.125 |
| 13 | 0.125 |
| 14 | 0.125 |
| 15 | 0.125 |
| 16 | 0.125 |
| 17 | 0.125 |
| 18 | 0.125 |
| 19 | 0.125 |

TABLE 2221
Analysis of 562C-M0008-C05

#562C-M0008-005 ie6 = 0 ie10 = 0
3-3.2 YYDFWSGYYT Posit = 17 score_D = 21.

| | |
|---|---|
| 36 DTAPTYYDFWSGYFGSDLWRGTNQTVWYQPANWFDP | (SEQ ID NO: 1073) |
| JH5 ----NWFDPWGQGTLVTVSS | (SEQ ID NO: 68) |
| YQPANWFDPWGQGTLVTVSS | (SEQ ID NO: 1074) |
| --------------- | |

(“YYDFWSGYYT” shown above is disclosed as SEQ ID NO: 177)
562C-M0008-C05 Jstump NWFDP (SEQ ID NO: 1075)
562C-M0008-C05 VD fill DTAPT (SEQ ID NO: 994)
562C-M0008-C05 D_inisol YYDFWSGYF (SEQ ID NO: 1076)
562C-M0008-C05 DJ fill FGSDLWRGTNQTVWYQPA (SEQ ID NO: 995)

TABLE 2229
N-mers of 3-22.2

| Sequence | | | Sequence | | |
|---|---|---|---|---|---|
| (SEQ ID | | | (SEQ ID | | |
| NOS 88 and | | | NOS 1091- | | |
| 1077-1090) | Exact | Inclusive | 1103) | Exact | Inclusive |
| YYYDSSGYYY | 30 | 30 | YYYDS | 27 | 338 |
| YYYDSSGYY | 81 | 111 | YYDSS | 26 | 631 |
| YYDSSGYYY | 31 | 61 | YDSSG | 31 | 703 |
| YYYDSSGY | 114 | 225 | DSSGY | 30 | 628 |
| YYDSSGYY | 95 | 237 | SSGYY | 42 | 399 |
| YDSSGYYY | 18 | 79 | SGYYY | 75 | 186 |
| YYYDSSG | 63 | 288 | YYYD | 41 | 379 |
| YYDSSGY | 102 | 453 | YYDS | 39 | 697 |
| YDSSGYY | 34 | 289 | YDSS | 12 | 764 |
| DSSGYYY | 19 | 98 | DSSG | 82 | 870 |
| YYYDSS | 23 | 311 | SSGY | 44 | 727 |
| YYDSSG | 66 | 582 | SGYY | 456 | 930 |
| YDSSGY | 38 | 543 | GYYY | 399 | 585 |
| DSSGYY | 36 | 344 | | | |
| SSGYYY | 13 | 111 | | | |

TABLE 2230
N-mers of 3-3.2

| Sequence | | | Sequence | | |
|---|---|---|---|---|---|
| (SEQ ID NOS | | | (SEQ ID | | |
| 177 and | | | NOS 1118- | | |
| 1104-1117) | Exact | Inclusive | 1130) | Exact | Inclusive |
| YYDFWSGYYT | 45 | 45 | YYDFW | 14 | 425 |
| YYDFWSGYY | 136 | 181 | YDFWS | 17 | 785 |
| YDFWSGYYT | 29 | 74 | DFWSG | 32 | 896 |
| YYDFWSGY | 152 | 333 | FWSGY | 37 | 810 |
| YDFWSGYY | 113 | 323 | WSGYY | 16 | 428 |
| DFWSGYYT | 10 | 84 | SGYYT | 9 | 98 |
| YYDFWSG | 60 | 393 | YYDF | 8 | 433 |
| YDFWSGY | 153 | 628 | YDFW | 20 | 819 |
| DFWSGYY | 47 | 380 | DFWS | 11 | 942 |
| FWSGYYT | 4 | 88 | FWSG | 26 | 1008 |
| YYDFWS | 18 | 411 | WSGY | 23 | 849 |
| YDFWSG | 62 | 750 | SGYY | 495 | 932 |
| DFWSGY | 57 | 742 | GYYT | 6 | 104 |
| FWSGYY | 27 | 411 | | | |
| WSGYYT | 1 | 89 | | | |

TABLE 2231
Selected D segments vs J tally

| | | JH1 | JH2 | JH3 | JH4 | JH5 | JH6 |
|---|---|---|---|---|---|---|---|
| 2-2.2 | GYCSSTSCYT | 5 | 4 | 39 | 51 | 22 | 42 |
| | (SEQ ID NO: 70) | | | | | | |
| 2-15.2 | GYCSGGSCYS | 15 | 19 | 59 | 108 | 17 | 59 |
| | (SEQ ID NO: 136) | | | | | | |
| 3-3.2 | YYDFWSGYYT | 35 | 36 | 197 | 355 | 129 | 453 |
| | (SEQ ID NO: 177) | | | | | | |
| 3-22.2 | YYYDSSGYYY | 63 | 46 | 413 | 530 | 56 | 138 |
| | (SEQ ID NO: 88) | | | | | | |
| 5-5.3 | GYSYGY | 7 | 13 | 62 | 185 | 6 | 106 |
| | (SEQ ID NO: 208) | | | | | | |
| 6-13.1 | GYSSSWY | 17 | 21 | 114 | 222 | 38 | 158 |
| | (SEQ ID NO: 215) | | | | | | |
| 6-19.1 | GYSSGWY | 31 | 39 | 144 | 302 | 50 | 106 |
| | (SEQ ID NO: 218) | | | | | | |
| none | none | 621 | 388 | 2246 | 2949 | 369 | 1999 |

TABLE 2240
Algorithm to determine Jstump

| | |
|---|---|
| MXMMXM | The stump is four long with one non- |
| \| | matching amino acid. |
| MXMXMX | There is no stump, because there are |
| | no two matches in a row. |

TABLE 2250
J vs length

| Length | JH1 | JH2 | JH3 | JH4 | JH5 | JH6 |
|---|---|---|---|---|---|---|
| 1 | 0 | 0 | 0 | 0 | 0 | 0 |
| 2 | 0 | 2 | 0 | 1 | 0 | 0 |
| 3 | 18 | 2 | 3 | 6 | 0 | 3 |
| 4 | 40 | 2 | 8 | 41 | 5 | 8 |
| 5 | 40 | 6 | 9 | 37 | 7 | 10 |
| 6 | 215 | 12 | 36 | 160 | 20 | 28 |
| 7 | 76 | 25 | 94 | 304 | 31 | 70 |
| 8 | 109 | 37 | 230 | 484 | 40 | 93 |
| 9 | 91 | 54 | 460 | 798 | 57 | 201 |
| 10 | 101 | 87 | 539 | 912 | 64 | 209 |
| 11 | 93 | 74 | 491 | 956 | 81 | 281 |
| 12 | 79 | 73 | 535 | 859 | 120 | 289 |
| 13 | 75 | 95 | 501 | 634 | 103 | 304 |
| 14 | 45 | 74 | 461 | 513 | 98 | 338 |
| 15 | 43 | 65 | 353 | 383 | 75 | 367 |
| 16 | 25 | 49 | 304 | 299 | 83 | 439 |
| 17 | 22 | 43 | 229 | 327 | 65 | 379 |
| 18 | 11 | 25 | 168 | 135 | 49 | 336 |
| 19 | 7 | 19 | 99 | 95 | 39 | 296 |
| 20 | 4 | 15 | 55 | 56 | 20 | 232 |
| 21 | 0 | 12 | 38 | 28 | 24 | 172 |
| 22 | 3 | 13 | 28 | 29 | 13 | 138 |
| 23 | 1 | 3 | 20 | 11 | 7 | 85 |
| 24 | 0 | 5 | 9 | 12 | 4 | 49 |
| 25 | 2 | 0 | 1 | 3 | 1 | 25 |
| 26 | 0 | 0 | 3 | 5 | 0 | 15 |
| 27 | 0 | 0 | 2 | 1 | 0 | 6 |
| 28 | 1 | 0 | 0 | 2 | 0 | 3 |
| 29 | 0 | 0 | 0 | 0 | 0 | 2 |
| 30 | 0 | 0 | 0 | 0 | 0 | 3 |
| 31 | 0 | 0 | 1 | 0 | 0 | 1 |
| 32 | 0 | 0 | 0 | 0 | 0 | 0 |
| 33 | 0 | 0 | 0 | 1 | 0 | 0 |
| 34 | 0 | 0 | 0 | 0 | 0 | 0 |
| 35 | 0 | 0 | 0 | 0 | 0 | 0 |
| 36 | 0 | 0 | 0 | 0 | 1 | 0 |

TABLE 2282
Cassette for HC CDR3
The amino acid sequence disclosed in Table 2282 is SEQ ID NO: 1132.
The DNA sequence disclosed in Table 2282 is SEQ ID NO: 1131.

```
--------FR3-------------------------------------------------
  68 69 70 71 72 73 74 75 76 77 78 79 80 81 82
    T I S R D N S K N T L Y L Q M
|act|atc|TCT|AGA|gac|aac|tct|aag|aat|act|ctc|tac|ttg|cag|atg|
                | XbaI |
---FR3---------^{a}------------------------------------------->|
82a 82b 82c 83 84 85 86 87 88 89 90 91 92 93 94
    N S L R A E D T A V Y Y C A K
|aac|agC|TTA|AGg|gct|gag|gac|aCT|GCA|Gtc|tac|tat|tgc|gct|aaa|
              |AflII |  | PstI |(2/2)
.......CDR3.................Jstump..........|----FR4----------
  95 96 97 98 98a 98b 98c 99 100 101 102 103 104 105 106
    D Y E G T G Y A F D I W G Q G
|gac|tat|gaa|ggt|act|ggt|tat|gct|ttc|gaC|ATA|TGg|ggt|caa|ggt|
---------FR4----(JH3)------>|
  107 108 109 110 111 112 113
    T M V T V S S
|act|atG|GTC|ACC|gtc|tct|agt
              | BstEII |
```

TABLE 2283
Analysis of CDR1

| P31 | | % | Cum % | P33 | | % | Cum % | P35 | | % | Cum % |
|---|---|---|---|---|---|---|---|---|---|---|---|
| R | 1665 | 9.1 | 9.1 | P | 1942 | 10.6 | 10.6 | G | 1738 | 9.5 | 9.5 |
| K | 1663 | 9.1 | 18.1 | S | 1458 | 8.0 | 18.5 | H | 1657 | 9.0 | 18.5 |
| W | 1593 | 8.7 | 26.8 | G | 1326 | 7.2 | 25.8 | S | 1519 | 8.3 | 26.8 |
| P | 1445 | 7.9 | 34.7 | T | 1096 | 6.0 | 31.7 | V | 1260 | 6.9 | 33.7 |
| H | 1375 | 7.5 | 42.2 | D | 1078 | 5.9 | 37.6 | M | 1095 | 6.0 | 39.7 |
| N | 1019 | 5.6 | 47.8 | A | 1054 | 5.7 | 43.4 | T | 1059 | 5.8 | 45.5 |
| S | 1014 | 5.5 | 53.3 | K | 1035 | 5.6 | 49.0 | N | 1047 | 5.7 | 51.2 |
| D | 955 | 5.2 | 58.5 | W | 1001 | 5.5 | 54.5 | Y | 1012 | 5.5 | 56.7 |
| A | 936 | 5.1 | 63.6 | N | 966 | 5.3 | 59.7 | A | 984 | 5.4 | 62.1 |
| Q | 896 | 4.9 | 68.5 | R | 933 | 5.1 | 64.8 | W | 904 | 4.9 | 67.0 |
| Y | 841 | 4.6 | 73.1 | H | 839 | 4.6 | 69.4 | F | 891 | 4.9 | 71.9 |
| M | 806 | 4.4 | 77.5 | M | 833 | 4.5 | 73.9 | I | 878 | 4.8 | 76.7 |
| G | 738 | 4.0 | 81.5 | Y | 802 | 4.4 | 78.3 | Q | 875 | 4.8 | 81.4 |
| F | 711 | 3.9 | 85.4 | E | 796 | 4.3 | 82.7 | P | 758 | 4.1 | 85.6 |
| L | 633 | 3.5 | 88.8 | V | 747 | 4.1 | 86.7 | D | 737 | 4.0 | 89.6 |
| E | 618 | 3.4 | 92.2 | F | 702 | 3.8 | 90.6 | L | 600 | 3.3 | 92.9 |
| T | 603 | 3.3 | 95.5 | Q | 662 | 3.6 | 94.2 | E | 560 | 3.1 | 95.9 |
| V | 449 | 2.4 | 97.9 | I | 544 | 3.0 | 97.1 | R | 390 | 2.1 | 98.1 |
| I | 377 | 2.1 | 100 | L | 525 | 2.9 | 100 | K | 354 | 1.9 | 100 |
| C | 2 | 0.0 | 100 | C | 0 | 0.0 | 100 | C | 1 | 0.0 | 100 |
| | 18339 | | | | 18339 | | | | 18319 | | |

TABLE 3001
Frequencies of JKs with A27

| Table 3001: A27::JK | | | |
|---|---|---|---|
| A27 VKIII 1483 | | | |
| | Freq in 1483 | Freq in 9310 | |
| name | A27s | Abs | |
| JK1 | 502 | 2846 | WTFGQGTKVEIK |
| | | | (SEQ ID NO: 1133) |
| JK2 | 363 | 1752 | YTFGQGTKLEIK |
| | | | (SEQ ID NO: 1134) |
| JK3 | 160 | 1153 | FTFGPGTKVDIK |
| | | | (SEQ ID NO: 1135) |
| JK4 | 297 | 2561 | LTFGGGTKVEIK |
| | | | (SEQ ID NO: 1136) |
| JK5 | 161 | 998 | ITFGQGTRLEIK |
| | | | (SEQ ID NO: 1137) |

TABLE 3005
Lengths of CDRs in A27s

| Length | CDR1 | CDR2 | CDR3 |
|---|---|---|---|
| 0 | 0 | 0 | 0 |
| 1 | 0 | 0 | 0 |
| 2 | 1 | 0 | 0 |
| 3 | 0 | 0 | 0 |
| 4 | 0 | 0 | 0 |
| 5 | 0 | 7 | 29 |
| 6 | 0 | 0 | 20 |
| 7 | 0 | 1439 | 10 |
| 8 | 0 | 37 | 179 |
| 9 | 0 | 0 | 835 |
| 10 | 3 | 0 | 312 |
| 11 | 181 | 0 | 88 |
| 12 | 1291 | 0 | 8 |
| 13 | 6 | 0 | 1 |
| 14 | 0 | 0 | 1 |

Table 3007 shows the base usage in the overall HC CDR3s and in the regions VJ fill, VD fill, D segment, DJ fill, and J stump. Notice that VJ fill is very high in G which is consistent with the high use Gly in this region; VJ fill accounts for about 23% of the bases. VD fill is even higher in G, consistent with being rich in Gly. VD fills are short and account for only about 9% of the bases. The sequences that come from D contribute about 26% of the CDR3 bases and are rich in T and G with A exceeding C. This is consistent with the high portion of Tyr (TAy). In the portion that comes from D regions, TAT codons outnumber TAC by 7847 to 5946. DJ fill has the highest G usage, 39%. In Jstump, T is very high, 35%. In Jstump, TAC codons outnumber TAT codons by 23170 to 1166.

TABLE 3007
Base Usage in CDR3

| | | | | | Number |
|---|---|---|---|---|---|
| | | | | | of |
| | T | C | A | G | bases |
| Overall | 232290 | 172221 | 174040 | 235907 | 814458 |
| % | 28.52 | 21.15 | 21.37 | 28.96 | |
| VJ fill | 37814 | 40356 | 37676 | 69623 | 185469 |
| % | 20.39 | 21.76 | 20.31 | 37.54 | |
| VD fill | 12818 | 17579 | 13829 | 27366 | 71592 |
| % | 17.90 | 24.55 | 19.32 | 38.22 | |
| from D | 66551 | 31887 | 48096 | 65848 | 212382 |
| % | 31.34 | 15.01 | 22.65 | 31.00 | |
| DJ fill | 8234 | 11271 | 7426 | 17291 | 44222 |
| % | 18.62 | 25.49 | 16.79 | 39.10 | |
| Jstump | 96758 | 66281 | 62763 | 49924 | 275726 |
| % | 35.09 | 24.04 | 22.76 | 18.11 | |

TABLE 3305
Distribution of AATs in Abs with CDR3 Len 3 N = 32

| | | | | | |
|---|---|---|---|---|---|
| P1 | % | P2 | % | P3 | % |

| | | | | | | | | |
|---|---|---|---|---|---|---|---|---|
| G | 16 | 50.00 | G | 11 | 34.38 | Y | 6 | 18.75 |
| E | 3 | 9.38 | D | 5 | 15.63 | L | 5 | 15.63 |
| R | 3 | 9.38 | S | 4 | 12.50 | R | 4 | 12.50 |
| S | 3 | 9.38 | E | 2 | 6.25 | V | 4 | 12.50 |
| I | 2 | 6.25 | R | 2 | 6.25 | F | 3 | 9.38 |
| F | 1 | 3.13 | F | 1 | 3.13 | N | 3 | 9.38 |
| L | 1 | 3.13 | H | 1 | 3.13 | A | 2 | 6.25 |
| M | 1 | 3.13 | I | 1 | 3.13 | H | 2 | 6.25 |
| N | 1 | 3.13 | K | 1 | 3.13 | G | 1 | 3.13 |
| Q | 1 | 3.13 | N | 1 | 3.13 | I | 1 | 3.13 |
| A | 0 | 0.00 | Q | 1 | 3.13 | T | 1 | 3.13 |
| C | 0 | 0.00 | W | 1 | 3.13 | C | 0 | 0.00 |
| D | 0 | 0.00 | Y | 1 | 3.13 | D | 0 | 0.00 |
| H | 0 | 0.00 | A | 0 | 0.00 | E | 0 | 0.00 |
| K | 0 | 0.00 | C | 0 | 0.00 | K | 0 | 0.00 |
| P | 0 | 0.00 | L | 0 | 0.00 | M | 0 | 0.00 |
| T | 0 | 0.00 | M | 0 | 0.00 | P | 0 | 0.00 |
| V | 0 | 0.00 | P | 0 | 0.00 | Q | 0 | 0.00 |
| W | 0 | 0.00 | T | 0 | 0.00 | S | 0 | 0.00 |
| Y | 0 | 0.00 | V | 0 | 0.00 | W | 0 | 0.00 |

TABLE 3306
Distribution of AATs in Abs with CDR3 Len 4, N = 104

| P1 | | % | P2 | | % | P3 | | % | P4 | | % |
|---|---|---|---|---|---|---|---|---|---|---|---|
| D | 27 | 25.96 | G | 18 | 17.31 | G | 30 | 28.85 | Y | 37 | 35.58 |
| G | 21 | 20.19 | L | 17 | 16.35 | D | 23 | 22.12 | I | 8 | 7.69 |
| S | 9 | 8.65 | F | 16 | 15.38 | E | 9 | 8.65 | V | 8 | 7.69 |
| R | 8 | 7.69 | R | 11 | 10.58 | K | 6 | 5.77 | D | 6 | 5.77 |
| Q | 6 | 5.77 | S | 7 | 6.73 | R | 6 | 5.77 | H | 6 | 5.77 |
| E | 5 | 4.81 | A | 5 | 4.81 | A | 4 | 3.85 | G | 5 | 4.81 |
| P | 5 | 4.81 | P | 5 | 4.81 | S | 4 | 3.85 | N | 5 | 4.81 |
| A | 4 | 3.85 | E | 4 | 3.85 | V | 4 | 3.85 | P | 5 | 4.81 |
| V | 4 | 3.85 | T | 4 | 3.85 | L | 3 | 2.88 | R | 5 | 4.81 |
| F | 2 | 1.92 | Y | 4 | 3.85 | Q | 3 | 2.88 | F | 4 | 3.85 |
| K | 2 | 1.92 | M | 3 | 2.88 | T | 3 | 2.88 | S | 4 | 3.85 |
| L | 2 | 1.92 | D | 2 | 1.92 | Y | 3 | 2.88 | T | 3 | 2.88 |
| N | 2 | 1.92 | K | 2 | 1.92 | W | 2 | 1.92 | A | 2 | 1.92 |
| T | 2 | 1.92 | V | 2 | 1.92 | F | 1 | 0.96 | E | 2 | 1.92 |
| W | 2 | 1.92 | W | 2 | 1.92 | H | 1 | 0.96 | L | 2 | 1.92 |
| Y | 2 | 1.92 | H | 1 | 0.96 | I | 1 | 0.96 | M | 1 | 0.96 |
| I | 1 | 0.96 | Q | 1 | 0.96 | N | 1 | 0.96 | Q | 1 | 0.96 |
| C | 0 | 0.00 | C | 0 | 0.00 | C | 0 | 0.00 | C | 0 | 0.00 |
| H | 0 | 0.00 | I | 0 | 0.00 | M | 0 | 0.00 | K | 0 | 0.00 |
| M | 0 | 0.00 | N | 0 | 0.00 | P | 0 | 0.00 | W | 0 | 0.00 |

TABLE 3307
Distribution of AATs in CDR3 having Len 5 N = 109

| P1 | | % | P2 | | % | P3 | | % | P4 | | % | P5 | | % |
|---|---|---|---|---|---|---|---|---|---|---|---|---|---|---|
| G | 40 | 36.70 | G | 16 | 14.68 | G | 39 | 35.78 | D | 38 | 34.86 | Y | 37 | 33.94 |
| D | 12 | 11.01 | P | 12 | 11.01 | F | 18 | 16.51 | G | 31 | 28.44 | V | 12 | 11.01 |
| L | 10 | 9.17 | T | 11 | 10.09 | L | 12 | 11.01 | A | 6 | 5.50 | D | 11 | 10.09 |
| V | 8 | 7.34 | D | 9 | 8.26 | R | 6 | 5.50 | R | 5 | 4.59 | I | 10 | 9.17 |
| A | 7 | 6.42 | Y | 9 | 8.26 | S | 6 | 5.50 | E | 4 | 3.67 | N | 6 | 5.50 |
| S | 7 | 6.42 | R | 7 | 6.42 | W | 5 | 4.59 | S | 4 | 3.67 | S | 6 | 5.50 |
| F | 6 | 5.50 | V | 7 | 6.42 | A | 4 | 3.67 | M | 3 | 2.75 | F | 4 | 3.67 |
| H | 5 | 4.59 | A | 6 | 5.50 | K | 4 | 3.67 | Y | 3 | 2.75 | G | 4 | 3.67 |
| I | 4 | 3.67 | L | 6 | 5.50 | M | 3 | 2.75 | F | 2 | 1.83 | A | 3 | 2.75 |
| R | 3 | 2.75 | Q | 5 | 4.59 | P | 3 | 2.75 | I | 2 | 1.83 | H | 3 | 2.75 |
| Q | 2 | 1.83 | W | 5 | 4.59 | D | 2 | 1.83 | K | 2 | 1.83 | L | 3 | 2.75 |
| W | 2 | 1.83 | S | 4 | 3.67 | E | 2 | 1.83 | L | 2 | 1.83 | P | 3 | 2.75 |
| E | 1 | 0.92 | F | 3 | 2.75 | H | 1 | 0.92 | T | 2 | 1.83 | R | 3 | 2.75 |
| P | 1 | 0.92 | K | 3 | 2.75 | I | 1 | 0.92 | N | 1 | 0.92 | T | 2 | 1.83 |
| Y | 1 | 0.92 | N | 3 | 2.75 | Q | 1 | 0.92 | P | 1 | 0.92 | K | 1 | 0.92 |
| C | 0 | 0.00 | E | 2 | 1.83 | T | 1 | 0.92 | Q | 1 | 0.92 | Q | 1 | 0.92 |
| K | 0 | 0.00 | H | 1 | 0.92 | V | 1 | 0.92 | V | 1 | 0.92 | C | 0 | 0.00 |
| M | 0 | 0.00 | C | 0 | 0.00 | C | 0 | 0.00 | W | 1 | 0.92 | E | 0 | 0.00 |
| N | 0 | 0.00 | I | 0 | 0.00 | N | 0 | 0.00 | C | 0 | 0.00 | M | 0 | 0.00 |
| T | 0 | 0.00 | M | 0 | 0.00 | Y | 0 | 0.00 | H | 0 | 0.00 | W | 0 | 0.00 |

TABLE 2263A
Composition of CDR1
CDR1

| | A | C | D | E | F | G | H | I | K | L |
|---|---|---|---|---|---|---|---|---|---|---|
| P31 | 936 | 2 | 955 | 618 | 711 | 738 | 1375 | 377 | 1663 | 633 |
| P32 | 0 | 0 | 0 | 0 | 0 | 0 | 0 | 0 | 0 | 0 |
| P33 | 1054 | 0 | 1078 | 796 | 702 | 1326 | 839 | 544 | 1035 | 525 |
| P34 | 0 | 0 | 0 | 0 | 0 | 0 | 0 | 0 | 0 | 0 |
| P35 | 984 | 1 | 737 | 560 | 891 | 1738 | 1657 | 878 | 354 | 600 |

| | M | N | P | Q | R | S | T | V | W | Y |
|---|---|---|---|---|---|---|---|---|---|---|
| P31 | 806 | 1019 | 1445 | 896 | 1665 | 1014 | 603 | 449 | 1593 | 841 |
| P32 | 0 | 0 | 0 | 0 | 0 | 0 | 0 | 0 | 0 | 18339 |
| P33 | 833 | 966 | 1942 | 662 | 933 | 1458 | 1096 | 747 | 1001 | 802 |
| P34 | 18339 | 0 | 0 | 0 | 0 | 0 | 0 | 0 | 0 | 0 |
| P35 | 1095 | 1047 | 758 | 875 | 390 | 1519 | 1059 | 1260 | 904 | 1012 |

At 31; 33; 35; ADEFGHIKLMNPQRSTVWY (no C) allowed. GL: SAS

TABLE 2263B
Composition of CDR2
CDR2

| | A | C | D | E | F | G | H | I | K | L |
|---|---|---|---|---|---|---|---|---|---|---|
| P50 | 8 | 4 | 4 | 0 | 2 | 3131 | 4 | 2 | 0 | 2 |
| P51 | 0 | 0 | 0 | 0 | 0 | 0 | 0 | 18339 | 0 | 0 |
| P52 | 6 | 0 | 7 | 1 | 0 | 2380 | 5 | 0 | 3 | 9 |
| P52a | 0 | 0 | 0 | 0 | 9 | 0 | 0 | 0 | 0 | 10 |
| P53 | 0 | 1 | 0 | 0 | 5 | 6 | 0 | 0 | 0 | 0 |
| P54 | 0 | 7 | 8 | 0 | 0 | 18264 | 0 | 0 | 0 | 0 |
| P55 | 3 | 10 | 16 | 1 | 0 | 18273 | 0 | 1 | 0 | 1 |
| P56 | 806 | 0 | 501 | 364 | 1788 | 767 | 1037 | 773 | 1259 | 1042 |
| P57 | 0 | 0 | 0 | 0 | 0 | 0 | 0 | 0 | 0 | 0 |
| P58 | 1033 | 1 | 854 | 616 | 1008 | 797 | 1055 | 664 | 1590 | 941 |

| | M | N | P | Q | R | S | T | V | W | Y |
|---|---|---|---|---|---|---|---|---|---|---|
| P50 | 0 | 0 | 1 | 0 | 1375 | 7263 | 0 | 1999 | 1176 | 3368 |
| P51 | 0 | 0 | 0 | 0 | 0 | 0 | 0 | 0 | 0 | 0 |
| P52 | 0 | 0 | 3 | 0 | 1610 | 6908 | 0 | 2097 | 1308 | 4002 |
| P52a | 0 | 0 | 10930 | 0 | 1 | 7385 | 3 | 0 | 0 | 1 |
| P53 | 0 | 0 | 0 | 0 | 0 | 18318 | 5 | 0 | 0 | 4 |
| P54 | 0 | 0 | 0 | 0 | 23 | 8 | 0 | 29 | 0 | 0 |
| P55 | 0 | 2 | 0 | 1 | 4 | 6 | 1 | 19 | 1 | 0 |
| P56 | 890 | 870 | 998 | 658 | 1194 | 1098 | 793 | 741 | 1181 | 1579 |
| P57 | 0 | 0 | 0 | 0 | 0 | 0 | 18339 | 0 | 0 | 0 |
| P58 | 914 | 929 | 709 | 886 | 1271 | 1299 | 1052 | 733 | 851 | 1136 |

At 50 & 52; allowed GSRVWY. GL A50; S52
At 52a; allowed PS. GL: G52a
At 56 & 58; allowed ADEFGHIKLMNPQRSTVWY. GL: S56; Y58

TABLE 3006
Lengths of Jstump (“HQFYEA,” “LDFYWY,” “IDFAX,” “YDFYX,” “PDFWNX,” and
“VDMGYYYYY” disclosed as SEQ ID NOS 1138-1143, respectively)

| | JH1 | | | | JH2 | | | | JH3 | | | |
|---|---|---|---|---|---|---|---|---|---|---|---|---|
| | | | with | | all | no | with | | | | with | |
| | all | no D | D | | all | D | D | | all | no D | D | |
| Number | 828 | 448 | 380 | Seq | 1311 | 965 | 346 | Seq | 5471 | 2887 | 2584 | Seq |
| 0 | 152 | 106 | 46 | | 23 | 19 | 4 | | 45 | 32 | 13 | |
| 1 | 267 | 122 | 145 | H | 13 | 11 | 2 | L | 33 | 20 | 13 | I |
| 2 | 141 | 120 | 21 | Q | 10 | 8 | 2 | D | 58 | 45 | 13 | D |
| 3 | 50 | 27 | 23 | F | 70 | 56 | 14 | F | 103 | 56 | 47 | F |
| 4 | 102 | 40 | 62 | Y | 55 | 26 | 29 | Y | 1353 | 730 | 623 | A |
| 5 | 52 | 16 | 36 | E | 268 | 141 | 127 | W | 3879 | 2004 | 1875 | X |
| 6 | 64 | 17 | 47 | A | 872 | 704 | 168 | Y | | | | |
| 7 | | | | | | | | | | | | |
| 8 | | | | | | | | | | | | |
| 9 | | | | | | | | | | | | |
| Median | 0.98 | 0.97 | 0.99 | | 5.25 | 5.32 | 4.96 | | 4.3 | 4.28 | 4.31 | |
| | JH4 | | | | JH5 | | | | JH6 | | | |
| | | | with | | | no | with | | | | with | |
| | all | noD | D | | all | D | D | | all | no D | D | |
| Number | 7917 | 3395 | 4522 | Seq | 1360 | 581 | 779 | Seq | 4691 | 2154 | 2537 | Seq |
| 0 | 91 | 51 | 40 | | 132 | 83 | 49 | | 18 | 11 | 7 | |
| 1 | 408 | 169 | 239 | Y | 101 | 64 | 37 | P | 23 | 15 | 8 | V |
| 2 | 1072 | 429 | 643 | D | 34 | 17 | 17 | D | 39 | 26 | 13 | D |
| 3 | 3332 | 1417 | 1915 | F | 137 | 74 | 63 | F | 280 | 151 | 129 | M |
| 4 | 1710 | 806 | 904 | Y | 424 | 169 | 255 | W | 337 | 183 | 154 | G |
| 5 | 1304 | 523 | 781 | X | 323 | 112 | 211 | N | 457 | 246 | 211 | Y |
| 6 | | | | | 209 | 62 | 147 | X | 498 | 269 | 229 | Y |
| 7 | | | | | | | | | 693 | 325 | 368 | Y |
| 8 | | | | | | | | | 1139 | 435 | 704 | Y |
| 9 | | | | | | | | | 1207 | 493 | 714 | Y |
| Median | 2.72 | 2.74 | 2.70 | | 3.65 | 3.31 | 3.88 | | 7.00 | 6.54 | 7.21 | |

Tables 225, 226, 227, 228, 229, and 2210 are distributions of JH1 to JH6

TABLE 225
JH1 ---AEYFQHWGQGTLVTVSS 1101 (SEQ ID NO: 66)

| | A | C | D | E | F | G | H | I | K | L | M | N | P | Q | R | S | T | V | W | Y | Δ |
|---|---|---|---|---|---|---|---|---|---|---|---|---|---|---|---|---|---|---|---|---|---|
| P4 | 31 | 0 | 0 | 0 | 0 | 0 | 0 | 0 | 0 | 0 | 0 | 0 | 0 | 0 | 0 | 0 | 0 | 0 | 0 | 0 | 1070 |
| P5 | 0 | 0 | 0 | 70 | 0 | 0 | 0 | 0 | 0 | 0 | 0 | 0 | 0 | 0 | 0 | 0 | 0 | 0 | 0 | 0 | 1031 |
| P6 | 0 | 0 | 0 | 0 | 0 | 0 | 0 | 0 | 0 | 0 | 0 | 0 | 1 | 0 | 0 | 0 | 0 | 0 | 0 | 175 | 925 |
| P7 | 0 | 0 | 0 | 0 | 220 | 0 | 0 | 0 | 0 | 1 | 0 | 0 | 0 | 0 | 0 | 0 | 0 | 0 | 0 | 0 | 880 |
| P8 | 0 | 0 | 11 | 1 | 0 | 0 | 4 | 0 | 0 | 0 | 0 | 0 | 0 | 218 | 2 | 0 | 0 | 0 | 0 | 0 | 865 |
| P9 | 0 | 1 | 0 | 0 | 0 | 0 | 417 | 0 | 0 | 1 | 0 | 2 | 1 | 1 | 0 | 0 | 0 | 0 | 0 | 5 | 673 |

TABLE 226
JH2 ---YWYFDLWGRGTLVTVSS 792
(SEQ ID NO: 67)

| | A | C | D | E | F | G | H | I | K | L | M | N | P | Q | R | S | T | V | W | Y | Δ |
|---|---|---|---|---|---|---|---|---|---|---|---|---|---|---|---|---|---|---|---|---|---|
| P4 | 0 | 0 | 0 | 0 | 0 | 0 | 0 | 0 | 0 | 0 | 0 | 0 | 0 | 0 | 0 | 0 | 0 | 0 | 0 | 118 | 674 |
| P5 | 0 | 0 | 0 | 0 | 0 | 0 | 0 | 0 | 0 | 0 | 0 | 0 | 0 | 0 | 0 | 0 | 0 | 0 | 395 | 0 | 397 |
| P6 | 0 | 0 | 1 | 0 | 1 | 0 | 0 | 0 | 0 | 0 | 0 | 1 | 0 | 0 | 0 | 1 | 0 | 0 | 0 | 565 | 223 |
| P7 | 0 | 0 | 0 | 0 | 662 | 0 | 0 | 2 | 0 | 4 | 0 | 1 | 0 | 0 | 0 | 0 | 0 | 0 | 0 | 1 | 122 |
| P8 | 0 | 0 | 693 | 0 | 0 | 1 | 0 | 0 | 0 | 0 | 0 | 2 | 0 | 0 | 0 | 0 | 0 | 0 | 0 | 0 | 96 |
| P9 | 0 | 0 | 1 | 0 | 13 | 0 | 3 | 5 | 0 | 637 | 0 | 4 | 1 | 0 | 0 | 3 | 1 | 12 | 1 | 23 | 88 |

TABLE 227
JH3 AFDIWGQGTMVTVSS 4677 (SEQ ID NO: 2)

| | A | C | D | E | F | G | H | I | K | L | M | N | P | Q | R | S | T | V | W | Y | Δ |
|---|---|---|---|---|---|---|---|---|---|---|---|---|---|---|---|---|---|---|---|---|---|
| P6 | 4092 | 0 | 0 | 0 | 0 | 0 | 0 | 0 | 0 | 0 | 0 | 0 | 0 | 0 | 0 | 0 | 0 | 0 | 0 | 0 | 585 |
| P7 | 0 | 0 | 0 | 0 | 4438 | 0 | 0 | 0 | 0 | 0 | 0 | 0 | 0 | 0 | 0 | 0 | 0 | 0 | 0 | 0 | 239 |
| P8 | 3 | 0 | 4507 | 6 | 0 | 7 | 10 | 0 | 0 | 0 | 0 | 4 | 0 | 0 | 0 | 0 | 0 | 0 | 0 | 0 | 140 |
| P9 | 3 | 2 | 0 | 0 | 27 | 0 | 0 | 4380 | 0 | 30 | 30 | 8 | 1 | 0 | 1 | 14 | 4 | 72 | 0 | 5 | 100 |

TABLE 228
JH4 YFDYWGQGTLVTVSS 7092 (SEQ ID NO: 1)

| | A | C | D | E | F | G | H | I | K | L | M | N | P | Q | R | S | T | V | W | Y | Δ |
|---|---|---|---|---|---|---|---|---|---|---|---|---|---|---|---|---|---|---|---|---|---|
| P6 | 0 | 0 | 0 | 0 | 0 | 0 | 0 | 0 | 0 | 0 | 0 | 0 | 0 | 0 | 0 | 0 | 0 | 0 | 0 | 1661 | 5431 |
| P7 | 0 | 0 | 0 | 0 | 4038 | 0 | 0 | 0 | 0 | 0 | 0 | 0 | 0 | 0 | 0 | 0 | 0 | 0 | 0 | 0 | 3054 |
| P8 | 2 | 0 | 6069 | 6 | 0 | 8 | 2 | 0 | 0 | 0 | 0 | 7 | 0 | 0 | 1 | 0 | 0 | 1 | 0 | 5 | 991 |
| P9 | 2 | 15 | 8 | 0 | 65 | 0 | 0 | 0 | 2 | 0 | 0 | 30 | 11 | 9 | 4 | 116 | 3 | 1 | 3 | 6651 | 172 |

TABLE 229
JH5 ----NWFDPWGQGTLVTVSS 1007
(SEQ ID NO: 68)

| | A | C | D | E | F | G | H | I | K | L | M | N | P | Q | R | S | T | V | W | Y | Δ |
|---|---|---|---|---|---|---|---|---|---|---|---|---|---|---|---|---|---|---|---|---|---|
| P5 | 0 | 0 | 0 | 0 | 0 | 0 | 0 | 0 | 0 | 0 | 0 | 371 | 0 | 0 | 0 | 0 | 0 | 0 | 0 | 0 | 636 |
| P6 | 0 | 0 | 0 | 0 | 0 | 0 | 0 | 0 | 0 | 0 | 0 | 0 | 0 | 0 | 0 | 0 | 0 | 0 | 748 | 0 | 259 |
| P7 | 0 | 0 | 0 | 0 | 900 | 0 | 0 | 0 | 0 | 2 | 0 | 0 | 0 | 0 | 0 | 0 | 0 | 0 | 0 | 1 | 104 |
| P8 | 2 | 0 | 937 | 1 | 0 | 0 | 0 | 0 | 0 | 0 | 0 | 1 | 0 | 0 | 0 | 0 | 0 | 0 | 0 | 1 | 65 |
| P9 | 3 | 0 | 1 | 0 | 2 | 0 | 2 | 0 | 0 | 3 | 0 | 0 | 946 | 0 | 0 | 15 | 1 | 0 | 0 | 0 | 34 |

TABLE 2210
JH6 YYYYYGMDVWGQGTTVTVSS 4382 (SEQ ID NO: 3)

| | A | C | D | E | F | G | H | I | K | L | M | N | P | Q | R | S | T | V | W | Y | Δ |
|---|---|---|---|---|---|---|---|---|---|---|---|---|---|---|---|---|---|---|---|---|---|
| P1 | 0 | 0 | 0 | 0 | 0 | 0 | 0 | 0 | 0 | 0 | 0 | 0 | 0 | 0 | 0 | 0 | 0 | 0 | 0 | 575 | 3807 |
| P2 | 0 | 0 | 0 | 0 | 0 | 0 | 0 | 0 | 0 | 0 | 0 | 0 | 0 | 0 | 0 | 0 | 0 | 0 | 0 | 1646 | 2736 |
| P3 | 0 | 0 | 1 | 1 | 2 | 2 | 2 | 0 | 2 | 0 | 0 | 3 | 0 | 0 | 0 | 5 | 1 | 0 | 0 | 2453 | 1910 |
| P4 | 0 | 0 | 0 | 0 | 3 | 0 | 3 | 0 | 0 | 1 | 0 | 1 | 2 | 0 | 0 | 3 | 0 | 0 | 0 | 2926 | 1443 |
| P5 | 0 | 0 | 0 | 0 | 7 | 2 | 6 | 1 | 0 | 0 | 0 | 5 | 1 | 0 | 1 | 7 | 0 | 0 | 0 | 3414 | 938 |
| P6 | 32 | 3 | 2 | 0 | 1 | 3241 | 3 | 1 | 0 | 0 | 0 | 2 | 2 | 1 | 1 | 8 | 1 | 4 | 0 | 545 | 535 |
| P7 | 0 | 0 | 0 | 0 | 1 | 0 | 0 | 7 | 1 | 49 | 4107 | 0 | 0 | 0 | 0 | 0 | 2 | 8 | 0 | 0 | 207 |
| P8 | 1 | 0 | 4297 | 2 | 0 | 6 | 1 | 0 | 0 | 0 | 0 | 3 | 0 | 0 | 0 | 0 | 0 | 0 | 0 | 0 | 72 |
| P9 | 5 | 0 | 1 | 0 | 0 | 1 | 0 | 8 | 0 | 3 | 0 | 0 | 0 | 0 | 0 | 0 | 0 | 4347 | 0 | 0 | 17 |

TABLE 2211A
distribution of AATs for VJ fill, P1-P4

| OA | | % | cum % | P1 | | % | cum % | P2 | | % | cum % | P3 | | % | cum % | P4 | | % | cum % |
|---|---|---|---|---|---|---|---|---|---|---|---|---|---|---|---|---|---|---|---|
| G | 11309 | 18.9 | 18.9 | G | 1850 | 21.7 | 21.7 | G | 1582 | 18.6 | 18.6 | G | 1701 | 20.3 | 20.3 | G | 1667 | 21.0 | 21.0 |
| R | 5851 | 9.8 | 28.7 | D | 1574 | 18.5 | 40.2 | R | 1206 | 14.2 | 32.7 | R | 1092 | 13.0 | 33.4 | S | 821 | 10.3 | 31.3 |
| S | 5378 | 9.0 | 37.7 | V | 713 | 8.4 | 48.6 | S | 845 | 9.9 | 42.6 | S | 767 | 9.2 | 42.5 | R | 721 | 9.1 | 40.4 |
| D | 4382 | 7.3 | 45.0 | E | 704 | 8.3 | 56.8 | L | 703 | 8.3 | 50.9 | L | 508 | 6.1 | 48.6 | L | 511 | 6.4 | 46.8 |
| L | 4053 | 6.8 | 51.7 | A | 607 | 7.1 | 64.0 | P | 648 | 7.6 | 58.5 | A | 500 | 6.0 | 54.6 | A | 503 | 6.3 | 53.2 |
| A | 3547 | 5.9 | 57.7 | S | 580 | 6.8 | 70.8 | V | 418 | 4.9 | 63.4 | P | 454 | 5.4 | 60.0 | W | 468 | 5.9 | 59.1 |
| P | 3214 | 5.4 | 63.0 | R | 490 | 5.8 | 76.5 | A | 391 | 4.6 | 68.0 | Y | 435 | 5.2 | 65.2 | Y | 467 | 5.9 | 64.9 |
| V | 2930 | 4.9 | 67.9 | L | 363 | 4.3 | 80.8 | T | 379 | 4.4 | 72.4 | V | 400 | 4.8 | 70.0 | V | 374 | 4.7 | 69.6 |
| Y | 2814 | 4.7 | 72.6 | I | 278 | 3.3 | 84.0 | D | 295 | 3.5 | 75.9 | W | 398 | 4.8 | 74.7 | P | 370 | 4.7 | 74.3 |
| T | 2606 | 4.4 | 77.0 | H | 240 | 2.8 | 86.9 | K | 251 | 2.9 | 78.9 | T | 351 | 4.2 | 78.9 | T | 370 | 4.7 | 79.0 |
| W | 2315 | 3.9 | 80.9 | T | 215 | 2.5 | 89.4 | N | 251 | 2.9 | 81.8 | D | 302 | 3.6 | 82.6 | D | 316 | 4.0 | 82.9 |
| E | 1801 | 3.0 | 83.9 | Q | 172 | 2.0 | 91.4 | Q | 248 | 2.9 | 84.7 | K | 261 | 3.1 | 85.7 | N | 251 | 3.2 | 86.1 |
| N | 1714 | 2.9 | 86.7 | P | 163 | 1.9 | 93.3 | I | 246 | 2.9 | 87.6 | F | 201 | 2.4 | 88.1 | F | 219 | 2.8 | 88.8 |
| F | 1702 | 2.8 | 89.6 | W | 113 | 1.3 | 94.6 | Y | 199 | 2.3 | 89.9 | E | 194 | 2.3 | 90.4 | Q | 180 | 2.3 | 91.1 |
| I | 1478 | 2.5 | 92.0 | F | 104 | 1.2 | 95.9 | H | 194 | 2.3 | 92.2 | I | 188 | 2.2 | 92.6 | I | 170 | 2.1 | 93.3 |
| K | 1425 | 2.4 | 94.4 | Y | 90 | 1.1 | 96.9 | W | 191 | 2.2 | 94.5 | N | 187 | 2.2 | 94.9 | K | 153 | 1.9 | 95.2 |
| H | 1372 | 2.3 | 96.7 | K | 89 | 1.0 | 98.0 | F | 186 | 2.2 | 96.6 | Q | 171 | 2.0 | 96.9 | E | 148 | 1.9 | 97.0 |
| Q | 1225 | 2.0 | 98.8 | N | 88 | 1.0 | 99.0 | E | 180 | 2.1 | 98.8 | H | 147 | 1.8 | 98.7 | H | 130 | 1.6 | 98.7 |
| M | 646 | 1.1 | 99.8 | M | 84 | 1.0 | 100.0 | M | 100 | 1.2 | 99.9 | M | 102 | 1.2 | 99.9 | M | 99 | 1.2 | 99.9 |
| C | 95 | 0.2 | 100.0 | C | 2 | 0.0 | 100.0 | C | 6 | 0.1 | 100.0 | C | 9 | 0.1 | 100.0 | C | 6 | 0.1 | 100.0 |
| | 59857 | | | | 8519 | | | | 8519 | | | | 8368 | | | | 7944 | | |

TABLE 2211B
distribution of AATs for VJ fill, P5-P8

| P5 | | % | cum % | P6 | | % | cum % | P7 | | % | cum % | P8 | | % | cum % |
|---|---|---|---|---|---|---|---|---|---|---|---|---|---|---|---|
| G | 1376 | 19.0 | 19.04 | G | 1047 | 17.3 | 17.3 | G | 806 | 17.9 | 17.9 | G | 462 | 14.1 | 14.1 |
| S | 692 | 9.6 | 28.6 | S | 559 | 9.3 | 26.6 | R | 416 | 9.2 | 27.1 | S | 307 | 9.4 | 23.5 |
| R | 645 | 8.9 | 37.5 | R | 534 | 8.8 | 35.4 | S | 388 | 8.6 | 35.7 | R | 305 | 9.3 | 32.9 |
| L | 515 | 7.1 | 44.7 | D | 439 | 7.3 | 42.7 | L | 332 | 7.4 | 43.0 | L | 272 | 8.3 | 41.2 |
| A | 461 | 6.4 | 51.1 | L | 430 | 7.1 | 49.8 | P | 315 | 7.0 | 50.0 | D | 255 | 7.8 | 49.0 |
| Y | 428 | 5.9 | 57.0 | A | 381 | 6.3 | 56.1 | D | 310 | 6.9 | 56.9 | P | 226 | 6.9 | 55.9 |
| W | 425 | 5.9 | 62.9 | P | 351 | 5.8 | 61.9 | A | 253 | 5.6 | 62.5 | Y | 212 | 6.5 | 62.4 |
| D | 404 | 5.6 | 68.4 | Y | 347 | 5.7 | 67.7 | Y | 248 | 5.5 | 68.0 | A | 192 | 5.9 | 68.3 |
| T | 333 | 4.6 | 73.1 | T | 336 | 5.6 | 73.2 | T | 200 | 4.4 | 72.4 | T | 153 | 4.7 | 73.0 |
| P | 311 | 4.3 | 77.4 | W | 264 | 4.4 | 77.6 | W | 184 | 4.1 | 76.5 | F | 135 | 4.1 | 77.1 |
| V | 300 | 4.2 | 81.5 | V | 235 | 3.9 | 81.5 | V | 174 | 3.9 | 80.3 | V | 135 | 4.1 | 81.2 |
| K | 264 | 3.7 | 85.2 | N | 232 | 3.8 | 85.3 | F | 153 | 3.4 | 83.7 | W | 122 | 3.7 | 85.0 |
| F | 220 | 3.0 | 88.2 | F | 204 | 3.4 | 88.7 | H | 139 | 3.1 | 86.8 | N | 100 | 3.1 | 88.0 |
| N | 212 | 2.9 | 91.1 | E | 135 | 2.2 | 91.0 | N | 134 | 3.0 | 89.8 | H | 98 | 3.0 | 91.0 |
| I | 160 | 2.2 | 93.4 | H | 129 | 2.1 | 93.1 | I | 117 | 2.6 | 92.4 | E | 73 | 2.2 | 93.3 |
| E | 141 | 2.0 | 95.3 | K | 127 | 2.1 | 95.2 | E | 102 | 2.3 | 94.6 | K | 66 | 2.0 | 95.3 |
| Q | 129 | 1.8 | 97.1 | I | 119 | 2.0 | 97.2 | K | 92 | 2.0 | 96.7 | I | 63 | 1.9 | 97.2 |
| H | 124 | 1.7 | 98.8 | Q | 105 | 1.7 | 98.9 | Q | 86 | 1.9 | 98.6 | Q | 47 | 1.4 | 98.7 |
| M | 77 | 1.1 | 99.9 | M | 57 | 0.9 | 99.9 | M | 55 | 1.2 | 99.8 | M | 24 | 0.7 | 99.4 |
| C | 9 | 0.1 | 100.0 | C | 9 | 0.1 | 100.0 | C | 10 | 0.2 | 100.0 | C | 20 | 0.6 | 100.0 |
| | 7226 | | | | 6040 | | | | 4514 | | | | 3267 | | |

TABLE 2217
DJ fill

| | OA | | % | cum | P1 | | % | cum | P2 | | % | cum | P3 | | % | cum | P4 | | % | cum |
|---|---|---|---|---|---|---|---|---|---|---|---|---|---|---|---|---|---|---|---|---|
| 1 | G | 3844 | 16.0 | 16.0 | P | 1134 | 12.5 | 12.5 | G | 1266 | 18.5 | 18.5 | G | 831 | 20.4 | 20.4 | G | 369 | 18.2 | 18.2 |
| 2 | P | 2449 | 10.2 | 26.2 | S | 1102 | 12.2 | 24.7 | P | 691 | 10.1 | 28.6 | D | 420 | 10.3 | 30.7 | D | 200 | 9.9 | 28.1 |
| 3 | S | 2299 | 9.6 | 35.7 | G | 1020 | 11.3 | 35.9 | D | 653 | 9.6 | 38.2 | R | 390 | 9.6 | 40.2 | R | 185 | 9.1 | 37.3 |
| 4 | R | 2271 | 9.4 | 45.2 | R | 885 | 9.8 | 45.7 | R | 628 | 9.2 | 47.4 | P | 318 | 7.8 | 48.0 | S | 164 | 8.1 | 45.4 |
| 5 | D | 1948 | 8.1 | 53.3 | L | 675 | 7.4 | 53.1 | S | 602 | 8.8 | 56.2 | S | 295 | 7.2 | 55.3 | P | 160 | 7.9 | 53.3 |
| 6 | L | 1683 | 7.0 | 60.3 | T | 510 | 5.6 | 58.7 | L | 458 | 6.7 | 62.9 | N | 274 | 6.7 | 62.0 | L | 151 | 7.5 | 60.7 |
| 7 | A | 1178 | 4.9 | 65.2 | F | 484 | 5.3 | 64.1 | A | 328 | 4.8 | 67.7 | L | 273 | 6.7 | 68.7 | Y | 114 | 5.6 | 66.4 |
| 8 | T | 1042 | 4.3 | 69.5 | A | 480 | 5.3 | 69.4 | N | 296 | 4.3 | 72.1 | A | 183 | 4.5 | 73.2 | A | 91 | 4.5 | 70.8 |
| 9 | N | 1038 | 4.3 | 73.8 | D | 454 | 5.0 | 74.4 | H | 248 | 3.6 | 75.7 | Y | 173 | 4.2 | 77.4 | H | 85 | 4.2 | 75.0 |
| 10 | F | 897 | 3.7 | 77.6 | K | 371 | 4.1 | 78.5 | T | 236 | 3.5 | 79.1 | V | 145 | 3.6 | 81.0 | N | 77 | 3.8 | 78.9 |
| 11 | H | 836 | 3.5 | 81.0 | W | 318 | 3.5 | 82.0 | Y | 223 | 3.3 | 82.4 | T | 139 | 3.4 | 84.4 | T | 69 | 3.4 | 82.3 |
| 12 | Y | 806 | 3.4 | 84.4 | H | 292 | 3.2 | 85.2 | V | 211 | 3.1 | 85.5 | H | 129 | 3.2 | 87.5 | V | 64 | 3.2 | 85.4 |
| 13 | V | 781 | 3.2 | 87.6 | V | 286 | 3.2 | 88.4 | F | 193 | 2.8 | 88.3 | F | 101 | 2.5 | 90.0 | F | 62 | 3.1 | 88.5 |
| 14 | K | 705 | 2.9 | 90.6 | N | 266 | 2.9 | 91.3 | I | 178 | 2.6 | 90.9 | W | 85 | 2.1 | 92.1 | E | 60 | 3.0 | 91.5 |
| 15 | W | 636 | 2.6 | 93.2 | E | 210 | 2.3 | 93.6 | K | 165 | 2.4 | 93.3 | I | 83 | 2.0 | 94.1 | K | 52 | 2.6 | 94.0 |
| 16 | E | 537 | 2.2 | 95.4 | Y | 166 | 1.8 | 95.4 | W | 150 | 2.2 | 95.5 | E | 82 | 2.0 | 96.1 | I | 45 | 2.2 | 96.2 |
| 17 | I | 496 | 2.1 | 97.5 | Q | 161 | 1.8 | 97.2 | E | 145 | 2.1 | 97.7 | Q | 72 | 1.8 | 97.9 | W | 40 | 2.0 | 98.2 |
| 18 | Q | 382 | 1.6 | 99.1 | I | 157 | 1.7 | 99.0 | Q | 94 | 1.4 | 99.0 | K | 60 | 1.5 | 99.4 | M | 17 | 0.8 | 99.1 |
| 19 | M | 182 | 0.8 | 99.9 | M | 82 | 0.9 | 99.9 | M | 54 | 0.8 | 99.8 | M | 20 | 0.5 | 99.9 | Q | 16 | 0.8 | 99.9 |
| 20 | C | 36 | 0.1 | 100.0 | C | 13 | 0.1 | 100.0 | C | 12 | 0.2 | 100.0 | C | 6 | 0.1 | 100.0 | C | 3 | 0.1 | 100.0 |
| | | 24046 | | | | 9066 | | | | 6831 | | | | 4079 | | | | 2024 | | |

TABLE 2232A
Tally of D3-22.2

| P1 | | % | cum % | P2 | | % | cum % | P3 | | % | cum % | P4 | | % | cum % | P5 | | % | cum % |
|---|---|---|---|---|---|---|---|---|---|---|---|---|---|---|---|---|---|---|---|
| Δ | 459 | 36.7 | 36.7 | Y | 777 | 62.2 | 62.2 | Y | 929 | 74.6 | 74.6 | D | 1087 | 87.2 | 87.2 | S | 1126 | 90.4 | 90.4 |
| Y | 397 | 31.8 | 68.5 | Δ | 294 | 23.5 | 85.7 | Δ | 165 | 13.2 | 87.8 | Δ | 33 | 2.6 | 89.9 | R | 21 | 1.7 | 92.1 |
| D | 94 | 7.5 | 76.1 | G | 32 | 2.6 | 88.3 | G | 27 | 2.2 | 90.0 | G | 22 | 1.8 | 91.7 | G | 20 | 1.6 | 93.7 |
| G | 85 | 6.8 | 82.9 | D | 16 | 1.3 | 89.6 | S | 16 | 1.3 | 91.3 | R | 16 | 1.3 | 92.9 | T | 18 | 1.4 | 95.1 |
| N | 57 | 4.6 | 87.4 | R | 16 | 1.3 | 90.9 | F | 15 | 1.2 | 92.5 | E | 12 | 1.0 | 93.9 | Δ | 15 | 1.2 | 96.3 |
| H | 47 | 3.8 | 91.2 | H | 15 | 1.2 | 92.1 | L | 13 | 1.0 | 93.5 | S | 11 | 0.9 | 94.8 | N | 13 | 1.0 | 97.4 |
| S | 23 | 1.8 | 93.0 | P | 15 | 1.2 | 93.3 | D | 11 | 0.9 | 94.4 | N | 9 | 0.7 | 95.5 | K | 5 | 0.4 | 97.8 |
| R | 22 | 1.8 | 94.8 | S | 15 | 1.2 | 94.5 | E | 10 | 0.8 | 95.2 | H | 8 | 0.6 | 96.1 | A | 3 | 0.2 | 98.0 |
| V | 12 | 1.0 | 95.8 | L | 12 | 1.0 | 95.4 | P | 10 | 0.8 | 96.0 | L | 8 | 0.6 | 96.8 | H | 3 | 0.2 | 98.2 |
| P | 8 | 0.6 | 96.4 | N | 11 | 0.9 | 96.3 | A | 9 | 0.7 | 96.7 | P | 6 | 0.5 | 97.3 | I | 3 | 0.2 | 98.5 |
| A | 7 | 0.6 | 97.0 | A | 8 | 0.6 | 97.0 | R | 9 | 0.7 | 97.4 | Y | 6 | 0.5 | 97.8 | P | 3 | 0.2 | 98.7 |
| F | 7 | 0.6 | 97.5 | I | 8 | 0.6 | 97.6 | H | 8 | 0.6 | 98.1 | A | 5 | 0.4 | 98.2 | W | 3 | 0.2 | 99.0 |
| I | 7 | 0.6 | 98.1 | T | 8 | 0.6 | 98.2 | T | 5 | 0.4 | 98.5 | F | 5 | 0.4 | 98.6 | Y | 3 | 0.2 | 99.2 |
| L | 6 | 0.5 | 98.6 | F | 7 | 0.6 | 98.8 | V | 5 | 0.4 | 98.9 | T | 5 | 0.4 | 99.0 | F | 2 | 0.2 | 99.4 |
| Q | 4 | 0.3 | 98.9 | V | 6 | 0.5 | 99.3 | C | 4 | 0.3 | 99.2 | W | 5 | 0.4 | 99.4 | L | 2 | 0.2 | 99.5 |
| T | 4 | 0.3 | 99.2 | E | 2 | 0.2 | 99.4 | Q | 3 | 0.2 | 99.4 | I | 2 | 0.2 | 99.5 | V | 2 | 0.2 | 99.7 |
| E | 3 | 0.2 | 99.4 | K | 2 | 0.2 | 99.6 | I | 2 | 0.2 | 99.6 | K | 2 | 0.2 | 99.7 | C | 1 | 0.1 | 99.8 |
| K | 2 | 0.2 | 99.6 | Q | 2 | 0.2 | 99.8 | N | 2 | 0.2 | 99.8 | Q | 2 | 0.2 | 99.8 | D | 1 | 0.1 | 99.8 |
| C | 1 | 0.1 | 99.7 | C | 0 | 0.0 | 99.8 | K | 1 | 0.1 | 99.8 | M | 1 | 0.1 | 99.9 | E | 1 | 0.1 | 99.9 |
| W | 1 | 0.1 | 99.8 | M | 0 | 0.0 | 99.8 | M | 1 | 0.1 | 99.9 | V | 1 | 0.1 | 100 | Q | 1 | 0.1 | 100 |
| M | 0 | 0.0 | 99.8 | W | 0 | 0.0 | 99.8 | W | 1 | 0.1 | 100 | C | 0 | 0.0 | 100 | M | 0 | 0.0 | 100 |
| | 1249 | | | | 1246 | | | | 1246 | | | | 1246 | | | | 1246 | | |

TABLE 2232B
Tally of D3-22.2

| P6 | | % | cum % | P7 | | % | Cum % | P8 | | % | cum % | P9 | | % | cum % | P10 | | | |
|---|---|---|---|---|---|---|---|---|---|---|---|---|---|---|---|---|---|---|---|
| S | 1111 | 89.2 | 89.2 | G | 1091 | 87.6 | 87.6 | Y | 823 | 66.1 | 66.1 | Y | 496 | 39.8 | 39.8 | Δ | 759 | 60.9 | 60.9 |
| G | 29 | 2.3 | 91.5 | Δ | 59 | 4.7 | 92.3 | Δ | 159 | 12.8 | 78.8 | Δ | 395 | 31.7 | 71.5 | Y | 163 | 13.1 | 74.0 |
| R | 25 | 2.0 | 93.5 | A | 22 | 1.8 | 94.1 | P | 41 | 3.3 | 82.1 | S | 61 | 4.9 | 76.4 | P | 68 | 5.5 | 79.5 |
| Δ | 22 | 1.8 | 95.3 | D | 17 | 1.4 | 95.4 | L | 33 | 2.6 | 84.8 | P | 53 | 4.3 | 80.7 | S | 50 | 4.0 | 83.5 |
| T | 15 | 1.2 | 96.5 | P | 10 | 0.8 | 96.2 | S | 32 | 2.6 | 87.3 | L | 46 | 3.7 | 84.3 | G | 37 | 3.0 | 86.4 |
| N | 14 | 1.1 | 97.6 | V | 9 | 0.7 | 97.0 | W | 27 | 2.2 | 89.5 | R | 31 | 2.5 | 86.8 | R | 36 | 2.9 | 89.3 |
| Y | 7 | 0.6 | 98.2 | L | 8 | 0.6 | 97.6 | H | 20 | 1.6 | 91.1 | F | 27 | 2.2 | 89.0 | F | 24 | 1.9 | 91.3 |
| P | 5 | 0.4 | 98.6 | S | 6 | 0.5 | 98.1 | R | 19 | 1.5 | 92.6 | G | 21 | 1.7 | 90.7 | L | 21 | 1.7 | 92.9 |
| A | 4 | 0.3 | 98.9 | R | 4 | 0.3 | 98.4 | F | 16 | 1.3 | 93.9 | W | 21 | 1.7 | 92.4 | D | 18 | 1.4 | 94.4 |
| F | 3 | 0.2 | 99.1 | T | 4 | 0.3 | 98.7 | D | 15 | 1.2 | 95.1 | H | 20 | 1.6 | 94.0 | H | 15 | 1.2 | 95.6 |
| I | 3 | 0.2 | 99.4 | Y | 4 | 0.3 | 99.0 | G | 13 | 1.0 | 96.1 | D | 14 | 1.1 | 95.1 | W | 11 | 0.9 | 96.5 |
| K | 3 | 0.2 | 99.6 | N | 3 | 0.2 | 99.3 | N | 10 | 0.8 | 97.0 | V | 10 | 0.8 | 95.9 | V | 9 | 0.7 | 97.2 |
| E | 2 | 0.2 | 99.8 | E | 2 | 0.2 | 99.4 | T | 10 | 0.8 | 97.8 | I | 9 | 0.7 | 96.6 | N | 8 | 0.6 | 97.8 |
| D | 1 | 0.1 | 99.8 | F | 2 | 0.2 | 99.6 | A | 6 | 0.5 | 98.2 | T | 8 | 0.6 | 97.3 | A | 6 | 0.5 | 98.3 |
| L | 1 | 0.1 | 99.9 | H | 1 | 0.1 | 99.7 | I | 6 | 0.5 | 98.7 | A | 7 | 0.6 | 97.8 | E | 6 | 0.5 | 98.8 |
| V | 1 | 0.1 | 100 | K | 1 | 0.1 | 99.8 | K | 5 | 0.4 | 99.1 | Q | 7 | 0.6 | 98.4 | T | 6 | 0.5 | 99.3 |
| C | 0 | 0 | 100 | M | 1 | 0.1 | 99.8 | Q | 5 | 0.4 | 99.5 | K | 6 | 0.5 | 98.9 | I | 4 | 0.3 | 99.6 |
| H | 0 | 0 | 100 | Q | 1 | 0.1 | 99.9 | C | 2 | 0.2 | 99.7 | E | 5 | 0.4 | 99.3 | K | 3 | 0.2 | 99.8 |
| M | 0 | 0 | 100 | W | 1 | 0.1 | 100 | E | 2 | 0.2 | 99.8 | N | 4 | 0.3 | 99.6 | M | 1 | 0.1 | 99.9 |
| Q | 0 | 0 | 100 | C | 0 | 0.0 | 100 | V | 2 | 0.2 | 100 | C | 3 | 0.2 | 99.8 | Q | 1 | 0.1 | 100 |
| W | 0 | 0 | 100 | I | 0 | 0.0 | 100 | M | 0 | 0 | 100 | M | 2 | 0.2 | 100 | C | 0 | 0 | 100 |
| | 1246 | | | | 1246 | | | | 1246 | | | | 1246 | | | | 1246 | | |

TABLE 2261A
D vs Length (3-17)

| | | Length | | | | | | | | | | | | | | |
|---|---|---|---|---|---|---|---|---|---|---|---|---|---|---|---|---|
| | Sequence | 3 | 4 | 5 | 6 | 7 | 8 | 9 | 10 | 11 | 12 | 13 | 14 | 15 | 16 | 17 |
| 2-2.2 | GYCSSTSCYT | 0 | 0 | 0 | 1 | 0 | 0 | 0 | 4 | 4 | 10 | 7 | 17 | 21 | 23 | 17 |
| | (SEQ ID NO: 70) | | | | | | | | | | | | | | | |
| 2-8.2 | GYCTNGVCYT | 0 | 0 | 0 | 0 | 0 | 0 | 0 | 0 | 1 | 3 | 2 | 6 | 5 | 4 | 6 |
| | (SEQ ID NO: 115) | | | | | | | | | | | | | | | |
| 2-15.2 | GYCSGGSCYS | 0 | 0 | 0 | 1 | 3 | 2 | 7 | 10 | 12 | 24 | 24 | 28 | 21 | 41 | 25 |
| | (SEQ ID NO: 136) | | | | | | | | | | | | | | | |
| 2-21.2 | AYCGGDCYS | 0 | 0 | 0 | 0 | 0 | 0 | 2 | 4 | 6 | 3 | 6 | 8 | 9 | 6 | 6 |
| | (SEQ ID NO: 174) | | | | | | | | | | | | | | | |
| 3-3.2 | YYDFWSGYYT | 0 | 0 | 0 | 0 | 1 | 7 | 14 | 27 | 50 | 41 | 62 | 79 | 95 | 114 | 103 |
| | (SEQ ID NO: 177) | | | | | | | | | | | | | | | |
| 3-10.2 | YYYGSGSYYN | 0 | 0 | 0 | 1 | 5 | 17 | 16 | 43 | 65 | 90 | 83 | 84 | 73 | 70 | 46 |
| | (SEQ ID NO: 81) | | | | | | | | | | | | | | | |
| 3-22.2 | YYYDSSGYYY | 0 | 0 | 0 | 0 | 3 | 9 | 16 | 31 | 73 | 120 | 131 | 131 | 118 | 168 | 146 |
| | (SEQ ID NO: 88) | | | | | | | | | | | | | | | |
| 4-17.2 | DYGDY | 0 | 0 | 0 | 1 | 7 | 11 | 44 | 39 | 46 | 58 | 42 | 39 | 23 | 20 | 10 |
| | (SEQ ID NO: 195) | | | | | | | | | | | | | | | |
| 5-5.3 | GYSYGY | 0 | 0 | 0 | 0 | 6 | 8 | 13 | 25 | 53 | 42 | 41 | 37 | 39 | 27 | 30 |
| | (SEQ ID NO: 208) | | | | | | | | | | | | | | | |
| 5-12.3 | GYSGYDY | 0 | 0 | 0 | 0 | 0 | 2 | 10 | 18 | 22 | 27 | 20 | 23 | 18 | 12 | 10 |
| | (SEQ ID NO: 205) | | | | | | | | | | | | | | | |
| 6-13.1 | GYSSSWY | 0 | 0 | 1 | 1 | 3 | 6 | 14 | 27 | 65 | 71 | 76 | 63 | 60 | 51 | 42 |
| | (SEQ ID NO: 215) | | | | | | | | | | | | | | | |
| 6-19.1 | GYSSGWY | 0 | 0 | 0 | 0 | 2 | 8 | 22 | 62 | 100 | 92 | 85 | 64 | 64 | 43 | 33 |
| | (SEQ ID NO: 218) | | | | | | | | | | | | | | | |
| none | none | 32 | 103 | 105 | 447 | 517 | 828 | 1278 | 1277 | 1056 | 853 | 653 | 473 | 339 | 304 | 210 |

TABLE 2261B
D vs Length (18-32)

| | | Length | | | | | | | | | | | | | | |
|---|---|---|---|---|---|---|---|---|---|---|---|---|---|---|---|---|
| | Sequence | 18 | 19 | 20 | 21 | 22 | 23 | 24 | 25 | 26 | 27 | 28 | 29 | 30 | 31 | 32 |
| 2-2.2 | GYCSSTSCYT | 15 | 10 | 2 | 11 | 13 | 2 | 2 | 0 | 0 | 1 | 1 | 0 | 0 | 1 | 0 |
| | (SEQ ID NO: 70) | | | | | | | | | | | | | | | |
| 2-8.2 | GYCTNGVCYT | 3 | 3 | 1 | 2 | 5 | 1 | 0 | 0 | 0 | 0 | 0 | 0 | 0 | 0 | 0 |
| | (SEQ ID NO: 115) | | | | | | | | | | | | | | | |
| 2-15.2 | GYCSGGSCYS | 24 | 14 | 11 | 5 | 13 | 8 | 3 | 0 | 0 | 1 | 0 | 0 | 0 | 0 | 0 |
| | (SEQ ID NO: 136) | | | | | | | | | | | | | | | |
| 2-21.2 | AYCGGDCYS | 4 | 3 | 2 | 1 | 1 | 0 | 0 | 0 | 0 | 0 | 0 | 0 | 0 | 0 | 0 |
| | (SEQ ID NO: 174) | | | | | | | | | | | | | | | |
| 3-3.2 | YYDFWSGYYT | 117 | 131 | 128 | 83 | 62 | 37 | 24 | 10 | 3 | 3 | 0 | 0 | 2 | 1 | 0 |
| | (SEQ ID NO: 177) | | | | | | | | | | | | | | | |
| 3-3.3 | ITIFGVVII | 5 | 5 | 2 | 3 | 2 | 0 | 0 | 0 | 0 | 0 | 0 | 0 | 0 | 0 | 0 |
| | (SEQ ID NO: 178) | | | | | | | | | | | | | | | |
| 3-10.2 | YYYGSGSYYN | 40 | 26 | 25 | 17 | 14 | 11 | 4 | 2 | 5 | 0 | 1 | 0 | 0 | 0 | 0 |
| | (SEQ ID NO: 81) | | | | | | | | | | | | | | | |
| 3-22.2 | YYYDSSGYYY | 97 | 69 | 37 | 31 | 21 | 12 | 3 | 2 | 1 | 1 | 0 | 0 | 0 | 0 | 0 |
| | (SEQ ID NO: 88) | | | | | | | | | | | | | | | |
| 4-17.2 | DYGDY | 11 | 7 | 4 | 2 | 3 | 1 | 1 | 0 | 0 | 0 | 1 | 0 | 0 | 0 | 0 |
| | (SEQ ID NO: 195) | | | | | | | | | | | | | | | |
| 5-5.3 | GYSYGY | 14 | 15 | 7 | 1 | 2 | 6 | 0 | 0 | 4 | 0 | 0 | 0 | 0 | 0 | 0 |
| | (SEQ ID NO: 208) | | | | | | | | | | | | | | | |
| 5-12.3 | GYSGYDY | 8 | 5 | 2 | 5 | 1 | 2 | 0 | 0 | 0 | 0 | 0 | 0 | 0 | 0 | 0 |
| | (SEQ ID NO: 205) | | | | | | | | | | | | | | | |
| 6-13.1 | GYSSSWY | 30 | 21 | 18 | 3 | 6 | 1 | 2 | 3 | 0 | 0 | 1 | 0 | 0 | 0 | 0 |
| | (SEQ ID NO: 215) | | | | | | | | | | | | | | | |
| 6-19.1 | GYSSGWY | 30 | 26 | 14 | 8 | 5 | 4 | 1 | 1 | 1 | 0 | 1 | 0 | 0 | 0 | 0 |
| | (SEQ ID NO: 218) | | | | | | | | | | | | | | | |
| none | none | 93 | 65 | 27 | 16 | 9 | 4 | 1 | 2 | 2 | 0 | 1 | 0 | 0 | 0 | 0 |

TABLE 2267
Tally of VJ fill

| OA | | % | % cum. | P1 | | % | % cum. | P2 | | % | % cum. | P3 | | % | % cum. | P4 | | % | % cum. |
|---|---|---|---|---|---|---|---|---|---|---|---|---|---|---|---|---|---|---|---|
| G | 11386 | 19.21 | 19.21 | G | 1868 | 21.67 | 21.67 | G | 1602 | 18.58 | 18.58 | G | 1724 | 20.43 | 20.43 | G | 1688 | 21.16 | 21.16 |
| R | 5879 | 9.92 | 29.12 | D | 1594 | 18.49 | 40.16 | R | 1217 | 14.12 | 32.70 | R | 1101 | 13.05 | 33.48 | S | 843 | 10.57 | 31.72 |
| S | 5409 | 9.12 | 38.25 | V | 722 | 8.37 | 48.53 | S | 853 | 9.89 | 42.59 | S | 796 | 9.43 | 42.91 | R | 730 | 9.15 | 40.87 |
| D | 4231 | 7.14 | 45.39 | E | 713 | 8.27 | 56.80 | L | 715 | 8.29 | 50.89 | L | 513 | 6.08 | 48.99 | L | 510 | 6.39 | 47.26 |
| L | 3985 | 6.72 | 52.11 | A | 620 | 7.19 | 63.99 | P | 654 | 7.59 | 58.47 | A | 505 | 5.98 | 54.98 | A | 506 | 6.34 | 53.60 |
| A | 3521 | 5.94 | 58.05 | S | 591 | 6.86 | 70.85 | V | 425 | 4.93 | 63.40 | P | 457 | 5.42 | 60.39 | W | 466 | 5.84 | 59.44 |
| P | 3216 | 5.43 | 63.47 | R | 496 | 5.75 | 76.60 | A | 401 | 4.65 | 68.05 | Y | 415 | 4.92 | 65.31 | Y | 449 | 5.63 | 65.07 |
| V | 2927 | 4.94 | 68.41 | L | 366 | 4.25 | 80.85 | T | 384 | 4.45 | 72.51 | V | 403 | 4.78 | 70.09 | T | 378 | 4.74 | 69.81 |
| T | 2624 | 4.43 | 72.84 | I | 279 | 3.24 | 84.09 | D | 300 | 3.48 | 75.99 | W | 396 | 4.69 | 74.78 | V | 375 | 4.70 | 74.51 |
| Y | 2534 | 4.27 | 77.11 | H | 245 | 2.84 | 86.93 | N | 256 | 2.97 | 78.96 | T | 352 | 4.17 | 78.95 | P | 369 | 4.62 | 79.13 |
| W | 2312 | 3.90 | 81.01 | T | 224 | 2.60 | 89.53 | K | 254 | 2.95 | 81.90 | D | 305 | 3.61 | 82.57 | D | 317 | 3.97 | 83.11 |
| E | 1793 | 3.02 | 84.04 | Q | 174 | 2.02 | 91.54 | I | 253 | 2.93 | 84.84 | K | 261 | 3.09 | 85.66 | N | 250 | 3.13 | 86.24 |
| N | 1697 | 2.86 | 86.90 | P | 165 | 1.91 | 93.46 | Q | 250 | 2.90 | 87.74 | F | 202 | 2.39 | 88.05 | F | 211 | 2.64 | 88.88 |
| F | 1547 | 2.61 | 89.51 | W | 112 | 1.30 | 94.76 | H | 198 | 2.30 | 90.04 | E | 196 | 2.32 | 90.38 | Q | 180 | 2.26 | 91.14 |
| I | 1484 | 2.50 | 92.01 | F | 102 | 1.18 | 95.94 | Y | 198 | 2.30 | 92.33 | I | 190 | 2.25 | 92.63 | I | 173 | 2.17 | 93.31 |
| K | 1432 | 2.42 | 94.43 | K | 89 | 1.03 | 96.97 | W | 193 | 2.24 | 94.57 | N | 189 | 2.24 | 94.87 | K | 155 | 1.94 | 95.25 |
| H | 1365 | 2.30 | 96.73 | N | 89 | 1.03 | 98.00 | F | 183 | 2.12 | 96.69 | Q | 171 | 2.03 | 96.89 | E | 147 | 1.84 | 97.09 |
| Q | 1217 | 2.05 | 98.79 | Y | 87 | 1.01 | 99.01 | E | 179 | 2.08 | 98.77 | H | 149 | 1.77 | 98.66 | H | 130 | 1.63 | 98.72 |
| M | 633 | 1.07 | 99.85 | M | 83 | 0.96 | 99.98 | M | 100 | 1.16 | 99.93 | M | 104 | 1.23 | 99.89 | M | 97 | 1.22 | 99.94 |
| C | 87 | 0.15 | 100.00 | C | 2 | 0.02 | 100.00 | C | 6 | 0.07 | 100.00 | C | 9 | 0.11 | 100.00 | C | 5 | 0.06 | 100.00 |
| | 59279 | | | | 8621 | | | | 8621 | | | | 8438 | | | | 7979 | | |

TABLE 2273
Tally of D 6-13.1 and D6-19.1
D 6-13.1 GYSSSWY 570 (SEQ ID NO: 215)

| | A | C | D | E | F | G | H | I | K | L | M | N | P | Q | R | S | T | V | W | Y | Δ |
|---|---|---|---|---|---|---|---|---|---|---|---|---|---|---|---|---|---|---|---|---|---|
| 1 | 8 | 0 | 3 | 5 | 5 | 198 | 0 | 2 | 5 | 9 | 6 | 1 | 19 | 5 | 32 | 16 | 11 | 5 | 10 | 1 | 229 |
| 2 | 4 | 0 | 39 | 5 | 15 | 57 | 31 | 6 | 1 | 8 | 0 | 3 | 4 | 3 | 24 | 12 | 1 | 9 | 3 | 273 | 72 |
| 3 | 1 | 0 | 5 | 0 | 7 | 40 | 2 | 4 | 0 | 3 | 0 | 0 | 2 | 0 | 17 | 477 | 4 | 3 | 0 | 2 | 3 |
| 4 | 0 | 0 | 0 | 0 | 1 | 2 | 1 | 0 | 0 | 0 | 0 | 2 | 0 | 0 | 2 | 558 | 3 | 0 | 0 | 1 | 0 |
| 5 | 6 | 0 | 6 | 1 | 1 | 0 | 0 | 0 | 0 | 1 | 0 | 6 | 4 | 0 | 7 | 529 | 3 | 2 | 1 | 1 | 2 |
| 6 | 1 | 0 | 2 | 1 | 6 | 8 | 2 | 0 | 1 | 4 | 0 | 2 | 7 | 0 | 6 | 1 | 0 | 1 | 494 | 1 | 33 |
| 7 | 7 | 0 | 5 | 6 | 11 | 14 | 7 | 1 | 3 | 12 | 1 | 5 | 11 | 0 | 11 | 37 | 13 | 4 | 3 | 332 | 87 |

Tally of D 6-19.1 GYSSGWY 672 (SEQ ID NO: 218)

| | A | C | D | E | F | G | H | I | K | L | M | N | P | Q | R | S | T | V | W | Y | Δ |
|---|---|---|---|---|---|---|---|---|---|---|---|---|---|---|---|---|---|---|---|---|---|
| 1 | 27 | 0 | 9 | 7 | 3 | 177 | 3 | 2 | 10 | 17 | 4 | 0 | 32 | 6 | 29 | 23 | 12 | 13 | 8 | 2 | 288 |
| 2 | 8 | 2 | 33 | 7 | 6 | 61 | 25 | 8 | 4 | 14 | 4 | 8 | 9 | 5 | 27 | 21 | 8 | 19 | 3 | 306 | 94 |
| 3 | 6 | 0 | 8 | 3 | 1 | 55 | 1 | 3 | 1 | 3 | 1 | 12 | 0 | 1 | 16 | 540 | 13 | 1 | 1 | 0 | 6 |
| 4 | 0 | 0 | 1 | 0 | 0 | 6 | 0 | 2 | 0 | 0 | 0 | 4 | 0 | 0 | 3 | 651 | 4 | 0 | 0 | 1 | 0 |
| 5 | 0 | 0 | 0 | 0 | 0 | 672 | 0 | 0 | 0 | 0 | 0 | 0 | 0 | 0 | 0 | 0 | 0 | 0 | 0 | 0 | 0 |
| 6 | 2 | 3 | 1 | 1 | 4 | 6 | 5 | 1 | 1 | 12 | 2 | 1 | 6 | 1 | 9 | 10 | 2 | 1 | 594 | 0 | 10 |
| 7 | 8 | 1 | 8 | 3 | 21 | 14 | 9 | 4 | 3 | 23 | 1 | 7 | 16 | 4 | 10 | 43 | 8 | 9 | 9 | 379 | 92 |

Composit

| | | | | | | | | | | | | | | | | | | | | | |
|---|---|---|---|---|---|---|---|---|---|---|---|---|---|---|---|---|---|---|---|---|---|
| 1 | 35 | 0 | 12 | 12 | 8 | 375 | 3 | 4 | 15 | 26 | 10 | 1 | 51 | 11 | 61 | 39 | 23 | 18 | 18 | 3 | 517 |
| 2 | 12 | 2 | 72 | 12 | 21 | 118 | 56 | 14 | 5 | 22 | 4 | 11 | 13 | 8 | 51 | 33 | 9 | 28 | 6 | 579 | 166 |
| 3 | 7 | 0 | 13 | 3 | 8 | 95 | 3 | 7 | 1 | 6 | 1 | 12 | 2 | 1 | 33 | 1017 | 17 | 4 | 1 | 2 | 9 |
| 4 | 0 | 0 | 1 | 0 | 1 | 8 | 1 | 2 | 0 | 0 | 0 | 6 | 0 | 0 | 5 | 1209 | 7 | 0 | 0 | 2 | 0 |
| 5 | 6 | 0 | 6 | 1 | 1 | 672 | 0 | 0 | 0 | 1 | 0 | 6 | 4 | 0 | 7 | 529 | 3 | 2 | 1 | 1 | 2 |
| 6 | 3 | 3 | 3 | 2 | 10 | 14 | 7 | 1 | 2 | 16 | 2 | 3 | 13 | 1 | 15 | 11 | 2 | 2 | 1088 | 1 | 43 |
| 7 | 15 | 1 | 13 | 9 | 32 | 28 | 16 | 5 | 6 | 35 | 2 | 12 | 27 | 4 | 21 | 80 | 21 | 13 | 12 | 711 | 179 |

TABLE 2280
Tally of D 4-17.2 DYGDY 386 (SEQ ID NO: 760)

| | A | C | D | E | F | G | H | I | K | L | M | N | P | Q | R | S | T | V | W | Y | |
|---|---|---|---|---|---|---|---|---|---|---|---|---|---|---|---|---|---|---|---|---|---|
| 1 | 12 | 0 | 164 | 6 | 9 | 23 | 11 | 5 | 2 | 15 | 4 | 13 | 18 | 0 | 9 | 14 | 9 | 9 | 5 | 5 | 53 |
| 2 | 1 | 0 | 5 | 1 | 4 | 0 | 6 | 0 | 2 | 3 | 0 | 7 | 2 | 0 | 6 | 3 | 3 | 1 | 4 | 331 | 7 |
| 3 | 0 | 1 | 0 | 0 | 0 | 384 | 0 | 0 | 0 | 0 | 0 | 0 | 0 | 0 | 1 | 0 | 0 | 0 | 0 | 0 | 0 |
| 4 | 3 | 0 | 352 | 4 | 0 | 0 | 0 | 2 | 0 | 1 | 1 | 1 | 3 | 0 | 1 | 0 | 1 | 4 | 2 | 2 | 9 |
| 5 | 4 | 0 | 2 | 2 | 13 | 7 | 8 | 2 | 0 | 13 | 0 | 1 | 5 | 2 | 3 | 11 | 1 | 2 | 1 | 245 | 64 |

TABLE 2293
D2-15.2, D2-2.2, and composite
Tally of D 2-15.2 GYCSGGSCYS 277 (SEQ ID NO: 136)

| | A | C | D | E | F | G | H | I | K | L | M | N | P | Q | R | S | T | V | W | Y | | |
|---|---|---|---|---|---|---|---|---|---|---|---|---|---|---|---|---|---|---|---|---|---|---|
| 1 | 2 | 0 | 2 | 4 | 0 | 85 | 3 | 2 | 2 | 3 | 0 | 0 | 7 | 3 | 25 | 5 | 5 | 4 | 1 | 4 | 120 | 277 |
| 2 | 4 | 0 | 13 | 5 | 5 | 12 | 8 | 2 | 0 | 1 | 0 | 3 | 6 | 3 | 5 | 9 | 4 | 3 | 1 | 128 | 65 | 277 |
| 3 | 3 | 188 | 1 | 0 | 5 | 6 | 1 | 2 | 0 | 4 | 0 | 2 | 0 | 0 | 4 | 3 | 2 | 3 | 5 | 2 | 46 | 277 |
| 4 | 1 | 1 | 0 | 1 | 1 | 13 | 1 | 2 | 2 | 2 | 0 | 8 | 3 | 1 | 5 | 205 | 7 | 2 | 2 | 2 | 18 | 277 |
| 5 | 1 | 0 | 3 | 0 | 0 | 268 | 0 | 0 | 0 | 0 | 0 | 0 | 0 | 0 | 5 | 0 | 0 | 0 | 0 | 0 | 0 | 277 |
| 6 | 3 | 0 | 4 | 0 | 0 | 266 | 0 | 0 | 0 | 0 | 0 | 0 | 0 | 0 | 0 | 1 | 1 | 1 | 0 | 1 | 0 | 277 |
| 7 | 1 | 0 | 0 | 1 | 2 | 9 | 1 | 2 | 0 | 2 | 0 | 10 | 0 | 0 | 16 | 212 | 12 | 3 | 2 | 2 | 2 | 277 |
| 8 | 2 | 191 | 2 | 0 | 1 | 20 | 1 | 0 | 1 | 1 | 0 | 0 | 1 | 2 | 3 | 10 | 2 | 0 | 5 | 12 | 23 | 277 |
| 9 | 7 | 1 | 1 | 1 | 14 | 8 | 5 | 1 | 2 | 5 | 0 | 2 | 12 | 3 | 6 | 10 | 1 | 1 | 14 | 136 | 47 | 277 |
| 10 | 3 | 1 | 4 | 2 | 10 | 16 | 1 | 1 | 0 | 7 | 0 | 0 | 11 | 2 | 9 | 87 | 3 | 0 | 3 | 3 | 114 | 277 |

Tally of D 2-2.2 GYCSSTSCYT 163 (SEQ ID NO: 70)

| | A | C | D | E | F | G | H | I | K | L | M | N | P | Q | R | S | T | V | W | Y | | |
|---|---|---|---|---|---|---|---|---|---|---|---|---|---|---|---|---|---|---|---|---|---|---|
| 1 | 1 | 0 | 1 | 4 | 2 | 53 | 2 | 1 | 0 | 3 | 1 | 1 | 2 | 1 | 18 | 3 | 3 | 2 | 1 | 1 | 63 | 163 |
| 2 | 1 | 0 | 9 | 1 | 4 | 7 | 3 | 1 | 0 | 1 | 0 | 2 | 1 | 0 | 3 | 4 | 0 | 4 | 1 | 98 | 23 | 163 |
| 3 | 0 | 136 | 1 | 1 | 0 | 1 | 0 | 0 | 0 | 1 | 0 | 0 | 0 | 1 | 2 | 3 | 0 | 1 | 1 | 1 | 14 | 163 |
| 4 | 1 | 0 | 2 | 0 | 0 | 3 | 0 | 3 | 1 | 0 | 0 | 2 | 0 | 0 | 1 | 138 | 6 | 0 | 0 | 3 | 3 | 163 |
| 5 | 4 | 1 | 3 | 0 | 0 | 1 | 0 | 0 | 0 | 0 | 0 | 0 | 0 | 0 | 2 | 148 | 3 | 0 | 0 | 1 | 0 | 163 |
| 6 | 2 | 0 | 2 | 0 | 0 | 1 | 0 | 2 | 1 | 0 | 1 | 2 | 0 | 0 | 1 | 2 | 149 | 0 | 0 | 0 | 0 | 163 |
| 7 | 0 | 0 | 1 | 0 | 0 | 7 | 0 | 0 | 0 | 0 | 0 | 4 | 0 | 0 | 6 | 137 | 6 | 0 | 0 | 0 | 2 | 163 |
| 8 | 1 | 141 | 0 | 0 | 0 | 3 | 1 | 0 | 0 | 3 | 0 | 1 | 1 | 0 | 1 | 2 | 0 | 1 | 3 | 2 | 3 | 163 |
| 9 | 2 | 0 | 0 | 0 | 6 | 2 | 3 | 1 | 2 | 8 | 0 | 1 | 13 | 2 | 6 | 9 | 1 | 1 | 1 | 85 | 20 | 163 |
| 10 | 4 | 0 | 4 | 4 | 2 | 15 | 1 | 2 | 1 | 2 | 1 | 2 | 6 | 1 | 10 | 7 | 15 | 3 | 4 | 2 | 77 | 163 |

Composit

| | A | C | D | E | F | G | H | I | K | L | M | N | P | Q | R | S | T | V | W | Y | Δ | Σ |
|---|---|---|---|---|---|---|---|---|---|---|---|---|---|---|---|---|---|---|---|---|---|---|
| 1 | 3 | 0 | 3 | 8 | 2 | 138 | 5 | 3 | 2 | 6 | 1 | 1 | 9 | 4 | 43 | 8 | 8 | 6 | 2 | 5 | 183 | 440 |
| 2 | 5 | 0 | 22 | 6 | 9 | 19 | 11 | 3 | 0 | 2 | 0 | 5 | 7 | 3 | 8 | 13 | 4 | 7 | 2 | 226 | 88 | 440 |
| 3 | 3 | 324 | 2 | 1 | 5 | 7 | 1 | 2 | 0 | 5 | 0 | 2 | 0 | 1 | 6 | 6 | 2 | 4 | 6 | 3 | 60 | 440 |
| 4 | 2 | 1 | 2 | 1 | 1 | 16 | 1 | 5 | 3 | 2 | 0 | 10 | 3 | 1 | 6 | 343 | 13 | 2 | 2 | 5 | 21 | 440 |
| 5 | 5 | 1 | 6 | 0 | 0 | 269 | 0 | 0 | 0 | 0 | 0 | 0 | 0 | 0 | 7 | 148 | 3 | 0 | 0 | 1 | 0 | 440 |
| 6 | 5 | 0 | 6 | 0 | 0 | 267 | 0 | 2 | 1 | 0 | 1 | 2 | 0 | 0 | 1 | 3 | 150 | 1 | 0 | 1 | 0 | 440 |
| 7 | 1 | 0 | 1 | 1 | 2 | 16 | 1 | 2 | 0 | 2 | 0 | 14 | 0 | 0 | 22 | 349 | 18 | 3 | 2 | 2 | 4 | 440 |
| 8 | 3 | 332 | 2 | 0 | 1 | 23 | 2 | 0 | 1 | 4 | 0 | 1 | 2 | 2 | 4 | 12 | 2 | 1 | 8 | 14 | 26 | 440 |
| 9 | 9 | 1 | 1 | 1 | 20 | 10 | 8 | 2 | 4 | 13 | 0 | 3 | 25 | 5 | 12 | 19 | 2 | 2 | 15 | 221 | 67 | 440 |
| 10 | 7 | 1 | 8 | 6 | 12 | 31 | 2 | 3 | 1 | 9 | 1 | 2 | 17 | 3 | 19 | 94 | 18 | 3 | 7 | 5 | 191 | 440 |

TABLE 3002
A27 CDR1s (SEQ ID NOS 1144 and 925, respectively, in order of appearance)

| Len = 11 | | | 181 | | | | | | | | | | | | | | | | | | |
|---|---|---|---|---|---|---|---|---|---|---|---|---|---|---|---|---|---|---|---|---|---|
| “G.L.” | | A | C | D | E | F | G | H | I | K | L | M | N | P | Q | R | S | T | V | W | Y |
| R | 24 | 0 | 0 | 0 | 0 | 0 | 0 | 0 | 0 | 1 | 0 | 0 | 0 | 0 | 0 | 180 | 0 | 0 | 0 | 0 | 0 |
| A | 25 | 175 | 0 | 0 | 0 | 0 | 0 | 0 | 0 | 0 | 0 | 0 | 0 | 0 | 0 | 0 | 3 | 3 | 0 | 0 | 0 |
| S | 26 | 0 | 0 | 0 | 0 | 0 | 2 | 0 | 0 | 0 | 0 | 0 | 1 | 0 | 0 | 2 | 175 | 1 | 0 | 0 | 0 |
| Q | 27 | 0 | 0 | 0 | 3 | 0 | 0 | 0 | 0 | 1 | 1 | 0 | 0 | 1 | 174 | 1 | 0 | 0 | 0 | 0 | 0 |
| S | 28 | 0 | 0 | 0 | 0 | 0 | 4 | 0 | 0 | 0 | 0 | 0 | 7 | 1 | 0 | 0 | 160 | 8 | 0 | 0 | 1 |
| V | 29 | 0 | 0 | 0 | 0 | 0 | 1 | 0 | 25 | 0 | 1 | 0 | 1 | 0 | 0 | 1 | 0 | 0 | 152 | 0 | 0 |
| S | 30 | 1 | 0 | 1 | 0 | 2 | 20 | 1 | 0 | 0 | 0 | 0 | 14 | 0 | 0 | 15 | 120 | 3 | 0 | 0 | 4 |
| S | 31 | 0 | 0 | 1 | 0 | 4 | 6 | 2 | 1 | 0 | 0 | 0 | 18 | 0 | 0 | 11 | 104 | 30 | 1 | 0 | 3 |
| Y | 32 | 0 | 0 | 6 | 0 | 6 | 0 | 2 | 0 | 3 | 0 | 0 | 42 | 0 | 0 | 1 | 15 | 0 | 0 | 1 | 105 |
| L | 33 | 0 | 0 | 0 | 0 | 1 | 0 | 0 | 1 | 0 | 168 | 0 | 0 | 0 | 0 | 0 | 0 | 0 | 11 | 0 | 0 |
| A | 34 | 169 | 0 | 0 | 0 | 0 | 4 | 0 | 0 | 0 | 0 | 0 | 0 | 0 | 0 | 0 | 1 | 3 | 4 | 0 | 0 |

| Len = 12 | | | 1291 | | | | | | | | | | | | | | | | | | |
|---|---|---|---|---|---|---|---|---|---|---|---|---|---|---|---|---|---|---|---|---|---|
| G.L. | | A | C | D | E | F | G | H | I | K | L | M | N | P | Q | R | S | T | V | W | Y |
| R | 24 | 0 | 0 | 0 | 0 | 0 | 11 | 0 | 0 | 6 | 0 | 0 | 0 | 0 | 0 | 1266 | 0 | 4 | 0 | 4 | 0 |
| A | 25 | 1242 | 0 | 0 | 0 | 0 | 0 | 0 | 0 | 0 | 0 | 0 | 0 | 7 | 0 | 0 | 1 | 35 | 6 | 0 | 0 |
| S | 26 | 0 | 0 | 0 | 0 | 0 | 1 | 0 | 0 | 0 | 0 | 0 | 2 | 0 | 0 | 5 | 1269 | 14 | 0 | 0 | 0 |
| Q | 27 | 0 | 0 | 0 | 19 | 0 | 0 | 21 | 0 | 2 | 4 | 0 | 0 | 9 | 1221 | 15 | 0 | 0 | 0 | 0 | 0 |
| S | 28 | 3 | 0 | 2 | 0 | 3 | 16 | 0 | 15 | 1 | 2 | 0 | 30 | 5 | 0 | 33 | 1081 | 92 | 1 | 0 | 7 |
| V | 29 | 1 | 0 | 1 | 0 | 28 | 3 | 0 | 142 | 0 | 68 | 1 | 0 | 1 | 0 | 0 | 0 | 1 | 1045 | 0 | 0 |
| S | 30 | 23 | 0 | 27 | 1 | 6 | 63 | 4 | 17 | 1 | 2 | 1 | 40 | 9 | 1 | 80 | 929 | 70 | 6 | 2 | 9 |
| S | 30a | 9 | 0 | 9 | 0 | 3 | 48 | 8 | 10 | 2 | 2 | 0 | 93 | 1 | 1 | 55 | 994 | 43 | 4 | 1 | 8 |
| S | 31 | 9 | 0 | 26 | 1 | 5 | 27 | 6 | 8 | 16 | 1 | 2 | 244 | 4 | 0 | 123 | 705 | 93 | 1 | 0 | 20 |
| Y | 32 | 0 | 0 | 7 | 1 | 81 | 1 | 28 | 0 | 2 | 4 | 0 | 21 | 0 | 9 | 6 | 71 | 0 | 1 | 4 | 1055 |
| L | 33 | 0 | 0 | 0 | 0 | 19 | 0 | 0 | 22 | 0 | 1194 | 3 | 0 | 0 | 0 | 0 | 0 | 0 | 52 | 1 | 0 |
| A | 34 | 1216 | 0 | 0 | 0 | 0 | 19 | 0 | 0 | 0 | 0 | 1 | 1 | 0 | 0 | 0 | 15 | 17 | 22 | 0 | 0 |

TABLE 3003
A27 CDR2s (SEQ ID NOS 926 and 1145, respectively, in order of appearance)

| Len = 7 | | | 1439 | | | | | | | | | | | | | | | | | | |
|---|---|---|---|---|---|---|---|---|---|---|---|---|---|---|---|---|---|---|---|---|---|
| G.L. | | A | C | D | E | F | G | H | I | K | L | M | N | P | Q | R | S | T | V | W | Y |
| G | 50 | 97 | 0 | 104 | 1 | 0 | 1197 | 3 | 0 | 1 | 0 | 0 | 2 | 0 | 0 | 12 | 21 | 0 | 1 | 0 | 0 |
| A | 51 | 1254 | 0 | 0 | 0 | 0 | 18 | 0 | 7 | 0 | 0 | 2 | 0 | 1 | 0 | 0 | 13 | 120 | 24 | 0 | 0 |
| S | 52 | 8 | 0 | 0 | 0 | 26 | 0 | 0 | 1 | 1 | 2 | 0 | 1 | 0 | 0 | 0 | 1378 | 7 | 1 | 0 | 14 |
| S | 53 | 4 | 0 | 5 | 0 | 7 | 14 | 9 | 27 | 16 | 2 | 1 | 191 | 0 | 0 | 76 | 922 | 152 | 0 | 0 | 13 |
| R | 54 | 0 | 0 | 0 | 0 | 0 | 2 | 0 | 0 | 2 | 1 | 1 | 0 | 0 | 0 | 1431 | 0 | 2 | 0 | 0 | 0 |
| A | 55 | 1385 | 0 | 1 | 0 | 1 | 7 | 0 | 0 | 0 | 0 | 0 | 1 | 14 | 0 | 0 | 9 | 2 | 19 | 0 | 0 |
| T | 56 | 52 | 0 | 1 | 0 | 0 | 1 | 1 | 4 | 2 | 0 | 0 | 1 | 31 | 0 | 0 | 39 | 1307 | 0 | 0 | 0 |

| Len = 8 | | | 37 | | | | | | | | | | | | | | | | | | |
|---|---|---|---|---|---|---|---|---|---|---|---|---|---|---|---|---|---|---|---|---|---|
| “G.L.” | | A | C | D | E | F | G | H | I | K | L | M | N | P | Q | R | S | T | V | W | Y |
| Y | 50a | 0 | 0 | 0 | 0 | 5 | 0 | 0 | 0 | 0 | 0 | 0 | 0 | 0 | 0 | 0 | 1 | 0 | 0 | 0 | 31 |
| G | 50 | 2 | 0 | 5 | 0 | 0 | 28 | 0 | 0 | 0 | 0 | 0 | 0 | 0 | 0 | 0 | 2 | 0 | 0 | 0 | 0 |
| A | 51 | 29 | 0 | 0 | 0 | 0 | 1 | 0 | 0 | 0 | 0 | 0 | 0 | 0 | 0 | 0 | 0 | 4 | 3 | 0 | 0 |
| S | 52 | 0 | 0 | 0 | 0 | 0 | 0 | 0 | 0 | 0 | 0 | 0 | 0 | 0 | 0 | 1 | 36 | 0 | 0 | 0 | 0 |
| S | 53 | 1 | 0 | 0 | 0 | 1 | 1 | 0 | 2 | 0 | 0 | 0 | 4 | 0 | 0 | 6 | 17 | 4 | 0 | 0 | 1 |
| R | 54 | 0 | 0 | 0 | 0 | 0 | 0 | 0 | 0 | 0 | 0 | 0 | 0 | 0 | 0 | 36 | 0 | 0 | 0 | 1 | 0 |
| A | 55 | 35 | 0 | 0 | 0 | 0 | 0 | 0 | 0 | 0 | 0 | 0 | 0 | 1 | 0 | 0 | 0 | 0 | 1 | 0 | 0 |
| T | 56 | 5 | 0 | 0 | 0 | 0 | 0 | 0 | 0 | 0 | 0 | 0 | 0 | 0 | 0 | 2 | 2 | 28 | 0 | 0 | 0 |

TABLE 3004
A27 CDR3s (SEQ ID NOS 1146, 966 and 1147, respectively, in order of appearance)

| Len = 8 | | | 358 | | | | | | | | | | | | | | | | | | |
|---|---|---|---|---|---|---|---|---|---|---|---|---|---|---|---|---|---|---|---|---|---|
| “G.L.” | | A | C | D | E | F | G | H | I | K | L | M | N | P | Q | R | S | T | V | W | Y |
| Q | 89 | 0 | 0 | 0 | 0 | 0 | 0 | 16 | 0 | 0 | 0 | 0 | 0 | 0 | 342 | 0 | 0 | 0 | 0 | 0 | 0 |
| Q | 90 | 0 | 0 | 0 | 4 | 0 | 2 | 42 | 0 | 6 | 4 | 0 | 4 | 0 | 278 | 12 | 0 | 0 | 0 | 0 | 6 |
| Y | 91 | 0 | 0 | 0 | 0 | 12 | 2 | 8 | 0 | 0 | 2 | 0 | 0 | 0 | 0 | 16 | 6 | 2 | 0 | 0 | 310 |
| G | 92 | 4 | 0 | 12 | 4 | 0 | 302 | 4 | 2 | 0 | 0 | 0 | 2 | 0 | 0 | 6 | 12 | 0 | 0 | 2 | 8 |
| S | 93 | 0 | 0 | 4 | 0 | 4 | 20 | 0 | 4 | 2 | 6 | 4 | 40 | 2 | 2 | 40 | 204 | 22 | 4 | 0 | 0 |
| S | 94 | 2 | 0 | 0 | 0 | 2 | 0 | 0 | 0 | 2 | 26 | 0 | 0 | 20 | 4 | 2 | 290 | 2 | 0 | 8 | 0 |
| X | 95 | 0 | 0 | 0 | 0 | 28 | 12 | 16 | 16 | 0 | 50 | 2 | 0 | 82 | 6 | 40 | 12 | 6 | 28 | 22 | 38 |
| T | 97 | 14 | 0 | 0 | 0 | 2 | 6 | 0 | 0 | 0 | 18 | 0 | 0 | 2 | 0 | 2 | 8 | 298 | 6 | 0 | 2 |

| Len = 9 | | | 1670 | | | | | | | | | | | | | | | | | | |
|---|---|---|---|---|---|---|---|---|---|---|---|---|---|---|---|---|---|---|---|---|---|
| G.L. | | A | C | D | E | F | G | H | I | K | L | M | N | P | Q | R | S | T | V | W | Y |
| Q | 89 | 0 | 0 | 0 | 6 | 0 | 0 | 90 | 0 | 0 | 22 | 10 | 2 | 0 | 1538 | 0 | 0 | 0 | 2 | 0 | 0 |
| Q | 90 | 0 | 0 | 0 | 6 | 0 | 2 | 96 | 0 | 6 | 8 | 2 | 0 | 0 | 1524 | 12 | 2 | 0 | 4 | 0 | 8 |
| Y | 91 | 30 | 6 | 0 | 0 | 42 | 8 | 32 | 0 | 0 | 14 | 0 | 6 | 0 | 0 | 138 | 52 | 8 | 0 | 0 | 1334 |
| G | 92 | 130 | 0 | 74 | 20 | 14 | 1072 | 8 | 2 | 4 | 6 | 2 | 56 | 0 | 2 | 40 | 158 | 10 | 16 | 0 | 56 |
| S | 93 | 26 | 0 | 46 | 2 | 12 | 84 | 12 | 14 | 14 | 8 | 8 | 178 | 4 | 12 | 134 | 906 | 158 | 14 | 2 | 36 |
| S | 94 | 32 | 0 | 0 | 0 | 52 | 12 | 2 | 6 | 0 | 26 | 0 | 2 | 66 | 0 | 6 | 1204 | 68 | 4 | 166 | 24 |
| P | 95 | 18 | 0 | 0 | 4 | 10 | 14 | 6 | 0 | 8 | 96 | 10 | 0 | 1266 | 30 | 76 | 74 | 28 | 24 | 4 | 2 |
| L | 96 | 8 | 0 | 12 | 20 | 126 | 52 | 16 | 124 | 26 | 360 | 2 | 6 | 60 | 36 | 286 | 12 | 26 | 46 | 196 | 256 |
| T | 97 | 32 | 0 | 0 | 0 | 4 | 6 | 0 | 4 | 2 | 0 | 2 | 6 | 8 | 0 | 0 | 64 | 1536 | 6 | 0 | 0 |

| Len = 10 | | | 624 | | | | | | | | | | | | | | | | | | |
|---|---|---|---|---|---|---|---|---|---|---|---|---|---|---|---|---|---|---|---|---|---|
| “G.L.” | | A | C | D | E | F | G | H | I | K | L | M | N | P | Q | R | S | T | V | W | Y |
| Q | 89 | 0 | 0 | 0 | 0 | 0 | 0 | 30 | 0 | 0 | 2 | 0 | 0 | 0 | 592 | 0 | 0 | 0 | 0 | 0 | 0 |
| Q | 90 | 0 | 0 | 0 | 2 | 2 | 0 | 50 | 0 | 8 | 16 | 0 | 4 | 0 | 514 | 18 | 2 | 0 | 2 | 0 | 6 |
| Y | 91 | 2 | 2 | 0 | 0 | 24 | 0 | 6 | 0 | 0 | 4 | 0 | 2 | 0 | 0 | 50 | 14 | 2 | 0 | 0 | 518 |
| G | 92 | 14 | 0 | 30 | 0 | 0 | 498 | 0 | 0 | 2 | 0 | 0 | 12 | 0 | 0 | 10 | 46 | 4 | 2 | 0 | 6 |
| S | 93 | 6 | 0 | 18 | 2 | 4 | 46 | 2 | 14 | 4 | 2 | 0 | 82 | 2 | 0 | 32 | 364 | 34 | 8 | 2 | 2 |
| S | 94 | 8 | 0 | 0 | 0 | 10 | 0 | 0 | 0 | 0 | 8 | 0 | 0 | 4 | 0 | 2 | 520 | 12 | 0 | 60 | 0 |
| P | 95 | 6 | 0 | 0 | 0 | 4 | 0 | 2 | 0 | 2 | 38 | 2 | 0 | 512 | 6 | 14 | 18 | 8 | 10 | 0 | 2 |
| x | 95a | 20 | 0 | 0 | 12 | 0 | 58 | 2 | 4 | 6 | 86 | 38 | 0 | 252 | 14 | 64 | 30 | 28 | 10 | 0 | 0 |
| x | 96 | 4 | 4 | 0 | 0 | 62 | 18 | 6 | 80 | 0 | 72 | 2 | 6 | 2 | 0 | 10 | 2 | 4 | 46 | 118 | 188 |
| T | 97 | 14 | 0 | 0 | 0 | 0 | 0 | 0 | 10 | 0 | 0 | 0 | 0 | 2 | 0 | 0 | 42 | 556 | 0 | 0 | 0 |

TABLE 3008
VD fill from DNA analysis

| P1 | | % | P2 | | % | P3 | | % | P4 | | % | P5 | | | P6 | | |
|---|---|---|---|---|---|---|---|---|---|---|---|---|---|---|---|---|---|
| D | 2019 | 21.0 | G | 1335 | 18.6 | G | 853 | 20.5 | G | 376 | 18.3 | R | 154 | 16.6 | G | 64 | 16.2 |
| G | 1938 | 20.1 | R | 1050 | 14.6 | R | 600 | 14.4 | R | 267 | 13.0 | G | 150 | 16.2 | R | 62 | 15.7 |
| V | 924 | 9.60 | P | 880 | 12.2 | P | 417 | 10.0 | P | 255 | 12.4 | P | 98 | 10.6 | P | 40 | 10.1 |
| A | 864 | 8.98 | L | 635 | 8.83 | S | 384 | 9.24 | S | 175 | 8.53 | S | 70 | 7.55 | S | 39 | 9.85 |
| E | 845 | 8.78 | S | 588 | 8.18 | T | 271 | 6.52 | L | 161 | 7.85 | A | 59 | 6.36 | T | 31 | 7.83 |
| S | 506 | 5.26 | A | 382 | 5.31 | A | 263 | 6.33 | A | 129 | 6.29 | L | 56 | 6.04 | A | 24 | 6.06 |
| R | 465 | 4.83 | T | 302 | 4.20 | L | 247 | 5.94 | T | 115 | 5.60 | T | 54 | 5.83 | L | 23 | 5.81 |
| L | 375 | 3.90 | V | 286 | 3.98 | V | 183 | 4.40 | V | 99 | 4.82 | W | 36 | 3.88 | K | 20 | 5.05 |
| T | 319 | 3.32 | K | 244 | 3.39 | E | 121 | 2.91 | E | 68 | 3.31 | V | 33 | 3.56 | V | 19 | 4.80 |
| H | 256 | 2.66 | Q | 226 | 3.14 | I | 101 | 2.43 | F | 58 | 2.83 | Y | 31 | 3.34 | F | 14 | 3.54 |
| P | 235 | 2.44 | I | 207 | 2.88 | K | 98 | 2.36 | W | 55 | 2.68 | D | 30 | 3.24 | D | 10 | 2.53 |
| Q | 214 | 2.22 | E | 177 | 2.46 | F | 95 | 2.29 | I | 52 | 2.53 | K | 28 | 3.02 | I | 10 | 2.53 |
| I | 192 | 2.00 | D | 151 | 2.10 | W | 94 | 2.26 | K | 51 | 2.49 | F | 25 | 2.70 | Y | 10 | 2.53 |
| M | 90 | 0.94 | H | 147 | 2.05 | Y | 91 | 2.19 | D | 42 | 2.05 | E | 23 | 2.48 | W | 8 | 2.02 |
| F | 87 | 0.90 | F | 136 | 1.89 | D | 78 | 1.88 | Y | 35 | 1.71 | I | 21 | 2.27 | E | 7 | 1.77 |
| W | 87 | 0.90 | N | 125 | 1.74 | Q | 77 | 1.85 | H | 32 | 1.56 | Q | 19 | 2.05 | N | 5 | 1.26 |
| N | 74 | 0.77 | W | 115 | 1.60 | H | 63 | 1.52 | Q | 32 | 1.56 | H | 16 | 1.73 | H | 4 | 1.01 |
| K | 62 | 0.64 | Y | 112 | 1.56 | N | 63 | 1.52 | M | 25 | 1.22 | N | 14 | 1.51 | Q | 4 | 1.01 |
| Y | 57 | 0.59 | M | 87 | 1.21 | M | 52 | 1.25 | N | 24 | 1.17 | M | 10 | 1.08 | M | 2 | 0.51 |
| C | 13 | 0.14 | C | 3 | 0.04 | C | 5 | 0.12 | C | 1 | 0.05 | C | 0 | 0.00 | C | 0 | 0.00 |
| | 9622 | | | 7188 | | | 4156 | | | 2052 | | | 927 | | | 396 | |

TABLE 3010A
VJ fill distribution: 1-5

| P1 | | % | P2 | | % | P3 | | % | P4 | | % | P5 | | % |
|---|---|---|---|---|---|---|---|---|---|---|---|---|---|---|
| G | 2165 | 20.84 | G | 2682 | 26.2 | G | 1778 | 18.1 | G | 1820 | 19.90 | G | 1410 | 20.53 |
| E | 1786 | 17.19 | R | 1342 | 13.1 | R | 1221 | 12.4 | S | 878 | 9.60 | S | 713 | 10.38 |
| D | 1655 | 15.93 | S | 916 | 8.96 | S | 799 | 8.12 | Y | 808 | 8.83 | R | 660 | 9.61 |
| V | 794 | 7.64 | L | 730 | 7.14 | D | 583 | 5.92 | R | 745 | 8.15 | A | 454 | 6.61 |
| S | 629 | 6.05 | P | 678 | 6.63 | Y | 557 | 5.66 | N | 623 | 6.81 | L | 432 | 6.29 |
| A | 623 | 6.00 | A | 509 | 4.98 | L | 554 | 5.63 | L | 527 | 5.76 | W | 385 | 5.60 |
| R | 564 | 5.43 | V | 426 | 4.17 | P | 532 | 5.41 | A | 510 | 5.58 | Y | 366 | 5.33 |
| L | 391 | 3.76 | T | 415 | 4.06 | A | 526 | 5.34 | W | 460 | 5.03 | T | 360 | 5.24 |
| I | 316 | 3.04 | D | 299 | 2.92 | T | 456 | 4.63 | T | 452 | 4.94 | P | 332 | 4.83 |
| H | 260 | 2.50 | I | 270 | 2.64 | V | 444 | 4.51 | P | 403 | 4.41 | D | 310 | 4.51 |
| T | 234 | 2.25 | K | 268 | 2.62 | W | 434 | 4.41 | V | 397 | 4.34 | V | 291 | 4.24 |
| Q | 199 | 1.92 | N | 258 | 2.52 | H | 389 | 3.95 | D | 299 | 3.27 | I | 219 | 3.19 |
| P | 175 | 1.68 | Q | 239 | 2.34 | E | 293 | 2.98 | I | 260 | 2.84 | F | 182 | 2.65 |
| W | 126 | 1.21 | W | 234 | 2.29 | K | 275 | 2.79 | F | 220 | 2.41 | K | 169 | 2.46 |
| Y | 103 | 0.99 | Y | 232 | 2.27 | Q | 251 | 2.55 | H | 173 | 1.89 | N | 168 | 2.45 |
| F | 102 | 0.98 | E | 218 | 2.13 | N | 232 | 2.36 | Q | 168 | 1.84 | E | 129 | 1.88 |
| K | 90 | 0.87 | F | 200 | 1.96 | F | 212 | 2.15 | K | 152 | 1.66 | Q | 112 | 1.63 |
| N | 90 | 0.87 | H | 191 | 1.87 | I | 204 | 2.07 | E | 139 | 1.52 | H | 94 | 1.37 |
| M | 86 | 0.83 | M | 113 | 1.11 | M | 92 | 0.93 | M | 102 | 1.12 | M | 77 | 1.12 |
| C | 2 | 0.02 | C | 6 | 0.06 | C | 10 | 0.1 | C | 10 | 0.11 | C | 6 | 0.09 |
| | 10390 | | | 10226 | | | 9842 | | | 9146 | | | 6869 | |

TABLE 3010B
VJ fill distribution: 6-9

| P6 | | % | P7 | | % | P8 | | % | P9 | | |
|---|---|---|---|---|---|---|---|---|---|---|---|
| G | 1041 | 19.47 | G | 716 | 18.95 | G | 428 | 16.94 | G | 300 | 19.63 |
| S | 580 | 10.85 | R | 464 | 12.28 | R | 317 | 12.55 | R | 178 | 11.65 |
| R | 533 | 9.97 | S | 383 | 10.13 | S | 245 | 9.70 | P | 145 | 9.49 |
| A | 399 | 7.46 | P | 298 | 7.89 | P | 225 | 8.91 | S | 143 | 9.36 |
| L | 377 | 7.05 | A | 248 | 6.56 | L | 185 | 7.32 | A | 88 | 5.76 |
| P | 376 | 7.03 | L | 235 | 6.22 | A | 169 | 6.69 | L | 79 | 5.17 |
| T | 344 | 6.43 | T | 208 | 5.50 | T | 139 | 5.50 | V | 79 | 5.17 |
| Y | 279 | 5.22 | Y | 199 | 5.27 | V | 116 | 4.59 | T | 78 | 5.10 |
| W | 261 | 4.88 | W | 157 | 4.15 | W | 114 | 4.51 | Y | 76 | 4.97 |
| V | 195 | 3.65 | F | 152 | 4.02 | Y | 113 | 4.47 | F | 68 | 4.45 |
| D | 165 | 3.09 | V | 120 | 3.18 | D | 77 | 3.05 | D | 52 | 3.40 |
| F | 159 | 2.97 | D | 107 | 2.83 | F | 70 | 2.77 | W | 47 | 3.08 |
| N | 125 | 2.34 | I | 96 | 2.54 | E | 60 | 2.38 | I | 41 | 2.68 |
| E | 109 | 2.04 | N | 85 | 2.25 | N | 56 | 2.22 | N | 38 | 2.49 |
| I | 106 | 1.98 | K | 70 | 1.85 | H | 46 | 1.82 | E | 30 | 1.96 |
| Q | 92 | 1.72 | H | 64 | 1.69 | K | 45 | 1.78 | Q | 27 | 1.77 |
| K | 81 | 1.51 | Q | 63 | 1.67 | I | 43 | 1.70 | H | 22 | 1.44 |
| H | 72 | 1.35 | E | 53 | 1.40 | Q | 42 | 1.66 | M | 16 | 1.05 |
| M | 45 | 0.84 | M | 49 | 1.30 | M | 20 | 0.79 | K | 15 | 0.98 |
| C | 8 | 0.15 | C | 12 | 0.32 | C | 16 | 0.63 | C | 6 | 0.39 |
| | 5347 | | | 3779 | | | 2526 | | | 1528 | |

Below, tables 3020-3027 show preferred proportions of amino-acid types (AA types) that can be used to construct libraries of HC CDR3s. The lengths of the CDRs can be from 4 to 14. The tables show proportions for positions 1 through 12. For length 13 and 14, the proportions for position 9 is repeated once or twice.

For length 11, the tabulated position 9 can be omitted or the average of positions 9 and 10 of the table can be used to make the actual position 9 and the table value for position 11 for the actual position 10. The tabulated position 12 is used at position 11.

For length 10, tabulated positions 8 and 9 of the table can be omitted and the tabulated 10, 11, and 12 can be used as positions 8, 9, and 10. Alternatively, the actual position 8 is the average of the tabulated 8 and the tabulated 10; the actual position 9 is the average of the tabulated 9 and the tabulated 11; and the actual position 10 is the tabulated 12.

For length 9, tabulated positions 7, 8, 9 of the table can be omitted and the tabulated positions 10, 11, and 12 can be used. Alternatively, positions 8, 9, and 10 can be omitted. Alternatively, we could omit positions 9, 10, and 11. Alternatively, tabulated positions 11, 12, and 13 can be omitted. Alternatively, the actual position 7 could be the average of the tabulated positions 7 and 10; position 8 is the average of the tabulated positions 8 and 11; and position 9 is the average of tabulated positions 9 and 12.

For length 8, tabulated positions [6, 7, 8, & 9]; [7, 8, 9, &10]; [8, 9, 10, & 11]; or [9, 10, 11, & 12] can be omitted. Alternatively, positions 1-5 as tabulated can be used; tabulated position 6 can be omitted; average tabulated positions 7 and 11 for the actual position 6; average the tabulated positions 8 and 12 for the actual position 7; and average the tabulated positions 9 and 12 for the actual position 8.

For length 7, tabulated positions [5, 6, 7, 8, & 9]; [6, 7, 8, 9, & 10]; [7, 8, 9, 10, & 11]; or [8, 9, 10, 11, & 12] can be omitted. Alternatively, tabulated positions 5 & 6 can be omitted and average tabulated positions 7 and 11 for the actual position 5; average the tabulated positions 8 and 12 for the actual position 6; and average the tabulated positions 9 and 12 for the actual position 7 can be used. Alternatively, positions 1-4 as tabulated can be used; omit tabulated positions 8 & 9; average tabulated positions 5 and 11 for the actual position 5; average the tabulated positions 6 and 12 for the actual position 6; and average the tabulated positions 7 and 12 for the actual position 7.

For length 6, tabulated positions [4, 5, 6, 7, 8, & 9]; [5, 6, 7, 8, 9, & 10]; [6, 7, 8, 9, 10, & 11]; or [7, 8, 9, 10, 11, & 12] can be omitted. Alternatively, positions 1-3 can be included as tabulated; omit tabulated positions 4, 5 & 6; average tabulated positions 7 and 11 for the actual position 4; average the tabulated positions 8 and 12 for the actual position 5; and average the tabulated positions 9 and 12 for the actual position 6. Alternatively, positions 1-3 can be included as tabulated; omit tabulated positions 7, 8 & 9; average tabulated positions 4 and 10 for the actual position 4; average the tabulated positions 5 and 11 for the actual position 5; and average the tabulated positions 6 and 12 for the actual position 6.

For length 5, tabulated positions [3, 4, 5, 6, 7, 8, & 9]; [4, 5, 6, 7, 8, 9, & 10]; [5, 6, 7, 8, 9, 10, & 11]; or [6, 7, 8, 9, 10, 11, & 12] can be omitted. Alternatively, positions 1 and 2 can be included as tabulated; omit tabulated positions 3, 4, 5 & 6 and average tabulated positions 7 and 11 for the actual position 3; average the tabulated positions 8 and 12 for the actual position 4; and average the tabulated positions 9 and 12 for the actual position 5. Alternatively, tabulated positions 6, 7, 8 & 9 can be omitted and average tabulated positions 3 and 11 for the actual position 3 can be used; average the tabulated positions 4 and 12 for the actual position 4 can be used; and average the tabulated positions 5 and 12 for the actual position 5 can be used.

For length 4, tabulated positions [2, 3, 4, 5, 6, 7, 8, & 9]; [3, 4, 5, 6, 7, 8, 9, & 10]; [4, 5, 6, 7, 8, 9, 10, & 11]; or [5, 6, 7, 8, 9, 10, 11, & 12] can be omitted. Alternatively, position 1 as tabulated can be used; omit tabulated positions 2, 3, 4, 5 & 6 and average tabulated positions 7 and 11 for the actual position 2; average the tabulated positions 8 and 12 for the actual position 3; and average the tabulated positions 9 and 12 for the actual position 4. Alternatively, tabulated positions 5, 6, 7, 8 & 9 can be omitted and average tabulated positions 2 and 11 for the actual position 2; average the tabulated positions 3 and 12 for the actual position 3; and average the tabulated positions 4 and 12 for the actual position 4.

Tables 3020-3027 show proportions that are derived from Table 3010 by altering the proportions of Gly, Ser, and Tyr. Libraries can be built with any of the sets of proportions.

There is evidence that useful antibodies may be obtained when only Tyr and Ser are allowed at each position in HC CDR3 or indeed in all of the CDRs of a synthetic antibody. Although such antibodies have been reported to have high affinity and good specificity, none have been introduced into clinical trials. The inclusion of other AA types may be important in obtaining antibodies that are useful as therapeutics.

### Example 8

### A Library of HC CDR3s Having Lengths from 4 to 12 and No D Segments

This example will use Table 3023, Table 3010 adjusted to have high Tyr. For length 12, the members will have the AA types distribution shown in Table 3023. For length 11, the first eight positions are as tabulated in Table 3023A, B. The ninth position has a distribution that is the average of the tabulated 9^{th} and 10^{th} position: A: 0.0364, D: 0.0215, F: 0.5281, G: 0.0116, L: 0.0327, P: 0.0600, R: 0.0737, S: 0.0116, T: 0.0323, V: 0.0327, W: 0.0195, Y: 0.01399. Positions 10 and 11 have the distribution tabulated as “11” and “12”. In this example, the positions of HC CDR3 are numbered 1 to 12. These correspond to the positions 95, 96, . . . 102d.

For length 10, Positions 1-7 are as tabulated in Table 3023A, B. Position 8 is the average of tabulated positions 8 and 10: A: 0.04034, D: 0.0184, F: 0.5167, G: 0.0116, L: 0.04413, P: 0.05371, R: 0.0756, S: 0.0116, T: 0.0332, V: 0.0277, W: 0.0272, Y: 0.140. Position 9 is the average of tabulated positions 9 and 11: A: 0.0364, D: 0.5215, F: 0.02814, G: 0.01160, L: 0.0327, P: 0.0600, R: 0.0737, S: 0.0116, T: 0.0323, V: 0.0327, W: 0.0195, Y: 0.1399. Position 10 is as tabulated under position “12”.

For length 9, positions 1-7 are as tabulated in Table 3023. Positions 8 and 9 are as tabulated under positions “11” and “12”.

For length 8, positions 1-5 as tabulated are used. Positions 6-8 are as shown in Table 3031.

For length 7, positions 1-4 are as tabulated in Table 3023. Positions 5-7 are as shown in Table 3032 in which the averaged tabulated positions 5 & 10, 6 & 11, and 7 & 12. of Table 3010 are used.

For length 6, positions 1-3 are as tabulated in Table 3023. Positions 4-6 are as shown in Table 3033 in which the averaged tabulated positions 4 & 10, 5 & 11, and 6 & 12 are used.

For length 5, positions 1-5 are as tabulated in Table 3023A, B.

For length 4, positions 1-3 are as tabulated in Table 3023A and position 4 is as tabulated under position “12” in Table 3023B, i.e. tabulated positions 4-11 are omitted.

The proportions of the differing lengths could be varied according to the target. For example, peptides, small proteins, carbohydrates, and glycoproteins may give better binders from libraries when the shorter lengths are more common. Large proteins may give better binders when the longer members are more common. One embodiment of the present invention has the length components in the ratios: L4:L5:L6:L7:L8:L9:L10:L11:L12::1:1:1:1:1:1:1:1:1. One embodiment of the present invention has the length components in the ratios: L4:L5:L6:L7:L8:L9:L10:L11:L12::3:3:2:2:2:1:1:1:1. One embodiment of the present invention has the length components in the ratios: L4:L5:L6:L7:L8:L9:L10:L11:L12::1:1:1:1:2:2:2:3:3. For each length we obtain, for example, 2.E6 members and 1.8E7 HC CDR3 in total. This diversity is combined with a library of HC CDER½ diversity of, for example, 2.E7 to make, for example, 1.E9 HCs.

The diversity of HC CDR3 is combined with the HC CDR1/CDR2 diversity shown in Example 4.1 and Example 4.2, in Example 4.3, or in Example 15. The LC diversity is shown in Example 5, Example 9, or Example 16. A preferred vector is pMID55F and the method of construction is given in Example 9.

TABLE 3020A
Low Gly, Ser, and Tyr
Library based on Table 3010: positions 1-6

| | Position | | | | | |
|---|---|---|---|---|---|---|
| AA type | 1 | 2 | 3 | 4 | 5 | 6 |
| A | 0.0785 | 0.0868 | 0.0855 | 0.0880 | 0.1077 | 0.1161 |
| C | 0 | 0 | 0 | 0 | 0 | 0 |
| D | 0.2085 | 0.0509 | 0.0947 | 0.0515 | 0.0735 | 0.0481 |
| E | 0.2250 | 0 | 0 | 0 | 0 | 0 |
| F | 0 | 0 | 0 | 0 | 0 | 0 |
| G | 0.0932 | 0.0815 | 0.0823 | 0.0834 | 0.0824 | 0.0814 |
| H | 0.0327 | 0 | 0 | 0 | 0 | 0 |
| I | 0.0398 | 0.0460 | 0 | 0 | 0 | 0 |
| K | 0 | 0.0457 | 0 | 0 | 0 | 0 |
| L | 0.0492 | 0.1244 | 0.0901 | 0.0908 | 0.1025 | 0.1097 |
| M | 0 | 0 | 0 | 0 | 0 | 0 |
| N | 0 | 0 | 0 | 0.1073 | 0 | 0 |
| P | 0 | 0.1155 | 0.0866 | 0.0695 | 0.0787 | 0.1095 |
| Q | 0 | 0 | 0 | 0 | 0 | 0 |
| R | 0.0711 | 0.2283 | 0.1984 | 0.1285 | 0.1566 | 0.1552 |
| S | 0.0725 | 0.0775 | 0.0769 | 0.0780 | 0.0770 | 0.0767 |
| T | 0.0295 | 0.0708 | 0.0741 | 0.0779 | 0.0854 | 0.1001 |
| V | 0.1000 | 0.0727 | 0.0722 | 0.0684 | 0.0691 | 0.0568 |
| W | 0 | 0 | 0.0706 | 0.0793 | 0.0913 | 0.0760 |
| Y | 0 | 0 | 0.0686 | 0.0776 | 0.0759 | 0.0703 |

TABLE 3020B
Low Gly, Ser, and Tyr
Library based on Table 3010: positions 7-12

| | Position | | | | | |
|---|---|---|---|---|---|---|
| AA type | 7 | 8 | 9 | 10 | 11 | 12 |
| A | 0.1038 | 0.0934 | 0.0834 | 0 | 0 | 0 |
| C | 0 | 0 | 0 | 0 | 0 | 0 |
| D | 0.0448 | 0.0426 | 0.0493 | 0 | 1.00 | 0 |
| E | 0 | 0 | 0 | 0 | 0 | 0 |
| F | 0 | 0.0387 | 0.0645 | 1.00 | 0 | 0 |
| G | 0.0833 | 0.0830 | 0.0815 | 0 | 0 | 0 |
| H | 0 | 0 | 0 | 0 | 0 | 0 |
| I | 0 | 0 | 0 | 0 | 0 | 0 |
| K | 0 | 0 | 0 | 0 | 0 | 0 |
| L | 0.0984 | 0.1022 | 0.0749 | 0 | 0 | 0 |
| M | 0 | 0 | 0 | 0 | 0 | 0 |
| N | 0 | 0 | 0 | 0 | 0 | 0 |
| P | 0.1248 | 0.1244 | 0.1374 | 0 | 0 | 0 |
| Q | 0 | 0 | 0 | 0 | 0 | 0 |
| R | 0.1942 | 0.1752 | 0.1687 | 0 | 0 | 0 |
| S | 0.0768 | 0.0745 | 0.0750 | 0 | 0 | 0 |
| T | 0.0870 | 0.0768 | 0.0739 | 0 | 0 | 0 |
| V | 0.0490 | 0.0641 | 0.0749 | 0 | 0 | 0 |
| W | 0.0656 | 0.0630 | 0.0446 | 0 | 0 | 0 |
| Y | 0.0724 | 0.0624 | 0.0720 | 0 | 0 | 1.00 |

TABLE 3021A
Low Ser and Tyr, high Gly
Proportions for positions 1-6 with high Gly

| | Postion | | | | | |
|---|---|---|---|---|---|---|
| AA type | 1 | 2 | 3 | 4 | 5 | 6 |
| A | 0.0634 | 0.0696 | 0.0746 | 0.0779 | 0.0949 | 0.1015 |
| D | 0.1684 | 0.0408 | 0.0827 | 0.0456 | 0.0647 | 0.0420 |
| E | 0.1817 | 0 | 0 | 0 | 0 | 0 |
| G | 0.2800 | 0.2800 | 0.2801 | 0.2802 | 0.2803 | 0.2801 |
| H | 0.0264 | 0 | 0 | 0 | 0 | 0 |
| I | 0.0321 | 0.0369 | 0 | 0 | 0 | 0 |
| K | 0 | 0.0366 | 0 | 0 | 0 | 0 |
| L | 0.0398 | 0.0997 | 0.0786 | 0.0804 | 0.0903 | 0.0958 |
| N | 0 | 0 | 0 | 0.0950 | 0 | 0 |
| P | 0 | 0.0926 | 0.0756 | 0.0615 | 0.0693 | 0.0956 |
| R | 0.0574 | 0.1830 | 0.1732 | 0.1137 | 0.1379 | 0.1356 |
| S | 0.0230 | 0.0230 | 0.0230 | 0.0230 | 0.0231 | 0.0230 |
| T | 0.0238 | 0.0567 | 0.0647 | 0.0689 | 0.0752 | 0.0874 |
| V | 0.0808 | 0.0582 | 0.0630 | 0.0606 | 0.0608 | 0.0496 |
| W | 0 | 0 | 0.0616 | 0.0702 | 0.0804 | 0.0664 |
| Y | 0.0231 | 0.0230 | 0.0230 | 0.0230 | 0.0231 | 0.0230 |

TABLE 3021B
Low Ser and Tyr, high Gly
Proportions for positions 7-12 with high Gly

| | Position | | | | | |
|---|---|---|---|---|---|---|
| AA type | 7 | 8 | 9 | 10 | 11 | 12 |
| A | 0.0911 | 0.0807 | 0.0729 | 0 | 0 | 0 |
| D | 0.0393 | 0.0368 | 0.0430 | 0 | 1.00 | 0 |
| F | 0 | 0.0334 | 0.0563 | 1.00 | 0 | 0 |
| G | 0.2801 | 0.2801 | 0.2801 | 0 | 0 | 0 |
| L | 0.0864 | 0.0883 | 0.0654 | 0 | 0 | 0 |
| P | 0.1096 | 0.1074 | 0.1200 | 0 | 0 | 0 |
| R | 0.1705 | 0.1513 | 0.1474 | 0 | 0 | 0 |
| S | 0.0230 | 0.0230 | 0.0230 | 0 | 0 | 0 |
| T | 0.0764 | 0.0663 | 0.0645 | 0 | 0 | 0 |
| V | 0.0430 | 0.0554 | 0.0654 | 0 | 0 | 0 |
| W | 0.0576 | 0.0544 | 0.0390 | 0 | 0 | 0 |
| Y | 0.0230 | 0.0230 | 0.0230 | 0 | 0 | 1.00 |

TABLE 3022A
Low Gly & Tyr, High Ser
Proportions for positions 1-6 with high Ser

| | Position | | | | | |
|---|---|---|---|---|---|---|
| | 1 | 2 | 3 | 4 | 5 | 6 |
| A | 0.0634 | 0.0696 | 0.0746 | 0.0778 | 0.0948 | 0.1014 |
| D | 0.1684 | 0.0408 | 0.0827 | 0.0456 | 0.0647 | 0.0420 |
| E | 0.1817 | 0 | 0 | 0 | 0 | 0 |
| G | 0.0232 | 0.0232 | 0.0232 | 0.0232 | 0.0233 | 0.0232 |
| H | 0.0264 | 0 | 0 | 0 | 0 | 0 |
| I | 0.0321 | 0.0369 | 0 | 0 | 0 | 0 |
| K | 0 | 0.0366 | 0 | 0 | 0 | 0 |
| L | 0.0398 | 0.0997 | 0.0786 | 0.0803 | 0.0902 | 0.0958 |
| N | 0 | 0 | 0 | 0.0950 | 0 | 0 |
| P | 0 | 0.0926 | 0.0756 | 0.0615 | 0.0692 | 0.0956 |
| R | 0.0574 | 0.1830 | 0.1732 | 0.1137 | 0.1378 | 0.1355 |
| S | 0.2798 | 0.2797 | 0.2801 | 0.2803 | 0.2809 | 0.2800 |
| T | 0.0238 | 0.0567 | 0.0646 | 0.0689 | 0.0751 | 0.0874 |
| V | 0.0808 | 0.0583 | 0.0630 | 0.0605 | 0.0608 | 0.0496 |
| W | 0 | 0 | 0.0616 | 0.0701 | 0.0803 | 0.0663 |
| Y | 0.0231 | 0.0230 | 0.0230 | 0.0230 | 0.0231 | 0.0230 |

TABLE 3022B
Low Gly & Tyr, High Ser
Proportions for positions 7-12 with high Ser

Position

| | 7 | 8 | 9 | 10 | 11 | 12 |
|---|---|---|---|---|---|---|
| A | 0.0911 | 0.0807 | 0.0729 | 0 | 0 | 0 |
| D | 0.0393 | 0.0368 | 0.0430 | 0 | 1.00 | 0 |
| F | 0 | 0.0334 | 0.0563 | 1.00 | 0 | 0 |
| G | 0.0232 | 0.0232 | 0.0232 | 0 | 0 | 0 |
| L | 0.0864 | 0.0883 | 0.0654 | 0 | 0 | 0 |
| P | 0.1095 | 0.1074 | 0.1200 | 0 | 0 | 0 |
| R | 0.1705 | 0.1513 | 0.1474 | 0 | 0 | 0 |
| S | 0.2801 | 0.2800 | 0.2800 | 0 | 0 | 0 |
| T | 0.0763 | 0.0663 | 0.0645 | 0 | 0 | 0 |
| V | 0.0430 | 0.0553 | 0.0654 | 0 | 0 | 0 |
| W | 0.0576 | 0.0544 | 0.0390 | 0 | 0 | 0 |
| Y | 0.0230 | 0.0230 | 0.0230 | 0 | 0 | 1.00 |

TABLE 3023A
Proportions with high Tyr
Proportions for positions 1-6 with high Tyr

| | Position | | | | | |
|---|---|---|---|---|---|---|
| AA type | 1 | 2 | 3 | 4 | 5 | 6 |
| A | 0.0635 | 0.0696 | 0.0746 | 0.0777 | 0.0945 | 0.1014 |
| D | 0.1685 | 0.0408 | 0.0826 | 0.0456 | 0.0645 | 0.0420 |
| E | 0.1819 | 0 | 0 | 0 | 0 | 0 |
| G | 0.0232 | 0.0232 | 0.0232 | 0.0232 | 0.0232 | 0.0232 |
| H | 0.0265 | 0 | 0 | 0 | 0 | 0 |
| I | 0.0322 | 0.0369 | 0 | 0 | 0 | 0 |
| K | 0 | 0.0366 | 0 | 0 | 0 | 0 |
| L | 0.0398 | 0.0998 | 0.0786 | 0.0802 | 0.0899 | 0.0958 |
| N | 0 | 0 | 0 | 0.0949 | 0 | 0 |
| P | 0 | 0.0927 | 0.0755 | 0.0614 | 0.0690 | 0.0956 |
| R | 0.0574 | 0.1832 | 0.1731 | 0.1135 | 0.1373 | 0.1355 |
| S | 0.0232 | 0.0232 | 0.0232 | 0.0232 | 0.0232 | 0.0232 |
| T | 0.0238 | 0.0568 | 0.0646 | 0.0688 | 0.0749 | 0.0874 |
| V | 0.0808 | 0.0583 | 0.0630 | 0.0605 | 0.0606 | 0.0496 |
| W | 0 | 0 | 0.0616 | 0.0701 | 0.0800 | 0.0663 |
| Y | 0.2793 | 0.2788 | 0.2800 | 0.2809 | 0.2829 | 0.2799 |

TABLE 3023B
Proportions with high Tyr
Proportions for positions 7-12 with high Tyr

| | Position | | | | | |
|---|---|---|---|---|---|---|
| AA type | 7 | 8 | 9 | 10 | 11 | 12 |
| A | 0.0910 | 0.0807 | 0.0729 | 0 | 0 | 0 |
| D | 0.0393 | 0.0368 | 0.0430 | 0 | 1.00 | 0 |
| F | 0 | 0.0334 | 0.0563 | 1.00 | 0 | 0 |
| G | 0.0232 | 0.0232 | 0.0232 | 0 | 0 | 0 |
| L | 0.0863 | 0.0883 | 0.0654 | 0 | 0 | 0 |
| P | 0.1095 | 0.1074 | 0.1200 | 0 | 0 | 0 |
| R | 0.1704 | 0.1513 | 0.1474 | 0 | 0 | 0 |
| S | 0.0232 | 0.0232 | 0.0232 | 0 | 0 | 0 |
| T | 0.0763 | 0.0663 | 0.0645 | 0 | 0 | 0 |
| V | 0.0430 | 0.0553 | 0.0654 | 0 | 0 | 0 |
| W | 0.0576 | 0.0544 | 0.0390 | 0 | 0 | 0 |
| Y | 0.2801 | 0.2797 | 0.2798 | 0 | 0 | 1.00 |

TABLE 3024A
High Gly & Ser, low Tyr
Proportions for positions 1-6 with high Gly & Ser

| | Position | | | | | |
|---|---|---|---|---|---|---|
| AA type | 1 | 2 | 3 | 4 | 5 | 6 |
| A | 0.0505 | 0.0553 | 0.0593 | 0.0619 | 0.0755 | 0.0807 |
| D | 0.1340 | 0.0325 | 0.0658 | 0.0363 | 0.0515 | 0.0334 |
| E | 0.1446 | 0 | 0 | 0 | 0 | 0 |
| G | 0.2228 | 0.2227 | 0.2228 | 0.2229 | 0.2230 | 0.2228 |
| H | 0.0210 | 0 | 0 | 0 | 0 | 0 |
| I | 0.0256 | 0.0293 | 0 | 0 | 0 | 0 |
| K | 0 | 0.0291 | 0 | 0 | 0 | 0 |
| L | 0.0316 | 0.0793 | 0.0626 | 0.0639 | 0.0718 | 0.0762 |
| N | 0 | 0 | 0 | 0.0756 | 0 | 0 |
| P | 0 | 0.0737 | 0.0601 | 0.0490 | 0.0552 | 0.0761 |
| R | 0.0457 | 0.1456 | 0.1378 | 0.0905 | 0.1097 | 0.1079 |
| S | 0.2228 | 0.2228 | 0.2228 | 0.2228 | 0.2228 | 0.2228 |
| T | 0.0189 | 0.0451 | 0.0514 | 0.0548 | 0.0598 | 0.0696 |
| V | 0.0643 | 0.0463 | 0.0501 | 0.0482 | 0.0484 | 0.0395 |
| W | 0 | 0 | 0.0490 | 0.0558 | 0.0639 | 0.0528 |
| Y | 0.0184 | 0.0183 | 0.0183 | 0.0183 | 0.0184 | 0.0183 |

TABLE 3024B
High Gly & Ser, low Tyr
Proportions for positions 7-12 with high Gly & Ser

| | Position | | | | | |
|---|---|---|---|---|---|---|
| AA type | 7 | 8 | 9 | 10 | 11 | 12 |
| A | 0.0725 | 0.0642 | 0.0580 | 0 | 0 | 0 |
| D | 0.0313 | 0.0293 | 0.0342 | 0 | 1.00 | 0 |
| F | 0 | 0.0266 | 0.0448 | 1.00 | 0 | 0 |
| G | 0.2228 | 0.2228 | 0.2228 | 0 | 0 | 0 |
| L | 0.0687 | 0.0702 | 0.0520 | 0 | 0 | 0 |
| P | 0.0872 | 0.0855 | 0.0955 | 0 | 0 | 0 |
| R | 0.1357 | 0.1204 | 0.1173 | 0 | 0 | 0 |
| S | 0.2228 | 0.2228 | 0.2228 | 0 | 0 | 0 |
| T | 0.0608 | 0.0528 | 0.0513 | 0 | 0 | 0 |
| V | 0.0342 | 0.0440 | 0.0520 | 0 | 0 | 0 |
| W | 0.0458 | 0.0433 | 0.0310 | 0 | 0 | 0 |
| Y | 0.0183 | 0.0183 | 0.0183 | 0 | 0 | 1.00 |

TABLE 3025A
Proportions with high Gly and Tyr
Proportions for positions 1-6 with high Gly & Tyr

| | Position | | | | | |
|---|---|---|---|---|---|---|
| AA type | 1 | 2 | 3 | 4 | 5 | 6 |
| A | 0.0426 | 0.0467 | 0.0501 | 0.0523 | 0.0637 | 0.0682 |
| D | 0.1132 | 0.0274 | 0.0556 | 0.0306 | 0.0435 | 0.0282 |
| E | 0.1222 | 0 | 0 | 0 | 0 | 0 |
| G | 0.2550 | 0.2549 | 0.2550 | 0.2549 | 0.2549 | 0.2550 |
| H | 0.0178 | 0 | 0 | 0 | 0 | 0 |
| I | 0.0216 | 0.0248 | 0 | 0 | 0 | 0 |
| K | 0 | 0.0246 | 0 | 0 | 0 | 0 |
| L | 0.0267 | 0.0670 | 0.0528 | 0.0540 | 0.0606 | 0.0644 |
| N | 0 | 0 | 0 | 0.0638 | 0 | 0 |
| P | 0 | 0.0622 | 0.0508 | 0.0413 | 0.0465 | 0.0642 |
| R | 0.0386 | 0.1229 | 0.1164 | 0.0764 | 0.0926 | 0.0911 |
| S | 0.0188 | 0.0188 | 0.0188 | 0.0188 | 0.0188 | 0.0188 |
| T | 0.0160 | 0.0381 | 0.0434 | 0.0463 | 0.0505 | 0.0587 |
| V | 0.0543 | 0.0391 | 0.0423 | 0.0407 | 0.0409 | 0.0334 |
| W | 0 | 0 | 0.0414 | 0.0471 | 0.0540 | 0.0446 |
| Y | 0.2733 | 0.2737 | 0.2734 | 0.2737 | 0.2741 | 0.2734 |

TABLE 3025B
Proportions with high Gly and Tyr
Proportions for positions 1-6 with high Gly & Tyr

| | Position | | | | | |
|---|---|---|---|---|---|---|
| AA type | 7 | 8 | 9 | 10 | 11 | 12 |
| A | 0.0612 | 0.0542 | 0.0490 | 0 | 0 | 0 |
| D | 0.0264 | 0.0247 | 0.0289 | 0 | 1.00 | 0 |
| F | 0 | 0.0224 | 0.0378 | 1.00 | 0 | 0 |
| G | 0.2550 | 0.2550 | 0.2550 | 0 | 0 | 0 |
| L | 0.0581 | 0.0593 | 0.0440 | 0 | 0 | 0 |
| P | 0.0736 | 0.0722 | 0.0807 | 0 | 0 | 0 |
| R | 0.1146 | 0.1017 | 0.0991 | 0 | 0 | 0 |
| S | 0.0188 | 0.0188 | 0.0188 | 0 | 0 | 0 |
| T | 0.0513 | 0.0446 | 0.0434 | 0 | 0 | 0 |
| V | 0.0289 | 0.0372 | 0.0440 | 0 | 0 | 0 |
| W | 0.0387 | 0.0366 | 0.0262 | 0 | 0 | 0 |
| Y | 0.2734 | 0.2733 | 0.2732 | 0 | 0 | 1.00 |

TABLE 3026A
Proportions with high Ser and Tyr
Proportions with high Ser and Tyr

| | Position | | | | | |
|---|---|---|---|---|---|---|
| AA type | 1 | 2 | 3 | 4 | 5 | 6 |
| A | 0.04193 | 0.04594 | 0.04928 | 0.05143 | 0.06263 | 0.06705 |
| D | 0.11133 | 0.02694 | 0.05464 | 0.03012 | 0.04274 | 0.02777 |
| E | 0.12013 | 0 | 0 | 0 | 0 | 0 |
| G | 0.02508 | 0.02507 | 0.02507 | 0.02507 | 0.02507 | 0.02507 |
| H | 0.01747 | 0 | 0 | 0 | 0 | 0 |
| I | 0.02125 | 0.02434 | 0 | 0 | 0 | 0 |
| K | 0 | 0.02416 | 0 | 0 | 0 | 0 |
| L | 0.02629 | 0.06586 | 0.05195 | 0.05311 | 0.05962 | 0.06331 |
| N | 0 | 0 | 0 | 0.06278 | 0 | 0 |
| P | 0 | 0.06115 | 0.04994 | 0.04066 | 0.04577 | 0.06316 |
| R | 0.03794 | 0.12085 | 0.11443 | 0.07513 | 0.09108 | 0.08958 |
| S | 0.26072 | 0.26062 | 0.2608 | 0.26071 | 0.26064 | 0.26079 |
| T | 0.01573 | 0.03746 | 0.04272 | 0.04551 | 0.04966 | 0.05776 |
| V | 0.05338 | 0.03845 | 0.0416 | 0.04 | 0.04018 | 0.03281 |
| W | 0 | 0 | 0.04069 | 0.04636 | 0.05306 | 0.04383 |
| Y | 0.26876 | 0.26916 | 0.26889 | 0.26912 | 0.26954 | 0.26887 |

TABLE 3026B
Proportions with high Ser and Tyr
Proportions with high Ser and Tyr

Position

| AA type | 7 | 8 | 9 | 10 | 11 | 12 |
|---|---|---|---|---|---|---|
| A | 0.0602 | 0.05333 | 0.04818 | 0 | 0 | 0 |
| D | 0.02597 | 0.0243 | 0.02843 | 0 | 1.0 | 0 |
| F | 0 | 0.02206 | 0.03722 | 1.0 | 0 | 0 |
| G | 0.02507 | 0.02508 | 0.02508 | 0 | 0 | 0 |
| L | 0.05709 | 0.05832 | 0.04322 | 0 | 0 | 0 |
| P | 0.0724 | 0.071 | 0.07936 | 0 | 0 | 0 |
| R | 0.11267 | 0.09999 | 0.09743 | 0 | 0 | 0 |
| S | 0.26079 | 0.2608 | 0.26072 | 0 | 0 | 0 |
| T | 0.05045 | 0.04384 | 0.04265 | 0 | 0 | 0 |
| V | 0.02842 | 0.03659 | 0.04322 | 0 | 0 | 0 |
| W | 0.03807 | 0.03595 | 0.02578 | 0 | 0 | 0 |
| Y | 0.26887 | 0.26874 | 0.2687 | 0 | 0 | 1.0 |

TABLE 3027A
Proportions with high Gly, Ser, and Tyr
Proportions with high Gly, Ser, and Tyr

| | Position | | | | | |
|---|---|---|---|---|---|---|
| AA type | 1 | 2 | 3 | 4 | 5 | 6 |
| A | 0.0215 | 0.0236 | 0.0253 | 0.0264 | 0.0321 | 0.0344 |
| D | 0.0570 | 0.0138 | 0.0280 | 0.0154 | 0.0219 | 0.0142 |
| E | 0.0615 | 0 | 0 | 0 | 0 | 0 |
| G | 0.2572 | 0.2572 | 0.2572 | 0.2572 | 0.2572 | 0.2572 |
| H | 090 | 0 | 0 | 0 | 0 | 0 |
| I | 0.0109 | 0.0125 | 0 | 0 | 0 | 0 |
| K | 0 | 0.0124 | 0 | 0 | 0 | 0 |
| L | 0.0135 | 0.0338 | 0.0266 | 0.0272 | 0.0306 | 0.0324 |
| N | 0 | 0 | 0 | 0.0322 | 0 | 0 |
| P | 0 | 0.0313 | 0.0256 | 0.0208 | 0.0235 | 0.0324 |
| R | 0.0194 | 0.0619 | 0.0586 | 0.0385 | 0.0467 | 0.0459 |
| S | 0.2572 | 0.2572 | 0.2572 | 0.2572 | 0.2573 | 0.2572 |
| T | 081 | 0.0192 | 0.0219 | 0.0233 | 0.0255 | 0.0296 |
| V | 0.0274 | 0.0197 | 0.0213 | 0.0205 | 0.0206 | 0.0168 |
| W | 0 | 0 | 0.0208 | 0.0238 | 0.0272 | 0.0225 |
| Y | 0.2575 | 0.2575 | 0.2575 | 0.2575 | 0.2575 | 0.2575 |

TABLE 3027B
Proportions with high Gly, Ser, and Tyr
Proportions with high Gly, Ser, and Tyr

| | Position | | | | | |
|---|---|---|---|---|---|---|
| AA type | 7 | 8 | 9 | 10 | 11 | 12 |
| A | 0.0308 | 0.0273 | 0.0247 | 0 | 0 | 0 |
| D | 0.0133 | 0.0125 | 0.0146 | 0 | 1.00 | 0 |
| F | 0 | 0.0113 | 0.0191 | 1.00 | 0 | 0 |
| G | 0.2572 | 0.2572 | 0.2572 | 0 | 0 | 0 |
| L | 0.0292 | 0.0299 | 0.0221 | 0 | 0 | 0 |
| P | 0.0371 | 0.0364 | 0.0407 | 0 | 0 | 0 |
| R | 0.0577 | 0.0512 | 0.0499 | 0 | 0 | 0 |
| S | 0.2572 | 0.2572 | 0.2572 | 0 | 0 | 0 |
| T | 0.0258 | 0.0225 | 0.0218 | 0 | 0 | 0 |
| V | 0.0146 | 0.0187 | 0.0221 | 0 | 0 | 0 |
| W | 0.0195 | 0.0184 | 0.0132 | 0 | 0 | 0 |
| Y | 0.2575 | 0.2575 | 0.2575 | 0 | 0 | 1.00 |

TABLE 3028A
Proportions for Example 13

| | Position | | | | | |
|---|---|---|---|---|---|---|
| | 1 | 2 | 3 | 4 | 5 | 6 |
| A | 0.0494 | 0.0542 | 0.0581 | 0.0607 | 0.0739 | 0.0783 |
| D | 0.1312 | 0.0318 | 0.0644 | 0.0356 | 0.0504 | 0.0324 |
| E | 0.1416 | 0.0000 | 0.0000 | 0.0000 | 0.0000 | 0.0000 |
| F | 0.0000 | 0.0000 | 0.0000 | 0.0000 | 0.0000 | 0.0000 |
| G | 0.2374 | 0.2374 | 0.2375 | 0.2376 | 0.2377 | 0.2450 |
| H | 0.0206 | 0.0000 | 0.0000 | 0.0000 | 0.0000 | 0.0000 |
| I | 0.0251 | 0.0287 | 0.0000 | 0.0000 | 0.0000 | 0.0000 |
| K | 0.0000 | 0.0285 | 0.0000 | 0.0000 | 0.0000 | 0.0000 |
| L | 0.0310 | 0.0777 | 0.0613 | 0.0626 | 0.0704 | 0.0739 |
| N | 0.0000 | 0.0000 | 0.0000 | 0.0740 | 0.0000 | 0.0000 |
| P | 0.0000 | 0.0721 | 0.0589 | 0.0480 | 0.0540 | 0.0738 |
| Q | 0.0000 | 0.0000 | 0.0000 | 0.0000 | 0.0000 | 0.0000 |
| R | 0.0447 | 0.1426 | 0.1350 | 0.0886 | 0.1075 | 0.1046 |
| S | 0.2374 | 0.2374 | 0.2374 | 0.2374 | 0.2375 | 0.2351 |
| T | 0.0185 | 0.0442 | 0.0504 | 0.0537 | 0.0586 | 0.0675 |
| V | 0.0629 | 0.0454 | 0.0491 | 0.0472 | 0.0474 | 0.0383 |
| W | 0.0000 | 0.0000 | 0.0480 | 0.0547 | 0.0626 | 0.0512 |
| Y | 0.0000 | 0.0000 | 0.0000 | 0.0000 | 0.0000 | 0.0000 |

TABLE 3028B
Proportions for Example 13

| | Position | | | | | |
|---|---|---|---|---|---|---|
| | 7 | 8 | 9 | 10 | 11 | 12 |
| A | 0.0710 | 0.0629 | 0.0562 | 0.0275 | 0.0275 | 0 |
| D | 0.0306 | 0.0287 | 0.0331 | 0.0162 | 0.5162 | 0 |
| E | 0.0000 | 0.0000 | 0.0000 | 0.0000 | 0.0000 | 0 |
| F | 0.0000 | 0.0260 | 0.0434 | 0.5212 | 0.0212 | 0 |
| G | 0.2375 | 0.2375 | 0.2353 | 0.1152 | 0.1152 | 0 |
| H | 0.0000 | 0.0000 | 0.0000 | 0.0000 | 0.0000 | 0 |
| I | 0.0000 | 0.0000 | 0.0000 | 0.0000 | 0.0000 | 0 |
| K | 0.0000 | 0.0000 | 0.0000 | 0.0000 | 0.0000 | 0 |
| L | 0.0673 | 0.0688 | 0.0504 | 0.0247 | 0.0247 | 0 |
| N | 0.0000 | 0.0000 | 0.0000 | 0.0000 | 0.0000 | 0 |
| P | 0.0854 | 0.0837 | 0.0925 | 0.0453 | 0.0453 | 0 |
| Q | 0.0000 | 0.0000 | 0.0000 | 0.0000 | 0.0000 | 0 |
| R | 0.1329 | 0.1179 | 0.1135 | 0.0556 | 0.0556 | 0 |
| S | 0.2374 | 0.2374 | 0.2455 | 0.1152 | 0.1152 | 0 |
| T | 0.0595 | 0.0517 | 0.0497 | 0.0243 | 0.0243 | 0 |
| V | 0.0335 | 0.0431 | 0.0504 | 0.0247 | 0.0247 | 0 |
| W | 0.0449 | 0.0424 | 0.0300 | 0.0147 | 0.0147 | 0 |
| Y | 0.0000 | 0.0000 | 0.0000 | 0.0155 | 0.0155 | 1.0 |

TABLE 3031
Distributions for actual positions 6-8 in HC CDR3 of length 8.

| AA | | | |
|---|---|---|---|
| type | Act 6 | Act 7 | Act 8 |
| A | 0.0455 | 0.0403 | 0.0364 |
| D | 0.0196 | 0.5187 | 0.0215 |
| F | 0.5 | 0.0167 | 0.0281 |
| G | 0.0116 | 0.0116 | 0.0116 |
| L | 0.0432 | 0.0441 | 0.0327 |
| P | 0.0548 | 0.0536 | 0.06 |
| R | 0.085 | 0.0756 | 0.0737 |
| S | 0.0116 | 0.0116 | 0.0116 |
| T | 0.0382 | 0.0332 | 0.0323 |
| V | 0.0215 | 0.0276 | 0.0327 |
| W | 0.0288 | 0.0272 | 0.0195 |
| Y | 0.1402 | 0.1398 | 0.6399 |

TABLE 3032
Positions 5-7 in HC CDR3s of length 7.

| AA type | Act 5 | Act 6 | Act 7 |
|---|---|---|---|
| A | 0.0472 | 0.0507 | 0.0455 |
| D | 0.0322 | 0.5210 | 0.0196 |
| F | 0.5000 | 0.0000 | 0.0000 |
| G | 0.0116 | 0.0116 | 0.0116 |
| L | 0.0450 | 0.0479 | 0.0432 |
| P | 0.0345 | 0.0478 | 0.0548 |
| R | 0.0687 | 0.0678 | 0.0852 |
| S | 0.0116 | 0.0116 | 0.0116 |
| T | 0.0374 | 0.0437 | 0.0382 |
| V | 0.0303 | 0.0248 | 0.0215 |
| W | 0.0400 | 0.0332 | 0.0288 |
| Y | 0.1414 | 0.1399 | 0.6400 |

TABLE 3033
Averaged tabulated positions 5 & 10, 6 & 11, and
7 & 12 of Table 3010

| AA type | Act 4 | Act 5 | Act 6 |
|---|---|---|---|
| A | 0.0389 | 0.0472 | 0.0507 |
| D | 0.0228 | 0.5322 | 0.0210 |
| F | 0.5000 | 0.0 | 0.0 |
| G | 0.0116 | 0.0116 | 0.0116 |
| L | 0.0401 | 0.0450 | 0.0479 |
| N | 0.0474 | 0.0 | 0.0 |
| P | 0.0307 | 0.0345 | 0.0478 |
| R | 0.0568 | 0.0687 | 0.0678 |
| S | 0.0116 | 0.0116 | 0.0116 |
| T | 0.0344 | 0.0374 | 0.0437 |
| V | 0.0302 | 0.0303 | 0.0248 |
| W | 0.0350 | 0.0400 | 0.0332 |
| Y | 0.1405 | 0.1414 | 0.6399 |

### Example 9

### A Library of LC

There are 40 Vkappa germline genes. In the CDRs, these show the diversity shown in Table 3600. One embodiment of the invention involves a library in which the varied positions of the LC CDRs (CDR1: 27-28, 30-32; CDR2: 50, 53, 56, and CDR3: 91-96) are varied so that a) the germline residue of A27 is present at 50% (the first AAT in each of the “Allowed AATs” columns of Table 3601-3603 is the germline AAT), b) the ten most common AATs at each position are included, and c) all the AATs that are seen at each position are included at equal frequency. This means that some positions have more than 11 allowed AATs. Two positions are allowed to have no amino acid in a portion of the library, these are 30a and 93 as indicated by “*” in the “Allowed AATs” column of table 3601 and table 3603. That is, CDR1 can be either 11 or 12 in length and CDR3 can be either 8 or 9 in length. This gives a diversity of 2.9E6 for CDR1, 1.8E3 for CDR2, and 3.4E6 for CDR3. The overall allowed diversity is 1.8E16. An actual library could have 1.E7, 3.E7, 1.E8, 3.E8, 1.E9, or 3.E9 actual members. These would be combined with a HC library that has 0.1, 0.3, 1., 3., or 10 times as many members to make a library of 1.E8, 3.E8, 1.E9, 3.E9, 1.E10, 3.E10, 1.E11, or 5.E11 members.

The library is built in the vector pMID55F as shown in Table 3610 and Table 3611. Vector pMID55F has been designed to make transfer of diversity into the vector efficient. Each CDR in the vector has two stop codons. First four libraries are built: HC CDR1-CDR2, HC CDR3, LC CDR1-CDR2, and LC CDR3. Each of these libraries will have 1.E6, 3.E6, 1.E7, or 3.E7 members. A library of HCs is built by transferring the CDR3 diversity as XbaI-ApaI fragments into the HC CDR1-CDR2 diversity. This HC library will have 1.E7, 3.E7, 1.E8, 3.E8, 1.E9, or 5.E9 members. XbaI and ApaI have opposite polarity, XbaI creates a 5′ overhang while ApaI gives a 3′ overhang.

A library of LCs is built by transferring the CDR1-CDR2 diversity as a SacI/XhoI fragment into the CDR3 diversity. SacI gives a 3′ overhang while XhoI gives a 5′ overhang. This LC library will have 1.E7, 3.E7, 1.E8, 3.E8, 1.E9, or 5.E9 members. The Fab library is built by transferring LCs as SacI/EcoRI fragments into the HC diversity. SacI gives a 3′ overhang while EcoRI gives a 5′ overhang. The final library will have 1.E8, 3.E8, 1.E9, 3.E9, 1.E10, 3.E10, 1.E11, or 5.E11 members. All of the restriction enzymes used in construction of the library are available at high concentration and cut to completion. Each pair of enzymes used has one that give a 5′ overhang while the other give a 3′ overhang.

TABLE 3600
Germ-line diversity of human Vkappas in the CDRs

CDR1

| | | |
|---|---|---|
| 24 | RQWKG | n = 5 |
| 25 | AMS | n = 3 |
| 26 | SR | n = 2 |
| 27 | QE | n = 2 |
| 28 | SDG | n = 3 |
| 29 | ILV | n = 3 |
| 30 | SRLVDG | n = 6 |
| 31 | SNDYH | n = 5 |
| 31a | -S | n = 2 |
| 31b | -DS | n = 3 |
| 31c | -DN | n = 3 |
| 31d | -GN | n = 3 |
| 31e | -NKY | n = 4 |
| 31f | -TN | n = 3 |
| 32 | YDWANS | n = 6 |
| 33 | LM | n = 2 |
| 34 | NAGDYSH | n = 7 |

CDR2

| | | |
|---|---|---|
| 50 | ADYTKELGW | n = 9 |
| 51 | ALVGI | n = 5 |
| 52 | ST | n = 2 |
| 53 | SNTYQ | n = 5 |
| 54 | LRWS | n = 4 |
| 55 | QEADFVI | n = 7 |
| 56 | STP | n = 3 |

CDR3

| | | |
|---|---|---|
| 89 | QLMH | n = 4 |
| 90 | QK | n = 2 |
| 91 | SYHFALDRG | n = 9 |
| 92 | YDNITLGS | n = 8 |
| 93 | SNEHQK | n = 6 |
| 94 | TLAYFWSH | n = 8 |
| 95 | PSH | n = 3 |

Diversity: 8.82E+08 3.78E+04 8.29E+04 2.76E+18
Nkappa = 40

TABLE 3601
LC CDR1 Diversity (SEQ ID NO: 1148)

| Position | Diversity | Cumulative | Allowed AATs |
|---|---|---|---|
| 24 | 1 | 1 | R |
| 25 | 1 | 1.00E+00 | A |
| 26 | 1 | 1.00E+00 | S |
| 27 | 11 | 1.10E+01 | QEADGHKLNPR |
| 28 | 11 | 1.21E+02 | SDGAFINPRTY |
| 29 | 1 | 1.21E+02 | V |
| 30 | 13 | 1.57E+03 | SRLVDGAFINPTY |
| 30a | 13 | 2.04E+04 | SNDYHAGIPRTY* |
| 31 | 12 | 2.45E+05 | SADGHIKNRTY |
| 32 | 12 | 2.94E+06 | YDWANSFHKLQR |
| 33 | 1 | 2.94E+06 | L |
| 34 | 1 | 2.94E+06 | A |

TABLE 3602
LC CDR2 Diversity (SEQ ID NO: 1149)

| Position | Diversity | Cumulative | Allowed AATs |
|---|---|---|---|
| 50 | 14 | 14 | GADYTKELWHNRSV |
| 51 | 1 | 1.40E+01 | A |
| 52 | 1 | 1.40E+01 | S |
| 53 | 12 | 1.68E+02 | SNTYQDFGHIKR |
| 54 | 1 | 1.68E+02 | R |
| 55 | 1 | 1.68E+02 | A |
| 56 | 11 | 1.85E+03 | TPSADGHIKNR |

TABLE 3603
LC CDR3 diversity

| Position | Diversity | Cumulative | Allowed AATs |
|---|---|---|---|
| 89 | 1 | 1 | Q |
| 90 | 1 | 1.00E+00 | Q |
| 91 | 11 | 1.10E+01 | YSHFALDRGQT |
| 92 | 13 | 1.43E+02 | GYDNITLSAEFRV |
| 93 | 15 | 2.15E+03 | SNEHQKADGIRTVY* |
| 94 | 12 | 2.57E+04 | STLAYFWHGIPR |
| 95 | 12 | 3.09E+05 | PSHAFGKLQRTV |
| 96 | 11 | 3.40E+06 | LWYFIVRQPKG |
| 97 | 1 | 3.40E+06 | T |

TABLE 3610
pMID55F annotated

```
pMID55F 4621 2010.07.28
LC
CDR1-2 as SacI(GAGCTc)/XhoI(Ctcgag) is 442
SacI uses NEB buffer 1(100) or 4(100); 20 Ku/mL or 100 Ku/mL
XhoI uses NEB buffer 2(100), 3(100), or 4(100); 20 Ku/mL or 100 Ku/mL
CDR3 as XhoI(Ctcgag)/NcoI(Ccatgg) is 511
XhoI uses NEB buffer 2(100), 3(100), or 4(100); 20 Ku/mL or 100 Ku/mL
NcoI uses NEB buffer 2(100) or 4(100); 20 or 100 Ku/mL
CDR3 as XhoI(Ctcgag)/AscI(GGcgcgcc) is 420
whole LC as HindIII(Aagctt)/EcoRI(Gaattc) is 564
whole LC as SacI(GAGCTc)/EcoRI(Gaattc) is 684
SacI uses NEB buffer 1(100) or 4(100); 20 Ku/mL or 100 Ku/mL
EcoRI uses any NEB buffer at 100% activity; 20 or 100 Ku/mL
HC
CDR1-2 as EcoRI(Gaattc)/XbaI(Tctaga) is 487
CDR3 as XbaI(Tctaga)/ApaI(GGGCCc) is 459
XbaI uses NEB buffers 2(100) or 4(100); 20 or 100 Ku/mL
CDR3 as PstI(CTGCAg)/ApaI(GGGCCc) is 398
whole HC as AscI(GGcgcgcc)/NheI(Gctagc) is 488
Preferred procedure is to:
a) put LC CDR1-2 into LC CDR3 diversity (SacI and XhoI have opposite
      polarity),
b) put HC CDR3 into HC CDR1-2 diversity (XbaI and ApaI have opposite
      polarity), and
c) put LC diversity into HC diversity (SacI and EcoRI have opposite
      polarity).
Dropping in Ff ORI:
KpnI(GGTACc; 4622) and ApaLI(Gtgcac; 4235) Len = 387 polarity is opposite
ApaLI uses NEB buffers 1, 2, or 4; 10 Ku/mL or 50 Ku/mL
Dropping in Anchor::Ff ORI:
KpnI(GGTACc; 4622) and PspOMI(Gggccc; 3424) Len = 1198
KpnI uses NEB buffer 4, 100 Ku/mL or 20 Ku/mL
PspOMI uses NEB buffer 4, 20 Ku/mL
------------------------------------------------------------------------
Input = F:\zzback\VECTORS\pMID52\pmid55f.ibi
LOCUS pMID55F 4621 CIRCULAR
Useful REs (cut MAnoLI fewer than 3 times) 2003.02.04 plus AseI
Non-cutters
```

| | | |
|---|---|---|
| AatII GACGTc | AfeI AGCgct | AvrII Cctagg |
| BclI Tgatca | BsmI NGcattc | BspMI Nnnnnnnnngcaggt |
| | | (SEQ ID NO: 1048) |
| BsrGI Tgtaca | BstAPI GCANNNNntgc | BstZ17I GTAtac |
| | (SEQ ID NO: 1049) | |
| NotI GCggccgc | NruI TCGcga | NsiI ATGCAt |
| PciI Acatgt | PmeI GTTTaaac | PshAI GACNNnngtc |
| | | (SEQ ID NO: 1050) |
| SalI Gtcgac | SapI GCTCTTC | SbfI CCTGCAgg |
| SgfI GCGATcgc | SnaBI TACgta | SphI GCATGc |
| Sse8387I CCTGCAgg | SwaI ATTTaaat | XcmI CCANNNNNnnnntgg |
| | | (SEQ ID NO: 1051) |

cutters
Enzymes that cut more than 5 times.
BsrFI Rccggy 7
FauI nNNNNNNGCGGG 6
(SEQ ID NO: 1150)
Enzymes that cut from 1 to 5 times.
$ = DAM site, * = DCM site, & = both

| | | | | | | |
|---|---|---|---|---|---|---|
| Acc65I Ggtacc | 1 | 1 | | | | |
| KpnI GGTACc | 1 | 1 | ++++++ | | | |
| BsaBI GATNNnnatc | 2 | 7$ | 1016 | | | |
| (SEQ ID NO: 1047) | | | | | | |
| PvuI CGATcg | 3 | 12$ | 562$ | 4120$ | | |
| EagI Cggccg | 2 | 16$ | 1011 | | | |
| NaeI GCCggc | 4 | 18 | 789 | 2739 | 4366 | |
| NgoMIV Gccggc | 4 | 18 | 789 | 2739 | 4366 | |
| BciVI GTATCCNNNNNN | 2 | 86 | 1637 | | | |
| (SEQ ID NO: 1054) | | | | | | |
| BspHI Tcatga | 2 | 94 | 1126 | | | |
| EarI Nnnnngaagag | 3 | 135 | 3470$ | 4101 | | |
| (SEQ ID NO: 1268) | | | | | | |
| -″-CTCTTCNnnn | 2 | 2838 | 3327 | | | |
| (SEQ ID NO: 1052) | | | | | | |
| StyI Ccwwgg | 3 | 226 | 2744 | 3386 | | |
| Eco57I CTGAAG | 3 | 247$ | 325 | 2240 | | |
| -″- cttcag | 1 | 1319 | | | | |
| AvaI Cycgrg | 4 | 265 | 2019 | 2233 | 4578 | |
| BglII Agatct | 1 | 287$ | | | | |
| StuI AGGcct | 1 | 321 | | | | |
| BsiHKAI GWGCWc | 5 | 347 | 1791 | 3159 | 3242 | 4235 |
| HgiAI GWGCWc | 5 | 347 | 1791 | 3159 | 3242 | 4235 |
| BlpI GCtnagc | 2 | 380 | 2058 | | | |
| EspI GCtnagc | 2 | 380 | 2058 | | | |
| MscI TGGcca | 1 | 398 | | | | |
| BcgI gcannnnnntcg | 1 | 407 | | | | |
| (SEQ ID NO: 1055) | | | | | | |
| -″- cgannnnnntgc | 1 | 498 | | | | |
| (SEQ ID NO: 1152) | | | | | | |
| BamHI Ggatcc | 1 | 421$ | | | | |
| SexAI Accwggt | 1 | 442* | | | | |
| ScaI AGTact | 2 | 451 | 2920 | | | |
| BsiWI Cgtacg | 1 | 494 | | | | |
| HincII GTYrac | 2 | 554 | 2007 | | | |
| HpaI GTTaac | 1 | 554 | | | | |
| EcoO109I RGgnccy | 4 | 569 | 2023 | 2600 | 3424 | |
| PpuMI RGgwccy | 2 | 569 | 2023 | | | |
| Bsu36I CCtnagg | 1 | 573 | | | | |
| BsaAI YACgtr | 2 | 612$ | 4469 | | | |
| BtrI CACgtg | 1 | 612$ | | | | |
| PmlI CACgtg | 1 | 612$ | | | | |
| FspI TGCgca | 2 | 709 | 4140 | | | |
| AseI ATtaat | 2 | 758 | 989 | | | |
| FseI GGCCGGcc | 1 | 788 | | | | |
| BstBI TTcgaa | 1 | 802 | | | | |
| BglI GCCNNNNnggc | 4 | 810 | 2734 | 3493 | 4146 | |
| (SEQ ID NO: 1056) | | | | | | |
| BpmI CTGGAG | 1 | 844 | | | | |
| -″- ctccag | 1 | 2039 | | | | |
| BsaI GGTCTCNnnnn | 1 | 862 | | | | |
| (SEQ ID NO: 1057) | | | | | | |
| RsrII CGgwccg | 1 | 887 | | | | |
| AhdI GACNNNnngtc | 1 | 929 | | | | |
| (SEQ ID NO: 1058) | | | | | | |
| Eam1105I GACNNNnngtc | 1 | 929 | | | | |
| (SEQ ID NO: 1153) | | | | | | |
| PacI TTAATtaa | 1 | 990 | | | | |

1025: End of AlpR module ------------------------------------------

| | | | | | |
|---|---|---|---|---|---|
| BmgBI CACgtc | 1 | 1026 | ++++++ | | |
| AlwNI CAGNNNctg | 2 | 1432 | 2599 | | |
| BssSI Cacgag | 1 | 1673 | | | |
| DrdI GACNNNNnngtc | 3 | 1738 | 3019 | 4512 | |
| (SEQ ID NO: 1059) | | | | | |
| BseRI NNnnnnnnnnctcctc | 3 | 1784 | 2127 | 3140 | |
| (SEQ ID NO: 1063) | | | | | |
| BanII GRGCYc | 4 | 1791 | 3406 | 3424 | 4396 |
| Ecl1361 GAGctc | 1 | 1791 | | | |

1791: End of ColE1 ORI module -------------------------------------

| | | | |
|---|---|---|---|
| SacI GAGCTc | 1 | 1791 | ++++++ |

1797: Start Plac module -------------------------------------------

| | | | |
|---|---|---|---|
| PflMI CCANNNNntgg | 1 | 1909 | CCAagcttTGG |
| (SEQ ID NO: 1060) | | | (SEQ ID NO: 1154) |
| HindIII Aagctt | 1 | 1911 | ++++++ |
| BsmFI Nnnnnnnnnnnnnnngtccc | 2 | 1963 | 2001 |
| (SEQ ID NO: 1061) | | | |
| -″- GGGACNNNNNNNNNNnn | 2 | 2023* | 2203 |
| (SEQ ID NO: 1062) | | | |

1945: Start LC Signal sequence ------------------------------------

| | | | |
|---|---|---|---|
| SpeI Actagt | 1 | 1971 | ++++++ |

1999: Start LC FR1 ------------------------------------------------

| | | | | | |
|---|---|---|---|---|---|
| PflFI GACNnngtc | 4 | 2010 | 2025 | 2541 | 3222 |
| Tthl11I GACNnngtc | 4 | 2010 | 2025 | 2541 | 3222 |
| XmaI Cccggg | 1 | 2019 | | | |
| SanDI GGgwccc | 1 | 2023 | | | |

```
  2068: Start LC CDR1 -----------------------------------------------
  2104: Start LC FR2 ------------------------------------------------
```

| | | | | |
|---|---|---|---|---|
| BtgI Ccrygg | 3 | 2131 | 2744 | 3894 |
| DsaI Ccrygg | 3 | 2131 | 2744 | 3894 |
| SacII CCGCgg | 1 | 2131 | | |

```
  2149: Start LC CDR2 -----------------------------------------------
  2170: Start LC FR3 ------------------------------------------------
```

| | | | |
|---|---|---|---|
| TliI Ctcgag | 1 | 2233 | |
| XhoI Ctcgag | 1 | 2233 | ++++++ |
| BsgI ctgcac | 1 | 2336 | |

```
  2266: Start LC CDR3 -----------------------------------------------
  2293: Start LC FR4 ------------------------------------------------
  2323: Start Ckappa ------------------------------------------------
```

| | | | | |
|---|---|---|---|---|
| BbsI gtcttcnnNNNN | 3 | 2347 | 3133 | 3522 |
| (SEQ ID NO: 1155) | | | | |
| EcoRI Gaattc | 1 | 2475* | | |
| AccI GTmkac | 2 | 2575 | 3028 | |
| SgrAI CRccggyg | 1 | 2612 | | |
| AgeI Accggt | 2 | 2613 | 3216 | |

2647: Stop codon of LC --------------------------------------------

| | | |
|---|---|---|
| AscI GGcgcgcc | 1 | 2653 |
| BssHII Gcgcgc | 1 | 2654 |

2689: Start HC signal sequence ------------------------------------

| | | | |
|---|---|---|---|
| SfiI GGCCNNNNnggcc | 1 | 2733 | GGCCCAGCcggcc |
| (SEQ ID NO: 1066) | | | (SEQ ID NO: 1156) |
| NcoI Ccatgg | 1 | 2744 | |

2752: Start HC FR1 ------------------------------------------------

| | | |
|---|---|---|
| MfeI Caattg | 1 | 2758 |
| BspEI Tccgga | 1 | 2824 |

2842: Start HC CDR1 -----------------------------------------------

| | | | |
|---|---|---|---|
| BstXI CCANNNNNntgg | 1 | 2865* | |
| (SEQ ID NO: 1067) | | | |
| EcoNI CCTNNnnnagg | 2 | 2872* | 3192* |
| (SEQ ID NO: 1068) | | | |

```
  2899: Start HC CDR2 -----------------------------------------------
  2914: Start HC FR3 ------------------------------------------------
```

| | | | |
|---|---|---|---|
| XbaI Tctaga | 1 | 2962 | ++++++ |
| AflII Cttaag | 1 | 3006 | |
| PstI CTGCAg | 1 | 3023 | |

```
  3046: Start HC CDR3 -----------------------------------------------
  3079: Start HC FR4 ------------------------------------------------
```

| | | | |
|---|---|---|---|
| BstEII Ggtnacc | 1 | 3096 | ++++++ |
| BsmBI CGTCTCNnnnn | 1 | 3102 | |
| (SEQ ID NO: 1064) | | | |

3112: Start CH1 ---------------------------------------------------

| | | |
|---|---|---|
| NheI Gctagc | 1 | 3141 |

3423: End of CH1 --------------------------------------------------

| | | | |
|---|---|---|---|
| ApaI GGGCCc | 1 | 3424 | ++++++ |
| Bsp120I Gggccc | 1 | 3424 | |
| PspOMI Gggccc | 1 | 3424 | |
| MluI Acgcgt | 2 | 3518 | 3989 |

3526: Start M13 III domain 3 --------------------------------------

| | | |
|---|---|---|
| BspDI ATcgat | 1 | 3658 |
| NdeI CAtatg | 1 | 3854 |

3982: stop codon of HC::anchor ------------------------------------

| | | |
|---|---|---|
| EcoRV GATatc | 1 | 4000 |
| PvuII CAGctg | 1 | 4090 |
| KasI Ggcgcc | 1 | 4161 |
| ApaLI Gtgcac | 1 | 4235 |

4241: Start of Ff ORI module --------------------------------------

| | | |
|---|---|---|
| DraIII CACNNNgtg | 1 | 4469 |
| PsiI TTAtaa | 1 | 4597 |

```
------------------------------------------------------------------------
(The DNA sequence disclosed below is SEQ ID NO: 1157 and the corresponding
coded amino acid sequences disclosed below are SEQ ID NOS 1158-1160)
          1 GGTACc GATTAcgatc
              KpnI.. BsaBI.....(1/2) KpnI GGTACc; Acc65I Ggtacc
              Acc65I PvuI..(1/3)
        16 Cggcc ggcact tttcggggaa atgtgcgcgg aacccctatt
      PvuI..
              EagI...(1/2)
        57 tgtttatttt
        67 tctaaataca ttcaaatatg tatccgctca tgagacaata accctgataa atgcttcaat
      ApR gene: 192-1049
      127 aatattgaaa aaggaagagt
                    1 2 3 4 5 6 7 8 9 10 11 12 13 14 15
                    M S I Q H F R V A L I P F F A
      147 atg agt att caa cat ttc cgt gtc gcc ctt att ccc ttt ttt gcg
                    16 17 18 19 20 21 22 23 24 25 26 27 28 29 30
                    A F C L P V F A H P E T L V K
      pMID21 acg ctg
      192 gca ttt tgc ctt cct gtt ttt gct cac cca gaa aCc ttg gtg aaa
                                                                                                            StyI....(1/3)
                    31 32 33 34 35 36 37 38 39 40 41 42 43 44 45
                    V K D A E D Q L G A R V G Y I
      237 gta aaa gat gCT GAA Gat cag ttg ggt gcc cga gtg ggt tac atc
                                            Eco57I..(1/4)
                    46 47 48 49 50 51 52 53 54 55 56 57 58 59 60
                    E L D L N S G K I L E S F R P
    pMID21 G CGC C
      282 gaa ctA gat ctc aac agc ggt aag atc ctt gag agt ttt AGG cct
                              BglII... StuI...
                                                                                                                                    Eco57I...
                    61 62 63 64 65 66 67 68 69 70 71 72 73 74 75
                    E E R F P M M S T F K V L L C
      327 GAA Gaa cgt ttt cca atg atg agc act ttt aaa gtt ctg cta tgt
        Eco57I....(2/4)
                    76 77 78 79 80 81 82 83 84 85 86 87 88 89 90
                    G A V L S R I D A G Q E Q L G
    pMID21 A T A TC C G
      372 ggc gcg gtG Ctg agc cgt att gac gcT GGc caa gag caa ctc ggt
                                      BlpI.....(1/2) MscI....(1/2)
                    91 92 93 94 95 96 97 98 99 100 101 102 103 104 105
                    R R I H Y S Q N D L V E Y S P
    pMID21 C A T
  act cc cgc cGg atc cac tat tct cag aat gAc ctg gtt gag tac tca cca
                            BamHI... SexAI....
                  106 107 108 109 110 111 112 113 114 115 116 117 118 119 120
                    V T E K H L T D G M T V R E L
  pMID21 A A
      462 gtc aca gaa aag cat ctt acg gat ggc atg acC gta cga gaa tta
                                                                                                      BsiWI...
                  121 122 123 124 125 126 127 128 129 130 131 132 133 134 135
                    C S A A I T M S D N T A A N L
      507 tgc agt get gcc ata acc atg agt gat aac act gcg gcc aac tta
                  136 137 138 139 140 141 142 143 144 145 146 147 148 149 150
                    L L T T I G G P K E L T A F L
    pMID21 T C G G
      552 ctG TTa aca acg atc gga gga CCt aag gag cta acc gct ttt ttg
                      HpaI.... Bsu36I...
                  151 152 153 154 155 156 157 158 159 160 161 162 163 164 165
                    H N M G D H V T R L D R W E P
    pMID21 T A
      597 cac aac atg ggg gat CAC gtg act cgc ctt gat cgt tgg gaa ccg
                                                          BsaAI..(1/2)
                                                          PmlI...
                  166 167 168 169 170 171 172 173 174 175 176 177 178 179 180
                    E L N E A I P N D E R D T T M
      642 gag ctg aat gaa gcc ata cca aac gac gag cgt gac acc acg atg
                  181 182 183 184 185 186 187 188 189 190 191 192 193 194 195
                    P V A M A T T L R K L L T G E
      687 cct gta gca atg gca aca acg ttg cgc aaa cta tta act ggc gaa
                  196 197 198 199 200 201 202 203 204 205 206 207 208 209 210
                    L L T L A S R Q Q L I D W M E
      732 cta ctt act cta get tcc cgg caa caa tta ata gac tgg atg gag
                  211 212 213 214 215 216 217 218 219 220 221 222 223 224 225
                    A D K V A G P L L R S A L P A
    pMID21 T A A G C TC
      777 gcg gat aaa gtG GCC GGc cca ctt cTT cga aGt gcc ctt ccg gct
                                              FseI....... BstBI...
                  226 227 228 229 230 231 232 233 234 235 236 237 238 239 240
                    G W F I A D K S G A G E R G S
      822 ggc tgg ttt att gct gat aaa tct gga gcc ggt gag cgt ggg tct
                  241 242 243 244 245 246 247 248 249 250 251 252 253 254 255
                    R G I I A A L G P D G K P S R
    pMID21 G G A
      867 cgc ggt atc att gca gca ctC Gga ccg gat ggt aag ccc tcc cgt
                                                                      RsrII....
                  256 257 258 259 260 261 262 263 264 265 266 267 268 269 270
                    I V V I Y T T G S Q A T M D E
      912 atc gta gtt atc tac acg acg ggg agt cag gca act atg gat gaa
                  271 272 273 274 275 276 277 278 279 280 281 282 283 284 285
                    R N R Q I A E I G A S L I K H
    pMID21 C G
      957 cga aat aga cag atc gct gag ata ggt gcc tca TTA ATT aag cat
                                                                                                          PacI......
                  286 287
                    W •  •
    1002 tgg taa tga Cggcc GATGGtcATC
                                          EagI....(2/2) (Cggccg)
                                                        BsaBI.....
    1026 CACgtc
                  BmgBI.
--- Boundary between AmpR module and ColE1 ORI module ---------------------
    1032 ctgtcagac caagtttact
    1051 catatatact ttagattgat ttaaaacttc atttttaatt taaaaggatc taggtgaaga
    1111 tcctttttga taatctcatg accaaaatcc cttaacgtga gttttcgttc cactgagcgt
                                                                                  Start ColE1 ORI from pBR322
    1171 cagaccccgt agaaaagatc aaaggatctt cttgagatcc tttttttctg cgcgtaatct
    1231 gctgcttgca aacaaaaaaa ccaccgctac cagcggtggt ttgtttgccg gatcaagagc
    1291 taccaactct ttttccgaag gtaactggct tcagcagagc gcagatacca aatactgttc
    1351 ttctagtgta gccgtagtta ggccaccact tcaagaactc tgtagcaccg cctacatacc
    1411 tcgctctgct aatcctgtta cCAGTGGctg ctgccagtgg cgataagtcg tgtcttaccg
                                                            AlwNI....(1/2)
    1471 ggttggactc aagacgatag ttaccggata aggcgcagcg gtcgggctga acggggggtt
    1531 cgtgcataca gcccagcttg gagcgaacga cctacaccga actgagatac ctacagcgtg
    1591 agctatgaga aagcgccacg cttcccgaag ggagaaaggc ggacaggtat ccggtaagcg
    1651 gcagggtcgg aacaggagag cgCacgaggg agcttccagg gggaaacgcc tggtatcttt
                                                              BssSI.
    1711 atagtcctgt cgggtttcgc cacctctgac ttgagcgtcg atttttgtga tgctcgtcag
                        End of ColE1 ORI
    1771 gggggcggag cctatggaaa GAGCTc
                                                          SacI..
        Lac promoter
                                            −35 region.......
    1797 ctcactcatt aggcACCCCA GGCTTTACAC
                                        −10 region....... Lac operator...........
    1827 tttatgcttc cgGCTCGTAT GTTGTGTGgA ATTGTGAGCG GATAACAATT tcacacagga
    1887 aacagctatg accatgatta
    HindIII-NheI segment with stop codons in all CDRs (2010.06.15)
    1907 cgCC AAGCTt tggagccttttttttggagattttcaac
                        PflMI.......(CCANNNNntgg) (SEQ ID NO: 1060)
                                HindIII (Aagctt)
    A Display gene for A27 in pM22B3.
    IIIsignal::A27::Ckappa
                  signal sequence-----(1945-1998)------------------------------
                      1 2 3 4 5 6 7 8 9 10 11 12 13 14 15
                      M K K L L S A I P L V V P F Y
    1945 |atg|aaG|aaA|ctg|ctg|tct|gct|atc|ccA|cta|gtt|gtc|cct|ttc|tat|
                                                                                        SpeI....
                Signal-------
                    16 17 18
                      S H S
    1990 |tct|cat|agt|
                  FR1------------------------------------------
                  19 20 21 22 23 24 25 26 27 28 29 30
                  E1 I V3 L T5 Q S7 P G9 T L S12
  a27 gl: T A C
    1999 |gaa|atT|gtG|TTg|acg|cag|tcC|ccg|ggG|aCC|Ctg|tct|
                                      HincII.. XmaI....(Cccggg)
                                      (2/2) SanDI....(GGgwccc)
                    FR1---------------------------------------
                    31 32 33 34 35 36 37 38 39 40 41
                    L13 S P G E R A T L S C23
  A27 Gl: C C C
    2035 |ttg|tCT|CCA|Ggg|gaa|aga|gcc|acG|CTg|AGC|tgc|
                                                                                BlpI.....(2/2)(GCtnagc)
                    CDR1-------------------------------------------
                    42 43 44 45 46 47 48 49 50 51 52 53
                    R24 A S Q S28 V S S S30a Y L A34
  A27 Gl: AG C AGT
    2068 TAG|gcA|TAG|cag|agt|gtt|agc|agc|agc|tac|tta|gcc|
                      * *
                      FR2-------------------------------------------------------
                    54 55 56 57 58 59 60 61 62 63 64 65 66 67 68
                    W Y Q Q K P G Q A P R45 L L I Y
  A27 GL: C T C C A
    2104 |tgg|taT|cag|cag|aaa|ccg|ggt|cag|gct|CCG|Cgg|ctc|ctc|atc|tat|
                                                                                            SacII..
                      CDR2-----------------------
                    69 70 71 72 73 74 75
                      G50 A S S R A T56
  A27 GL: CC G
    2149 |ggt|gca|TAA|agc|TAG|gcc|act|
                                      * *
                    FR3-------------------------------------------------------
                    76 77 78 79 80 81 82 83 84 85 86 87 88 89 90
                      G I P D60 R F S G S65 G S G T D F
  A27 GL:
    2170 |ggc|atc|cca|gac|agg|ttc|agt|ggc|agt|ggg|TCt|GGg|aca|gac|ttc|
                    FR3-------------------------------------------------------
                    91 92 93 94 95 96 97 98 99 100 101 102 103 104 105
                      T L T I S R L E P E D F A V Y
  A27 GL:
    2215 |act|ctc|acc|atc|agc|aGa|Ctc|gag|cCT|GAA|Gat|ttt|gca|gtg|tat|
                                                                    XhoI... Eco57I..(3/3)
                    FR3----
                  106 107
                      Y C
  A27 GL:
    2260 |tac|tgt|
                    CDR3------------------------------
                    108 109 110 111 112 113 114 115 116
                    Q89 Q Y G S S P95 L T
  A27 GL: T C
    2266 |cag|cag|TAG|ggt|agc|TAA|cct|ctc|act|
                                      * *
                  FR4------------------------------------- JK4
                    117 118 119 120 121 122 123 124 125 126
                    F98 G G G101 T K V E I K107
  JK4 g
    2293 |ttc|ggc|gga|ggc|act|aag|gtg|gag|atc|aaa|
                                                                                            ++Cut site of BsgI
                  Ckappa----------------------------------------------------
                  R G T V A A P S V F I F P P S
    2323 cgt gga act gtg gCT GCA Cca tct gtc ttc atc ttc ccg cca tct
                                                  BsgI....(−14/−16)
                  D E Q L K S G T A S V V C L L
    2368 gat gag cag ttg aaa tct gga act gcc tct gtt gtg tgc ctg ctg
                  N N F Y P R E A K V Q W K V D
    2413 aat aac ttc tat ccc aga gag gcc aaa gta cag tgg aag gtg gat
                  N A L Q S G N S Q E S V T E Q
    2458 aac gcc ctc caa tcg ggG aat tcc cag gag agt gtc aca gag cag
                                                            EcoRI...
                  D S K D S T Y S L S S T L T L
    2503 gac agc aag gac agc acc tac agc ctc agc agc acc ctg act ctg
                  S K A D Y E K H K V Y A C E V
    2548 tcc aaa gca gac tac gag aaa cac aaa GTC TAC gcc tgc gaa gtc
                  T H Q G L S S P V T K S F N R
    2593 acc cat CAG GGC ctg agt tCA ccg gtg aca aag agc ttc aac agg
                                AlwNI......(2/2) SgrAI.....
                  G E C •  •
    2638 gga gag tgt taa taa
    2653 GG cgcgcc ta accatctatt
                                                      AscI.....
                                                        BssHII.
    2673 tcaaggaaca gtctta
                  HC signal seq
                    1 2 3 4 5 6 7 8 9 10 11 12 13 14 15
                  M K K L L F A I P L V V P F V
    2689 atg aag aaa ctg ctc ttt gct atc ccg ctc gtc gtt cct ttt gtG
                                                                                                                                    SfiI...
                  16 17 18 19 20 21
                  A Q P A M A
    2734 GCC CAG Ccg gcc ATG Gcc
          SfiI..............
                                          NcoI.... (Ccatgg)
                HC FR1----------------------------
                  22 23 24 25 26 27 28 29 30
                  E V Q L L E S G G
    2752 gaa gtt Caa ttg tta gag tct ggt ggc
                                MfeI...
                  FR1-------------------------------------------------------
                  31 32 33 34 35 36 37 38 39 40 41 42 43 44 45
                  G L V Q P G G S L R L S C A A
    2779 ggt ctt gtt cag cct ggt ggt tct tta cgt ctt tct tgc gct gct
                  FR1-------------------
                  46 47 48 49 50 51
                  S G F T F S
    2824 Tcc gga ttc act ttc tct
                BspEI..¹
                CDR1--------------
                  52 53 54 55 56
                  S •  A •  S
    2842 tcg TAG get TAA tct
                          Y M
                  FR2---------------------------------------------------
                  57 58 59 60 61 62 63 64 65 66 67 68 69 70
                  W V R Q A P G K G L E W V S
    2857 tgg gtt cgC CAA GCT Cct ggt aaa ggt ttg gag tgg gtt tct
                                    BstXI............
                CDR2--------------
                71 72 73 74 75
                  •  I •  G S
    2899 TGA atc TAA ggt tct
                  A S
                  CDR2------------------------------------------
                  76 77 78 79 80 81 82 83 84 85 86 87
                  G G S T Y Y A D S V K G
    2914 ggt ggc agt act tac tat gct gac tcc gtt aaa ggt
                FR3----------
                  88 89 90
                  R F T
    2950 cgc ttc act
                FR3--------------------------------------------------------
                  91 92 93 94 95 96 97 98 99 100 101 102 103 104 105
                  I S R D N S K N T L Y L Q M N
    2959 atc Tct aga gac aac tct aag aat act ctc tac ttg cag atg aac
                        XbaI...
                FR3---------------------------------------------------- CDR3--
                106 107 108 109 110 111 112 113 114 115 116 117 118 119 120
                  S L R A E D T A V Y Y C A K D
    3004 agC tta agg gct gag gac aCT GCA gtc tac tat tgc gct aaa gat
                    AflII... PstI....
          CDR3--------------------------------------
                121 122 123 124 125 126 127 128 129 130
                  •  E G •  G Y A F D I
    3049 TAG gaa ggt TAG ggt tat gct ttc gat ata
                  Y T Jstump.........
                FR4------------------
                131 132 133 134 135 136 137 138 139 140 141
                  W G Q G T M V T V S S
    3079 tgg ggt caa ggt act atG gtc acc gtc tct agt!g
                                                            BstEII...
                                                                            BsmBI..........
                                                                            C GTC TCN nnn n (SEQ ID NO: 1064)
                CH1--------------------------------
                142 143 144 145 146 147 148 149 150
                  A S T K G P S V F
    3112 gcc tcc acc aaa ggt cca tcg gtc ttc
                CH1--------------------------------------------------------
                151 152 153 154 155 156 157 158 159 160 161 162 163 164 165
                  P L A P S S K S T S G G T A A
    3139 ccG cta gca ccc tcc tcc aag agc acc tct ggg ggc aca gcg gcc
                    NheI....
                CH1--------------------------------------------------------
                166 167 168 169 170 171 172 173 174 175 176 177 178 179 180
                  L G C L V K D Y F P E P V T V
    3184 ctg ggc tgc ctg gtc aag gac tac ttc ccc gaa ccg gtg acg gtg
                CH1--------------------------------------------------------
                181 182 183 184 185 186 187 188 189 190 191 192 193 194 195
                  S W N S G A L T S G V H T F P
    3229 tcg tgg aac tca ggt gct ctg acc agc ggc gtc cac acc ttc ccg
                CH1--------------------------------------------------------
                196 197 198 199 200 201 202 203 204 205 206 207 208 209 210
                  A V L Q S S G L Y S L act ccS V V
    3274 gct gtc cta cag tct agc gga ctc tac tcc ctc agc agc gta gtg
                CH1--------------------------------------------------------
                211 212 213 214 215 216 217 218 219 220 221 222 223 224 225
                  T V P S S S L G T Q T Y I C N
    3319 acc gtg ccc tct tct agc ttg ggc acc cag acc tac atc tgc aac
                CH1--------------------------------------------------------
                226 227 228 229 230 231 232 233 234 235 236 237 238 239 240
                  V N H K P S N T K V D K K V E
    3364 gtg aat cac aag ccc agc aac acc aag gtg gac aag aaa gtt gag
                CH1------------
                241 242 243 244
                  P K S C
    3409 ccc aaa tct tgt
                                        His tag Myc Tag
                245 246 247 248 249 250 251 252 253 254 255
                  A G P H H H H H H G A
    3421 gct GGG CCc cat cat cat cac cat cac ggg gcc
                        ApaI...
                256 257 258 259 260 261 262 263 264 265 266 267 268 269 270
                  A E Q K L I S E E D L N G A A
    3454 gca gaa caa aaa ctc atc tca gaa gag gat ctg aat ggg gcc gca
                271 272 273 274 275 276 277 278 279
                  E A S S A S N A S
    3499 gag gct agt tct gct agt aAc gcg tct
                  80 83 86 89 92 95 98 01 04
                                                                  MluI....(1/2)
                Domain 3 of M13 III----
                280 281 282 283 284 285
                S G D F D Y
    3526 tcc ggt gat ttt gat tat
                286 287 288 289 290 291 292 293 294 295 296 297 298 299 300
                  E K M A N A N K G A M T E N A
    3544 gaa aag atg gca aac gct aat aag ggg gct atg acc gaa aat gcc
                301 302 303 304 305 306 307 308 309 310 311 312 313 314 315
                  D E N A L Q S D A K G K L D S
    3589 gat gaa aac gcg cta cag tct gac gct aaa ggc aaa ctt gat tct
                316 317 318 319 320 321 322 323 324 325 326 327 328 329 330
                  V A T D Y G A A I D G F I G D
    3634 gtc gct act gat tac ggt gct gct ATc gat ggt ttc att ggt gac
                                                                                BspDI..
                331 332 333 334 335 336 337 338 339 340 341 342 343 344 345
                  V S G L A N G N G A T G D F A
    3679 gtt tcc ggc ctt gct aat ggt aat ggt gct act ggt gat ttt gct
                346 347 348 349 350 351 352 353 354 355 356 357 358 359 360
                  G S N S Q M A Q V G D G D N S
    3724 ggc tct aat tcc caa atg gct caa gtc ggt gac ggt gat aat tca
                361 362 363 364 365 366 367 368 369 370 371 372 373 374 375
                  P L M N N F R Q Y L P S L P Q
    3769 cct tta atg aat aat ttc cgt caa tat tta cct tcc ctc cct caa
                376 377 378 379 380 381 382 383 384 385 386 387 388 389 390
                  S V E C R P F V F G A G K P Y
    3814 tcg gtt gaa tgt cgc cct ttt gtc ttt ggc gct ggt aaa cCA tat
                                                                                                                          NdeI.......
                                                                                                                        Transmembrane
                                                                                                                        segment---->
                391 392 393 394 395 396 397 398 399 400 401 402 403 404 405
                  E F S I D C D K I N L F R G V
    3859 gaa ttt tct att gat tgt gac aaa ata aac tta ttc cgt ggt gtc
    NdeI...
                406 407 408 409 410 411 412 413 414 415 416 417 418 419 420
                  F A F L L Y V A T F M Y V F S
    3904 ttt gcg ttt ctt tta tat gtt gcc acc ttt atg tat gta ttt tct
                421 422 423 424 425 426 427 428 429 430 431 432
                  T F A N I L R N K E S •
    3949 acg ttt get aac ata ctg cgt aat aag gag tct taa
    3985 tga aAC GCG Tga tga
    4000 GATatc
                          EcoRV.
    4006 actg gccgtcgttt
    4020 tacaacgtcg tgactgggaa aaccctggcg ttacccaact taatcgcctt gcagcacatc
    4080 cccctttcgc CAGctggcgt aatagcgaag aggcccgcac cgatcgccct tcccaacagt
                                    PvuII.
    4140 tgcgcagcct gaatggcgaa tGgcgcctga tgcggtattt tctccttacg catctgtgcg
                                                            KasI..
    4200 gtatttcaca ccgcatacgt caaagcaacc atagt
    4235 Gtgcac
              ApaLI.
                                                                                          Start phage ori
    4241 acgcg ccctgtagcg gcgcattaag
    4266 cgcggcgggt gtggtggtta cgcgcagcgt gaccgctaca cttgccagcg ccttagcgcc
    4326 cgctcctttc gctttcttcc cttcctttct cgccacgttc gccggctttc cccgtcaagc
    4386 tctaaatcgg gggctccctt tagggttccg atttagtgct ttacggcacc tcgaccccaa
    4446 aaaacttgat ttgggtgatg gttCACGTAg tgggccatcg ccctgataga cggtttttcg
                                                                DraIII....
    4506 ccctttgacg ttggagtcca cgttctttaa tagtggactc ttgttccaaa ctggaacaac
    4566 actcaactct atctcgggct attcttttga tTTAtaaggg attttgccga tttcgg
                                                                                  PsiI..
¹BspEI requires only a 10-fold over digestions, which is good. Is only active in NEB 3 buffer, which means it is likely sensitive. Blocked by dam methylation, which is not an issue here. Available at 10 Ku/mL.
```

TABLE 3611
pMID55F not annotated (SEQ ID NO: 1161)

pMID55F 4621 2010.07.27
ORIGIN

| | |
|---|---|
| 1 | GGTACCGATT ACGATCGGCC GGCACTTTTC GGGGAAATGT GCGCGGAACC CCTATTTGTT |
| 61 | TATTTTTCTA AATACATTCA AATATGTATC CGCTCATGAG ACAATAACCC TGATAAATGC |
| 121 | TTCAATAATA TTGAAAAAGG AAGAGTATGA GTATTCAACA TTTCCGTGTC GCCCTTATTC |
| 181 | CCTTTTTTGC GGCATTTTGC CTTCCTGTTT TTGCTCACCC AGAAACCTTG GTGAAAGTAA |
| 241 | AAGATGCTGA AGATCAGTTG GGTGCCCGAG TGGGTTACAT CGAACTAGAT CTCAACAGCG |
| 301 | GTAAGATCCT TGAGAGTTTT AGGCCTGAAG AACGTTTTCC AATGATGAGC ACTTTTAAAG |
| 361 | TTCTGCTATG TGGCGCGGTG CTGAGCCGTA TTGACGCTGG CCAAGAGCAA CTCGGTCGCC |
| 421 | GGATCCACTA TTCTCAGAAT GACCTGGTTG AGTACTCACC AGTCACAGAA AAGCATCTTA |
| 481 | CGGATGGCAT GACCGTACGA GAATTATGCA GTGCTGCCAT AACCATGAGT GATAACACTG |
| 541 | CGGCCAACTT ACTGTTAACA ACGATCGGAG GACCTAAGGA GCTAACCGCT TTTTTGCACA |
| 601 | ACATGGGGGA TCACGTGACT CGCCTTGATC GTTGGGAACC GGAGCTGAAT GAAGCCATAC |
| 661 | CAAACGACGA GCGTGACACC ACGATGCCTG TAGCAATGGC AACAACGTTG CGCAAACTAT |
| 721 | TAACTGGCGA ACTACTTACT CTAGCTTCCC GGCAACAATT AATAGACTGG ATGGAGGCGG |
| 781 | ATAAAGTGGC CGGCCCACTT CTTCGAAGTG CCCTTCCGGC TGGCTGGTTT ATTGCTGATA |
| 841 | AATCTGGAGC CGGTGAGCGT GGGTCTCGCG GTATCATTGC AGCACTCGGA CCGGATGGTA |
| 901 | AGCCCTCCCG TATCGTAGTT ATCTACACGA CGGGGAGTCA GGCAACTATG GATGAACGAA |
| 961 | ATAGACAGAT CGCTGAGATA GGTGCCTCAT TAATTAAGCA TTGGTAATGA CGGCCGATGG |
| 1021 | TCATCCACGT CCTGTCAGAC CAAGTTTACT CATATATACT TTAGATTGAT TTAAAACTTC |
| 1081 | ATTTTTAATT TAAAAGGATC TAGGTGAAGA TCCTTTTTGA TAATCTCATG ACCAAAATCC |
| 1141 | CTTAACGTGA GTTTTCGTTC CACTGAGCGT CAGACCCCGT AGAAAAGATC AAAGGATCTT |
| 1201 | CTTGAGATCC TTTTTTTCTG CGCGTAATCT GCTGCTTGCA AACAAAAAAA CCACCGCTAC |
| 1261 | CAGCGGTGGT TTGTTTGCCG GATCAAGAGC TACCAACTCT TTTTCCGAAG GTAACTGGCT |
| 1321 | TCAGCAGAGC GCAGATACCA AATACTGTTC TTCTAGTGTA GCCGTAGTTA GGCCACCACT |
| 1381 | TCAAGAACTC TGTAGCACCG CCTACATACC TCGCTCTGCT AATCCTGTTA CCAGTGGCTG |
| 1441 | CTGCCAGTGG CGATAAGTCG TGTCTTACCG GGTTGGACTC AAGACGATAG TTACCGGATA |
| 1501 | AGGCGCAGCG GTCGGGCTGA ACGGGGGGTT CGTGCATACA GCCCAGCTTG GAGCGAACGA |
| 1561 | CCTACACCGA ACTGAGATAC CTACAGCGTG AGCTATGAGA AAGCGCCACG CTTCCCGAAG |
| 1621 | GGAGAAAGGC GGACAGGTAT CCGGTAAGCG GCAGGGTCGG AACAGGAGAG CGCACGAGGG |
| 1681 | AGCTTCCAGG GGGAAACGCC TGGTATCTTT ATAGTCCTGT CGGGTTTCGC CACCTCTGAC |
| 1741 | TTGAGCGTCG ATTTTTGTGA TGCTCGTCAG GGGGGCGGAG CCTATGGAAA GAGCTCCTCA |
| 1801 | CTCATTAGGC ACCCCAGGCT TTACACTTTA TGCTTCCGGC TCGTATGTTG TGTGGAATTG |
| 1861 | TGAGCGGATA ACAATTTCAC ACAGGAAACA GCTATGACCA TGATTACGCC AAGCTTTGGA |
| 1921 | GCCTTTTTTT TGGAGATTTT CAACATGAAG AAACTGCTGT CTGCTATCCC ACTAGTTGTC |
| 1981 | CCTTTCTATT CTCATAGTGA AATTGTGTTG ACGCAGTCCC CGGGGACCCT GTCTTTGTCT |
| 2041 | CCAGGGGAAA GAGCCACGCT GAGCTGCTAG GCATAGCAGA GTGTTAGCAG CAGCTACTTA |
| 2101 | GCCTGGTATC AGCAGAAACC GGGTCAGGCT CCGCGGCTCC TCATCTATGG TGCATAAAGC |
| 2161 | TAGGCCACTG GCATCCCAGA CAGGTTCAGT GGCAGTGGGT CTGGGACAGA CTTCACTCTC |
| 2221 | ACCATCAGCA GACTCGAGCC TGAAGATTTT GCAGTGTATT ACTGTCAGCA GTAGGGTAGC |
| 2281 | TAACCTCTCA CTTTCGGCGG AGGCACTAAG GTGGAGATCA AACGTGGAAC TGTGGCTGCA |
| 2341 | CCATCTGTCT TCATCTTCCC GCCATCTGAT GAGCAGTTGA AATCTGGAAC TGCCTCTGTT |
| 2401 | GTGTGCCTGC TGAATAACTT CTATCCCAGA GAGGCCAAAG TACAGTGGAA GGTGGATAAC |
| 2461 | GCCCTCCAAT CGGGGAATTC CCAGGAGAGT GTCACAGAGC AGGACAGCAA GGACAGCACC |
| 2521 | TACAGCCTCA GCAGCACCCT GACTCTGTCC AAAGCAGACT ACGAGAAACA CAAAGTCTAC |
| 2581 | GCCTGCGAAG TCACCCATCA GGGCCTGAGT TCACCGGTGA CAAAGAGCTT CAACAGGGGA |
| 2641 | GAGTGTTAAT AAGGCGCGCC TAACCATCTA TTTCAAGGAA CAGTCTTAAT GAAGAAACTG |
| 2701 | CTCTTTGCTA TCCCGCTCGT CGTTCCTTTT GTGGCCCAGC CGGCCATGGC CGAAGTTCAA |
| 2761 | TTGTTAGAGT CTGGTGGCGG TCTTGTTCAG CCTGGTGGTT CTTTACGTCT TTCTTGCGCT |
| 2821 | GCTTCCGGAT TCACTTTCTC TTCGTAGGCT TAATCTTGGG TTCGCCAAGC TCCTGGTAAA |
| 2881 | GGTTTGGAGT GGGTTTCTTG AATCTAAGGT TCTGGTGGCA GTACTTACTA TGCTGACTCC |
| 2941 | GTTAAAGGTC GCTTCACTAT CTCTAGAGAC AACTCTAAGA ATACTCTCTA CTTGCAGATG |
| 3001 | AACAGCTTAA GGGCTGAGGA CACTGCAGTC TACTATTGCG CTAAAGATTA GGAAGGTTAG |
| 3061 | GGTTATGCTT TCGATATATG GGGTCAAGGT ACTATGGTCA CCGTCTCTAG TGCCTCCACC |
| 3121 | AAAGGTCCAT CGGTCTTCCC GCTAGCACCC TCCTCCAAGA GCACCTCTGG GGGCACAGCG |
| 3181 | GCCCTGGGCT GCCTGGTCAA GGACTACTTC CCCGAACCGG TGACGGTGTC GTGGAACTCA |
| 3241 | GGTGCTCTGA CCAGCGGCGT CCACACCTTC CCGGCTGTCC TACAGTCTAG CGGACTCTAC |
| 3301 | TCCCTCAGCA GCGTAGTGAC CGTGCCCTCT TCTAGCTTGG GCACCCAGAC CTACATCTGC |
| 3361 | AACGTGAATC ACAAGCCCAG CAACACCAAG GTGGACAAGA AAGTTGAGCC CAAATCTTGT |
| 3421 | GCTGGGCCCC ATCATCATCA CCATCACGGG GCCGCAGAAC AAAAACTCAT CTCAGAAGAG |
| 3481 | GATCTGAATG GGGCCGCAGA GGCTAGTTCT GCTAGTAACG CGTCTTCCGG TGATTTTGAT |
| 3541 | TATGAAAAGA TGGCAAACGC TAATAAGGGG GCTATGACCG AAAATGCCGA TGAAAACGCG |
| 3601 | CTACAGTCTG ACGCTAAAGG CAAACTTGAT TCTGTCGCTA CTGATTACGG TGCTGCTATC |
| 3661 | GATGGTTTCA TTGGTGACGT TTCCGGCCTT GCTAATGGTA ATGGTGCTAC TGGTGATTTT |
| 3721 | GCTGGCTCTA ATTCCCAAAT GGCTCAAGTC GGTGACGGTG ATAATTCACC TTTAATGAAT |
| 3781 | AATTTCCGTC AATATTTACC TTCCCTCCCT CAATCGGTTG AATGTCGCCC TTTTGTCTTT |
| 3841 | GGCGCTGGTA AACCATATGA ATTTTCTATT GATTGTGACA AAATAAACTT ATTCCGTGGT |
| 3901 | GTCTTTGCGT TTCTTTTATA TGTTGCCACC TTTATGTATG TATTTTCTAC GTTTGCTAAC |
| 3961 | ATACTGCGTA ATAAGGAGTC TTAATGAAAC GCGTGATGAG ATATCACTGG CCGTCGTTTT |
| 4021 | ACAACGTCGT GACTGGGAAA ACCCTGGCGT TACCCAACTT AATCGCCTTG CAGCACATCC |
| 4081 | CCCTTTCGCC AGCTGGCGTA ATAGCGAAGA GGCCCGCACC GATCGCCCTT CCCAACAGTT |
| 4141 | GCGCAGCCTG AATGGCGAAT GGCGCCTGAT GCGGTATTTT CTCCTTACGC ATCTGTGCGG |
| 4201 | TATTTCACAC CGCATACGTC AAAGCAACCA TAGTGTGCAC ACGCGCCCTG TAGCGGCGCA |
| 4261 | TTAAGCGCGG CGGGTGTGGT GGTTACGCGC AGCGTGACCG CTACACTTGC CAGCGCCTTA |
| 4321 | GCGCCCGCTC CTTTCGCTTT CTTCCCTTCC TTTCTCGCCA CGTTCGCCGG CTTTCCCCGT |
| 4381 | CAAGCTCTAA ATCGGGGGCT CCCTTTAGGG TTCCGATTTA GTGCTTTACG GCACCTCGAC |
| 4441 | CCCAAAAAAC TTGATTTGGG TGATGGTTCA CGTAGTGGGC CATCGCCCTG ATAGACGGTT |
| 4501 | TTTCGCCCTT TGACGTTGGA GTCCACGTTC TTTAATAGTG GACTCTTGTT CCAAACTGGA |
| 4561 | ACAACACTCA ACTCTATCTC GGGCTATTCT TTTGATTTAT AAGGGATTTT GCCGATTTCG |
| 4621 | G |

### Example 10

### A Library of HC CDR3s Having Lengths from 4 to 12 and No D Segments

This example will use Table 3021, Table 3010 adjusted to have high Gly. For length 12, the members will have the AA types distribution shown in Table 3021. For length 11, the first eight positions are as tabulated in Table 3021A, B. The ninth position has a distribution that is the average of the tabulated 9^{th} and 10^{th} position: A: 0.0364, D: 0.0215, F: 0.5281, G: 0.1400, L: 0.0327, P: 0.0600, R: 0.0737, S: 0.0116, T: 0.0323, V: 0.0327, W: 0.0195, Y: 0.0115. Positions 10 and 11 have the distribution tabulated as “11” and “12”. In this example, the positions of HC CDR3 are numbered 1 to 12. These correspond to the positions 95, 96, . . . 102d.

For length 10, Positions 1-7 are as tabulated in Table 3021A, B. Position 8 is the average of tabulated positions 8 and 10: A: 0.0403, D: 0.0184, F: 0.5167, G: 0.1400, L: 0.04413, P: 0.05371, R: 0.0757, S: 0.0115, T: 0.0332, V: 0.0277, W: 0.0272, Y: 0.012. Position 9 is the average of tabulated positions 9 and 11: A: 0.0364, D: 0.5215, F: 0.0281, G: 0.140, L: 0.0327, P: 0.0600, R: 0.0737, S: 0.0115, T: 0.0323, V: 0.0327, W: 0.0195, Y: 0.0115. Position 10 is as tabulated under position “12”.

For length 9, positions 1-6 are as tabulated in Table 3021. Position 7 is the average of tabulated positions 7 and 10, viz. A: 0.0455, D: 0.0196, F: 0.50, G: 0.140, L: 0.0432, P: 0.0548, R: 0.0853, S: 0.0115, T: 0.0382, V: 0.0215, W: 0.0288, Y: 0.0115. Positions 8 and 9 are as tabulated under positions “11” and “12”.

For length 8, positions 1-5 as tabulated are kept. Positions 6-8 are as shown in Table 3620.

For length 7, positions 1-4 are as tabulated in Table 3021. Positions 5-7 are as shown in Table 3621 in which the averaged tabulated positions 5 & 10, 6 & 11, and 7 & 12. of Table 3021 are used.

For length 6, positions 1-3 are as tabulated in Table 3021. Positions 4-6 are as shown in Table 3622 in which the averaged tabulated positions 4 & 10, 5 & 11, and 6 & 12 are used.

For length 5, positions 1-5 are as tabulated in Table 3021A, B.

For length 4, positions 1-3 are as tabulated in Table 3021A and position 4 is as tabulated under position “12” in Table 3021B, i.e. tabulated positions 4-11 are omitted.

The proportions of the differing lengths could be varied according to the target. For example, peptides, small proteins, carbohydrates, and glycoproteins may give better binders from libraries when the shorter lengths are more common. Large proteins may give better binders when the longer members are more common. One embodiment of the present invention has the length components in the ratios: L4:L5:L6:L7:L8:L9:L10:L11:L12::1:1:1:1:1:1:1:1:1. One embodiment of the present invention has the length components in the ratios: L4:L5:L6:L7:L8:L9:L10:L11:L12::3:3:2:2:2:1:1:1:1. One embodiment of the present invention has the length components in the ratios: L4:L5:L6:L7:L8:L9:L10:L11:L12::1:1:1:1:2:2:2:3:3. For each length, for example, 2.E6 members are obtained and 1.8E7 HC CDR3 in total. This diversity is combined with a library of HC CDER½ diversity of, for example, 2.E7 to make, for example, 1.E9 HCs.

The diversity of HC CDR3 is combined with the HC CDR1/CDR2 diversity shown in Example 4.1 and Example 4.2 or in Example 4.3. The LC diversity is shown in Example 5, Example 9, or Example 15. A preferred vector is pMID55F and the method of construction is given in Example 9.

TABLE 3620
Example 10, length 8

| | Act 6 | Act 7 | Act 8 |
|---|---|---|---|
| A | 0.05073 | 0.04555 | 0.04034 |
| D | 0.02101 | 0.51965 | 0.01839 |
| F | 0.5 | 0 | 0.0167 |
| G | 0.14004 | 0.14005 | 0.14003 |
| L | 0.04792 | 0.04319 | 0.04413 |
| P | 0.04781 | 0.05478 | 0.05371 |
| R | 0.06779 | 0.08527 | 0.07566 |
| S | 0.01152 | 0.01152 | 0.01152 |
| T | 0.04372 | 0.03818 | 0.03316 |
| V | 0.02482 | 0.02151 | 0.02768 |
| W | 0.03318 | 0.02881 | 0.0272 |
| Y | 0.0115 | 0.01151 | 0.5115 |

TABLE 3621
Example 10, length 7

| | 5&10 | 6&11 | 7&12 |
|---|---|---|---|
| | Act 5 | Act 6 | Act 7 |
| A | 0.04744 | 0.05073 | 0.04555 |
| D | 0.03237 | 0.52101 | 0.01965 |
| F | 0.5 | 0 | 0 |
| G | 0.14017 | 0.14004 | 0.14005 |
| L | 0.04514 | 0.04792 | 0.04319 |
| P | 0.03466 | 0.04781 | 0.05478 |
| R | 0.06896 | 0.06779 | 0.08527 |
| S | 0.01153 | 0.01152 | 0.01152 |
| T | 0.0376 | 0.04372 | 0.03818 |
| V | 0.03042 | 0.02482 | 0.02151 |
| W | 0.04018 | 0.03318 | 0.02881 |
| Y | 0.01155 | 0.0115 | 0.51151 |

TABLE 3622
Example 10, length 6

| | 4&10 | 5&11 | 6&12 |
|---|---|---|---|
| | Act 4 | Act 5 | Act 6 |
| A | 0.03893 | 0.04744 | 0.05073 |
| D | 0.02281 | 0.53237 | 0.02101 |
| F | 0.5 | 0 | 0 |
| G | 0.14008 | 0.14017 | 0.14004 |
| L | 0.04019 | 0.04514 | 0.04792 |
| N | 0.04751 | 0 | 0 |
| P | 0.03077 | 0.03466 | 0.04781 |
| R | 0.05686 | 0.06896 | 0.06779 |
| S | 0.01152 | 0.01153 | 0.01152 |
| T | 0.03446 | 0.0376 | 0.04372 |
| V | 0.03028 | 0.03042 | 0.02482 |
| W | 0.03509 | 0.04018 | 0.03318 |
| Y | 0.01152 | 0.01155 | 0.5115 |

### Example 11

### A Library of HC CDR3s Having Lengths from 5 to 11 and No D Segments

This example will use Table 3024, Table 3010 adjusted to have high Gly and Ser with low Tyr. For length 11, the first eight positions are as tabulated in Table 3024A, B. The ninth position has a distribution that is the average of the tabulated 9^{th} and 10^{th} position: A: 0.029, D: 0.017, F: 0.522, G: 0.1114, L: 0.026, P: 0.0478, R: 0.0586, S: 0.1114, T: 0.0257, V: 0.026, W: 0.0155, Y: 0.0091. Positions 10 and 11 have the distribution tabulated as “11” and “12”. In this example, the positions of HC CDR3 are numbered 1 to 11. These correspond to the positions 95, 96, . . . 102c.

For length 10, Positions 1-8 are as tabulated in Table 3024A, B. Position 9 is the average of tabulated positions 9 and 11: A: 0.029, D: 0.517, F: 0.0224, G: 0.11140, L: 0.026, P: 0.0477, R: 0.0586, S: 0.1113, T: 0.0257, V: 0.026, W: 0.0155, Y: 0.0091. Position 10 is as tabulated under position “12”.

For length 9, positions 1-6 are as tabulated in Table 3024. Position 7 is the average of tabulated positions 7 and 10, viz. A: 0.0362, D: 0.0156, F: 0.50, G: 0.11140, L: 0.03436, P: 0.0436, R: 0.0678, S: 0.1114, T: 0.0304, V: 0.0171, W: 0.0229, Y: 0.0091. Positions 8 and 9 are as tabulated under positions “11” and “12”.

For length 8, positions 1-5 are kept as tabulated. Positions 6-8 are as shown in Table 3630.

For length 7, positions 1-4 are as tabulated in Table 3024. Positions 5-7 are as shown in Table 3631 in which the averaged tabulated positions 5 & 10, 6 & 11, and 7 & 12. of Table 3024 are used.

For length 6, positions 1-3 are as tabulated in Table 3024. Positions 4-6 are as shown in Table 3632 in which the averaged tabulated positions 4 & 10, 5 & 11, and 6 & 12.

For length 5, positions 1-5 are as tabulated in Table 3024A, B.

The proportions of the differing lengths could be varied according to the target. For example, peptides, small proteins, carbohydrates, and glycoproteins may give better binders from libraries when the shorter lengths are more common. Large proteins may give better binders when the longer members are more common. One embodiment of the present invention has the length components in the ratios: L5:L6:L7:L8:L9:L10:L11::1:1:1:1:1:1:1. One embodiment of the present invention has the length components in the ratios: L5:L6:L7:L8:L9:L10:L11::3:2:2:2:1:1:1. One embodiment of the present invention has the length components in the ratios: L5:L6:L7:L8:L9:L10:L11::1:1:1:2:2:2:3. For each length, for example, 2.E6 members can be obtained and 1.4E7 HC CDR3 in total. This diversity is combined with a library of HC CDER½ diversity of, for example, 2.E7 to make, for example, 1.E9 HCs.

The diversity of HC CDR3 is combined with the HC CDR1/CDR2 diversity shown in Example 4.1 and Example 4.2 or in Example 4.3. The LC diversity is shown in Example 5, Example 9, or Example 15. A preferred vector is pMID55F and the method of construction is given in Example 9.

TABLE 3630
Example 11 Length 8

| | 6&10 | 7&11 | 8&12 |
|---|---|---|---|
| AA type | Act 6 | Act 7 | Act 8 |
| A | 0.0404 | 0.0362 | 0.0321 |
| D | 0.0167 | 0.5156 | 0.0146 |
| F | 0.5000 | 0.0000 | 0.0133 |
| G | 0.1114 | 0.1114 | 0.1114 |
| L | 0.0381 | 0.0344 | 0.0351 |
| P | 0.0380 | 0.0436 | 0.0427 |
| R | 0.0539 | 0.0678 | 0.0602 |
| S | 0.1114 | 0.1114 | 0.1114 |
| T | 0.0348 | 0.0304 | 0.0264 |
| V | 0.0197 | 0.0171 | 0.0220 |
| W | 0.0264 | 0.0229 | 0.0216 |
| Y | 0.0092 | 0.0092 | 0.5092 |

TABLE 3631
Example 11, Length 7

| | 5&10 | 6&11 | 7&12 |
|---|---|---|---|
| AA type | Act 5 | Act 6 | Act 7 |
| A | 0.0377 | 0.0404 | 0.0362 |
| D | 0.0258 | 0.5167 | 0.0156 |
| F | 0.5000 | 0.0000 | 0.0000 |
| G | 0.1115 | 0.1114 | 0.1114 |
| L | 0.0359 | 0.0381 | 0.0344 |
| P | 0.0276 | 0.0380 | 0.0436 |
| R | 0.0549 | 0.0539 | 0.0678 |
| S | 0.1114 | 0.1114 | 0.1114 |
| T | 0.0299 | 0.0348 | 0.0304 |
| V | 0.0242 | 0.0197 | 0.0171 |
| W | 0.0320 | 0.0264 | 0.0229 |
| Y | 0.0092 | 0.0092 | 0.5092 |

TABLE 3632
Example11, Length 6

| AA | 4&10 | 5&11 | 6&12 |
|---|---|---|---|
| type | Act 4 | Act 5 | Act 6 |
| A | 0.03097 | 0.037735 | 0.040355 |
| D | 0.018145 | 0.52575 | 0.01671 |
| F | 0.5 | 0 | 0 |
| G | 0.11144 | 0.11151 | 0.11141 |
| L | 0.03197 | 0.03591 | 0.03812 |
| N | 0.037795 | 0 | 0 |
| P | 0.02448 | 0.027575 | 0.03803 |
| R | 0.045235 | 0.05486 | 0.053925 |
| S | 0.111385 | 0.11139 | 0.111385 |
| T | 0.02741 | 0.029915 | 0.034775 |
| V | 0.024085 | 0.0242 | 0.019745 |
| W | 0.02791 | 0.031965 | 0.02639 |
| Y | 0.009165 | 0.00919 | 0.50915 |

### Example 12

### Alternative HC CDR3 Libraries

We can use the proportions shown in Table 3010, 3020, 3021, 3022, 3023, 3024, 3025, 3026, or 3027 in various ways. For example, in a library built according to Table 3023 and Table 3100. Table 3100 tells us which column to use in one of the source Tables 3010, 3020-3027. First one picks a length from the column labeled “Length”. Then one picks a position in the row to the right of “Length”. The entry in Table 3100 tells which column to use in the source table.

Assume Table 3023 is the source table. For members with length 8, the proportions for position 1 would come from Table 3023 position 1. For position 2, the proportions would come from the column “position 2”. The same process is used for positions 3, 4, and 5. As shown in Table 3100, the proportions for positions 6-8 (the final three positions) would come from “position 10”, “position 11”, and “position 12” of table 3023. For the members with length 9, positions 1-5 are as for the members with length 8. Position 6 is a repeat of position 5. For length 10, we repeat the proportions of position 5 of Table 3023 three times. For length 11, we repeat the proportions of position 5 of Table 3023 four times. For length 12, we repeat the proportions of position 5 of Table 3023 five times. Repeating the composition at several positions, reduces the number of mixtures needed. Most of the positional variation in HC CDR3 that lack D segments occurs in the first four or five positions.

The diversity of HC CDR3 is combined with the HC CDR1/CDR2 diversity shown in Example 4.1 and Example 4.2 or in Example 4.3. The LC diversity shown in Example 5, Example 9, or Example 15. A preferred vector is pMID55F and the method of construction is given in Example 9.

TABLE 3100
Alternative for examples 8, 10, 11, & 13

| | Position in HC CDR3 | | | | | | | | | | | |
|---|---|---|---|---|---|---|---|---|---|---|---|---|
| Length | 1 | 2 | 3 | 4 | 5 | 6 | 7 | 8 | 9 | 10 | 11 | 12 |
| 4 | 1 | 2 | 3 | 4 | | | | | | | | |
| 5 | 1 | 2 | 3 | 4 | 12 | | | | | | | |
| 6 | 1 | 2 | 3 | 4 | 11 | 12 | | | | | | |
| 7 | 1 | 2 | 3 | 4 | 5 | 11 | 12 | | | | | |
| 8 | 1 | 2 | 3 | 4 | 5 | 10 | 11 | 12 | | | | |
| 9 | 1 | 2 | 3 | 4 | 5 | 5 | 10 | 11 | 12 | | | |
| 10 | 1 | 2 | 3 | 4 | 5 | 5 | 5 | 10 | 11 | 12 | | |
| 11 | 1 | 2 | 3 | 4 | 5 | 5 | 5 | 5 | 10 | 11 | 12 | |
| 12 | 1 | 2 | 3 | 4 | 5 | 5 | 5 | 5 | 5 | 10 | 11 | 12 |

### Example 13

### Library of HC CDR3 with Lengths from 4 to 12

Table 3028A and Table 3028B show proportions derived from Table 3010 by increasing the proportion of Ser and Gly and by reducing the proportion of Tyr. For length 12, the proportions are as found in Table 3028A and 3028B. For length 11, the first eight positions are as tabulated in Table 3028A, B. Positions 9, 10, and 11 are as recorded in Table 3028A, B under positions 10, 11, and 12. That is, the column labeled “9” is omitted. In this example, the positions of HC CDR3 are numbered 1 to 12. These correspond to the positions 95, 96, . . . 102d in the full HC.

For length 10, Positions 1-7 are as tabulated in Table 3028A, B. Positions 8-10 are as shown for positions 10-12 in Table 3028A, B. That is, columns 8 and 9 are omitted.

For length 9, columns 7, 8, and 9 in Table 3028A, B are omitted.

For length 8, columns 6, 7, 8, and 9 in Table 3028A, B are omitted.

For length 7, columns 5, 6, 7, 8, and 9 in Table 3028A, B are omitted.

For length 6, columns 5, 6, 7, 8, 9, and 10 in Table 3028A, B are omitted.

For length 5, columns 4, 5, 6, 7, 8, 9, and 10 in Table 3028A, B are omitted.

For length 4, columns 5-12 in Table 3028A, B are omitted.

The proportions of the differing lengths could be varied according to the target. For example, peptides, small proteins, carbohydrates, and glycoproteins may give better binders from libraries when the shorter lengths are more common. Large proteins may give better binders when the longer members are more common. One embodiment of the present invention has the length components in the ratios: L4:L5:L6:L7:L8:L9:L10:L11:L12::1:1:1:1:1:1:1:1:1. One embodiment of the present invention has the length components in the ratios: L4:L5:L6:L7:L8:L9:L10:L11:L12::3:3:2:2:2:1:1:1:1. One embodiment of the present invention has the length components in the ratios: L4:L5:L6:L7:L8:L9:L10:L11:L12::1:1:1:1:2:2:2:3:3. For each length, for example, 2.E6 members are obtained and 1.8E7 HC CDR3 in total. This diversity is combined with a library of HC CDER½ diversity of, for example, 2.E7 to make, for example, 1.E9 HCs.

The diversity of HC CDR3 is combined with the HC CDR1/CDR2 diversity shown in Example 4.1 and Example 4.2 or in Example 4.3. The LC diversity is shown in Example 5, Example 9, or Example 15. A preferred vector is pMID55F and the method of construction is given in Example 9.

### Example 14

### HC CDR1 and CDR2

Table 54 shows a diversity that allows 5,508 sequences in HC CDR1. At position 31, Ser is the germline (GL) amino-acid type. Hence we make Ser, for example, four times more likely than each of the other AATs. Since 18 types are allowed, Ser will be allowed ˜19% (4/21) of the time and each of the others are allowed at ˜4.7%. (C and M are excluded.) Thus, if there is no selection for the AA type at position 31, an antibody with Ser is most likely to be isolated. Similarly, at 33 the GL AA type is Ala and Ala is made, for example, 4 times as likely (20%) as all the others (5%) (C, N, and M are excluded. N is excluded because 35 is biased toward S and N—X—(S/T).) is avoided. At 35 Ser is the GL AA type and it is made, for example, four times as likely as the others. At all three positions, Cys and Met have been excluded. Cys is excluded because to avoid gratuitous disulfides or exposed unpaired cysteines that could adversely affect the solubility and reactivity of the antibody. Met is excluded because exposed methionines side groups are subject to oxidation which can alter binding properties and shelf life.

In CDR2, diversity is allowed at positions 50, 52, 52a, 56, and 58 (as shown in Table 55). At 50, 52, 56, and 58, all amino-acid types except Cys and Met are allowed and the GL AA types are made more likely by four fold.

Combined CDR1 and CDR2 diversity shown in Table 54 and Table 55 is 2.19E9.

### Example 15

### A Preferred Form of Variegation for HC CDR1 and CDR2

A preferred form of variegation for HC CDR1 and CDR2 is shown in Table 191 (context is given in Table 190). These variegations are based in part on examination of antibodies from a variety of sources. In this embodiment, position 31 is allowed to be only SADGQRY. At positions 33, all AATs except Cys, Glu, Asn, and Met are allowed. At position 35, all AATs except Cys and Met are allowed. Cys is excluded to prevent unwanted extraneous disulfide or exposed unpaired cysteins (both are undesirable). Met is excluded to prevent methonine from being selected. Asn is excluded at 33 because 35 is biased toward Ser and the occurrence of N—X—(S/T) sequences should be minimized. Having Met in the combining site would make the antibody prone to poor shelf life. Oxidation of a Met in the combining site is very likely to change the binding properties of the Ab. Positions 31, 33, and 35 are picked for variegation because the side groups of these amino acids point toward the antibody combining site. A methionine in such a position is likely to greatly alter the binding properties if it is oxidized.

Gly and Phe are allowed at position 54, with Gly at, for example, six times the frequency of Phe. This allows the antibody to resemble 1-69 in CDR2; 1-69 is often selected as a binder to viral targets. In Table 191, N is removed from positions 33, 52, 53, and 56. Q is allowed at 53. The diversity allowed is 2016(CDR1), 4.66E+06(CDR2), and 9.40E+09(both).ets. In addition, Ile is added to the allowed AATs at position 53 because 1-69 has Ile at this position.

At each position, the GL AAT may be more frequent than each of the others by 2-, 3-, 4-, 5-, 6-, 7-, 8-, 9-, or 10-fold.

Because of the unique BstXI restriction site in FR2, CDR1 can be recombined with CDR2.

TABLE 191
Diversity in HC CDR1 and CDR2 (context is given
in Table 190)
The first allowed AAT is the GL AAT and is present
at, for example, four times each of the others.

| Position | Symbol | Allowed |
|---|---|---|
| 31 | <1> | SADGQRY |
| 33 | <2> | ASDFGHIKLPQRTVWY |
| | | (no C, E, M, N) |
| 35 | <3> | SADEFGHIKLNPQRTVWY |
| | | (no C or M) |
| | | 123456789012345678 |
| 50 | <4> | AYRWVGSE |
| 52 | <5> | SADEFGHIKLPQRTVWY |
| | | (no C, M, N) |
| 52a | <6> | GYWSPADRY |
| 53 | <7> | SDGAQRI |
| 55 | <8> | GS |
| 56 | <9> | SADEFGHIKLPQRTVWY |
| 58 | <A> | YRWVGSEA |
| 54 | <B> | GF |

The diversity allowed is 2016 (CDR1), 4.66E+06(CDR2), and 9.40E+09(both).

### Example 16

### A Library of LCs

There are 40 Vkappa germline genes. In the CDRs, these show the diversity shown in Table 3600. One embodiment of the invention involves a library in which the varied positions of the LC CDRs (CDR1: 27-28, 30-32; CDR2: 50, 53, 56, and CDR3: 91-96) are varied so that a) the germline residue of A27 is present at 50% (the first AAT in each of the “Allowed AATs” columns of Table 4601-4603 is the germline AAT), b) the ten most common AATs at each position are included, c) all the AATs that are seen at each position are included at equal frequency, and d) the fraction of members that have N—X—(S/T) is below 2%, 1%, 0.5%, 0.1% or N—X—(S/T) is not allowed. This means that some positions have more than 11 allowed AATs. Two positions are allowed to have no amino acid in a portion of the library, these are 30a and 93 as indicated by “*” in the “Allowed AATs” column of table 4601 and table 4603. That is, CDR1 can be either 11 or 12 in length and CDR3 can be either 8 or 9 in length. This gives a diversity of 2.94E+06 for CDR1, 1.85E+03 for CDR2, and, 3.17E+06 for CDR3. The overall allowed diversity is 1.72E+16. An actual library could have 1.E7, 3.E7, 1.E8, 3.E8, 1.E9, or 3.E9 actual members. These would be combined with a HC library that has 0.1, 0.3, 1., 3., or 10 times as many members to make a library of 1.E8, 3.E8, 1.E9, 3.E9, 1.E10, 3.E10, 1.E11, or 5. E11 members.

At position 27, N is allowed because V29 is fixed. At position 28, N is changed to Q because Ser is the GL AAT at 30 and is the most common AAT at this position. At 30 N is changed to Q because Ser is the GL AAT at 31 which affect those members that have an amino acid at 30a. At 30a, N has been eliminated because S is allowed at 32; Q is allowed at 30a. N is allowed at 31 because L33 is fixed.

At position 50 N is changed to Q because S51 is fixed. N is allowed at position 53 because A55 is fixed. N is allowed at 56 because residue 58 is neither S nor T.

At position 91, N is changed to Q because S is the GL AAT at 93.

The library will be built in the vector pMID55F as shown in Table 3610 and Table 3611. Vector pMID55F has been designed to make transfer of diversity into the vector efficient. Each CDR in the vector has two stop codons. First four libraries are built: HC CDR1-CDR2, HC CDR3, LC CDR1-CDR2, and LC CDR3. Each of these libraries will have 1.E6, 3.E6, 1.E7, or 3.E7 members. A library of HCs is built by transferring the CDR3 diversity as XbaI-ApaI fragments into the HC CDR1-CDR2 diversity. This HC library will have 1.E7, 3.E7, 1.E8, 3.E8, 1.E9, or 5.E9 members. XbaI and ApaI have opposite polarity, XbaI creates a 5′ overhang while ApaI gives a 3′ overhang.

A library of LCs is built by transferring the CDR1-CDR2 diversity as a SacI/XhoI fragment into the CDR3 diversity. SacI gives a 3′ overhang while XhoI gives a 5′ overhang. This LC library will have 1.E7, 3.E7, 1.E8, 3.E8, 1.E9, or 5.E9 members. The Fab library is built by transferring LCs as SacI/EcoRI fragments into the HC diversity. SacI gives a 3′ overhang while EcoRI gives a 5′ overhang. The final library will have 1.E8, 3.E8, 1.E9, 3.E9, 1.E10, 3.E10, 1.E11, or 5.E11 members. All of the restriction enzymes used in construction of the library are available at high concentration and cut to completion. Each pair of enzymes used has one that give a 5′ overhang while the other give a 3′ overhang.

TABLE 4601
LC CDR1 Diversity (low N-X-(S/T)) (SEQ ID NO: 1196)

| Position | Diversity | Cumulative | Allowed AATs |
|---|---|---|---|
| 24 | 1 | 1 | R |
| 25 | 1 | 1.00E+00 | A |
| 26 | 1 | 1.00E+00 | S |
| 27 | 11 | 1.10E+01 | QEADGHKLNPR |
| 28 | 11 | 1.21E+02 | SDGAFIQPRTY |
| 29 | 1 | 1.21E+02 | V |
| 30 | 13 | 1.57E+03 | SRLVDGAFIQPTY |
| 30a | 13 | 2.04E+04 | SQDYHAGIPRTY* |
| 31 | 11 | 2.25E+05 | SADGHIKNRTY |
| 32 | 12 | 2.70E+06 | YDWANSFHKLQR |
| 33 | 1 | 2.70E+06 | L |
| 34 | 1 | 2.94E+06 | A |

TABLE 4602
LC CDR2 Diversity (low N-X-(S/T)) (SEQ ID
NO: 1197)

| Position | Diversity | Cumulative | Allowed AATs |
|---|---|---|---|
| 50 | 14 | 14 | GADYTKELWHQRSV |
| 51 | 1 | 1.40E+01 | A |
| 52 | 1 | 1.40E+01 | S |
| 53 | 12 | 1.68E+02 | SNTYQDFGHIKR |
| 54 | 1 | 1.68E+02 | R |
| 55 | 1 | 1.68E+02 | A |
| 56 | 11 | 1.85E+03 | TPSADGHIKNR |

TABLE 4603
LC CDR3 diversity (low N-X-(S/T))

| Position | Diversity | Cumulative | Allowed AATs |
|---|---|---|---|
| 89 | 1 | 1 | Q |
| 90 | 1 | 1.00E+00 | Q |
| 91 | 11 | 1.10E+01 | YSHFALDRGQT |
| 92 | 13 | 1.43E+02 | GYDQITLSAEFRV |
| 93 | 14 | 2.00E+03 | SEHQKADGIRTVY* |
| 94 | 12 | 2.40E+04 | STLAYFWHGIPR |
| 95 | 12 | 2.88E+05 | PSHAFGKLQRTV |
| 96 | 11 | 3.17E+06 | LWYFIVRQPKG |
| 97 | 1 | 3.17E+06 | T |

| Biblioteca | HC CDR3 | page | comments |
|---|---|---|---|
| 1 | X₁-X₂-X₃-X₄-X₅-X₆-X₇-X₈-X₉-X₁₀- | 5, ¶0014 | no D, L = 12-15; 9-15 Jstump; |
| | X₁₁-X₁₂-X₁₃-X₁₄-X₁₅ | | X1-X8 VJfill |
| 2 | X₁-X₂-X₃-X₄-X₅-(X₆-(X₇- | 6, ¶0016 | no D, L = 8-11, 9-11 Jstump, |
| | (X₈)))-X₉-X₁₀-X₁₁ | | X1-X8 VJfill |
| 3 | (X₁-(X₂-(X₃-(X₄))))-X₅-X₆-X₇- | 6, ¶0018 | X1-x4 = 0-4 AAs of VDfill; |
| | X₈-X₉-X₁₀-X₁₁-X₁₂-X₁₃-X₁₄-X₁₅ | | X5-X7, 8, 9 . . . 3-11 AAs of a D |
| | X₁₆-X₁₇-X₁₈-X₁₉-X₂₀-X₂₁-X₂₂-X₂₃- | | seg; |
| | X₂₄-X₂₅-X₂₆-X₂₇-X₂₈ | | 0-4 AAs of DJfill; |
| | | | 0-9 AAs of Jstump; |
| | | | L = 3-28 |
| 4 | X₁-X₂-X₃-X₄-X₅-X₆-X₇-X₈-(((X₉-) | 8, ¶0025 & | no D; X1-X8 are VJ fill or |
| | X₁₀-)X₁₁-)X₁₂-X₁₃-X₁₄ | 144, ¶0500ff | missing; |
| | | | X9-X11 same distrib. as X8 |
| | | | or missing; |
| | | | X12-X14 Jstump |
| | | | L = 11-14 |
| 5 | X₁-X₂-X₃-X₄-X₅-X₆-X₇-X₈-X₉-X₁₀- | 10, ¶0047 | 0-4 of X1-X4 are VDfill; |
| | X₁₁-X₁₂-X₁₃-X₁₄-X₁₅-X₁₆-X₁₇ | | 2-8 of X5-X12 are a D seg; |
| | | | 0-2 of X13-X14 are DJfill; |
| | | | X15-X17 are Jstump; |
| | | | L = 5-17 |
| 6 | X₁-X₂-X₃-X₄-X₅-X₆-X₇-X₈-X₉-X₁₀- | 12, ¶0065 | 5-8 of X1-X8 are VJfill; |
| | X₁₁ | | X9-X11 fixed; |
| | | | L = 8-11 (no D) |
| | | | Essentially same as |
| | | | Biblioteca 2. |
| 7 | X₁-X₂-X₃-X₄-X₅-X₆-X₇-X₈-X₉-X₁₀- | 16, ¶0082 | 6-11 of X1-X11 are VJfill; |
| | X₁₁-X₁₂-X₁₃-X₁₄ | | X12-X14 fixed; |
| | | | L = 9-14 (no D) |
| 8 | X₁-X₂-X₃-X₄-X₅-X₆-X₇-X₈-X₉-X₁₀- | 19, ¶0105 | 7-11 of X1-X11 are VJfill; |
| | X₁₁-X₁₂-X₁₃-X₁₄ | | X12-X14 fixed; |
| | | | L = 10-14 (no D) |
| 9 | X₁-X₂-G₃-X₄-G₅-X₆-X₇-X₈-X₉-X₁₀- | 21, ¶0122 | X1-X2 VJfill; X3 = G; X4 |
| | X₁₁-X₁₂-X₁₃-X₁₄ | | VJfill; |
| | | | X5 = G; X6 VJfill; X7 = R/Δ; |
| | | | X8-X11 = VJfill/Δ,; X12-X14 |
| | | | fixed |
| | | | L = 9-14 (no D) |
| 10 | X₁-X₂-X₃-X₄-X₅-X₆-X₇-X₈-X₉-X₁₀- | 23, ¶0141 | 0-2 of X1-X2 VDfill; |
| | X₁₁-X₁₂-X₁₃-X₁₄-X₁₅-X₁₆ | | X3-X4 VD fill; X5-X7 = DSS; |
| | (SEQ ID NO: 1198) | | X8 30G:1ADPVLSRTYN |
| | | | X9 30Y:1PLSWHRFDGN |
| | | | X10 30Y:1SPLRFGWHDV |
| | | | X11 = G; |
| | | | 0-2 of X12-X13 DJfill; |
| | | | X14-X16 fixed |
| | | | L = 12-16 (D3-22.2) |
| 11 | X₁-X₂-X₃-X₄-X₅-X₆-X₇-X₈-X₉-X₁₀- | 24, ¶0159 | 0-4 of X1-X4 VDfill/G/Δ; |
| | X₁₁-X₁₂-X₁₃-X₁₄-X₁₅-X₁₆-X₁₇-X₁₈- | | X5-X12 = yDSSGYyy² (SEQ ID |
| | X₁₉ | | NO: 1241); |
| | (SEQ ID NO: 1199) | | X13 = DJfill; X14-X16 = G/Δ; |
| | | | X17-X19 = fDY |
| | | | L = 12-19 (D3-22.2) |
| 12 | (X₁-(X₂-))-X₃-X₄-X₅-X₆-X₇- | 26, ¶0179 | 0-2 of X1-X2 VDfill; |
| | (X₈-(X₉-))-X₁₀-X₁₁-X₁₂-X₁₃ | | X3-X7 dYGDy (SEQ ID NO: |
| | (SEQ ID NO: 1200) | | 1242); |
| | | | 0-2 of X8-X9 DJfill; |
| | | | X10-X13 = aFDY (SEQ ID NO: |
| | | | 1264) |
| | | | L = 9-13 (D4-17.2) |
| 13 | (X₁-(X₂-))-X₃-X₄-X₅-X₆-X₇-X₈- | 28, ¶0197 | 0-2 of X1-X2 VDfill; |
| | X₉-(X₁₀-)-X₁₁-X₁₂-X₁₃ | | X3-X9 = gySSsWy (SEQ ID NO: |
| | (SEQ ID NO: 1201) | | 1243); |
| | | | of X10 DJfill; X11-X13 |
| | | | fixed |
| | | | L = 10-13 (D6-13.1) |
| 14 | X₁-X₂-X₃-X₄-X₅-X₆-X₇-X₈-X₉-X₁₀- | 30, ¶0216 | 0-2 of X1-X2 VDfill |
| | X₁₁-X₁₂-X₁₃-X₁₄-X₁₅-X₁₆-X₁₇ | | 9-10 of X3-X12 gyCsggsCys |
| | (SEQ ID NO: 1202) | | (SEQ ID NO: 1244); |
| | | | 0-2 of X13-X14 DJfill; |
| | | | X15-X17 FDY fixed |
| | | | L = 12-17 (D2-15.2) |
| 15 | X₁-X₂-X₃-X₄-X₅-X₆-X₇-X₈-X₉-X₁₀- | 33, ¶0243 | no D; X1-X6 VJfill; |
| | X₁₁-X₁₂-X₁₃ | | X7-X10 VJfill/Δ; |
| | | | X11-X13 FDY fixed |
| | | | L = 9-13 |
| 16 | X₁-X₂-X₃-X₄-X₅-X₆-X₇-X₈-X₉-X₁₀- | 33, ¶0243 | 0-2 of X1-X2 VDfill; |
| | X₁₁-X₁₂-X₁₃-X₁₄-X₁₅-X₁₆ | | X3-X11 are a D segment; |
| | | | 0-2 of X12-X13 DJfill/Δ; |
| | | | X14-X16 FDY fixed; |
| | | | L = 12-16 |
| 17 | aeyfqh³ | 98, Table 21 | JH1(whole) wobbled⁴ |
| | (SEQ ID NO: 1203) | | 7:1:1:1; |
| | | | L = 6, No D |
| 18 | ydygdy | 98, Table 21 | Y::D4-17(2)::FR4 of JH1 |
| | (SEQ ID NO: 1204) | | wobbled 7:1:1:1; L = 6 |
| 19 | gysygy | 98, Table 21 | D5-5(3)::FR4 of JH1 wobbled |
| | (SEQ ID NO: 1205) | | 7:1:1:1; L = 6 |
| 20 | syyfdy | 98, Table 21 | no D; SY::JH4 whole; |
| | (SEQ ID NO: 1206) | | wobbled 7:1:1:1; L = 6 |
| 21 | yyaeyfqh | 98, Table 21 | YY⁵::JH1stump-whole; wobble |
| | (SEQ ID NO: 1207) | | 73:9:9:9 L = 8 |
| 22 | ygyssswy | 98, Table 21 | Y::D6-13(1)::FR4 of JH1; |
| | (SEQ ID NO: 1208) | | wobble 73:9:9:9; L = 8 |
| 23 | ygdyyfdy | 98, Table 21 | D4-17(2)[2-5]::JH4(whole); |
| | (SEQ ID NO: 1209) | | wobble 73:9:9:9; L = 8 |
| 24 | yyydssgyyy | 98, Table 21 | D3-22(2)::Fr4 of JH1; |
| | (SEQ ID NO: 1210) | | wobble 73:9:9:9; L = 10 |
| 25 | gyCsstsCyt⁶ | 98, Table 21 | D2-2(2)::Fr4 of JH1; wobble |
| | (SEQ ID NO: 1211) | | 73:9:9:9; L = 10 |
| 26 | yyssaeyfqh | 98, Table 21 | YYSS (SEQ ID NO: |
| | (SEQ ID NO: 1212) | | 1245)::JH1(whole); wobble |
| | | | 73:9:9:9; L = 10 |
| 27 | gysygyyfdy | 98, Table 21 | D5-5(3)::JH4(whole); |
| | (SEQ ID NO: 1213) | | wobble 73:9:9:9; L = 10 |
| 28 | yyydssgyyyqh | 98, Table 21 | D3-22(2)::QH::Fr4 of JH1; |
| | (SEQ ID NO: 1214) | | wobble 85:5:5:5; L = 12 |
| 29 | gyCsstsCytqh | 99, Table 21 | D2-2(2)::QH::Fr4 of JH1; |
| | (SEQ ID NO: 1215) | | wobble 85:5:5:5; L = 12 |
| 30 | ydgsysaeyfqh | 99, Table 21 | YDGSYS (SEQ ID NO: |
| | (SEQ ID NO: 1216) | | 1246)::JH1(whole)⁷; wobble |
| | | | 85:5:5:5; L = 12 |
| 31 | yydyvwgsyryt | 99, Table 21 | D3-16(2)::Fr of JH1; wobble |
| | (SEQ ID NO: 1217) | | 85:5:5:5; L = 12 |
| 32 | gysygyywyfdl | 99, Table 21 | D5-5(3)::JH2(whole); wobble |
| | (SEQ ID NO: 1218) | | 85:5:5:5; L = 12 |
| 33 | yyydssgyyyyfqh | 99, Table 21 | D3-22(2)::YFQH (SEQ ID NO: |
| | (SEQ ID NO: 1219) | | 1247)::Fr of JH1; wobble |
| | | | 73:9:9:9; L = 14 |
| 34 | gyCsstsCytyfqh | 99, Table 21 | D2-2(2)::YFQH (SEQ ID NO: |
| | (SEQ ID NO: 1220) | | 1247)::Fr of JH1; wobble |
| | | | 73:9:9:9; L = 14 |
| 35 | sygyCsstsCytqh | 99, Table 21 | SY::D2-2(2)::QH::Fr of JH1; |
| | (SEQ ID NO: 1221) | | wobble 73:9:9:9; L = 14 |
| 36 | syrysgysaeyfqh | 99, Table 21 | SYRYSGYS (SEQ ID NO: |
| | (SEQ ID NO: 1222) | | 1248)::JH1(whole)⁸; wobble |
| | | | 73:9:9:9; L = 14 |
| 37 | ayCggdCysnwfdp | 99, Table 21 | D2-21(2)::JH5(whole); |
| | (SEQ ID NO: 1223) | | wobble 73:9:9:9; L = 14 |
| 38 | sdgyyydssgyyydy | 99, Table 21 | SD::D3-22.2::JH4(101ff); |
| | (SEQ ID NO: 1224) | | wobble 73:9:9:9; L = 15 |
| 39 | gsgyCsggsCysfdy | 99, Table 21 | GS::D2-15.2::JH4(100ff); |
| | (SEQ ID NO: 1225) | | wobble 73:9:9:9; L = 15 |
| 40 | ggrgyssgwyrafdi | 99, Table 21 | GGR::D6-19.1::R::JH3(all); |
| | (SEQ ID NO: 1226) | | wobble 73:9:9:9; L = 15 |
| 41 | yyydssgyyyaeyfqh | 99, Table 21 | D3-22 (2)::JH1(whole); |
| | (SEQ ID NO: 1227) | | wobble 73:9:9:9; L = 16 |
| 42 | gyCsstsCytaeyfqh | 98, Table 21 | D2-2(2)::JH1(whole); wobble |
| | (SEQ ID NO: 1228) | | 73:9:9:9; L = 16 |
| 43 | sydsyrsygsaeyfqh | 100, Table 21 | SYDSYRSYGS (SEQ ID NO: |
| | (SEQ ID NO: 1229) | | 1249)::JH1(whole)⁹; wobble |
| | | | 73:9:9:9; L = 16 |
| 44 | sysygyCsstsCytqh | 100, Table 21 | SYSY (SEQ ID NO: 1250)::D2- |
| | (SEQ ID NO: 1230) | & 135, ¶0477 | 2(2)::QH::Fr JH1; wobble |
| | | | 73:9:9:9; L = 16 |
| 45 | srpgyssswyyyygmdv | 100, Table 21 | SRP::6-13.1::JH6(−1Y); |
| | (SEQ ID NO: 1231) | | wobble 73:9:9:9; L = 17 |
| 46 | gyCsggsCysyyyygmdv | 100, Table 21 | D2-15.2::JH6(-1Y); wobble |
| | (SEQ ID NO: 1232) | | 73:9:9:9; L = 18 |
| 47 | dgyCsggsCysyyygmdv | 100, Table 21 | D::D2-15.2::JH6(−2Ys); |
| | (SEQ ID NO: 1233) | | wobble 73:9:9:9; L = 18 |
| 48 | dgyyydssgyyyrgyyfdy | 100, Table 21 | D::D3-22.2::RGY::JH4(a11); |
| | (SEQ ID NO: 1234) | | wobble 73:9:9:9; L = 18 |
| 49 | yssyyyydssgyyyaeyfqh | 100, Table 21 | YSSY (SEQ ID NO: 1251)::D3- |
| | (SEQ ID NO: 1235) | | 22(2)::JH1(whole); wobble |
| | | | 73:9:9:9; L = 20 |
| 50 | syysgyCsstsCytaeyfqh | 100, Table 21 | SYYS (SEQ ID NO: 1252)::D2- |
| | (SEQ ID NO: 1236) | | 2(2)::JH1(whole); wobble |
| | | | 73:9:9:9; L = 20 |
| 51 | sgyCsstsCytyysaeyfqh | 100, Table 21 | s::D2- |
| | (SEQ ID NO: 1237) | | 2(2)::YYS::JH1(whole); |
| | | | wobble 73:9:9:9; L = 20 |
| 52 | yyyydyvwgsyrytsnwfdp | 100, Table 21 | Y::D3-16(2)::S::JH5(whole); |
| | (SEQ ID NO: 1238) | | wobble 73:9:9:9; L = 20 |
| 53 | yyyydyvwgsyrytssyfdy | 100, Table 21 | Y: :D3- |
| | (SEQ ID NO: 1239) | | 16(2)::SS::JH4(whole); |
| | | | wobble 73:9:9:9; L = 20 |
| 54 | (FSYDR)(QERSYL)(HDRSYL) | 117, Table 60 | L = 3 dobbling JH1stump; |
| | | | first AAT 3X |
| 55 | (TYRDL)(TYRDL)(GSYRDL) | 117, Table 61 | L = 3 dobbling D1-1.1.2; |
| | | | first AAT 5X |
| 56 | (ysdrl)(fsydrl)(drsyl) | 118, Table 62 | L = 4; dobbling JH2stump; |
| | (lsydr) | | first AAT 4X |
| 57 | (lsydr)(lsydr)(wsydr) | 118, Table 63 | L = 4; dobbling D3-10.1; |
| | (fsydr) | | first AAT 4X |
| 58 | (ysrdl)(ysrdl)(ysrdl)(dysrl) | 119, Table 52 | L = 16; dobbling |
| | (syrdl)(syrd1)(gasyrdl) | | D2-21.2::JH1stump; |
| | (ysrdl)(ysrdl)(ysrdl)(asyrd) | | first AAT 3X |
| | (ersyl)(ysrd1)(fysrd)(qersy) | | |
| | (hersyl) | | |
| 59 | (gsydrl)(ysdrl)C(syrdl) | 119, Table 53 | L = 16; dobbling D2-2.2; |
| | (syrdl)(syrdl)(tyrdl) | | first AAT 3X |
| | (syrdl)C(ysrdl)(tyrdl) | | |
| | (asydrl)(ersyl)(ysdrl) | | |
| | (fysrdl)(qersyl)(hdrsyl) | | |
| 60 | (dsyl)(ysl)¹⁰(gsydrl)(ysl) | 120, ¶0455 | L = 23; dobbling DY::D2- |
| | C(sydrl)(sydrl)(tydrl) | | 22::YGYSY (SEQ ID NO: |
| | (sydrl)C(ysl)(tydrl)(gsyrd) | | 1253)::JH1stump; |
| | (ysl)(sydrl)(ysl)(asydr) | | first AAT 3X |
| | (ersyl)(ysl)(fsydr)(gysdrl) | | |
| | (hsydrl) | | |
| 61 | gsgyCsggsCysfdy | 122, ¶0457 | L = 15; dobbling GS::D2- |
| | (SEQ ID NO: 1240) | & Table 80 | 15.2::JH4stump; |
| | | | first AAT 3X |
| 62-97 | See templates | p. 122 ¶455 & | Dobbling 3:1:1:1:1 |
| | 18-53 in Table 80 | Table 80 | |
| 98 | X₁-X₂-(X₃-(X₄-(X₅-(X₆-(X₇- | | X₁-X₈ have 5 to 12 of the |
| | (X₈-(X₉)))))))-X₁₀-X₁₁ | | most often seen AATs. |

²lower case indicates variegation.
³In 17-53, lower case AATs are wobbled or dobbled.
⁴At paragraph 0457, it is said that each of the sequences shown in Table 21 (Bibliotecas 17-53) can be dobbled as in Biblioteca 61.
⁵YY could come from a D segment, how long does it need to be to be a “D seg”?
⁶uppercase letters are not wobbled.
⁷GSY is found in D1-26.3.3, but no tetramers of the parental seq come from D segments.
⁸YSGY (SEQ ID NO: 807) is found in D5-18.3.
⁹YDSY (SEQ ID NO: 1265) is found in D5-12.3.2.
¹⁰Y:S:L::2:2:1, same at all positions having YSL.

Table of examples.

| Example | Content | page |
|---|---|---|
| 1 | Prophetic Example 1: Libraries With Very Short HC CDR3s | 74 |
| 2 | Prophetic Example 2: Libraries with Very Long HC CDR3s | 81 |
| 3 | Example 3: HC CDR3 of length 6-20. | 109 |
| 4 | HC CDR1/2 | 126 |
| 4.1 | HC CDR1 | 127 |
| 4.2 | HC CDR2 | 128 |
| 4.3 | HC CDR1/2 | 129 |
| 4.4 | HC CDR3, lengths 3, 4, 5 | 132 |
| 4.5 | HC CDR3 length 10 to 20 | 134 |
| 4.6 | Dobbling of yycakGSGYCSGGSCYSFDYwgqgtlvtvss (SEQ ID NO: 931) | 137 |
| 5 | Synthetic light chain diversity | 142 |
| 6 | Wobbled DNA for HC CDR3 16d | 156 |
| 7 | Further examples of synthetic HC CDR3s | 161 |
| 8 | A library of HC CDR3s having lengths from 4 to 12 and no D segments. | 242 |
| 9 | A library of LC | 254 |
| 10 | A library of HC CDR3s having lengths from 4 to 12 and no D segments. | 271 |
| 11 | A library of HC CDR3s having lengths from 5 to 11 and no D segments. | 275 |
| 12 | Alternative HC CDR3 libraries | 278 |
| 13 | Library of HC CDR3 with lengths from 4 to 12 (no D) | 279 |
| 14 | HC CDR1 and CDR2 | 280 |
| 15 | A preferred form of variegation for HC CDR1 and CDR2 | 281 |
| 16 | A Library of LCs | 282 |
| 43 | Use of VH3-66 as a framework | 138 |
| 44 | Diversifying trastuzumab | 140 |
| 50 | A library having no D segments in HC CDR3 | 181 |

All Tables

| Table | Page | |
|---|---|---|
| number | number | |
| 1 | 78 | Designs of very short exemplary HC CDR3s |
| 3 | 100 | Human JH segments |
| 5 | 73 | Standard codes for mixed nucleotides |
| 6 | 74 | Example of mixed nucleotides for wobbling |
| 7 | 76 | Amino-acid sequences of parental CDR3s of lengths 3, 4, 5 |
| 8 | 77 | DNA encoding V-5D2-8.2a-JH2 for wobbling |
| 11 | 101 | Trimers that can be extracted from human D segments |
| 12 | 103 | Distinct tetramers that can be extracted from human D segments |
| 13 | 106 | Pentamers that can be extracted from human D segments |
| 14 | 108 | All hexamers that can be extracted from human D segments |
| 19 | 69 | 26 VL to be used in pLCSK23 |
| 20 | 98 | Frequency of D segments in 21578 Abs |
| 21 | 111 | Parental amino-acid sequences for HC CDR3s of 6-20 AAs. (Bibl = |
| | | Biblioteca) |
| 22 | 114 | HC display cassette |
| 25 | 117 | The DNA sequence of DY3F85LC containing a sample germline O12 |
| | | kappa light chain |
| 30 | 119 | DNA sequence of DY3FHC87 (SEQ ID NO: 894) |
| 35 | 122 | DNA sequence of pMID21: 5957 bp (SEQ ID NO: 895) |
| 36 | 124 | pM21J containing IIIss::A27::Ckappa |
| 40 | 125 | pLCSK23 (SEQ ID NO: 896) |
| 50 | 128 | Diversity for CDR1 in 3-23 (Diversity = 5832) |
| 51 | 129 | HC CDR2: Diversity = 419904 |
| 52 | 135 | Library 1: Diversity = 5 E 11 the “parental” sequence occurs at 1 in 1.5 |
| | | E6. (Biblioteca 58) |
| 53 | 136 | Library 2: CDR3 length 16; Diversity is 3.0 E 10 and the parental |
| | | sequence occurs once in 3.7 E 5. (Biblioteca 59) |
| 54 | 128 | Diversity for CDR1 in 3-23 (Diversity = 5508) |
| 55 | 129 | HC CDR2: Diversity = 396,576 (reduced N-X-(S/T) |
| 60 | 132 | A dobbled HC CDR3 of length 3 (V-3JH1 of Table 7) (Biblioteca 54) |
| 61 | 133 | A dobbled HC CDR3 of length 3 from a D fragment (V-3D1-1.1.2-JH1 of |
| | | Table 7). (Biblioteca 55) |
| 62 | 133 | HC CDR3 length 4 from JH2 (V-4JH2 in Table 7) (Biblioteca 56) |
| 63 | 134 | HC CDR3 of length four from V-4D3-10.1a in Table 8 (Biblioteca 57) |
| 65 | 137 | Dobbling of Design 1 with SEQ ID NO: 898 as parent (Biblioteca 60) |
| 66 | 146 | Distribution of VLs in 13222 LCs |
| 68 | 144 | where to vary A27 |
| 69 | 147 | A Display gene for A27 in pM21J. |
| 70 | 149 | Tally of mutations in CDRs of A27 Abs |
| 71 | 152 | Allowed diversity in CDR1, 2, and 3 of A27::JK4 (reduced N-X-(S/T) |
| 72 | 150 | Variegation of CDRs of A27 Abs (reduced N-X-(S/T) |
| 73 | 153 | Allowed diversity in CDR1, 2, and 3 of A27::JK4. |
| 75 | 154 | Frequencies of amino acids in HC CDR3s. |
| 76 | 155 | Length distribution of 21578 HC CDR3s |
| 80 | 138 | Dobbling of yycakGSGYCSGGSCYSFDYwgqgtlvtvss (SEQ ID NO: 931) |
| 100 | 60 | Length diversity in a library of HC CDR3s |
| 190 | 131 | Diversity in HC CDR1 and CDR2 |
| 191 | 282 | Diversity in HC CDR1 and CDR2 (reduced N-X-(S/T)) |
| 200 | 183 | Expected actual diversity of CDR1/2 vs number of isolates |
| 201 | 183 | Expected actual diversity of CDR3 vs number of isolates |
| 202 | 184 | LC CDR3 diversity |
| 204 | 185 | LC backbone |
| 209 | 188 | LC CDR1 |
| 210 | 189 | LC CDR2 |
| 211 | 190 | LC CDR3 |
| 212 | 191 | amount of diversity allowed in each LC CDR. |
| 213 | 192 | pM21J |
| 215 | 198 | Unannotated DNA sequence of pM21J |
| 216 | 200 | Sampling of allowed diversity in LC CDRs |
| 221 | 201 | Tally Utilization of JHs based on AA sequences from amino-acid sequence |
| | | analysis |
| 223 | 201 | Use of AAs HC CDR3 (19051 Abs; 343244 Amino acids |
| 224 | 202 | Lengths of CDR3 |
| 225 | 219 | JH1 ---AEYFQHWGQGTLVTVSS 1101 (SEQ ID NO: 66) |
| 226 | 219 | JH2 ---YWYFDLWGRGTLVTVSS 792 (SEQ ID NO: 67) |
| 227 | 219 | JH3 -----AFDIWGQGTMVTVSS 4677 (SEQ ID NO: 2) |
| 228 | 220 | JH4 -----YFDYWGQGTLVTVSS 7092 (SEQ ID NO: 1) |
| 229 | 220 | JH5 ----NWFDPWGQGTLVTVSS 1007 (SEQ ID NO: 68) |
| 300 | 62 | Results of 1, 2, or 3 base changes from parental codons |
| 400 | 156 | Cassette for display of wobbled HC CDR3 16d |
| 500 | 157 | Expected distribution of AA types in wobbled HC CDR3 16d |
| 770 | 151 | Variegation of human A27 |
| 800 | 158 | LC K1(O12)::JK1 |
| 900 | 159 | CDR1 diversity |
| 1000 | 159 | Big CDR1 diversity |
| 1100 | 160 | CDR2 diversity |
| 1200 | 160 | Big CDR2 diversity |
| 1300 | 160 | CDR3 diversity |
| 1400 | 161 | Big CDR3 diversity |
| 2210 | 220 | JH6 YYYYYGMDVWGQGTTVTVSS 4382 (SEQ ID NO: 3) |
| 2211 | 221 | distribution of AATs for VJ fill; P1-P4 |
| 2212 | 202 | VD fill |
| 2214 | 203 | Where are the various amino-acid types found |
| 2215 | 207 | Prescribed lengths of CDR3 |
| 2217 | 223 | DJ fill |
| 2219 | 208 | Prescribeded lengths in Library 3 |
| 2220 | 208 | Prescribed lengths in Library 4 |
| 2221 | 208 | Analysis of 562C-M0008-C05 |
| 2229 | 209 | N-mers of 3-22.2 |
| 2230 | 209 | N-mers of 3-3.2 |
| 2231 | 210 | Selected D segments vs J tally |
| 2232 | 224 | Tally of D3-22.2 |
| 2240 | 210 | Algorithm to determine Jstump |
| 2250 | 211 | J vs length |
| 2261 | 226 | D vs Length (3-17) |
| 2263 | 216 | Composition of CDR1 |
| 2267 | 228 | Tally of VJ fill |
| 2273 | 229 | Tally of D 6-13.1 and D6-19.1 D 6-13.1 GYSSSWY 570 |
| | | (SEQ ID NO: 215) |
| 2280 | 230 | Tally of D 4-17.2 DYGDY 386 |
| 2282 | 211 | Cassette for HC CDR3 |
| 2283 | 212 | Analysis of CDR1 |
| 2293 | 231 | D2-15.2, D2-2.2 and composite |
| 3001 | 212 | A27::JK |
| 3001 | 212 | Frequencies of JKs with A27 |
| 3002 | 233 | A27 CDR1s |
| 3003 | 234 | A27 CDR2s |
| 3004 | 235 | A27 CDR3s |
| 3005 | 213 | Lengths of CDRs in A27s |
| 3006 | 218 | Lengths of Jstump |
| 3007 | 214 | Base Usage in CDR3 |
| 3008 | 237 | VD fill from DNA analysis |
| 3010 | 238 | VJ fill distribution: 1-5 |
| 3020 | 243 | Low Gly, Ser, & Tyr |
| 3021 | 245 | Low Ser and Tyr, High Gly |
| 3022 | 246 | Low Gly & Tyr, High Ser |
| 3023 | 247 | Proportions with high Tyr |
| 3024 | 248 | High Gly & Ser, Low Tyr |
| 3025 | 249 | Proportions with high Gly and Tyr |
| 3026 | 250 | Proportions with high Ser and Tyr |
| 3027 | 251 | Proportions with high Gly, Ser, Tyr |
| 3028 | 252 | Proportions for Example 13 |
| 3031 | 253 | Distributions for actual positions 6-8 in HC CDR3 of length 8. |
| 3032 | 253 | Positions 5-7 in HC CDR3s of length 7. |
| 3033 | 254 | Averaged tabulated positions 5 & 10; 6 & 11; and 7& 12 of Table 3010 |
| 3100 | 279 | Alternative for Example 8 |
| 3305 | 214 | Distribution of AATs in Abs with CDR3 Len 3 N = 32 |
| 3306 | 215 | Distribution of AATs in Abs with CDR3 Len 4; N = 104 |
| 3307 | 215 | Distribution of AATs in CDR3 having Len 5 N = 109 |
| 3500 | 139 | 3-66 display cassette |
| 3508 | 141 | Herceptin display |
| 3600 | 256 | Germ-line diversity of human Vkappas in the CDRs |
| 3601 | 257 | LC CDR1 Diversity |
| 3602 | 257 | LC CDR2 Diversity |
| 3603 | 257 | LC CDR3 diversity |
| 3610 | 257 | pMID55F annotated |
| 3611 | 270 | pMID55F not annotated |
| 3620 | 273 | Example 10, length 8 |
| 3621 | 274 | Example 10, Length 7 |
| 3622 | 275 | Example 10, Length 6 |
| 3630 | 277 | Example 11 Length 8 |
| 3631 | 277 | Example 11, Length 7 |
| 3632 | 278 | Example 11, Length 6 |
| 4601 | 284 | LC CDR1 Diversity (low N-X-(S/T)) |
| 4602 | 284 | LC CDR2 Diversity (low N-X-(S/T)) |
| 4603 | 284 | LC CDR3 diversity (low N-X-(S/T)) |
| 6501 | 17 | Alternative variegation for the HC CDR3 of Library P65; Part 1 |
| 6502 | 17 | Alternative variegation for the HC CDR3 of Library P65; Part 2 |
| 6503 | 17 | Alternative variegation for the HC CDR3 of Library P65; Part 1 |
| 6504 | 18 | Alternative variegation for the HC CDR3 of Library P65; Part 2 |
| 6505 | 18 | Alternative variegation for the HC CDR3 of Library P65; Part 1 |
| 6506 | 19 | Alternative variegation for the HC CDR3 of Library P65; Part 2 |
| 6511 | 22 | HC CDR3 proportions Length = 11-14 part 2 |

### REFERENCES

The contents of all cited references including literature references, issued patents, published or non-published patent applications cited throughout this application as well as those listed below are hereby expressly incorporated by reference in their entireties. In case of conflict, the present application, including any definitions herein, will control.
U.S. Published Application 2005-0119455A1
Sidhu et al., J Mol Biol. 2004 338:299-310.
1: Koide S, Sidhu S S. The importance of being tyrosine: lessons in molecular recognition from minimalist synthetic binding proteins. ACS Chem. Biol. 2009 May 15; 4(5):325-34. Review. PubMed PMID: 19298050.
2: Birtalan S, Zhang Y, Fellouse F A, Shao L, Schaefer G, Sidhu S S. The intrinsic contributions of tyrosine, serine, glycine and arginine to the affinity and specificity of antibodies. J Mol Biol. 2008 Apr. 11; 377(5):1518-28. Epub 2008 Feb. 12. PubMed PMID: 18336836.
3: Fellouse F A, Esaki K, Birtalan S, Raptis D, Cancasci V J, Koide A, Jhurani P, Vasser M, Wiesmann C, Kossiakoff A A, Koide S, Sidhu S S. High-throughput generation of synthetic antibodies from highly functional minimalist phage-displayed libraries. J Mol. Biol. 2007 Nov. 2; 373(4):924-40. Epub 2007 Aug. 19. PubMed PMID: 17825836.
4: Zhang Y, Yeh S, Appleton B A, Held H A, Kausalya P J, Phua D C, Wong W L, Lasky L A, Wiesmann C, Hunziker W, Sidhu S S. Convergent and divergent ligand specificity among PDZ domains of the LAP and zonula occludens (ZO) families. J Biol Chem. 2006 Aug. 4; 281(31):22299-311. Epub 2006 May 31. PubMed PMID: 16737968.
5: Fellouse F A, Barthelemy P A, Kelley R F, Sidhu S S. Tyrosine plays a dominant functional role in the paratope of a synthetic antibody derived from a four amino acid code. J Mol Biol. 2006 Mar. 17; 357(1):100-14. Epub 2005 Dec. 19. PubMed PMID: 16413576.
6: Fellouse F A, Li B, Compaan D M, Peden A A, Hymowitz S G, Sidhu S S. Molecular recognition by a binary code. J Mol Biol. 2005 May 20; 348(5):1153-62. Epub 2005 Apr. 1. PubMed PMID: 15854651.
7: Fellouse F A, Wiesmann C, Sidhu S S. Synthetic antibodies from a four-amino-acid code: a dominant role for tyrosine in antigen recognition. Proc Natl Acad Sci USA. 2004 Aug. 24; 101(34):12467-72. Epub 2004 Aug. 11. PubMed PMID: 15306681; PubMed Central PMCID: PMC515084.

### EQUIVALENTS

A number of embodiments of the invention have been described. Nevertheless, it will be understood that various modifications may be made without departing from the spirit and scope of the invention. Accordingly, other embodiments are within the scope of the following claims.

1. A library of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is X₁-X₂-X₃-X₄-X₅-X₆-X₇-X₈-X₉-X₁₀-X₁₁-X₁₂-X₁₃-X₁₄,
wherein each of X₁ through X₈ are each independently occupied by the amino acids that most frequently occur at each of positions X₁ through X₈ as shown in Table 3010;
wherein any one of residues X₈ through X₁₁ are each independently absent or have the same distribution as X₈ as shown in Table 3010; and
X₁₂ through X₁₄ correspond to residues 100-102 of a human JH.

2. A library of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is X₁-X₂-X₃-X₄-X₅-X₆-X₇-X₈-X₉-X₁₀-X₁₁-X₁₂-X₁₃-X₁₄,
wherein each of X₁ through X₈ are each independently occupied by the eleven amino acids that most frequently occur at each of positions X₁ through X₈ as shown in Table 3010 wherein Gly is three times as frequent as the others and AATs 2-11 are at the same frequency;
wherein any one of residues X9 through X₁₁ are each independently absent or have the same distribution as used at position X₈; and
X₁₂ through X₁₄ correspond to residues 100-102 of a human JH.

3. A library of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is X₁-X₂-X₃-X₄-X₅-X₆-X₇-X₈-X₉-X₁₀-X₁₁-X₁₂-X₁₃-X₁₄-X₁₅-X₁₆-X₁₇, wherein
X₁ through X₄ are each independently absent or have the same distribution as X₁ through X₄, as shown in Table 3008;
none or 1, 2, 3, 4, or 5 of X₅ through X₁₂ are each independently absent or are independently occupied by amino acids that most frequently occur at positions corresponding to X₅ through X₁₂ in a human D segment;
X₁₃ and X₁₄ are each independently absent or are occupied by the 5 to 12 amino acids that most frequently occur in a DJ fill in Table 75; and
X₁₅ through X₁₇ are occupied by amino acids that correspond to residues 100-102 of a human JH.

4. A library of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is X₁-X₂-X₃-X₄-X₅-X₆-X₇-X₈-X₉-X₁₀-X₁₁-X₁₂-X₁₃-X₁₄-X₁₅-X₁₆-X₁₇, wherein
X₁ through X₄ are each independently absent or have the same distribution as X₁ through X₄, as shown in Table 3008;
none or 1, 2, 3, 4, or 5 of X₅ through X₁₂ are each independently absent or are independently occupied by amino acids that most frequently occur at positions corresponding to X₅ through X₁₂ in a human D segment;
X₁₃ and X₁₄ are each independently absent or are occupied by the 5 to 12 amino acids that most frequently occur in a DJ fill in Table 75; and
X₁₅ through X₁₇ are occupied by amino acids that correspond to residues 100-102 of a human JH.

5. A library of vectors or genetic packages that display, display and express, or comprise a member of a diverse family of human antibody related peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is
X₁-X₂-X₃-X₄-X₅-X₆-X₇-X₈-X₉-X₁₀-X₁₁ wherein
X₁ is G, D, V, E, A, S, R, L, I, H, T, or Q, in the ratios for G:D:V:E:A:S:R:L:I:H:T:Q of 217:185:84:83:71:68:58:43:33:28:25:20;
X₂ is G, R, S, L, P, V, A, T, D, K, N, Q, or I, in the ratios for G:R:S:L:P:V:A:T:D:K:N:Q:I of 186:142:99:83:76:49:46:44:35:29:29:29:29;
X₃ is G, R, S, L, A, P, Y, V, W, T, or D, in the ratios for G:R:S:L:A:P:Y:V:W:T:D of 203:130:92:61:60:54:52:48:48:42:36;
X₄ is G, S, R, L, A, W, Y, V, P, T, or D, in the ratios for G:S:R:L:A:W:Y:V:P:T:D of 210:103:91:64:63:59:59:47:47:47:40;
X₅ is G, S, R, L, A, Y, W, D, T, P, or V, in the ratios for G:S:R:L:A:Y:W:D:T:P:V of 190:96:89:71:64:59:59:56:46:43:42;
X₆ is G, S, R, D, L, A, P, Y, T, W, V, or Δ (absent), in the ratios for G:S:R:D:L:A:P:Y:T:W:V:Δ of 173:93:88:73:71:63:58:57:56:44:39:*;
X₇ is G, S, R, D, L, A, P, Y, T, W, V, or Δ (absent), in the ratios for G:S:R:D:L:A:P:Y:T:W:V:Δ of 173:93:88:73:71:63:58:57:56:44:39:*;
X₈ is G, S, R, D, L, A, P, Y, T, W, V, or Δ (absent), in the ratios for G:S:R:D:L:A:P:Y:T:W:V:Δ of 173:93:88:73:71:63:58:57:56:44:39:*;
X₉ is F;
X₁₀ is D; and
X₁₁ is Y, wherein the distribution of lengths (Len) is Len 8:Len 9:Len 10:Len 11::2:3:3:2, and wherein * indicates that the proportion of Δ is determined by the prescribed length distribution under the rule that each deleteable codon is deleted with the same frequency.

6. A library of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is
X₁-X₂-X₃-X₄-X₅-X₆-X₇-X₈-X₉-X₁₀-X₁₁-X₁₂-X₁₃-X₁₄, wherein
X₁ is G, D, E, V, S, A, R, L, I, H, T, or Q, in the ratios for G:D:V:E:A:S:R:L:I:H:T:Q of 217:185:84:83:71:68:58:43:33:28:25:20;
X₂ is G, R, S, L, P, V, A, T, D, K, N, Q, or I, in the ratios for G:R:S:L:P:V:A:T:D:K:N:Q:I of 186:142:99:83:76:49:46:44:35:29:29:29:29;
X₃ is G, R, S, L, A, P, Y, V, W, T, or D, in the ratios for G:R:S:L:A:P:Y:V:W:T:D of 203:130:92:61:60:54:52:48:48:42:36;
X₄ is G, S, R, L, A, W, Y, V, P, T, or D, in the ratios for G:S:R:L:A:W:Y:V:P:T:D of 210:103:91:64:63:59:59:47:47:47:40;
X₅ is G, S, R, L, A, Y, W, D, T, P, or V, in the ratios for G:S:R:L:A:Y:W:D:T:P:V of 190:96:89:71:64:59:59:56:46:43:42;
X₆ is G, S, R, D, L, A, P, Y, T, W, or V, in the ratios for G:S:R:D:L:A:P:Y:T:W:V of 173:93:88:73:71:63:58:57:56:44:39;
X₇ is G, R, S, L, P, D, A, Y, T, W, V, or Δ (absent), in the ratios for G:R:S:L:P:D:A:Y:T:W:V:Δ of 179:92:86:74:70:69:56:55:44:41:39:*;
X₈ is G, S, R, L, D, P, Y, A, T, F, V, or Δ, in the ratios for G:S:R:L:D:P:Y:A:T:F:V:Δ of 141:94:93:83:78:69:65:59:47:41:41:*;
X₉ is G, S, R, L, D, P, Y, A, T, F, V, or Δ, in the ratios for G:S:R:L:D:P:Y:A:T:F:V:Δ of 141:94:93:83:78:69:65:59:47:41:41:*;
X₁₀ is G, S, R, L, D, P, Y, A, T, F, V, or Δ, in the ratios for G:S:R:L:D:P:Y:A:T:F:V:Δ of 141:94:93:83:78:69:65:59:47:41:41:*;
X₁₁ is G, S, R, L, D, P, Y, A, T, F, V, or Δ, in the ratios for G:S:R:L:D:P:Y:A:T:F:V:Δ of 141:94:93:83:78:69:65:59:47:41:41:*;
X₁₂ is F;
X₁₃ is D; and
X₁₄ is Y;
wherein the distribution of lengths (Len) is Len9:Len10:Len11:Len12:Len13:Len14::n1:n2:n3:n4:n5:n6, and wherein * indicates that the proportion of Δ is determined by the prescribed length distribution under the rule that each deleteable codon is deleted with the same frequency.

7. A library of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is
X₁-X₂-X₃-X₄-X₅-X₆-X₇-X₈-X₉-X₁₀-X₁₁-X₁₂-X₁₃-X₁₄, wherein
X₁ is G, D, V, E, A, S:R:L, I:H, T, or Q, in the ratios for G:D:V:E:A:S:R:L:I:H:T:Q of 217:185:84:83:71:68:58:43:33:28:25:20;
X₂ is G, R, S, L, P, V, A, T, D, K, N, Q, or I, in the ratios for G:R:S:L:P:V:A:T:D:K:N:Q:I of 186:142:99:83:76:49:46:44:35:29:29:29:29;
X₃ is G, R, S, L, A, P, Y, V, W, T, or D, in the ratios for G:R:S:L:A:P:Y:V:W:T:D of 203:130:92:61:60:54:52:48:48:42:36;
X₄ is G, S, R, L, A, W, Y, V, P, T, or D, in the ratios for G:S:R:L:A:W:Y:V:P:T:D of 210:103:91:64:63:59:59:47:47:47:40;
X₅ is G, S, R, L, A, Y, W, D, T, P, or V, in the ratios for G:S:R:L:A:Y:W:D:T:P:V of 190:96:89:71:64:59:59:56:46:43:42;
X₆ is G, S, R, D, L, A, P, Y, T, W, or V, in the ratios for G:S:R:D:L:A:P:Y:T:W:V of 173:93:88:73:71:63:58:57:56:44:39;
X₇ is G, R, S, L, P, D, A, Y, T, W, or V, in the ratios for G:R:S:L:P:D:A:Y:T:W:V of 179:92:86:74:70:69:56:55:44:41:39;
X₈ is G, S, R, L, D, P, Y, A, T, F, V, or Δ (absent), in the ratios for G:S:R:L:D:P:Y:A:T:F:V:Δ of 141:94:93:83:78:69:65:59:47:41:41:*;
X₉ is G, S, R, L, D, P, Y, A, T, F, V, or Δ, in the ratios for G:S:R:L:D:P:Y:A:T:F:V:Δ of 141:94:93:83:78:69:65:59:47:41:41:*;
X₁₀ is G, S, R, L, D, P, Y, A, T, F, V, or Δ, in the ratios for G:S:R:L:D:P:Y:A:T:F:V:Δ of 141:94:93:83:78:69:65:59:47:41:41:*;
X₁₁ is G, S, R, L, D, P, Y, A, T, F, V, or Δ, in the ratios for G:S:R:L:D:P:Y:A:T:F:V:Δ of 141:94:93:83:78:69:65:59:47:41:41:*;
X₁₂ is F;
X₁₃ is D; and
X₁₄ is Y,
wherein the distribution of lengths (Len) is Len10:Len11:Len12:Len13:Len14::n1:n2:n3:n4:n5, and wherein * indicates that the proportion of Δ is determined by the prescribed length distribution under the rule that each deleteable codon is deleted with the same frequency.

8. A library of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is
X₁-X₂-G₃-X₄-G₅-X₆-X₇-X₈-X₉-X₁₀-X₁₁-X₁₂-X₁₃-X₁₄ (SEQ ID NO: 1254) wherein
X₁ is G, D, E, V, S, A, R, L, I, H, T, or Q, in the ratios for G:D:V:E:A:S:R:L:I:H:T:Q of 217:185:84:83:71:68:58:43:33:28:25:20;
X₂ is G, R, S, L, P, V, A, T, D, K, N, Q, or I, in the ratios for G:R:S:L:P:V:A:T:D:K:N:Q:I of 186:142:99:83:76:49:46:44:35:29:29:29:29;
X₃ is G;
X₄ is G, S, R, L, A, W, Y, V, P, T, or D, in the ratios for G:S:R:L:A:W:Y:V:P:T:D of 210:103:91:64:63:59:59:47:47:47:40;
X₅ is G;
X₆ is G, S, R, D, L, A, P, Y, T, W, or V, in the ratios for G:S:R:D:L:A:P:Y:T:W:V of 173:93:88:73:71:63:58:57:56:44:39;
X₇ is R or absent (Δ) with equal frequency;
X₈ is G, S, R, L, D, P, Y, A, T, F, V, or Δ, in the ratios for G:S:R:L:D:P:Y:A:T:F:V:Δ of 141:94:93:83:78:69:65:59:47:41:41:*;
X₉ is G, S, R, L, D, P, Y, A, T, F, V, or Δ, in the ratios for G:S:R:L:D:P:Y:A:T:F:V:Δ of 141:94:93:83:78:69:65:59:47:41:41:*;
X₁₀ is G, S, R, L, D, P, Y, A, T, F, V, or Δ, in the ratios for G:S:R:L:D:P:Y:A:T:F:V:Δ of 141:94:93:83:78:69:65:59:47:41:41:*;
X₁₁ is G, S, R, L, D, P, Y, A, T, F, V, or Δ, in the ratios for G:S:R:L:D:P:Y:A:T:F:V:Δ of 141:94:93:83:78:69:65:59:47:41:41:*;
X₁₂ is F;
X₁₃ is D; and
X₁₄ is Y,
wherein the distribution of lengths (Len) is Len9:Len10:Len11:Len12:Len13:Len14::n1:n2:n3:n4:n5:n6, and wherein * indicates that the proportion of Δ is determined by the prescribed length distribution under the rule that each deleteable codon is deleted with the same frequency.

9. A library of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is
X₁-X₂-X₃-X₄-X₅-X₆-X₇-X₈-X₉-X₁₀-X₁₁-X₁₂-X₁₃-X₁₄-X₁₅-X₁₆ (SEQ ID NO: 1255) wherein
X₁ is D, G, V, E, A, S, R, L, T, H, P, or Δ (absent), in the ratios for D:G:V:E:A:S:R:L:T:H:P:Δ of 214:192:92:90:86:52:50:39:32:32:25:*;
X₂ is G, R, P, L, S, A, V, T, K, D, Q, or Δ, in the ratios G:R:P:L:S:A:V:T:K:D:Q:Δ of 171:153:107:83:81:51:40:40:34:32:30:*; X₃ is Y, G, D, R, H, P, S, L, N, A, or I, in the ratios for Y:G:D:R:H:P:S:L:N:A:I of 30:1:1:1:1:1:1:1:1:1:1;
X₄ is Y, G, S, F, L, D, E, P, A, R, or H, in the ratios for Y:G:S:F:L:D:E:P:A:R:H of 30:1:1:1:1:1:1:1:1:1:1;
X₅ is D;
X₆ is S;
X₇ is S;
X₈ is G, A, D, P, V, L, S, R, T, Y, or N, in the ratios for G:A:D:P:V:L:S:R:T:Y:N of 30:1:1:1:1:1:1:1:1:1:1;
X₉ is Y, P, L, S, W, H, R, F, D, G, N, in the ratios for Y:P:L:S:W:H:R:F:D:G:N of 30:1:1:1:1:1:1:1:1:1:1;
X₁₀ is Y, S, P, L, R, F, G, W, H, D, V, in the ratios for Y:S:P:L:R:F:G:W:H:D:V of 30:1:1:1:1:1:1:1:1:1:1;
X₁₁ is G;
X₁₂ is G, P, D, R, S, L, A, N, H, T, Y, or Δ, in the ratios for G:P:D:R:S:L:A:N:H:T:Y:Δ of 185:101:96:92:88:67:48:43:36:35:33:*;
X₁₃ is G, D, R, P, S, N, L, A, Y, V, T, or Δ, in the ratios for G:D:R:P:S:N:L:A:Y:V:T:Δ of 204:103:96:78:72:67:67:45:42:36:34:*;
X₁₄ is F;
X₁₅ is D; and
X₁₆ is Y,
wherein the distribution of lengths (Len) is Len12:Len13:Len14:Len15:Len16::n1:n2:n3:n4:n5, and wherein * indicates that the proportion of Δ is determined by the prescribed length distribution under the rule that each deleteable codon is deleted with the same frequency.

10. A library of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is
X₁-X₂-X₃-X₄-X₅-X₆-X₇-X₈-X₉-X₁₀-X₁₁-X₁₂-X₁₃-X₁₄-X₁₅-X₁₆-X₁₇-X₁₈-X₁₉ (SEQ ID NO: 1256), wherein
X₁ is D, G, V, E, A, S, R, L, T, H, P, or Δ (absent), in the ratios for D:G:V:E:A:S:R:L:T:H:P:Δ of 214:192:92:90:86:52:50:39:32:32:25:*;
X₂ is G, R, P, L, S, A, V, T, K, D, Q, or Δ, in the ratios for G:R:P:L:S:A:V:T:K:D:Q:Δ of 171:153:107:83:81:51:40:40:34:32:30:*;
X₃ is G or Δ at a ratio determined by the prescribed length distribution;
X₄ is G or Δ at a ratio determined by the prescribed length distribution;
X₅ is Y, G, S, F, L, D, E, P, A, R, or H, in the ratios for Y:G:S:F:L:D:E:P:A:R:H of 30:1:1:1:1:1:1:1:1:1:1;
X₆ is D;
X₇ is S;
X₈ is S;
X₉ is G;
X₁₀ is Y;
X₁₁ is Y, S, P, L, R, F, G, W, H, D, or V, in the ratios for Y:S:P:L:R:F:G:W:H:D:V of 50:5:5:5:5:5:5:5:5:5:5;
X₁₂ is Y, P, S, G, R, F, L, D, H, W, or V, in the ratios for Y:P:S:G:R:F:L:D:H:W:V of 50:5:5:5:5:5:5:5:5:5:5;
X₁₃ is G, R, S, L, D, P, A, T, F, I, Y, or Δ, in the ratios for G:R:S:L:D:P:A:T:F:I:Y:Δ of 5:1:1:1:1:1:1:1:1:1:1:15;
X₁₄ is G or Δ, at a ratio determined by the prescribed length distribution;
X₁₅ is G, R, S, L, D, P, A, T, F, I, Y, or Δ, in the ratios for G:R:S:L:D:P:A:T:F:I:Y:Δ of 5:1:1:1:1:1:1:1:1:1:1:15;
X₁₆ is G, R, S, L, D, P, A, T, F, I, Y, or Δ, in the ratios for G:R:S:L:D:P:A:T:F:I:Y:Δ of 5:1:1:1:1:1:1:1:1:1:1:15;
X₁₇ is F, G, P, S, R, D, L, A, T, N, or H, in the ratios for F:G:P:S:R:D:L:A:T:N:H of 500:103:66:62:61:52:45:32:28:28:22;
X₁₈ is D; and
X₁₉ is Y,
wherein the distribution of lengths (Len) is Len15:Len16:Len17:Len18:Len19::n1:n2:n3:n4:n5, and wherein * indicates that the proportion of Δ is determined by the prescribed length distribution under the rule that each deleteable codon is deleted with the same frequency.

11. A library of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is
X₁-X₂-X₃-X₄-X₅-X₆-X₇-X₈-X₉-X₁₀-X₁₁-X₁₂-X₁₃ (SEQ ID NO: 1257) wherein
X₁ is D, G, V, E, A, S, R, L, T, H, P, or Δ (absent), in the ratios for D:G:V:E:A:S:R:L:T:H:P::Δ of 214:192:92:90:86:52:50:39:32:32:25:*;
X₂ is G, R, P, L, S, A, V, T, K, D, Q, or Δ, in the ratios for G:R:P:L:S:A:V:T:K:D:Q:Δ of 171:153:107:83:81:51:40:40:34:32:30:*;
X₃ is D, G, P, L, S, N, A, H, F, R, T, or V, in the ratios for D:G:P:L:S:N:A:H:F:R:T:V of 10:1:1:1:1:1:1:1:1:1:1:1;
X₄ is Y;
X₅ is G;
X₆ is D;
X₇ is Y, F, L, S, H, G, P, A, R, D, or E, in the ratios for Y:F:L:S:H:G:P:A:R:D:E of 10:1:1:1:1:1:1:1:1:1:1;
X₈ is G, R, S, L, D, P, A, T, F, I, Y, or Δ, in the ratios for G:R:S:L:D:P:A:T:F:I:Y:Δ of 5:1:1:1:1:1:1:1:1:1:1:*;
X₉ is G, R, S, L, D, P, A, T, F, I, Y, or Δ, in the ratios for G:R:S:L:D:P:A:T:F:I:Y:Δ of 5:1:1:1:1:1:1:1:1:1:1:*;
X₁₀ is A, F, G, P, S, R, D, L, T, N, or H, in the ratios for A:F:G:P:S:R:D:L:T:N:H of 10:1:1:1:1:1:1:1:1:1:1;
X₁₁ is F;
X₁₂ is D; and
X₁₃ is I,
wherein the distribution of lengths (Len) is Len10:Len11:Len12:Len13::n1:n2:n3:n4, and wherein * indicates that the proportion of Δ is determined by the prescribed length distribution under the rule that each deleteable codon is deleted with the same frequency.

12. A library of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is
X₁-X₂-X₃-X₄-X₅-X₆-X₇-X₈-X₉-X₁₀-X₁₁-X₁₂-X₁₃ (SEQ ID NO: 1258) wherein:
X₁ is D, G, V, E, A, S, R, L, T, H, P, or Δ, in the ratios for D:G:V:E:A:S:R:L:T:H:P::Δ of 214:192:92:90:86:52:50:39:32:32:25:*;
X₂ is G, R, P, L, S, A, V, T, K, D, Q, or Δ, in the ratios for G:R:P:L:S:A:V:T:K:D:Q::Δ of 171:153:107:83:81:51:40:40:34:32:30:*;
X₃ is G, P, R, S, T, W, A, D, L, E, or K, in the ratios for G:P:R:S:T:W:A:D:L:E:K of 10:1:1:1:1:1:1:1:1:1:1;
X₄ is Y, G, D, R, S, F, A, V, P, L, or E, in the ratios for Y:G:D:R:S:F:A:V:P:L:E of 10:1:1:1:1:1:1:1:1:1:1;
X₅ is S;
X₆ is S;
X₇ is S, G, R, D, N, P, A, V, Y, T, or L, in the ratios for S:G:R:D:N:P:A:V:Y:T:L of 10:10:1:1:1:1:1:1:1:1:1;
X₈ is W;
X₉ is Y, S, G, D, P, R, A, F, H, K, or T, in the ratios for Y:S:G:D:P:R:A:F:H:K:T of 10:1:1:1:1:1:1:1:1:1:1;
X₁₀ is Y, P, S, G, R, L, T, F, A, D, or K, in the ratios for Y:P:S:G:R:L:T:F:A:D:K of 10:1:1:1:1:1:1:1:1:1:1 or X₁₀ is Y, P, S, G, R, L, T, F, A, D, K, or Δ in the ratios for Y:P:S:G:R:L:T:F:A:D:K:Δ of 10:1:1:1:1:1:1:1:1:1:1:*;
X₁₁ is F;
X₁₂ is D; and
X₁₃ is L,
wherein the distribution of lengths (Len) is Len10:Len11:Len12:Len13::n1:n2:n3:n4, and wherein * indicates that the proportion of Δ is determined by the prescribed length distribution under the rule that each deleteable codon is deleted with the same frequency.

13. A library of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is
X₁-X₂-X₃-X₄-X₅-X₆-X₇-X₈-X₉-X₁₀-X₁₁-X₁₂-X₁₃-X₁₄-X₁₅-X₁₆-X₁₇ (SEQ ID NO: 1259) wherein:
X₁ is D, G, V, E, A, S, R, L, T, H, P, or Δ (absent), in the ratios for D:G:V:E:A:S:R:L:T:H:P:Δ of 214:192:92:90:86:52:50:39:32:32:25:*;
X₂ is G, R, P, L, S, A, V, T, K, D, Q, or Δ, in the ratios for G:R:P:L:S:A:V:T:K:D:Q::Δ of 171:153:107:83:81:51:40:40:34:32:30:*;
X₃ is G, R, P, S, T, E, H, V, Y, A, L, or Δ, in the ratios for G:R:P:S:T:E:H:V:Y:A:L:Δ of 20:1:1:1:1:1:1:1:1:1:1:*;
X₄ is Y, D, G, H, P, N, R, S, V, A, or L, in the ratios for Y:D:G:H:P:N:R:S:V:A:L of 20:1:1:1:1:1:1:1:1:1:1;
X₅ is Cys;
X₆ is S, G, D, R, T, Y, F, L, N, V, or W, in the ratios for S:G:D:R:T:Y:F:L:N:V:W of 20:1:1:1:1:1:1:1:1:1:1;
X₇ is G, S, D, R, T, Y, F, L, N, V, or W, in the ratios for G:S:D:R:T:Y:F:L:N:V:W of 20:20:1:1:1:1:1:1:1:1:1;
X₈ is G, T, D, R, S, Y, F, L, N, V, or W, in the ratios for G:T:D:R:S:Y:F:L:N:V:W of 20:20:1:1:1:1:1:1:1:1:1;
X₉ is S, G, T, D, R, Y, F, L, N, V, or W, in the ratios for S:G:T:D:R:Y:F:L:N:V:W of 20:1:1:1:1:1:1:1:1:1:1;
X₁₀ is Cys;
X₁₁ is Y, F, W, D, R, S, H, A, L, N, or K, in the ratios for Y:F:W:D:R:S:H:A:L:N:K of 20:1:1:1:1:1:1:1:1:1:1;
X₁₂ is S, G, T, R, A, D, Y, W, P, L, F, or Δ, in the ratios for S:G:T:R:A:D:Y:W:P:L:F:Δ of 20:1:1:1:1:1:1:1:1:1:1:*;
X₁₃ is G, R, S, L, D, P, A, T, F, I, Y, or Δ, in the ratios for G:R:S:L:D:P:A:T:F:I:Y:Δ of 5:1:1:1:1:1:1:1:1:1:1:*;
X₁₄ is G, R, S, L, D, P, A, T, F, I, Y, or Δ, in the ratios for G:R:S:L:D:P:A:T:F:I:Y:Δ of 5:1:1:1:1:1:1:1:1:1:1:*;
X₁₅ is F;
X₁₆ is D; and
X₁₇ is L,
wherein the distribution of lengths (Len) is Len12:Len13:Len14:Len15:Len16:Len17::n1:n2:n3:n4:n5:n6, and wherein * indicates that the proportion of Δ is determined by the prescribed length distribution under the rule that each deleteable codon is deleted with the same frequency.

14. A library of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode a heavy chain (HC) CDR3, wherein the HC CDR3 is
X₁-X₂-X₃-X₄-X₅-X₆-X₇-X₈-X₉-X₁₀-X₁₁-X₁₂ wherein
X₁ is any of the amino-acid types shown in tables 3010, 3020-3027 for position 1,
X₂ is any of the AATs shown in tables 3010 or 3020-3027 for position 2,
X₃ is any of the AATs shown in tables 3010 or 3020-3027 for position 3,
X₄ is any of the AATs shown in tables 3010 or 3020-3027 for position 4,
X₅ is any of the AATs shown in tables 3010 or 3020-3027 for position 5,
X₆ is any of the AATs shown in tables 3010 or 3020-3027 for position 6,
X₇ is any of the AATs shown in tables 3010 or 3020-3027 for position 7,
X₈ is any of the AATs shown in tables 3010 or 3020-3027 for position 8,
X₉ is any of the AATs shown in tables 3010 or 3020-3027 for position 9,
X₁₀ is any of the AATs shown in tables 3010 or 3020-3027 for position 10,
X₁₁ is any of the AATs shown in tables 3010 or 3020-3027 for position 11, and
X₁₂ is any of the AATs shown in tables 3010 or 3020-3027 for position 12, wherein any of the amino acids X₃ through X₉ may independently be omitted.

15. A library of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode a heavy chain (HC) CDR1 and CDR2 as described in Example 14 or Example 15.

16. A library of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode a light chain with diversity in CDR1, CDR2, and CDR3 as described in Example 9 or Example 16.

17. A library of vectors or genetic packages that display, display and express, or comprise a member of a diverse family of human antibody peptides, polypeptides or proteins and collectively display, display and express, or comprise at least a portion of the diversity of the antibody family, wherein the vectors or genetic packages comprise variegated DNA sequences that encode diversity of claims 14, 15, and 16.

18. The library of any of the preceeding claims, wherein the diverse family are Fabs.

19. The library of any of the preceeding claims, wherein the diverse family are scFvs.

20. The library of any of the preceeding claims, wherein the diverse family are IgGs.

21. The library of claim 14, where the Fabs are displayed on phagemids.

22. The library of any of the preceeding claims, wherein the members comprise diversity in HC CDR1 and/or CDR2.

23. The library of any of the preceeding claims, wherein the members further encode framework (FR) regions 1-4.

24. The library of claim 19, wherein the FR regions 1-4 correspond to FR regions 1-4 from 3-23.

25. The library of any of the preceeding claims, wherein the members encode HC CDR1, HC CDR2 and FR regions 1-4.

26. The library of claim 21, wherein the members comprise a 3-23 HC framework

27. The library of any of the proceeding claims, wherein the members further comprises a LC variable region.

28. The library of claim 23, wherein the LC variable region comprise an A27 LC framework.

29. The library of any of the proceeding claims, wherein the library has at least 10⁴, 10⁵ 10⁶, 10⁷, 10⁸, 10⁹ 10¹⁰, 10¹¹ diverse members.

30. A library of Fabs as described in Examples 13, 14, and 16 built in pMID55F.

31. A library of Fabs built in a phagemid vector with pairs of restriction enzymes such that in each pair one enzyme creates a 5′ overhang of at least 4 bases and the other enzyme creates a 3′ overhang of at least four bases.

32. The library of claim 27 wherein the pairs of restriction enzyme recognition sites are separated by between 400 and 700 bases.
